(19) United States
(12) Patent Application Publication
(10) Pub. No.: US 2019/0073730 A1
(43) Pub. Date: Mar. 7, 2019

(54) Computer-Implemented Methods of and Systems for Analyzing Patent Claims

(71) Applicant: Search For Yeti, LLC, Arlington, VA (US)

(72) Inventors: Thomas J. Perkowski, Darien, CT (US); Jay Guiliano, Arlington, VA (US); Frank Rathgeber, Alexandria, VA (US); Aaron Levine, Houston, TX (US)

(21) Appl. No.: 15/944,790

(22) Filed: Apr. 4, 2018

Related U.S. Application Data
(63) Continuation of application No. 13/924,589, filed on Jun. 23, 2013.
(60) Provisional application No. 61/791,519, filed on Mar. 15, 2013.

(51) Int. Cl. G06Q 50/18; G06Q 10/06

(52) U.S. Cl. CPC G06Q 50/184; G06Q 10/063

(57) ABSTRACT

An advanced relational database and user interface system used for the evaluation, analysis and generation of specialized reports in any of a plurality data analysis environments. The database and analysis system can be utilized for many purposes, but particularly and preferably to support the analysis of patent claims and more specifically claim construction, infringement, written description, invalidity and/or patentability, among other matters of intellectual property litigation and analysis.

### CROSS-REFERENCE TO RELATED APPLICATIONS

This application is a continuation of U.S. application Ser. No. 13/924,589, filed Jun. 23, 2013, for Computer-Implemented Methods of and Systems for Analyzing Patent Claims, which application claims the benefit under 35 U.S.C. § 119(e) of U.S. Provisional Application No. 61/791,519, Systems for and Methods of Analyzing and Charting the Boundaries of Patent Protection Afforded to Patent Claims, filed Mar. 15, 2013, each of which is hereby incorporated herein by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### REFERENCE TO SEQUENCE LISTING, A TABLE, OR A COMPUTER PROGRAM LISTING COMPACT DISK APPENDIX

Not Applicable.

### BACKGROUND OF INVENTION

### Field of Invention

The present invention relates to advancements in the art of patent analysis, including claim drafting, searching, scope interpretation, prosecution, assertion, defense, contention, and enforcement, through improvements in technologies for analyzing the patent prosecution history of patent applications and granted patents, including patent claims and prior art references. The invention further relates generally to data processing systems. More specifically, the invention relates to a coordinated processing and analyzing of large amounts of data to reveal complex interrelationships in a coherent manner. More specifically still, in one implementation, the invention relates to data processing in accordance with the multifaceted constraints of intellectual property analysis and litigation.

### Brief Description of the State of Knowledge in the Art

It is well known that the process of obtaining a US Patent begins with filing of a patent application in the United States Patent and Trademark Office (“USPTO”). The patent application contains several parts, including the Patent Specification (“Specification”) and the original Claims to Invention (“Claims”). The Specification is a detailed disclosure of the invention teaching the relevant public (i.e. one with ordinary skill in the art) how to practice the preferred embodiments of a claimed invention. The specification also details the features of an invention considered to be unique, and thus patentable.

The patent claims—numbered clauses set forth at the end of a patent—are intended to provide notice of what a patent covers. A patent claim describes an invention so that it distinguishes recited subject matter from the prior art references considered during patent claim prosecution. Each patent claim defines the inventive features or elements of the invention in a single sentence. Each claim element is viewed as a “limitation” of the invention because it is recited as an essential feature of the invention. Each claim sentence, together with all the limitations in the claim, determines the scope of the invention. The patent claims define the boundaries of patent protection granted to the inventor (“Patentee”). The claims describe a protective boundary line around a patentee's right to exclude others from making, selling, using of offering for sale the specified invention—thus informing others about the boundaries of a patentee's rights. The limits of these boundaries are defined linguistically using words and phrases by reciting this language in a set of claims. Much like a real property deed describes the “metes and bounds” of a parcel of land or real property, a patent claim has been described as defining the “metes and bounds” of an invention. In other words, the real property deed describes the physical boundary for a piece of land, whereas the issued patent claim is meant to describe the boundaries of an invention.

The purpose of the written patent claim is to provide the public with a clear understanding of a patentee's exclusive property rights in his or her patented invention. Ideally, each patent claim should provide a bright-line as to what subject matter is covered by one or more patent claims. Oftentimes, this is not been the case, for various reasons.

During the patent application process before the PTO, a patent examiner (“Examiner”) is assigned to a filed patent application. The Examiner examines the patent specification and claims to determine whether or not the invention, as defined in the Claims, is patentable over the considered prior art references made of record during the patent prosecution history. Patent examination involves determining whether or not the invention as claimed meets the statutory patentability criteria of patent eligible subject matter, novelty, usefulness, and non-obviousness, as well as whether the claimed subject matter is adequately disclosed by the Specification.

According to the USPTO Manual of Patent Examination and Procedure (“MPEP”), the written description should provide the clearest explanation of the applicant's invention, by exemplifying the invention, explaining how it relates to the prior art and explaining the relative significance of various features of the invention. Accordingly, the MPEP urges USPTO personnel to continue their evaluation by (a) determining the function of the invention, that is, what the invention does when used as disclosed (e.g., the functionality of a programmed computer); and (b) determining the features necessary to accomplish at least one asserted practical application. Also, the goal of claim analysis is to identify the boundaries of the protection sought by a Patentee and to understand how the claims relate to and define what a Patentee has indicated is the invention. According to the MPEP § 2100, USPTO personnel should first determine the scope of a claim by thoroughly analyzing the language of the claim before determining if the claim complies with each statutory requirement for patentability. USPTO personnel should begin claim analysis by identifying and evaluating each claim limitation. For processes, the claim limitations will define steps or acts to be performed. For products, the claim limitations will define discrete physical structures or materials. Product claims are claims that are directed to machines, manufactures or compositions of matter. USPTO personnel should correlate each claim limitation to all portions of the disclosure that describe the claim limitation. This is to be done in all cases, regardless of whether the claimed invention is defined using means or step plus function language. The correlation step is to ensure that USPTO personnel correctly interpret each claim limitation.

The subject matter of a properly construed claim is defined by the language/linguistic terms that limit the scope of subject matter coverage. It is this subject matter, recited in a claim, that must be examined by an Examiner. When evaluating the scope of a claim, every limitation in the claim must be considered. USPTO personnel may not dissect a claimed invention into discrete elements and then evaluate the elements in isolation. Instead, the claim as a whole must be considered. As a general matter, the grammar and intended meaning of terms used in a claim will dictate whether the language limits the claim scope. Language that suggests or makes optional but does not require steps to be performed, or does not limit a claim to a particular structure, does not limit the scope of a claim or claim limitation.

If a patent claim is drafted so broad that it includes (embraces) the prior art, then the claim will be rejected and not allowed. If an Examiner finds that a claim satisfies the statutory criteria for patentability, and all other requirements have been satisfied, including timely payment of the Issue Fee, then a US Letters Patent is issued (i.e. granted) with the Specification and the allowed (i.e. approved) Claims to Invention.

In a quid pro quo manner, in return for a patent grant, the inventor must give, as consideration, a complete revelation or disclosure of the best mode of the invention for which patent protection is sought.

FIG. 1A sets forth a graphical image of the title page of an exemplary US Patent Grant, selected for illustration purposes only. FIG. 1B sets forth a graphical image of the claims issued in the exemplary US Patent Grant. FIG. 1C sets forth a graphical image of a directory of digital files associated with the exemplary US Patent Grant, including .tsv files and an image file wrapper subdirectory containing numerous pdf files comprising the complete prosecution (file wrapper) history of the exemplary US Patent Grant obtained from Google/USPTO. Finally, FIG. 1D sets forth a graphical image of the Index of Claims in the patent prosecution history of the exemplary US Patent Grant. Collectively, these documents provide the documents comprising the patent prosecution history or file wrapper of the exemplary US Patent Grant.

After the patent claims are allowed and a patent is granted, the allowed patent claims may be considered by third parties (working in the field of invention) as well as the federal courts, to determine the scope of the patent claims.

The table of FIG. 2A sets forth the critical question relating to the cognitive process of patent claim scope interpretation, or construction, that must be carried out for patent claims, whether granted, allowed and/or pending.

When evaluating the scope of a claim, every limitation in the claim must be considered. USPTO personnel may not dissect a claimed invention into discrete elements and then evaluate the elements in isolation. Instead, the claim as a whole must be considered.

Determination of the scope of a patented invention (through an interpretation of the allowed patent claims) is one of the most contentious and difficult tasks of modern patent law. Because patent claims are central to determinations of patent scope and patent validity, the stakes are very large when trying to improve the predictability of claim construction/interpretation. The Patent Office and the courts are constantly making patent scope decisions. The Patent Office does so when it determines the scope of the claims that it will allow. The courts determine scope in litigation, where questions of patent infringement are decided. In the former context, the applicant wants to claim as much as she can, and the Patent Office must decide what claims are allowable. While decisions regarding what subject matter to allow in patent claims are constrained by a number of legal principles, and by the nature of the invention itself, in many cases the Patent Office has considerable room for discretion. Within that discretionary zone, the Patent Office must decide which claims should be allowed and which ones should be rejected. This involves determining the scope and content of the prior art [MPEP 2141.1]. The Examiner must also determine the differences between the prior art and the claimed invention [MPEP 2141.02].

The certainty with which patent scope is defined is a crucial variable in determining whether the net impact of patents is positive or negative. Relative certainty regarding the scope of a patent claim(s) can promote the development and dissemination of related technology by providing a sense of security both to investors in patent rights and to investors in activities that might be vulnerable to charges of patent infringement. Greater certainty may also facilitate licensing that promotes efficient levels of inventive and productive activity. Parties may be more likely to avoid expensive litigation and agree to licensing terms if they can first agree on the scope of protection afforded by granted patent claims.

After a patent has been issued, a patentee may allege that competitors are using the patentee's patented invention. In arguing its case, the patentee may try to demonstrate that the accused infringer's products and/or services fall within the boundaries of the patentee's claimed invention, as defined in its patent claims. Meanwhile, the defendant, or patent challenger, may argue first that the granted patent is invalid (i.e. contend that the claims are invalid), and second that the defendant's product and/or service is different in some material respect from the invention claimed by the patentee, and that therefore defendant's product and/or service does not infringe the patentee's asserted patent claim(s).

Claim interpretation, or claim construction, is important in determining the scope of a patentee's patent rights and in determining whether anyone else has a patent that would prevent another from making, using, selling or importing an apparatus or method defined by the claims. Claims are interpreted as to their meaning when viewed by a person of ordinary skill in the art and in light of: the patents written description; arguments made to the patent office; and dictionary definitions. Claim terms are given their ordinary meaning unless the patent's written description or arguments made to the patent office indicate otherwise. Occasionally, prior art references and expert witnesses are used to resolve ambiguity. To show patent infringement, an accused device, method, system or composition must possess each claimed element, or something equivalent to the element. An equivalent can be something that does substantially the same thing in substantially the same way, to achieve substantially the same result. The range of equivalents can be limited by the claim's interpretation, as discussed above.

Oftentimes, claim interpretation (i.e. claim construction) is the centerpiece of patent litigation. In a patent infringement lawsuit, at some point, the patent claims may be interpreted to determine how infringement, validity, and other issues under the patent will be measured. Patents typically have multiple claims, and each claim is considered separately for issues of infringement and validity.

In Markman v. Westview Instruments, Inc., the Supreme Court ruled that judges, not juries, must construe patent claims. Since the Markman ruling, federal district court judges have been exclusively assigned the difficult task of interpreting all controverted patent claims. Shortly after Markman, the Federal Circuit decided that the district court's claim construction analyses were subject to de novo review by the Federal Circuit. This combination of shifting the responsibility for claim construction from juries to judges and raising the standard of appellate review resulted in a substantial increase in the Federal Circuit's discretion in reviewing claim constructions.

FIG. 3A describes the general method of patent claim construction articulated in Markman and Phillips, involving the claims, claim construction rules and doctrines, intrinsic evidence, extrinsic evidence, proper claim interpretation, and initial interpretation of patent claims by court.

FIG. 3B sets forth principles involved when construing (i.e. constructing) the meaning of words in patent claims, and the scope of the patent claim itself, and when deviation from ordinary meaning of words should be allowed.

In conjunction with the use of intrinsic evidence to construe claims, an old axiom about patents still seems to operate: that all granted patents “are to receive a liberal construction, and under the fair application of the rule, ut res magis valeat quam pereat, are, if practicable, to be so interpreted as to uphold and not to destroy the right of the inventor,” Turrill v. Mich. S. & N. Ind. R.R., 68 U.S. 491, 510 (1863) (emphasis added). Thus, it is essential to understand the scope of patent claims before their breadth (i.e. scope) can be limited for purposes of preserving patent validity. To do otherwise, the court construing patent claims would be putting “the validity cart before the claim construction horse”.

In view of the many difficulties that patent claim construction (i.e. interpretation) presents to human beings seeking to understand the scope of protection afforded by a set of patent claims, in view of the patent claim prosecution history, some recent computer-assisted tools have been developed to assist in this intellectual challenge. The table of FIG. 4 lists a number of conventional patent file history analysis tools, and patent claim charting tools, that have been developed over the years.

In particular, Landon IP, based in Arlington, Va. recently introduced a service platform called Patent Workbench™. The platform is described to use researchers to review patent file histories, and then described to include a process to perform organizational and preparation tasks. The end result is a Patent Workbench™ file package, delivered to customers over a secure website, for download, using its desktop-based Patent Workbench™ Reader. The Reader provides access reports and tools for reviewing and analyzing the patent claims, and other patent file history information. Using the Patent Workbench™ Reader, the customer can review and navigate the organized file history, with all papers accessible by date, paper type, or other way that works for the end-user. Access is provided to all versions of claims, with links to papers and sections of papers that are pertinent to claim construction. The user can track and compare claims and identify changes in claim language during prosecution. The entire patent file history and cited references can be searched using advanced search capabilities. Important documents, such as missed prior art, can be saved with all other files related to the patent file history. Reports and views can be exported and shared, for use in internal working papers or work products for the courts.

Landon IP's Patent Workbench™ service platform offers an improved way to handle the onerous preparation tasks required when reviewing patent file histories. This may help attorneys to more quickly and efficiently conduct legal analysis involved in construing patent claims. This service platform is not without shortcomings and drawbacks. In particular, while the Patent Workbench™ service platform helps reduce un-front organizational tasks associated with patent file history analysis, and improves the management, navigation and searching of patent file history documents, it does little if anything to improve upon the actual process of understanding the scope of patent claims.

Also, while various charting tools have been developed and proposed for use in (i) charting patent claims and prior art during patent claim contention proceedings (e.g. Lithosphere's PATDEK® 1.0 System) and expedited patent examination proceedings in the USPTO, (ii) charting patent claims and products and/or services during freedom to operate (FTO) efforts (LUCID® Claimbot) described in U.S. Pat. No. 8,161,023, incorporated by reference, (iii) charting patent claims and products and/or services during patent assertion efforts (Patriot™ Charts & PatentCafe) and enforcement proceedings, (iv) charting patent claims and rules of construction during Markman Hearings (conventional Markman Charts), such claim charting tools have little assistance when seeking to understanding the scope of patent claims.

Also, while some minor advances have been made in the field of knowledge-based systems, specifically using formal concept analysis to carry out automated learning of concept hierarchies from a body of text (i.e. text corpora—Journal of Artificial Intelligence Research, Vol. 24, 2005, pgs. 305-339), such advances are inadequate to allow such computer-based machines to replace patent attorneys and their faculties of language understanding and human judgment, in the highly complex process of patent claim construction, linguistic interpretation, and patent claim scope understanding. Moreover, it is not expected that future advances in this field will allow even the most powerful computing machines to replace human linguistic judgment in the complex matter of patent claim construction, interpretation and claim scope understanding.

Also, the flood of prior art information on the WWW becoming available from millions of sources, outside conventional technical and patent database systems, will continue to generate prior art documents that will become relevant and material to the millions of Patent Claims staked out and being pursued by Applicant/Owners under America's new first-to-file rules. Also, while most patent experts believe better access to prior art information will provide more transparency around the patent process, others believe this will drown the public in a sea of prior art information, and not improve the complex process of disclosing prior art to the Patent Office, and understanding the scope of patent claims or the patent owner's corresponding right to exclude others who infringe upon the same.

It is believed that, in the United States, the presumption of validity of each patent claim in a granted US Patent, under 35 USC Section 282, will continue to face attack with increased pressure from USPTO re-examination and post-grant proceeding activities. This may work to undermine the authority of the Patent Office and the general Public's confidence in the US Patent System to produce “gold-plated” patents that can and will withstand invalidity contentions by third-parties. In a worse case scenario for Applicant/Inventors, such pressures and forces might someday cause the US Patent System to devolve into a system of invention registration, without patent claim examination, and the abolishment of the presumption of validity associated with granted patent claims that can be asserted against patent infringers.

It is also believed that there is a great need in today's world of patent protection for significant advancements in computer-implemented systems and methods that can improve the patent process in a two-folder manner: (1) assist Applicant/Owners and their Patent Attorneys and Agents to more efficiently and effectively search for prior art references, carry out their duty of candor and good faith before the USPTO under 37 CFR 1.56 during patent prosecution, and assess the patentability of patent claims in view of retrieved prior art references; and also (2) assist Patent Office Examiners when (i) reviewing disclosed prior art references, and (ii) deciding on issues of patent claim patentability, in view of an accurately considered state of the art. The goal would be for the Patent Office to issue significantly more gold-plated patents to Applicant/Owners, and the spirit of trust between the Public, the Patent Office, Applicant/Inventor/Owner Community and the Patent Law Profession will be strengthened and preserved, so that our nation and its people will benefit from this.

In general, conventional methods of patent claim analysis suffer from a number of shortcomings and drawbacks, namely, they: (1) are time consuming; (2) are very expensive; (3) requires technical domain and legal knowledge (i.e. expertise) that may be difficult or otherwise expensive to access by many who need answers specific questions on a particular set of patent claims; (4) involve the use of the most expensive, least knowledgeable persons to perform the analysis (i.e. patent attorneys, paralegals); (5) fail to employ people with the greatest expertise and knowledge in the art (i.e. engineers, scientists and technicians) to help perform and/or support the patent analysis, and instead, invites them into the patent analysis process after a patent litigation has been commenced; (6) fail to provide an adequate documentary trail for others to follow what legal analysis has been performed to date on any given patent analysis matter; (7) involve subjective judgments as to what is covered and not covered by particular patent claims; (8) lack sufficient transparency and makes it difficult for most others to follow or understand what has happened, despite them having knowledge and/or skill in the art to which the patent claims are directed; and similar reasons.

In short, there are many problems associated with conventional approaches to performing patent claim analysis, determining the scope and boundaries of patent protection, and securing high quality patents having claim scope and boundaries that are clear and accessible to those who have an interest in knowing about them with a reasonable degree of certainty.

Thus, there is a great need in the art for a much better, less expensive, and more consistent way of performing rational patent analysis, with greater transparency, and accountability, and more flexible tools and methods designed to serve the growing needs of the patent law field and explosion of prior art information flooding the human race, so as to advance the art of patent protection in significant ways, enable the securing of enforceable patent claims that will withstand the challenge of third-party invalidity contentions, maintain public confidence in the Patent Office and its Examining Corps, and protecting the public's interests in granting patent protection to inventors for their technical contributions to the art, while avoiding the shortcomings and drawbacks of prior art systems and methodologies.

In an increasingly complex world, situations regularly arise that require the processing and analysis of large amounts of data, aspects of which might be interrelated in numerous ways. It is often useful to be able to simplify the analysis of data and express interrelationships across subsets thereof in a coherent manner, etc. In the field of complex data processing, various systems are available for distilling large amounts of data down to its core features in a variety of ways for ease of analysis.

One field that regularly involves large data sets with multi-layered complexities is litigation. In the environment of intellectual property, for example, issues of claim construction, infringement, written description, invalidity and/or patentability, among others, might arise. At the heart of these issues are the patent claims, each of which includes a variety of concepts. The issues might require analysis of large volumes of textual and graphical description, followed by the structured analysis and mapping of portions thereof against the claims' individual concepts.

With further respect to intellectual property, in the context of patent analysis or litigation, for example, several variables may contribute to the complexity and volume of data present in a typical case or matter, including large numbers of 1) patents and claims at issue, 2) claim limitations in individual claims, 3) references cited by the applicant and/or patent examiner during examination of an application and/or 4) additional prior art references uncovered during post-issuance investigation. As the data in these categories increase, the number of discrete issues likewise generally increases. To combat this complexity, it may be beneficial to combine related issues into groups for purposes of analysis. When searching for invalidating prior art, for example, systems exist that allow a user to break complex claims down into their individual limitations, and combine multiple similar limitations across claims or patents into conceptual groupings to reduce the number of individual concepts, in an effort to render the search for prior art more efficient.

Despite these features, however, the user may nevertheless be left to sort through hundreds or thousands of prior art disclosures that may apply alone or in combination across large numbers of claim limitation or concepts. It may be beneficial in certain scenarios to further enable a user to rank or otherwise qualify prior art references or individual disclosures in a customizable variety of ways, with respect to the individual claim concepts being investigated.

### OBJECTS OF THE PRESENT INVENTION

Accordingly, a primary object of the present invention is to provide a new and improved network-based patent analytical workspace, designed for use by everyone interested in patents, supported by powerful information search systems, and highly-advanced computer-implemented language processing capabilities, engineered to (i) help everyone gain simpler access into the complex process of understanding the scope and limits of such patent protection, afforded by any set of patent claims, pending, allowed or granted, (ii) assist Applicant/Inventors to properly reconstruct the true state of knowledge in the art at the time of patent application filing by electronic disclosure of relevant and material prior art references to the Patent Office with insightful forms of analytical support to assist in patent claim examination in a spirit of candor and good faith and the securing of strong but proper patent protection, and also (iii) allow anyone to easily challenge the scope and boundaries of granted patent claims, whenever necessary and proper, supported by rational prior art analysis and documentary support, with the goal of optimizing the scope of granted patent protection to Inventors for their contributions to the art as allowed under the Patent Laws, providing security for capital investments in patented inventions, and protecting the Public's interests in clearly knowing the boundaries of such patent grants, while overcoming the shortcomings and drawbacks of prior art methods and technologies.

Another object of the present invention is to provide anyone with a better way of analyzing and understanding inventions (i.e. useful ideas) represented by claims expressed in natural human language.

Another object of the present invention is to provide improved tools for exploring opportunities for securing patent protection on particular inventions, discovering ways of operating in the marketplace with increased levels of intellectual property freedom, developing new products and/or services not requiring third-party patent licenses, and discovering and removing barriers to market entry created by granted patents having claims that are believed to be invalid.

Another object of the present invention is to provide a new and improved method of and system for analyzing and charting the patent prosecution histories of granted patents and published patent applications so as to provide a Claim Scope Schema (CSS) structure, during the patent claim understanding/interpretation process, that functions as a framework that helps organize information relating to the scope and meaning of any allowed patent claim, to assist anyone interested in better understanding the scope and boundaries offered by allowed patent claims.

Another object of the present invention is to provide computer-implemented systems and methods that enable unprecedented levels of automation in the field of patent law practice, wherein patent claim analysis and charting operations are automated, to a great extent, so as to assist patent attorneys in making more informed decisions and judgments about the scope and boundaries of patent claims before filing, during prosecution, and after grant, while increasing the speed of service delivery and reducing the cost thereof to clients.

Another object of the present invention is to provide a novel computer-implemented method of and system for performing patent analysis and charting that: (1) is significantly less expensive and more efficient; (2) employs people with the greatest expertise and knowledge in the art (i.e. engineers, scientists and technicians), essential to high-quality patent analysis, and who are often less expensive than lawyers, to help perform and/or support the critical stages of any patent analysis; (3) generates a robust documentary trail for others to understand what legal analysis has been performed by others to date, on any given patent analysis matter; (4) provides a claim scope schema (CSS) structure for any set of allowed patent claims that eliminates subjective judgments as to what is covered and not covered by particular patent claims; (5) improves transparency around the patent prosecution process; and (6) helps others to better understand, and visualize the linguistic nature of the scope and boundaries of protection that should be afforded by a particular set of patent claims, in view of the patent prosecution history, and the state of knowledge in the art at the time the invention was made.

Another object of the present invention is to provide a novel Claim Scope Concept (CSC) based markup model and process, implemented on a computer system, for any patent claim expressed in natural language, and directed to a useful invention, setting forth the meets and bounds (i.e. the scopes and limits) of patent protection to be afforded to an invention covered by a patent claim, in view of the known state of knowledge in the art at the time of invention or patent application filing.

Another object of the present invention is to provide such a computer-implemented Claim Scope Concept (CSC) based markup process, for marking up any patent claim composed of a plurality of Claim Limitation Language Strings (CLLS), wherein during the markup process, the following process is performed: (i) each Claim Limitation Language String (CLLS) is assigned a Claim Limitation Identifier or index (CLID); (ii) a Scope Concept Phrase (SCP) composed of a set of words (W1, . . . WN) describing the Scope Concept encompassed by the Claim Limitation Language String (CLLS) is assigned to the CLLS; and (iii) a Claim Scope Concept Structure Identifier (CSCSID) is assigned to the CLLS, to identify the entire CSC data structure, in accordance with the principles of the present invention.

Another object of the present invention is to provide a novel computer-implemented method of and system for performing patent analysis and charting that employs (i) conceptual modeling of the scope of patent claim limitations and/or sub-limitations, and (ii) analysis of prior art references and patent prosecution history documents using the scope concepts assigned to the conceptual models of the patent claims under analysis, and further uses these scope concepts to generate scope concept based prior art search vectors provided to powerful advanced prior art search engines, and designed to search for and discover relevant and material prior art references (e.g. searchable text and/or searchable graphics and/or images) that correspond or substantiate the subject matter of one or more scope concept indexed claim limitation language strings (CLLS) in the patent claims under analysis.

Another object of the present invention is to provide a novel computer-implemented method of and system for performing patent analysis and charting, using scope concept mapping techniques applied to the language of patent claim limitations and corresponding disclosure in the prior art references, cited during the course of the patent prosecution history of the patent claims, so as to provide a claim scope schema (CSS) in the form of a chart structure, containing the text of the allowed claims and text and graphics based prior art language landscape or background visually mapped against the allowed claim limitations, and other scope concept relevant information collected from the patent prosecution history, to help interested parties to more accurately resolve the scope and boundaries of patent protection afforded the allowed patent claims.

Another object of the present invention is to provide such novel computer-implemented method of and system, wherein the language of patent limitations is also mapped to specific corresponding portions of statements made by the examiner and/or applicants/owners during the course of the patent prosecution history of the patent claims.

Another object of the present invention is to provide an Internet-based multi-mode patent claim analysis and charting system that: (i) makes use of claim scope concept (CSC) mapping between claims and statements made in patent prosecution history, including prior art references; (ii) supports multiple configurable modes of system operation, wherein each configurable mode of system operation employs different mapping techniques for different kinds of patent claim related analysis, language and information processing, and information charting; and (iii) generates the various prosecution-history based chart structures for the different modes of system operation supported by system.

Another object of the present invention is to provide such an Internet-based multi-mode patent claim analysis and charting system that has a structured mode of analysis that guides the user(s), step-by-step, using graphical user interfaces (GUIs) designed to educate, instruct and help identify and collect relevant information about the patent prosecution history, in a structured manner, with the aid of programmed expertise.

Another object of the present invention is to provide such an Internet-based multi-mode patent claim analysis and charting system that presents collected and processed prosecution history information in novel claim scope schema (CSS) structures, realizable using XML-based spreadsheet charting technology, that allow inventors, engineers and scientists, as well as patent professionals, including attorneys paralegals and other members of a legal analysis team, to better comprehend, discuss and visualize the boundaries or scope of patent claim protection that should be allowed by a set of granted patent claims, in view of the cited prior art references made of record, as well as in view of non-cited prior art references discovered subsequent to the allowance and granting of a patent.

Another object of the present invention is to provide such an Internet-based multi-mode patent claim analysis and charting system that supports multiple modes of patent claim analysis, and allows collected information from one mode of patent analysis, to be used and leveraged in other modes of patent analysis, with respect to any life cycle of any granted patent or group of patents.

Another object of the present invention is to provide such an Internet-based multi-mode patent claim analysis and charting system that replaces and/or supports some attorney/lawyer functions with computer-implemented technology and tools designed to assist in organizing patent claims and prior art information, and supporting automated patent searching, automated claim patentability analysis, and automated patent claim invalidity analysis, with the goal of better understanding patent claims and large prior art reference data sets, gaining a significant edge over standard patent claim chart analysis, and acquiring a deeper understanding of the patent issues.

Another object of the present invention is to provide a novel set of patent prosecution history processing tools to generate scope concept schema (CSS) charts that are designed assist in and enhance the understanding of the scope and boundaries of patent protection, and which can be applied to infringement and invalidity analysis, to assist in the understanding of the proper scope of patent claims.

Another object of the present invention is to provide a novel set of patent prosecution history processing tools designed in the form of a multi-mode patent analysis and charting system, that can be simply reconfigured by any authorized user if and when the claims are determined to be too broad, based on the prior art reference analysis, so that a patent claim invalidity contention can be properly made.

Another object of the present invention is to provide a novel set of patent prosecution history processing tools designed in the form of a multi-mode patent analysis and charting system, that be reconfigured and used to assist in determining whether or not the claim scope truly reaches an accused product or service.

Another object of the present invention is to provide a novel set of patent prosecution history processing tools designed for processing, tracking and handling information collected during the prosecution history of a patent, the prior art considered during prosecution, any stated reasons for allowance, and also prior art not considered during prosecution.

Another object of the present invention is to provide a novel set of patent prosecution history processing tools that generate claim scope schema charts, designed to help enhance the understanding of the scope and boundaries of patent protection.

Another object of the present invention is to provide a new method of and apparatus for extracting natural language information from a patent file history database system and displaying patent claim chart structures that enhance the visualization and understanding of the scope and boundaries of patent claim protection.

Another object of the present invention is to provide a new and improved class of information management, analysis, mapping and charting tools (i.e. instruments) designed for use by inventors, scientists, engineers, patent attorneys, paralegals and others involved in the patent process, to help achieve greater transparency, lower legal costs, and greater technological expertise during the entire patent life-cycle process.

Another object of the present invention is to provide an improved method of and system for supporting the visualization and understanding of patent protection boundaries allowed by granted patent claims.

Another object of the present invention is to provide an Internet-based document processing system for supporting an improved method of patent file history analysis assisting in the visualization and understanding the boundaries of patent protection allowed granted patent claims, by supporting scope concept based analysis of patent claim limitations and patent prosecution history information, and scope concept based display/charting processes designed to help better organize prior art information surrounding a particular set of patent claims specified in a pending or allowed patent application, or granted patent.

Another object of the present invention is to provide a method of and system for intelligently analyzing the file/prosecution history of a granted patent in a highly structured manner, and automatically generating patent claim prosecution history charts to help better understand and visualize the boundaries of patent protection afforded by the patent claims in the granted patent.

Another object of the present invention is to provide a method of and system for using claim scope concepts that have been assigned to a set of patent claims, to automatically generate patent file history based claim scope schema (CSS) charts containing patent claims, prior art references and prosecution history statements that have been mapped and linked to or indexed by the claim scope concepts.

Another object of the present invention is to provide a computer-based system configured in a patent claim scope interpretation analysis mode of operation, for analyzing and charting the patent prosecution history of a granted patent, so as to help better visualize and understand the boundaries of patent protection afforded by the patent claims of the granted patent.

Another object of the present invention is to provide a computer-based system configured in a Markman patent claim term analysis mode of operation, for generating patent prosecution history based Markman claim charts to help better understand terms in patent claims of a granted patent.

Another object of the present invention is to provide a computer-based system configured in hybrid-type claim scope interpretation/Markman analysis mode of operation, for analyzing and charting the patent prosecution history of a granted patent, so as to help better understand the boundaries of patent protection afforded by the patent claims of the granted patent.

Another object of the present invention is to provide a computer-based system configured in a prior art analysis mode of operation, for analyzing and charting patent prosecution history of a granted patent, and generating search vectors for use in searching for and discovering new prior art references related to the subject matter of the patent claims in a patent grant.

Another object of the present invention is to provide a computer-based system configured in a prior art analysis mode of operation, for analyzing and charting patent prosecution history of a granted patent, and generating patent prosecution history based claim contention charts for use in contending the invalidity of allowed patent claims in a granted patent.

Another object of the present invention is to provide a computer-based system configured in a patent claim infringement analysis mode of operation, for analyzing and charting patent prosecution history of a granted patent, and generating patent prosecution history based claim infringement charts to assist in patent claim infringement analysis of alleged products and/or services.

Another object of the present invention is to provide a computer-based system configured in a freedom-to-operate (FTO) analysis mode of operation, for analyzing and charting a group of granted patents and/or published patent applications, against product and/or service descriptions, in patent prosecution history based freedom to operate (FTO) charts, used during FTO analysis of the patent claims in the group of patents/applications.

Another object of the present invention is to provide a computer-based system configured in a patent litigation-storyboard analysis mode of operation, for analyzing and charting patent prosecution history of a granted patent, as well as plaintiff-produced and/or defendant-produced evidence discovered during litigation, and generating prosecution history and other evidence-based patent litigation-storyboard charts to assist in evidentiary and litigation planning issues related to the allegedly-infringing products and/or services, as well as other disputed issues (damages, validity, estoppel, inequitable conduct, etc.) involved in the patent litigation.

Another object of the present invention is to provide a computer-implemented method of and system for conducting a structured analysis of the file wrapper/prosecution history of a granted patent, and supporting the generation of allowed claim charts that facilitate the application of the patent claim construction rule requiring interpretation of granted patent claims so as to preserve claim validity.

Another object of the present invention is to provide a computer-implemented patent file history analysis platform for analyzing the patent file wrapper history of a granted patent using claim scope concepts abstracted from claim limitation language strings, and displaying patent file history charts containing allowed patent claims, cited and applied prior art references, cited and non-applied prior art references, and prosecution history statements, transparently mapped and indexed using direct linking and/or claim scope concept mapping processes.

Another object of the present invention is to provide a computer-implemented method of discovering cumulative prior art references mapped to patent file history based charts containing allowed patent claims, cited and applied and cited and non-applied prior art references, and prosecution history statements made by the applicant(s) and the patent office, transparently mapped and indexed using direct linking and/or claim scope concept mapping processes.

Another object of the present invention is to provide a computer-implemented system for and method of generating claim charts for supporting Markman hearings, wherein the patent prosecution history based claim scope schema (CSS) charts contain the allowed patent claims, cited and applied and cited and non-applied prior art references, and prosecution history statements by applicant(s) and the Patent Office, transparently mapped and indexed using parsed claim limitations.

Another object of the present invention is to provide a computer-implemented system for and method of generating patent prosecution history based patent claim charts for supporting each substantial new question of patentability (SNQP) in a request for reexamination or other post-grant proceedings of certain allowed claims in a granted patent, while reducing the burden on the USPTO, wherein each patent prosecution history based patent claim chart contains certain allowed patent claims for which reexamination is requested, prior art references cited and applied during prosecution, prior art references cited and not-applied during prosecution, prosecution history statements by applicant(s) and/or the patent office (i.e. examiner), and prior art references cited in the request, each being transparently mapped and indexed using direct linking and/or claim scope concept mapping processes.

Another object of the present invention is to provide a computer-implemented system for and method of generating prosecution history based patent claim invalidity charts for supporting patent claim invalidity contentions.

Another object of the present invention is to provide a computer-implemented system for and method of generating patent prosecution history based patent claim charts that include cited prior art references scope concept mapped against limitation and/or sub-limitation language in the patent claims, and prior art references supporting third-party patent claim invalidity contentions, so as to help patent owners counter-defend against patent claim invalidity contentions being raised by third parties against the patent claims of the patent owner, and also to help both the patent owner and such third parties to quickly resolve the proper scope and boundaries of patent protection that should be afforded by the patent claims in view of the true state of knowledge the art, without invalidating the patent claims.

Another object of the present invention is to provide a computer-implemented system for and method of abstracting claim scope concepts from, or assigning claim scope concepts to, the claim limitation language strings of patent claims in a granted patent and/or published patent application.

Another object of the present invention is to provide a computer-implemented system for generating patent prosecution history based chart structures that assist human users during the cognitive process of visualizing and understanding the scope and boundaries of patent claims during the patent claim construction/interpretation process, before the scope or breadth of patent claims is limited for purposes of preserving claim validity.

Another object of the present invention is to provide a computer-implemented system for and method of generating an unique object-oriented patent claim analysis and charting platform, automatically programmed for each granted patent, to help others better visualize and understand the claim scope and boundaries of patent protection allowed by any granted patent.

Another object of the present invention is to provide a novel computer-implemented system platform that automatically (i) generates, for each patent granted in a national patent protection system (indexed by Pat. No. and/or application Ser. No.), an object-oriented patent analysis and charting system comprising patent file history data, methods and GUIs, and then (ii) loads the object-oriented patent analysis and charting system onto Internet-based servers so that the patent analysis and charting system can be remotely accessed by a group of authorized web-enabled clients, so they can (i) efficiently analyze the patent file/prosecution history of the granted patent (including the allowed patent claims, cited prior art references, and patent prosecution history statements) in a highly structured manner, (ii) link claim rejections and prior art reference disclosure to corresponding limitations in the allowed patent claims, (iii) link prosecution history statements made by applicant(s) and the examiner to corresponding claim limitation and/or sub-limitation language, (iv) formulate and assign scope concepts to the limitations of the allowed patent claims, and then (v) link (i.e. map) cited prior art references to corresponding language in the allowed patent claims using scope concept based mapping techniques, so as to automatically generate patent prosecution history based claim scope schema (CSS) charts designed to better help understand the scope and boundaries of patent protection that should be allowed or afforded by the patent claims in each granted patent, granted against a scope concept mapped prior art landscape.

Another object of the present invention is to provide a novel method of analyzing the patent file wrapper (i.e. prosecution) history of a granted patent, using improved methods, data structures and CSS-charting technology, to help others better understand the boundaries of patent protection afforded by the allowed claims of the granted patent, and to do so with a greatly increased level of efficiency and at a significantly lower cost savings

Another object of the present invention is to provide a computer-implemented method of contending the invalidity of allowed patent claims in a granted patent using scope concept mapping of prior art references and the language of claim sub-limitations in the allowed patent claims.

Another object of the present invention is to provide a computer-implemented method of scope concept based mapping of the language of claimed subject matter in granted patent claims, against the technical disclosure of one or more corresponding prior art references, that may or may not have been cited during the prosecution history of the granted patent, so as to significantly improve the discrimination between a claimed invention against surrounding prior art references, and assist in the understanding of the scope and boundaries of granted patent claims.

Another object of the present invention is to provide a computer-implemented method of scope concept based mapping of granted patent claims and corresponding prior art references, so as to assist in the valuation and devaluation of an invention covered by a granted patent claim.

Another object of the present invention is to provide a computer-implemented method of claim patentability analysis, employing scope concept analyzed patent claims and prior art references, so as to assist in rationally determining the best combination of prior art references to support the rejection or allowance of one or more patent claims, for example, during ordinary as well as expedited patent examination proceedings.

Another object of the present invention is to provide a computer-implemented method of patent claim invalidity contention analysis, employing scope concept analyzed patent claims and prior art references, so as to assist in determining the best combination of prior art references to support the contention of patent claim invalidity, for example, during post-grant as well as inter-parte re-examination proceedings.

Another object of the present invention is to provide a computer-implemented method of linking the claim limitation or sub-limitation language of a patent claim and a formulated claim scope concept embraced by the claim limitation or sub-limitation language during a scope concept formation and assignment process carried out within a patent analysis and charting system.

Another object of the present invention is to provide a computer-implemented method of linking claim scope concepts with linguistic statements made in patent file history documents, including the patent specification, office action documents, amendments and prior art references, or marking up such linguistic statements with claim scope concept (CSC) structures, so that such statements can be mapped against corresponding patent claim limitations displayed in patent prosecution history based claim scope schema (CSS) chart structures which can be used to support patent claim scope interpretation.

Another object of the present invention is to provide an Internet-based multi-mode patent claim analysis and charting system that can be user-reconfigured to support any one of more of a plurality of modes of system operation, including, but not limited to: a patent claim prosecution analysis mode, during which, patent claim prosecution history charts are automatically generated and displayed; patent claim scope interpretation/construction analysis mode, during which, patent claim scope interpretation charts are automatically generated and displayed; a Markman patent claim analysis mode, during which patent prosecution history based Markman claim charts are automatically generated and displayed; a hybrid-type patent claim scope/Markman analysis mode, during which hybrid patent prosecution history claim charts are automatically generated and displayed a prior/present art search analysis mode, during which prior art search vector specifications are generated as system output; a patent claim invalidity contention analysis mode, during which patent prosecution history based claim contention charts are automatically generated and displayed; a patent claim infringement analysis mode, during which patent prosecution history based claim infringement charts are automatically generated and displayed; freedom to operate (FTO) analysis mode, during which patent prosecution history based freedom-to-operate (FTO) charts are automatically generated and displayed; and a patent litigation-storyboard analysis mode, during which patent prosecution history based patent litigation-storyboard charts are automatically generated and displayed.

Another object is to provide an Internet-based (i.e. cloud-based) patent analysis and charting system designed for use by millions of people around the world to better understand and charting the scope and boundaries of patent protection afforded to patent claims.

Another object of the present invention is to provide a novel method of and system designed for automatically generating rational patent claim invalidity contentions, based on different classes of prior art references, for use in various applications.

Another object of the present invention is to provide a novel method of and system designed for automatically generating patent claim invalidity contention reports for use in various applications, including patent insurance policy and risk mitigation systems employed to underwrite and manage patent infringement defense and liability insurance policies in diverse marketplaces.

Another object of the present invention is to provide a novel patent insurance policy and risk mitigation system, employing patent prosecution history based prior art search methods, and automated patent claim invalidity contention generation methods, that enable an unprecedented level of risk mitigation to patent insurance policy underwriters and policy holders by virtue of new and improved capacities to efficiently and economically create and advance patent invalidity contentions against the improper assertion of patent claims in marketplace.

Another object of the present invention is to provide a method of procuring a patent insurance policy with a patent invalidity contention analysis (PICA) provision, over a patent insurance and risk mitigation network supported by an internet-based patent claim invalidity contention analysis (PICA) generation, charting and reporting system to assist in the mitigation of risks and costs associated with providing patent insurance coverage.

Another object of the present invention patent insurance and risk mitigation network for procuring and administering patent insurance policies between insured parties and patent insurance underwriters, containing patent invalidity contention analysis (PICA) provisions, supported by an internet-based patent claim invalidity contention analysis (PICA) generation, charting and reporting system to assist in the mitigation of risks and costs associated with providing patent insurance coverage.

Another object of the present invention is to provide a novel prior art patent searching system, supporting advanced methods having the capacity to (i) generate patent prosecution history (PPH) based or claim scope concept (CSC) based search vectors for use in searching for and discovering prior art disclosure information located anywhere along the WWW as well as patent and technical databases, and related to the subject matter of the claim limitation language strings (CLLS) of a set of patent claims under investigation, (ii) conduct prior art searches based on such search vectors, and (iii) generate search reports based on such search efforts with the prior art search resulting being indexed or tagged by the CSC-based search vectors used to conduct the prior art patent search.

Another object of the present invention is to provide a novel prior art patent searching system, supporting advanced methods having the capacity to (i) generate patent prosecution history (PPH) based or claim scope concept (CSC) based search vectors for use in searching for and discovering news and present art information on companies, products, services and people, located anywhere along the WWW as well as patent and technical databases, and being related to the subject matter of the claim limitation language strings (CLLS) of a set of patent claims under investigation, and (ii) conduct searches based on such search vectors, and (iii) generate search reports based on such search efforts with the search results being indexed or tagged by the CSC-based search vectors used to conduct the search.

Another object of the present invention is to provide a new and improved method of and system for presenting, analyzing, searching and examining patent claims in a national patent office, and documenting the same during the patent prosecution history, so as to provide greater transparency and more accurate patent claim scope resolution in the interests of inventors, patent owners and the general public alike.

Another object of the present invention is to provide a patent claim examination and prior art management system supporting automated claim patentability analysis charting processes, for use by examiners when examining the claims in a pending utility patent application.

Another object of the present invention is to provide an improved system and process for examining patent claims in a patent office, employing computer-assisted scope concept analysis of both pending patent claims and prior art references, and automated methods for generating rational patent claim patentability analyses, charts and reports, to better serve the public interest.

Another object of the present invention is to provide an improved patent claim examination system and process involving the deployment of a patent claim examination and prior art management system employing scope concept analysis of patent claims and prior art references and computer-assisted claim patentability analysis and documentation processes.

An object of the present invention is to provide a novel Claim Scope Concept Markup Language (CSCML) and a machine-implemented document processing method called Claim Scope Concept Processing (CSCP) which, when working together, enables unprecedented levels of computer-assisted patent claim analysis and charting—designed to assist patent attorneys in making more informed decisions and judgments about the scope and boundaries of patent claims before filing, during prosecution, and after grant.

An object of the present invention is to provide a Claim Scope Concept Markup Language that is designed to (i) help users quickly identify and capture claim limitations in patent claims, and inventive features encompassed by the language of the claim limitations and/or sub-limitations of the patent claims, (ii) convert ordinary text-based patent claim language into CSCML-based patent claim language, or any ordinary text-based patent claim into a CSCML-based patent claim, and (iii) be practiced by a trained human user using a CSCML editor program running on any client or server computer system.

An object of the present invention is to provide a machine-implemented Claim Scope Concept Processing (CSCP) algorithm designed to process the CSCML-based patent claims and generates various scope concept based data structures that are used throughout the various legal processes currently found in patent law environments.

An object of the present invention is to provide a novel computer-implemented system supporting a Claim Scope Concept Markup Language (CSCML) and a machine-implemented document processing algorithm called Claim Scope Concept Processing (CSCP) Applications, for use in legal process applications including, but not limited to, claim patentability analysis, patent claim invalidity contention analysis, scope-concept based search vector generation, patent claim infringement analysis, and patent claim scope interpretation/construction analysis.

An object of the present invention is to provide a method of marking-up each claim limitation or sub-limitation language string (CLLS) in a patent claim to create a Claim Scope Concept Structure (CSCS) for each marked-up claim limitation or sub-limitation language string (CLLS) in a patent claim, for use in Claim Scope Concept (CSC) based processes of the present invention.

An object of the present invention is to provide a novel set of components for marking up a patent claim and its claim limitation or sub-limitation language strings, expressed in a set of patent claims, and using the XML language to generate XML-based Claim Scope Concept Structures (CSCS) in accordance with the principles of the present invention

An object of the present invention is to provide CSC-based prior art reference analysis and ranking method, wherein prior art references are automatically ranked by priority of Claim Scope Concepts Structures (CSC), and thereafter, the analysis or review of a set of prior art references is performed by human workers in an order of priority based on the CSCS-based ranking of the prior art references, thereby minimizing prior art reference analysis costs while optimizing analysis results.

An object of the present invention is to provide a novel method of indexing or tagging patent claims and prior art references using CSC-based search vectors, functioning as CSC-based prior art reference tags.

An object of the present invention is to provide a novel computer-implemented method of performing cumulative prior art reference analysis, and generating reports based on such analysis, designed for use when submitting information disclosure statements (IDSs), as well as performing claim patentability analysis, claim invalidity analysis, and other forms of claim-based analysis.

An object of the present invention is to provide a novel computer-implemented method of and system for automated prior art reference searching, prior art reference analysis, claim patentability analysis, and cumulative prior art reference analysis, identification and reporting to provide improved levels of compliance with Rule 56 obligations of duty of candor and good faith to the Patent Office.

An even further object of the present invention is a novel computer-implemented system and computer-implemented method of claim analysis, charting and claim scope visualization designed to assist in better understanding the scope and boundaries of patent protection that can be properly afforded by patent claims in view of a represented state of knowledge in the art at the time of invention or patent application filing.

Another object of the present invention is to provide an Internet-based patent analysis and charting system supporting an open-public claim patentability analysis (OPCPA) module which is accessible on the WWW, and allow members of the public, working alone or together, to review the file history of and patent claims in any published patent application prior to grant, and generate automated rational claim patentability analysis charts for disclosure in the published patent application and review and consideration by the patent examiner during the patent examination process.

Another object of the present invention is to provide such an Internet-based patent analysis and charting system, wherein members of the public, working alone or together, can easily access the Web-based open-public claim patentability analysis (OPCPA) module using a Web-enabled client, and perform the following functions: (i) identify any specific published patent application for public claim review and analysis prior to patent grant; (ii) create a public patent claim review (PPCR) account on the system accessible through the web-based OPCPA module; (iii) load the file history and prior art references of the specified patent in system database, and link the same to the PPCR account; (iv) scope-concept analyze the patent claims in the published patent application prior to grant; (v) generate claim scope concept (CSC) based prior art search vectors based on the scope concept analyzed patent claims; (vi) use the CSC-based prior art search vectors to search for new and non-cited prior art references relating to the subject matter of the patent claims in the published patent application; (vii) add to the PPCR account, new and non-cited prior art references for review and analysis using CSC-based prior art reference GUIs/schemas; (viii) select scope concept analyzed prior art references, including scope-concept analyzed prior art references cited by the Examiner or Applicant/Inventor, for use in automated rational claim patentability analysis by the system; and (ix) automated generation of claim patentability charts and reports based on the selected scope concept analyzed prior art references.

Another object of the present invention is to provide an Internet-based patent analysis and charting system supporting an open-public patent claim invalidity contention analysis (OPCICA) module which is accessible on the WWW, and allows members of the public, working alone or together, to review the file history of and allowed patent claims in any granted patent after grant, and generate automated rational claim invalidity contention analysis for disclosure in the granted patent and review and consideration by the patent examiner during a post grant review or reexamination proceeding.

Another object of the present invention is to provide such an Internet-based patent analysis and charting system, wherein members of the public, working alone or together, can easily access the Web-based open-public claim invalidity contention analysis (OPCICA) module using any Web-enabled client, and perform the following functions: (i) identify any specific granted patent for public claim review and analysis; (ii) create a public patent claim review (PPCR) account on the system accessible through the web-based OPCPA module; (iii) load the file history and prior art references of the specified patent in system database, and link the same to the PPCR account; (iv) scope-concept analyze the patent claims in the patent; (v) generate claim scope concept (CSC) based prior art search vectors based on the scope concept analyzed patent claims; (vi) use the CSC-based prior art search vectors to search for new and non-cited prior art references relating to the subject matter of the patent claims in the patent; (vii) add to the PPCR account, new and non-cited prior art references for review and analysis using CSC-based prior art reference GUIs/schemas; (viii) select scope concept analyzed prior art references, including scope-concept analyzed prior art references cited by the Examiner or Applicant/Inventor, for use in automated rational claim invalidity contention analysis by the system; and (ix) automated generation of claim invalidity contention analysis charts and reports based on the selected scope concept analyzed prior art references.

Another object of the present invention is to provide an internet-based patent analysis and charting system with an open-public claim patentability analysis (OPCPA) module and an open-public claim invalidity contention analysis (OPCICA) module, that are accessible and utilizable on the WWW by members of the public.

Another object of the present invention is to provide a patent analysis and charting system that has an automated XML-based document generation module that interacts with at least one patent analysis and charting module so that any user (e.g. Inventor/Applicant patent attorney, patent agent, patent examiner, judge, public advocate, engineer, scientist, et al) can simply and quickly generate a particular patent-related document (e.g. Request for Re-examination, Office Action With Argument for Non-Patentability, Response to Office Action with Argument for Patentability, Argument For Patent Claim Invalidity Contention, etc.) based on the output chart structures generated during patent analysis and charting operations supported on the multi-mode patent analysis and charting system.

Another object of the present invention is to provide a multi-mode patent analysis and charting system that has an automated XML-based document generation module that interacts with one or more of the patent analysis and charting modules supported by the system so that any user (e.g. Inventor/Applicant patent attorney, patent agent, patent examiner, judge, public advocate, engineer, scientist, et al) can simply and quickly generate a particular patent-related document (e.g. Request for Re-examination, Office Action With Argument for Non-Patentability, Response to Office Action with Argument for Patentability, Argument For Patent Claim Invalidity Contention, etc.) based on the output chart structures generated during patent analysis and charting operations supported on the multi-mode patent analysis and charting system.

Another object of the present invention is to provide such a multi-mode patent analysis and charting system, wherein its automated XML-based document generation module supports the automated generation of patent-related documents and automated synchronization of data content among XML-based target and source documents and the system database during the document generation process.

Another object of the present invention is to provide such a multi-mode patent analysis and charting system, wherein its automated XML-based document generation module allows a diverse class of system users to automatically generate “file-ready” or “near-file-ready” documents (e.g. legal filings, government agency office actions, legal memorandums, legal opinions and/or judicial orders etc.) containing natural-language arguments in support of particular positions, decisions or opinions on, including, but not limited to: (i) the invalidity of granted patent claims of improper scope in view of the state of the art in view of particular prior art references analyzed in generated claim invalidity contention charts; (ii) the patentability of pending patent claims in view of particular combination of prior art references analyzed in generated claim patentability charts; (iii) the non-patentability of pending patent claims in view of particular prior art references analyzed in generated claim patentability charts; (iv) the allowability/patentability of pending patent claims in view of particular prior art references analyzed in generated claim patentability charts or claim invalidity contention charts; (v) the infringement of granted patent claims in view patent claims and products/services analyzed in generated claim infringement analysis charts; (vi) the non-infringement of granted patent claims in view patent claims and products/services analyzed in generated claim infringement analysis charts; (vii) the freedom to operate (FTO) particular product and/or service designs around particular patent claims analyzed in FTO-based charts; etc.

One embodiment of the present invention can in one aspect be generally described as an advanced relational database and user interface system used for the evaluation, analysis and generation of specialized reports in any of a plurality of data analysis environments. The database and analysis system can be utilized for many purposes, but may be particularly applicable to the analysis of patent claims and more specifically claim construction, infringement, written description, invalidity and/or patentability. Despite the fact that most of the examples discussed herein focus on patent analysis, those of skill in the art will recognize that the techniques and systems in accordance with the invention are not limited to patent analysis but can be employed in any document or other data-source driven analysis project requiring the collating, comparison and contrasting of multiple information sources. Exemplary environments include crime investigation and case management, medical diagnostics and disease research, and scientific experimentation and exploration, among countless other examples.

The system allows for analysis, querying, report generation, data mining and visualization to be performed or crowd sourced (e.g., taking advantage of the inputs of multiple people) by potentially large numbers of system users, stored over time, edited, manipulated, searched, exported and readily accessed by those having appropriate access rights. Reports, visualization and differing data mining techniques can also be applied by users to manipulate, output and delve into the stored data in a variety of ways.

Different individuals or groups of individuals may be associated with differing levels of access rights, depending on the project. Users are preferably identified by user name and passwords, but additional security features such as IP address checks, security questions and even random verification codes presented to users through smart phone applications can be used to heighten security. In this manner, individuals—even third parties or strangers—can productively contribute to a project with varying access rights. This differentiation between various users facilitates orderly review, management and crowd-sourcing. In the context of patent analysis, third parties might be limited to simply the ability to submit prior art for review. Alternatively, lower level users might be able to enter analysis or perform more manipulation of the information in the system and use varying features of the system. Higher level users might have the ability to create and manage projects, construct, link and delink concepts, etc., and run experiments, generate reports or visualizations of the data, etc.

One important feature of a relational database structure and system according to the present invention is its ability to leverage or exploit informational overlap. In the context of an embodiment of patent analysis, many claims of a patent within a single patent, across a patent family or even across multiple patent families within a similar subject area utilize similar elements, language or ideas. The system of the present invention leverages this informational overlap to facilitate the analysis of potentially vast numbers of patent claims by linking in the relational database the informational overlap—for example overlapping claims, claim elements or limitations or even segments and fragments of claims. This overlapping information is referred to herein as “concepts”, “concept phrases”, “sub-concepts” or “bridging data.” Concepts themselves can be grouped together and organized to facilitate more efficient review of the information sources.

Once this linking of concepts has begun, information sources can be analyzed, entered into the system for comparison, contrasting, analysis and synthesis. The generation of concepts can also be an iterative process where additional concepts are created, sub-concepts are created or concepts themselves can be edited to evolve over time as the collective understanding of the project evolves.

Information sources can be evaluated by the users of the system and information relating to the information source as well as its relation to the concepts can be entered into the system. For example, in the context of patent analysis, an information source might be a plurality of descriptive documents, including prior art references in various forms such as transcripts, figures, brochures, working models and other embodiments. For documents, a user could upload a copy of the prior art reference to the system then enter its relevant bibliographical information (e.g. publication date, author, inventor, etc.) and status (e.g. confidential, public). Another user (or the same user) could then evaluate that item of prior art, matching disclosure from the prior art with the concepts or sub-concepts discussed above. Another user can review that evaluation, make edits, rank or grade the evaluators, etc.

As the evaluation of information sources is in progress, users may track progress of the evaluation of information sources and additionally generate reports and visualizations. Many different types of reports can be generated and many types of data visualization can be implemented.

As one, non-limiting example, a report in the context of a patent analysis project can take the form of invalidity contentions in accordance with the expectations and specific rules promulgated by, for instance, the Eastern District of Texas. As another, non-limiting example, data visualization in the context of patent analysis can take the form of a heat map depicting (using colors ranging from dark purple through white) the intensity or availability or prevalence of prior art disclosures of a certain concept, claim limitation or claim.

Further reporting and analysis or data mining can take the form of experiments. For example, again the context of a patent analysis, different versions of the same type of visualization or report can be run using different fundamental assumptions. For example, the priority date of the patent being analyzed can be artificially set to a particular date—for instance to test the impact of a pre-filing conception date. Alternatively, the experiment could, again in the context of patent analysis, generate reports using only a certain type of information source, in this instance only 102(b) references or only non-confidential references. Alternately, the experiment could test the impact of the removal or exclusion of a particular information source.

Another aspect of the invention is a performance tracking system coupled with an optional incentive or reward system to facilitate and promote the use of the cloud and crowd sourced aspects of the system. Many different levels of access to the system can be established by those who themselves have the highest levels of access. Access to different features of the system can be tailored on an individualized level or based upon certain domain names or based on certain IP addresses, etc. Incentives and reward structures can also be overlaid on these levels of access and likewise tailored in the same fashion. For example, if the system reveals particular prior art shortcomings for one or more concepts in a case, the concept(s) can be identified to third parties for prior art searching to locate the particular concept in a prior art reference whereby a third party is incentivized by money, prizes, fame or other rewards for identifying the missing concept(s) specified as completely lacking, not very well disclosed, or otherwise in need of improvement from the prior art perspective.

Variations of the system include linking cases or projects to expand collections of prior art across different technologies, by linking database elements (concepts, references or disclosures related to concepts for prior art). Other variations include differential access to portions of the system according to user attributes and access controls. User types can include outside counsel, in-house counsel, company representatives, law firm personnel such as assistants, paralegals, non-lawyer technology professions, outside consultants, experts, and third party outsourcing services.

A final aspect of the system is a billing system that charges certain users for access to the system based on a plurality of factors or schedules. For example, the system can bill a user organization on a per user basis or on a tiered user basis—such as an additional fee per every five users. The billing system may also preferably be tied into the performance, reward and incentive system.

This and many other features and advantages of the invention will be made apparent from the following detailed description that proceeds with reference to the accompanying Figures and in the Claims.

A portion of the disclosure of this patent document, in particular the figures, contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BRIEF DESCRIPTION OF THE DRAWINGS

For a more complete understanding of how to practice the Objects of the Present Invention, the following Detailed Description of the Illustrative Embodiments can be read in conjunction with the accompanying Drawings, wherein:

FIG. 1A is a graphical image of the title page of an exemplary US Patent Grant;

FIG. 1B is a graphical image of the claims issued in the exemplary US Patent Grant;

FIG. 1C is a graphical image of a computer-based directory of digital files associated with the exemplary US Patent Grant depicted in FIGS. 1A and 1B, including .tsv files and an image file wrapper subdirectory containing numerous pdf files comprising the complete prosecution (file wrapper) history of the exemplary US Patent Grant obtained from Google/USPTO;

FIG. 1D is a graphical image of the Index of Claims in the patent prosecution history of the exemplary US Patent Grant;

FIG. 2A is a table describing the primary challenge underlying the process of patent claim interpretation, which must be carried out by human beings in diverse environments involving all patent claims, whether granted, allowed or pending;

FIGS. 2B1 through 2B5 show graphical images of Web pages of the USPTO.gov site setting forth the principles and rules for claim interpretation under the US Patent Laws;

FIG. 3A is a schematic representation of a method of patent claim construction, involving the claims, claim construction rules and doctrines, intrinsic evidence, extrinsic evidence, proper claim interpretation, and initial interpretation of patent claims by a court;

FIG. 3B is a schematic representation of setting forth foundational principles involved when construing (i.e. constructing) the meaning of words in patent claims, and the scope of the patent claim itself, and when deviation from ordinary meaning of words should be allowed;

FIG. 4 is a table listing conventional patent file history analysis tools, and patent claim charting tools;

FIG. 5 is a schematic representation of the Internet-based (i.e. Cloud-based) multi-mode patent claim analysis and charting system of the present invention, showing the various system components, including data center comprising web servers, application servers and RDBMS servers, domestic and foreign patent database servers, USPTO electronic filing system (EFS) and related database servers, and patent term and standards based database servers and commercial Google patent database servers, configured and interfaced around the infrastructure of the Internet (i.e. the Cloud), and accessible by a plurality of Web-enabled client machines, including workstations, mobile tablet computers (e.g. iPad computers), and mobile smart-phones (e.g. iPhones, Android phones etc), each supporting an http client application;

FIG. 6A is a schematic representation of a first implementation of the server-based data (collection and processing) center supporting the Internet-based multi-mode patent claim analysis and charting system of the present invention, shown in FIG. 5;

FIG. 6B is a schematic representation of a second implementation of the server-based data (collection and processing) center supporting the Internet-based multi-mode patent claim analysis and charting system of the present invention, as shown in FIG. 5;

FIG. 7A is a schematic representation of a first implementation of a Web-enabled client machine employed in the Internet-based multi-mode patent claim analysis and charting system of the present invention, as shown in FIG. 5, supporting both online and off-line modes of system operation;

FIG. 7B is a schematic representation of a second implementation of a second Web-enabled client machine employed in the Internet-based multi-mode patent claim analysis and charting system of the present invention, as shown in FIG. 5, supporting only an online mode of system operation;

FIGS. 8A and 8B, taken together, set for a relational database model for the RDBMS server employed in the multi-mode patent analysis and charting system depicted in FIG. 5, showing various database tables that can be used when implementing the illustrative embodiments of the present invention;

FIG. 9 is a schematic representation of the object-oriented deployment platform used to deploy Internet-based multi-mode patent claim analysis and charting system of the present invention, over the Internet, for each granted patent and published patent application within any national, regional or international patent system (e.g. USPTO, EPO, or WIPO);

FIG. 10 is a schematic representation depicting the patent life-cycle in the USA, and the various phases where the Internet-based multi-mode patent claim analysis and charting system of the present invention can be used with great advantage and benefit in the US Patent System, in particular, as well as in any national, regional or international patent system, in general;

FIG. 11 is a schematic representation of a mode transition diagram illustrating the various modes of system operation supported by the multi-mode patent claim analysis and charting system of the present invention, and the various pathways for mode transition within the system;

FIG. 12 is a table specifying the different types of novel patent claim chart structures generated during each mode of the multi-mode patent claim analysis and charting system of the illustrative embodiment of the present invention;

FIG. 13 is a schematic diagram illustrating the information mapping process supported by the system during its patent claim prosecution analysis mode of system operation, wherein prosecution history data is mapped to particular data fields within the claim chart structures generated during this particular mode of system operation;

FIGS. 14A through 14G, taken together, set forth a flow chart describing the steps performed during the method of analyzing and charting the patent prosecution history of a pending patent application, using the multi-mode patent analysis and charting system of the present invention configured in its patent claim prosecution analysis mode of system operation;

FIG. 15 is a schematic representation illustrating the application of the multi-mode patent analysis and charting system configured in its patent claim prosecution analysis mode of system operation, during particular phases of the patent life-cycle time line, by the patent application owner and its competitors;

FIGS. 16A through 16O set forth a set of wireframe-type graphical user interfaces (GUIs) served up from the Web and other servers of the Internet-based multi-mode patent analysis and charting system, to one or more of its Internet-based client machines, during the structured workflow process supported by the system during its patent claim prosecution analysis mode of system operation;

FIG. 17 is a schematic representation describing the information mapping process used during the patent claim prosecution analysis mode of system operation, described in FIGS. 134A through 14G, and supporting the generation of the patent claim chart structure designed for this mode of system operation;

FIGS. 18A through 18C is a graphical representation of an XML-based spreadsheet-type chart structure generated by the multi-mode system of the present invention during its the patent claim prosecution analysis mode of system operation;

FIG. 19 is a schematic diagram illustrating the information mapping process supported by the system during its patent claim scope interpretation/construction analysis mode of system operation, wherein prosecution history data (including prior art reference data) is mapped to particular data fields within the claim chart structures generated during this particular mode of system operation;

FIGS. 20A through 20H, taken together, set forth a flow chart describing the steps performed during the method of analyzing and charting the patent prosecution history of a granted patent, using the multi-mode patent analysis and charting system of the present invention configured in its patent claim scope interpretation analysis mode of system operation;

FIG. 21 is a schematic representation illustrating the application of the multi-mode patent analysis and charting system configured in its patent claim scope interpretation analysis mode of system operation, during particular phases of the patent life-cycle time-time, by both the patent owner and its competitors;

FIGS. 22A through 22CC set forth a set of wireframe-type graphical user interfaces (GUIs) served up by the servers of the Internet-based multi-mode patent analysis and charting system, to one or more of its Internet-based client machines, during the structured workflow process supported by the system during its patent claim scope interpretation analysis mode of operation;

FIG. 23 is a schematic representation describing the scope concept mapping process used during the patent claim scope interpretation analysis mode of system operation, described in FIGS. 22A through 22CC, and supporting the automated generation of the patent claim chart structure designed for this mode of system operation;

FIG. 24 is a flow chart describing a method claim scope concept formulation, assignment and linkage that can be practiced within the multi-mode patent analysis and charting system of the present invention, during any of the patent claim, prosecution history, prior art reference, and product/service infringement and other mapping operations supported within the multi-mode system of the present invention;

FIG. 25A is a Claim Scope Concept Based Markup model for any patent claim expressed in natural language, and directed to a useful invention, setting forth the meets and boundaries (i.e. the scopes and limits) of patent protection to be afforded to the invention covered by the patent claim which is composed of a plurality of claim limitation language strings (CLLS), wherein during the markup process, (i) each claim limitation language string (CLLS) is assigned a claim limitation identifier or index (CLID), (ii) a Claim Scope Concept Phrase (CSCP) composed of a set of words (W1, . . . WN) describing the Scope Concept encompassed by the Claim Limitation Language String (CLLS), is assigned to the CLLS, and (iii) a Claim Scope Concept Structure Identifier (CSCSID) is assigned to the CLLS to identify the entire CSC data structure, in accordance with the principles of the present invention;

FIG. 25B and FIG. 25C, taken together, set forth a flow chart describing the operations carried out during a method of indexing (or marking up) the language of claim limitation and/or sub-limitations in each patent claim under analysis, with or otherwise using Claim Scope Concepts that are expressed as a set of the linguistic units such as words and/or phrases. used to define the same), practiced during many of the patent analysis modes supported within the multi-mode system of the present invention;

FIG. 26A is a schematic block representation of the subsystem architecture of the multi-mode system, supporting the scope concept/claim-limitation-language indexing process specified in FIGS. 25A and 25B;

FIG. 26B is a schematic representation of a set of Claim Scope Concept Profiles for a set of patent claims that have been scope concept analyzed using the method of scope concept formulation according to the principles of the present invention;

FIG. 26C is a schematic representation of (i.e. schema for) a Scope Concept Based Prior Art Reference Analysis Graphical User Interface (GUI) for use in scope concept analyzing prior art references, with respect to a selected set of patent claims;

FIG. 26D is a schematic representation of set of Prior Art Reference Scope Concept Profile documents (i.e. schemas for such documents) for a set of prior art references that have been scope concept analyzed using its corresponding Scope Concept Based Prior Art Reference GUI, schematically illustrated in FIG. 26C;

FIGS. 27A through 27F is a graphical representation of an XML-based claim scope schema (CSS) spreadsheet-type chart structure generated by the multi-mode system of the illustrative embodiment, during its the patent claim scope interpretation analysis mode of system operation;

FIG. 28 is a schematic diagram illustrating the patent claim term information mapping process supported by the system during its Markman patent claim term analysis mode of system operation, wherein patent claim data and court-specified claim term meaning definitions for common claim terms are linked together and mapped to particular data fields within the patent claim chart structures generated during this particular mode of system operation;

FIGS. 29A and 29E, taken together, set forth a flow chart describing the steps performed during the method of analyzing and charting the patent prosecution history of a granted patent involved in litigation, using the multi-mode patent analysis and charting system of the present invention configured in its Markman patent claim term analysis mode of system operation;

FIG. 30 is a schematic representation illustrating the application of the multi-mode patent analysis and charting system configured in its Markman patent claim term analysis mode of system operation, during particular phases of the patent life-cycle time line, by both the plaintiff/patent-owner and its defendants/competitors;

FIGS. 31A through 31N set forth a set of wireframe-type graphical user interfaces (GUIs) served up from the Web and other servers of the Internet-based multi-mode patent analysis and charting system, to one or more of its Internet-based client machines, during the structured workflow process supported by the system during its Markman patent claim term analysis mode of operation;

FIG. 32 is a schematic representation describing the claim term information mapping process used during the Markman patent claim term analysis mode of system operation, described in FIGS. 31A through 31N, and supporting the automated generation of the patent claim chart structures designed for this mode of system operation;

FIGS. 33A through 33E, taken together, set forth is a graphical representation of an XML-based spreadsheet-type claim scope schema (CSS) chart structure generated by the multi-mode system of the present invention during its the Markman patent claim term analysis mode of system operation;

FIG. 34 is a schematic diagram illustrating various information mapping processes supported by the system during its hybrid-type patent (claim scope interpretation/Markman claim term) analysis mode of system operation, wherein patent claim data and prosecution history data are scope concept mapped to particular data fields within the claim chart structures generated during this particular mode of system operation, while court-specified claim term meaning definitions for common claim terms are directly linked and mapped to particular fields within the claim chart structures generated during this particular mode of system operation;

FIGS. 35A through 35E, taken together, set forth a flow chart describing the steps performed during the method of analyzing and charting the patent prosecution history of the granted patent, using the multi-mode patent analysis and charting system of the present invention configured in its hybrid-type patent claim analysis mode of system operation;

FIG. 36 is a schematic representation illustrating the application of the multi-mode patent analysis and charting system configured in its hybrid-type patent claim analysis mode of system operation, during particular phases of the patent life-cycle, by the plaintiff/patent-owner and its defendant/competitors;

FIGS. 37A through 37CC set forth a set of wireframe-type graphical user interfaces (GUIs) served up by the servers of the Internet-based multi-mode patent analysis and charting system, to one or more of its Internet-based client machines, during the structured workflow process supported by the system during its hybrid-type patent claim analysis mode of operation;

FIG. 38 is a schematic representation describing the various information mapping processes used during the hybrid-type patent analysis mode of system operation, described in FIGS. 35A through 35N, and supporting the automated generation of the patent claim chart structure designed for this mode of system operation;

FIGS. 39A through 39G, taken together set forth a graphical representation of an XML-based spreadsheet-type claim scope schema (CSS) chart structure generated by the multi-mode system of the present invention during its the hybrid-type patent claim analysis mode of system operation;

FIG. 40 is a schematic diagram illustrating the various information mapping processes supported by the system during its prior/present art search analysis mode of system operation, wherein patent claim data and prosecution history data are scope concept mapped to particular data fields within the search vectors produced during this particular mode of system operation, while common claim terms (in the case of granted patents involved in litigation) and court-specified claim term meaning definitions are directly mapped to particular data fields within the search vectors produced during this particular mode of system operation;

FIGS. 41A through 41D, taken together, set forth a flow chart describing the steps performed during the method of analyzing and charting the patent prosecution history of a granted patent or published patent application, using the multi-mode patent analysis and charting system of the present invention configured in its prior/present art search analysis mode of system operation;

FIG. 42 is a schematic representation illustrating the application of the multi-mode patent analysis and charting system of the present invention, configured in its prior/present art search analysis mode of system operation, during particular phases of the patent life-cycle time line, by both the patent (or patent application) owner and its competitors;

FIGS. 43A through 43DD set forth a set of wireframe-type graphical user interfaces (GUIs) served up by the servers of the Internet-based multi-mode patent analysis and charting system, to one or more of its Internet-based client machines, during the structured workflow process supported by the system during its prior/present art search analysis mode of operation;

FIG. 44 is a schematic representation describing the various information mapping processes used during the prior/present art search analysis mode of system operation, described in FIGS. 43A through 43EE, and supporting the automated generation of the patent claim chart structure designed for this mode of system operation;

FIGS. 45A through 45G, taken together, set forth a graphical representation of an XML-based spreadsheet-type claim scope schema (CSS) chart structure generated by the multi-mode system of the present invention during its the prior/present art search analysis mode of system operation;

FIG. 46 is a schematic diagram illustrating the various information mapping processes supported by the system during its patent claim invalidity contention analysis mode of system operation, wherein patent claim data and prosecution history data are scope concept mapped to particular data fields within the claim chart structures generated during this particular mode of system operation, while patent claim terms and court-based term meanings linked thereto are mapped to other data fields within the claim chart structures (i.e. when a patent grant is involved in patent litigation and a Markman hearing has been scheduled between the parties);

FIGS. 47A through 47E, taken together, set forth a flow chart describing the steps performed during the method of analyzing and charting the patent prosecution history of a granted patent, using the multi-mode patent analysis and charting system of the present invention configured in its patent claim invalidity contention analysis mode of system operation;

FIG. 48 is a schematic representation illustrating the application of the multi-mode patent analysis and charting system configured in its patent claim invalidity contention mode of system operation, during particular phases of the patent life-cycle time line, by both the patent (or patent application) owner and its competitors;

FIGS. 49A through 49KK, taken together, set forth a set of wireframe-type graphical user interfaces (GUIs) served up from the Web and others servers of the Internet-based multi-mode patent analysis and charting system, to one or more of its Internet-based client machines, during the structured workflow process supported by the system during its patent claim invalidity contention analysis mode of system operation;

FIG. 50A is a schematic representation describing the various information mapping processes used during the patent claim invalidity contention analysis mode of system operation, described in FIGS. 48AA through 49KK, and supporting the generation of the patent claim chart structures designed for this mode of system operation;

FIG. 50B is schematic block diagram illustrating the system architecture of the present invention, for automatically generating sets of rational patent claim invalidity contentions based on sets of prior art references and a set of patent claims under contention analysis, and also generating summary patent invalidity contention analysis reports relating thereto in accordance with the principles of the present invention;

FIG. 50C is a schematic representation of (i.e. schema for) a set of Claim Scope Concept Profile documents for the set of patent claims that are the subject of a patent claim invalidity contention analysis;

FIG. 50D is a schematic representation of (i.e. schema for) a Scope Concept Based Prior Art Reference Analysis GUI for scope concept analyzing a set of prior art references in view of a specific set of patent claims under patent claim invalidity contention analysis;

FIG. 50E is a schematic representation of (i.e. schema for) a set of Prior Art Reference Scope Concept Profile documents or records, for the set of prior art references that have been scope concept analyzed during patent claim invalidity contention analysis using the Scope Concept Based Prior Art Reference Analysis GUI shown in FIG. 50D;

FIGS. 50F through 50L, taken together, set forth a flow chart describing the steps involved when carrying out the automated method of rationally generating patent claim invalidity contention analysis reports and patent claim invalidity contention charts, using an automatic patent claim invalidity contention analysis generation module supported within the patent analysis and charting system of the present invention;

FIG. 50M is a processing stage, within the multi-mode patent analysis and charting system of the present invention configured in its patent claim invalidity contention analysis mode, involving the claim scope concept list for the (n=1)th patent claim in the prior art reference scope concept profile that has been generated for the (m=1)th analyzed prior art reference being considered as a primary prior art reference (PPAR).

FIG. 50N is a schematic representation of a processing stage, within the multi-mode patent analysis and charting system of the present invention configured in its patent claim invalidity contention analysis mode, involving the claim scope concept list for the (n=N)th patent claim in the prior art reference scope concept profile for the (m=1)th analyzed prior art reference being considered as a primary prior art reference (PPAR);

FIG. 50O is a schematic representation of a processing stage, within the multi-mode patent analysis and charting system of the present invention configured in its patent claim invalidity contention analysis mode, involving the claim scope concept list for the (n=1)th patent claim in the prior art reference scope concept profile that has been generated for the (m=2)th analyzed prior art reference being considered as a primary prior art reference (PPAR);

FIG. 50P is a schematic representation of a processing stage, within the multi-mode patent analysis and charting system of the present invention configured in its patent claim invalidity contention analysis mode, involving the claim scope concept list for the (n=N)th patent claim in the prior art reference scope concept profile that has been generated for the (m=2)th analyzed prior art reference being considered as a primary prior art reference (PPAR);

FIG. 50Q is a schematic representation of a processing stage, within the multi-mode patent analysis and charting system of the present invention configured in its patent claim invalidity contention analysis mode, involving the claim scope concept list for the (n=1)th patent claim in the prior art reference scope concept profile for the (m=M)th analyzed prior art reference being considered as a primary prior art reference (PPAR);

FIG. 50R is a schematic representation of a processing stage, within the multi-mode patent analysis and charting system of the present invention configured in its patent claim invalidity contention analysis mode, involving the claim scope concept list for the (n=N)th patent claim in the prior art reference scope concept profile that has been generated for the (m=M)th analyzed prior art reference being considered as a primary prior art reference (PPAR);

FIG. 50S is a graphical representation of a sample patent claim invalidity contention report generated by the multi-mode system of the present invention while configured in its patent claim invalidity contention analysis mode of system operation;

FIGS. 51A through 51H, taken together, set forth a graphical representation of an XML-based spreadsheet-type claim scope schema (CSS) chart structure generated by the multi-mode system of the present invention during its patent claim invalidity contention analysis mode of system operation;

FIG. 52 is a schematic diagram illustrating the various information mapping processes supported by the system during its patent claim infringement analysis mode of system operation, wherein patent claim data, prosecution history data, court-specified claim term meaning definitions for common claim terms, and product and/or service data relating to products and/or services under investigation, are mapped to particular data fields within the claim chart structures generated during this particular mode of system operation;

FIGS. 53A through 53E, taken together, set forth a flow chart describing the steps performed during the method of analyzing and charting the patent prosecution history of at least one granted patent, using the multi-mode patent analysis and charting system of the present invention configured in its patent claim infringement analysis mode of system operation;

FIG. 54 is a schematic representation illustrating the application of the multi-mode patent analysis and charting system configured in its patent claim infringement analysis mode of system operation, along particular phases of the patent life-cycle time line, by both the patent owner and its competitors;

FIGS. 55A through 55DD set forth a set of wireframe-type graphical user interfaces (GUIs) served up by the servers of the Internet-based multi-mode patent analysis and charting system, to one or more of its Internet-based client machines, during the structured workflow process supported by the system during its patent claim infringement analysis mode of operation;

FIG. 56 is a schematic representation describing the various information mapping processes used during the patent claim infringement analysis mode of system operation, described in FIGS. 55A through 55DD, and supporting the generation of the patent claim chart structure designed for this mode of system operation;

FIGS. 57A through 57H, taken together, set forth a graphical representation of an XML-based spreadsheet-type claim scope schema (CSS) chart structure generated by the multi-mode system of the present invention during its the patent claim infringement analysis mode of system operation;

FIG. 58 is a schematic diagram illustrating the information mapping process supported by the system during its freedom to operate (FTO) analysis mode of system operation, wherein patent claim data and product and/or service data relating to products and/or services under FTO investigation, are mapped to particular data fields within the claim chart structures generated during this particular mode of system operation;

FIGS. 59A through 59F, taken together, set forth a flow chart describing the steps performed during the method of analyzing and charting the patent prosecution history of one or more published patent applications and/or granted patents in a group of patents/applications, using the multi-mode patent analysis and charting system of the present invention configured in its FTO analysis mode of system operation;

FIG. 60 is a schematic representation illustrating the application of the multi-mode patent analysis and charting system configured in its freedom-to-operate (FTO) mode of system operation, along particular phases of the patent life-cycle time line, by both the patent owner and its competitors;

FIGS. 61A through 61S set forth a set of wireframe-type graphical user interfaces (GUIs) served up from the Web and other servers of the Internet-based multi-mode patent analysis and charting system, to one or more of its Internet-based client machines, during the structured workflow process supported by the system during its FTO analysis mode of operation;

FIG. 62 is a schematic representation describing the information mapping process used during the FTO analysis mode of system operation, described in FIGS. 59A through 59F, and supporting the automated generation of the patent claim chart structures of FIGS. 64A through 64I, designed for this mode of system operation and supporting data entry by technical personnel having knowledge about the products and/or services listed in the XML-based spreadsheet FTO chart structures of the present invention;

FIGS. 63A and 63B, taken together, set forth a flow chart describing the steps performed by the scope concept formation method carried out during the FTO mode of the multi-mode patent analysis and charting system, involving the linking of scope concepts to language in the claims of published patent applications and/or granted patents in a group of patents/applications, according to the principles of the present invention, and determining whether or not one or more products and/or services under investigation use the formulated scope concepts embraced by the group of patents/applications;

FIGS. 64A through 64I is a graphical representation of an XML-based spreadsheet-type claim scope schema (CSS) chart structure generated by the multi-mode system of the present invention during its FTO analysis mode of system operation;

FIG. 65 is a schematic diagram illustrating the various information mapping processes supported by the system during its patent litigation-storyboard analysis mode of system operation, wherein patent claim data, prosecution history data, court-specified claim term meaning definitions for common claim terms, product and/or service data relating to products and/or services involved in litigation, as well as plaintiff-produced evidence and defendant-produced evidence, are mapped to particular data fields within the claim chart structures generated during this particular mode of system operation;

FIGS. 66A through 66F, taken together, set forth a flow chart describing the steps performed during the method of analyzing and charting the patent prosecution history of one or more granted patents, using the multi-mode patent analysis and charting system of the present invention configured in its patent litigation-storyboard analysis mode of system operation;

FIG. 67 is a schematic representation illustrating the application of the multi-mode patent analysis and charting system configured in its patent litigation-storyboard mode of system operation, along particular phases of the patent life-cycle time line, by both the plaintiff (i.e. patent owner) and its defendants/competitors;

FIGS. 68A through 68DD set forth a set of wireframe-type graphical user interfaces (GUIs) served up by the servers of the Internet-based multi-mode patent analysis and charting system, to one or more of its Internet-based client machines, during the structured (i.e. guided) workflow process supported by the system during its patent litigation-storyboard analysis mode of operation;

FIG. 69 is a schematic representation describing the information mapping process used during the FTO analysis mode of system operation, described in FIGS. 65A through 67CC, and supporting the generation of the patent claim chart structure designed for this mode of system operation; and

FIGS. 70A through 70I, taken together, set forth a graphical representation of an XML-based spreadsheet-type claim scope schema (CSS) chart structure generated by the multi-mode system of the present invention during its patent litigation-storyboard analysis mode of system operation;

FIGS. 71A and 71B set forth a set of wireframe-type graphical user interfaces (GUIs) served up from the Web and other servers of the Internet-based multi-mode patent analysis and charting system, to one or more of its Internet-based client machines, during the un-structured (i.e. un-guided or less-guided) workflow process supported by the system during its patent claim scope interpretation analysis mode and its patent claim invalidity contention analysis mode of system operation, respectively;

FIG. 72 is a schematic system diagram of the Internet-based patent insurance policy and risk mitigation network of the present invention, for procuring and administering patent insurance policies containing patent invalidity contention analysis (PICA) provisions, supported by an internet-based patent claim invalidity contention analysis (PICA) generation, charting and reporting system;

FIG. 73 is a schematic representation illustrating the process of procurement, underwriting and administration of patent insurance policies containing patent invalidity contention analysis (PICA) service provisions, using the Internet-based patent insurance policy and risk mitigation network of the present invention, illustrated in FIG. 72;

FIGS. 74A through 74E, taken together, set forth a flow chart describing the steps carried out within the network-centric process of ordering, underwriting and administering patent insurance policies containing PICA service provisions, using the Internet-based multi-mode patent analysis and charting system of the present invention, for generating PICA contentions and reports against patent claims cited in notice of infringement/infringing events;

FIG. 75 is a schematic representation of a sample PICA Service Report generated by the Internet-based PICA generation, charting and reporting system of the present invention;

FIG. 76 is a schematic representation of the Internet-based (i.e. cloud-based) the patent application searching, filing, prior art disclosure, and claim examination system of the present invention supporting automated claim patentability analysis and charting, and report generation, showing the various system components, including data center comprising web servers, application servers and RDBMS servers, domestic and foreign patent database servers, USPTO electronic filing system (EFS) and related database servers and commercial Google patent database servers, configured and interfaced around the infrastructure of the Internet (i.e. “the Cloud”), and accessible by a plurality of Web-enabled client machines, including workstations, mobile tablet computers (e.g. iPad computers), and mobile smart-phones (e.g. iPhones, Android phones etc), each supporting an http client application;

FIG. 77 is a schematic representation of a first implementation of the server-based data (collection and processing) center supporting the Internet-based system of the present invention shown in FIG. 76;

FIG. 78 is a schematic representation of a second implementation of the server-based data (collection and processing) center supporting the Internet—system of the present invention as shown in FIG. 76;

FIG. 79A is a schematic representation of a first implementation of a Web-enabled client machine employed in the Internet-based system of the present invention as shown in FIG. 76 supporting both online and off-line modes of system operation;

FIG. 79B is a schematic representation of a second implementation of a second Web-enabled client machine employed in the Internet-based system of the present invention, as shown in FIG. 76 supporting only an online mode of system operation;

FIGS. 80A and 80B, taken together, set forth a relational database model for the RDBMS server employed in the Internet-based (i.e. cloud-based) the patent application filing, prior art disclosure, and claim examination system depicted in FIG. 76 showing various database tables that can be used when implementing the illustrative embodiments of the present invention;

FIGS. 81A through 81I, taken together, set forth a flow chart describing the various steps that may be carried out when practicing the illustrative embodiment of the method of the present invention, involving claim scope concept (CSC) based claim patentability analysis that can be easily practiced before filing patent claims in the patent office, during examination of the patent claims, and throughout the claim prosecution process, in accordance with the principles of the present invention;

FIG. 82 is a schematic representation illustrating the application of the Internet-based system of FIG. 76, during particular phases of the patent life-cycle time line, by Applicant/Owners, patent attorneys and agents, and patent examiners alike;

FIGS. 83A through 83DD set forth a set of wireframe-type graphical user interfaces (GUIs) served up from the Web and other servers of the Internet-based system of FIG. 76, to one or more of its Internet-based client machines, during the workflow process supported by the system during the patent claim prosecution process in the patent office;

FIG. 84 is a schematic representation describing the claim scope concept (CSC) based information mapping process used during claim patentability analysis, by both the Applicant/Owner and patent examiner, within the system of the present invention;

FIG. 85 is schematic block diagram illustrating the system architecture of the present invention, for automatically generating sets of rational claim patentability analyses and chart structures based on sets of prior art references and a set of patent claims under analysis, and summary reports relating thereto, in accordance with the principles of the present invention;

FIG. 86 is a schematic representation of a set of Claim Scope Concept Profiles for a set of patent claims that are the subject of a claim patentability analysis in accordance with the principles of the present invention;

FIG. 87 is a schematic representation of (i.e. schema for) Scope Concept Based Prior Art Reference Analysis GUI for scope concept analyzing a set of prior art references in view of a specific set of patent claims under patentability analysis;

FIG. 88 is a schematic representation of (i.e. schema for) a set of Prior Art Reference Scope Concept Profile documents for the set of prior art references that have been scope concept analyzed during claim patentability analysis using the scope concept based prior art reference analysis GUI shown in FIG. 87;

FIGS. 89A through 89G, taken together, set forth a flow chart describing the steps involved when carrying out the automated method of rationally generating claim patentability analyses and patent claim patentability analysis charts, using an automatic patent claim patentability analysis generation module supported within the Internet-based system of the present invention shown in FIG. 76;

FIG. 90A is a processing stage, within the system of FIG. 76, involving the claim scope concept list for the (n=1)th patent claim in the Prior Art Reference Scope Concept Profile that has been generated for the (m=1)th analyzed prior art reference being considered as a primary prior art reference (PPAR).

FIG. 90B is a schematic representation of a processing stage, within the system of FIG. 77, involving the claim scope concept list for the (n=N)th patent claim in the Prior Art Reference Scope Concept Profile for the (m=1)th analyzed prior art reference being considered as a primary prior art reference (PPAR);

FIG. 90C is a schematic representation of a processing stage, within the system of FIG. 76, involving the claim scope concept list for the (n=1)th patent claim in the Prior Art Reference Scope Concept Profile that has been generated for the (m=2)th analyzed prior art reference being considered as a primary prior art reference (PPAR);

FIG. 90D is a schematic representation of a processing stage, within the system of FIG. 76, involving the claim scope concept list for the (n=N)th patent claim in the Prior Art Reference Scope Concept Profile that has been generated for the (m=2)th analyzed prior art reference being considered as a primary prior art reference (PPAR);

FIG. 90E is a schematic representation of a processing stage, within the system of FIG. 76, involving the claim scope concept list for the (n=1)th patent claim in the Prior Art Reference Scope Concept Profile for the (m=M)th analyzed prior art reference being considered as a primary prior art reference (PPAR);

FIG. 90F is a schematic representation of a processing stage, within the system of FIG. 76, involving the claim scope concept list for the (n=N)th patent claim in the Prior Art Reference Scope Concept Profile that has been generated for the (m=M)th analyzed prior art reference being considered as a primary prior art reference (PPAR);

FIG. 91 shows a graphical representation of a sample claim patentability analysis report generated by the system of the present invention shown in FIG. 76, while configured in its patent claim patentability analysis mode of system operation; and

FIGS. 92A through 92B, taken together, set forth a graphical representation of a spreadsheet-based claim patentability analysis chart structure automatically generated by the system of FIG. 76 during automated claim patentability analysis.

FIG. 93 is a schematic representation of a Claim Scope Concept Based Markup Language (CSCML) model of any patent claim expressed in natural language, and directed to a useful invention, setting forth the meets and boundaries (i.e. the scopes and limits) of patent protection to be afforded to the invention covered by the patent claim which is composed of a plurality of claim limitation language strings (CLLS), wherein during the markup process, each claim limitation language string (CLLS) is assigned (i) a claim limitation identifier (CLID), an inventive feature phrase (IFP) composed of a set of words (W1, . . . WN) describing at least one Inventive Feature Phrase (IFP) encompassed by the Claim Limitation Language String (CLLS), and a Claim Scope Concept Structure Identifier (CSCSID), identifying the entire CSC data structure, in accordance with the principles of the present invention;

FIG. 94 is a schematic block diagram illustrating a system architecture that can be implemented in the system of FIG. 5, 72, 76 or any other system or network, for the purpose of supporting an automated (i.e. computer-assisted) method of prior art searching, claim patentability analysis (PARSCPA) and cumulative prior art reference analysis, employing the CCSCML model of FIG. 93, in accordance with the principles of the present invention;

FIG. 95A through 95C, taken together, set forth the steps of an illustrative embodiment of the automated prior art searching and claim patentability analysis (PARSCPA) method of the present invention, using the system architecture shown in FIG. 94;

FIG. 96 is a schematic representation illustrating the marking-up of each Claim Limitation Or Sub-Limitation Language String (CLLS) in any utility patent claim, as illustrated in the CSCSML Model of FIG. 93, to create a Claim Scope Concept Structure (CSCS) for each marked-up claim limitation or sub-limitation language string (CLLS) in the Claim;

FIG. 97 is a schematic representation illustrating the generation of a CSC-based Search Vector (CSC-SV) from the data and meta-data contained in the Claim Scope Concept Structure (CSCS) of each Claim Limitation Language String (CLLS) of a Claim being marked-up using the CSCSML of the present invention;

FIG. 98 is a schematic representation illustrating the use of the set of generated CSC-based Search Vectors to search for and find a set of Prior Art References {PAR} containing prior art disclosure (e.g. searchable text and searchable graphics and/or images) discovered by the CSC-Based Search Vectors, and generating a set of Prior Art Search Records {PASR} for the retrieved Prior Art References (PAR);

FIG. 99 is a schematic representation illustrating the analyzing the Prior Art Reference Record (PARR) generated for each retrieved Prior Art Reference (PAR) discovered by the CSC-based Search Vectors, using the Claim Scope Concept (CSC) based Prior Art Reference Analysis Schema (or GUI), and the mapping of relevant prior art disclosure (discovered by the CSC-based Search Vectors) into corresponding CSC-indexed data fields in the Claim Scope Concept (CSC) based Prior Art Reference Analysis Schema (or GUI);

FIG. 100 is a schematic representation illustrating the optional organizing of the Claim Scope Concept Structures (CSCS) in the Claim Scope Concept (CSC-based) based prior art reference analysis schema, by grouping CSC structures having the same or similar Inventive Feature Phrases (IFP), or at least a predetermined number of common IFP words, wherein the effort to combine CSCS records in the schema would be helpful if and when prior art reference documents are to be manually analyzed or reviewed by human subject matter experts and there as many CSCS records produced in the Prior Art Reference Analysis Schema as there are Claim Limitation Language Strings (CLLS) parsed out and analyzed in each patent Claim;

FIG. 101 is a schematic representation illustrating the programmatic transformation of a set of Claim Scope Concept (CSC) Based Prior Art Reference Analysis (GUI) documents generated for the set of analyzed prior art references retrieved during the search, into a set of Prior Art Reference Claim Scope Concept (CSC) Profile documents for the set of analyzed prior art references retrieved during the search;

FIG. 102 is a schematic representation illustrating the automatic (i.e. programmatic) processing of a set of Prior Art Reference Claim Scope Concept (CSC) Profile documents generated for the analyzed retrieved set of Prior Art References so as to a set of generate a set of claim patentability analyses based on the analyzed retrieved references, and then generate claim patentability analysis charts based on the analyses, according to the present invention;

FIG. 103 is a schematic representation illustrating a method of marking-up each Claim Limitation Or Sub-Limitation Language String (CLLS) in a patent claim to create a Claim Scope Concept Structure (CSCS) for the marked-up claim limitation or sub-limitation language string (CLLS), for use in claim scope concept (CSC) based processes of the present invention;

FIG. 104 is a schematic representation illustrating the schema components used to mark up a patent claim and its claim limitation or sub-limitation language (CLLS), in a set of patent claims using, for example, the xml language, and generating an XML-based Claim Scope Concept Structure (CSCS) in accordance with the principles of the present invention;

FIG. 105 is a schematic representation of (i.e. schema for) a Claim Scope Concept Structure (CSCS) document or record generated for a parsed claim limitation or sub-limitation language string (CLLS) in any patent claim in any patent grant or patent application, wherein, consistent with the CSCML process of FIG. 93, the CSCS schema comprises (i) actual marked-up data associated with a Claim Limitation Or Sub-Limitation Language String (CLLS), (ii) meta-data associated with a Claim Limitation Identifier (CLID) assigned and linked to the parsed Claim Limitation Language String (CLLS), (iii) meta-data associated with a Claim Scope Concept Structure (CSCS) identifier linked to the Claim Limitation Identifier, including a Claim Scope Concept (CSC) Number, and (iv) an Inventive Feature Phrase (IFP={W−1, . . . W−M}) linked to the Claim Limitation Identifier, and assigned by the user, wherein the IFP may contain dominant meta-language encompassing the Claim Limitation Or Sub-Limitation Language String (CLLS);

FIG. 106 is a schematic representation of (i.e. schema for) a set of Claim Scope Concept (CSC) Profiles, generated for a set of Claims that are the subject of claim patentability analysis in accordance with the principles of the present invention;

FIG. 107 is a schematic representation of (i.e. schema for) a Claim Scope Concept (CSC) Based Search Vector (CSC-SV) profile, organized by Patent Claim Number, and generated for each patent claim under search analysis, and identifying the set of Prior Art References retrieved or discovered using the CSC-based Search Vectors generated from Claim Scope Concept Structure identified in the CSC-SV Profile;

FIG. 108 is a schematic representation of (i.e. schema for) a Claim Scope Concept (CSC) Based Search Vector (CSC-SV) profile, organized by Claim Scope Concept Structure (CSCS) Number, and generated for each patent claim under search analysis, and identifying the set of Prior Art References retrieved or discovered using the CSC-based Search Vectors generated from Claim Scope Concept Structure identified in the CSC-SV Profile;

FIG. 109 is a schematic representation of (i.e. schema for) the Master (i.e. complete) Set of Claim Scope Concept (CSC) Based Search Vector Profiles generated for a set of patent claims under claim search analysis;

FIG. 110 is a schematic representation describing the structure of the Claim Scope Concept (CSC) Based Prior Art Reference Analysis Schema based on a set of patent claims under analysis, and organized by Claim Scope Concept (CSC) Structure;

FIG. 111 is a schematic representation of a Claim Scope Concept (CSC) Based Prior Art Reference Analysis GUI generated from a document schema such as, for example, as shown in FIG. 110, for use in claim scope concept (CSC) analyzing a set of retrieved prior art references in view of a specific set of patent claims under claim patentability analysis;

FIG. 112 is a schematic representation of (i.e. schemas for) a set of Prior Art Reference Claim Scope Concept (CSC) Profile documents generated by the system, for a set of retrieved prior art references that were analyzed using the Claim Scope Concept Based Prior Art Reference GUI illustrated in FIG. 111;

FIG. 113 is a schematic representation of (i.e. schema for) a Claim Scope Concept (CSC) Based Search Vector and Prior Art Reference Profile document or record designed for a set of patent claims, organized by Claim Scope Concept (CSC) Structure Number, and generated while prior art references are being scope concept analyzed using the Claim Scope Concept Based Prior Art Reference Schema of FIG. 10;

FIG. 114 is a schematic representation of (i.e. schema for) the Claim Scope Concept (CSC) Based Search Vector and Prior Art Reference Profile document or record designed for a set of patent claims, organized by Claim Number, and generated while prior art references are being scope concept analyzed using the Claim Scope Concept Based Prior Art Reference Schema of FIG. 10;

FIG. 115 is a schematic representation illustrating the architecture of an automated claim patentability analysis generation module within the system of FIG. 94, supporting the practice of the automated method of rational claim patentability analysis and chart generation, described in FIGS. 116A through 116F, in accordance with an alternative embodiment of the present invention;

FIGS. 116A through 116F, taken together, describe the process steps involved in carrying out the automated method of rational claim patentability analysis and chart and report generation, using the automated claim patentability analysis generation module shown in FIG. 115;

FIG. 117A is a processing stage, supported within the system of the present invention, involving the Claim Scope Concept (CSC) list for the (n=1)th patent claim in the Prior Art Reference Claim Scope Concept Profile that has been generated for the (m=1)th analyzed prior art reference being considered as a primary prior art reference (PPAR).

FIG. 117B is a schematic representation of a processing stage, supported within the system of the present invention, involving the Claim Scope Concept (CSC) list for the (n=N)th patent claim in the Prior Art Reference Claim Scope Concept Profile for the (m=1)th analyzed prior art reference being considered as a primary prior art reference (PPAR);

FIG. 117C is a schematic representation of a processing stage, supported within the system of the present invention, involving the Claim Scope Concept (CSC) list for the (n=1)th patent claim in the Prior Art Reference Claim Scope Concept Profile that has been generated for the (m=2)th analyzed prior art reference being considered as a primary prior art reference (PPAR);

FIG. 117D is a schematic representation of a processing stage, supported within the system of the present invention, involving the Claim Scope Concept list for the (n=N)th patent claim in the Prior Art Reference Claim Scope Concept Profile that has been generated for the (m=2)th analyzed prior art reference being considered as a primary prior art reference (PPAR);

FIG. 117E is a schematic representation of a processing stage, supported within the system of the present invention, involving the Claim Scope Concept list for the (n=1)th patent claim in the Prior Art Reference Claim Scope Concept Profile for the (m=M)th analyzed prior art reference being considered as a primary prior art reference (PPAR);

FIG. 117F is a schematic representation of a processing stage, supported within the system of the present invention, involving the Claim Scope Concept list for the (n=N)th patent claim in the Prior Art Reference Claim Scope Concept Profile that has been generated for the (m=M)th analyzed prior art reference being considered as a primary prior art reference (PPAR); and

FIG. 118A through 118C, taken together, show an exemplary Excel-based cumulative prior art reference chart generated by system of FIG. 94, during or independent from the process of the present invention, in connection with patent claim analysis, search vector generation, prior art searching, prior art reference retrieval and analysis, and/or claim patentability analysis and charting operations;

FIG. 119 is a graphical representation of an exemplary cumulative prior art reference report generated by the system of FIG. 94, during the process of the present invention, indicating the total number of cumulative prior art references retrieved for each Claim Scope Concept Structure (CSCS) generated during the marking up of the Claim under analysis, wherein each prior art reference contains prior art disclosure that may substantiate the Claim Scope Concept Structure (CSCS) assigned to a Claim Limitation Language String (CLLS) in a Claim under analysis, and from which the CSC-based Search Vector discovering the Prior Art Reference originally was derived;

FIGS. 120A and 120B, taken together, set forth an XML-based spreadsheet based Cumulative Prior Art Reference Chart, listing the prior art references, and corresponding prior art disclosure, that substantiate an indicated Claim Limitation Language String (CLLS) to which a Claim Scope Concept Structure (CSCS) was generated during markup and from which a CSC-Based Search Vector was generated and used to discover indicated set of cumulative prior art references, listed in the Chart;

FIG. 121 is an exemplary wireframe-type graphical user interface (GUI) served up from the Web and other servers of the Internet-based multi-mode patent analysis and charting system shown in FIG. 5, to one or more of its Internet-based client machines, showing graphical icons allowing members of the public to access and use the Open Public Claim Patentability Analysis (OPCPA) Mode of the present invention, based on the Claim Patentability Analysis Mode illustrated in FIGS. 93 through 120B, and the Open Public Claim Invalidity Contention Analysis (OPCICA) Mode of the present invention, based on the Claim Invalidity Contention Analysis Mode illustrated in FIGS. 46 through 51H, in accordance with the principles of the present invention;

FIG. 122 is the exemplary wireframe-type graphical user interface (GUI) shown in FIG. 121, showing the selection of the graphical icon for accessing the Open Public Claim Patentability Analysis (OPCPA) Mode of the present invention, based on the Claim Patentability Analysis Mode illustrated in FIGS. 93 through 120B, so that members of the public are allowed to analyze the file history and claims in a published patent application, automatically generate claim patentability analysis charts, and disclose the same in the pending patent application for review and consideration by the patent examiner during patent examination;

FIG. 123 is the exemplary wireframe-type graphical user interface (GUI) shown in FIG. 121, showing the selection of the graphical icon for accessing the Open Public Claim Invalidity Contention Analysis (OPCICA) Mode of the present invention, based on the Claim Invalidity Contention Analysis Mode of the present invention illustrated in FIGS. 46 through 51H, so that members of the public are allowed to analyze the file history and claims in a granted patent, automatically generate claim invalidity contention analysis charts, and disclose the same in the granted patents for review and consideration by the patent examiner during post grant review, patent reexamination proceeding or the like;

FIG. 124 is an exemplary wireframe-type graphical user interface (GUI) served up from the Web and other servers of the Internet-based system of FIG. 76, to one or more of its Internet-based client machines, showing graphical icons allowing members of the public to access and use, from a privileged and confidential workspace (PCW) supported in an Electronic Business Center (EBC) of a patent office, either (i) the Open Public Claim Patentability Analysis (OPCPA) Mode based on the Claim Patentability Analysis Mode illustrated in FIGS. 93 through 120B, and/or (ii) the Open Public Claim Invalidity Contention Analysis (OPCICA) Mode based on the Claim Invalidity Contention Analysis Mode illustrated in FIGS. 46 through 51H;

FIG. 125 is an exemplary wireframe-type graphical user interface (GUI) showing the selection of the graphical icon for accessing the Open Public Claim Patentability Analysis (OPCPA) Mode of the present invention, based on the Claim Patentability Analysis Mode illustrated in FIGS. 93 through 120B;

FIG. 126 is an exemplary wireframe-type graphical user interface (GUI), showing the bibliographic data for an exemplary published patent application selected by the public user for analysis under the Open Public Claim Patentability Analysis (OPCPA) Mode of the present invention, wherein the file history and claims and prior art references in the published patent application are automatically loaded into the OPCPA Module, for subsequent analysis by one or members of the public;

FIG. 127 is the exemplary wireframe-type graphical user interface (GUI) showing the selection of the graphical icon for accessing the Open Public Claim Invalidity Contention Analysis (OPCICA) Mode of the present invention, based on the Claim Invalidity Contention Analysis Mode of the present invention illustrated in FIGS. 46 through 51H; and

FIG. 128 is an exemplary wireframe-type graphical user interface (GUI), showing the bibliographic data for an exemplary granted patent selected by the user for analysis under the Open Public Claim Invalidity Contention Analysis (OPCICA) Mode of the present invention, wherein the file history and claims and prior art references in the granted patent are automatically loaded into the OPCICA Module, for subsequent analysis by one or members of the public.

FIG. 129 is an exemplary wireframe-type graphical user interface (GUI) showing the selection of the graphical icon for accessing the Automated Patent-Related Document Generation Module of the present invention, supported within the multi-mode patent analysis and charting system of the present invention shown in FIGS. 5 through 71B, and the Internet-based system disclosed in FIGS. 76 through 92B;

FIG. 130 is flow chart describing the primary steps carried out during the document generation process of the present invention supported within the systems of the present invention, including automated XML-based document generation and automated data content synchronization among XML-based target and source documents and the system database; and

FIG. 131 is a schematic illustration graphically illustrating (ii) the mapping of data content within the system database of the multi-mode patent analysis and charting system of the present invention, to an output XML-based chart structure (i.e. XML-based source document), (ii) the mapping of data content from the output XML-based chart structure to a XML-based patent-related document (i.e. XML-based target document), (iii) the display of the XML-based patent-related document, (iv) the editing of data content within the XML-based patent-related document, and (v) the synchronization of data content among the XML-based patent-related document, the XML-based chart structure (i.e. document), and the system database within the multi-mode patent analysis and charting system of the present invention.

FIG. 132A is a high-level system architecture diagram in accordance with an embodiment of the invention.

FIG. 132B is a system architecture diagram in accordance with an embodiment of the invention.

FIG. 133A is a screenshot of a create user screen in accordance with an embodiment of the invention.

FIG. 133B is a screenshot of an initial case setup screen in accordance with an embodiment of the invention.

FIG. 134 is a screenshot of an automatic import and parsing screen in accordance with an embodiment of the invention.

FIG. 135 is a screenshot of a manual patent entry screen in accordance with an embodiment of the invention.

FIG. 136 is a screenshot of a concept phrase screen in accordance with an embodiment of the invention.

FIGS. 137 and 138 are screenshots of concept phrase association screens in accordance with embodiments of the invention.

FIGS. 139 and 140 are screenshots of case administration screens in accordance with embodiments of the invention.

FIG. 141 is a screenshot of a citation format screen in accordance with an embodiment of the invention.

FIG. 142 is a screenshot of an information source screen in accordance with an embodiment of the invention.

FIGS. 143 and 144 are screenshots of chart generation screens in accordance with embodiments of the invention.

FIG. 145 is a screenshot of an advance search screen in accordance with an embodiment of the invention.

FIG. 146-148 are screenshots of chart output excerpts in accordance with embodiments of the invention.

FIG. 149 is a screenshot of a data mining output excerpt in accordance with an embodiment of the invention.

FIG. 150 is an illustration of various information and concept rating criteria.

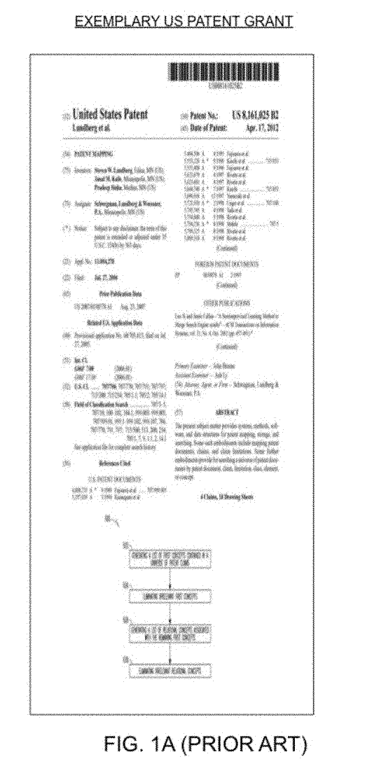

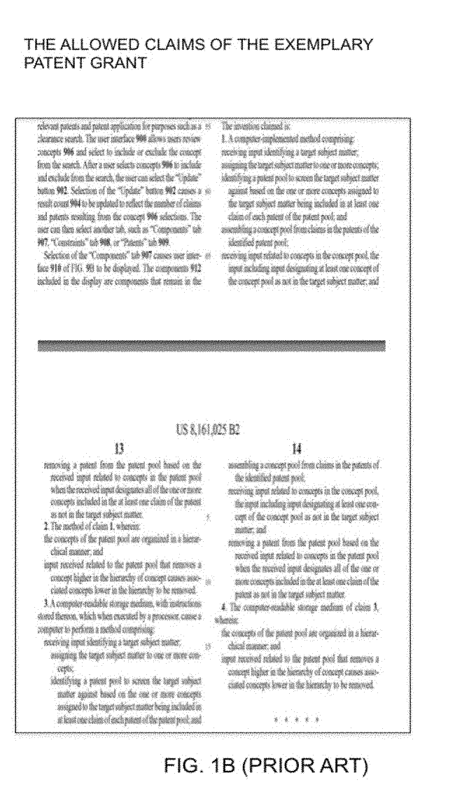

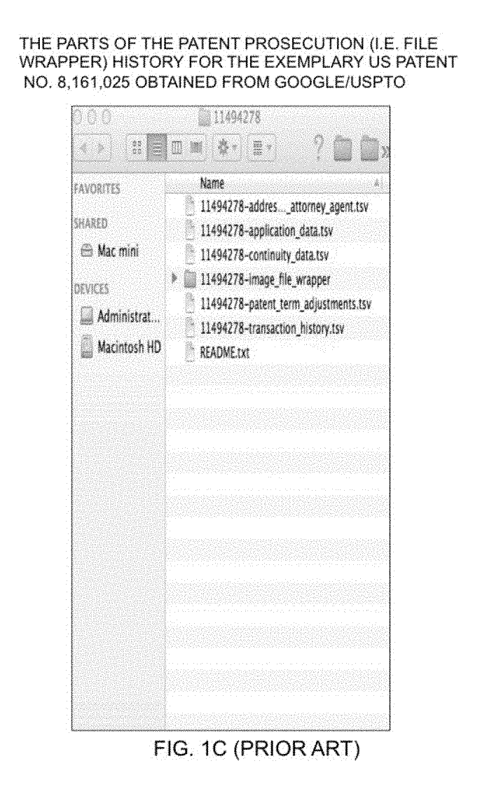

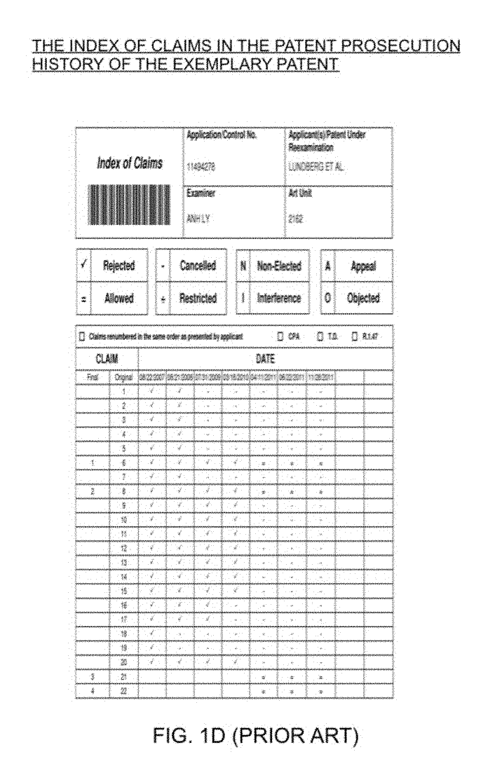

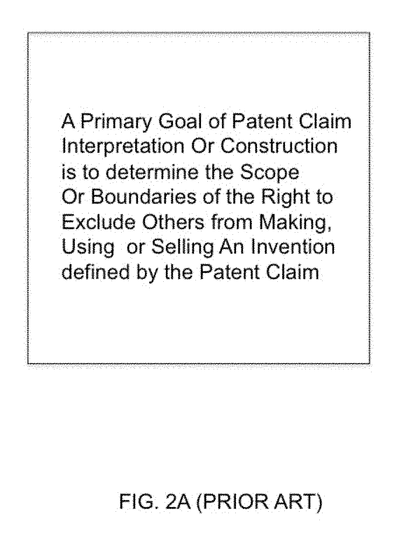

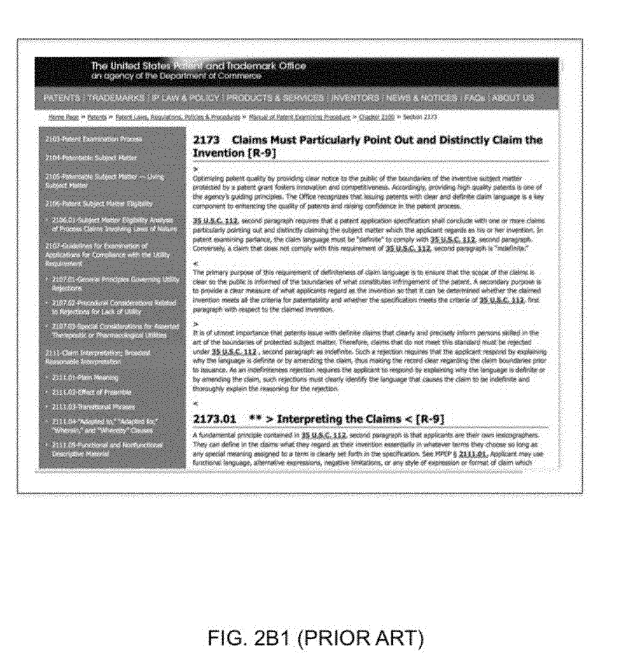

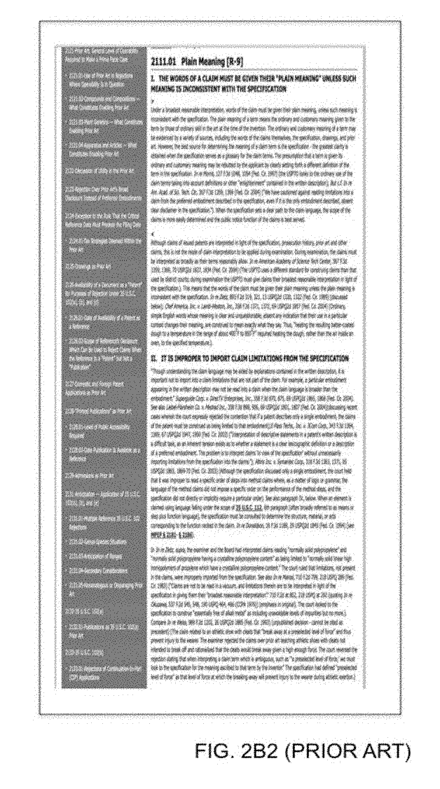

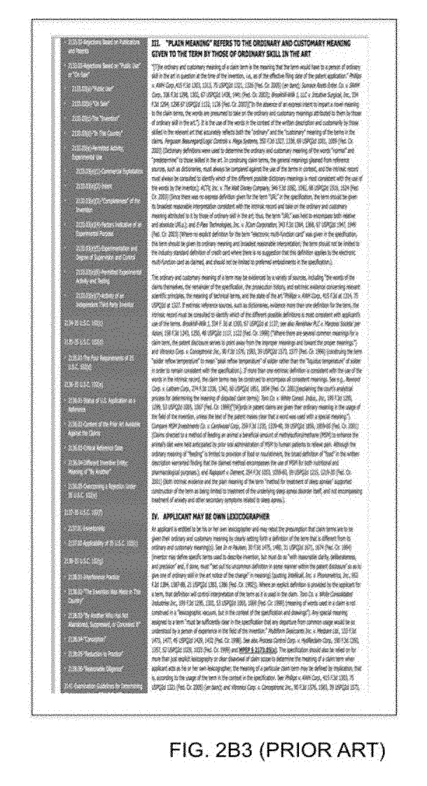

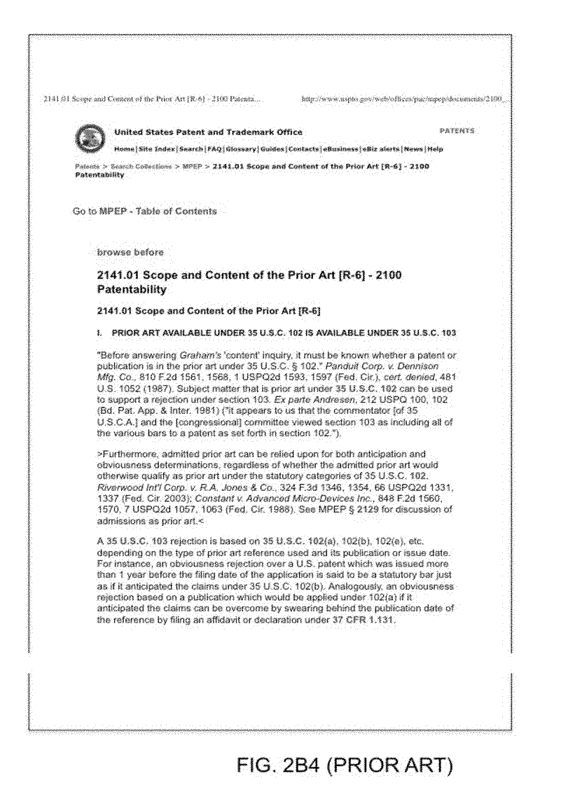

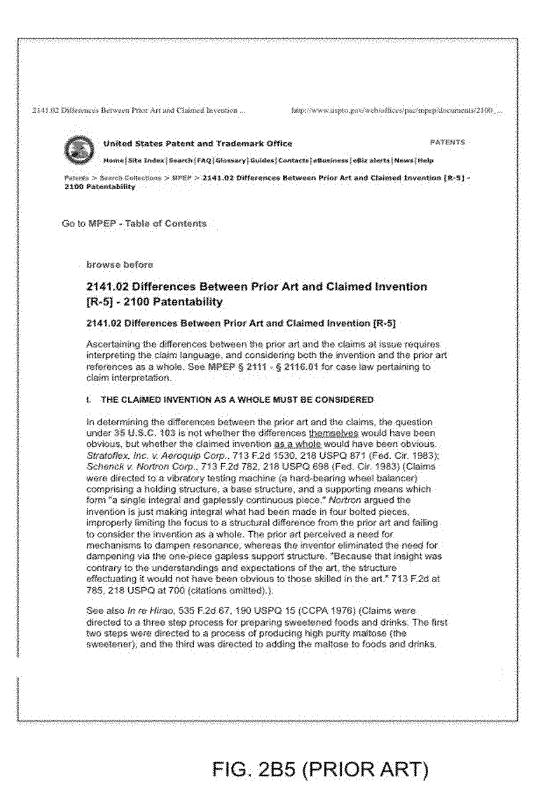

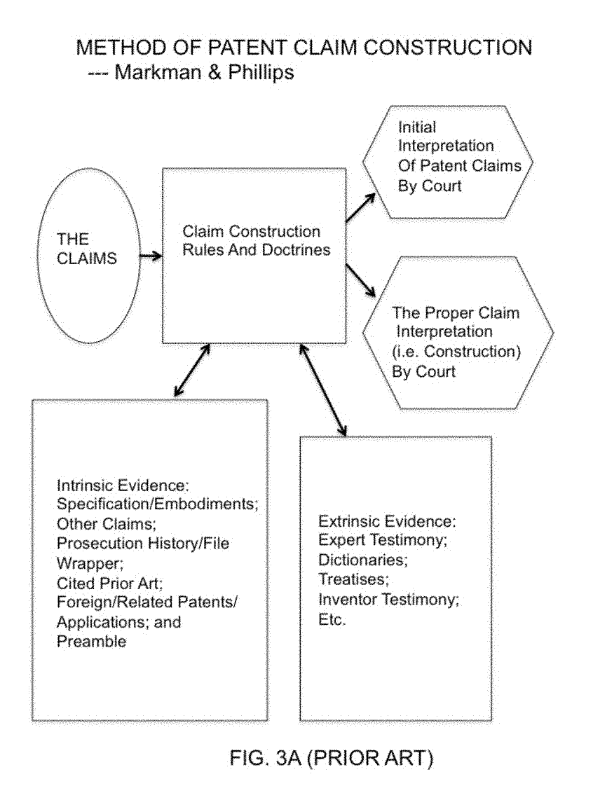

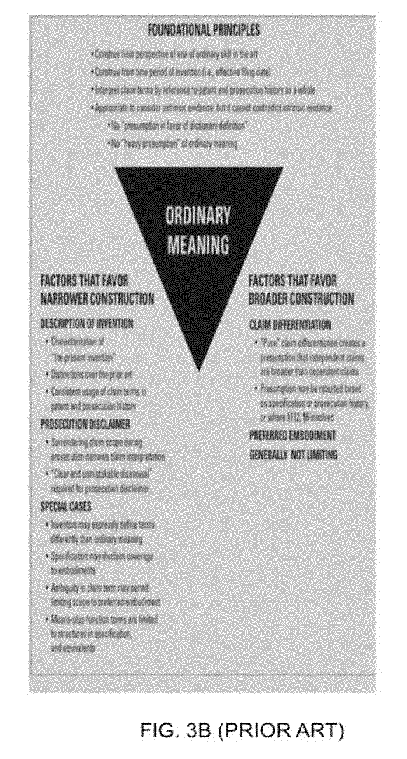

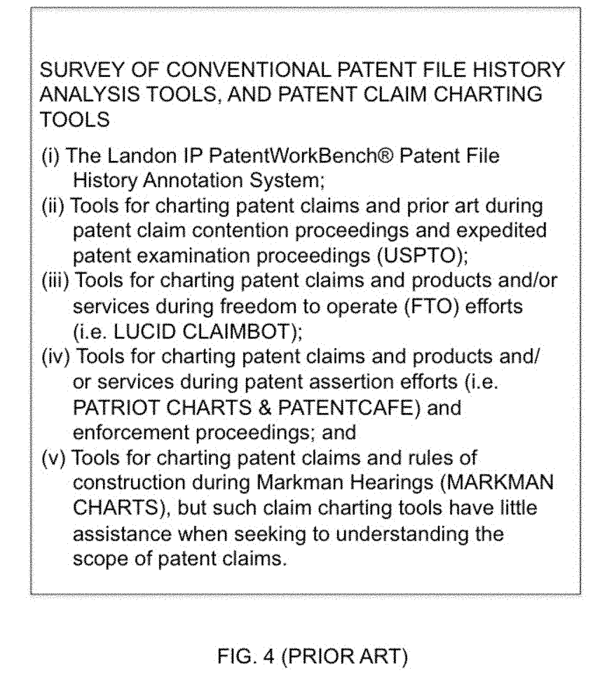

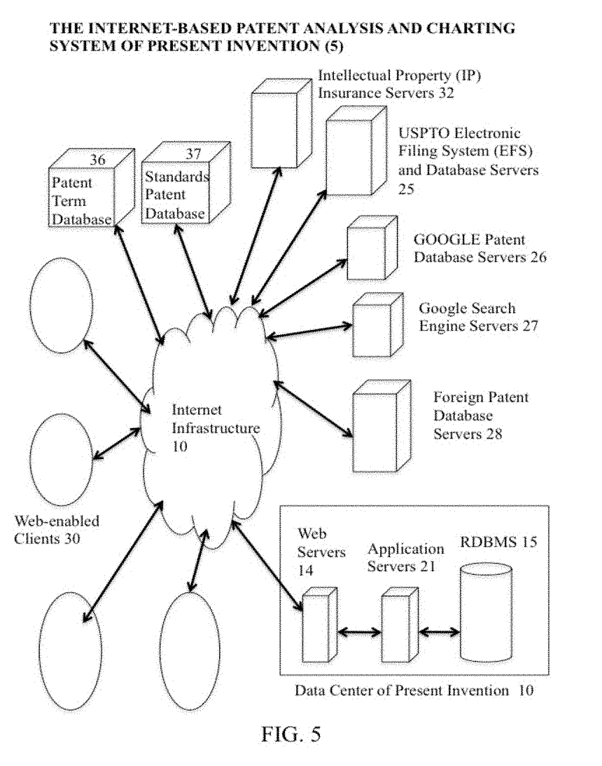

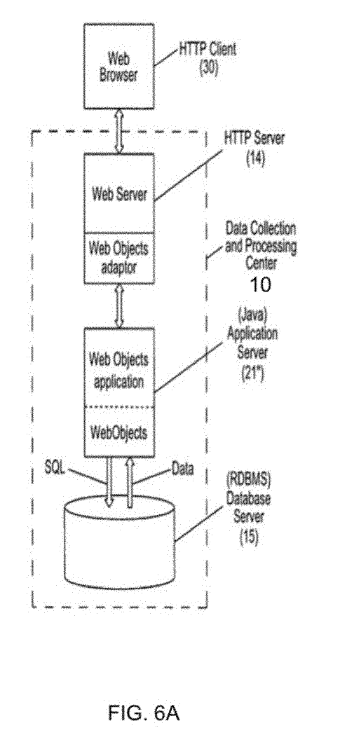

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

As used in this Patent Specification and in the Claims to Invention herein, the terms “chart”, “charts”, “chart structure” and “chart structures” shall include, but are not be limited to spreadsheet-type display structures, as shown in the Drawings for purposes of illustration only.

Therefore, the terms “chart”, “charts”, “chart structure” and “chart structures” shall be deemed to include all other document types, such as for example, Microsoft® Word documents, Microsoft® PowerPoint (PPT) decks, Microsoft® Excel spreadsheets, Adobe PDFs, HTML pages, XHTML5 pages, and any other suitable document-type, that are capable of containing and displaying the kind of textual, graphical (and even audible) information that may be collected from patent prosecution file histories, including patent specifications, patent claims, prior art references, patent office documents, as well as other diverse types of information that might be collected during patent litigation, patent post-grant proceedings, and from other events that may touch upon and impact the interpretation and construction of patent claims, as will be described in great technical detail hereinafter.

### Overview of the Internet-Based Multi-Mode Patent Analysis and Charting System of the Present Invention

Referring to FIG. 5, the Internet-based (i.e. Cloud-based) multi-mode patent claim analysis and charting system of the present invention 5 is shown comprising various system components, including an industrial-strength data collection and processing center 10 comprising web servers, application servers and RDBMS servers, domestic and foreign patent database servers, USPTO electronic filing system (EFS) and related database servers, and patent term and standards based database servers and commercial Google patent database servers, configured and interfaced around the infrastructure of the Internet, and accessible by a plurality of Web-enabled client machines (e.g. desktop computers, mobile computers such as iPad, and other Internet-enabled computing devices with graphics display capabilities, etc). In the illustrative embodiment, the system 5 is realized as an industrial-strength, carrier-class Internet-based network of object-oriented system design, deployed over a global data packet-switched TCP/IP communication network comprising numerous computing systems and networking components, as shown. As such, the information network of the present invention is often referred to herein as the “system” or “multi-mode system”.

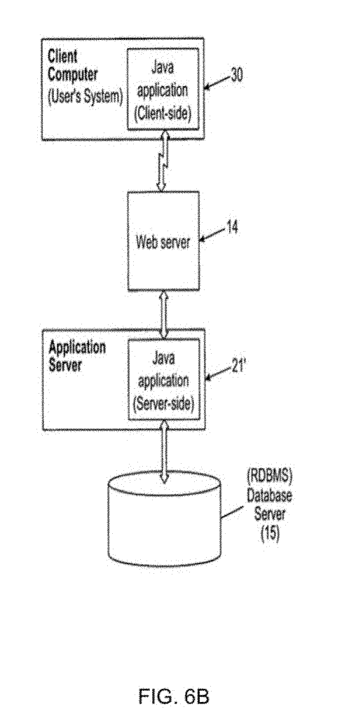

In general, the Internet-based system 5 can be implemented using any object-oriented integrated development environment (IDE) such as WebObjects 5.2 by Apple Computer Inc, Websphere IDE by IBM, or Weblogic IDE by BEA, or even an non-Java IDE such as Microsoft's .NET IDE. Two different Network implementations using the WebObjects IDE are illustrated in FIGS. 6A and 6B using Web-based and Java-client technology, respectively. Preferably, the entire system of the present invention can be designed according to object-oriented systems engineering (OOSE) methods using UML-based modeling tools, such as Rational ROSE Visual Modeling and XDE by Rational Software, Inc., or Together® Visual Modeling Software by Borland Software, using the industry-standard Rational Unified Process (RUP) or Enterprise Unified Process (EUP), both well known in the art. Implementation programming languages can include Java, C⁻, Objective C, PHP, and other computer programming languages known in the art. Preferably, the system is deployed as a three-tier server architecture with a double-firewall, and appropriate network switching and routing technologies well known in the art.

In FIG. 5 and through the present Specification, the RDBMS 15 in the data center 10 can be realized using one or more database servers, each comprising: one or more central processing units (CPUs); a memory architecture with program memory (RAM), cache, and disc storage (e.g. RAID storage) and optionally one or more network attached storage (NAS) devices; a system bus architecture; power supplies; controllers; and an input/output architecture configured in a manner known in the art. The RDBMS 15 will support an operating system (e.g Linux, OSX, Windows, Solaris, etc) and relational database software (e.g. mySQL, postgresSQL, Oracle Database software), designed and developed to support and perform the functions and services of the systems of the present invention described herein.

Each application server 21 within the data center 10 can be realized using one or more application servers, each comprising: one or more central processing units (CPUs); a memory architecture with program memory (RAM), cache, and disc storage (e.g. RAID storage); a system bus architecture; power supplies; controllers; and an input/output architecture configured in a manner known in the art. Each application server 21 will support an operating system (e.g. Linux, OSX, Windows, Solaris, etc) and application software (e.g. written in Java, PHP, C⁻, etc) designed and developed to support and perform the functions and services of the system of the present invention described herein.

Similarly, each Web server within the data center 10 can be realized using one or more web servers, each comprising: one or more central processing units (CPUs); a memory architecture with program memory (RAM), cache, and disc storage (e.g. RAID storage) and optionally one or more network attached storage (NAS) devices; a system bus architecture; power supplies; controllers; and an input/output architecture configured in a manner known in the art. Each web server 14 will support an operating system (e.g Linux, OSX, Windows, Solaris, etc) and web server (http) software (e.g. Apache httpd software) configured and deployed so as to serve a large number of clients simultaneously, in a manner well known in the art. Preferably, load-balancing servers will be provided to ensure optimal load balancing of incoming http requests to the web servers 14 of the system.

It is understood, that any one or more of the RDBMS servers 15, application servers 21 and/or web servers 14 of system 5 can be realized using virtual operating system software (e.g. VMware software) running on one or more hardware servers, in a manner well know in the server art.

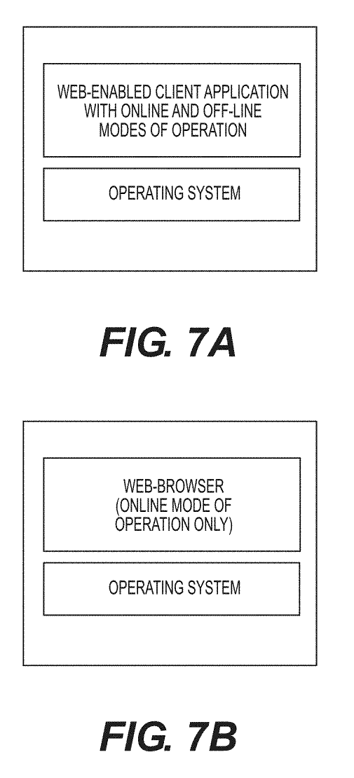

In one illustrative embodiment, the multi-mode patent analyzing and charting system of the present invention is realized as a hosted service using an application service provider (ASP) model, using Web-based client machines (e.g. workstations, desktops, laptops, mobile computers, tablet computers, smart-phones, etc). However, it is understood that some or all of the services provided by the system can be accessed using Java clients, preferably running behind a client enterprise firewall. As shown in FIG. 7A, the Web-enabled or Internet-enabled clients can be realized using a web-enabled (http-enabled) client application running on the operating system of a computing platform, to support both online and off-line modes of system operation. Alternatively, as shown in FIG. 7B, the Web-enabled (or Internet-enabled) clients can be realized using a web-browser application running on the operating system of a computing platform, to support online mode of system operation, only.

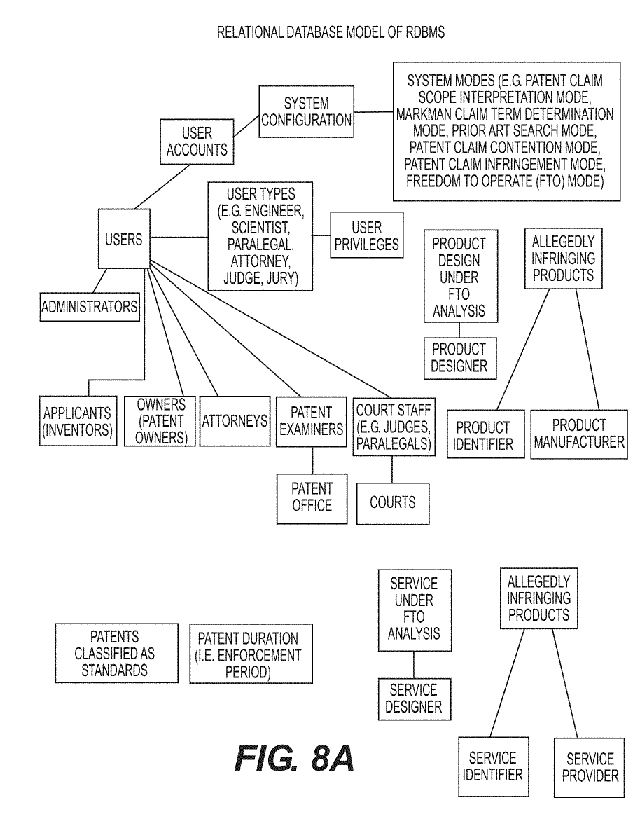

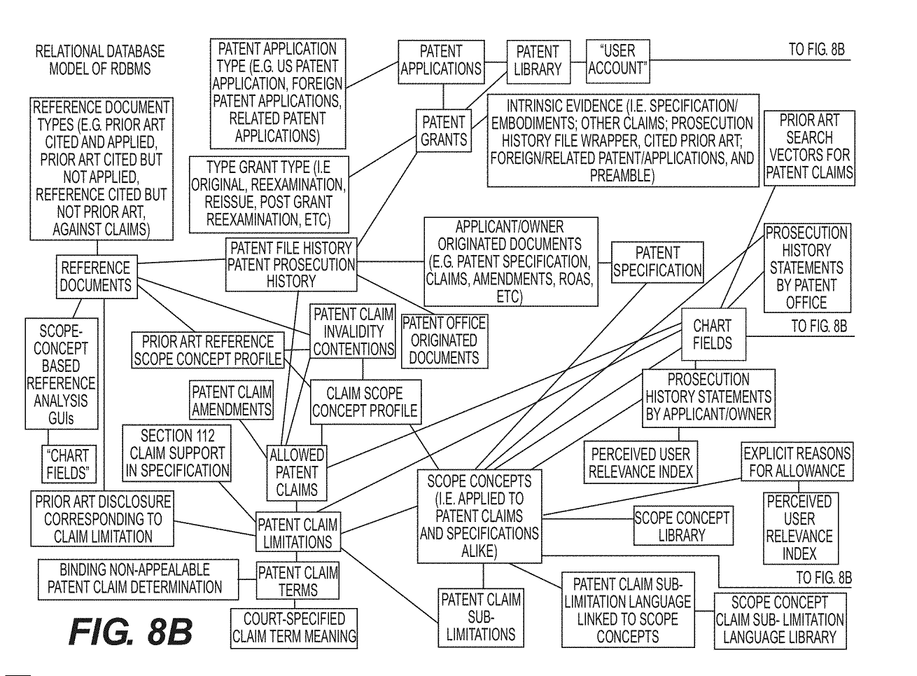

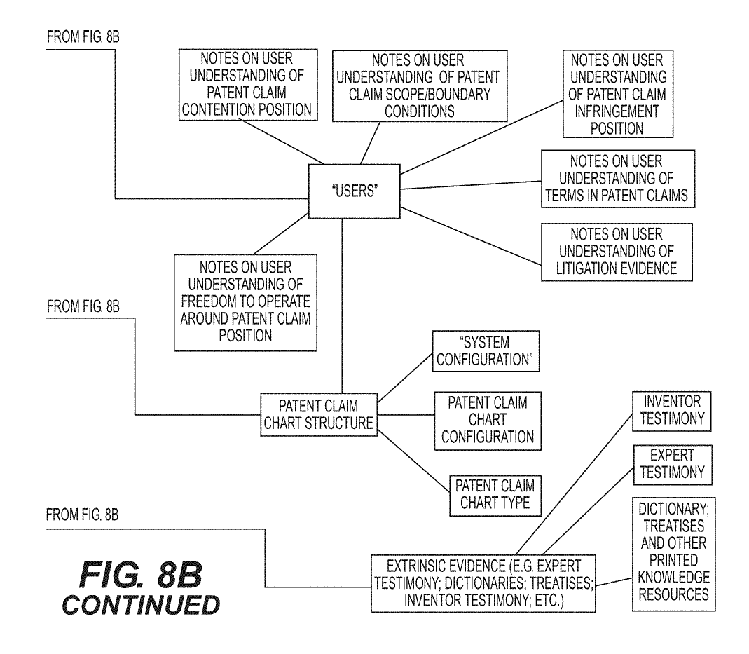

FIGS. 8A and 8B, taken together, set forth a relational database model for the RDBMS server employed in the system shown in FIG. 5. As shown, the relational database model specifies the various database tables that can be used when implementing the illustrative embodiment of the present invention. In the illustrative embodiment, particular terms are used to define particular interface, control and enterprise type objects used in the analysis, design and development of a preferred embodiment of the Internet-based system of the present invention. These enterprise-level objects, represented by the table structures in the relational database model shown in FIGS. 8A and 8B, and listed below, should be carefully considered while reading the present Specification.

### Enterprise-Level Objects Represented in the RDBMS of the System 5

### System Configuration

System Modes (e.g. Patent Claim Prosecution Analysis Mode, Patent Claim Scope

### Interpretation Analysis Mode, Markman Patent Claim Term Analysis Mode,

### Prior/Present Art Search Analysis Mode, Patent Claim Invalidity Contention Analysis

### Mode, Patent Claim Infringement Analysis Mode, Freedom to Operate (FTO) Analysis

### Mode, and Patent Litigation-Storyboard Analysis Mode)

### Clients

### User Accounts

### Users

User Type (e.g. Engineer, Scientist, Paralegal, Attorney, Judge, Jury, . . . )

### User Privileges

### Administrators

### Patent Office

### Patent Examiners

### Patent Grants

Patent Grant Type (i.e. Original, Reexamination, Post Grant, . . . )

### Applicants

### Owners (Patent Owners)

Courts (e.g. Judges, Clerks . . . )
Intrinsic Evidence (e.g. Intrinsic Evidence: Specification/Embodiments; Other Claims;

### Prosecution History/File Wrapper; Cited Prior Art; Foreign/Related Patents/Applications; and Preamble)

Extrinsic Evidence (e.g. Expert Testimony; Dictionaries; Treatises; Inventor Testimony; Etc.)

### Patent Applications

Patent Application Type (e.g. Foreign Patent Applications, Related Patent Applications)

### Patent File History (Patent Prosecution History)

### Patent Office Originated Documents

### Applicant/Owner Originated Documents

Reference Documents (e.g. Prior Art Cited and Applied, Prior Art Cited But Not

### Applied, Reference Cited But Not Prior Art Against Claims)

Reference Document Types (e.g. Prior Art Cited and Applied, Prior Art Cited But Not

### Applied, Reference Cited But Not Prior Art Against Claims)

### Patent Claim Amendments

### Patent Claims (Claims)

### Patent Specification

### Patent File History (Patent Prosecution History)

### Patent Claim Chart Structure

### Patent Claim Chart Type

### Patent Claim Chart Configuration

### Patents Classified as Standards

### Patent Duration (Enforcement Period)

### Allegedly Infringing Products

### Allegedly Infringing Services

### Notes User Understanding of Patent Claim Scope/Boundary Conditions

### Notes on User Understanding of Terms in Patent Claims

Prosecution History Statements By Applicant/Owner (e.g. Claim Limitation Disclaimer, . . . )

### Prosecution History Statements By Patent Office

### Reasons for Allowance

### Binding Non-Appealable Patent Claim Determinations

### CAFC Claim Term Meaning Library

### Court Specified Claim Term Meaning

### Binding Non-Appealable Patent Claim Determination

Patent Claims (original numbering, final numbering)

### Patent Claim Terms

### Patent Claim Limitations

### Patent Claim Sub-Limitations

### Patent Claim Amendments

### Patent Grants

### Claim Support In Specification (Section 112)

### Prior Art Disclosure Corresponding to Claim Limitation

(Claim) Scope Concept (i.e. Applied To Patent Claims and Specifications)

### Scope Concept Library

Patent Claim Sub-Limitation Language linked to Scope Concepts

### Scope Concept/Sub-limitation Language Link Library

### Scope-Concept Based Reference Analysis GUI

### User Observations on Patent Claim Interpretation/Construction

### Prior Art Reference Scope Concept Profile

### Claim Scope Concept Profile

### Product Design Under FTO Analysis

### Service Design Under FTO Analysis

Patent Grant Type (e.g. Original, Re-Examination, Reissue, Post-Grant Re-Examination, etc)
Patent Application Type (e.g. US Patent Application, Foreign Patent Application, Related Patent Application)

### Patent Library

### Chart Fields

### Perceived User Relevance

### Scope-Concept/Sub-Limitation Language Library

### Patent Claim Chart Structure

### Patent Claim Chart Type

### Patent Claim Chart Configuration

### Notes on User Understanding of Freedom-to-Operate Around Patent Claim Position

### Notes on User Understanding of Litigation Evidence

### Notes on User Understanding of Patent Claim Scope/Boundary Conditions

### Notes on User Understanding of Patent Claim Infringement Position

### Notes on User Understanding of Terms in Patent Claims

### Inventor Testimony

### Expert Testimony

### Dictionary, Treatises, and Other Printed Knowledge Sources

### Prior Art Search Vectors for Patent Claims

As can be seen in FIG. 8A, the object named “Users” is related to many other objects in the system, and also to many objects represented in FIG. 8B. Also, the object “User Accounts” is related to the objects “Users” and “System Configuration” shown in FIG. 8A, and also to the object “Users” shown in FIG. 8B.

As shown in 8B, the object named “Scope Concepts” is related to numerous other objects represented in FIG. 8B, including “Patent Claim Limitations”, “Patent Claim Sub-Limitations”, “Chart Fields” and many other objects shown. While the relationships among the many database objects are complex in the illustrative embodiment shown in FIGS. 5A and 5B, it is understood that different embodiments will have different database object relationships, to support the structures and methods employed in the implemented system. Such technical details are well known in the system engineering and relational database design arts, and will not be discussed in further detail hereinafter.

In FIG. 9, an industrial-strength enterprise-level object-oriented deployment platform is shown for deploying the Internet-based multi-mode patent claim analysis and charting system of the present invention over the infrastructure of the Internet. In the illustrative embodiment, each granted patent and published patent application in any national, regional or international patent system can be stored in either remotely accessible Internet-based database servers, or within the central system database of the system, so that it is immediately available to each user or group of users, for patent analysis and charting purposes.

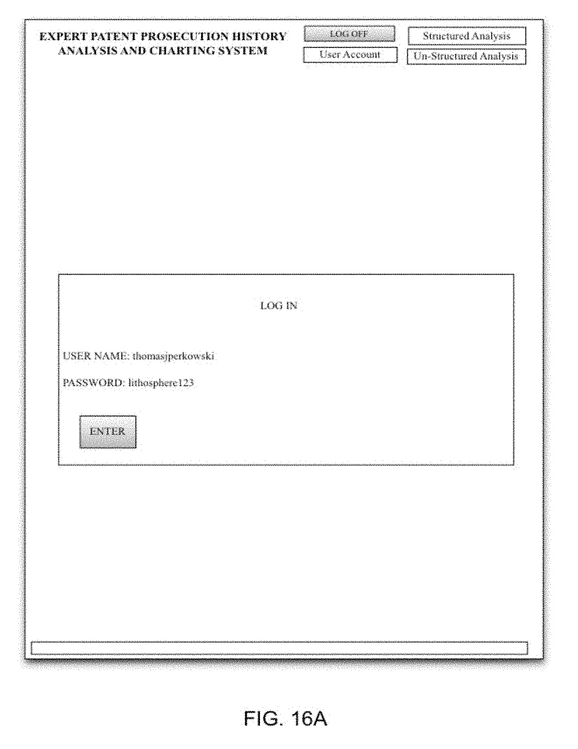

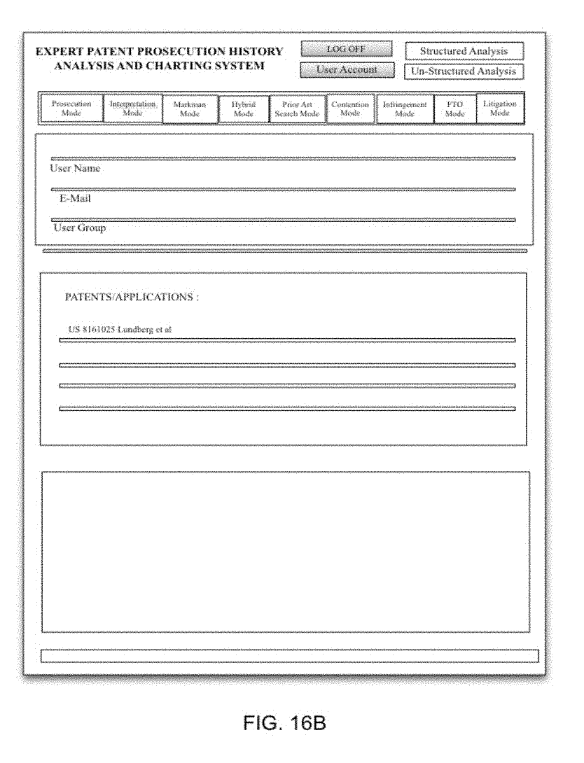

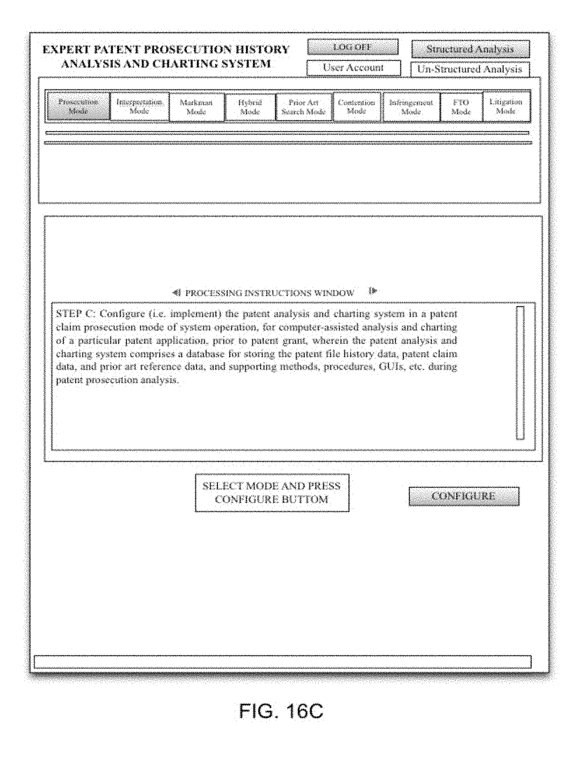

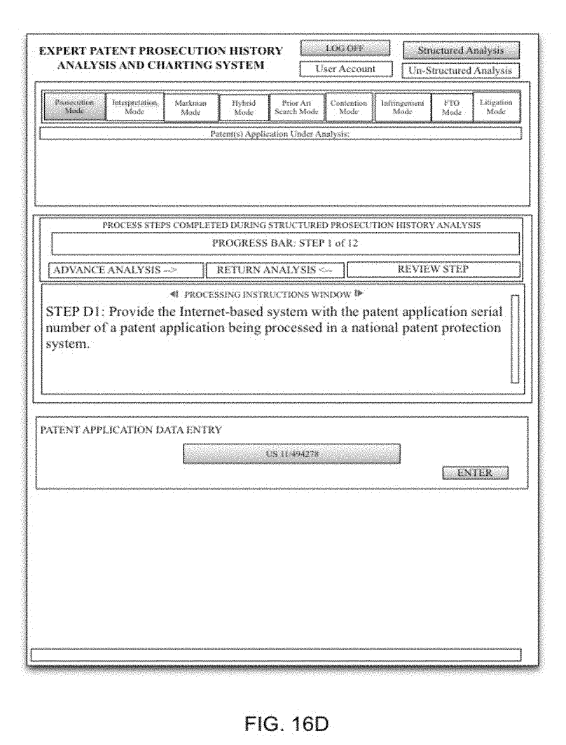

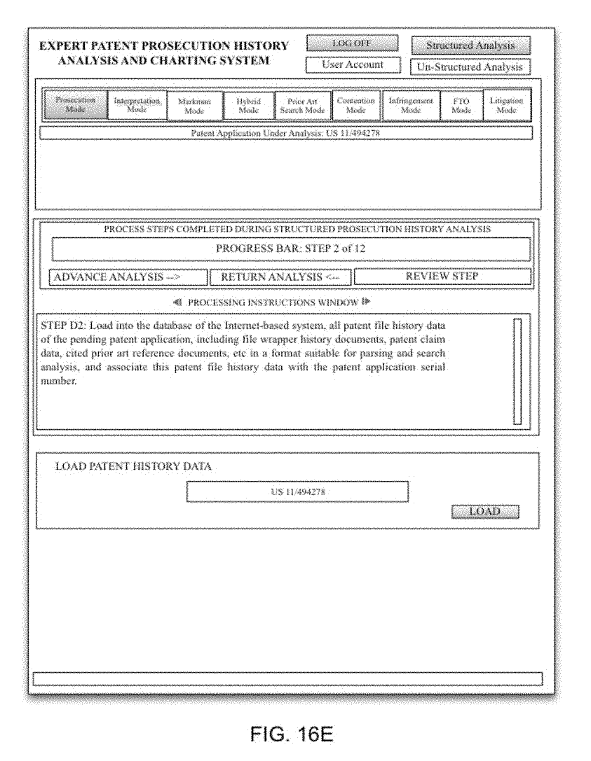

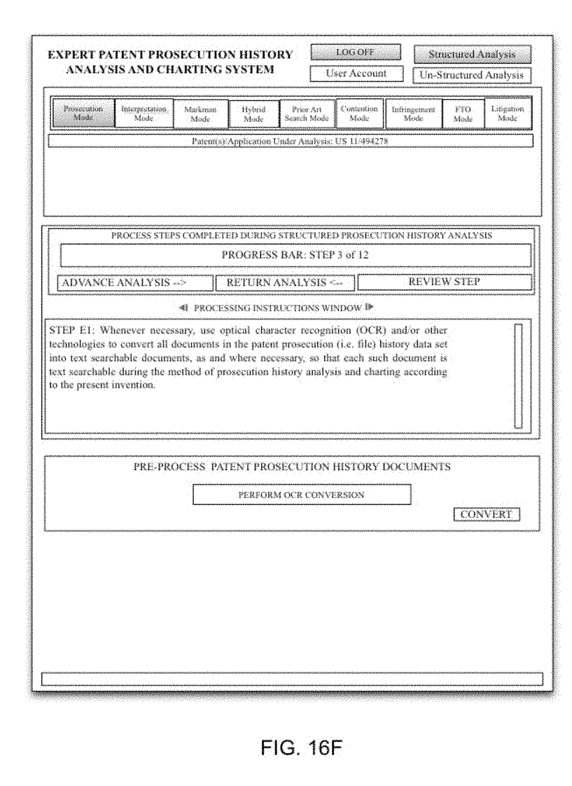

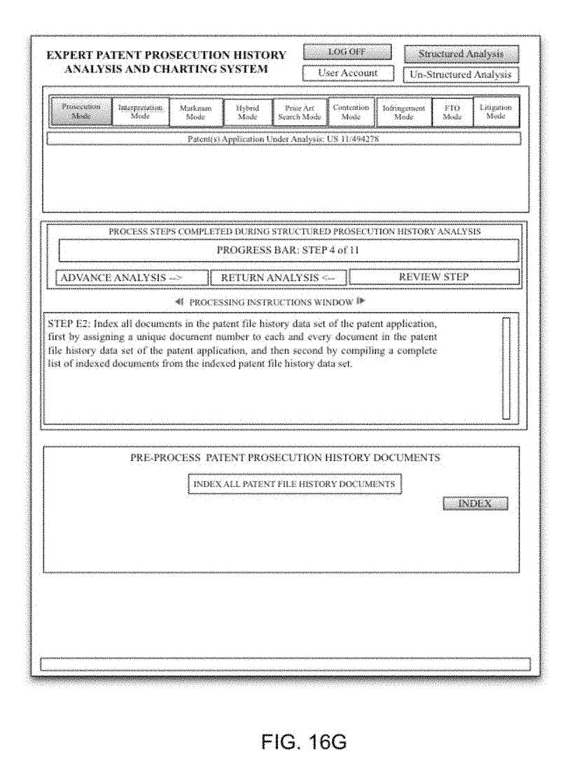

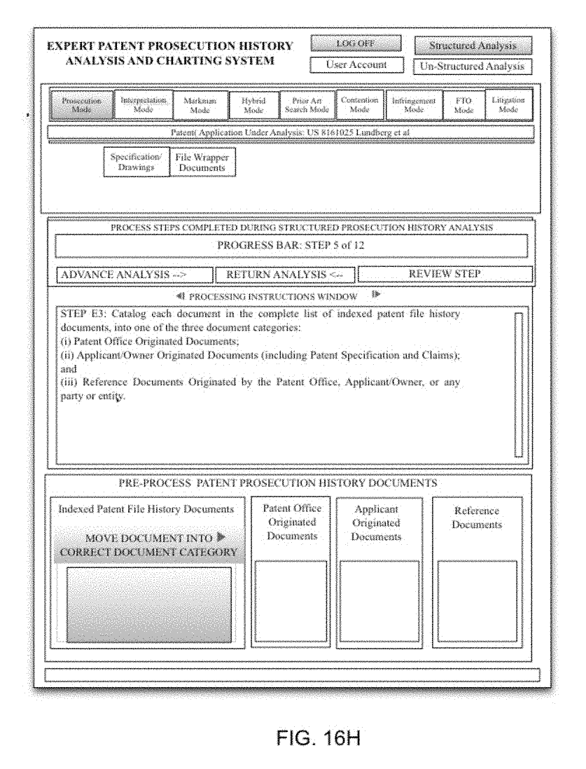

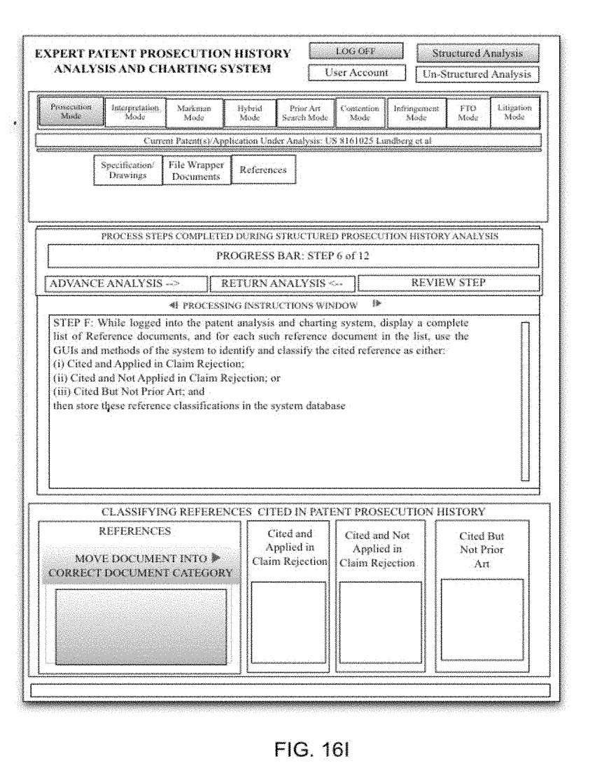

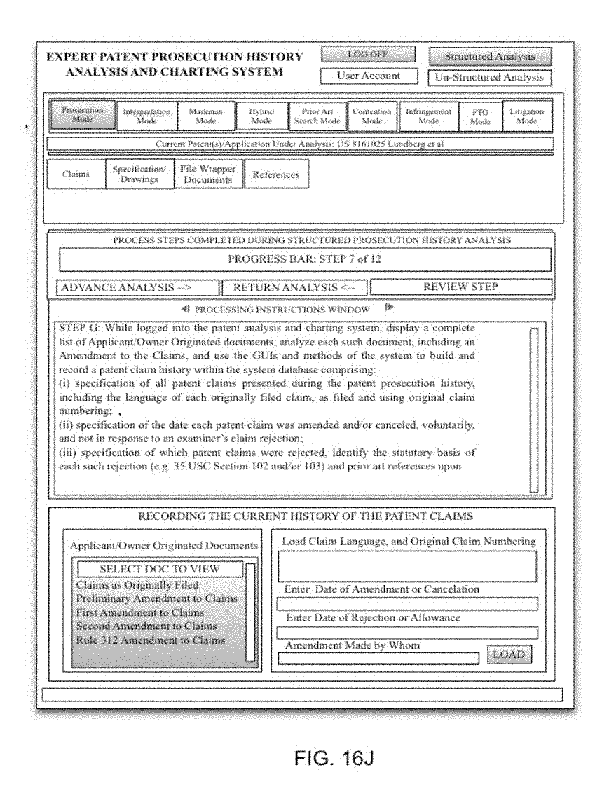

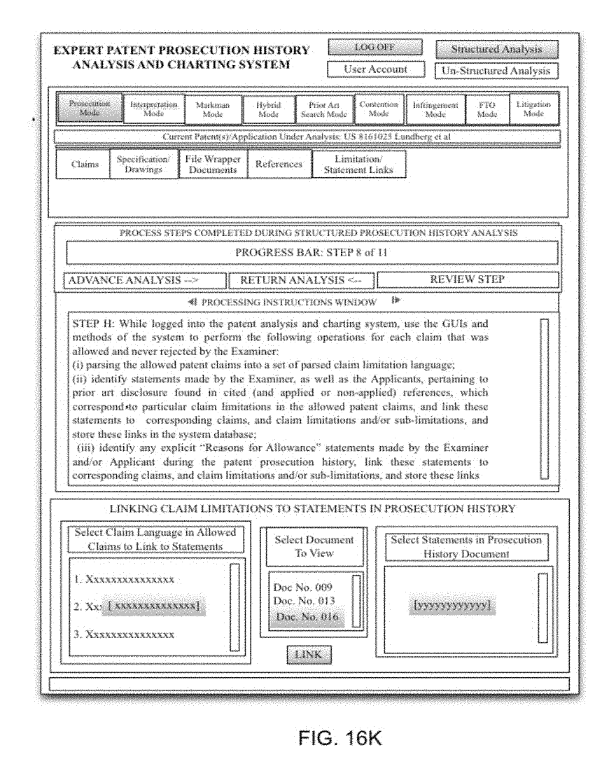

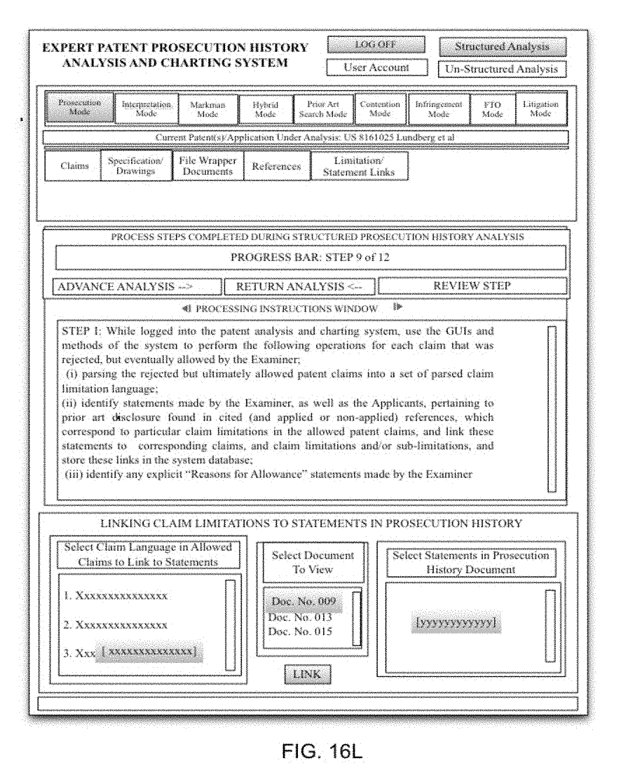

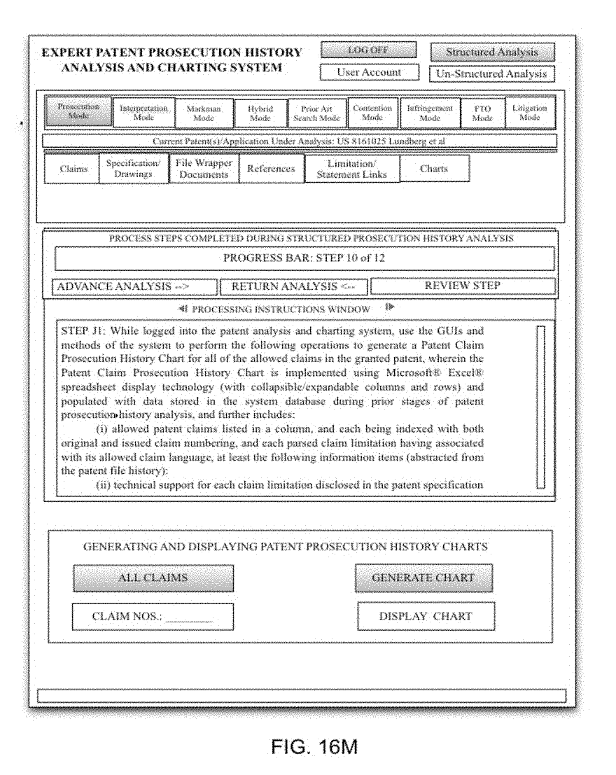

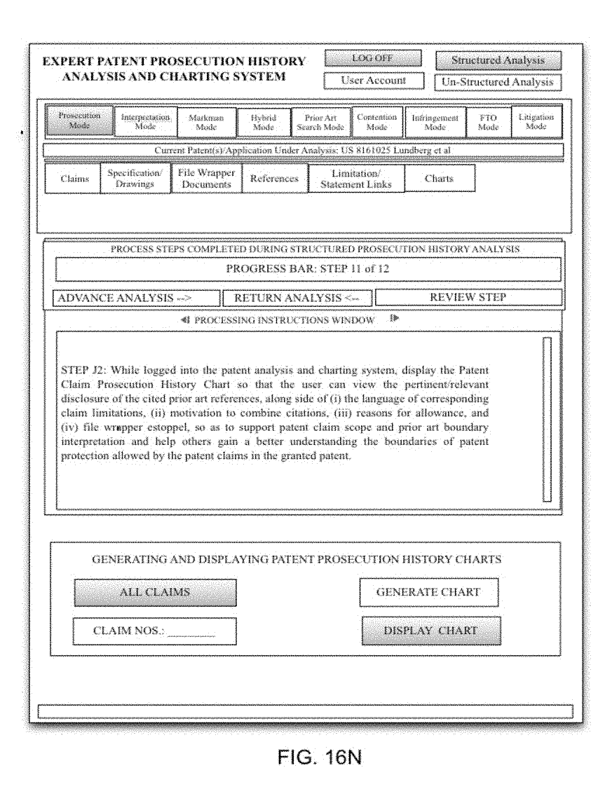

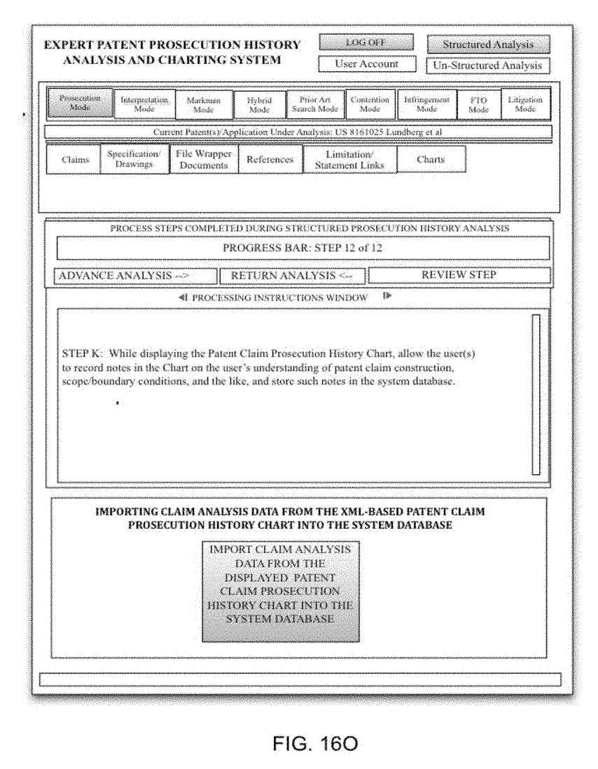

Once the case data for granted patents and/or published patent applications is loaded onto the deployment platform, the deployment platform is ready to deploy a multi-mode patent analysis and charting system for each group of users (“user group”) of virtually any size, even a user group having only a single user. As shown, each instantiation of the multi-mode patent analysis and charting system for any particular user group can be remotely accessed by a member of the registered group of authorized web-enabled clients through a log-in screen as shown in FIG. 16A.

The multi-mode system 5 of the present invention includes a Project Management Module that is made displayable as a tab on the GUI screens of the system, by making a preference selection in the User Account module. In the Project Management Module, any user, or user group, can upload into the system database 15, the XML-based electronic file history of each patent application and/or granted patent that the user or user group has added to their Project. The actual number of patent/application related cases in a user's Project Module at any moment in time will depend upon many factors, primarily what patent applications and/or granted patents they are interested in analyzing, understanding, prosecuting, asserting, defending, and/or challenging as described in greater detail hereinafter. The Project Management Module supports a number of functions, including (i) user management of all case information associated with each patent application and/or granted patent maintained in a given Project of a registered user or user group, and (ii) the selection of cases which are to “active” and can be worked upon (i.e. analyzed and charted) using the various modes of analysis and charting supported on the multi-mode patent analysis and charting system of the present invention 5 (and 300).

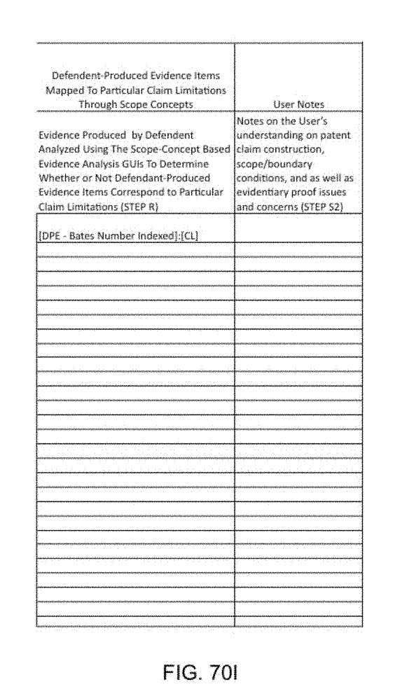

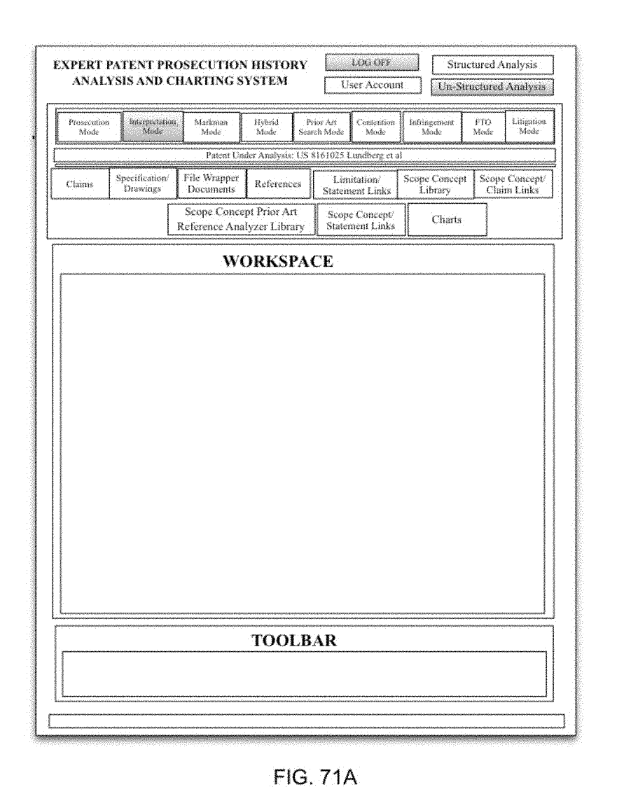

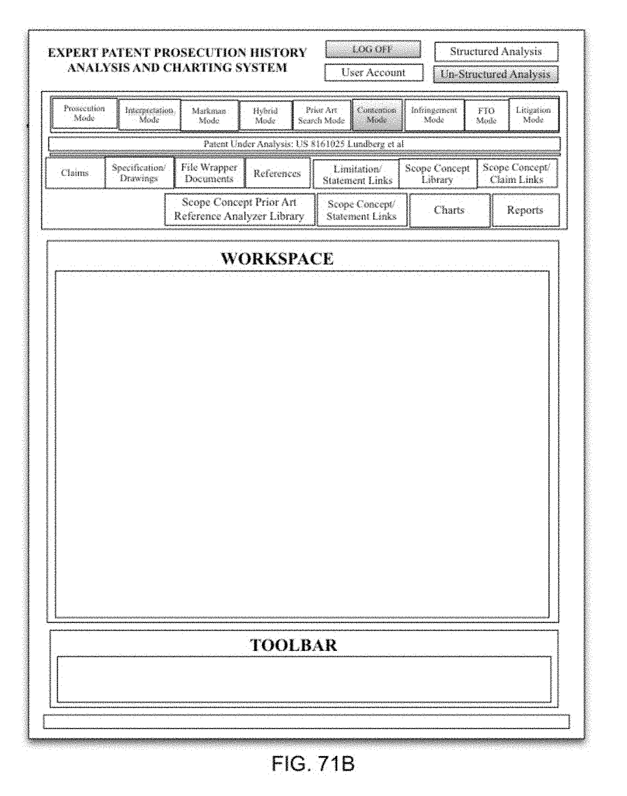

Once logged into the multi-mode system 5, the user can configure the system into a mode of system operation required for the task at hand using the GUI screen set forth in FIG. 16B. Then, the user, or group of users simultaneously logged into the system, can proceed to analyze and chart one or more granted patents and/or published patent applications in a highly structured (i.e. guided) manner, in accordance with the principles of the present invention, or alternatively, operate the system in a non-structured or un-guided mode as disclosed in FIGS. 71A and 71B, and discussed hereinafter.

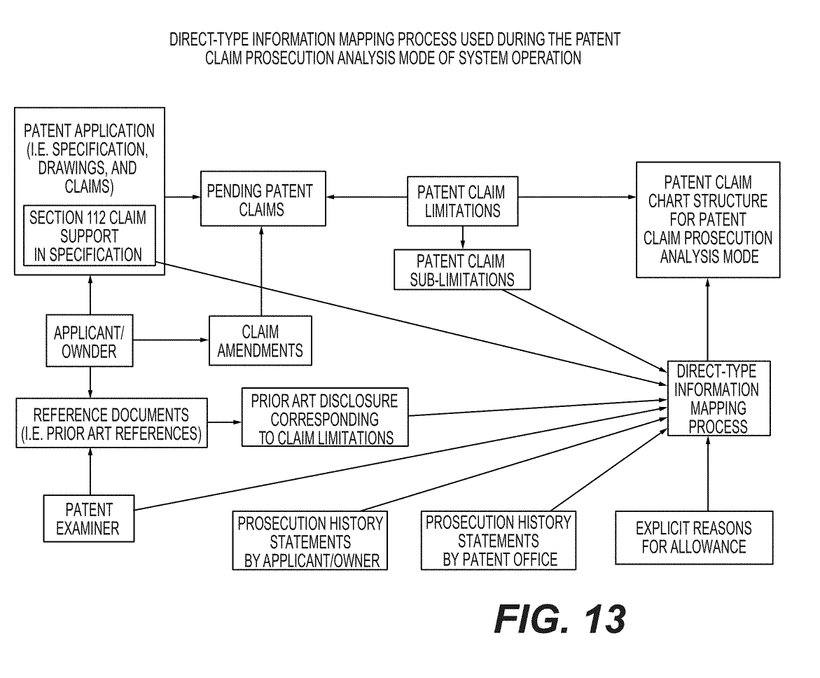

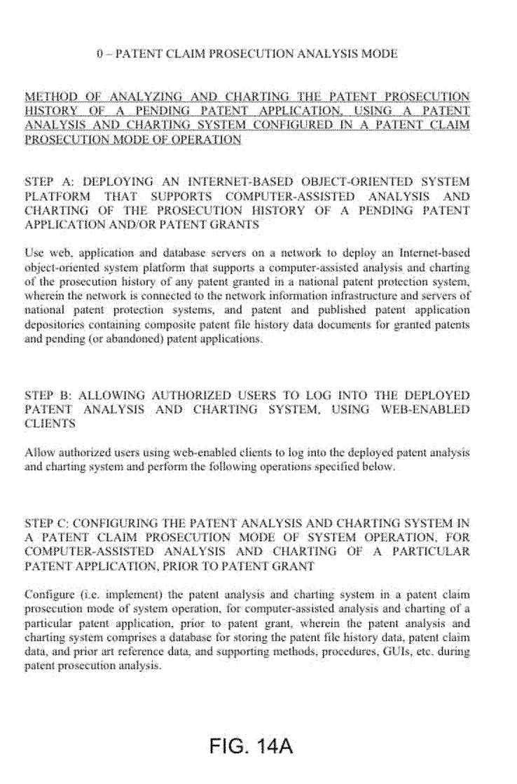

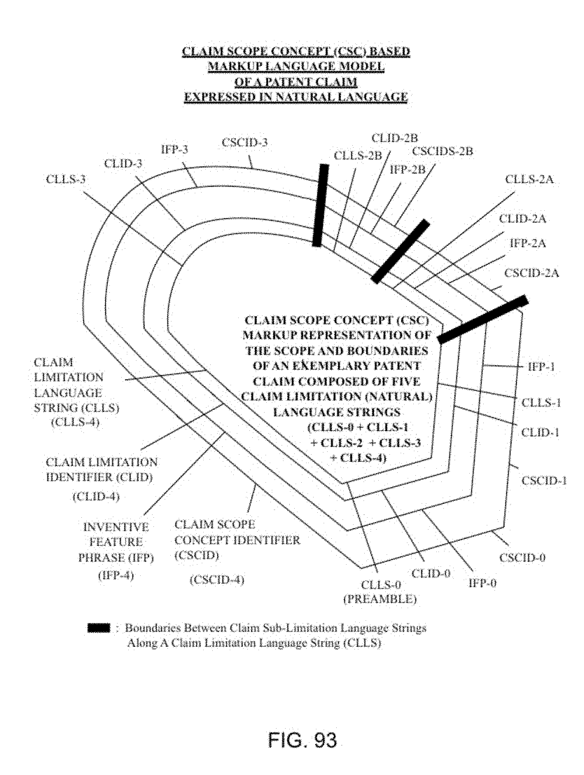

For example, using the system while configured in its Claim Patentability Analysis Mode (Mode 9) shown in FIGS. 93 through 120B, the user can use the multi-mode analysis and charting system to (i) search for prior art that are relevant and material to any invention (i.e. useful idea) expressed in the form of a patent claim comprising natural language strings as discussed hereinbelow, and following the conventions of any patent granting system involved or being considered by the inventor and/or its patent attorneys and/or agents, (ii) analyze the patentability of the claimed invention in view of discovered prior art, and (iii) generate claim analysis charts that support such patentability analysis and which can be used to help draft the claims of the proper scope and boundaries to help optimize patent claim protection. The prior art references involved in the search and patent claim analysis be patents, patent application publications, scientific and technical articles and/or any other form of information or graphical intelligence, stored in one or more databases and/or information servers on the WWW or other networks, using search engine technology and the like. The system can be used to While configured in its Patent Claim Prosecution Analysis Mode (Mode 0) specified in greater detail in FIGS. 13 through 18C, the user can analyze the patent claim prosecution history of any published patent application including any allowed patent claims, cited prior art references, and patent prosecution history statements that may have been published.

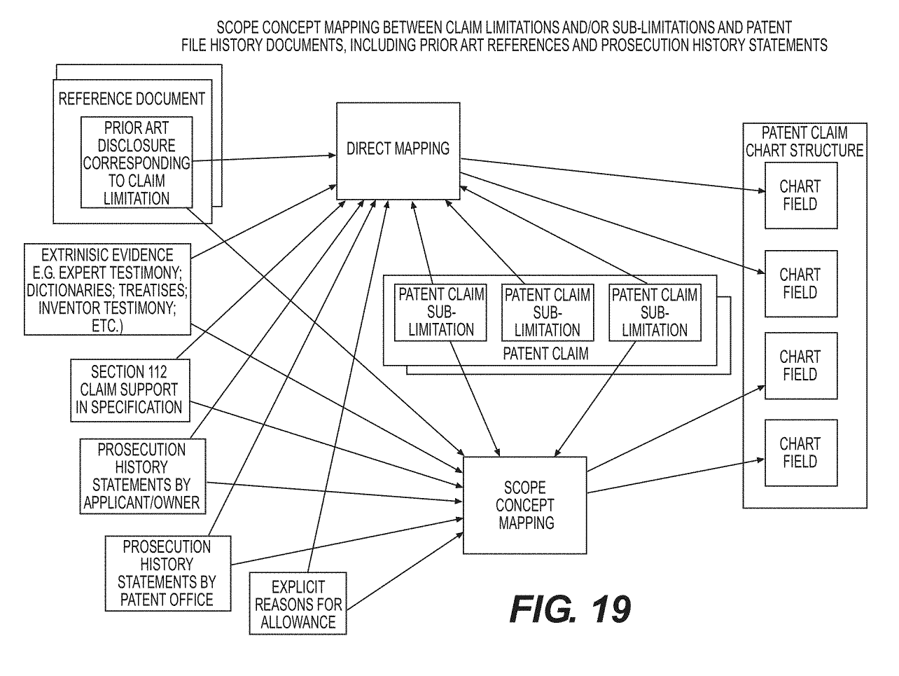

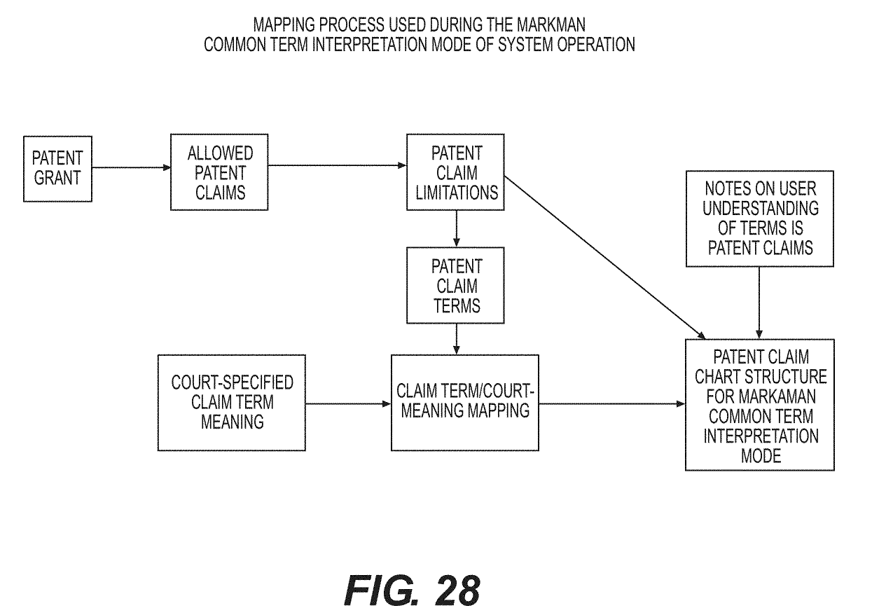

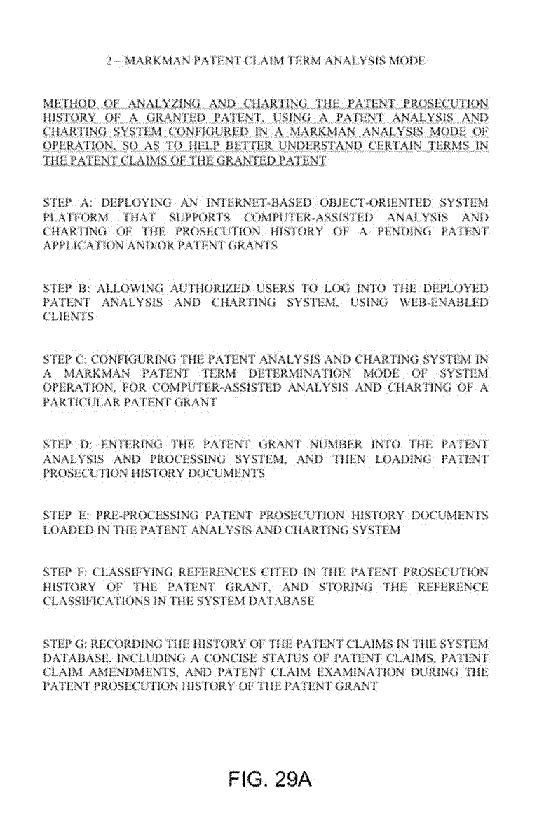

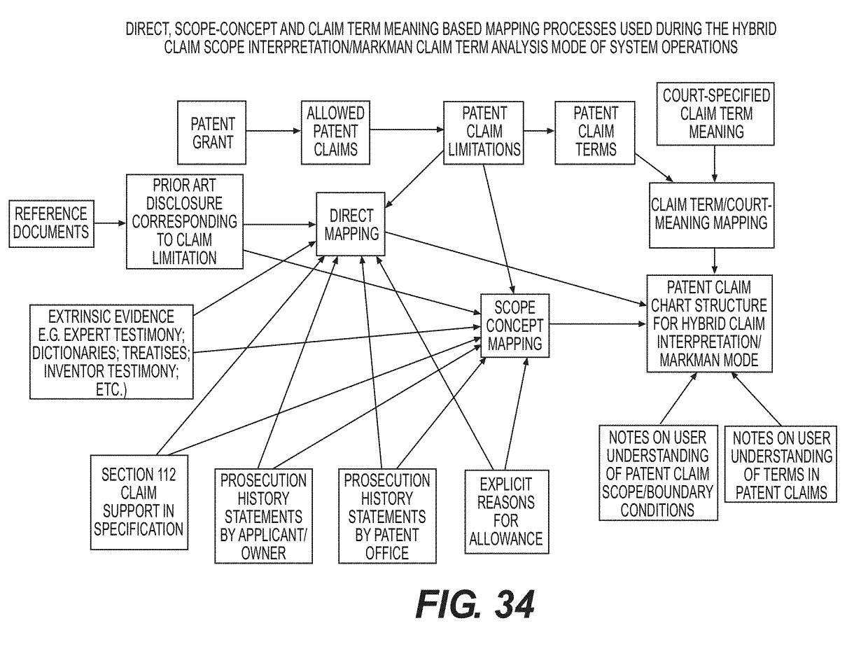

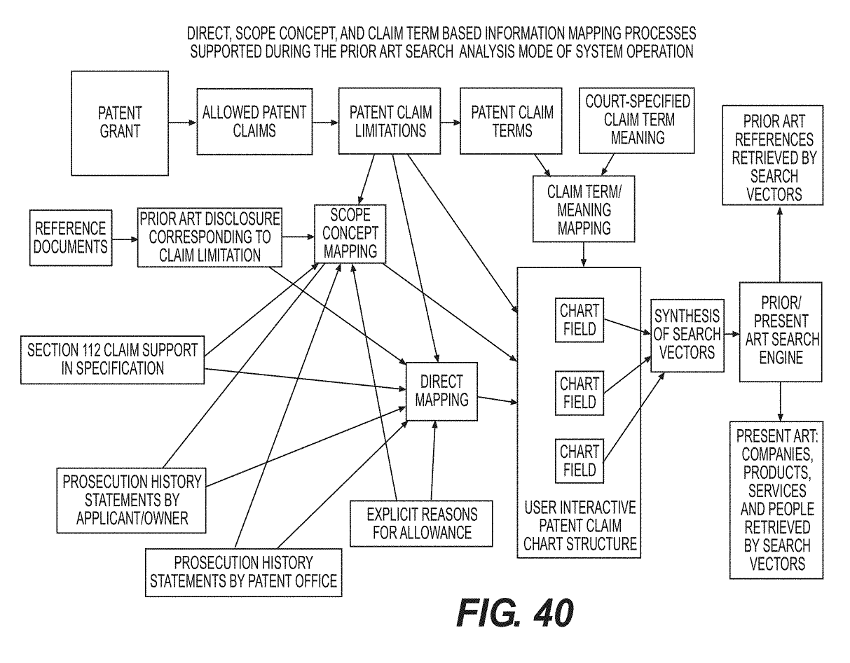

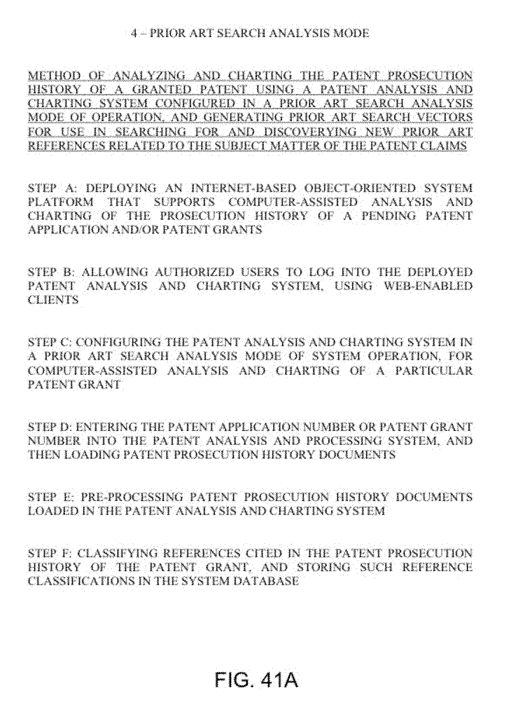

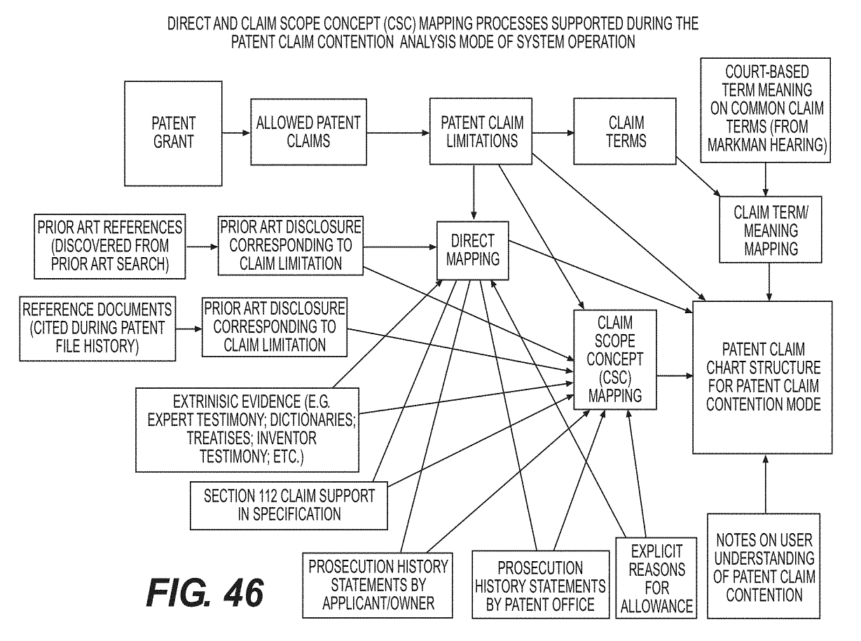

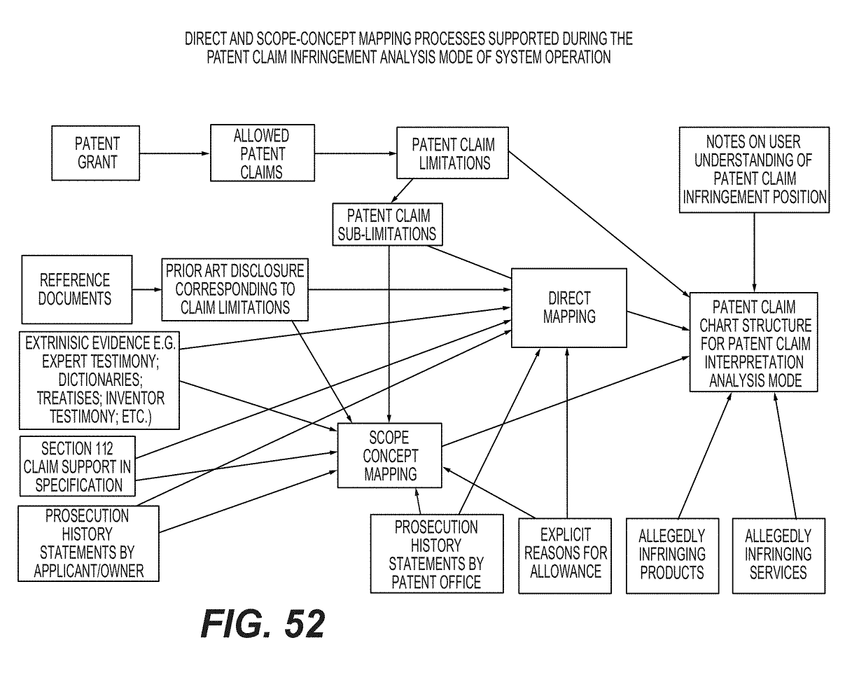

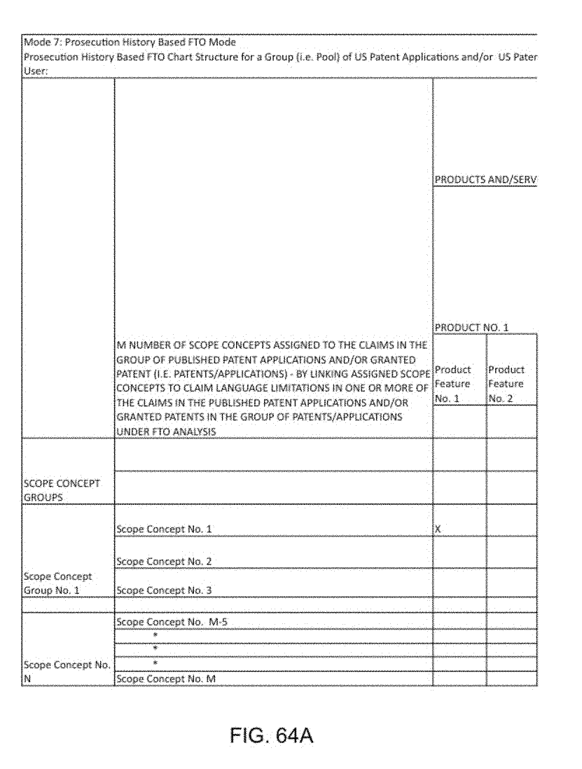

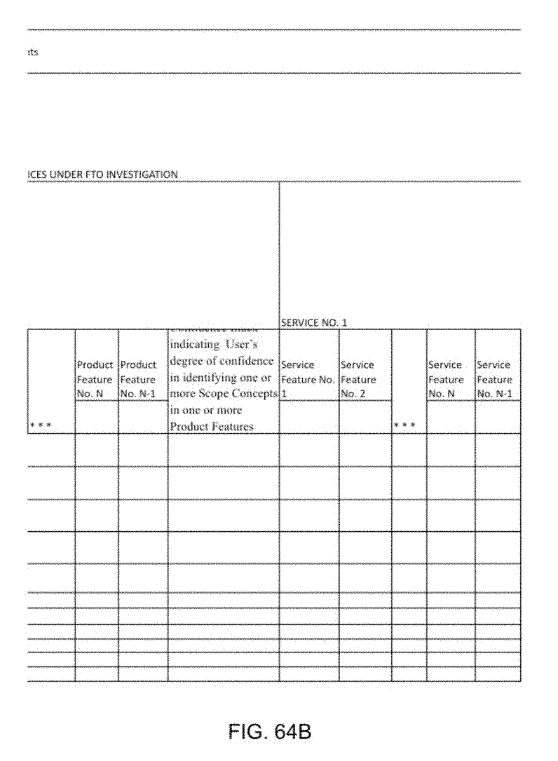

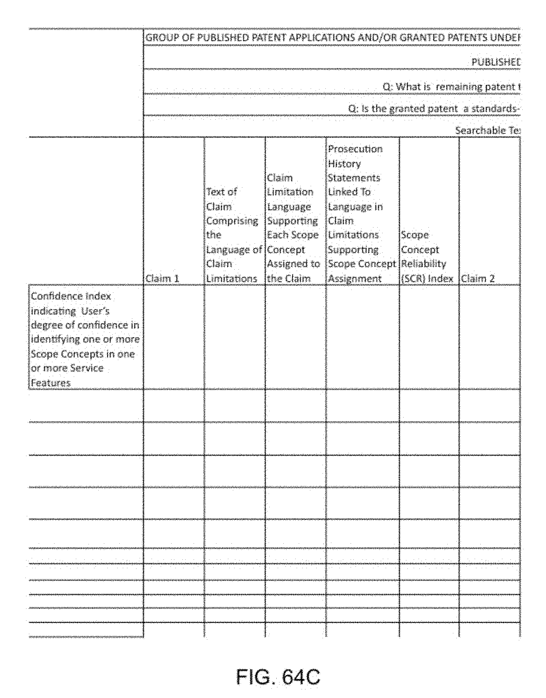

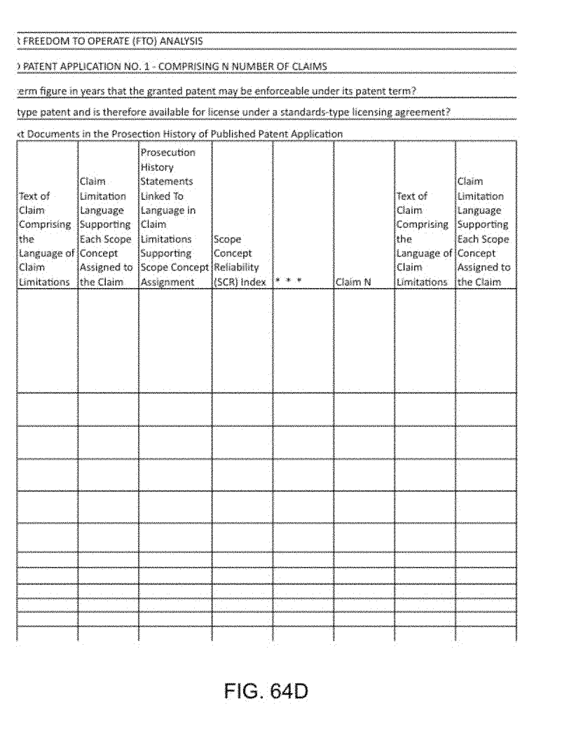

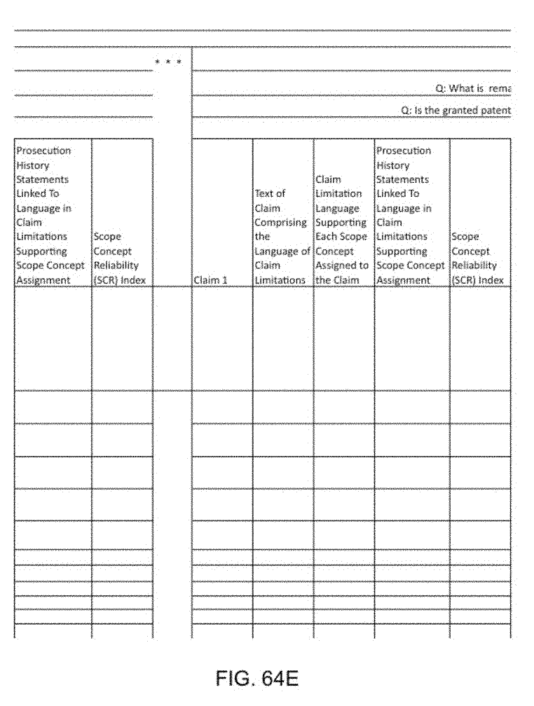

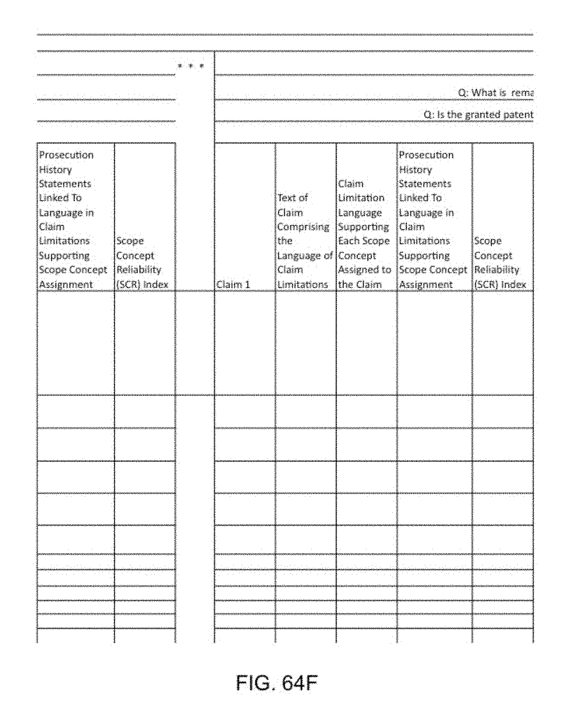

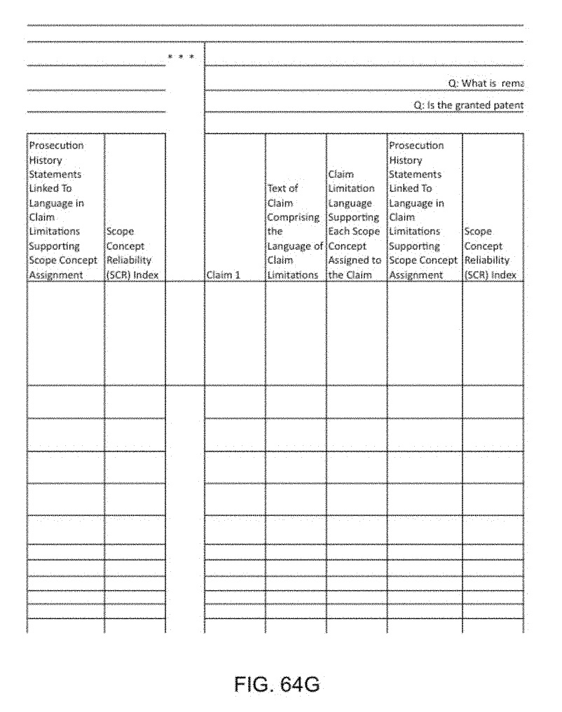

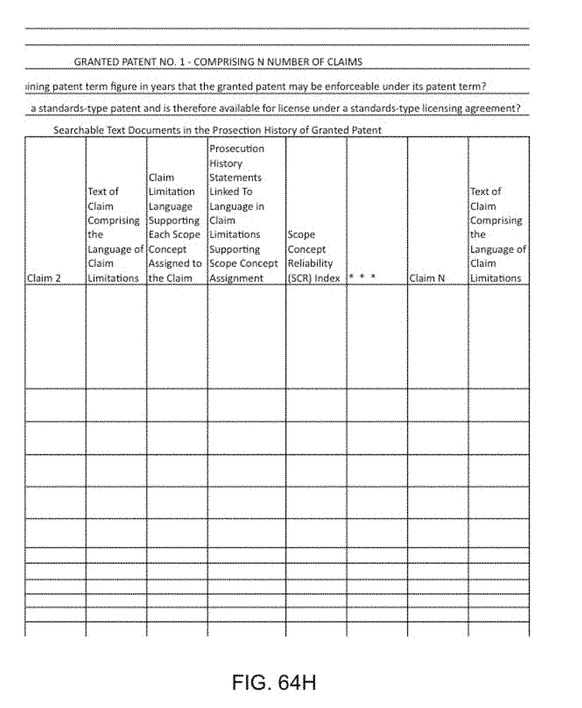

Using the system configured in any one of the following modes of system operation, the user can analyze the patent claim prosecution history of any granted patent including any allowed patent claims, cited prior art references, and patent prosecution history statements: the Patent Claim Scope Interpretation (i.e. Construction) Analysis Mode of operation (Mode 1) specified in FIGS. 19 through 27F; the Markman Patent Claim Term Analysis Mode of operation (Mode 2) specified in detail in FIGS. 28 through 33E; the Hybrid-Type Patent Claim Scope Interpretation/Markman Claim Term Analysis Mode of operation (Mode 3) specified in FIGS. 34 through 39E; the Prior/Present Art Search Analysis Mode of operation (Mode 4) specified in FIGS. 40 through 45G; the Patent Claim Invalidity Contention Analysis Mode of operation (Mode 5) specified in FIGS. 46 through 51H; the Patent Claim Infringement Analysis Mode of operation (Mode 6) specified in FIGS. 52 through 57H; or the Patent Litigation-Storyboard Analysis Mode of operation (Mode 8) specified in FIGS. 64 through 70I.

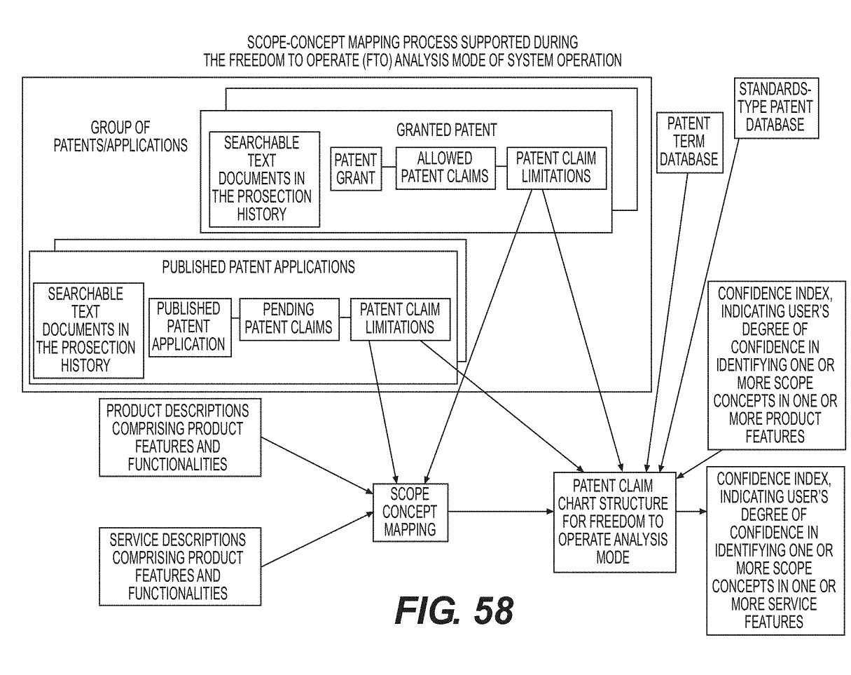

Alternatively, using the system configured in its Freedom to Operate (FTO) Analysis Mode of operation (Mode 7), specified in greater detail in FIGS. 58 through 63K, the user can analyze any group of published patent applications and/or granted (including any allowed patent claims, cited prior art references, and patent prosecution history statements)

As will be described in greater detail hereinafter, using the system of the present invention configured in at least Mode 0, Mode 1, Mode 2, Mode 3, Mode 4, Mode 5, Mode 6, or Mode 8, authorized users can perform the following sequence of tasks: (i) easily link claim rejections and prior art reference disclosure to corresponding limitations in allowed patent claims in a specified granted patent or published patent application; (ii) link prosecution history statements (by applicant(s) and/or the examiner) to corresponding claim limitation and/or sub-limitation language; (iii) formulate and assign scope concepts to the (sub)limitations of the allowed patent claims; (iv) link (i.e. map) cited prior art references to corresponding language in the allowed patent claims using scope concept based mapping techniques; and (v) then automatically generate patent prosecution history based patent charts designed to better help understand the scope and boundaries of patent protection that should be allowed or afforded by the patent claims in each granted patent, against a scope concept mapped prior art landscape.

In Mode 7, supporting FTO analysis, the system is configured to work with numerous granted patents and/or published patent applications at one time, and not a single granted patent or published patent application. Thus, during Mode 7, the user needs to formulate scope concepts that embrace multiple claims from different granted patents and/or published patent applications. Therefore, the system needs to operate differently in the FTO Mode (Mode 7), than in the other modes of system operation, as will be described in greater detail hereinafter.

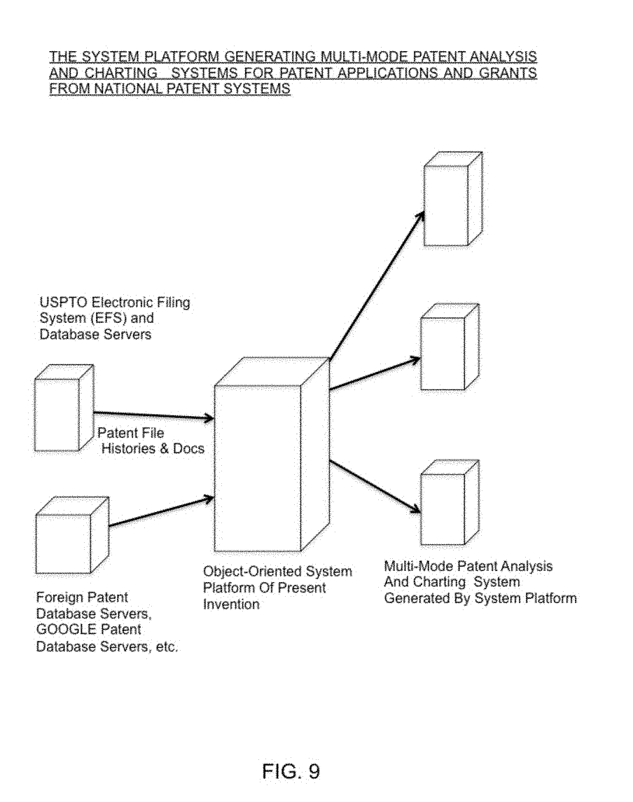

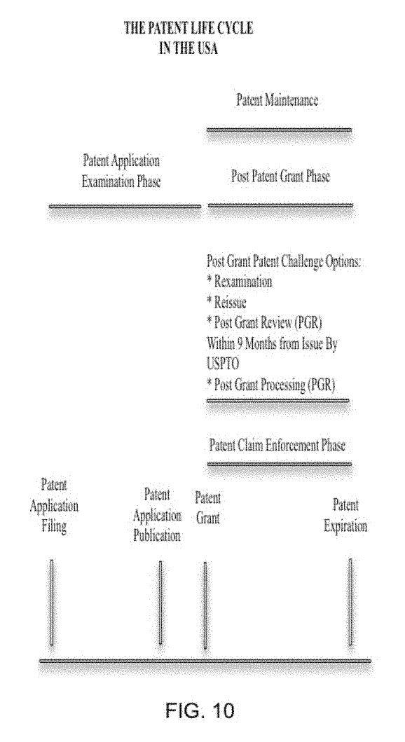

Notably, the patent prosecution history data and user-specific data collected by the user during any logged-in session on the system, will be stored against the particular user account of the logged in user. This user account may be linked to a higher-level group account, containing multiple users, each having specified rights and privileges to use particular services supported on the system in any given mode of system operation. Also, it is understood that work performed and user-data generated by a given user in any one mode of system operation, or by any group of users, can be accessed by the user or group of users when operating the multi-mode system in a different mode of patent analysis and charting. This feature of the system allows users to significantly leverage work done during others stages of patent analysis and/or during the various phases of the patent life-cycle in the USA, illustrated in FIG. 10.

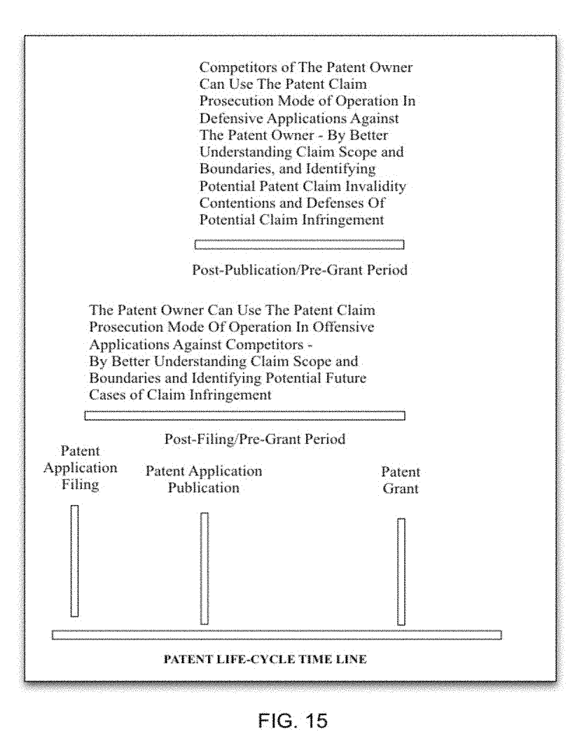

As illustrated in FIG. 10, the multi-mode patent claim analysis and charting system can be used with great advantage and benefit along the various phases of the patent life-cycle. During the pre-grant phase of the US Patent System, the multi-mode system can be configured in its Patent Claim Prosecution Analysis Mode (Mode 0) and be used to analyze and chart the patent claim prosecution history of a specified patent application, as (i) its patent claim prosecution naturally proceeds over time, and (ii) patent file history documents are made available to the public, and therefore can be imported into the system of the present invention for subsequent analysis and charting purposes. As illustrated in FIG. 15, the Patent Claim Prosecution Analysis Mode (i.e. use case) can be practiced by both the patent application owner as well as competitors who might be tracking the progress of a published patent application under examination before the Patent Office, prior to patent issuance.

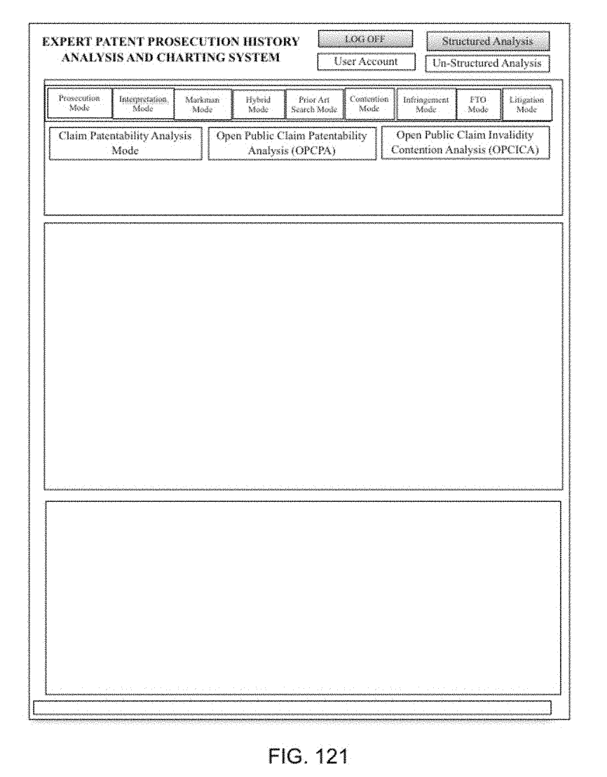

During the pre-grant phase, others modes of system operation, such as the Prior/Present Art Search Analysis Mode (Mode 4) can be used to search for relevant prior art on allowable claims. During the pre-grant phase, the Patent Claim Invalidity Contention Analysis Mode (Mode 5), and Open Public Claim Invalidity Contention Analysis (OPCICA) Mode (illustrated in FIGS. 121 through 127) can be used to develop invalidity contentions against allowable claims in a pending patent application before such claims are actually issued in a patent grant. Also, the FTO Analysis Mode (Mode 7) can be used to conduct FTO clearance studies against published patent claims, as well as granted patent claims, as the case may require.

During the post-grant phase, all other modes of system operation supported by the system (i.e. Modes 1 through 8 except the Patent Claim Prosecution Analysis Mode—Mode 0) can be practiced with excellent results. Notably, the Markman Patent Claim Term Analysis Mode (Mode 2), the Hybrid-Type Patent Claim Scope Infringement/Markman Analysis Mode (Mode 3), the Patent Claim Infringement Analysis Mode (Mode 6) and the Patent Litigation-Storyboard Analysis Mode (Mode 8) will may involve analyzing and charting granted patents that are involved in patent litigation. The Private and Open-Public Patent Claim Patentability Analysis Modes (Mode 9) may be used to analyze and chart one or more patent claims that are pending or which have been allowed in a pending patent application. The Patent Claim Invalidity Contention Analysis (Mode 5) can be used to analyze and chart one or more patent claims that have been allowed in a granted patent. Also, it is understood that any of these modes of patent analysis and charting can be practiced in actual as well as simulated environments, involving what-if scenario conditions, typically considered by patent attorneys and strategists.

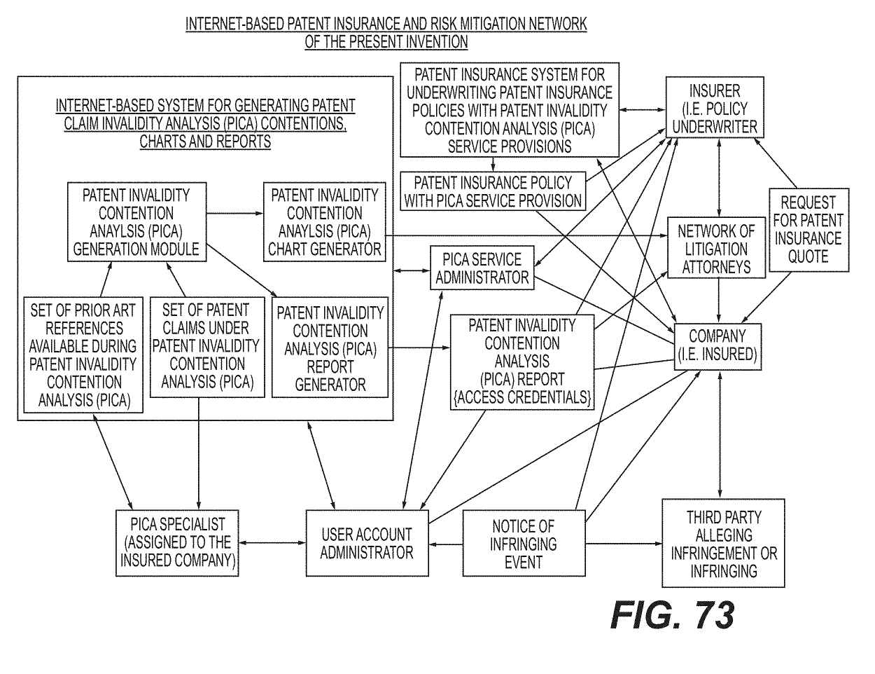

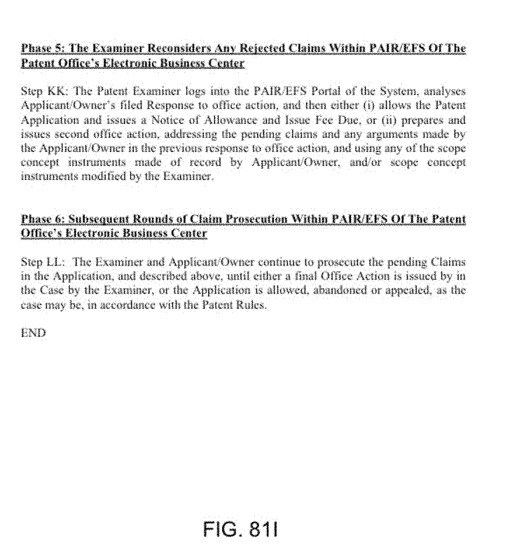

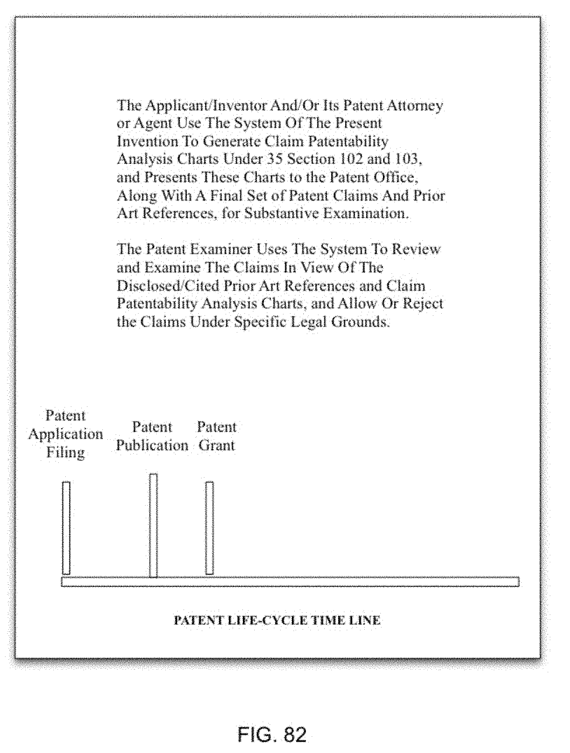

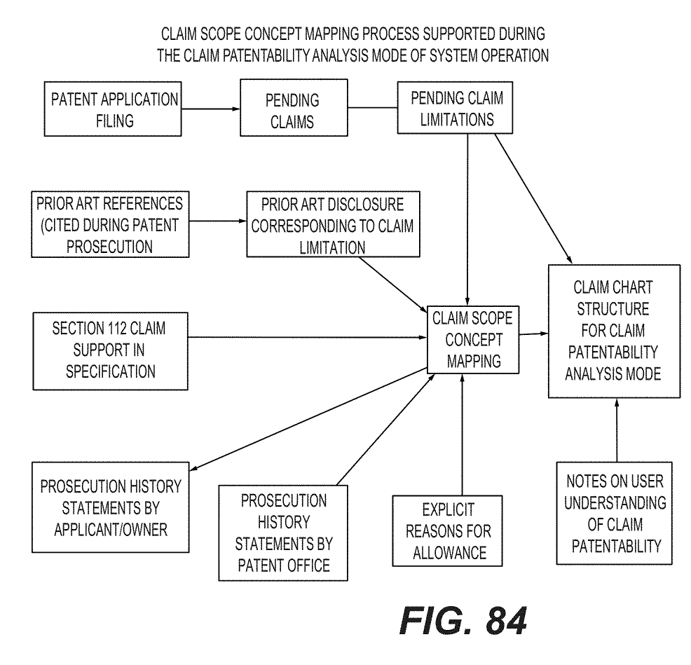

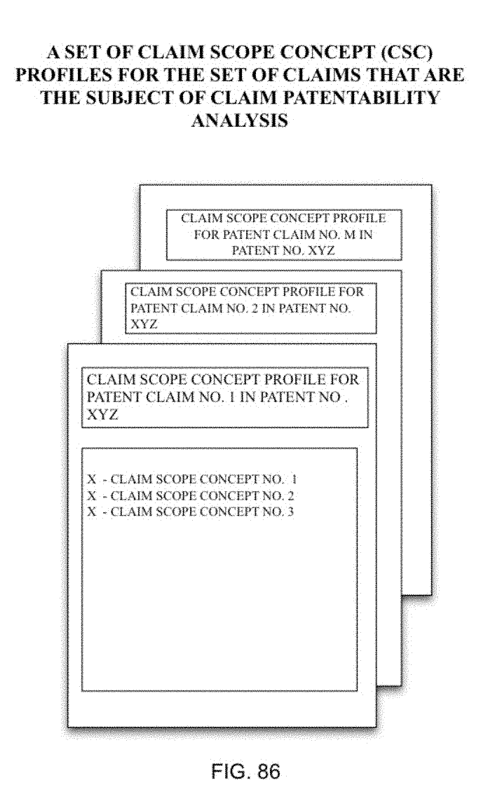

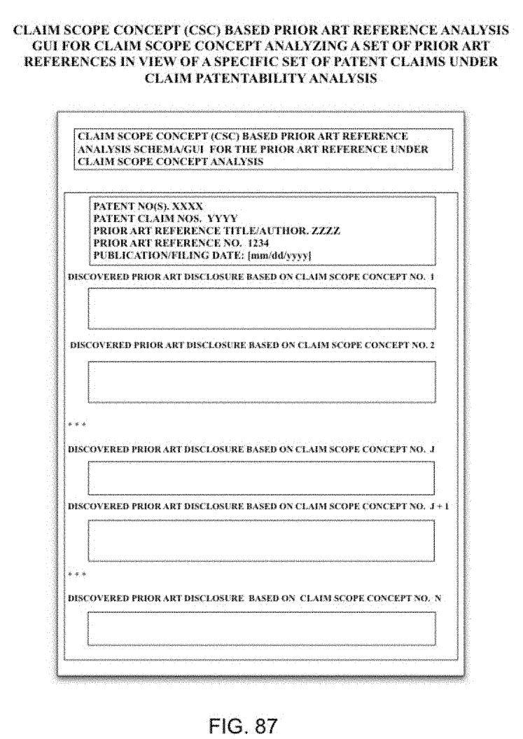

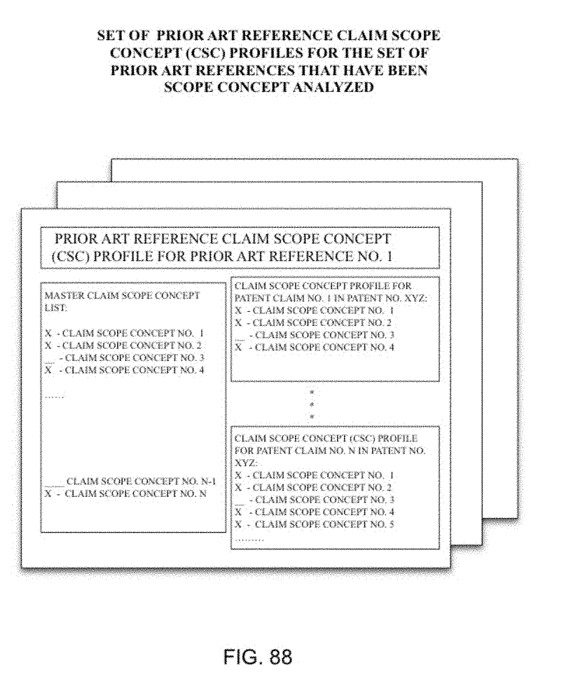

Notably, the computer-implemented methods disclosed in FIGS. 73 through 120B, relating to claim automated/computer-assisted claim search analysis, claim patentability analysis, and cumulative prior art reference analysis, can be considered as a new mode of system operation (e.g. Mode 9), and be incorporated into the multi-mode system 5, and made accessible to authorized users like all other modes of system operation supported therein. Also, the functionalities supported in this Mode 9 can be added to the preexisting Modes 0, 1, 3, 4 and others to transform and augment these modes of system operation so that authorized users can perform automated/computer-assisted claim search analysis, claim patentability analysis, and cumulative prior art reference analysis described in greater detail in FIGS. 93 through 120B.

Also, the computer-implemented methods disclosed in FIGS. 93 through 120B, relating to automated/computer-assisted cumulative prior art reference analysis can be incorporated into Internet-based system 300 to transform and augment this system so that authorized users can perform automated/computer-assisted cumulative prior art reference analysis described in FIGS. 93 through 120B, which should be very helpful during the prior art searching, analysis and claim examination process.

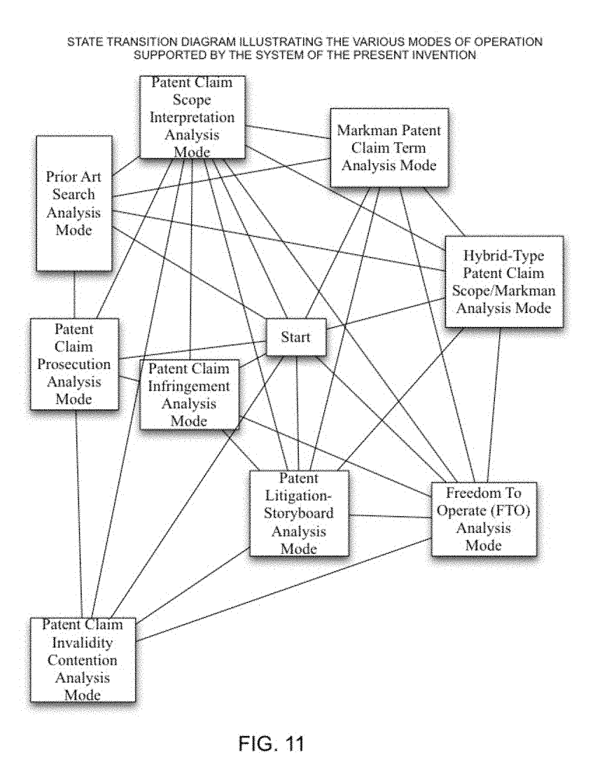

In FIG. 11, the mode transition diagram illustrates the various modes of system operation supported by the multi-mode system of the illustrative embodiment, and also various pathways for mode transition within the system. It is understood in other embodiments of the present invention, the multi-mode system can have different mode transition pathways. Clearly, as shown from the START point in the mode transition diagram, authorized users have great flexibility in choosing how to use the system, for any particular purpose, at any particular phase of the life-cycle of a single granted patent, a published patent application, and/or a group of granted patents and/or published patent applications. However, there are some logical constraints imposed on mode transition determined by the nature of certain phases of the patent life-cycle. For example, a patent claim infringement analysis typically requires there be a granted patent and allegedly infringing products and/or services, and a Markman patent claim term analysis requires a litigation and parties disputing terms in the claims of a patent involved in a patent litigation. Also, during an FTO analysis, it is expected that particular patent claims will require a further, more deeper analysis, and once such patent claims have been identified and analyzed during an FTO analysis, it will be helpful to transition the system of the present invention into its Patent Claim Scope Interpretation Mode (Mode 1), Patent Claim Invalidity Contention Mode (Mode 5) and/or Prior/Present Art Search Analysis Mode (Mode 4) from the FTO Analysis Mode (Mode 7). Notably, in the event that Mode 9, comprising the functions specified in FIGS. 93 through 102B, are added to the multi-mode system 5, then this state transition diagram will also include one or more state transitions to reflect such added functionalities. Also, the relational database model of the RDBMS 15 will be modified to support these added functionalities, as will become apparent hereinafter.

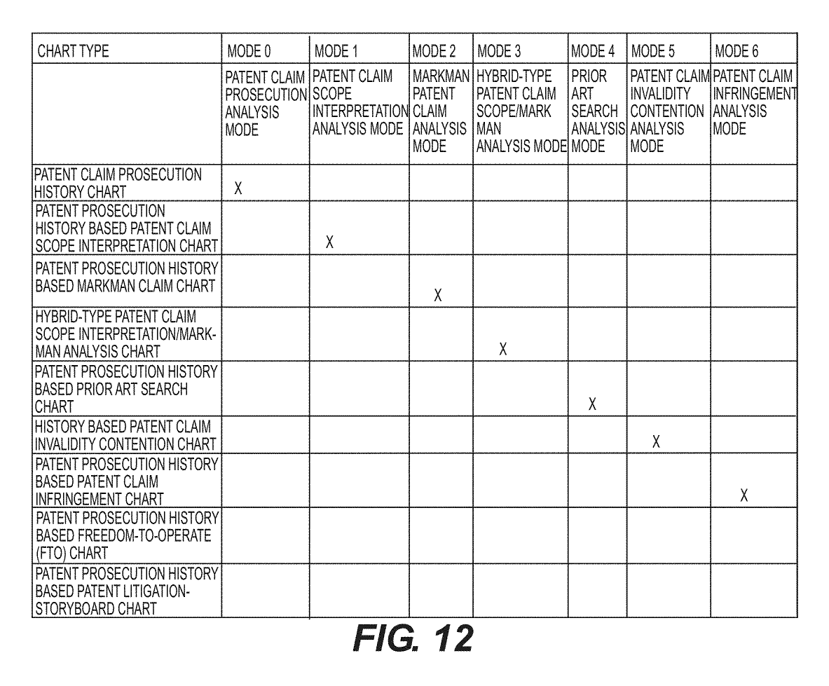

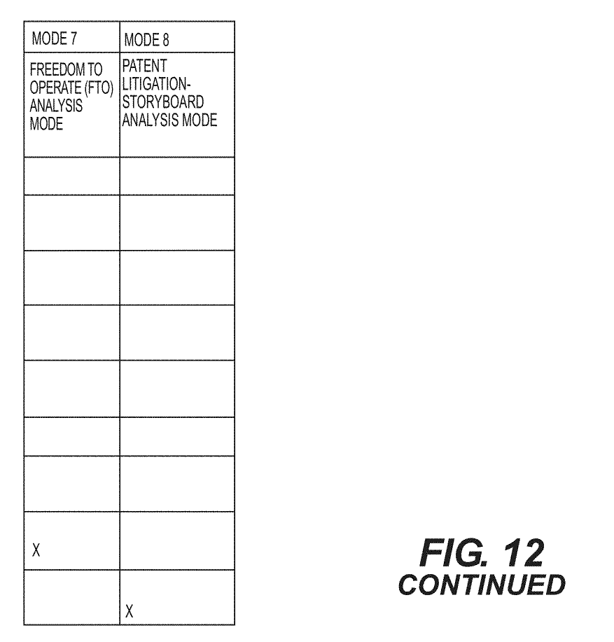

FIG. 12 specifies the different types of chart structures generated during each mode of the multi-mode patent claim analysis and charting system of the illustrative embodiment of the present invention. In general, each chart structure is realized as an XML-based Microsoft® Excel™ spreadsheet structure, with accordion-type or collapsible columns, to facilitate the easy display of particular columns and rows of the chart structure, as required by most users and/or user-groups. Using XML-based spreadsheet-type claim scope schema (CSS) chart structures, the user can download the spreadsheet-based chart structure to a desktop environment, fill in particular fields (e.g. notes) within the XML-based spreadsheet-type claim scope schema (CSS) chart structure, and then upload the updated spreadsheet chart structure to the system database, via XML mapping operations supported on the system platform of the present invention. A summary of these chart-types for a given system mode of patent analysis and charting is set forth below:

MODE 0: Patent Claim Prosecution Analysis Mode—patent prosecution history based claim scope concept (CSS) chart structures

### MODE 1: Patent Claim Scope Interpretation/Construction Analysis Mode—Patent Prosecution History Based Patent Claim Scope (Interpretation) Charts

### MODE 2: Markman Patent Claim Analysis Mode—Patent Prosecution History Based Markman Claim Charts

### MODE 3: Hybrid-Type Patent Claim Scope Interpretation/Markman Analysis Mode—Hybrid Patent Prosecution History Claim Charts

### MODE 4: Prior/Present Art Search Analysis Mode—Patent Prosecution History Prior Art Search Charts

### MODE 5: Patent Claim Invalidity Contention Analysis Mode—Patent Prosecution History Based Patent Claim Invalidity Contention Charts

### MODE 6: Patent Claim Infringement Analysis Mode—Patent Prosecution History Based Patent Claim Infringement Charts

### MODE 7: Freedom to Operate (FTO) Analysis Mode—Patent Prosecution History Based Freedom-To-Operate (FTO) Charts

### MODE 8: Patent Litigation-Storyboard Analysis Mode—Patent Prosecution History Based Patent Litigation-Storyboard Charts

MODE 9: Claim Patentability Analysis Mode—Claim Patentability Charts, and Cumulative Prior Art Reference Charts (FIGS. 93 through 120B)

### OPEN PUBLIC MODES: Claim Patentability Analysis, Prior Art Search Analysis, and Claim Invalidity Contention Analysis

Overview on Patent Analysis Methods Involving the Use of a Claim Scope Markup Language (CSCML) and Machine-Implemented Techniques for Scope Concept Based Processing (CSBP) of Patent Claim and Prior Art Reference Documents in Accordance with the Principles of the Present Invention

As will be described in greater detail hereinafter, the multi-mode patent analysis and charting system 5 and the patent application filing, searching, prior art disclosure, and claim examination system of the present invention 300, each support novel computer-implemented methods and tools for the definition, identification and/or assigned of Scope Concepts to specific claim limitation and/or sub-limitation language recited in a set of Patent Claims, in one or more Patent Applications and/or granted Patents, under analysis. In the preferred embodiments of the present invention, these computer-implemented methods involve the use of several different components, namely: (1) Patent Claims expressed in natural human language represented in a document or file type, and marked up in an electronic markup language that identifies user-defined Scope Concepts reflected within the claim limitation and/or sub-limitation language of Patent Claims, and this markup language is referred to hereinafter “Claim Scope Concept Markup Language (i.e. CSCML); (2) Searchable (OCR-encoded) Prior Art Reference documents containing natural human language, as well as mathematics and/or machine/computer language, represented in a document or file type, also created using a suitable markup language (e.g. OCR PDF); and (3) Scope Concept Based Processing (CSBP) Methods supported by one or more machine-implemented algorithms (i.e. programs) implemented in a programming language, and designed to initially or further process the Patent Claim (marked-up or otherwise) and Prior Art Reference documents, generate particular Scope-Concept based data structures, and carry out various processes designed to enable the efficient automation of patent claim analysis involving people interested in a field of invention, the practice of patent law, and/or product and/or service development, marketing, sales, business and/or commerce, anywhere around the world.

When working together as a system, the computer-implemented systems and methods of the present invention enable unprecedented levels of automation in the field of patent law practice, wherein patent claim analysis and charting operations are automated, to a great extent, so as to assist patent attorneys in making more informed decisions and judgments about the scope and boundaries of patent claims before filing, during prosecution, and after grant, while increasing the speed of service delivery and reducing the cost thereof to clients.

In general, the Claim Scope Concept Markup Language could be a hybrid type of electronic markup language including: (i) presentational markup code (i.e. tags), such used by conventional/traditional word-processing systems, providing instructions to programs as to how the Claim language should be presented during display, printout, viewing etc; (ii) procedural markup code (i.e. tags) embedded in the Claim text, providing specific instructions to programs as to how specifically tagged Claim language, e.g. corresponding claim limitation/sub-limitation language linked to the assigned Scope Concepts, should be processed; and (iii) descriptive markup code (i.e. tags) used to label/tag the claim limitation language and/or claim sub-limitation language assigned to Scope Concepts (encompassing Inventive Features reflected in the Claim language), rather than providing instructions on how to process tagged claim limitation language assigned to Scope Concepts in a Claim document.

Also, it is preferred that CSCML is defined as a SGML-based language, described by ISO 8879:1986 SGML—which is an ISO-technology standard for defining generalized markup language for documents. As is well known, the ISO 8879 Standard defines Generalized Markup as being based on two axioms, postulates or premises, namely: (1) that markup should be declarative, in that, it should describe a document's structure and other attributes, rather than specify the processing to be performed on it, because declarative markup is less likely to conflict with unforeseen future processing needs and techniques; and (2) markup should be rigorous so that the techniques available for processing rigorously-defined objects like programs and databases can be used for processing documents as well. HTML, XHTML and XML are all examples of SGML-based markup languages.

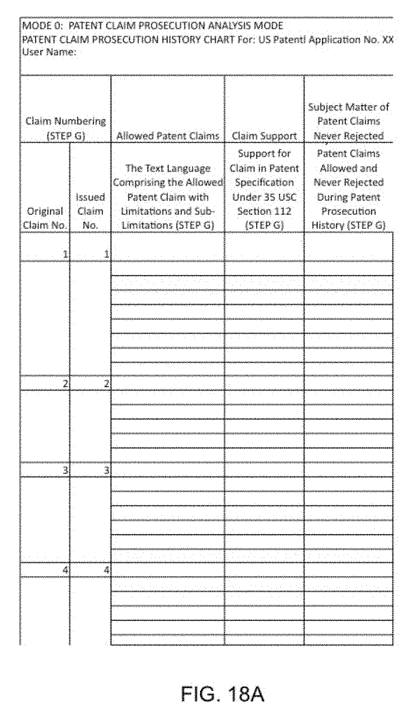

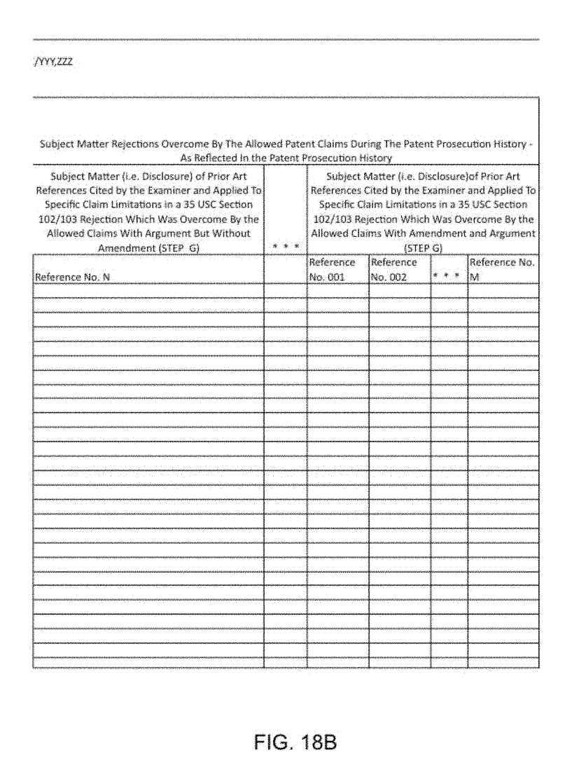

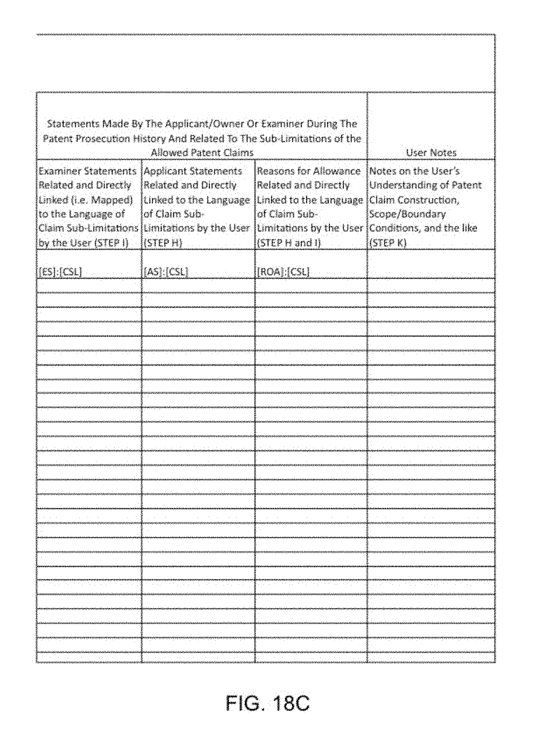

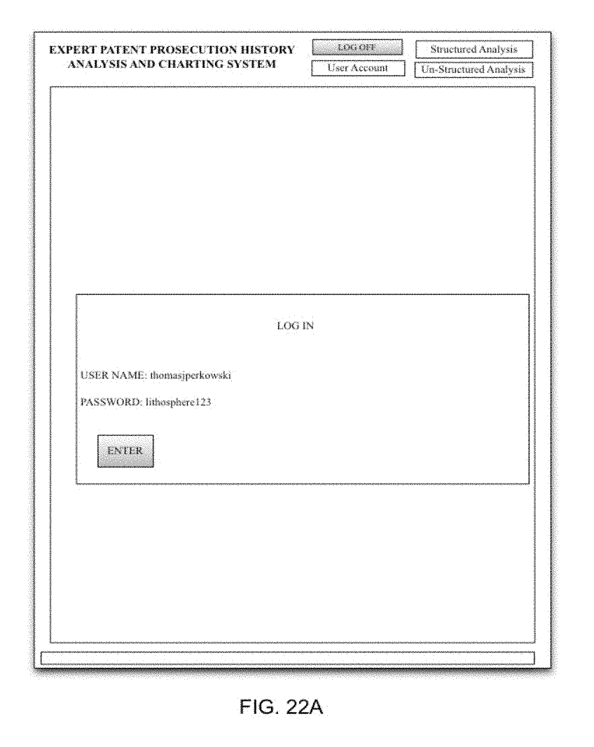

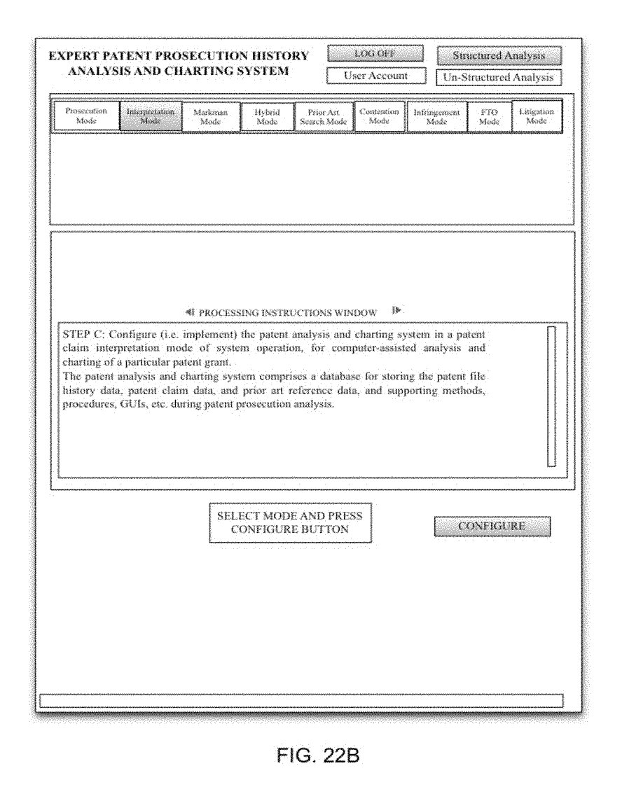

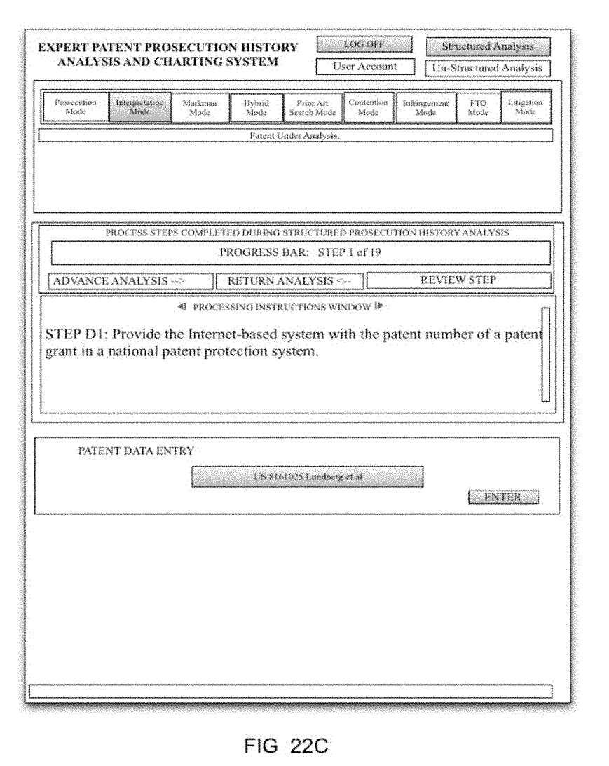

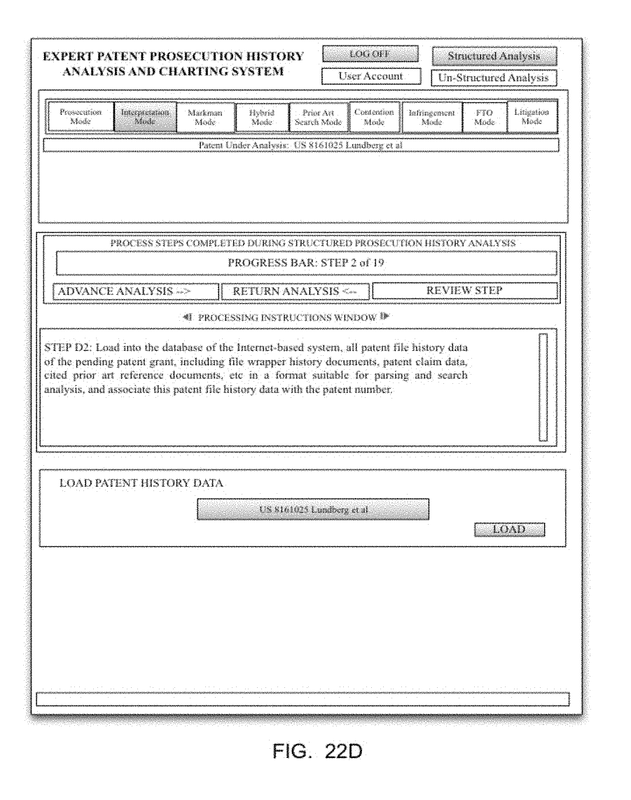

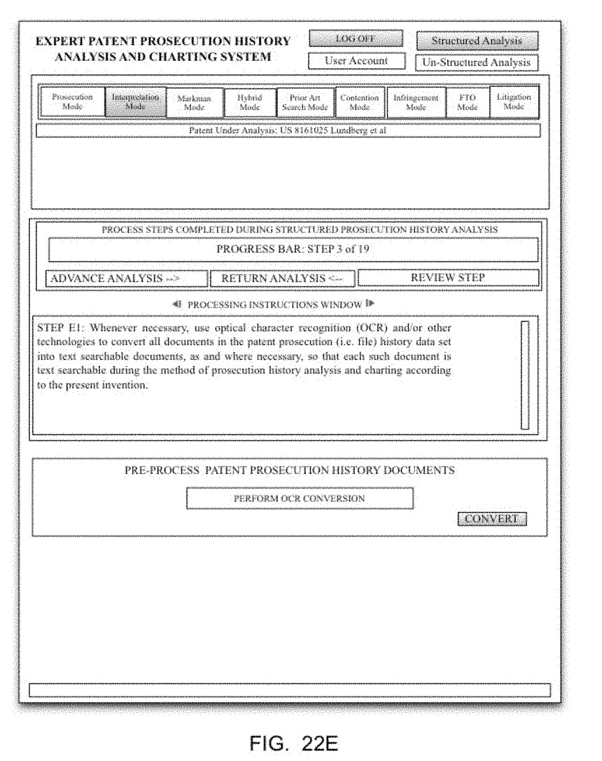

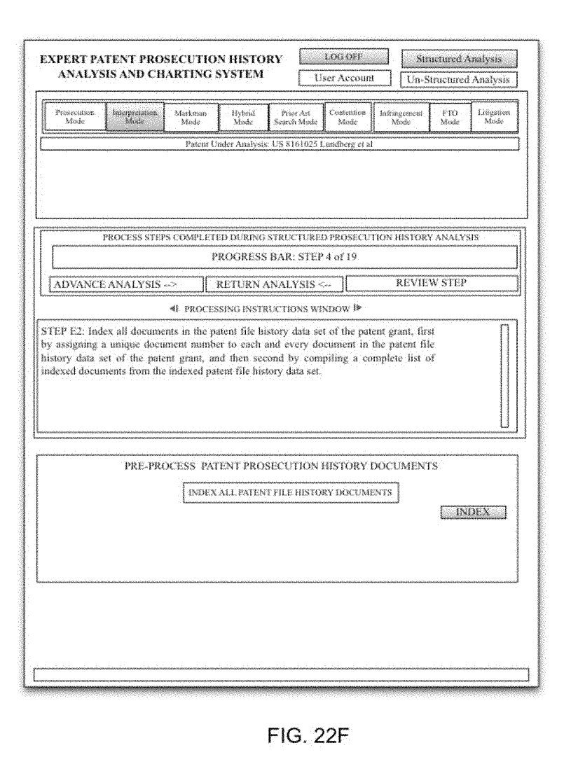

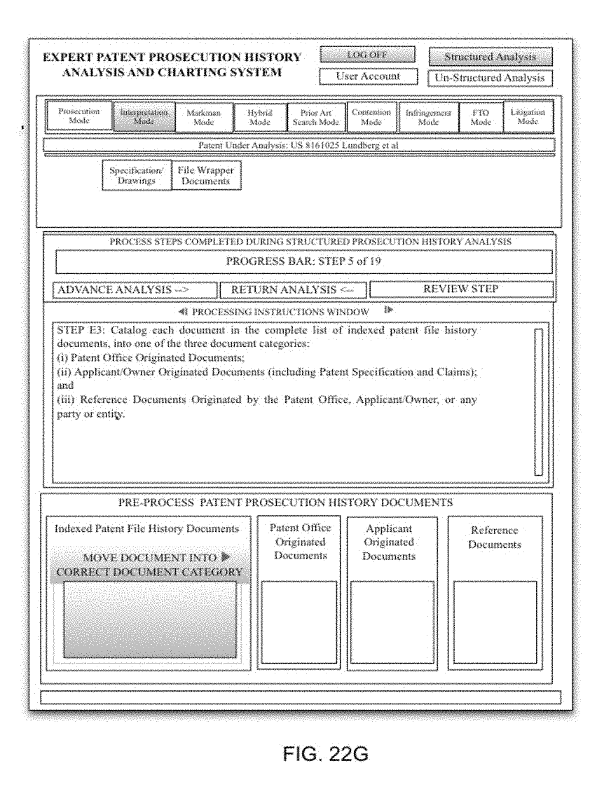

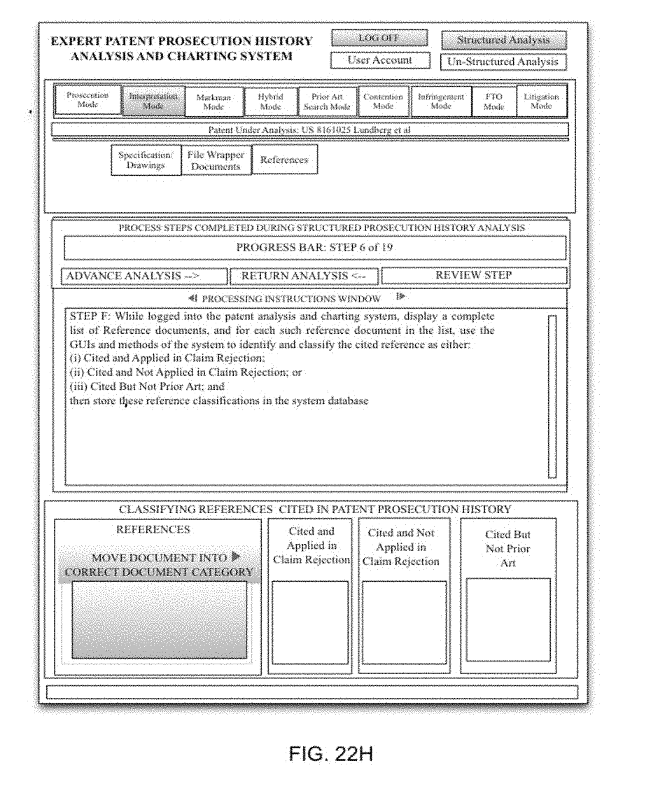

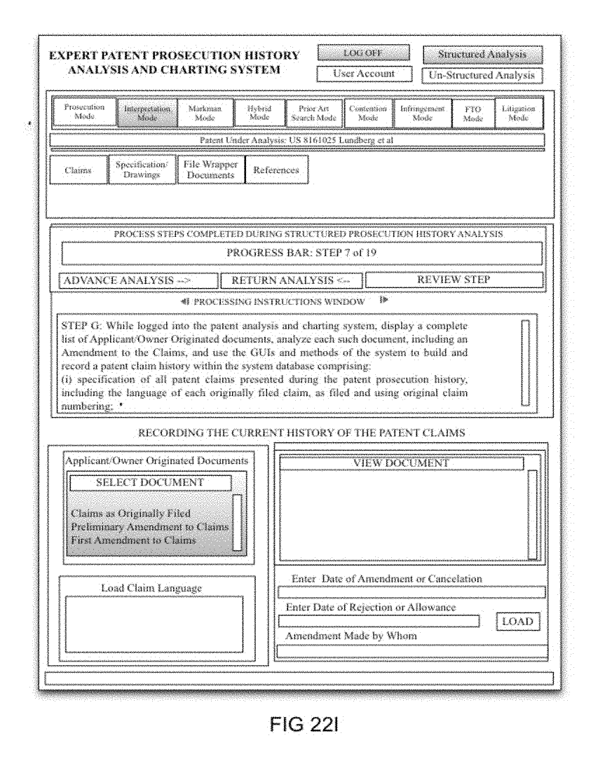

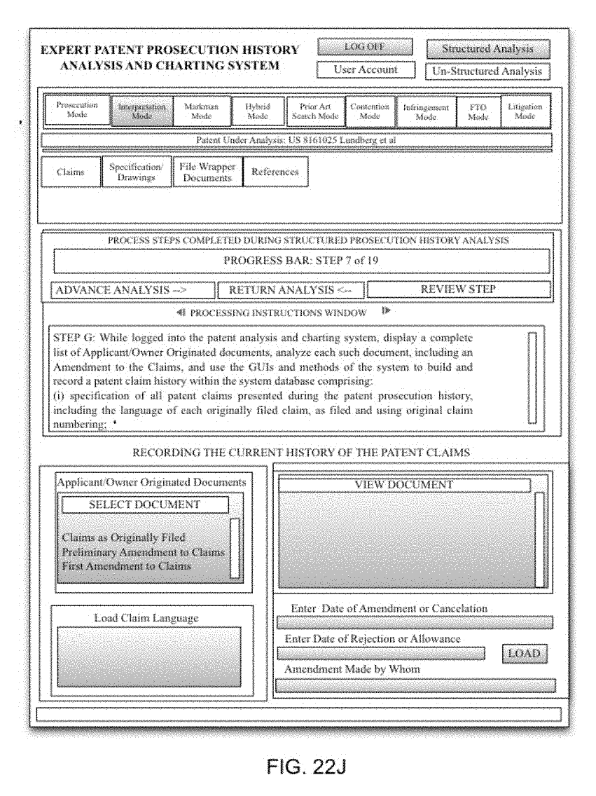

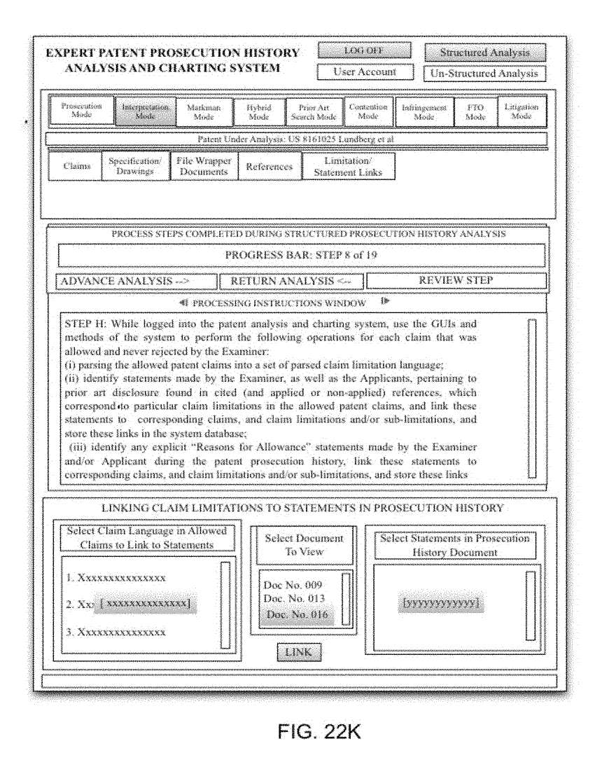

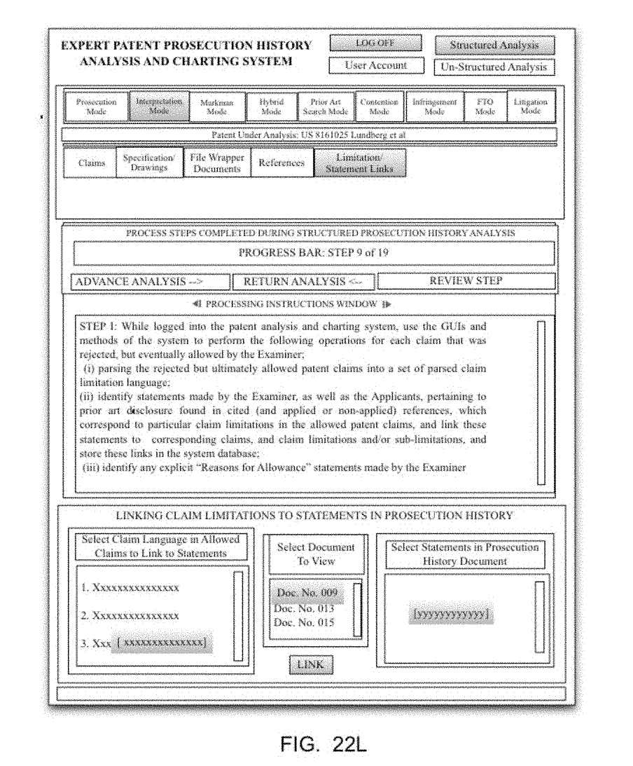

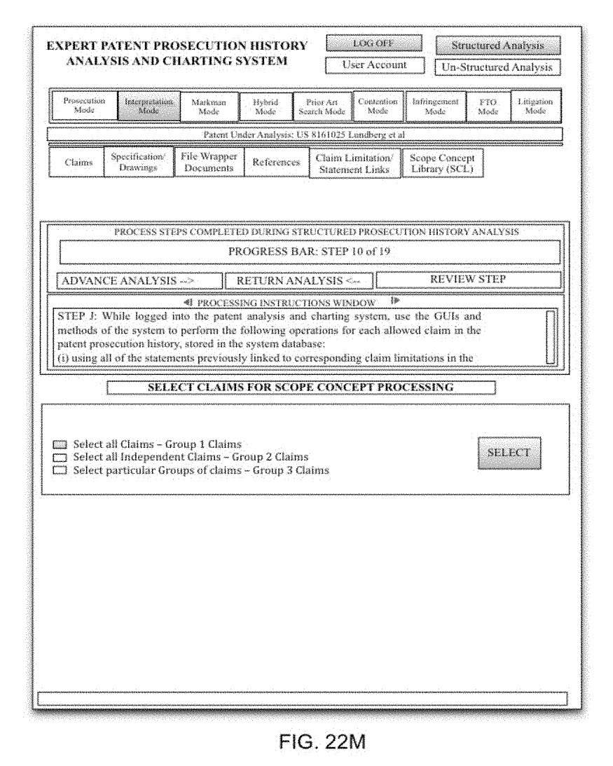

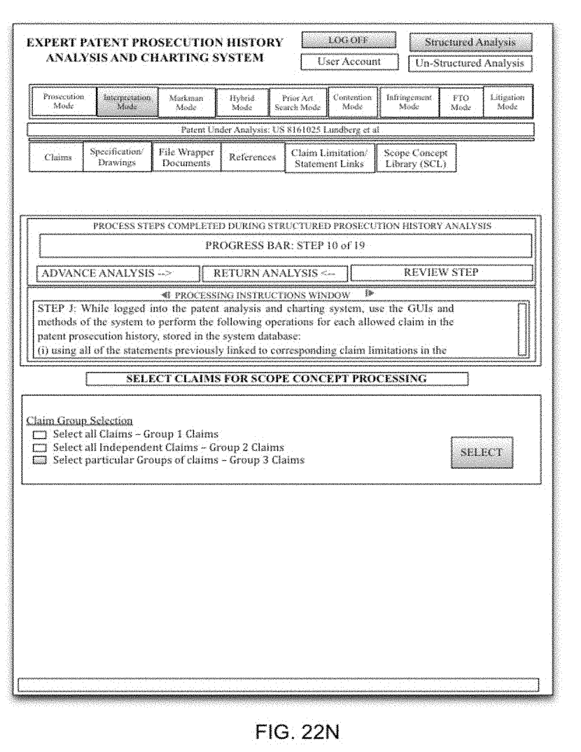

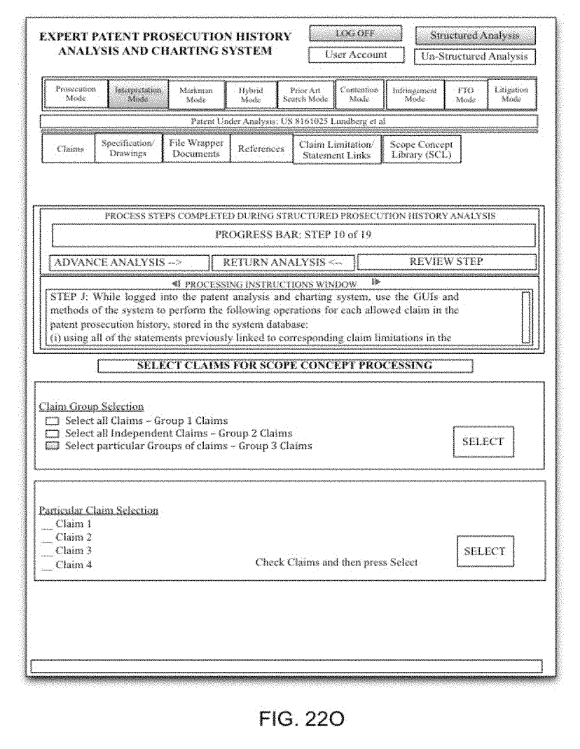

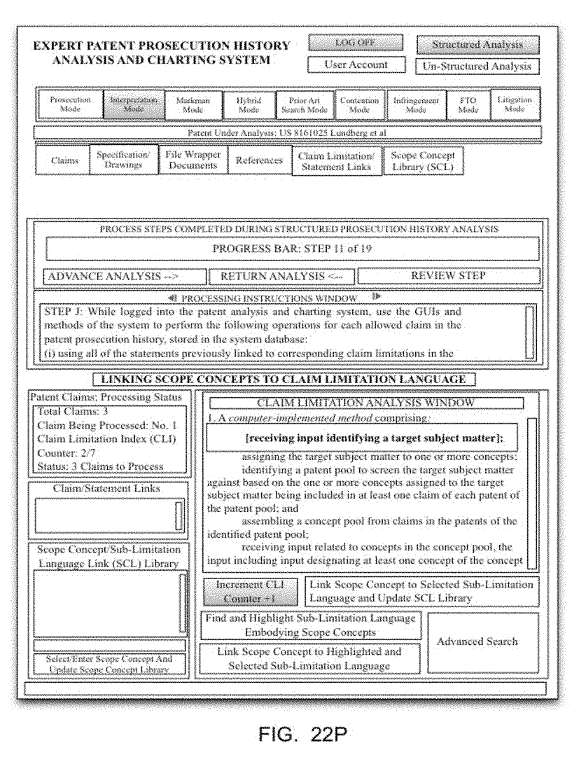

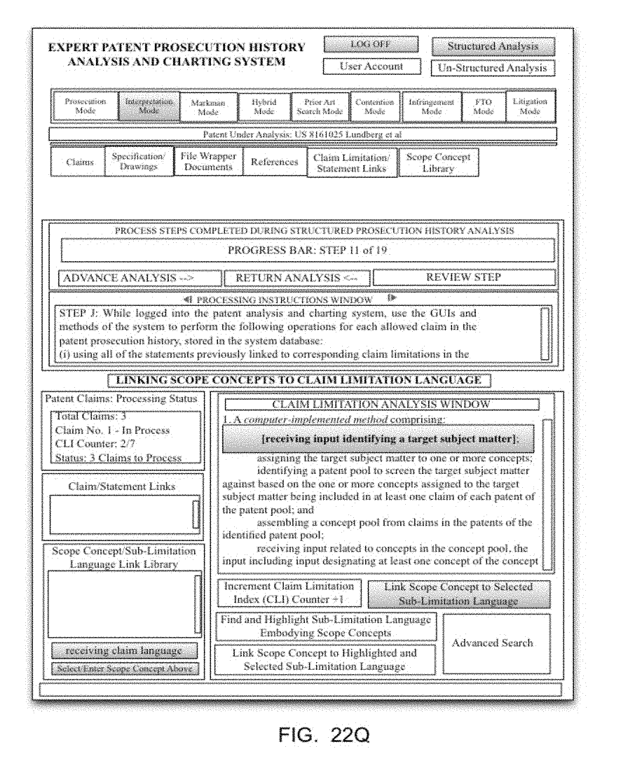

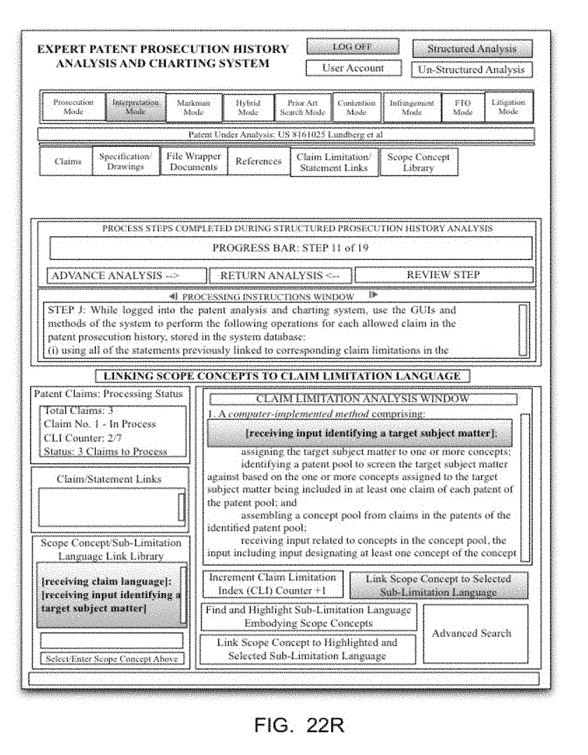

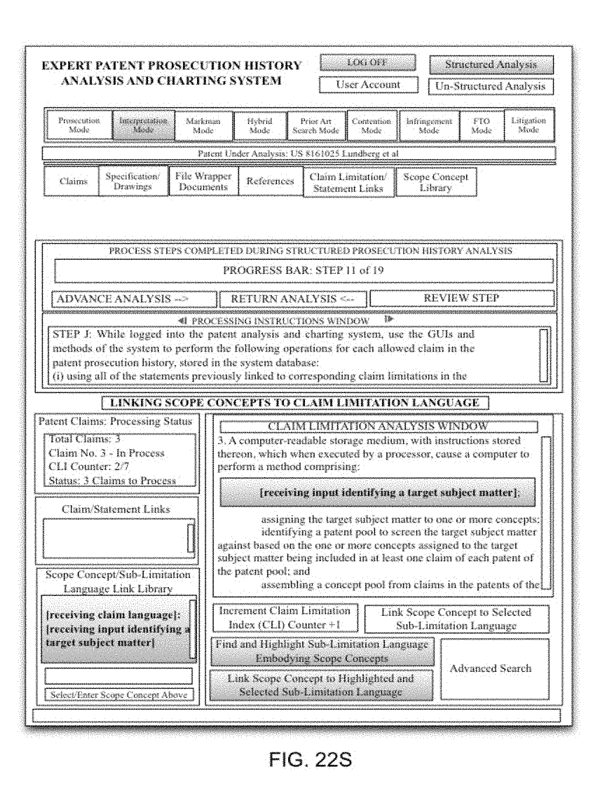

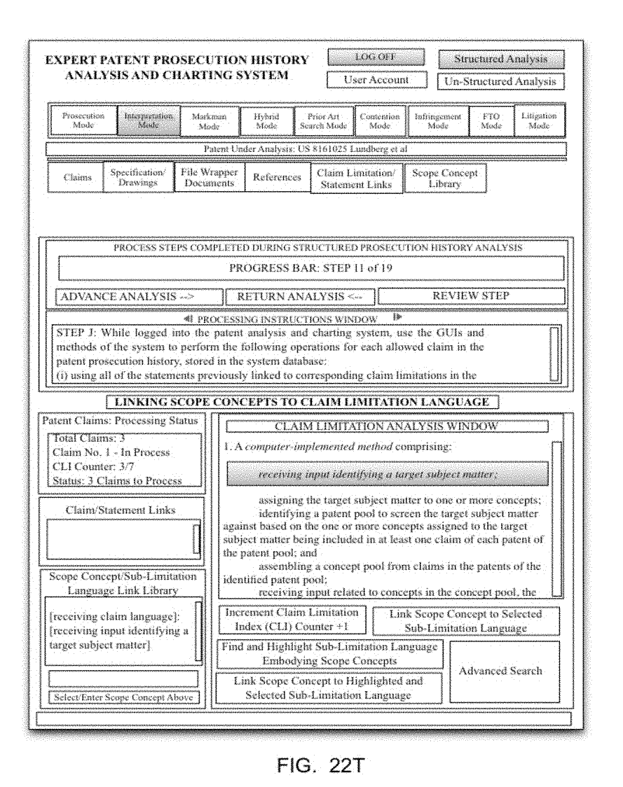

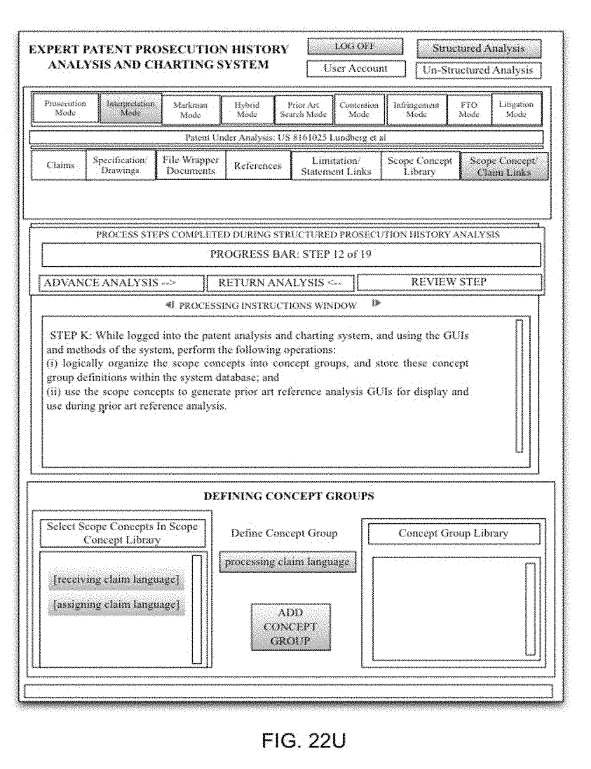

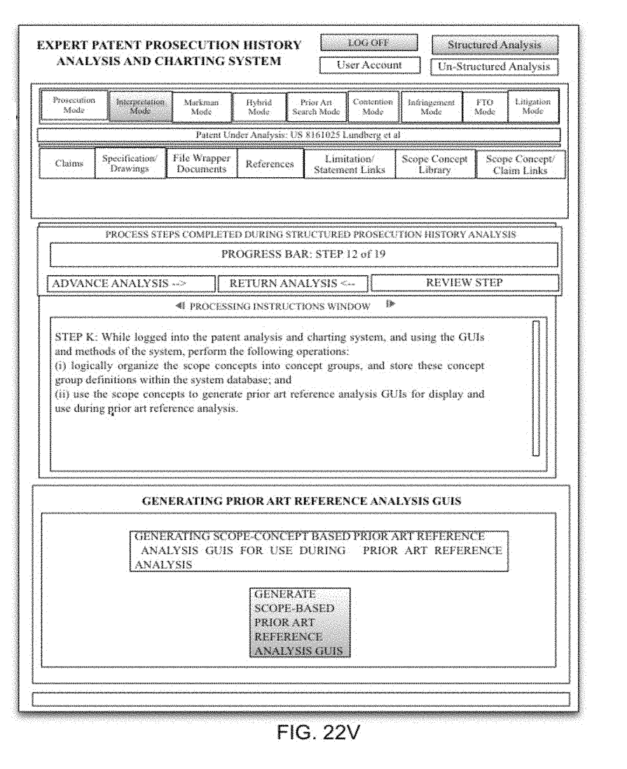

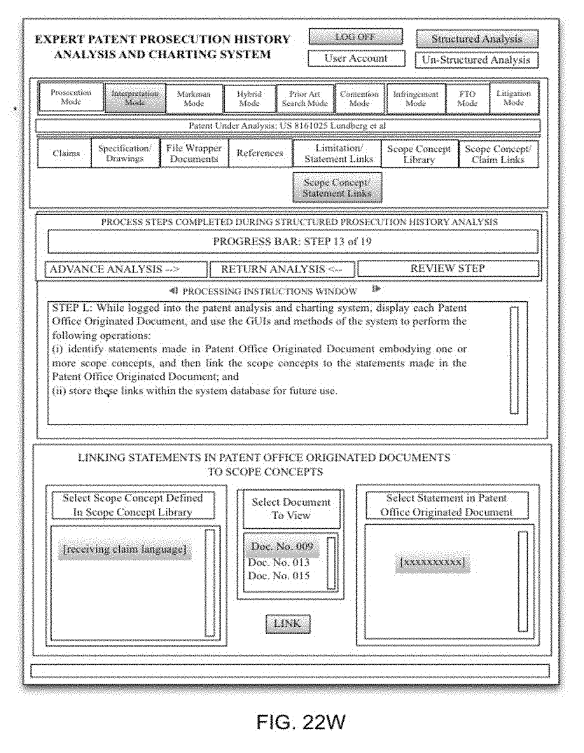

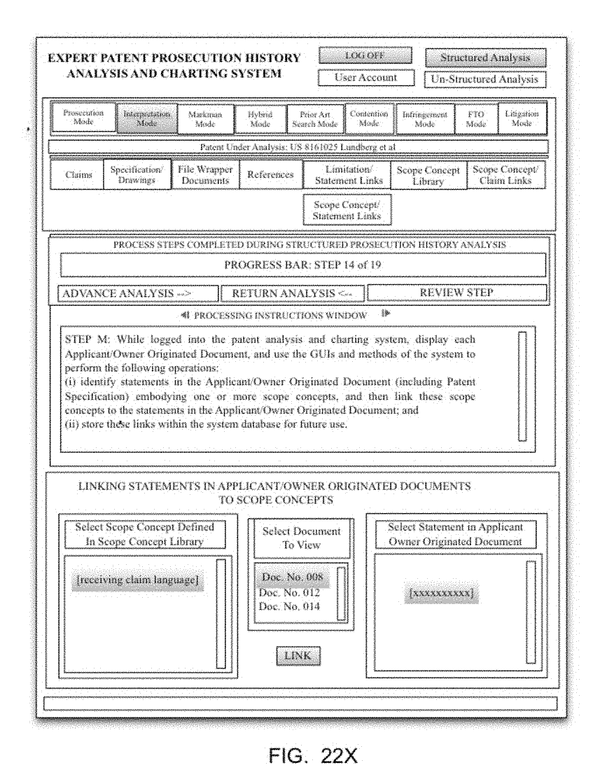

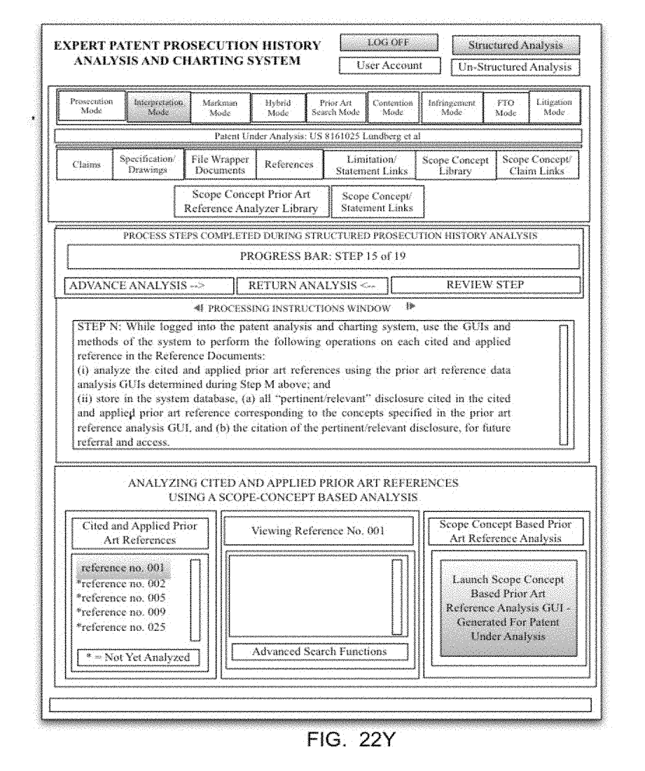

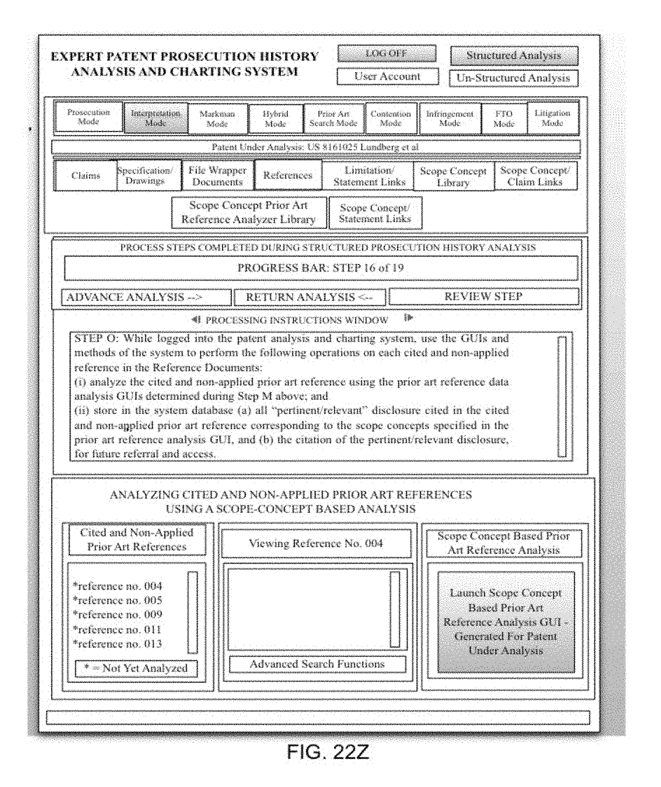

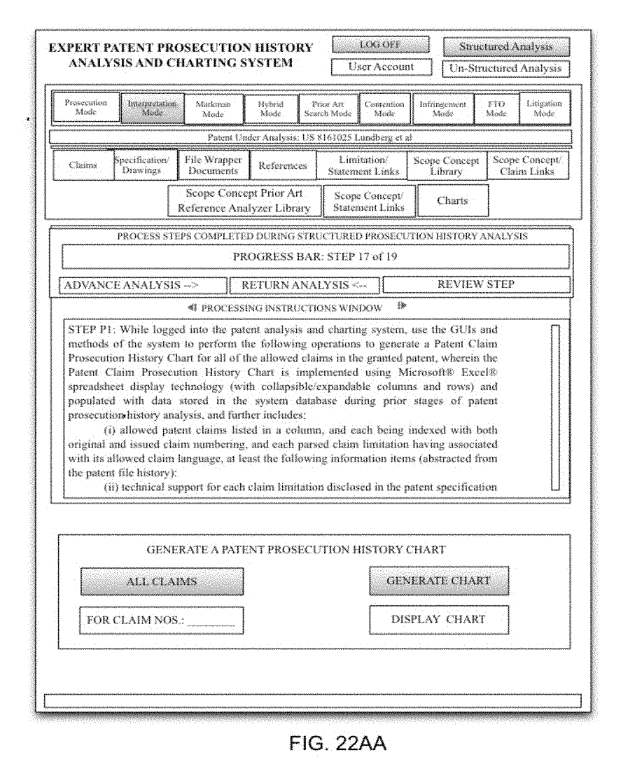

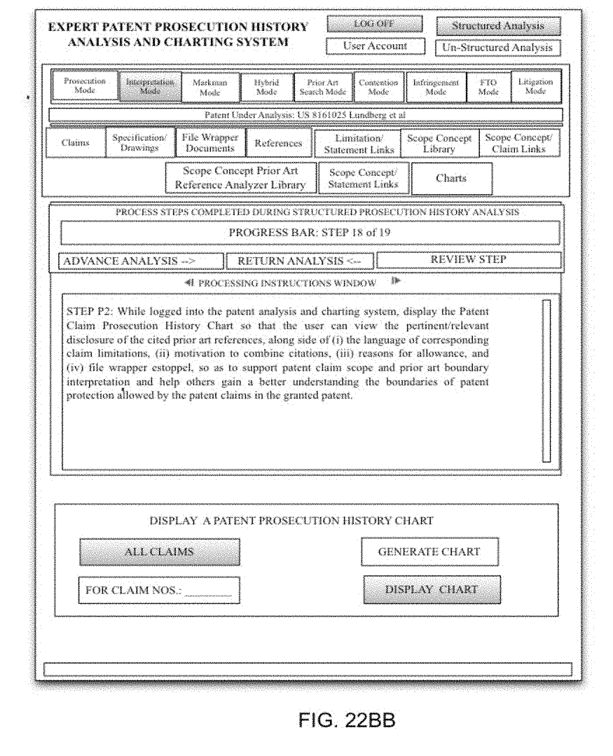

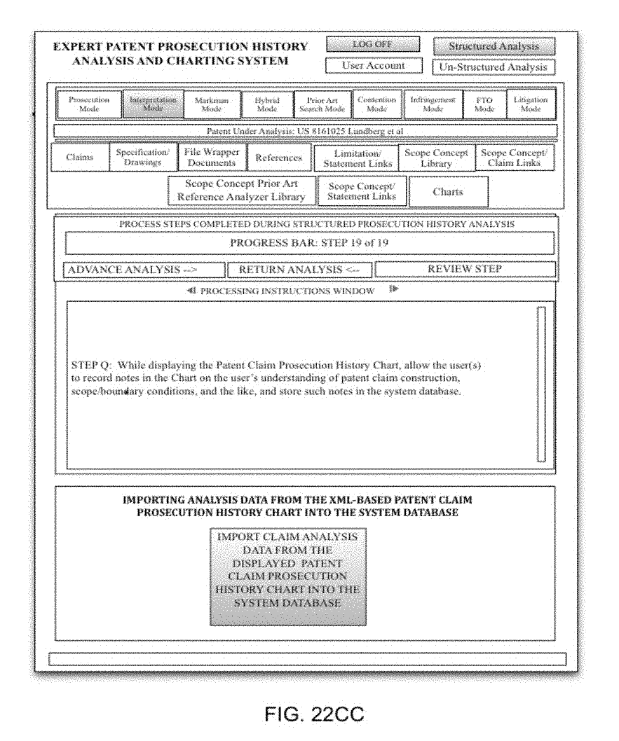

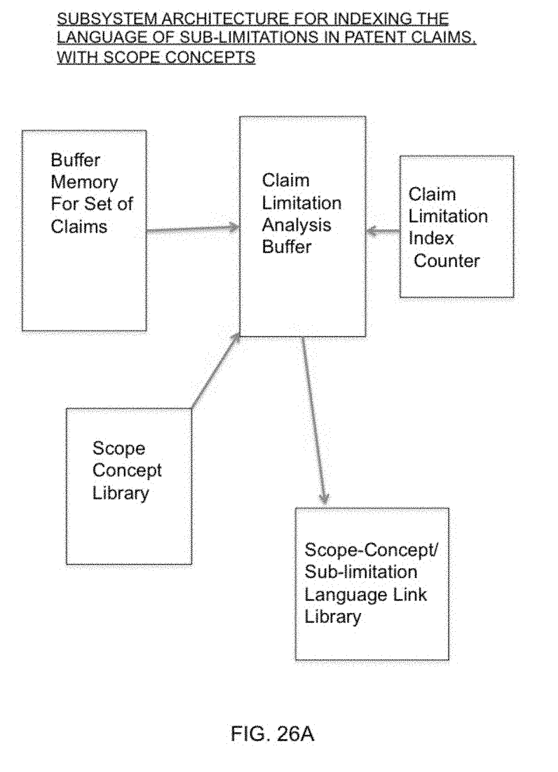

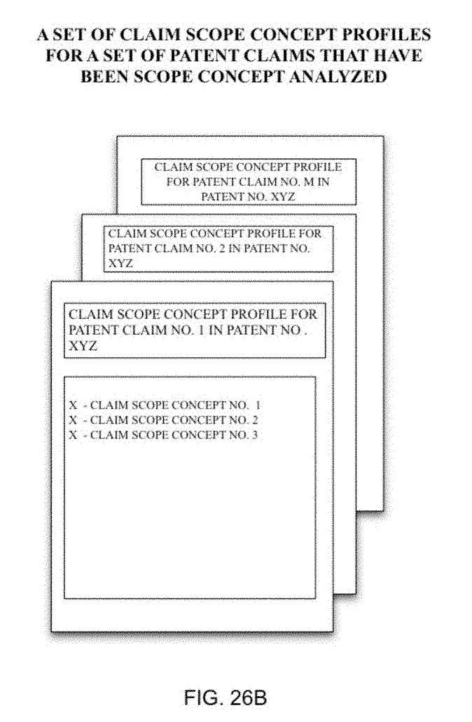

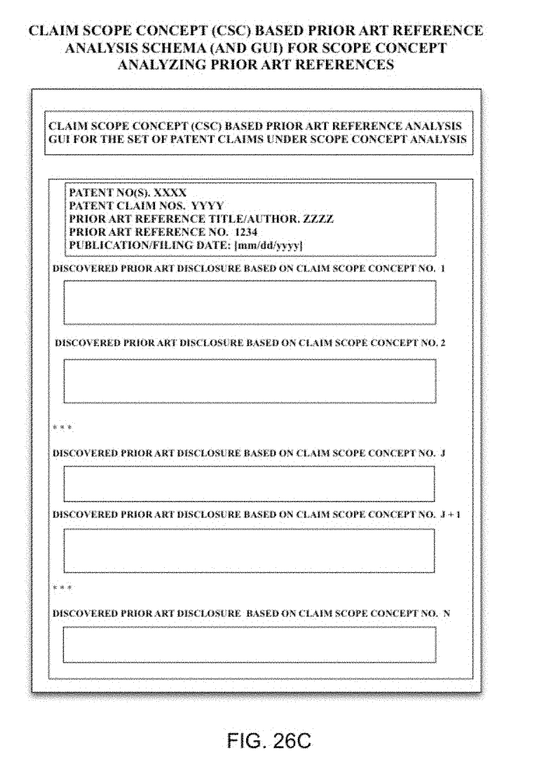

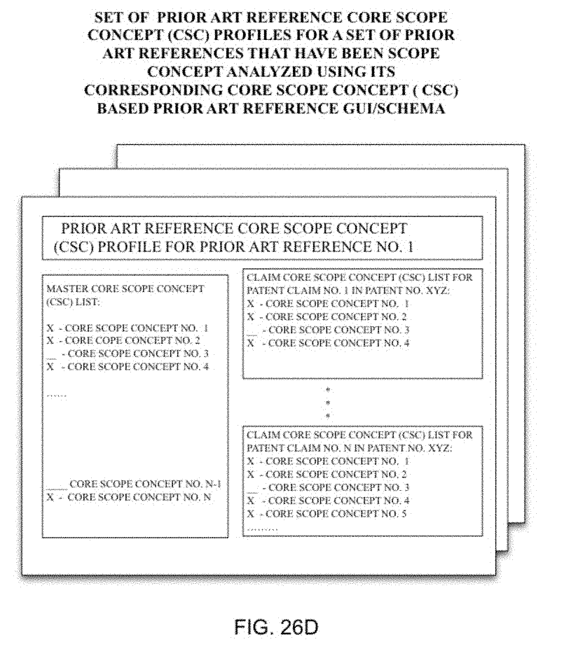

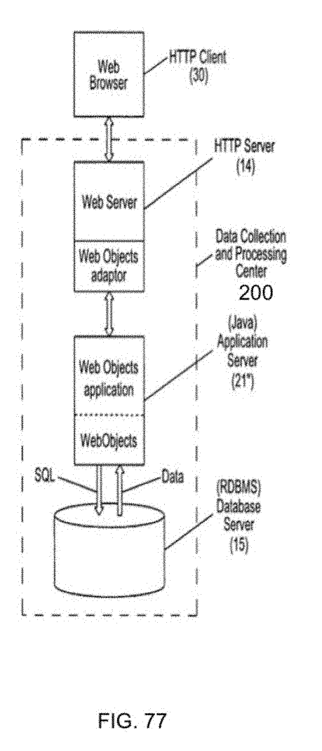

In the illustrative embodiments of the present invention, it is preferred that CSCML is realized as HTML5 with XML tag support (i.e. XHTML5) which is a hybrid type of markup language supporting: presentational markup code (i.e. tags) providing instructions to programs as to how the Claim language should be presented during display, printout, viewing etc; and descriptive markup code (i.e. tags) used to label/tag the claim limitation language and/or claim sub-limitation language assigned to Scope Concepts (encompassing Inventive Features reflected in the Claim language). By using XHTML5 to implement all GUIs supported in the various illustrative embodiments of the system shown in FIGS. 5 and 77, for example, it will be possible for any client machine 30, supporting a HTML5-enabled browser program, to support human users in following very important functions, without requiring specially-developed client-side applications: (i) marking up patent claim documents with Claim Scope Concept (CSC) tags, during claim scope concept formation and assignment operations, as illustrated in FIGS. 22A through 22P, FIGS. 37P through 37Q, FIGS. 43P through 43Q, FIGS. 49P through 49Q, FIGS. 55P through 55Q, and FIGS. 68P through 68T, FIGS. 83B through 83G and 83I, and FIGS. 93, 96 and 97; (ii) scope concept analyzing prior art reference documents using Claim Scope Concept (CSC) Based Prior Art Reference Analysis GUIs generated for the set of Patent Claims as illustrated in FIGS. 26C, 50D, 87, 110 and 111; and (iii) displaying and editing XML-based Spreadsheet Chart Structures generated by the system as illustrated in FIGS. 18A-18C, 27A-27F, 33A-33E, 33A-33F, 45A-45G, 51A-51G, 57A-57H, 64A-64I, 70A-70I, 92A-92B, 118A-118C, and 120A-120B.

In accordance with the principles of the present invention, the CSCML and the CSC-based mark-up process are designed to help users quickly identify and capture claim limitations in patent claims, as well as inventive features encompassed by the language of the parsed claim limitations and/or sub-limitations of the patent claims. The function of CSCML is to convert ordinary text-based patent claim language into CSCML-based patent claim language, or an ordinary text-based patent claim into a CSCML-based patent claim. Preferably, the Claim Scope Concept Markup Language (CSCML) of the present invention is practiced by a human user using a CSCML editor program that can run on any client or server computer system. Preferably, CSCML can be converted to HTML, PDF and Rich Text Format (RTF) and other document formats using a programming language.

Thereafter, a machine-implemented Claim Scope Concept Processing (CSCP) algorithm processes the CSCML-encoded patent claims (i.e. expressed in a CSCML format) and automatically generates various claim scope concept (CSC) based data structures (i.e. Claim Scope Concept Profiles for a set of Claims, A Master List of Claim Scope Concept Profiles for the set of Claims, a Scope Concept Based Prior Art Reference Analysis GUI, and a Prior Art Reference Scope Concept Profile for each prior art Reference analyzed using the Scope Concept Based Prior Art Reference Analysis GUI). These generated documents are then used throughout the various claim analysis processes described herein, including but not limited to: Claim Patentability Analysis; Patent Claim Invalidity Contention Analysis, Scope-Concept Based Search Vector Generation; Patent Claim Infringement Analysis, Patent Claim Scope Interpretation/Construction Analysis, et al.

For example, during the implementation of a Claim Patentability Analysis Process on an enterprise-level system, Claim Scope Concept Markup Language (CSCML) and CSCP-based machine-implemented document processing methods enable the following: automated claim scope concept profile generation; automated scope concept based prior art reference analysis GUI generation; automated prior art search vector generation; automated prior art reference scope concept profile generation (after prior art references have been analyzed by technical subject matter experts using the scope concept based prior art reference analysis GUI); and automated claim patentability analysis and charting.

It is understood, however, that CSCML and CSCP can be practiced in other legal process applications including, but not limited to, Claim Patentability Analysis, Patent Claim Invalidity Contention Analysis, Scope-Concept Based Search Vector Generation, Patent Claim Infringement Analysis, and Patent Claim Scope Interpretation/Construction Analysis, as described in detail above with respect to systems 5 and 200.

Hereinafter, it is understood that all programmatically-controlled language, schema, information and document processing methods of the present invention disclosed herein, will employ a variety decision-making techniques, analytical processes, and other forms of symbolic computation, which may employ the use of rationally-constructed systems and/or threads of rule-based logic designed to guide how information contained in language strings, CSC structures, schemas and/or documents are handled, processed, and transformed within the computer-implemented systems and networks disclosed herein, to generate and display new forms of information and/or documents in accordance with the disclosed principles of the present invention, for the purposes taught herein, while implemented using object-oriented systems engineering software development techniques known in the language processing, document processing, and computer programming arts.

### Specification of the Multi-Mode Patent Analysis and Charting System of the Present Invention Configured in its Patent Claim Prosecution Analysis Mode (Mode 0) of System Operation

FIG. 13 illustrates the information mapping process supported by the system during its patent claim prosecution mode of system operation. As shown, in this mode, prosecution history data from various sources (e.g. patent claim limitations and/or sub-limitations, Section 112 Claim Support in the Patent Specification, prior art disclosure (e.g. searchable text and searchable graphics and/or images) from prior art references corresponding to the claim limitations or parts thereof, prosecution history statements by the examiner and/or applicant(s)/owner including reasons for allowance) is mapped to particular fields within the claim chart structures generated during this particular mode of system operation. During this mode of operation, it is assumed that the (published) patent application under analysis has not yet been allowed (e.g. a notice of allowance and issue fee due has not yet been issued by the US Patent Office). Thus, it is reasonable to assume that the pending claims are still under examination, final claim amendments may not have been filed yet, there are still other prior art references that might still be disclosed and made of record, and that all prosecution statements to be made by the Examiner and/or the Applicant(s)/Owner have yet to be made, and thus the patent prosecution history remains open and has not yet stopped. While using the system in this mode of operation, file history documents can be incrementally uploaded into the system as patent documents become available to the public during the patent prosecution process, and the user(s) can continue with their analysis as developments occur within the patent prosecution process. FIG. 15 illustrates where the patent claim prosecution analysis mode of operation can be applied along the patent life-cycle timeline, between the time of original filing and during the pre-grant period.

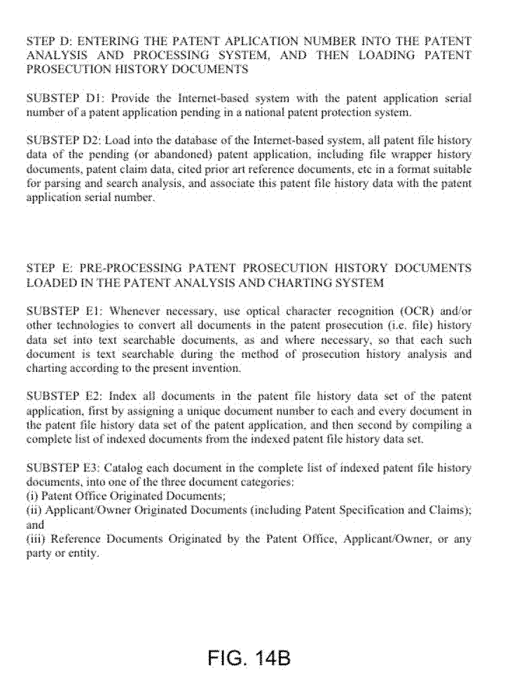

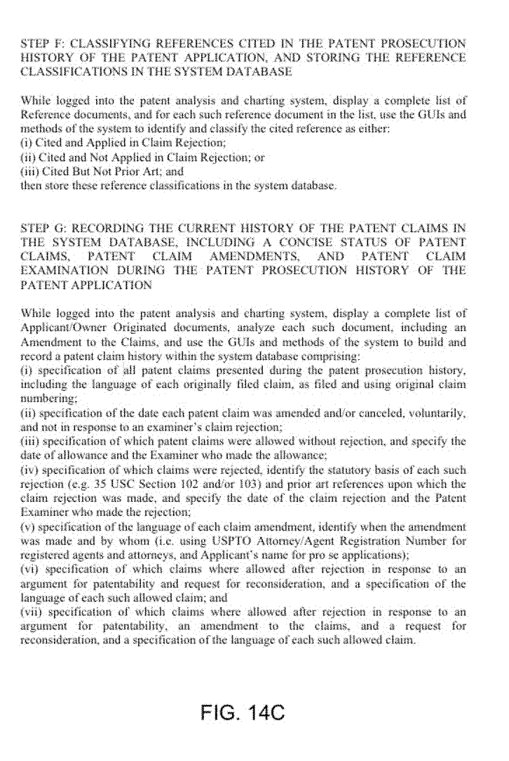

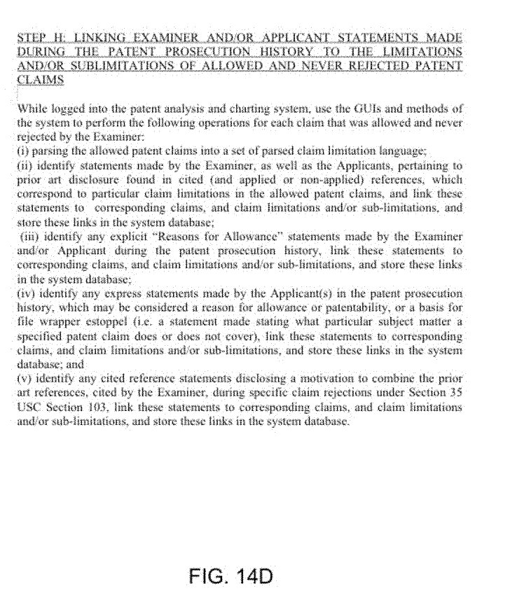

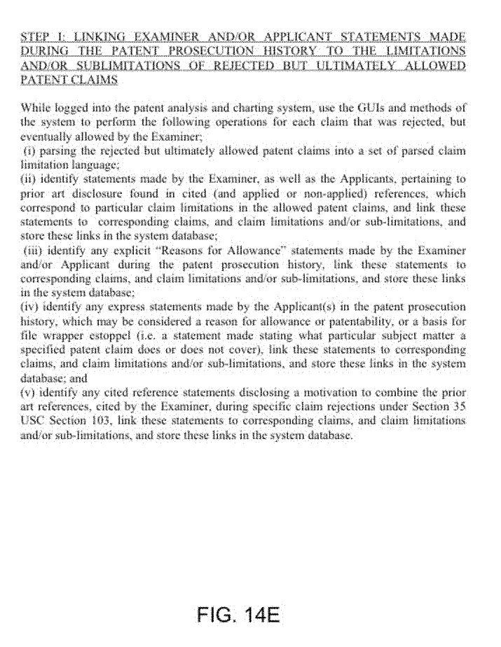

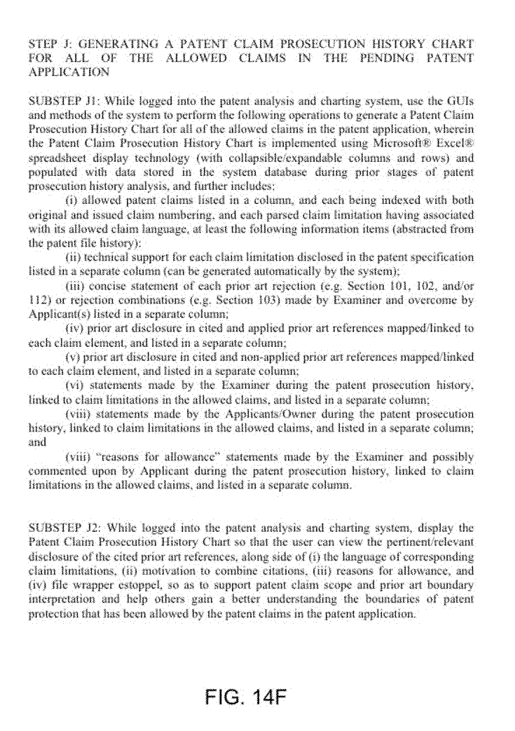

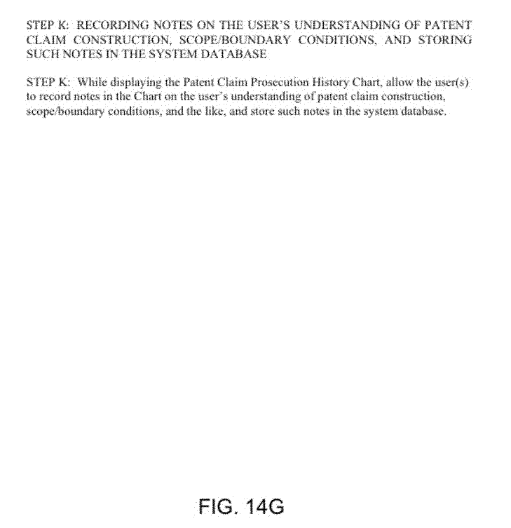

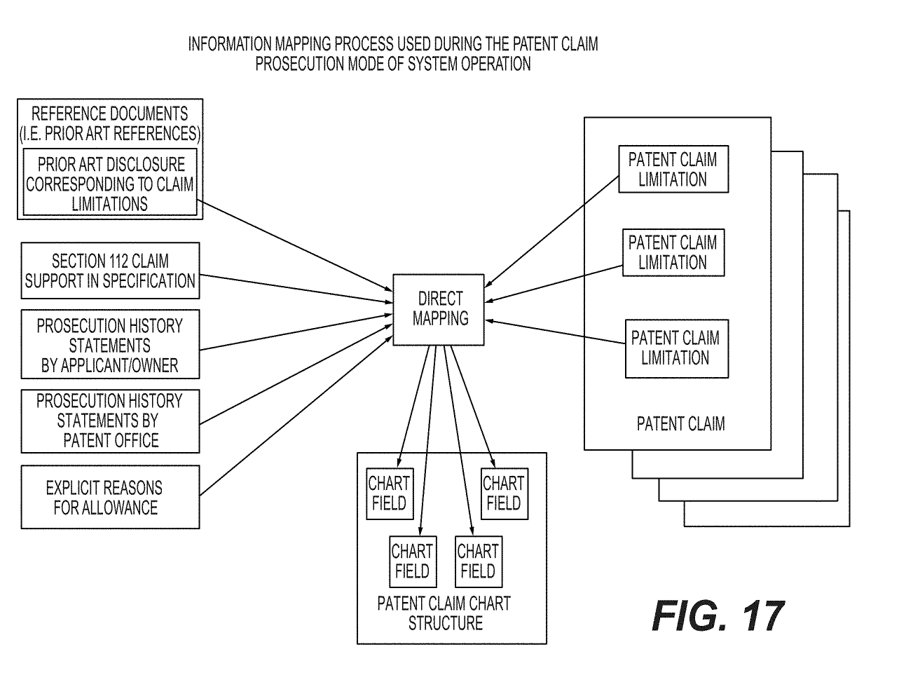

The flow chart set forth in FIGS. 14A through 14F describes, in greater detail, the steps performed during the method of analyzing and charting the patent prosecution history of a pending patent application, using the multi-mode patent analysis and charting system of the present invention configured in its patent claim prosecution mode of system operation. The workflow process specified in FIGS. 14A through 14F will be described now in greater detail with reference to corresponding wireframe GUIs shown in FIGS. 16A through 16O, and the information mapping process illustrated in FIGS. 13 and 17. Upon completion of the workflow process, the multi-mode system in its the patent claim prosecution analysis mode will automatically generate and display an XML-based spreadsheet-based chart structure as illustrated in FIG. 18A through 18C, that can be used by various users in any given user work group, including patent attorneys, during patent claim scope/boundary interpretation and other analytical efforts. For presentation purposes only, the XML-based spreadsheet-based chart structure shown in FIGS. 18A through 18C has been broken down into several sections in the figure Drawings, and should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

As shown in FIG. 13, during the patent claim prosecution analysis mode of system operation, the system supports a direct linking of specified parts of patent file history documents to corresponding language in the patent claim limitations and/or sub-limitations, and for these document-part/claim-limitation links to be mapped onto a novel claim chart structure containing the patent claims and other patent prosecution history items, specified in detail hereinafter. During this mode of system operation, scope concept mapping is not employed, as it is all other modes of system operation, because any allowed claims are not yet granted in the pending patent application under study during this mode of patent claim analysis and corresponding system operation. Also, it is preferred (although not essential) to reserve scope concept mapping between claim limitation language and corresponding sections of patent prosecution history documents (including prior art references) when a patent grant is finally issued from a pending patent application. The application of scope concept mapping to such situations will ensure that the entire set of claims in a granted patent can be considered as a whole when formulating scope concepts on the system of the present invention. When the allowed patent application is ultimately granted as an issued patent, then it will be more effective to apply scope concept mapping (i.e. linking) during prosecution history analysis of the claims in the granted patent as performed, for example, during the Patent Claim Scope Interpretation Analysis Mode (Mode 1) of system operation, as well as during other modes of system operation involving granted patents.

As shown in FIG. 13, the system enables the user to directly link or map prior art reference disclosure to the natural language of corresponding claim limitations in the allowed claims, as well as directly link prosecution history statements (and/or claim amendments) to corresponding claim limitation language in allowed claims. Subsequently, such links are recorded in the system database, and upon completion of patent prosecution history analysis, are used by the system to automatically generate and display patent prosecution history (PPH) based claim chart structures, shown in FIGS. 18A through 18C, designed to support an improved understanding of the scope and boundaries of patent protection afforded to the allowed claims, in view of the cited prior art references made of record during the patent prosecution history. Essential to the process of direct linking or mapping is determining “correspondence” of one degree or another between (i) claim limitation language, or amendments to claim language, and (ii) particular statements made by the Examiner or Applicant, and/or corresponding disclosure within prior art references, cited and considered by the Examiner during the course of the patent prosecution history. The details of this direct mapping process will be described in greater detail hereinafter.

### Method of Analyzing and Charting the Patent Prosecution History of a Pending Patent Application, Using a Patent Analysis and Charting System Configured in a Patent Claim Prosecution Analysis Mode of Operation (Mode 0)

Referring to the detailed flow chart set forth in FIGS. 14A through 14F, the Internet-based patent analysis and charting system of the present invention configured in its patent claim prosecution analysis mode of system operation will be now described in detail, and showing how one or more users can efficiently analyze and chart the patent prosecution history of any granted patent, using the wireframe GUI screens set forth in FIGS. 18A through 180, the mapping techniques illustrated in FIGS. 13 and 17, and the patent prosecution history based chart structures described in FIGS. 16A through 16O. Various applications for the patent analysis and charting system configured in this mode of operation are illustrated in FIG. 15 and will be described in greater detail hereinbelow.

The steps of the process described in FIGS. 14A through 14F will be described in detail below.

As indicated in Step A in FIG. 14A, Web, application and database servers on a network are used to deploy an Internet-based object-oriented system platform that supports a computer-assisted analysis and charting of the prosecution history of any patent granted in a national patent protection system. As shown in FIG. 5, the network is connected to the network information infrastructure and servers of national patent protection systems, and patent and published patent application depositories containing composite patent file history data documents for granted patents and pending (or abandoned) patent applications.

As indicated in Step B in FIG. 14A, web-enabled client machines are used to allow authorized users to log into the deployed patent analysis and charting system and perform the following operations specified below. An exemplary login GUI screen is shown in FIG. 16A for that purpose. In FIG. 16B, a GUI screen is shown for managing User Account information on the platform.

As indicated in Step C in FIG. 14A, the user employs a GUI as shown in FIG. 16C to configure the patent analysis and charting system in its patent claim prosecution analysis mode of system operation, for computer-assisted analysis and charting of a particular patent application, prior to patent grant. In general, the patent analysis and charting system comprises a database 15, shown in FIGS. 6A and 6B, for storing the patent file history data, patent claim data, and prior art reference data, and supporting methods, procedures, GUIs, etc. during patent prosecution analysis. The purpose of this step in the process is to select the mode of system operation to be configured on the system platform of the present invention.

As indicated in Substep D1 in FIG. 14B, the user employs a GUI screen as shown in FIG. 16D to provide the Internet-based system with the patent application serial number of a patent application pending in a national patent protection system. Then, at Substep D2, using a GUI screen as shown in FIG. 16E, all patent file history data of the pending (or abandoned) patent application, including file wrapper history documents, patent claim data, cited prior art reference documents, etc., are uploaded from patent servers shown in FIG. 5, into the database 15 of the Internet-based system, in a format suitable for parsing and search analysis, and associate this patent file history data with the patent application serial number.

As indicated in Substep E1 in FIG. 14B, a GUI screen as shown in FIG. 16F is employed so that, whenever necessary, the system uses optical character recognition (OCR) and/or other technologies to convert all documents in the patent prosecution (i.e. file) history data set into text searchable documents, as and where necessary, so that each such document is text searchable during the method of prosecution history analysis and charting according to the present invention.

As indicated in Substep E2 in FIG. 14B, a GUI screen as shown in FIG. 16G is employed so that all documents in the patent file history data set of the patent application are indexed by first assigning a unique document number to each and every document in the patent file history data set of the patent application, and then second by compiling a complete list of indexed documents from the indexed patent file history data set.

As indicated in Substep E3 in FIG. 14B, a GUI screen as shown in FIG. 16H is employed so that each document in the complete list of indexed patent file history documents, is cataloged into one of the three document categories: (i) Patent Office Originated Documents; (ii) Applicant/Owner Originated Documents (including Patent Specification and Claims); and (iii) Reference Documents Originated by the Patent Office, Applicant/Owner, or any party or entity.

As indicated in Step F in FIG. 14C, a GUI screen as shown in FIG. 16I is employed so that, while logged into the patent analysis and charting system, the system displays a complete list of Reference documents. For each such reference document in the list, the user uses the GUIs and methods of the system to identify and classify the cited reference as either: (i) cited and applied in claim rejection; (ii) cited and not applied in claim rejection; or (iii) cited but not prior art; and then store these reference classifications in the system database 15.

As indicated in Step G in FIG. 14C, a GUI screen as shown in FIG. 16J is employed so that the system enables the recording of the current history of the patent claims in the system database, including a concise status of patent claims, patent claim amendments, and patent claim examination during the patent prosecution history of the patent application. In the illustrative embodiment, this is achieved as follows. As shown, while logged into the patent analysis and charting system, the system displays a complete list of Applicant/Owner Originated documents, and then each such document, including an Amendment to the Claims is analyzed by the user using the GUIs and methods of the system so as to build and record a patent claim history (PCH) within the system database 15.

In the illustrative embodiment, the patent claim history (PCH) comprises:

(i) specification of all patent claims presented during the patent prosecution history, including the language of each originally filed claim, as filed and using original claim numbering;

(ii) specification of the date each patent claim was amended and/or canceled, voluntarily, and not in response to an examiner's claim rejection;

(iii) specification of which patent claims were allowed without rejection, and specify the date of allowance and the Examiner who made the allowance;

(iv) specification of which claims were rejected, identify the statutory basis of each such rejection (e.g. 35 USC Section 102 and/or 103) and prior art references upon which the claim rejection was made, and specify the date of the claim rejection and the Patent Examiner who made the rejection;

(v) specification of the language of each claim amendment, identify when the amendment was made and by whom (i.e. using USPTO Attorney/Agent Registration Number for registered agents and attorneys, and Applicant's name for pro se applications);

(vi) specification of which claims where allowed after rejection in response to an argument for patentability and request for reconsideration, and a specification of the language of each such allowed claim; and

(vii) specification of which claims where allowed after rejection in response to an argument for patentability, an amendment to the claims, and a request for reconsideration, and a specification of the language of each such allowed claim.

As indicated in Step H in FIG. 14D, a GUI screen as shown in FIG. 16K is employed, so that the system allows the user to link (i) examiner and/or applicant statements made during the patent prosecution history, to (ii) the limitations and/or sub-limitations of allowed and never rejected patent claims. In the illustrative embodiment, this is achieved as follows. While logged into the patent analysis and charting system, the user uses the GUIs and methods of the system to perform the following operations for each claim that was allowed and never rejected by the Examiner:

(i) parse the allowed patent claims into a set of parsed claim limitations comprising a set of natural language strings representing the set of parsed claim limitations;

(ii) identify statements made by the Examiner, as well as the Applicants, pertaining to prior art disclosure (e.g. searchable text and searchable graphics and/or images) found in cited (and applied or non-applied) references, which correspond to particular claim limitations in the allowed patent claims, and link these statements to corresponding claims, claim limitations and/or sub-limitations, and store these links in the system database 15;

(iii) identify any explicit “Reasons for Allowance” statements made by the Examiner and/or Applicant during the patent prosecution history, link these statements to corresponding claims, and claim limitations and/or sub-limitations, and store these links in the system database;

(iv) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), link these statements to corresponding claims, and claim limitations and/or sub-limitations, and store these links in the system database; and

(v) identify any cited reference statements disclosing a motivation to combine the prior art references, cited by the Examiner, during specific claim rejections under Section 35 USC Section 103, link these statements to corresponding claims, and claim limitations and/or sub-limitations, and store these links in the system database.

As indicated in Step I in FIG. 14E, a GUI screen as shown in FIG. 16L is employed so that the system allows the user to link examiner and/or applicant statements made during the patent prosecution history to the limitations and/or sub-limitations of rejected but ultimately allowed patent claims. While logged into the patent analysis and charting system, the user uses the GUIs and methods of the system to perform the following operations for each claim that was rejected, but eventually allowed by the Examiner:

(i) parse the rejected but ultimately allowed patent claims into a set of parsed claim limitations comprising a set of natural language strings representing the set of parsed claim limitations;

(ii) identify statements made by the Examiner, as well as the Applicants, pertaining to prior art disclosure (e.g. searchable text and searchable graphics and/or images) found in cited (and applied or non-applied) references, which correspond to particular claim limitations in the allowed patent claims, and link these statements to corresponding claims, and claim limitations and/or sub-limitations, and store these links in the system database;

(iii) identify any explicit “Reasons for Allowance” statements made by the Examiner and/or Applicant during the patent prosecution history, link these statements to corresponding claims, and claim limitations and/or sub-limitations, and store these links in the system database;

(iv) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), link these statements to corresponding claims, and claim limitations and/or sub-limitations, and store these links in the system database; and

(v) identify any cited reference statements disclosing a motivation to combine the prior art references, cited by the Examiner, during specific claim rejections under Section 35 USC Section 103, link these statements to corresponding claims, and claim limitations and/or sub-limitations, and store these links in the system database 15.

As indicated in Step J in FIG. 14F, a GUI screen as shown in FIG. 16M is employed so that, while logged into the patent analysis and charting system, the user uses the GUIs and methods of the system to perform mapping operations illustrated in FIG. 17 and generate a patent prosecution history based claim scope concept (CSS) chart structure, as shown in FIGS. 18A through 18C for all of the allowed claims in the patent application. Preferably, the patent prosecution history based claim scope concept (CSS) chart structure is implemented using Microsoft® Excel® XML-based spreadsheet display technology (with collapsible/expandable columns and rows) and populated with data stored in the XML-enabled system database during prior stages of patent prosecution history analysis.

As shown in FIGS. 18A through 18C, the patent prosecution history based claim scope schema (CSS) chart structure generated for any allowed/allowable set of patent claims, during the patent claim prosecution analysis mode, comprises data fields for presenting graphical representations of numerous graphical objects including: (i) allowed patent claims listed in a column, and each being indexed with both original and issued claim numbering, and each parsed claim limitation having associated with its allowed claim language, at least the following information items (abstracted from the patent file history):

(ii) technical support for each claim limitation disclosed in the patent specification listed in a separate column (can be programmatically generated by the system); (iii) concise statement of each prior art rejection (e.g. Section 101, 102, and/or 112) or rejection combinations (e.g. Section 103) made by Examiner and overcome by Applicant(s) listed in a separate column;

(iv) prior art disclosure (e.g. searchable text and searchable graphics and/or images) in cited and applied prior art references mapped/linked to each claim element, and listed in a separate column;

(v) prior art disclosure (e.g. searchable text and searchable graphics and/or images) in cited and non-applied prior art references mapped/linked to each claim element, and listed in a separate column;

(vi) statements made by the Examiner during the patent prosecution history, linked to claim limitations in the allowed claims, and listed in a separate column;

(viii) statements made by the Applicants/Owner during the patent prosecution history, linked to claim limitations in the allowed claims, and listed in a separate column; and

(ix) “reasons for allowance” statements made by the Examiner and possibly commented upon by Applicant during the patent prosecution history, linked to claim limitations in the allowed claims, and listed in a separate column.

As indicated in Substep J2 in FIG. 14F, a GUI screen as shown in FIG. 16N is employed so that, while logged into the patent analysis and charting system, the system displays the patent claim prosecution history chart structure so that the user can view the pertinent/relevant disclosure of the cited prior art references, along side of (i) the language of corresponding claim limitations, (ii) motivation to combine citations, (iii) reasons for allowance, and (iv) file wrapper estoppel, so as to support patent claim scope and prior art boundary interpretation and help others gain a better understanding the boundaries of patent protection that has been allowed by the patent claims in the patent application.

As indicated in Step K in FIG. 14G, a GUI screen as shown in FIG. 16O is employed so that, while the patent claim prosecution history chart structure shown in FIGS. 18A through 18C is displayed, the user is allowed to record notes in the Chart on the user's understanding of patent claim construction, scope/boundary conditions, and the like, and store such notes in the system database.

As shown in FIGS. 18A through 18C, the patent claim prosecution history chart structure for any patent application, comprises data fields for presenting graphical representations of the following graphical objects:

(i) allowed patent claims with original and issued claim numbering;

(ii) technical support for the claimed subject matter provided in the Patent Specification under 35 USC Section 112;

(iii) subject matter of patent claims never rejected (i.e. claims allowed but never rejected during prosecution);

(iv) subject matter rejections (i.e. identification of prior art references, the legal basis for rejection of specific patent claims, and reasons why claims are not patentable under the patent laws) overcome by the allowed patent claims during patent prosecution history, as reflected in the patent prosecution history, including subject matter rejections overcome by argument without amendment, and subject matter rejections overcome by argument and with amendment;

(v) statements by the Applicant/Owner or Examiner (including reasons for allowance) made during the patent prosecution history and related to the sub-limitations of the allowed patent claims; and

(vi) user notes on the user's understanding of the patent claim construction, scope/boundaries.

This information is captured during Steps G, H, K and others during the structure patent analysis process of the present invention carried out by the system of the present invention.

FIG. 15 illustrates the application of the multi-mode patent analysis and charting system configured in its patent claim prosecution mode of system operation, and how it may be deployed during particular phases of the patent life-cycle time line, by both the patent application owner and its competitors. In particular, competitors of the patent owner can use the patent claim prosecution mode of operation in defensive applications against the patent owner, namely, by better understanding the scope and boundaries of patent protection afforded by the claims, and identifying potential patent claim invalidity contentions and defenses of potential claim infringement. Also, the patent application owner can use the patent claim prosecution mode of operation in offensive applications against competitors, by (i) better understanding the scope and boundaries of the allowed patent claims, against a landscape of scope concept mapped prior art references being displayed in the chart structure, (ii) identifying potential future cases of claim infringement (requiring deeper patent claim infringement analysis).

Specification of the Multi-Mode Patent Analysis and Charting System of the Present Invention Configured in its Patent Claim Scope Interpretation (i.e. Construction) Analysis Mode (Mode 1) of System Operation

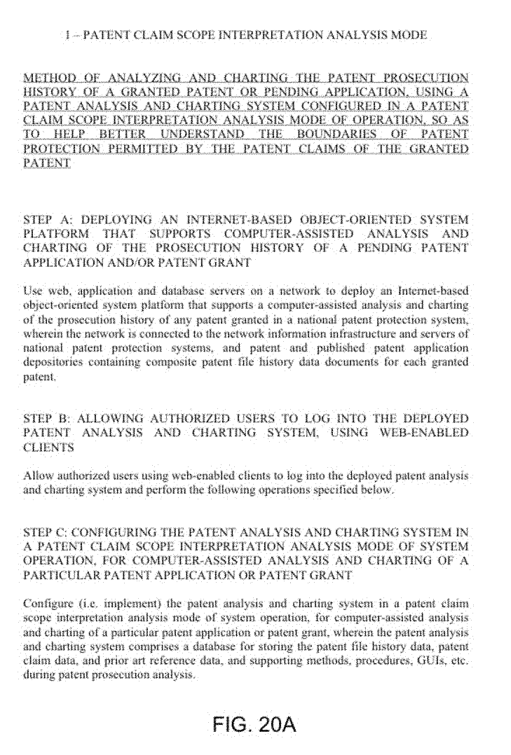

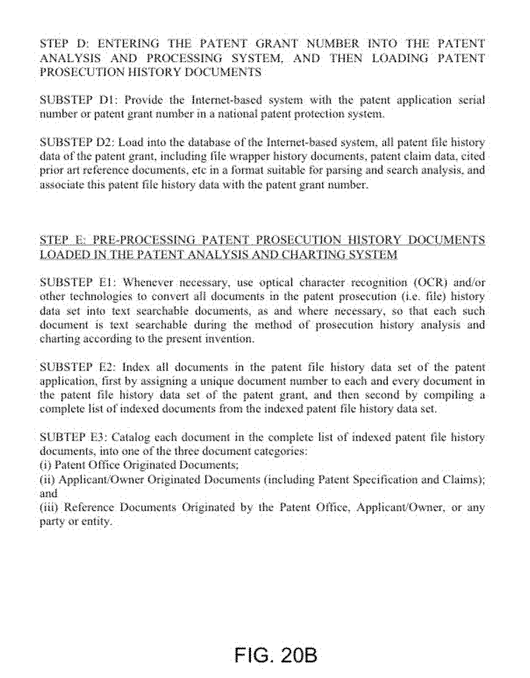

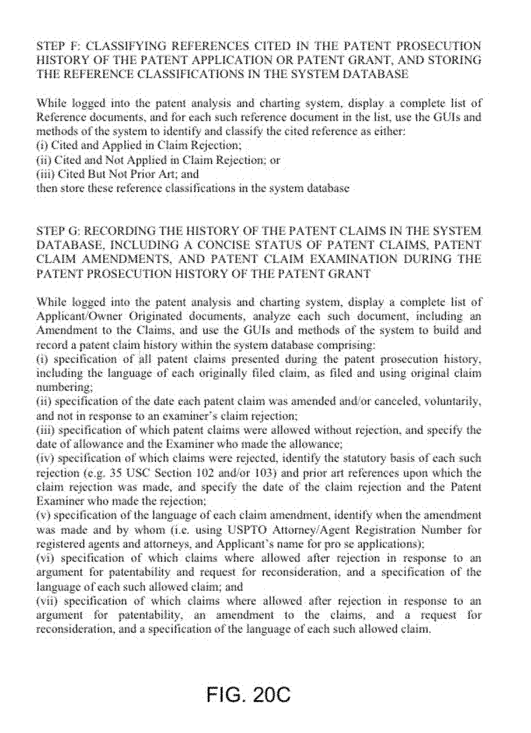

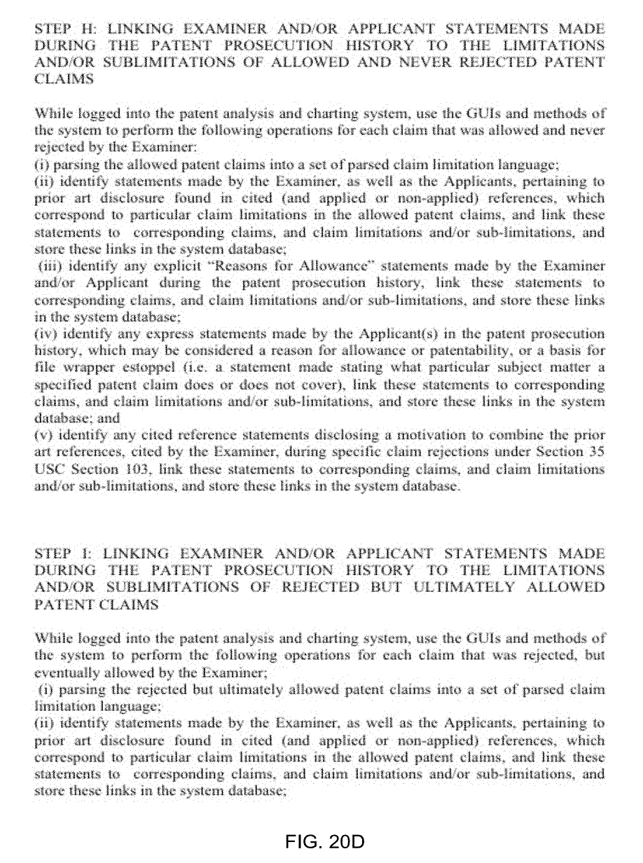

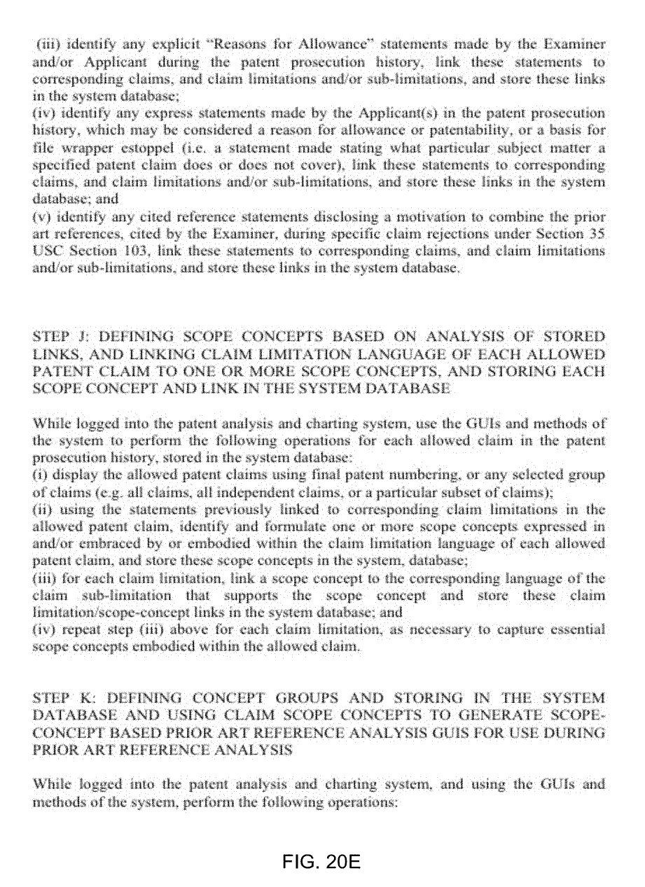

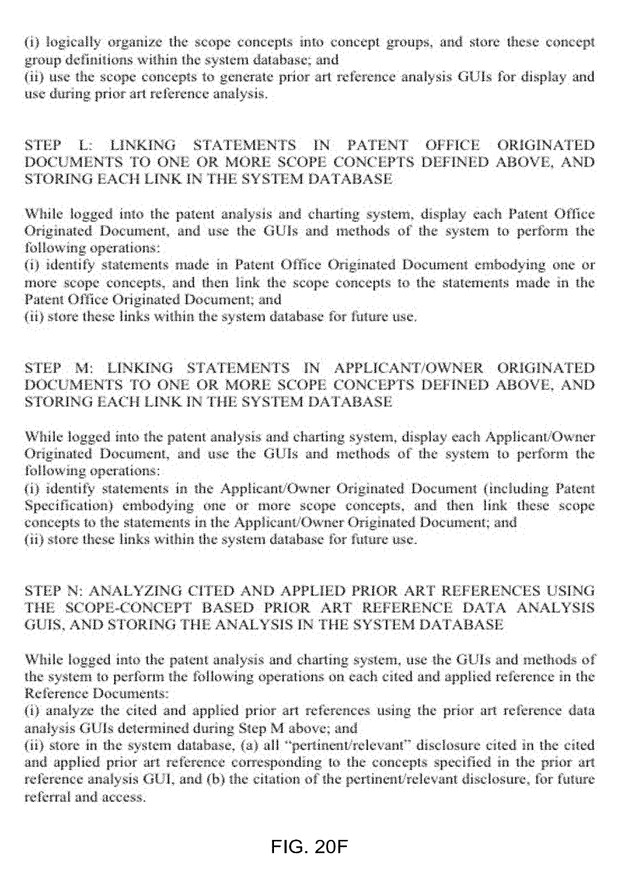

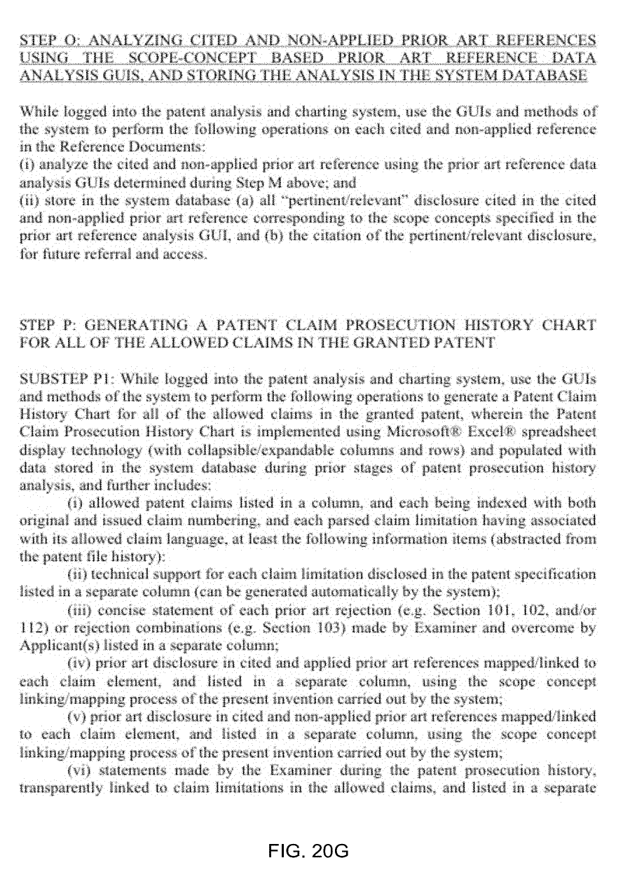

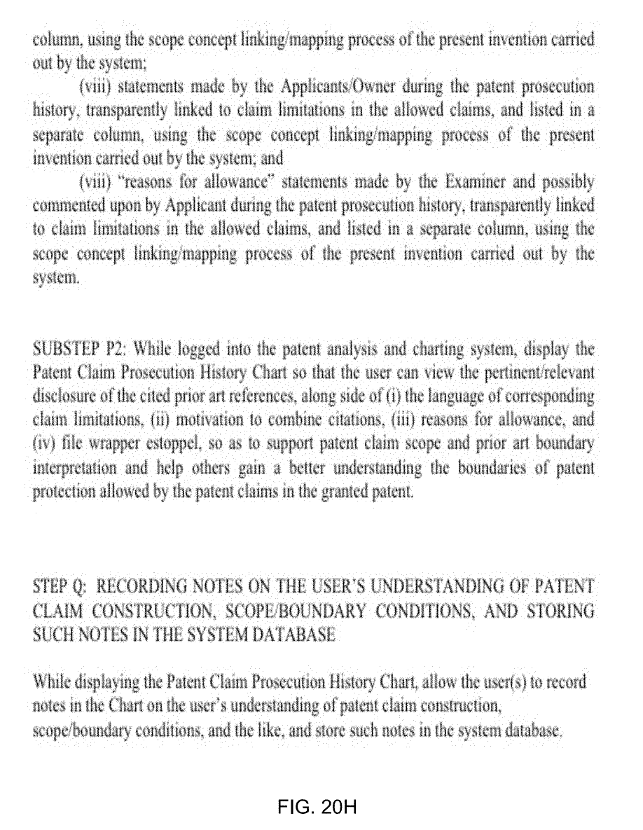

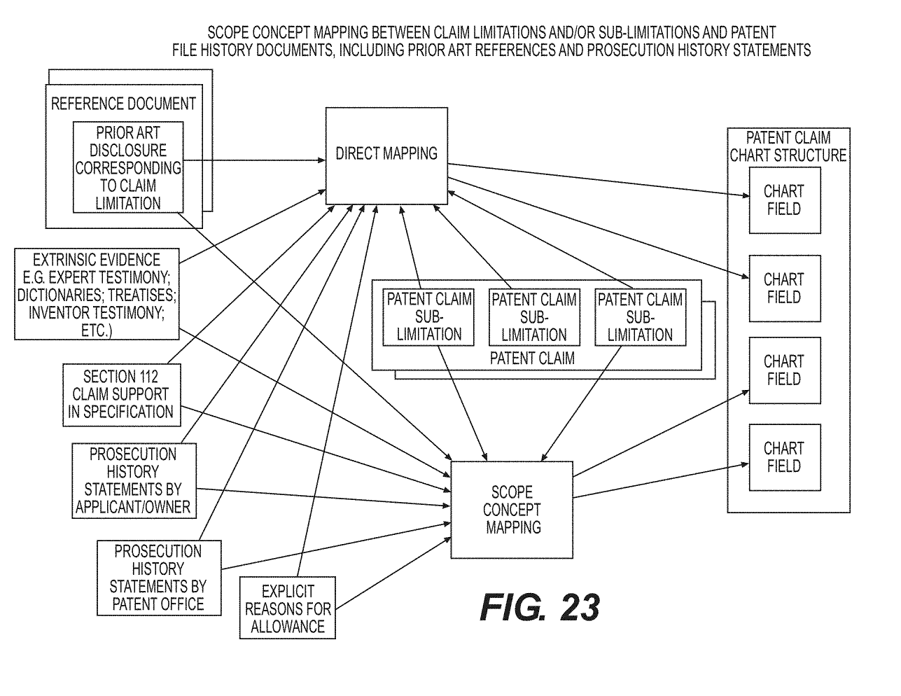

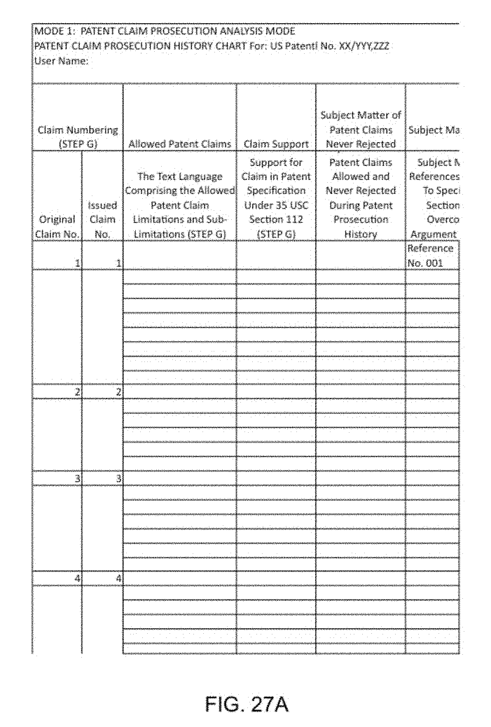

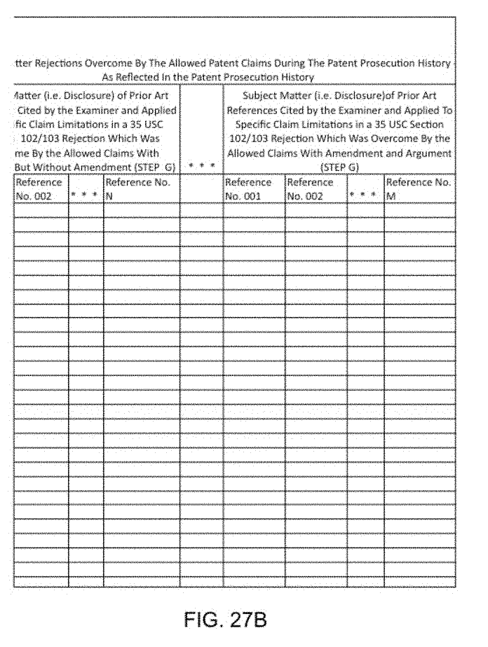

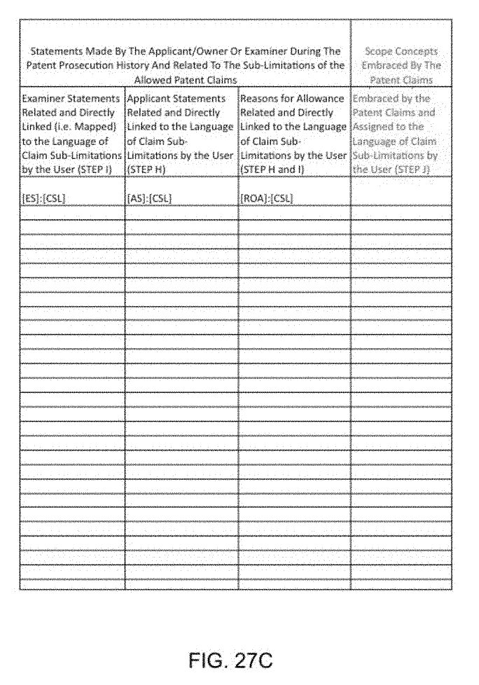

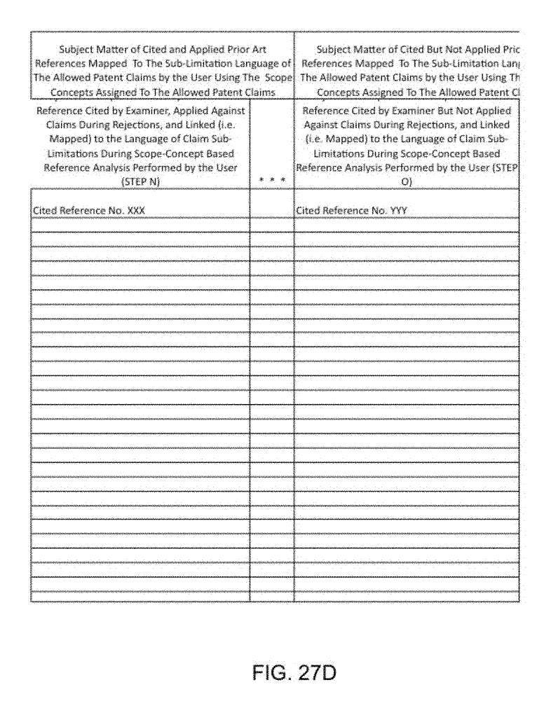

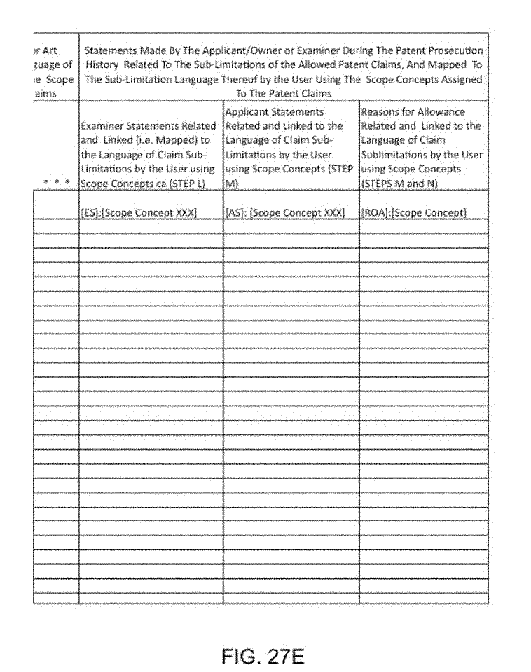

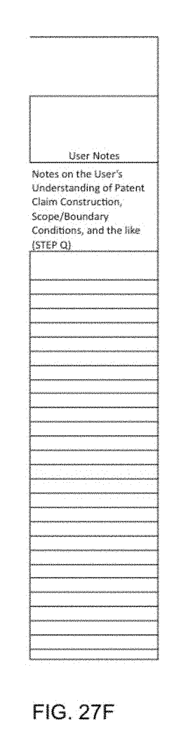

The flow chart of FIGS. 20A through 20H describes, in greater detail, the steps performed during the method of analyzing and charting the patent prosecution history of a pending patent application, using the multi-mode patent analysis and charting system of the present invention configured in its patent claim scope interpretation (i.e. construction) analysis mode of system operation. The workflow process specified in FIGS. 20A through 20H will be described now in greater detail with reference to corresponding wireframe GUIs shown in FIGS. 22A through 22DD, and the information mapping process illustrated in FIG. 23. Upon completion of the workflow process, the multi-mode system in its the patent claim prosecution mode will automatically (i.e. programmatically) generate and display an XML-based spreadsheet-based chart structure as illustrated in FIG. 27A through 27F, that can be used by various users in any given user work group, including patent attorneys, during patent claim scope/boundary interpretation and other analytical efforts. For presentation purposes only, the XML-based spreadsheet-based chart structure shown in FIGS. 27A through 27F has been broken down into several sections in the figure Drawings, and should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

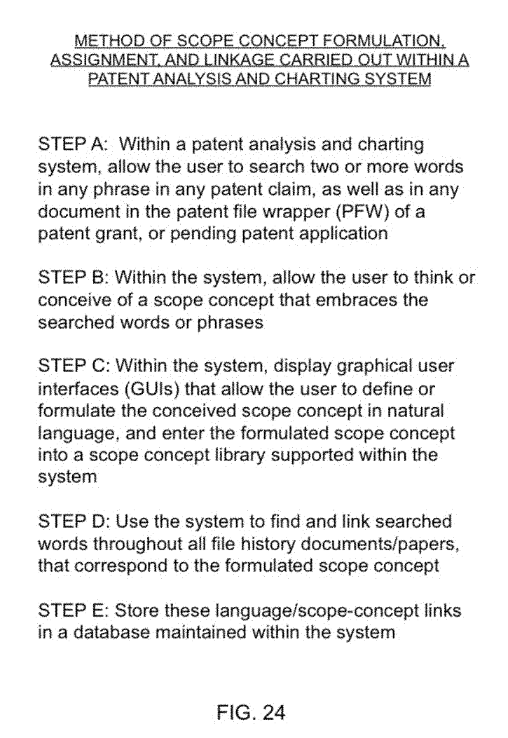

As shown in FIGS. 19 and 23, during the patent claim scope interpretation (i.e. construction) analysis mode of system operation, the system supports both (i) direct linking of specified parts of patent file history documents to corresponding language in the patent claims and/or claim limitations, as well as (ii) scope concept mapping of specified parts of patent file history documents and prior art references to corresponding language in the patent claims and/or claim limitations. The scope concept process is detailed in FIGS. 24, 25A, 25B, 25C and 26. Subsequently, these direct data string linking and data mapping are recorded in the system database, and upon completion of patent prosecution history analysis, are used by the system to automatically (i.e. programmatically) generate and display patent prosecution history (PPH) based claim chart structures, shown in FIGS. 27A through 27F, designed to support an improved understanding of the scope and boundaries of patent protection afforded to the allowed claims, in view of the cited prior art references made of record during the patent prosecution history. Essential to the process of scope concept linking or mapping during this mode of system operation is understanding which claim limitation language, or amendments to claim language, in each allowed patent claim, were considered relevant or otherwise important to the Examiner when deciding to allow the subject matter of particular claims, in view of particular prior art references, during the course of the patent prosecution history, and to identify statements made by the Applicant/Owner and/or Examiner which explain how the claimed invention differs from the prior art when taken as a whole, and provides a set of reasons for allowance of the claimed invention. Such statements and relevance are best captured during the direct linking process, carried out prior to the scope concept mapping, as direct linking operations will inform the user (e.g. a patent attorney) during the formulation and identification of scope concepts present in the claim limitations of the allowed patent claims, using the scope concept formulation process and machinery described in FIGS. 24 through 26. The details of this scope mapping process will be described in greater detail hereinafter.

Method of Analyzing and Charting the Patent Prosecution History of a Granted Patent, Using a Patent Analysis and Charting System Configured in a Patent Claim Scope Interpretation Analysis Mode of Operation (MODE 1), so as to Help Better Understand the Boundaries of Patent Protection Afforded by the Patent Claims of the Granted Patent

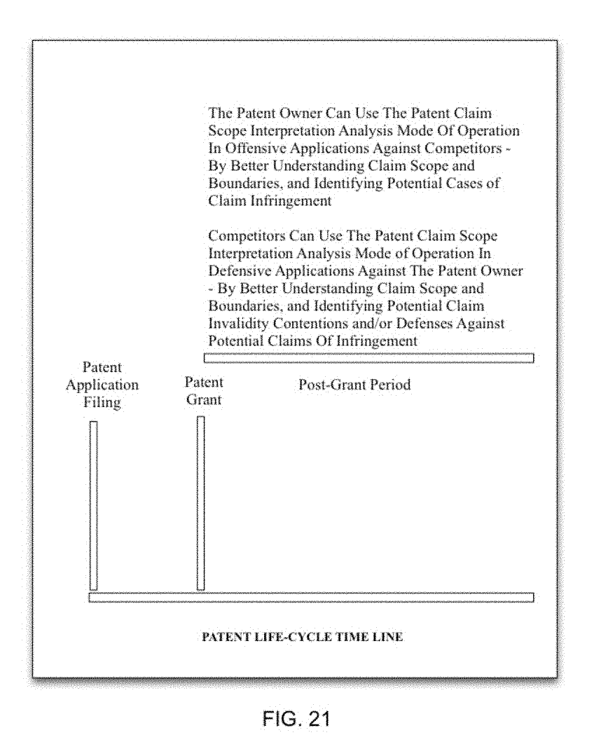

Referring now to the detailed flow chart set forth in FIGS. 20A through 200, the Internet-based patent analysis and charting system of the present invention configured in its patent claim scope interpretation (i.e. construction) analysis mode of system operation will be now described in detail, and showing how one or more users can efficiently analyze and chart the patent prosecution history of any granted patent, using the wireframe GUI screens set forth in FIGS. 22A through 22DD, the mapping techniques illustrated in FIGS. 19, 23, 24, 25A, 25B, and 26, and the patent prosecution history based chart structures described in FIGS. 27A through 27F. Various applications for the patent analysis and charting system configured in this mode of operation are illustrated in FIG. 21 and will be described in greater detail hereinbelow.

The steps of the process described in FIGS. 20A through 20H will be described in detail below.

As indicated in Step A in FIG. 20A, Web, application and database servers on a network are used to deploy an Internet-based object-oriented system platform that supports a computer-assisted analysis and charting of the prosecution history of any patent granted in a national patent protection system. As shown, the network is connected to the network information infrastructure and servers of national patent protection systems, and patent and published patent application depositories containing composite patent file history data documents for granted patents and pending (or abandoned) patent applications.

As indicated in Step B in FIG. 20A, web-enabled client machines are used to allow authorized users to log into the deployed patent analysis and charting system and perform the following operations specified below. An exemplary login GUI screen is shown in FIG. 22A for that purpose. In FIG. 22B, a GUI screen is shown for managing User Account information on the platform.

As indicated in Step C in FIG. 20A, the user employs a GUI screen as shown in FIG. 22B, to configure the patent analysis and charting system in its patent claim scope interpretation analysis mode of system operation (MODE 1), for computer-assisted analysis and charting of a particular patent application, prior to patent grant. In general, the patent analysis and charting system comprises a database for storing the patent file history data, patent claim data, and prior art reference data, and supporting methods, procedures, GUIs, etc. during patent scope interpretation analysis.

As indicated in Substep D1 in FIG. 20B, the user employs a GUI screen as shown in FIG. 22C, so as to provide the Internet-based system with the patent application serial number of a patent application pending in a national patent protection system. Then at Substep D2, using a GUI screen as shown in FIG. 22D, all patent file history data of the pending (or abandoned) patent application, including file wrapper history documents, patent claim data, cited prior art reference documents, etc., are uploaded from patent servers shown in FIG. 5, into the database 15 of the Internet-based system, in a format suitable for parsing and search analysis, and associate this patent file history data with the patent application serial number.

As indicated in Substep E1 in FIG. 20B, a GUI screen as shown in FIG. 22E is employed so that, whenever necessary, the system uses optical character recognition (OCR) and/or other technologies to convert all documents in the patent prosecution (i.e. file) history data set into text searchable documents, as and where necessary, so that each such document is text searchable during the method of prosecution history analysis and charting according to the present invention.

As indicated in Substep E2 in FIG. 20B, a GUI screen as shown in FIG. 22F is employed so that all documents in the patent file history data set of the patent application are indexed by first assigning a unique document number to each and every document in the patent file history data set of the patent application, and then second by compiling a complete list of indexed documents from the indexed patent file history data set.

As indicated in Substep E3 in FIG. 20B, a GUI screen as shown in FIG. 22G is employed so that each document in the complete list of indexed patent file history documents, is cataloged into one of the three document categories: (i) Patent Office Originated Documents; (ii) Applicant/Owner Originated Documents (including Patent Specification and Claims); and (iii) Reference Documents Originated by the Patent Office, Applicant/Owner, or any party or entity.

As indicated in Step F in FIG. 22C, a GUI screen as shown in FIGS. 22H and 221 is employed while logged into the patent analysis and charting system, the system displays a complete list of Reference documents, and for each such reference document in the list, the user uses the GUIs and methods of the system to identify and classify the cited reference as either: (i) cited and applied in claim rejection; (ii) cited and not applied in claim rejection; or (iii) cited but not prior art; and then store these reference classifications in the system database.

As indicated in Step G in FIG. 20C, a GUI screen as shown in FIG. 22J is employed so that the system enables the recording of the current history of the patent claims in the system database, including a concise status of patent claims, patent claim amendments, and patent claim examination during the patent prosecution history of the patent grant. In the illustrative embodiment, this is achieved as follows. While logged into the patent analysis and charting system, the system displays a complete list of Applicant/Owner Originated documents, and then each such document, including an Amendment to the Claims is analyzed by the user using the GUIs and methods of the system so as to build and record a patent claim history within the system database 15. In the illustrative embodiment, the patent claim history comprises:

(i) specification of all patent claims presented during the patent prosecution history, including the language of each originally filed claim, as filed and using original claim numbering;

(ii) specification of the date each patent claim was amended and/or canceled, voluntarily, and not in response to an examiner's claim rejection;

(iii) specification of which patent claims were allowed without rejection, and specify the date of allowance and the Examiner who made the allowance;

(iv) specification of which claims were rejected, identify the statutory basis of each such rejection (e.g. 35 USC Section 102 and/or 103) and prior art references upon which the claim rejection was made, and specify the date of the claim rejection and the Patent Examiner who made the rejection;

(v) specification of the language of each claim amendment, identify when the amendment was made and by whom (i.e. using USPTO Attorney/Agent Registration Number for registered agents and attorneys, and Applicant's name for pro se applications);

(vi) specification of which claims where allowed after rejection in response to an argument for patentability and request for reconsideration, and a specification of the language of each such allowed claim; and

(vii) specification of which claims where allowed after rejection in response to an argument for patentability, an amendment to the claims, and a request for reconsideration, and a specification of the language of each such allowed claim.

As indicated in Step H in FIG. 20D, a GUI screen as shown in FIG. 22K is employed so that the system allows the user to link examiner and/or applicant statements made during the patent prosecution history to the limitations and/or sub-limitations of allowed and never rejected patent claims. In the illustrative embodiment, this is achieved as follows. While logged into the patent analysis and charting system, the user use the GUIs and methods of the system to perform the following operations for each claim that was allowed and never rejected by the Examiner:

(i) parse the allowed patent claims into a set of parsed claim limitations comprising a set of natural language strings representing the set of parsed claim limitations;

(ii) identify statements made by the Examiner, as well as the Applicants, pertaining to prior art disclosure (e.g. searchable text and searchable graphics and/or images) found in cited (and applied or non-applied) references, which correspond to particular claim limitations in the allowed patent claims, and link these statements to corresponding claims, and claim limitations and/or sub-limitations, and store these links in the system database;

(iii) identify any explicit “Reasons for Allowance” statements made by the Examiner and/or Applicant during the patent prosecution history, link these statements to corresponding claims, and claim limitations and/or sub-limitations, and store these links in the system database;

(iv) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), link these statements to corresponding claims, and claim limitations and/or sub-limitations, and store these links in the system database; and

(v) identify any cited reference statements disclosing a motivation to combine the prior art references, cited by the Examiner, during specific claim rejections under Section 35 USC Section 103, link these statements to corresponding claims, and claim limitations and/or sub-limitations, and store these links in the system database.

As indicated in Step I in FIG. 20D, a GUI screen as shown in FIG. 22L is employed so that the system allows the user to link examiner and/or applicant statements made during the patent prosecution history to the limitations and/or sub-limitations of rejected but ultimately allowed patent claims. While logged into the patent analysis and charting system, the user uses the GUIs and methods of the system to perform the following operations for each claim that was rejected, but eventually allowed by the Examiner:

(i) parse the rejected but ultimately allowed patent claims into a set of parsed claim limitations comprising a set of natural language strings representing the set of parsed claim limitations;

(ii) identify statements made by the Examiner, as well as the Applicants, pertaining to prior art disclosure (e.g. searchable text and searchable graphics and/or images) found in cited (and applied or non-applied) references, which correspond to particular claim limitations in the allowed patent claims, and link these statements to corresponding claims, and claim limitations and/or sub-limitations, and store these links in the system database;

(iii) identify any explicit “Reasons for Allowance” statements made by the Examiner and/or Applicant during the patent prosecution history, link these statements to corresponding claims, and claim limitations and/or sub-limitations, and store these links in the system database;

(iv) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), link these statements to corresponding claims, and claim limitations and/or sub-limitations, and store these links in the system database; and

(v) identify any cited reference statements disclosing a motivation to combine the prior art references, cited by the Examiner, during specific claim rejections under Section 35 USC Section 103, link these statements to corresponding claims, and claim limitations and/or sub-limitations, and store these links in the system database.

As indicated in Step J in FIG. 20E, a GUI screen as shown in FIGS. 22M through 22T are employed so as to allow the user to define scope concepts based on analysis of stored links, and linking claim limitation language of each allowed patent claim to one or more scope concepts, and storing each scope concept and link in the system database. This is achieved as follows. While logged into the patent analysis and charting system, the user (e.g. patent attorney) uses these GUIs and methods supported by the system to perform the following operations for each allowed claim in the patent prosecution history, stored in the system database 15:

(i) display the allowed patent claims using final patent numbering, or any selected group of claims (e.g. all claims, all independent claims, or a particular subset of claims);

(ii) using the statements previously linked to corresponding claim limitations in the allowed patent claim, identify and formulate one or more scope concepts expressed in and/or embraced by or embodied within the claim limitation language of each allowed patent claim, and store these scope concepts in the system database;

(iii) for each claim limitation, link a scope concept to the corresponding language of the claim sub-limitation that supports the scope concept and store these claim limitation/scope concept links in the system database; and

(iv) repeat step (iii) above for each claim limitation, as necessary to capture essential scope concepts embodied within the allowed claim.

FIG. 23 describes both the direct linking and scope concept mapping processes employed during the patent claim scope analysis mode of system operation. Specifically, this schematic diagram graphically illustrates the linking of claim sub-limitation language with linguistic statements made in patent file history documents, including the patent specification, office action documents, amendments and prior art references, all of which are linked together in a transparent manner using patent scope concepts, stored in the system database 15, and ultimately displayed in a novel claim chart structure of the present invention, to support the patent claim scope interpretation/construction process carried out in diverse user environments where the scope and boundaries of patent protection are relevant and/or important.

The method of scope concept formulation, assignment/indexing and linkage employed in the above step will be described in greater technical detail below with reference to FIGS. 24, 25A, 25B and 26.

### Method of Scope Concept Formulation, Assignment and Linkage Supported by the System of the Present Invention

FIG. 24 describes a general method of claim scope concept (CSC) formulation, assignment and linkage (e.g. indexing) that can be practiced within the multi-mode patent analysis and charting system of the present invention, during any of the patent claim, prosecution history, prior art reference, and product/service infringement and other mapping operations supported within the multi-mode system.

As indicated in Step A of FIG. 24, the user of the patent analysis and charting system is allowed to search two or more words in any phrase in any patent claim, as well as in any document in the patent file wrapper (PFW) of a patent grant, or pending patent application.

As indicated in Step B of FIG. 24, the system then asks the user to think or conceive of a scope concept that embraces the searched words or phrases.

As indicated in Step C of FIG. 24, the system displays graphical user interfaces (GUIs) as shown in FIGS. 22P through 22T that allow the user to define or formulate the conceived scope concept in natural language, and enter the formulated scope concept into a scope concept library supported within the system.

As indicated in Step D of FIG. 24, the users uses the system and its GUIs to find and link searched words throughout all file history documents/papers, that correspond to the formulated scope concept.

As indicated in Step E of FIG. 24, the user uses the system GUIs to store these language/scope concept links in the system database maintained within the system.

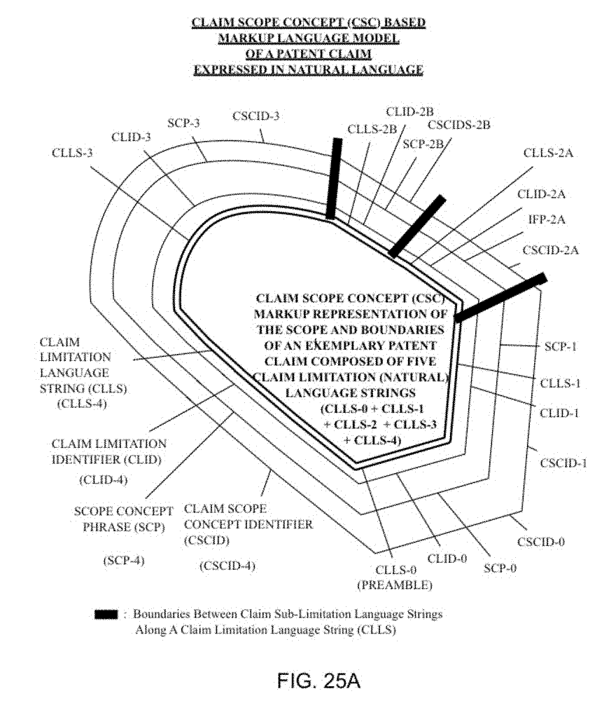

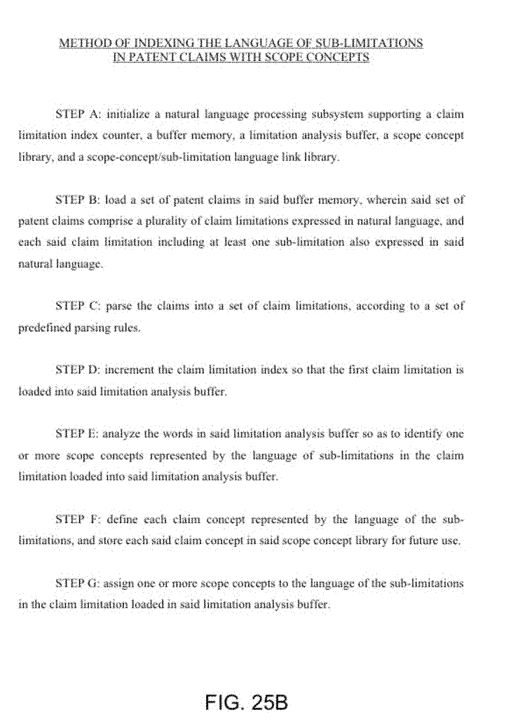

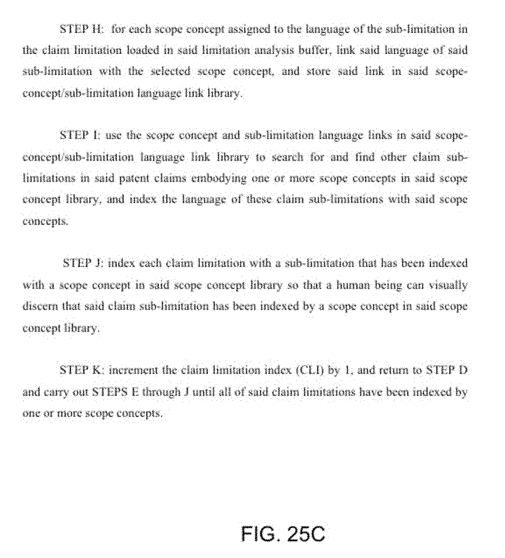

In FIG. 25A and FIG. 25B, a preferred method is disclosed in detail for assigning (i.e. indexing) (i) the language of sub-limitations in patent claims, with (ii) formulated scope concepts. As will become apparent hereinafter, this method of scope concept indexing or assignment can be practiced during many of the patent analysis modes supported within the multi-mode system of the present invention. This scope concept indexing method will be now described with reference to the natural language processing subsystem architecture shown in FIG. 26A, and embodied within the computing capacities of the various servers and data center, shown in FIGS. 5, 6A and 6B, supporting the Internet-based system implementation of the present invention.

Method of Indexing or Marking-Up the Natural Language of Claim Limitations and/or Sub-Limitations in Patent Claims Using Scope Concept Phrases (SCPs)

Before describing the scope concept indexing (or marking-up) method of the illustrative embodiment, it will be helpful to describe the Claim Scope Concept (CSC) Based Markup model show in FIG. 25A, for any patent claim expressed in natural language, and directed to a useful invention, setting forth the meets and boundaries (i.e. the scopes and limits) of patent protection to be afforded to the invention covered by the patent claim.

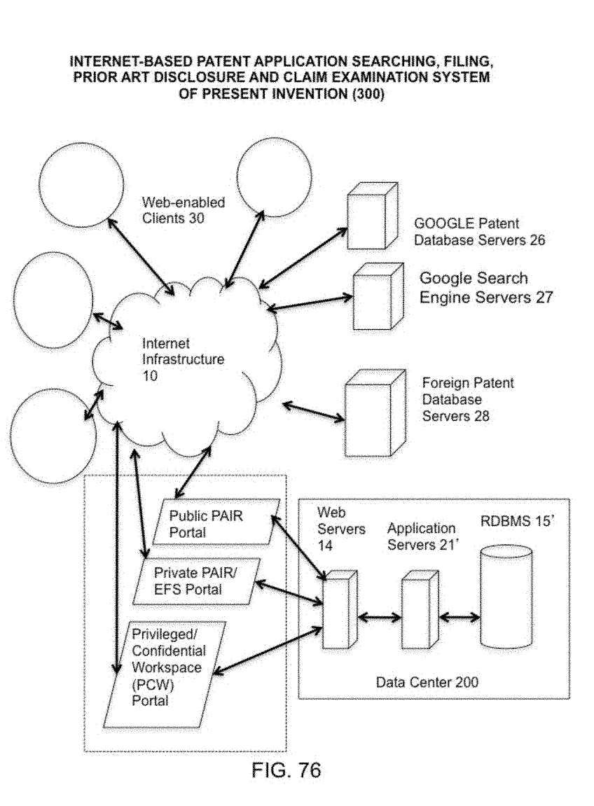

As shown in the CSC Markup Model of FIG. 25A, a marked up patent Claim is composed of a plurality of claim limitation language strings (CLLS), wherein during the markup process, the following process is performed: (i) each claim limitation language string (CLLS) is assigned a claim limitation identifier or index (CLID); (ii) a Claim Scope Concept Phrase (CSCP) composed of a set of words (W1, . . . WN) describing the Scope Concept encompassed by the Claim Limitation Language String (CLLS) is assigned to the CLLS, and wherein the words selected for the Claim Scope Concept Phrase (CSCP) may or may not have an antecedent basis in the CLLS and may be abstracted from the CLLS to encompass subject matter beyond the literal interpretation of the CLSS; and (iii) a Claim Scope Concept Structure Identifier (CSCSID) is assigned to the CLLS, to identify the entire CSC data structure, in accordance with the principles of the present invention. In general, the results of the claim markup process are stored in the system database for the user or user group, and are made available for use in the various CSC-based processes supported on the system of the present invention, as will be described in detail below. However, it is understood that there are other ways in which to implement this illustrative embodiment of the CSC-based mark-up or indexing process of the present invention (e.g. using XML techniques as described in connection with the illustrative embodiment of the present invention disclosed in FIGS. 76 through 120C).

Referring now to FIGS. 25B through 26C, the first illustrative embodiment of CSC-based mark-up process of the present invention will be described below, wherein the claim limitation and/or sub-limitation language in each patent claim is systematically marked-up (i.e. indexed) using Claim Scope Concepts which are expressed as a set of the linguistic units such as words and/or phrases, and subsequently used during the practice many of the patent analysis modes supported within system of the present invention, and elsewhere.

As indicated in Step A of FIG. 25B, the first step of the claim markup process involves deploying (e.g. instantiating and initializing) a natural language handling and processing subsystem (within the multi-mode system of FIGS. 5, 6A and 6B) so as to support the claim limitation index counter, the buffer memory, the limitation analysis buffer, the scope concept library, and the scope concept/sub-limitation language link library shown in FIG. 26A, and other services, which will be used to carry out the method of scope concept indexing/mapping practiced during Step J of FIG. 20E, described above, and elsewhere throughout the present Specification.

Then as indicated in Step B of FIG. 25B, a set of patent claims (e.g. associated with a pending application or specified patent grant) is loaded into the buffer memory of FIG. 26A, wherein the set of patent claims comprises a plurality of claim limitations expressed in natural language, and each claim limitation includes at least one sub-limitation also expressed in natural language, which may also include one or more of the following types of language: mathematical language, computer language (e.g. markup/presentational as well as programming language), chemical structure language, biological language, scientific language, engineering, musical language, and other languages known or to be known to man, and possibly executable by machine.

As indicated in Step C of FIG. 25B, the claims are parsed into a set of claim limitations, according to a set of predefined parsing rules.

As indicated in Step D of FIG. 25B, the claim limitation index is incremented so that the first claim limitation is loaded into the limitation analysis buffer shown in FIG. 26A.

As indicated in Step E of FIG. 25B, the words in the limitation analysis buffer are automatically analyzed (i.e. programmatically analyzed) so as to identify one or more scope concepts represented by the language of sub-limitations in the claim limitation loaded into the limitation analysis buffer.

As indicated in Step F of FIG. 25B, each claim concept represented by the language of the sub-limitation is defined by the user, and then each formulated claim concept is stored in the scope concept library, within the system database 15, for future use.

As indicated in Step G of FIG. 25B, the user assigns one or more scope concepts to the language of the sub-limitations in the claim limitation loaded in the limitation analysis buffer, shown in FIG. 26A.

As indicated in Step H of FIG. 25C, for each scope concept assigned to the language of the sub-limitation in the claim limitation loaded in said limitation analysis buffer, the language of the sub-limitation is linked with the selected scope concept, and then link is stored in the scope concept/sub-limitation language link library, shown in FIG. 26A.

As indicated in Step I of FIG. 25C, the scope concept and sub-limitation language links that have been stored in the scope concept/sub-limitation language link library are then used to automatically search (i.e. programmatically search) for and find other claim sub-limitations in the patent claims embodying one or more scope concepts in the scope concept library, and the language of these claim sub-limitations are then indexed (i.e. linked up) with the scope concepts.

As indicated in Step J of FIG. 25C, each claim limitation is indexed or marked up (i.e. linked up) with a sub-limitation that has been indexed with a scope concept in the scope concept library so that a human being can visually discern that the claim sub-limitation has been indexed by a scope concept in the scope concept library.

As indicated in Step K of FIG. 25C, the claim limitation index (CLI) is then incremented by 1, and the process returns to STEP D and STEPS E through J are carried out until all of the claim limitations have been indexed by one or more scope concepts.

The scope concept indexing method of FIG. 24 described above provides many advantages and benefits in the context of the multi-mode patent analysis system of the present invention. A primary advantage is increased speed in scope concept indexing a set of patent claims in a granted patent because, once a scope concept has been formulated, defined and stored in the system database, the system will automatically search the language (i.e. linguistic strings) supporting each claim limitation and sub-limitation in the remaining set of claims, and (i) automatically identifies (i.e. programmatically identifies), for the user, other claim sub-limitations which appear to embody the previously (i.e. currently) indexed scope concept, and (ii) allows the use to simply select these corresponding claim sub-limitations for similar scope concept indexing, thereby greatly reducing the time required by a user to scope concept index any set of allowed patent claims under analysis. A secondary benefit of this scope concept indexing subsystem of the present invention is that it applies artificial intelligence (AI) of sorts, to assist the user during the scope concept indexing process, but never overrides the user's linguistic judgment, but rather merely makes intelligent suggestions for what other claim sub-limitations, in a particular set of allowed patent claims, appears to embody a particular scope concept just assigned to a patent claims during the scope concept indexing process. 0 Notably, this process of hunting and searching for similar claim language in other claim sub-limitations, that embody a particular scope concept, can be made to operate (i) in a forward-looking mode (i.e. only searching for similar claim language present downstream in the set of allowed claims under scope concept processing, or (ii) in a recursive mode (i.e. searching for similar claim language both downstream and upstream in the set of allowed claims under scope concept processing.

Using the method of the present invention, the definition of any given scope concept will be formed by linking the formulated scope concept and all corresponding sub-limitation language strings [Scope Concept: {Claim Limitations Language}] and storing these definitions in the Scope Concept/Sub-Limitation Language Link Library.

When the scope concept indexing subsystem is operated in its the forward-looking mode, the scope concept definition of any scope concept will be modified as required to capture the corresponding claim sub-limitation language of each scope concept assignment made in the allowed set of patent claims, and as the process progresses towards the later claims in the set of claims, there will be typically more corresponding claim sub-limitation language strings associated with the scope concept definition, and therefore more opportunities to find similarities with other claim sub-limitations in the set of patent claims being processed. When the scope concept indexing (i.e. markup) subsystem is operated in its the recursive mode, the scope concept definition of any scope concept will be also modified as required to capture the corresponding claim sub-limitation language of each scope concept assignment made in the allowed set of patent claims. However, as the process progresses towards the later claims in the set of claims, there will be typically more corresponding claim sub-limitation language strings associated with the scope concept definition, both before and after any given scope concept assignment, and therefore even more opportunities to find similarities with other claim sub-limitations in the set of patent claims being processed. Thus, in recursive mode, the system can and will typically find claim sub-limitations that have been previously reviewed and analyzed, but will be suggested by the system as being potential candidates for scope concept indexing with a particular scope concept added to the Scope Concept Library.

During the process of claim scope concept analysis and scope concept formulation described above, the user assigns one or more scope concepts to each patent claim in the set of patent claims under analysis. Then, for the set of patent claims, the system automatically (i.e. programmatically) forms and maintains a Library of Scope Concepts (“Scope Concept Library”) stored in the system database 15. At any time, the user can review the Scope Concept Library for any given set of patent claims under analysis by clicking on the Scope Concept Library graphical icon presented with the GUI screens displayed by the system, as shown in FIG. 22U, for example.

For each patent claim that has been scope concept analyzed, the system automatically (i.e. programmatically) generates a Claim Scope Concept Profile, as shown in FIG. 26B, comprising a complete List of Scope Concepts that have been assigned to corresponding language in the claim limitations and/or sub-limitations of the Patent Claim. The system also maintains a Library of Scope Concept/Claim links, as shown in FIG. 22U.

As indicated in Step K in FIG. 20E, a GUI screen as shown in FIGS. 22U and 22V is displayed to the users so that the user can define concept groups and store the same in the system database 15. Also, as shown, the system uses the scope concepts formulated for the set of Claims to automatically generate a Scope Concept Based Prior Art Reference Analysis GUI 26C for display during prior art reference analysis. This is achieved by the system automatically (i.e. programmatically) constructing an HTML-based GUI schema for the Scope Concept Based Prior Art Reference Analysis GUI 26C. In the illustrative embodiment, the Scope Concept Based Prior Art Reference Analysis GUI 26C would be implemented as a Web-based interface using, for example, an HTML (or XHTML5) document served to the client machine. As a HTML schema defines the structure of an HTML document/interface, and XHTML5 schema defines the structure of an XHTML5 document/interface, an HTML (or XHTML5) schema would be automatically (i.e. programmatically) defined using the Scope Concepts for the set of Claims, stored in the system database 15 for subsequent use when generating the HTML-based Scope Concept Prior Art Reference Analysis GUI 26C.

As indicated in Step L in FIG. 20F, a GUI screen as shown in FIG. 22W is employed so that the user can link statements in patent office originated documents to one or more scope concepts defined above, and store each link in the system database. Specifically, while logged into the patent analysis and charting system, display each Patent Office Originated Document, and use the GUIs and methods of the system to perform the following operations: (i) identify statements made in Patent Office Originated Document embodying one or more scope concepts, and then link the scope concepts to the statements made in the Patent Office Originated Document; and (ii) store these links within the system database for future use.

As indicated in Step M in FIG. 20F, a GUI screen as shown in FIG. 22X is employed so that user can link statements in Applicant/Owner originated documents to one or more scope concepts defined above, and storing each link in the system database. Specifically, while logged into the patent analysis and charting system, display each Applicant/Owner Originated Document, the user uses the GUI screen and methods of the system to perform the following operations: (i) identify statements in the Applicant/Owner Originated Document (including Patent Specification) embodying one or more scope concepts, and then link these scope concepts to the statements in the Applicant/Owner Originated Document; and (ii) store these links within the system database for future use.

As indicated in Step N in FIG. 20F, a GUI screen as shown in FIG. 22Y is employed so that the user can analyze cited and applied prior art references using the scope concept based prior art reference analysis GUI, and then store the analysis in the system database. Specifically, while logged into the patent analysis and charting system, use the GUIs and methods of the system to perform the following operations on each cited and applied reference in the Reference Documents: (i) analyze the cited and applied prior art references using the scope concept based prior art reference analysis GUI determined during Step M above; and (ii) store in the system database, (a) all “pertinent/relevant” disclosure cited in the cited and applied prior art reference corresponding to and substantiating the scope concepts specified in the scope concept based prior art reference analysis GUI shown in FIG. 26C, and (b) the citation of the pertinent/relevant disclosure, for future referral and access.

After each Prior Art Reference is analyzed using the Claim Scope Concept (CSC) Based Prior Art Reference Analysis GUI during scope concept based prior art analysis in Step N, then a Prior Art Reference Claim Scope Concept (CSC) Profile is automatically generated for the Prior Art Reference that has been scope concept analyzed, as illustrated in FIG. 26D. As shown in FIG. 26D, the Prior Art Reference Claim Scope Concept Profile for each Prior Art Reference comprises: (i) a Master Claim Scope Concept List indicating which scope concepts (assigned to the set of Claims) have and have not been substantiated by prior art disclosure (e.g. searchable text and/or images or graphics) contained the prior art reference, and (ii) a Claim Scope Concept Profile, for each patent claim, indicating which scope concepts in each patent claim have and have not been substantiated by prior art disclosure contained in the Prior Art Reference, with a citation from the Prior Art Reference as to where the substantiating disclosure can be found in the Prior Art Reference.

As indicated in Step O in FIG. 20G, a GUI screen as shown in FIG. 22Z is employed so that the user can analyze cited and non-applied prior art references using the scope concept based prior art reference analysis GUIs, and then store the analysis in the system database. Specifically, while logged into the patent analysis and charting system, the user employs the GUIs and methods of the system to perform the following operations on each cited and non-applied reference in the Reference Documents: (i) analyze the cited and non-applied prior art reference using the prior art reference data analysis GUIs determined during Step M above; and (ii) store in the system database (a) all “pertinent/relevant” disclosure cited in the cited and non-applied prior art reference corresponding to the scope concepts specified in the prior art reference analysis GUI, and (b) the citation of the pertinent/relevant disclosure, for future referral and access.

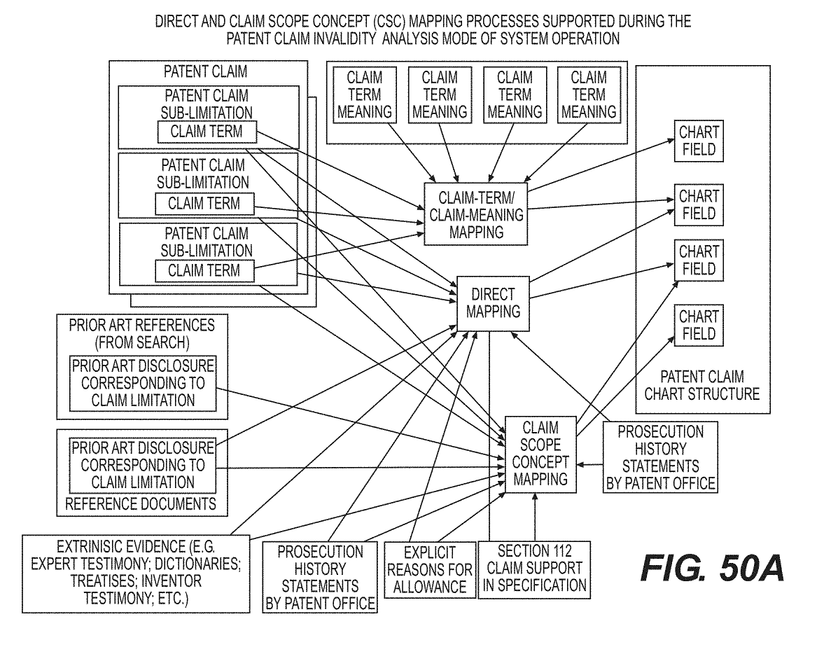

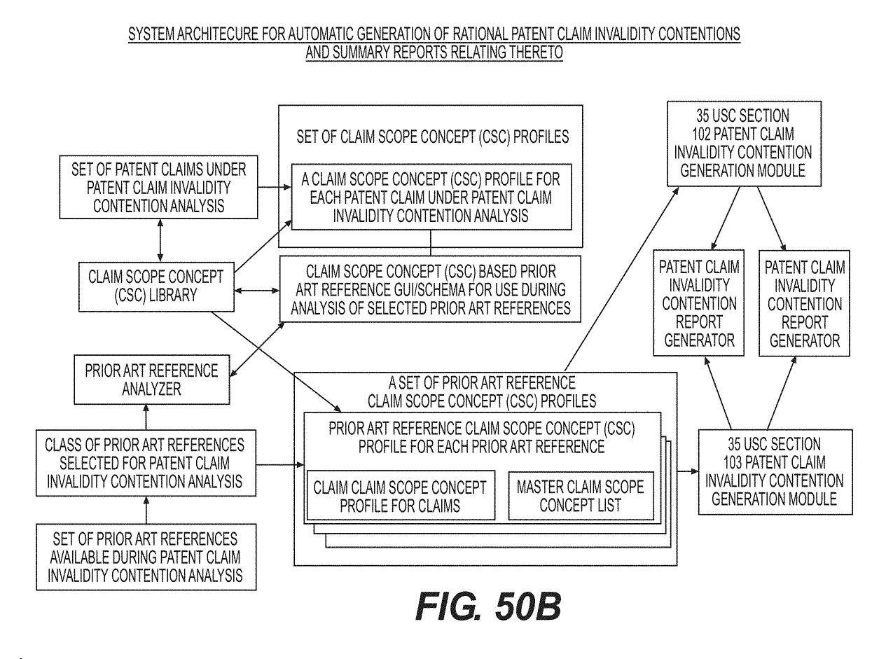

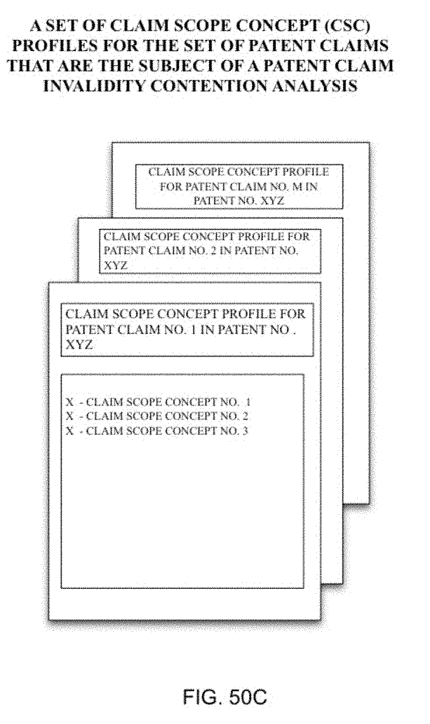

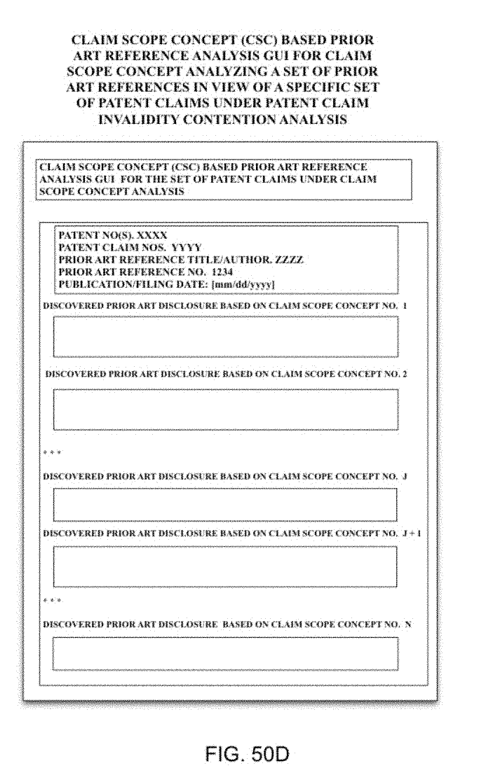

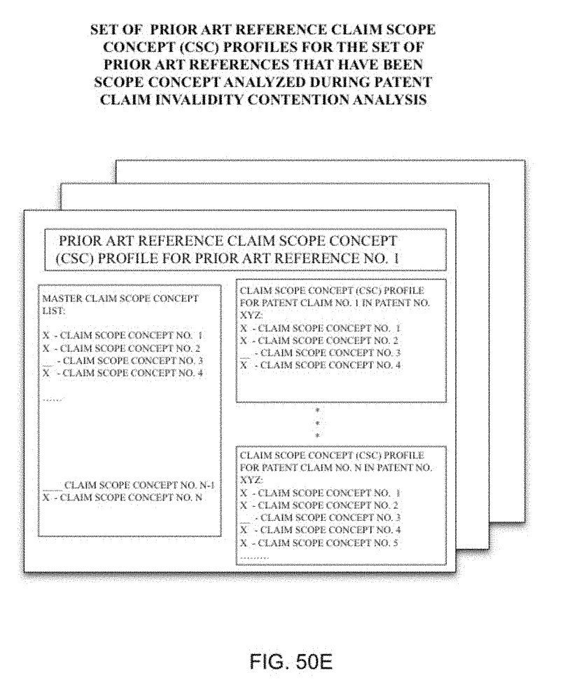

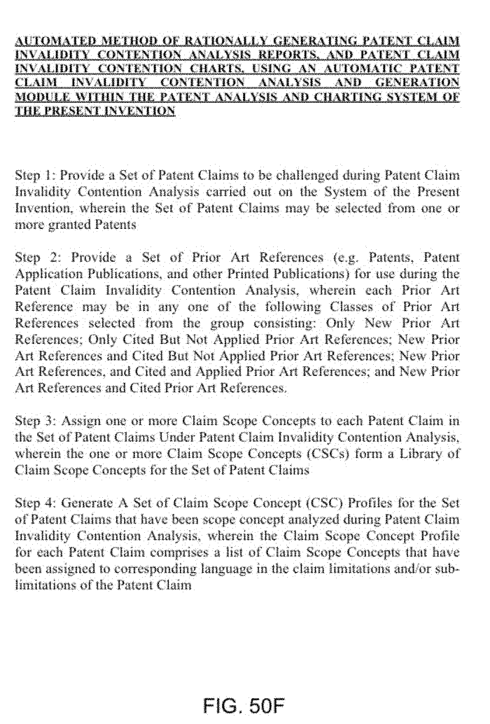

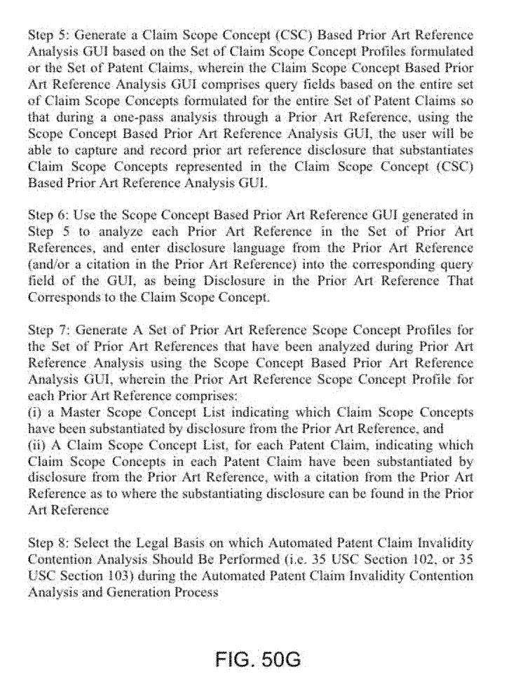

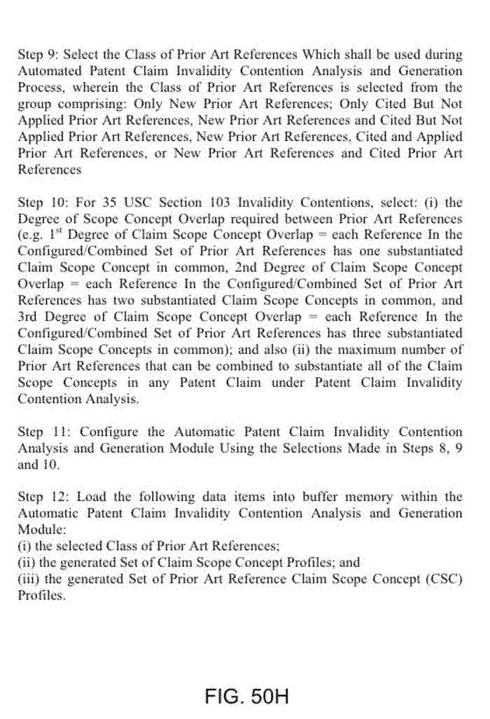

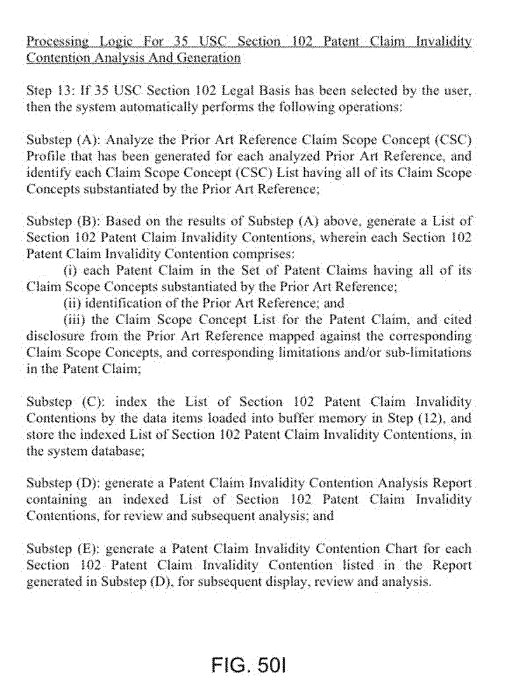

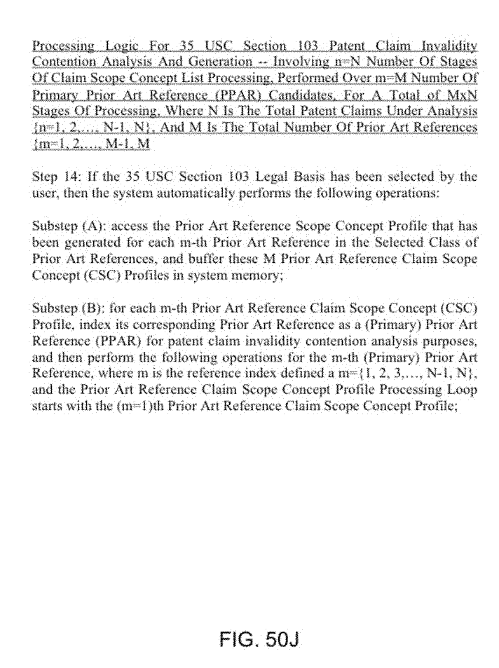

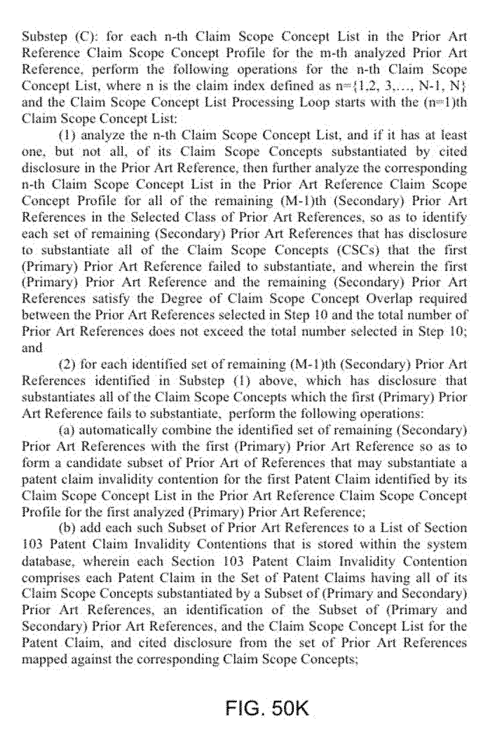

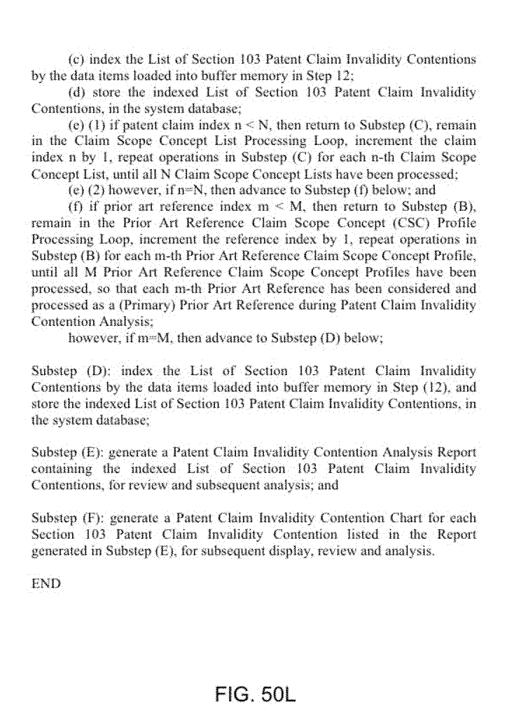

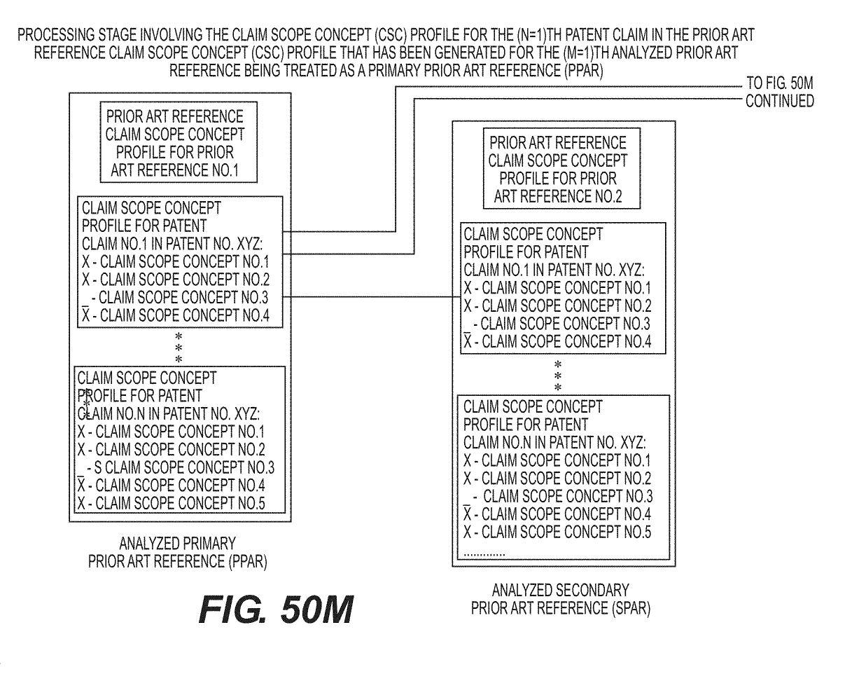

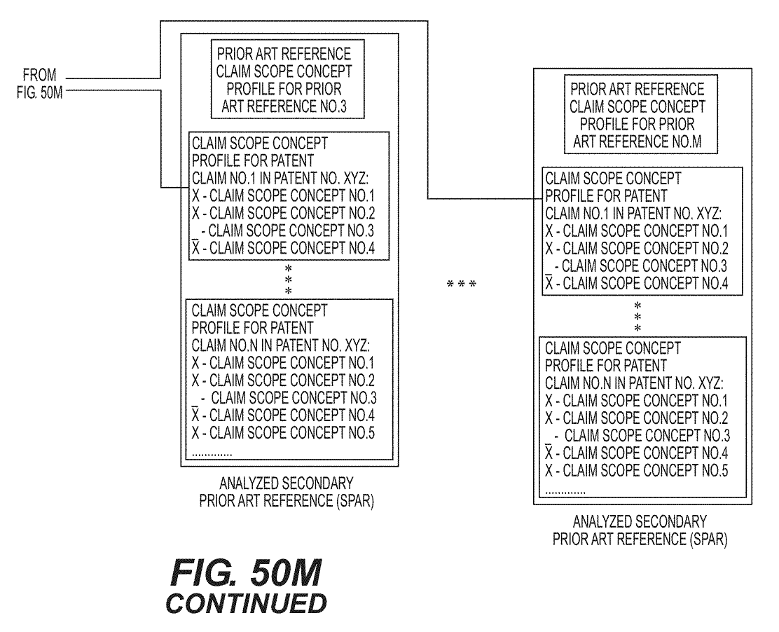

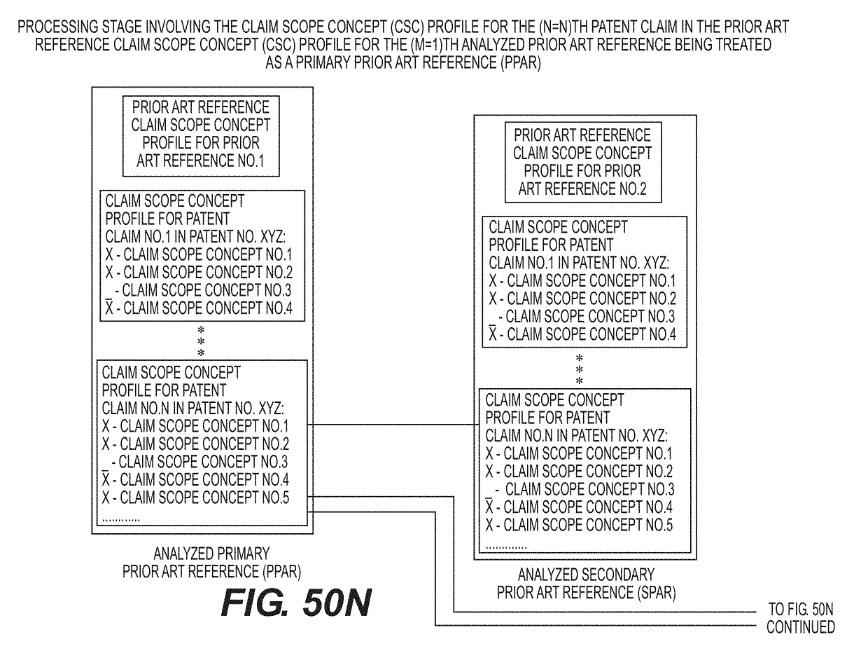

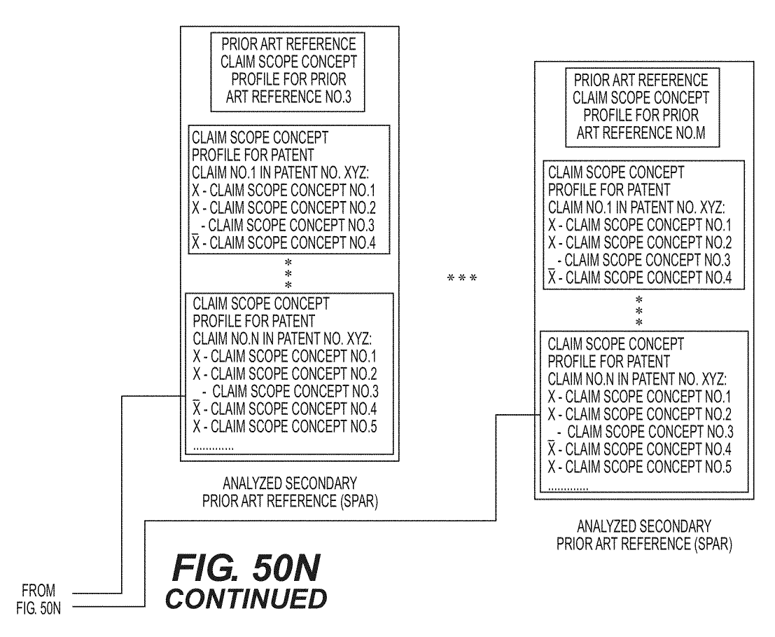

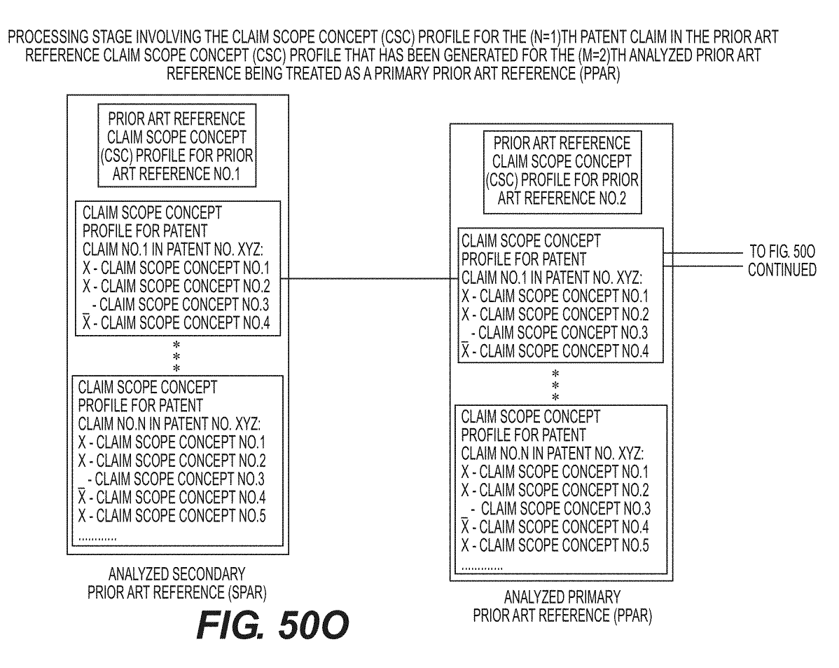

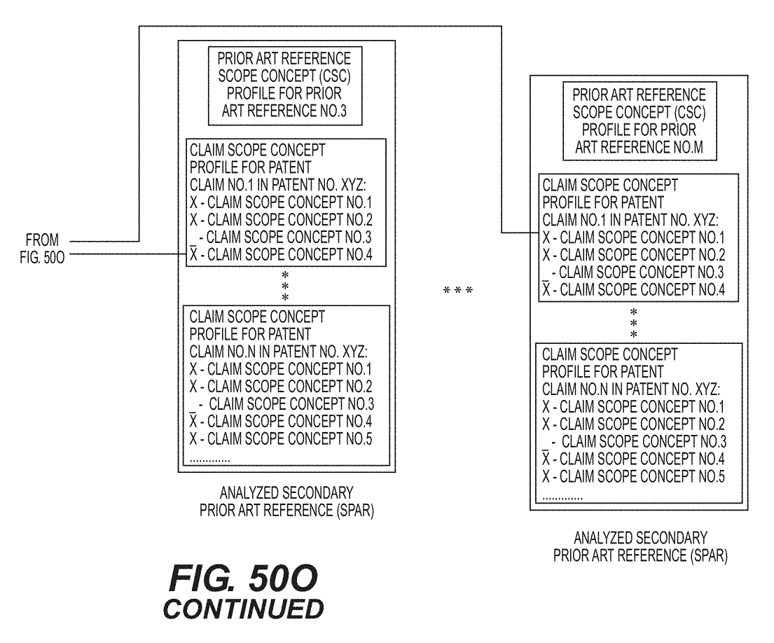

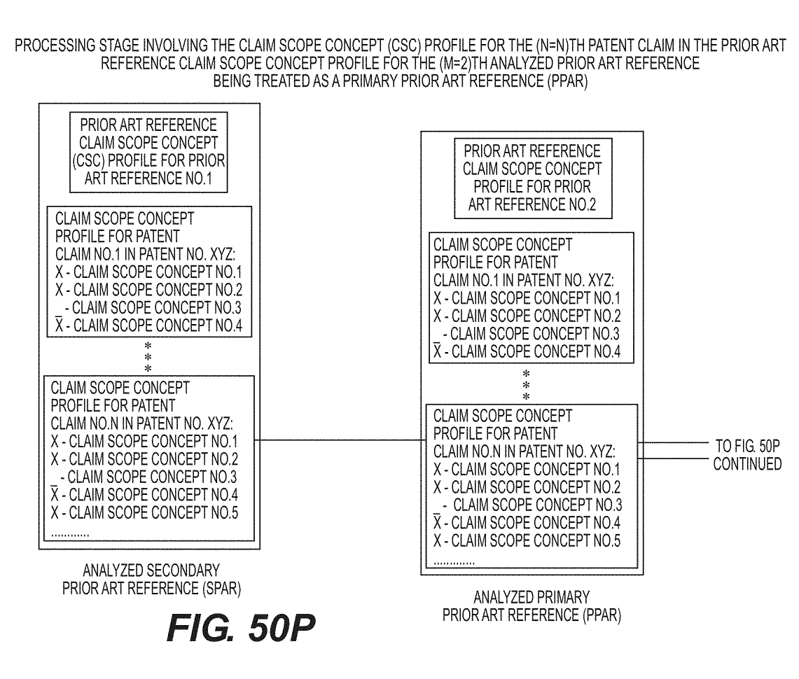

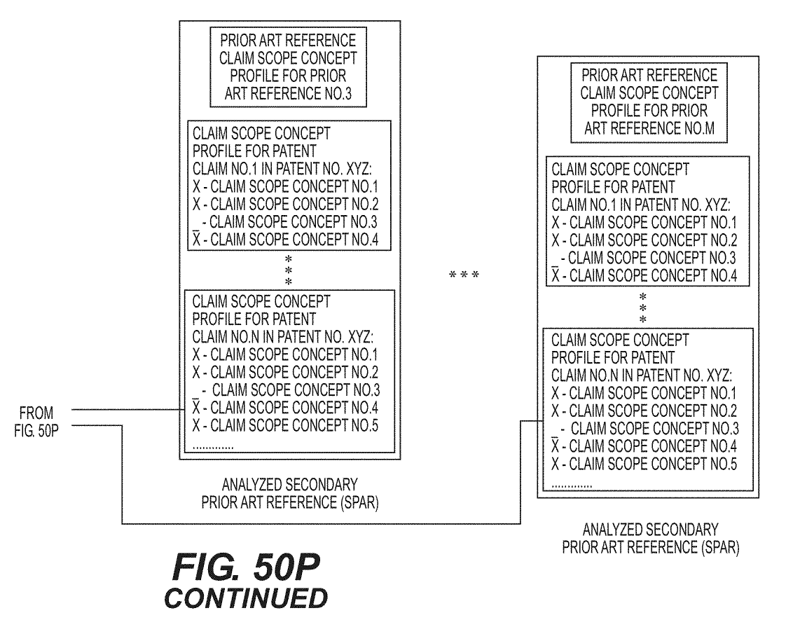

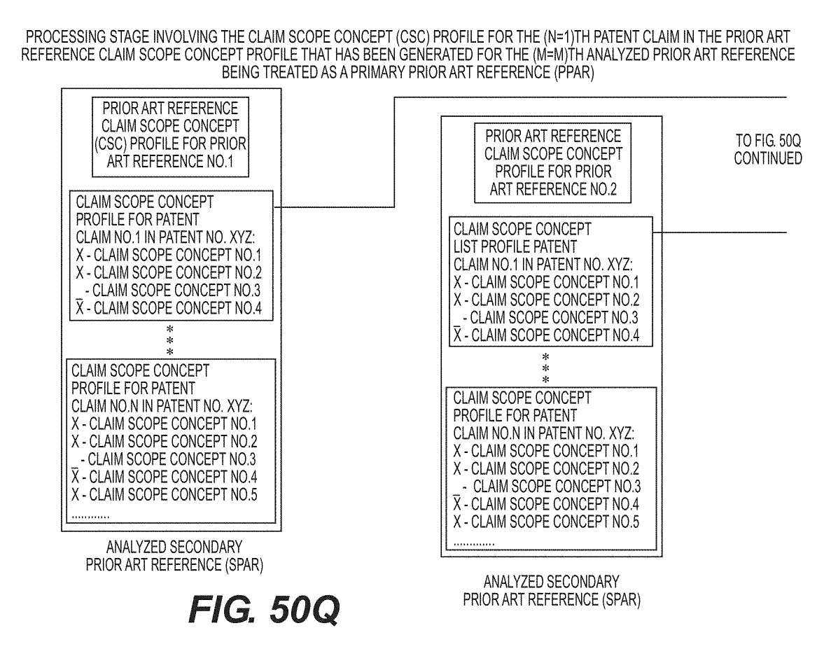

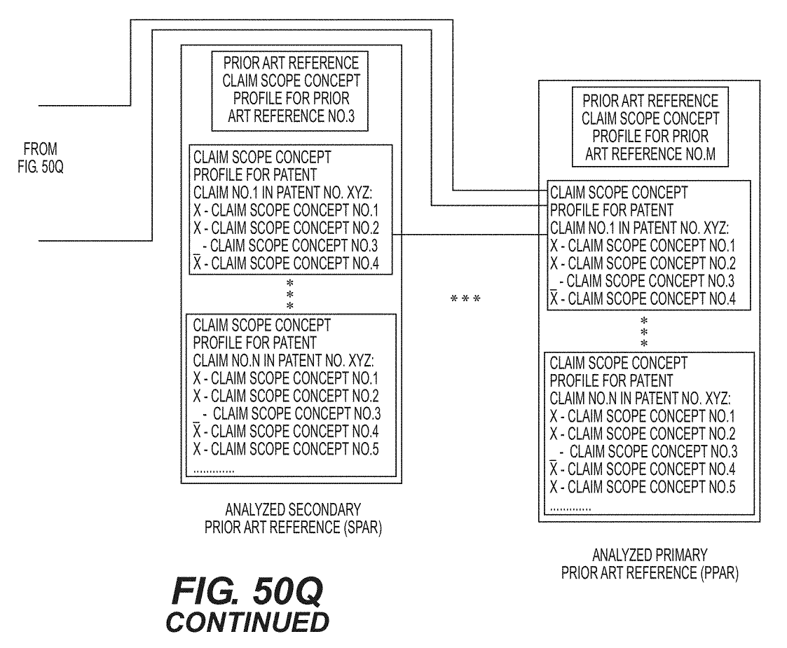

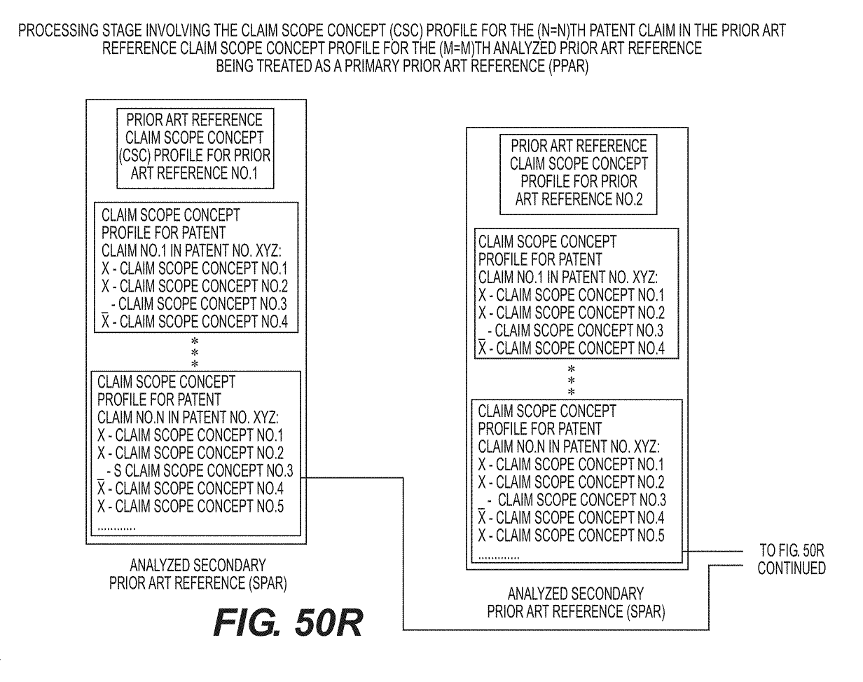

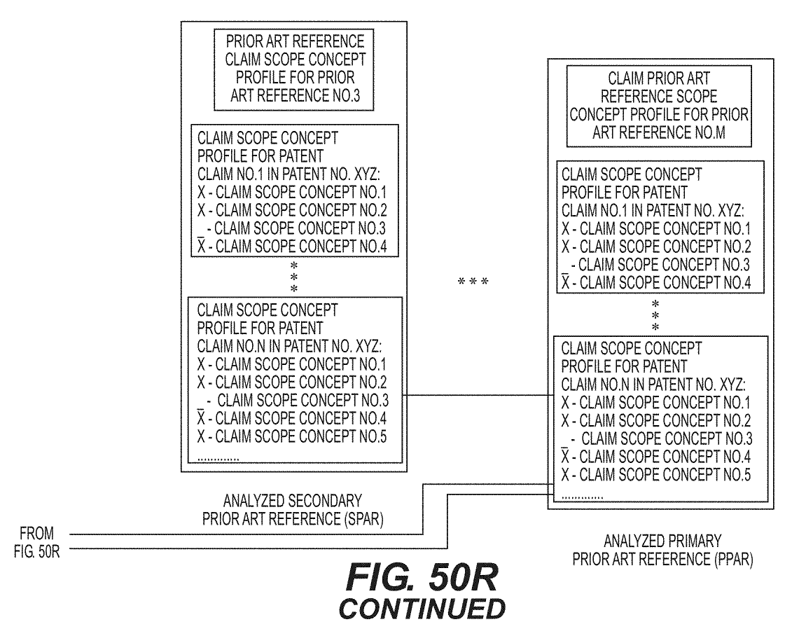

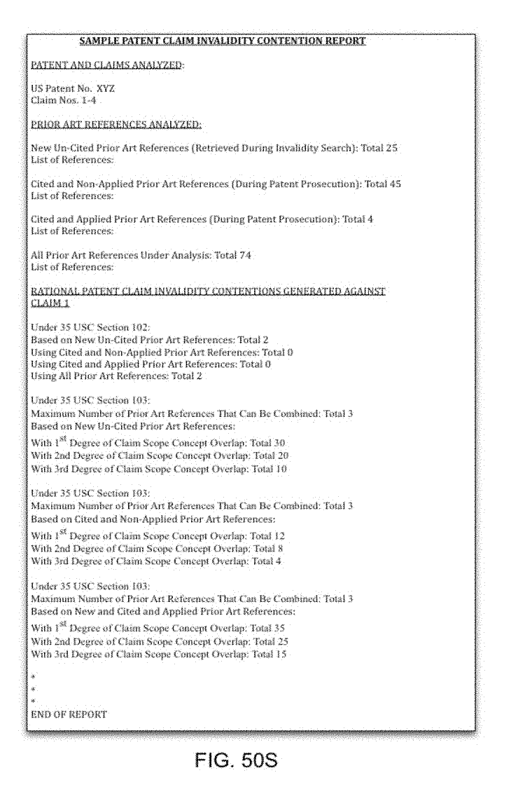

In alternative embodiments of the present invention, computer-assisted search methods/techniques can be used to analyze the language and other symbols contained in each prior art reference (e.g. cited and non-applied class) in the set of prior art references being analyzed for the purposes at hand, and locate specific sections of the prior art reference document containing prior art disclosure (e.g. searchable text and/or searchable graphics and/or images) that appears to be similar to the language linked to each scope concept embodied in the scope concept based prior art reference analysis GUI, as illustrated in FIG. 50D. Such automated computer-assisted search methods can be supported on the multi-mode patent analysis and charting system of the present invention, and automatically applied once the Claim Scope Concept Based Prior Art Reference Analysis GUI 26C is generated by the system, and return possible search results for each scope concept query field in the Claim Scope Concept Based Prior Art Reference Analysis GUI. Then when the technical subject matter expert begins to scope concept analyze each prior art reference for prior art disclosure (e.g. searchable text and/or searchable graphics and/or images) that substantiates any of the particular scope concepts listed in the Claim Scope Concept Based Prior Art Reference Analysis GUI, some potential cites are provided for review and confirmation, making the job of the technical subject matter expert a little easier, and more productive and efficient. At some point in time, when automated linguistic search methods have sufficiently advanced, then it may be possible for the technical subject matter expert to provide more of a review and confirmation role, rather than a deep document analysis role.

After each Prior Art Reference is analyzed using the Scope Concept Based Prior Art Reference Analysis GUI during scope concept based prior art analysis in Step O, then a Prior Art Reference Scope Concept Profile is automatically generated for the prior art reference that has been scope concept analyzed, as illustrated in FIG. 26C. As shown in FIG. 26C, the Prior Art Reference Claim Scope Concept Profile for each Prior Art Reference comprises: (i) a Master Claim Scope Concept List indicating which scope concepts (assigned to the set of Claims) have and have not been substantiated by disclosure from the prior art reference; and (ii) a Claim Scope Concept Profile, for each patent claim, indicating which claim scope concepts in each patent claim have and have not been substantiated by disclosure from the Prior Art Reference, with a citation from the prior art reference as to where the substantiating disclosure (e.g. text and/or images/graphics) can be found in the prior art reference.

As indicated in Step P in FIG. 20G, a GUI screen as shown in FIG. 22AA is employed so that the user can initiate the system to generate a patent claim prosecution history chart for all of the allowed claims in the granted patent. Specifically, at Substep P1, while logged into the patent analysis and charting system, the user uses the GUIs and methods of the system to generate a Patent Claim Prosecution History based Chart for all of the allowed claims in the granted patent, wherein the patent prosecution history based claim scope concept (CSS) chart structure is implemented using Microsoft® Excel® spreadsheet display technology (with collapsible/expandable columns and rows) and populated with data stored in the system database during prior stages of patent prosecution history analysis. In the illustrative embodiment, the patent prosecution history based claim scope concept (CSS) chart structure further includes:

(i) allowed patent claims listed in a column, and each being indexed with both original and issued claim numbering, and each parsed claim limitation having associated with its allowed claim language, at least the following information items (abstracted from the patent file history):

(ii) technical support for each claim limitation disclosed in the patent specification listed in a separate column (can be programmatically generated by the system);

(iii) concise statement of each prior art rejection (e.g. Section 101, 102, and/or 112) or rejection combinations (e.g. Section 103) made by Examiner and overcome by Applicant(s) listed in a separate column (i.e. identification of prior art references, the legal basis for rejection of specific patent claims, and reasons why claims are not patentable under the patent laws);

(iv) prior art disclosure (e.g. searchable text and/or searchable graphics and/or images) in cited and applied prior art references mapped/linked to each claim element, and listed in a separate column, using the scope concept linking/mapping process of the present invention carried out by the system;

(v) prior art disclosure (e.g. searchable text and/or searchable graphics and/or images) in cited and non-applied prior art references mapped/linked to each claim element, and listed in a separate column, using the scope concept linking/mapping process of the present invention carried out by the system;

(vi) statements made by the Examiner during the patent prosecution history, transparently linked to claim limitations in the allowed claims, and listed in a separate column, using the scope concept linking/mapping process of the present invention carried out by the system;

(vii) statements made by the Applicants/Owner during the patent prosecution history, transparently linked to claim limitations in the allowed claims, and listed in a separate column, using the scope concept linking/mapping process of the present invention carried out by the system; and

(viii) “reasons for allowance” statements made by the Examiner and possibly commented upon by Applicant during the patent prosecution history, transparently linked to claim limitations in the allowed claims, and listed in a separate column, using the scope concept linking/mapping process of the present invention carried out by the system.

During the patent claim understanding/interpretation process, the claim scope schema (CSS) structure, comprising all information from the patent prosecution history linked together by claim scope concepts (CSC) and contained within the spreadsheet-type chart structure, functions as a framework that helps organize information relating to the scope and meaning of any allowed patent claim represented in the chart structure, to assist anyone interested in better understanding the scope and boundaries offered by allowed patent claims.

As indicated in FIG. 22B, at Step P2, while logged into the patent analysis and charting system, the system then displays the XML-based patent prosecution history based claim scope concept (CSS) chart structure so that the user can view the pertinent/relevant disclosure of the cited prior art references, along side of (i) the language of corresponding claim limitations, (ii) motivation to combine citations, (iii) reasons for allowance, and (iv) file wrapper estoppel, so as to support patent claim scope and prior art boundary interpretation and help others gain a better understanding the boundaries of patent protection allowed by the patent claims in the granted patent. Notably, the XML-based patent prosecution history based claim scope concept (CSS) chart structure shown in FIGS. 27A through 27F can be displayed from a Web-based client system, in which case, the user can make notes or changes to certain fields that allow edits. It would be preferred that most of the fields in the patent prosecution history based claim scope concept (CSS) chart structure would be read only, thereby requiring authorized users to re-enter the system and make edits through GUIs of the system, in proper authentication and the like.

As shown in FIGS. 27A through 27F, the patent prosecution history claim scope schema (CSS) chart structure generated during the patent claim scope interpretation analysis mode, for any patent grant, comprises data fields for presenting graphical representations of the following graphical objects:

(i) the text language comprising the allowed patent claim limitations and sub-limitations (Step G) with original and issued claim numbering;

(ii) technical support for the claimed subject matter provided in patent specification under 35 USC Section 112 (Step G);

(iii) subject matter of patent claims allowed and never rejected during patent prosecution history (Steps H);

(iv) subject matter rejections (i.e. identification of prior art references, the legal basis for rejection of specific patent claims, and reasons why claims are not patentable under the patent laws) overcome by the allowed patent claims during patent prosecution history, as reflected in the patent prosecution history, including rejections overcome by argument without amendment, and rejections overcome by argument with amendment;

subject matter (i.e. disclosure) of prior art references cited by the examiner and applied to specific claim limitations in a 35 USC section 102/103 rejection which was overcome by the allowed claims with argument but without amendment (Step G);

subject matter (i.e. disclosure) of prior art references cited by the examiner and applied to specific claim limitations in a 35 USC Section 102/103 rejection which was overcome by the allowed claims with amendment and argument (Step G);

(v) examiner statements related and directly linked (i.e. mapped) to the language of claim sub-limitations by the user (Step I);

(vi) applicant statements related and directly linked to the language of claim sub-limitations by the user (Step H);

(vii) reasons for allowance related and directly linked to the language of claim sub-limitations by the user (Step H and I);

(viii) scope concepts embraced by the patent claims and assigned to the language of the claim sub-limitations by the user;

(ix) subject matter (i.e. disclosure) of a prior art reference cited by examiner, applied against claims during rejections, and linked (i.e. mapped) to the language of claim sub-limitations during scope concept based reference analysis performed by the user (Step N);

(x) subject matter (i.e. disclosure) of a prior art reference cited by examiner but not applied against claims during rejections, and linked (i.e. mapped) to the language of claim sub-limitations during scope concept based reference analysis performed by the user (Step O);

(xi) examiner statements related and linked (i.e. mapped) to the language of claim sub-limitations by the user using scope concepts (Step L);

(xii) applicant statements related and linked to the language of claim sub-limitations by the user using scope concepts (Step M);

(xiii) reasons for allowance related and linked to the language of claim sub-limitations by the user using scope concepts (Steps M and N); and

(xiv) notes on the user's understanding of patent claim construction, scope/boundary conditions, and the like (Step Q).

The above information is captured during Steps G, H, K and others of the structured patent analysis process of the present invention.

During the patent claim understanding/interpretation process, the claim scope schema (CSS) structure, comprising all information from the patent prosecution history linked together by claim scope concepts (CSC) and contained within the spreadsheet-type chart structure, functions as a framework that helps organize information relating to the scope and meaning of any allowed patent claim represented in the chart structure, to assist anyone interested in better understanding the scope and boundaries offered by allowed patent claims.

As indicated in step Q in FIG. 20H, a GUI screen as shown in FIG. 22CC is employed so that the user can that record notes on his or her understanding of patent claim construction, scope/boundary conditions, and storing such notes in the system database. Specifically, while displaying the patent prosecution history based claim scope concept (CSS) chart structure, the user(s) are allowed to record notes in the chart on the user's understanding of patent claim construction, scope/boundary conditions, and the like, and then store such notes in the system database. This note field in the chart will be a read/write field, whereas most all other fields will be read only, for the reasons explained above. If the XML-based chart structure is displayed from a web-based client system while logged into the system servers, any notes added to the Notes field will be automatically (i.e. programmatically) updated and stored in the system database, or like persistent data-storage device. If the XML-based chart structure is generated an XML-based file and then moved to another client machine, while logged off from the system servers, the users can make notes in the Notes field, and subsequently, the XML-based chart structure can be uploaded to the system by any client logged into the system, and requesting that the data be imported into the system database, as indicated in the lower half of the exemplary GUI screen shown in FIG. 22CC.

FIG. 21 illustrates the application of the multi-mode patent analysis and charting system configured in its patent claim scope interpretation (i.e. construction) analysis mode of system operation, and deployed during particular phases of the patent life-cycle time line, by both the patent owner and its competitors. In particular, the patent owner can use the patent claim scope analysis mode of operation in offensive applications against competitors, namely, by (i) better understanding the scope and boundaries of the allowed patent claims, against a landscape of scope concept mapped prior art references displayed in the chart structure, (ii) identifying potential future cases of claim infringement (requiring deeper patent claim infringement analysis), and (iii) cited prior art references scope concept mapped against the allowed patent claims in the patent prosecution history based chart structure so as determine when new non-cited prior art references, applied by defendant/competitors in patent claim invalidity contentions (e.g. during patent claim disputes or litigation proceedings) is merely duplicative prior art that has already been considered by the patent by examiner during patent prosecution. Also, competitors can use the patent claim scope interpretation analysis mode of operation in defensive applications against the patent owner, by better understanding the scope and boundaries of patent protection afforded by the claims, and identifying potential patent claim invalidity contentions and defenses of potential claim infringement. The ability of the system to be used by both patent owners and competitors provides an opportunity for better resolution of patent claim scope and boundaries, and a true and proper determination of patent protection afforded by the patent claims.

### Specification of the Multi-Mode Patent Analysis and Charting System of the Present Invention Configured in its Markman Patent Claim Term Analysis Mode of System Operation (Mode 2)

FIG. 28 illustrates the information mapping process supported by the system during its Markman patent claim term analysis mode of system operation, wherein patent claim data and court-specified claim term meaning definitions for common claim terms are mapped to particular fields within the claim chart structures generated during this particular mode of system operation.

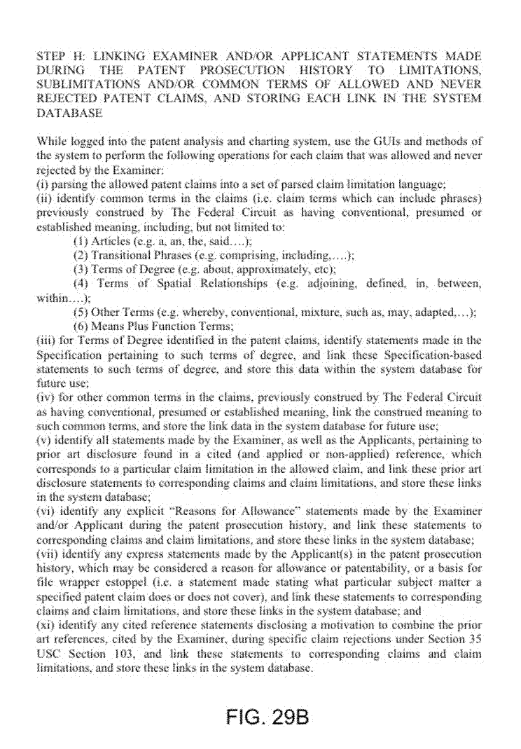

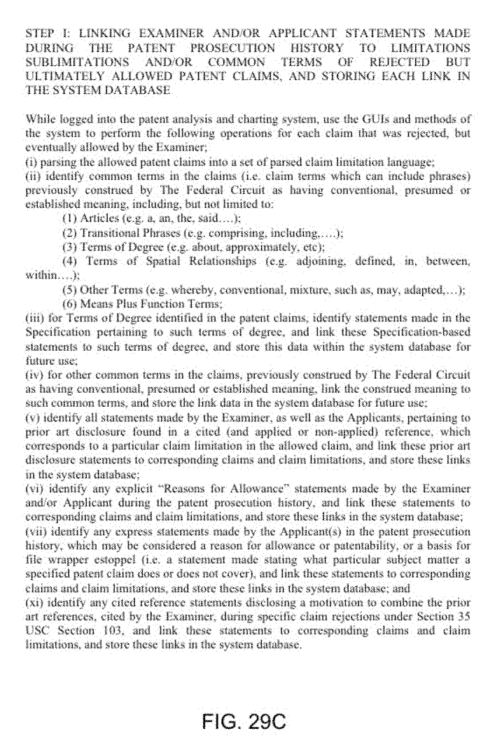

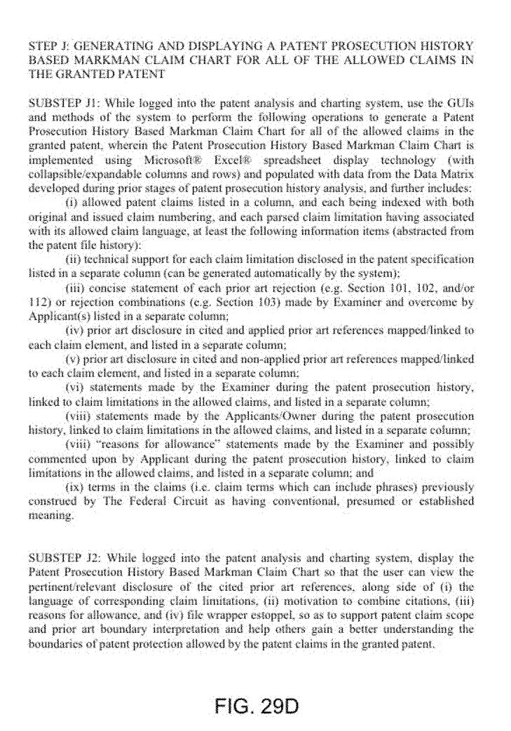

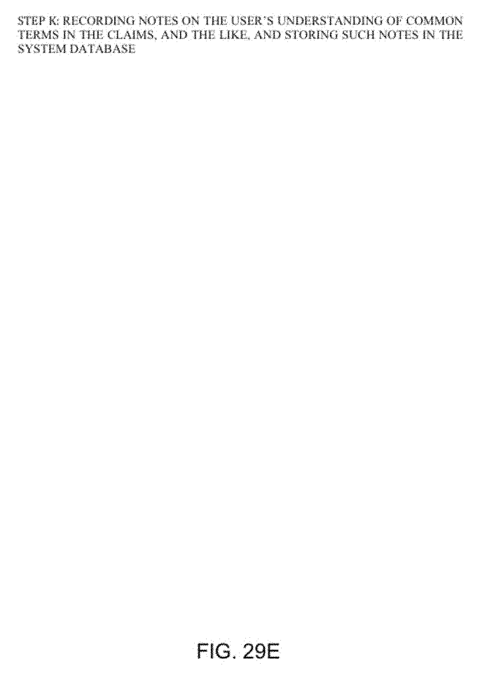

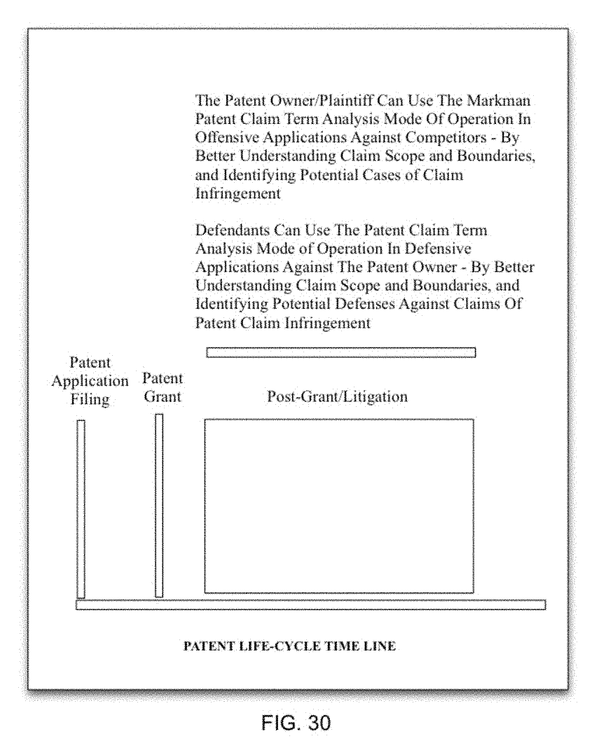

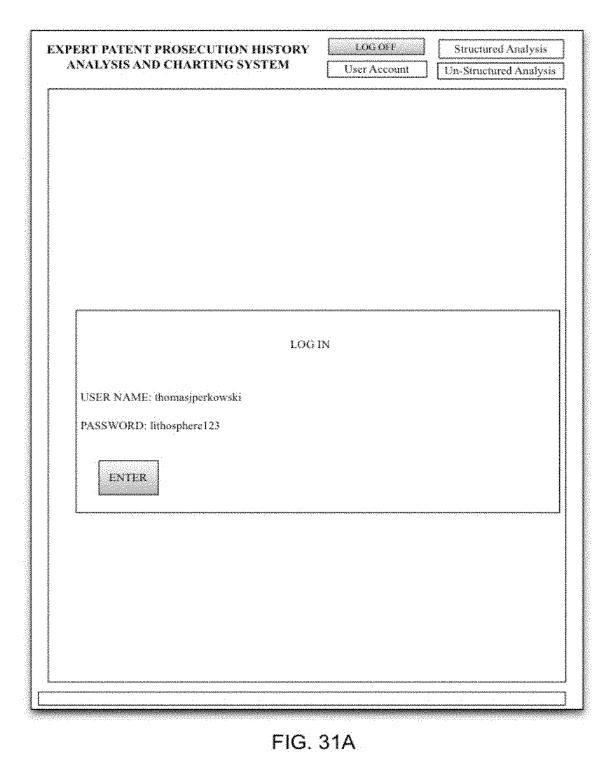

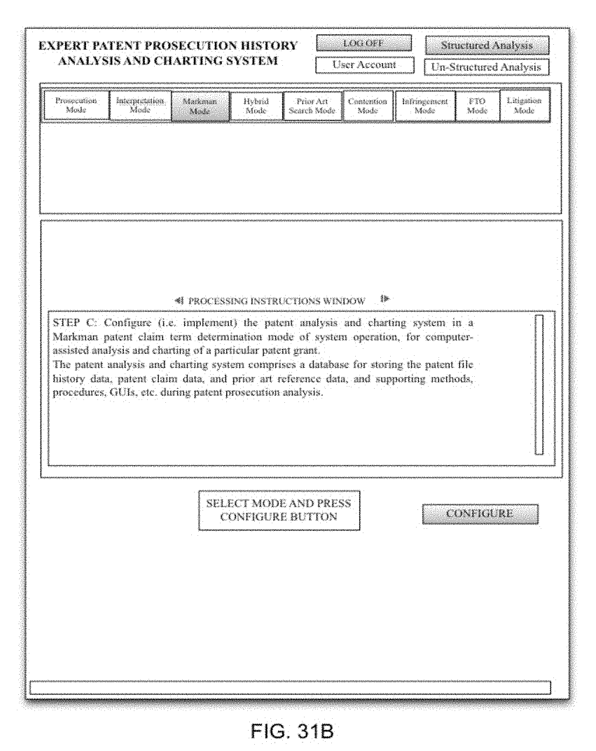

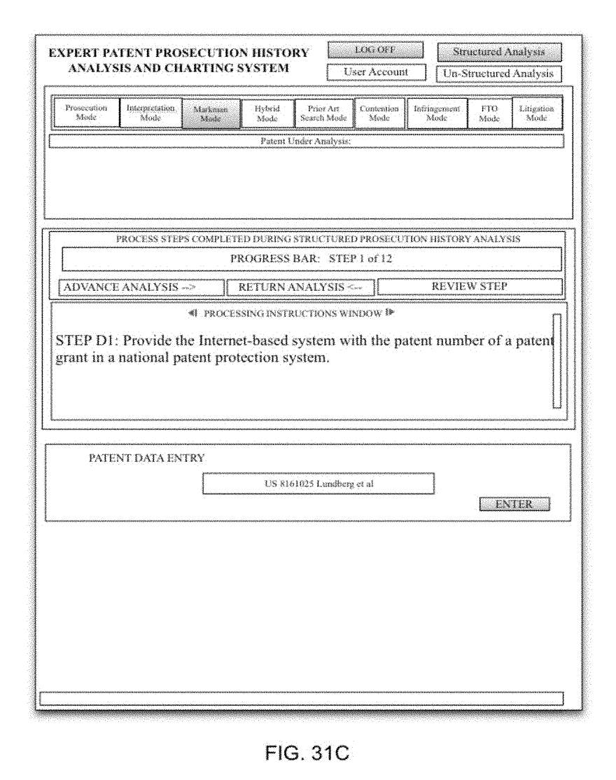

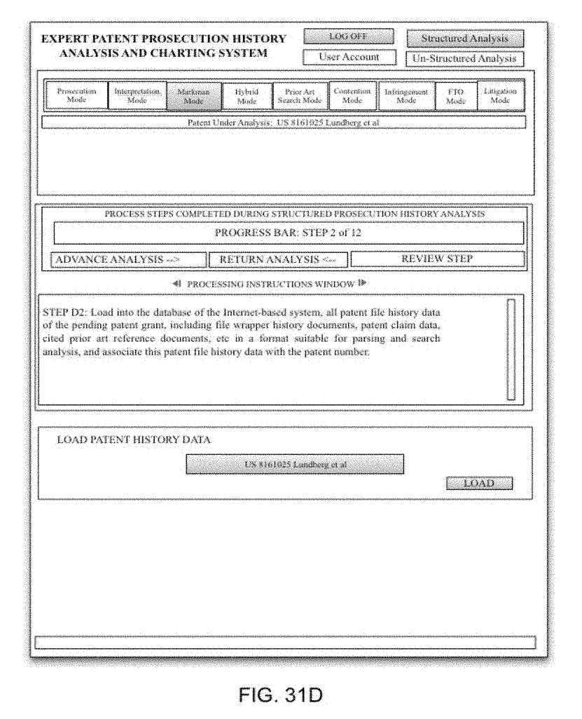

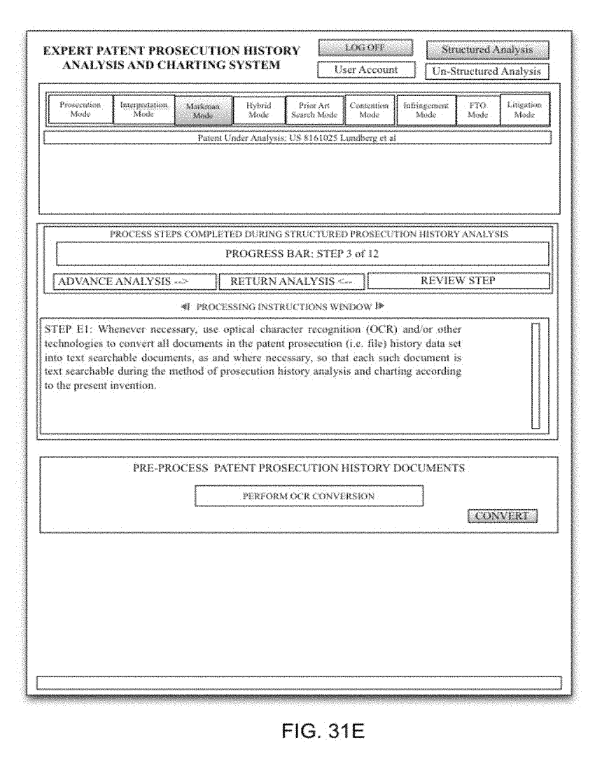

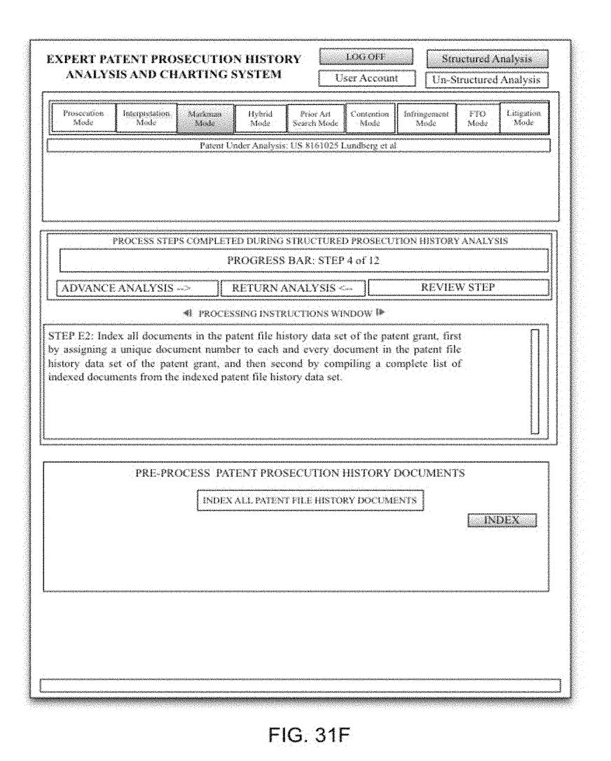

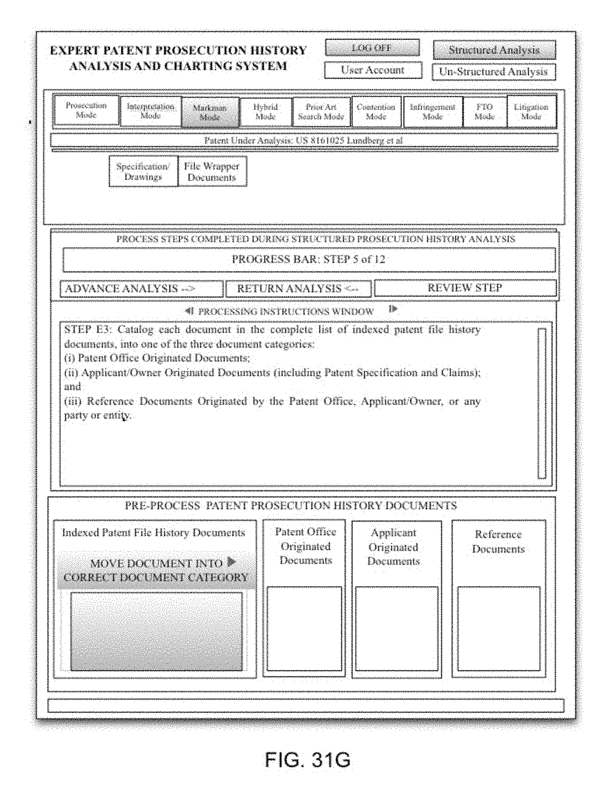

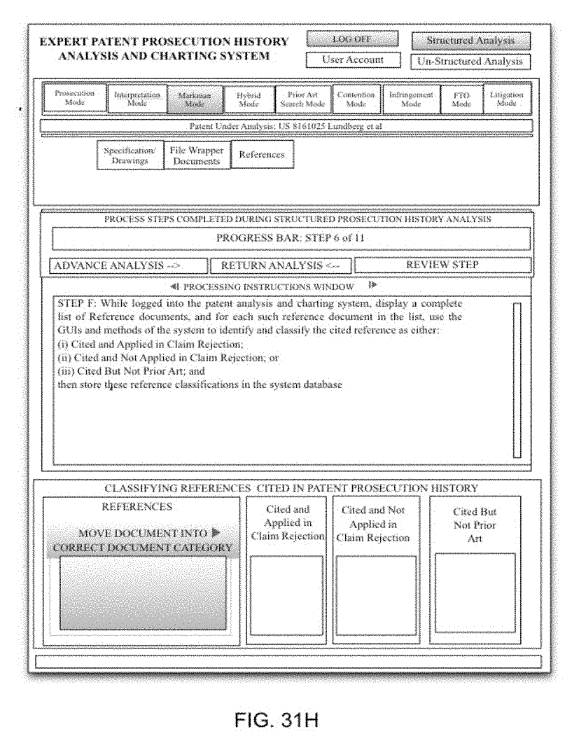

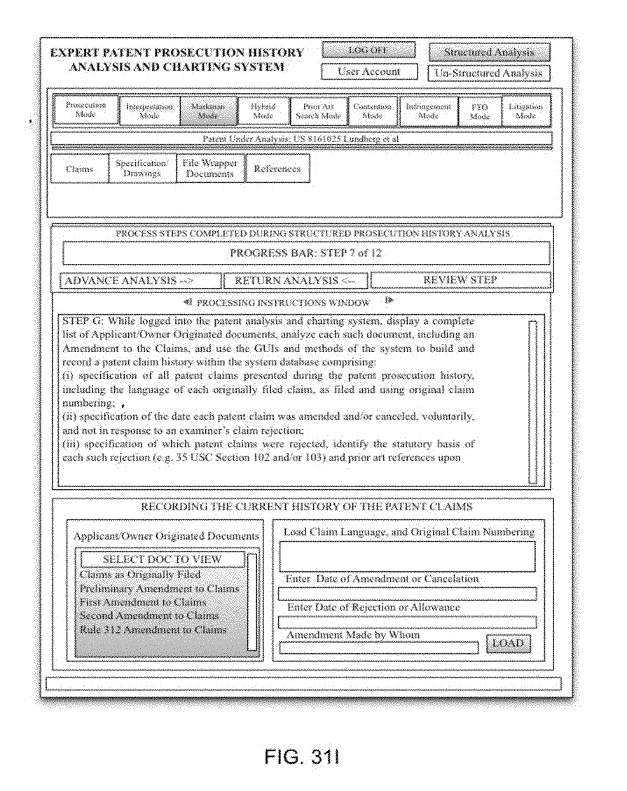

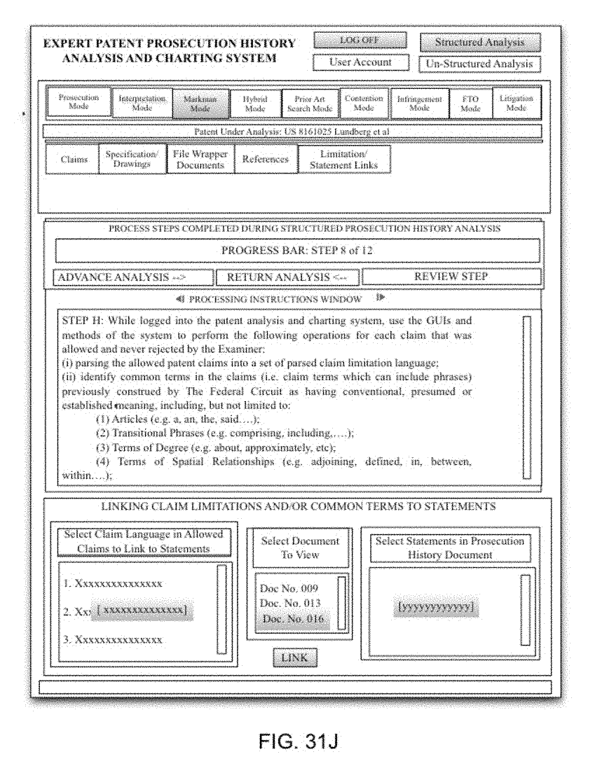

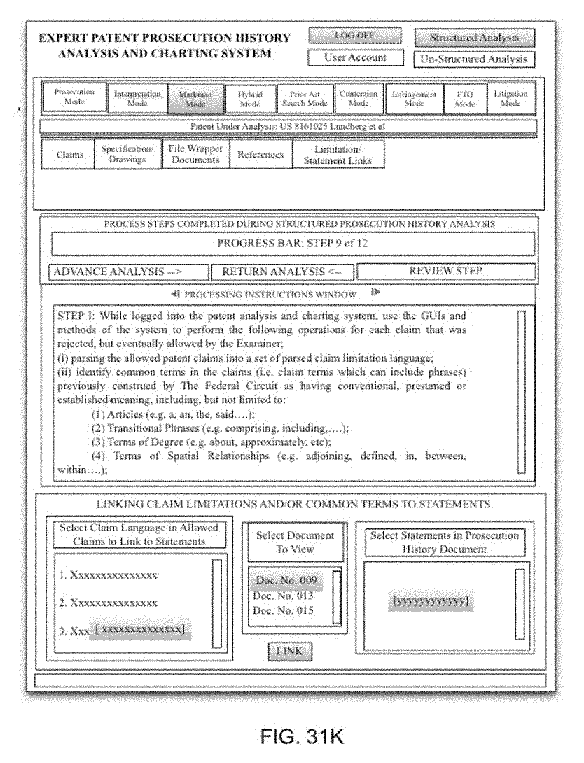

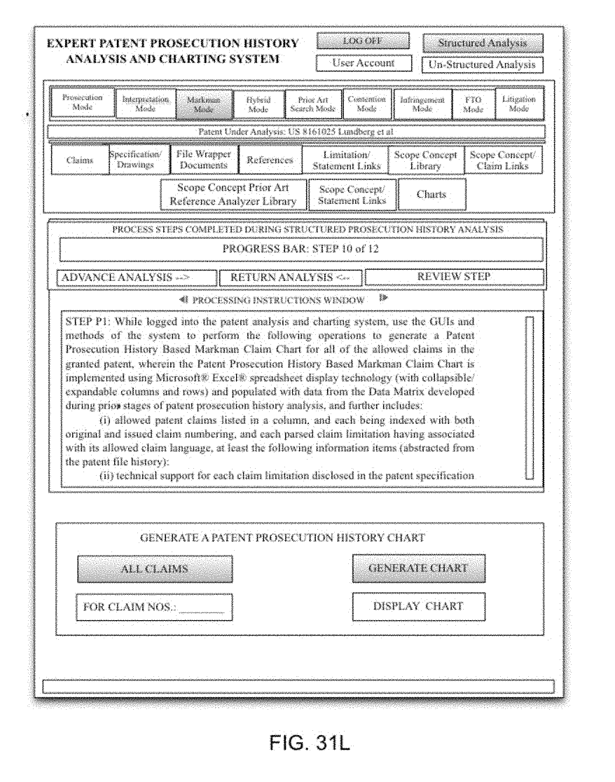

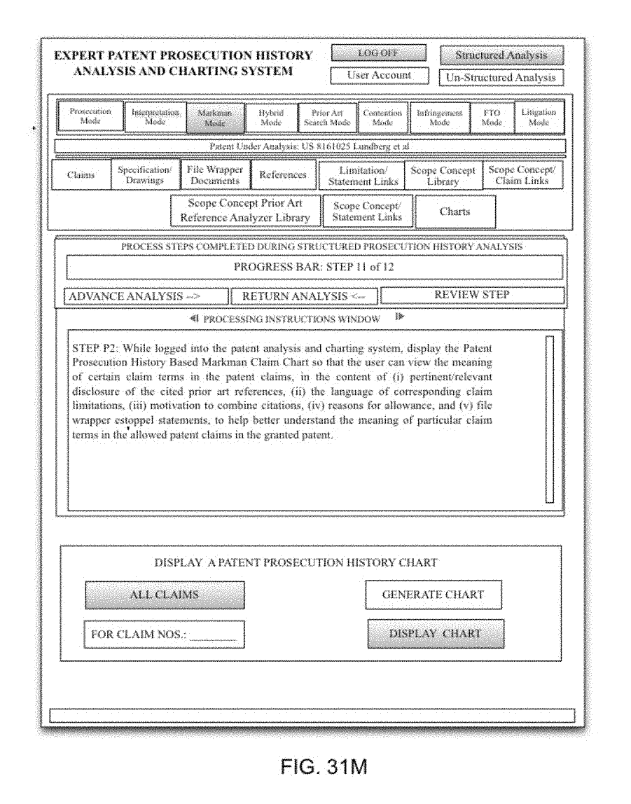

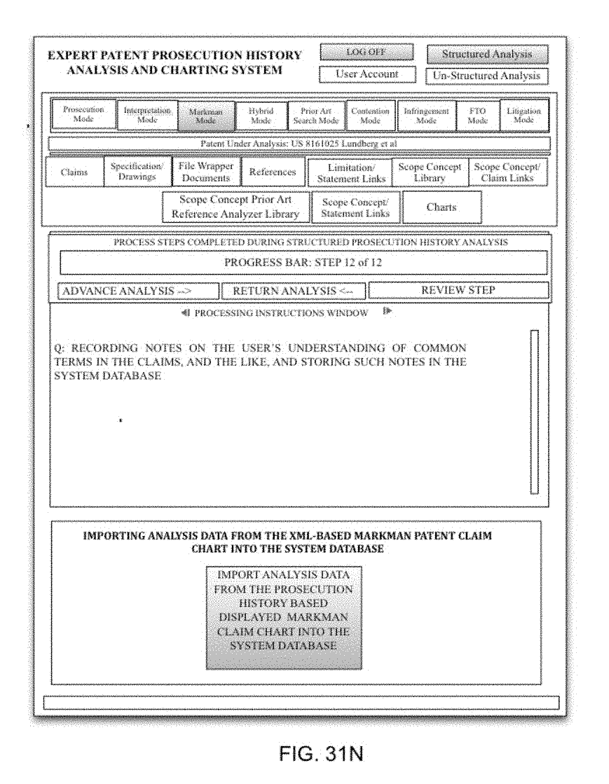

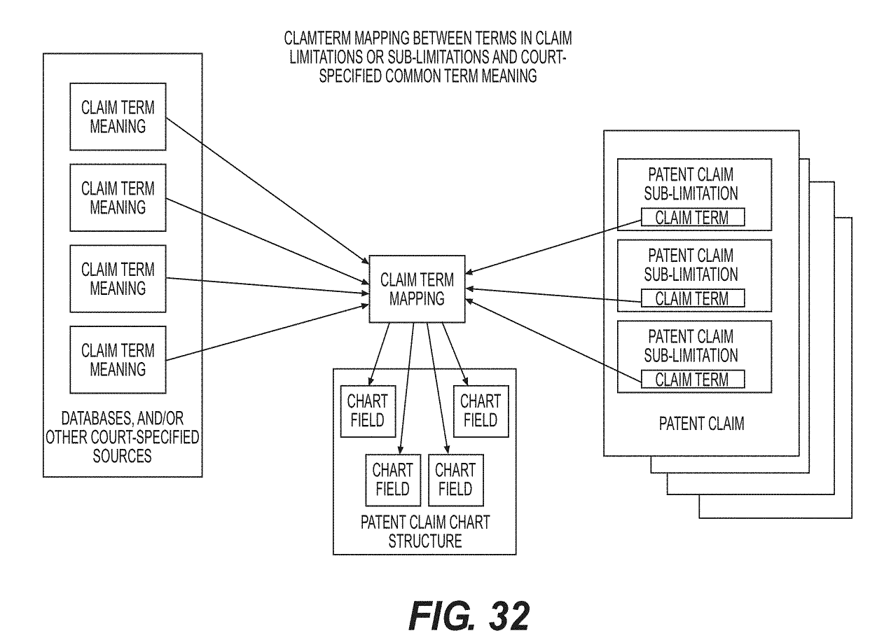

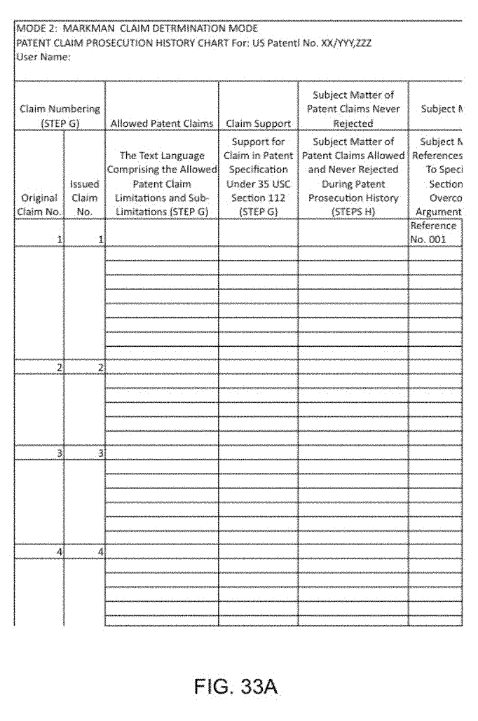

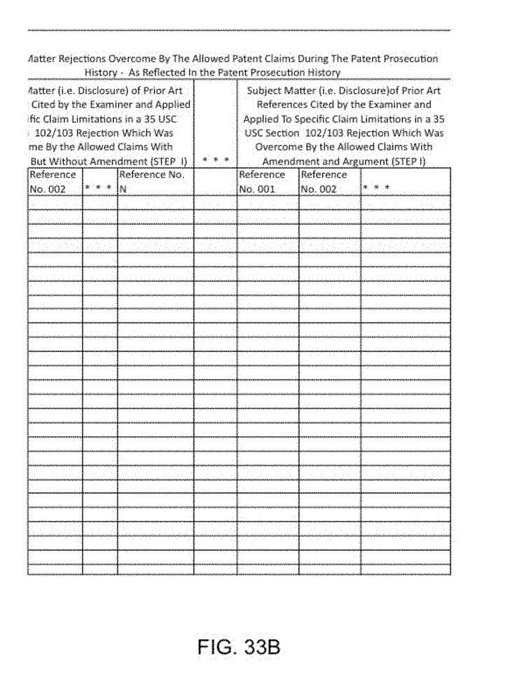

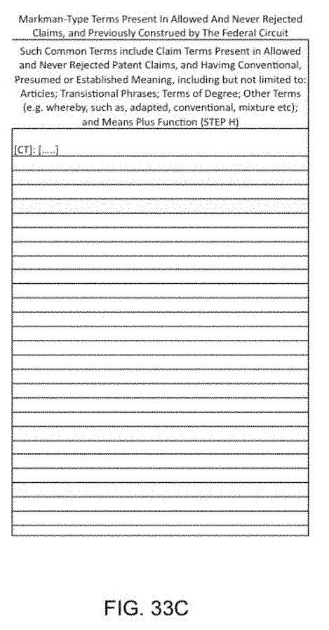

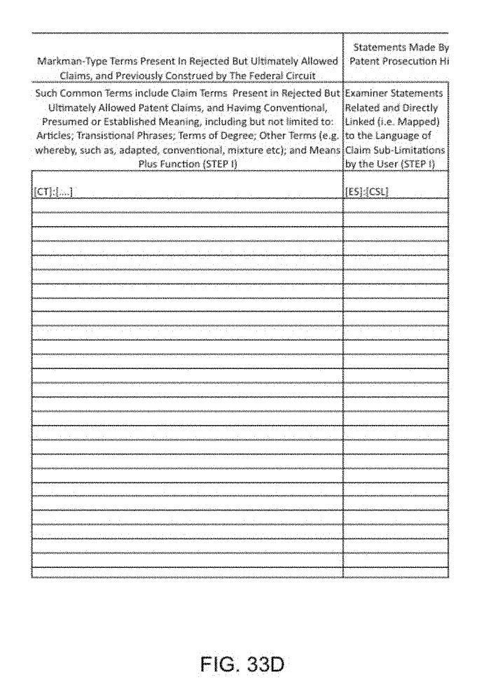

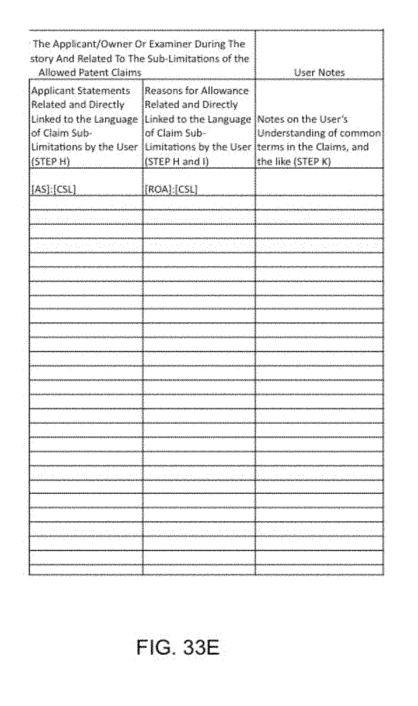

The workflow process specified in FIGS. 29AA through 29E will be described now in greater detail with reference to corresponding wireframe GUIs shown in FIGS. 31A through 31M, and the information mapping processes illustrated in FIGS. 30 and 32. Upon completion of the workflow process, the multi-mode system in its Markman patent claim term analysis mode will automatically generate and display an XML-based spreadsheet-based chart structure as illustrated in FIG. 33A through 33E, that can be used by various users in any given user work group, including patent attorneys, during patent claim scope/boundary interpretation and other analytical efforts.

For presentation purposes only, the XML-based spreadsheet-based chart structure shown in FIGS. 33A through 33E has been broken down into several sections in the figure Drawings. For proper viewing, these figure drawings should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

Method of Analyzing and Charting the Patent Prosecution History of a Granted Patent, Using a Patent Analysis and Charting System Configured in a Markman Claim Term Analysis Mode of Operation, so as to Help Better Understand Certain Terms in the Patent Claims of the Granted Patent

Referring now to the detailed flow chart set forth in FIGS. 28A through 28E, the Internet-based patent analysis and charting system of the present invention configured in its Markman claim analysis mode of system operation will be now described in detail, and showing how one or more users can efficiently analyze and chart the patent prosecution history of any granted patent, using the wireframe GUI screens set forth in FIGS. 31A through 31N, the mapping techniques illustrated in FIGS. 28 and 30, and the XML-based patent prosecution history based chart structures described in FIGS. 33A through 33E. Various applications for the patent analysis and charting system configured in this mode of operation are illustrated in FIG. 32 and will be described in greater detail hereinbelow.

Upon completion of the workflow process, the multi-mode system in its the Markman patent claim term analysis mode will automatically generate and display the XML-based spreadsheet-based chart structure as illustrated in FIG. 33A through 33E, that can be used by various users in any given user work group, including patent attorneys, during patent claim scope/boundary interpretation and other analytical efforts. For presentation purposes only, the XML-based spreadsheet-based chart structure shown in FIGS. 33A through 33E has been broken down into several sections in the figure Drawings, and should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

As shown in FIG. 28, during the Markman patent claim term analysis mode of system operation, the system supports the direct linking of court-specified meaning to common terms in the patent claims and/or claim limitations, which are in dispute between the parties involved in a patent litigation.

The steps of the process described in FIGS. 29A through 22E will be described in detail below.

As indicated in Step A in FIG. 29A, Web, application and database servers on a network are used to deploy an Internet-based object-oriented system platform that supports a computer-assisted analysis and charting of the prosecution history of any patent granted in a national patent protection system. As shown in FIG. 5, the network is connected to the network information infrastructure and servers of national patent protection systems, and patent and published patent application depositories containing composite patent file history data documents for granted patents and pending (or abandoned) patent applications.

As indicated in Step B in FIG. 29A, web-enabled client machines are used to allow authorized users to log into the deployed patent analysis and charting system and perform the following operations specified below. As exemplary login GUI screen is shown in FIG. 31A for that purpose. In FIG. 31B, a GUI screen is shown for managing User Account information on the platform.

As indicated in Step C in FIG. 29A, the user employs a GUI as shown in FIG. 31B to configure the patent analysis and charting system in its Markman patent claim term analysis mode of system operation, for computer-assisted analysis and charting of a particular patent application, prior to patent grant. In general, the patent analysis and charting system comprises a database for storing the patent file history data, patent claim data, and prior art reference data, and supporting methods, procedures, GUIs, etc. during patent prosecution analysis. The purpose of this step in the process is to select the mode of system operation to be configured on the system platform of the present invention.

As indicated in Step D in FIG. 29A, the user employs a GUI screen as shown in FIG. 31C to provide the Internet-based system with the patent grant number of the patent granted in a national patent protection system. Then, using a GUI screen as shown in FIG. 31D, all patent file history data of the granted patent, including file wrapper history documents, patent claim data, cited prior art reference documents, etc., are uploaded from patent servers shown in FIG. 5, into the database 15 of the Internet-based system, in a format suitable for parsing and search analysis, and associate this patent file history data with the patent application serial number.

As indicated in Step E in FIG. 29A, a GUI screen as shown in FIG. 31E is employed so that, whenever necessary, the system uses optical character recognition (OCR) and/or other technologies to convert all documents in the patent prosecution (i.e. file) history data set into text searchable documents, as and where necessary, so that each such document is text searchable during the method of prosecution history analysis and charting according to the present invention.

As indicated in Step E in FIG. 29A, a GUI screen as shown in FIG. 31F is employed so that all documents in the patent file history data set of the granted patent are indexed by first assigning a unique document number to each and every document in the patent file history data set of the patent application, and then second by compiling a complete list of indexed documents from the indexed patent file history data set.

As indicated in Step E3 in FIG. 29A, a GUI screen as shown in FIG. 31G is employed so that each document in the complete list of indexed patent file history documents, is cataloged into one of the three document categories: (i) Patent Office Originated Documents; (ii) Applicant/Owner Originated Documents (including Patent Specification and Claims); and (iii) Reference Documents Originated by the Patent Office, Applicant/Owner, or any party or entity.

As indicated in Step F in FIG. 29A, a GUI screen as shown in FIG. 31H is employed so that, while logged into the patent analysis and charting system, the system displays a complete list of Reference documents, and for each such reference document in the list, the user uses the GUIs and methods of the system to identify and classify the cited reference as either: (i) cited and applied in claim rejection; (ii) cited and not applied in claim rejection; or (iii) cited but not prior art; and then store these reference classifications in the system database

As indicated in Step G in FIG. 29A, a GUI screen as shown in FIG. 31I is employed so that the system enables the recording of the current history of the patent claims in the system database, including a concise status of patent claims, patent claim amendments, and patent claim examination during the patent prosecution history of the patent application. In the illustrative embodiment, this is achieved as follows. As shown, while logged into the patent analysis and charting system, the system displays a complete list of Applicant/Owner Originated documents, and then each such document, including an Amendment to the Claims is analyzed by the user using the GUIs and methods of the system so as to build and record a patent claim history (PCH) within the system database 15.

In the illustrative embodiment, the patent claim history (PCH) comprises:

(i) specification of all patent claims presented during the patent prosecution history, including the language of each originally filed claim, as filed and using original claim numbering;

(ii) specification of the date each patent claim was amended and/or canceled, voluntarily, and not in response to an examiner's claim rejection;

(iii) specification of which patent claims were allowed without rejection, and specify the date of allowance and the Examiner who made the allowance;

(iv) specification of which claims were rejected, identify the statutory basis of each such rejection (e.g. 35 USC Section 102 and/or 103) and prior art references upon which the claim rejection was made, and specify the date of the claim rejection and the Patent Examiner who made the rejection;

(v) specification of the language of each claim amendment, identify when the amendment was made and by whom (i.e. using USPTO Attorney/Agent Registration Number for registered agents and attorneys, and Applicant's name for pro se applications);

(vi) specification of which claims where allowed after rejection in response to an argument for patentability and request for reconsideration, and a specification of the language of each such allowed claim; and

(vii) specification of which claims where allowed after rejection in response to an argument for patentability, an amendment to the claims, and a request for reconsideration, and a specification of the language of each such allowed claim.

As indicated in Step H in FIG. 29B, a GUI screen as shown in FIG. 31J is employed, so that the system allows the user to link examiner and/or applicant statements made during the patent prosecution history to limitations, sub-limitations and/or common terms of allowed and never rejected patent claims, and then store each link in the system database. This step can be carried out as follows. While logged into the patent analysis and charting system, use the GUIs and methods of the system to perform the following operations for each claim that was allowed and never rejected by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure (e.g. searchable text and/or searchable graphics and/or images) found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(xi) identify any cited reference statements disclosing a motivation to combine the prior art references, cited by the Examiner, during specific claim rejections under Section 35 USC Section 103, and link these statements to corresponding claims and claim limitations, and store these links in the system database.

As indicated in Step I in FIG. 29B, a GUI screen as shown in FIG. 31K is employed, so that the system allows the user to link examiner and/or applicant statements made during the patent prosecution history to limitations sub-limitations and/or common terms of rejected but ultimately allowed patent claims, and then store each link in the system database. This step can be achieved as follows. While logged into the patent analysis and charting system, use the GUIs and methods of the system to perform the following operations for each claim that was rejected, but eventually allowed by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure (e.g. searchable text and/or searchable graphics and/or images) found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(xi) identify any cited reference statements disclosing a motivation to combine the prior art references, cited by the Examiner, during specific claim rejections under Section 35 USC Section 103, and link these statements to corresponding claims and claim limitations, and store these links in the system database.

As indicated in Step H in FIG. 29B, a GUI screen as shown in FIG. 31K is employed, so that the system allows the user to generate and display a patent prosecution history based Markman claim chart for all of the allowed claims in the granted patent. Specifically, while logged into the patent analysis and charting system, use the GUIs and methods of the system to perform the following operations to generate a claim scope schema (CSS) based Markman claim chart for all of the allowed claims in the granted patent, wherein the CSS-based Markman claim chart is implemented using Microsoft® Excel® spreadsheet display technology (with collapsible/expandable columns and rows) and populated with data from the patent claim history (PCH) developed during prior stages of patent prosecution history analysis.

In the illustrative embodiment, the patent claim history (PCH) comprises:

(i) allowed patent claims listed in a column, and each being indexed with both original and issued claim numbering, and each parsed claim limitation having associated with its allowed claim language, at least the following information items (abstracted from the patent file history):

(ii) technical support for each claim limitation disclosed in the patent specification listed in a separate column (can be generated automatically by the system);

(iii) concise statement of each prior art rejection (e.g. Section 101, 102, and/or 112) or rejection combinations (e.g. Section 103) made by Examiner and overcome by Applicant(s) listed in a separate column;

(iv) prior art disclosure (e.g. searchable text and/or searchable graphics and/or images) in cited and applied prior art references mapped/linked to each claim element, and listed in a separate column;

(v) prior art disclosure in cited and non-applied prior art references mapped/linked to each claim element, and listed in a separate column;

(vi) statements made by the Examiner during the patent prosecution history, linked to claim limitations in the allowed claims, and listed in a separate column;

(vii) statements made by the Applicants/Owner during the patent prosecution history, linked to claim limitations in the allowed claims, and listed in a separate column;

(viii) “reasons for allowance” statements made by the Examiner and possibly commented upon by Applicant during the patent prosecution history, linked to claim limitations in the allowed claims, and listed in a separate column; and

(ix) terms in the claims (i.e. claim terms which can include phrases) previously construed by The Federal Circuit as having conventional, presumed or established meaning.

Then, while logged into the patent analysis and charting system, display the CSS-based Markman claim chart so that the user can view the pertinent/relevant disclosure of the cited prior art references, along side of (i) the language of corresponding claim limitations, (ii) motivation to combine citations, (iii) reasons for allowance, and (iv) file wrapper estoppel, so as to support patent claim scope and prior art boundary interpretation and help others gain a better understanding the boundaries of patent protection allowed by the patent claims in the granted patent.

As shown in FIGS. 33A through 33F, the patent prosecution history based claim scope schema (CSS) chart structure generated during the Markman patent claim term analysis mode, for any patent grant, comprises data fields for presenting graphical representations of the following graphical objects:

(i) the text language comprising the allowed patent claim limitations and sub-limitations (Step G) with original and issued claim numbering;

(ii) technical support for the claimed subject matter provided in patent specification under 35 USC Section 112 (Step G);

(iii) subject matter of patent claims allowed and never rejected during patent prosecution history (Steps H);

(iv) subject matter rejections overcome by the allowed patent claims during patent prosecution history, as reflected in the patent prosecution history, including rejections overcome by argument without amendment, and rejections overcome by argument with amendment;

subject matter (i.e. disclosure) of prior art references cited by the examiner and applied to specific claim limitations in a 35 USC Section 102/103 rejection which was overcome by the allowed claims with argument but without amendment (Step I);

subject matter (i.e. disclosure) of prior art references cited by the examiner and applied to specific claim limitations in a 35 USC Section 102/103 rejection which was overcome by the allowed claims with amendment and argument (Step I);

(v) Markman-type terms present in allowed and never rejected claims, and previously construed by the federal circuit—such common terms including claim terms present in allowed and never rejected patent claims, and having conventional, presumed or established meaning, including but not limited to: articles; transitional phrases; terms of degree; other terms (e.g. whereby, such as, adapted, conventional, mixture etc); and means plus function (Step H);

(vi) Markman-type terms present in rejected but ultimately allowed claims, and previously construed by the federal circuit—such common terms including claim terms present in rejected but ultimately allowed patent claims, and having conventional, presumed or established meaning, including but not limited to: articles; transitional phrases; terms of degree; other terms (e.g. whereby, such as, adapted, conventional, mixture etc); and means plus function (Step I);

(vii) examiner statements made during the patent prosecution history and related and directly linked (i.e. mapped) to the language of sub-limitations of the allowed patent claims by the user (Step I);

(viii) applicant statements made during the patent prosecution history and related and directly linked to the language of claim sub-limitations of the allowed patent claims by the user (Step H);

(ix) reasons for allowance made during the patent prosecution history and related and directly linked to the language of claim sub-limitations of the allowed patent claims by the user (Step H and I);

(x) notes on the user's understanding of common terms in the claims, and the like (Step K).

During the patent claim understanding/interpretation process, the claim scope schema (CSS) structure, comprising all information from the patent prosecution history linked together by claim scope concepts (CSC) and contained within the spreadsheet-type chart structure, functions as a framework that helps organize information relating to the scope and meaning of any allowed patent claim represented in the chart structure, to assist anyone interested in better understanding the scope and boundaries offered by allowed patent claims.

As indicated in Step K in FIG. 29B, a GUI screen as shown in FIG. 31K is employed, so that the system allows the user to record notes on the user's understanding of common terms in the claims, and the like, and storing such notes in the system database. While displaying the CSS-based Markman claim chart, allow the user to record notes in the chart on the user's understanding of common terms in the claims, and the like, and store such notes in the system database.

FIG. 30 illustrates the application of the multi-mode patent analysis and charting system configured in its Markman patent claim (term) analysis mode of system operation, and deployed during particular phases of the patent life-cycle time line, by both the patent owner and its competitors. In particular, the patent owner can use the Markman patent claim (term) analysis mode of operation in offensive applications against competitors, namely, by (i) better understanding the scope and boundaries of the allowed patent claims, (ii) identifying potential future cases of claim infringement (requiring deeper patent claim infringement analysis). Also, defendants can use the Markman patent claim term analysis mode of operation in defensive applications against the patent owner, by better understanding the scope and boundaries of patent protection afforded by the claims, and identifying potential defenses of potential claims of patent claim infringement.

### Specification of the Multi-Mode Patent Analysis and Charting System of the Present Invention Configured in its Hybrid-Type Patent Claim Scope Interpretation/Markman Claim Term Analysis Mode of System Operation (Mode 3)

FIG. 34 illustrates the information mapping process supported by the system during its Hybrid-Type Patent Claim Scope Interpretation/Markman Claim Term Analysis Mode of system operation (i.e. hybrid analysis mode), wherein patent claim data, prosecution history data and court-specified claim term meaning definitions for common claim terms are mapped to particular fields within the claim chart structures generated during this particular mode of system operation.

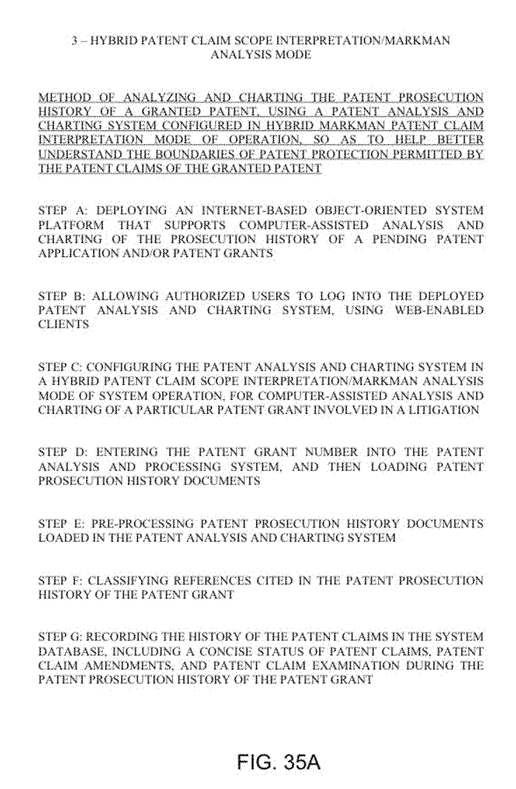

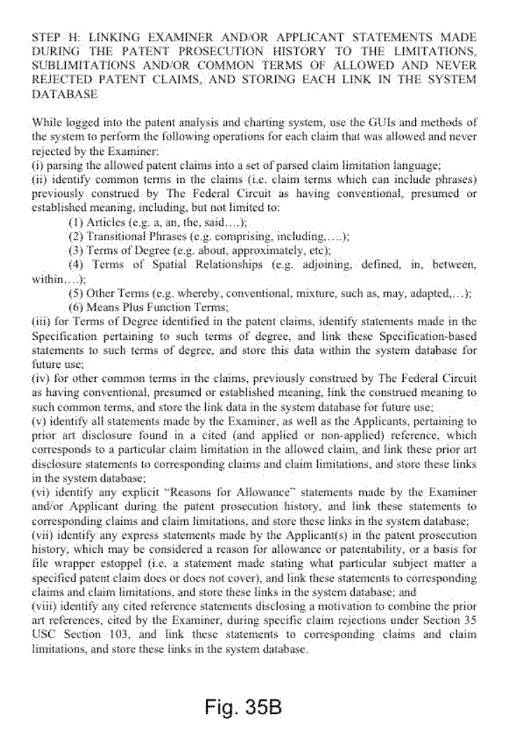

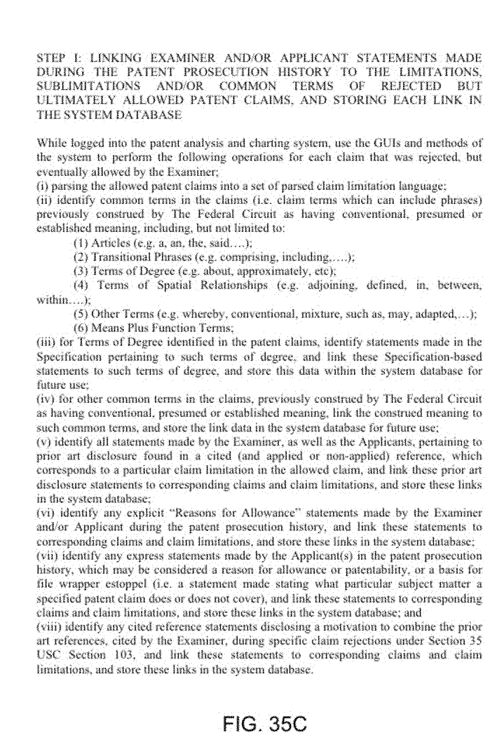

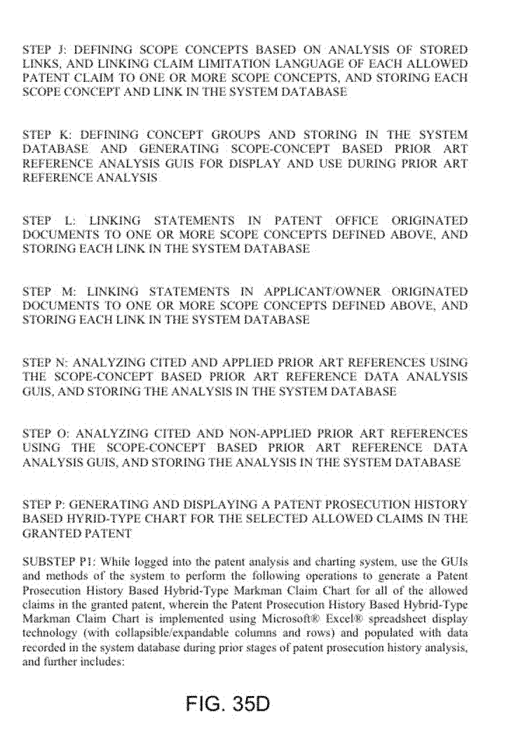

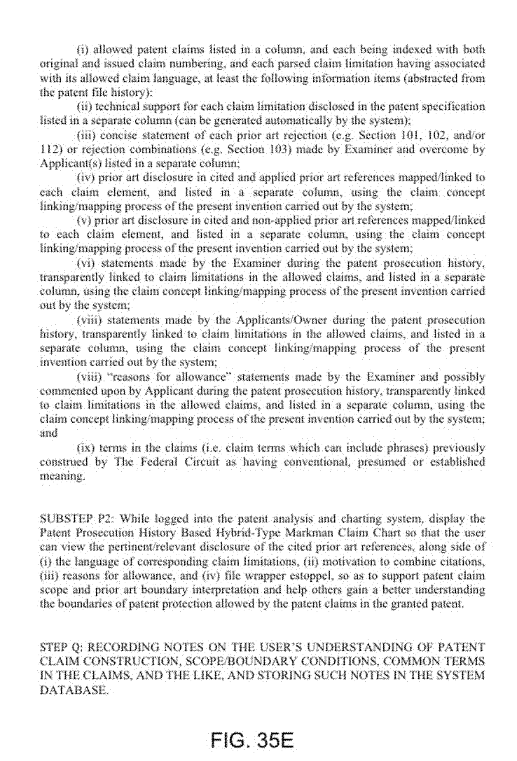

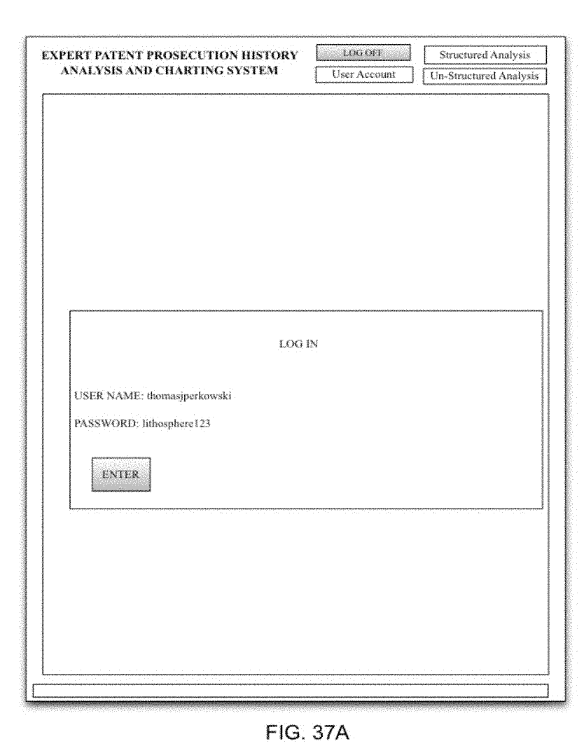

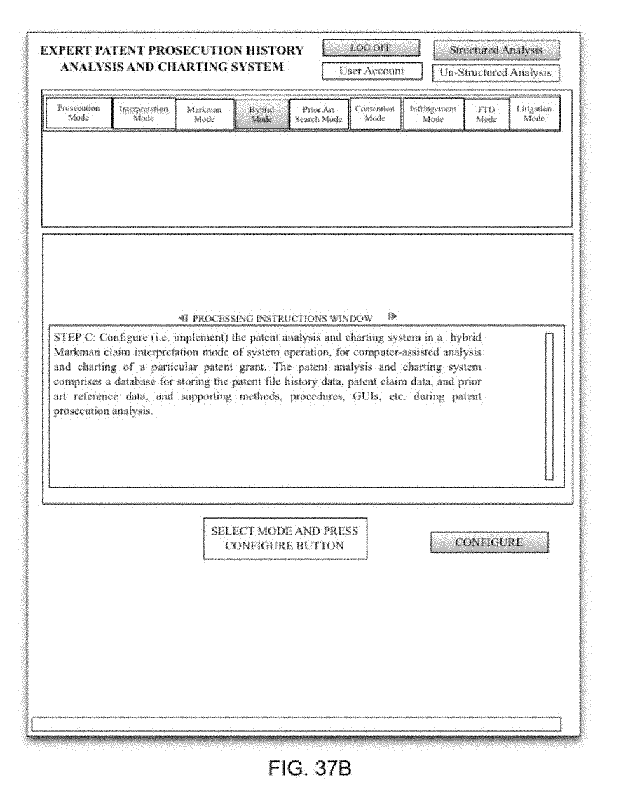

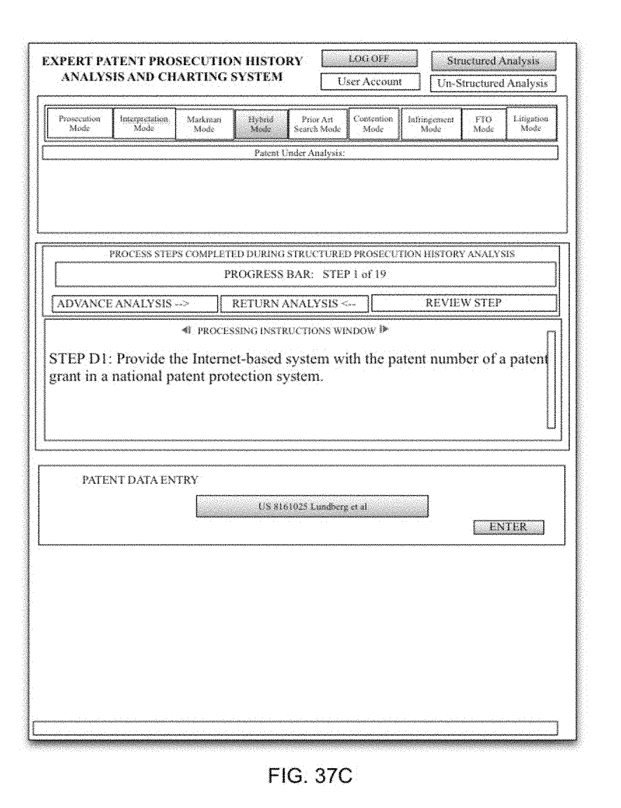

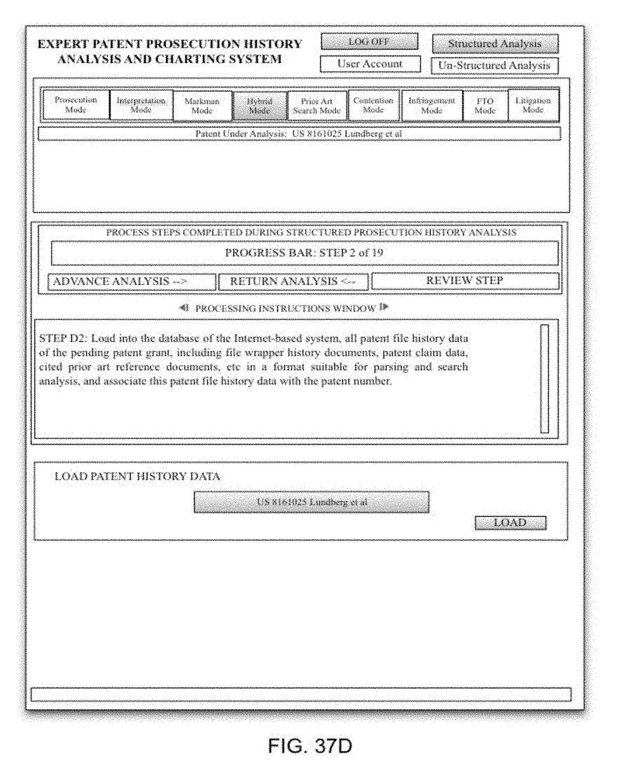

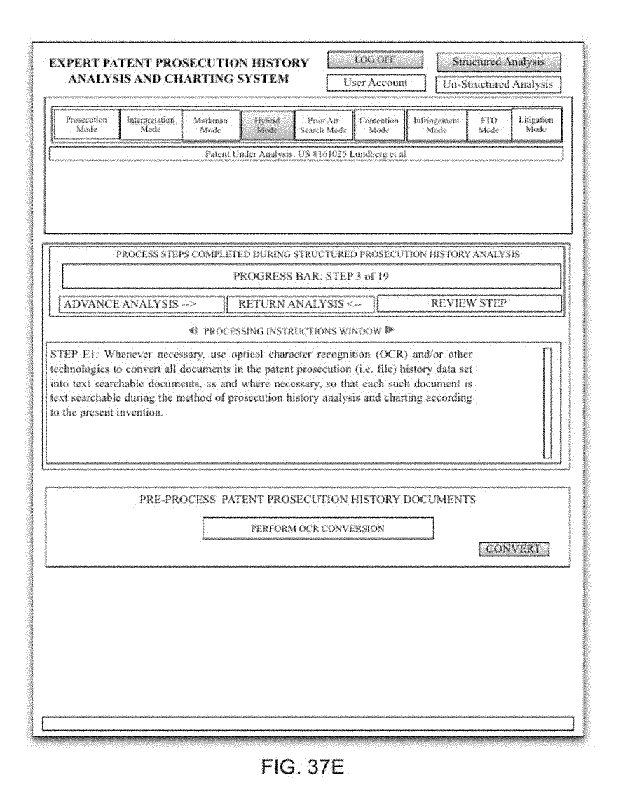

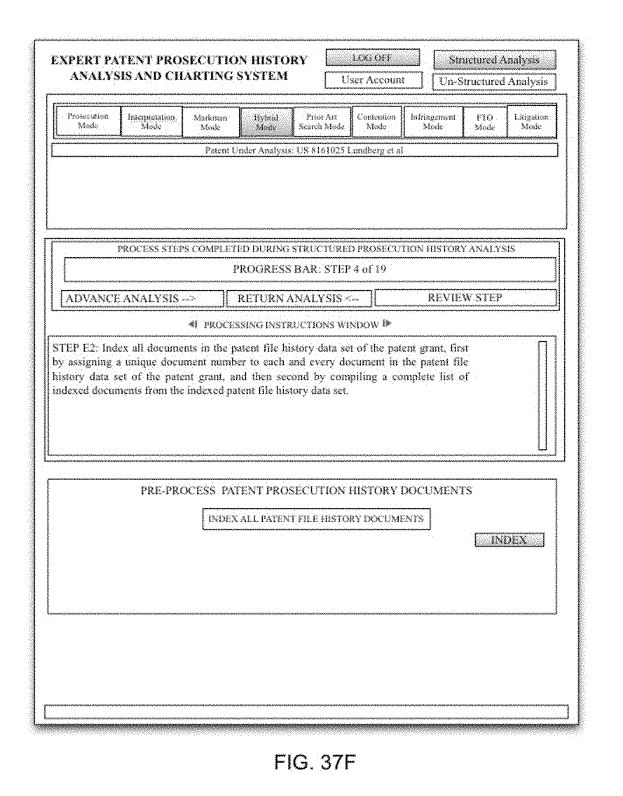

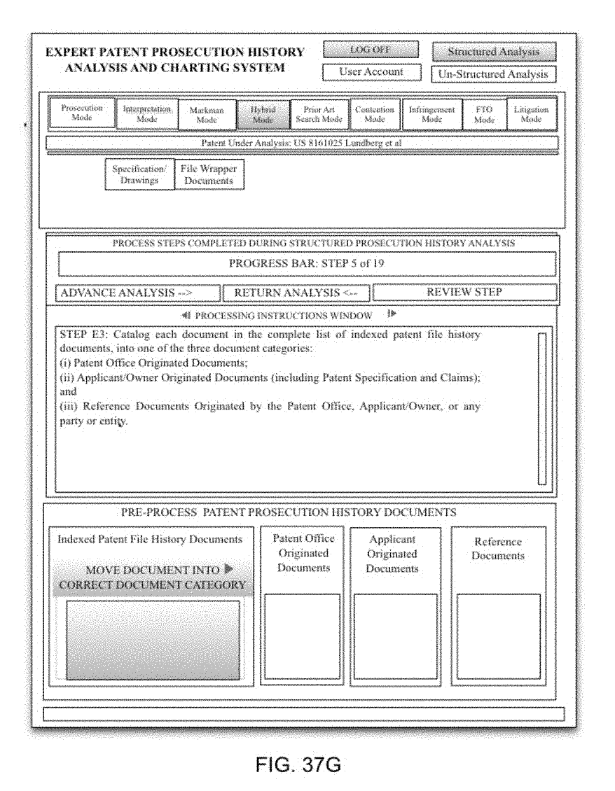

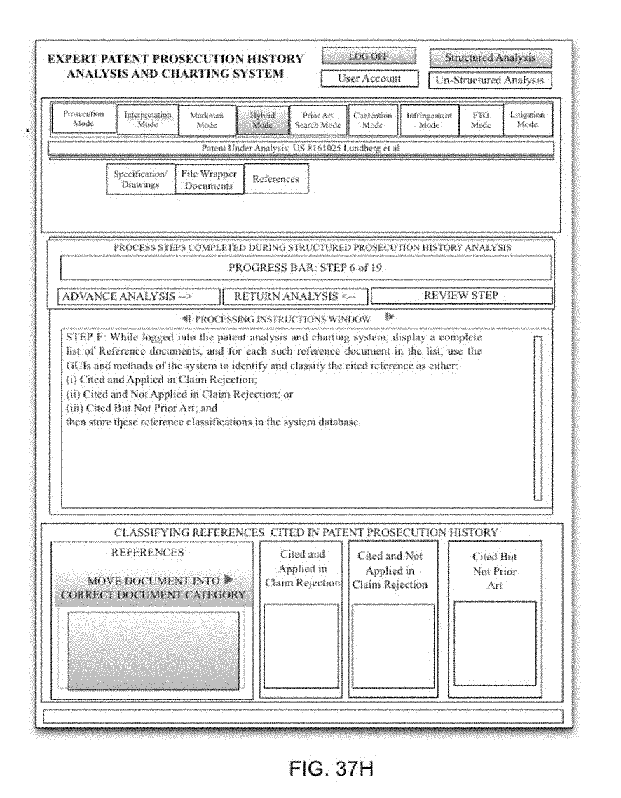

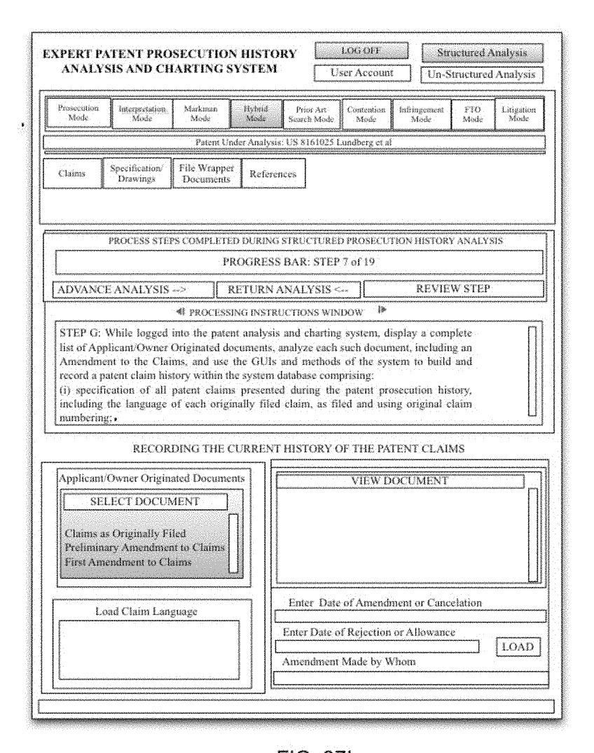

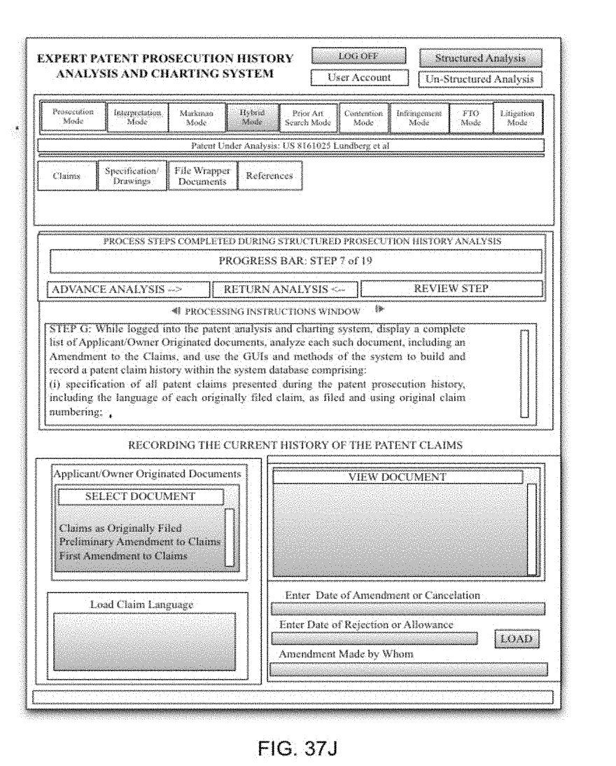

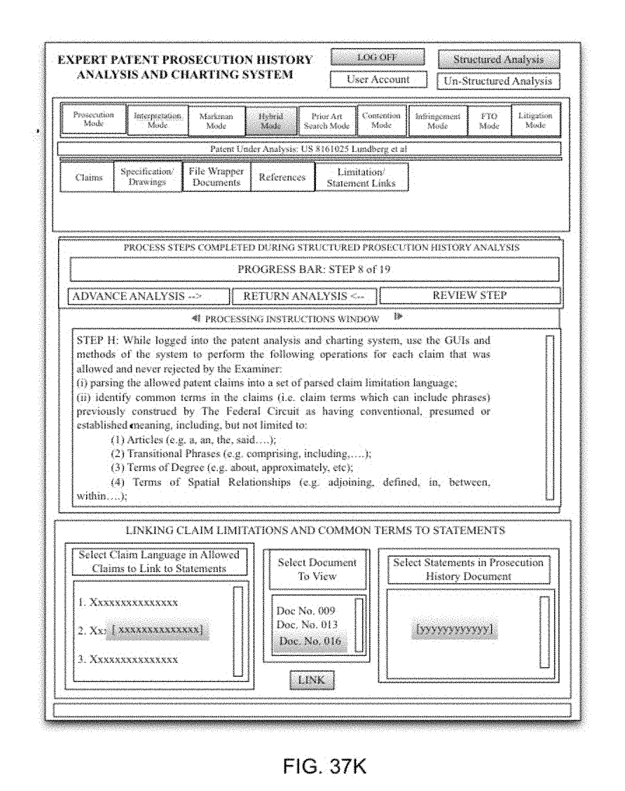

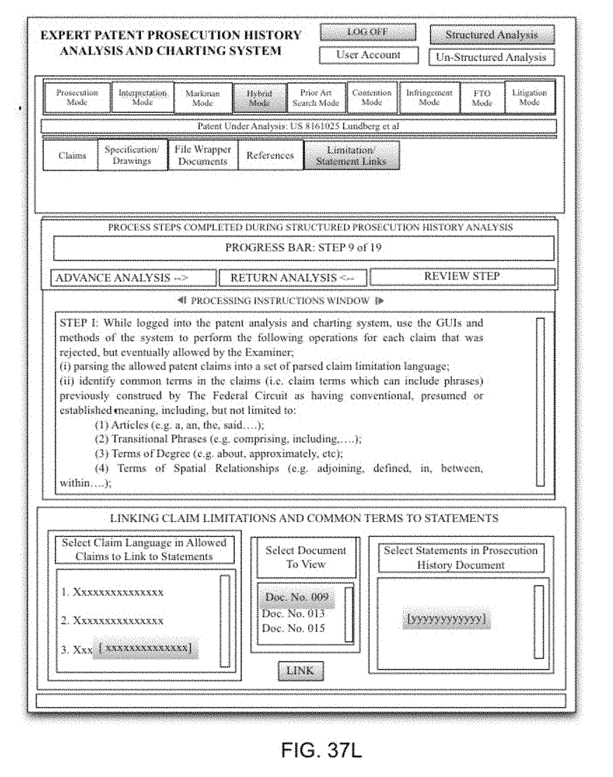

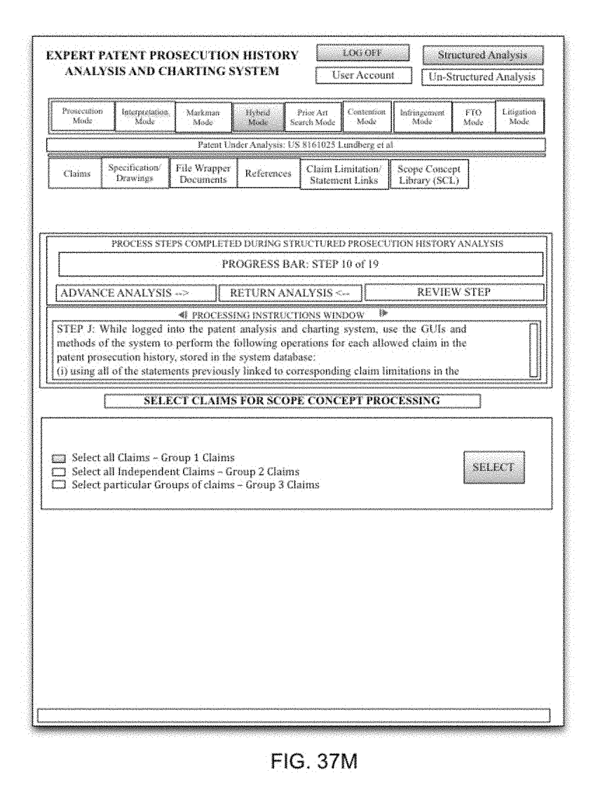

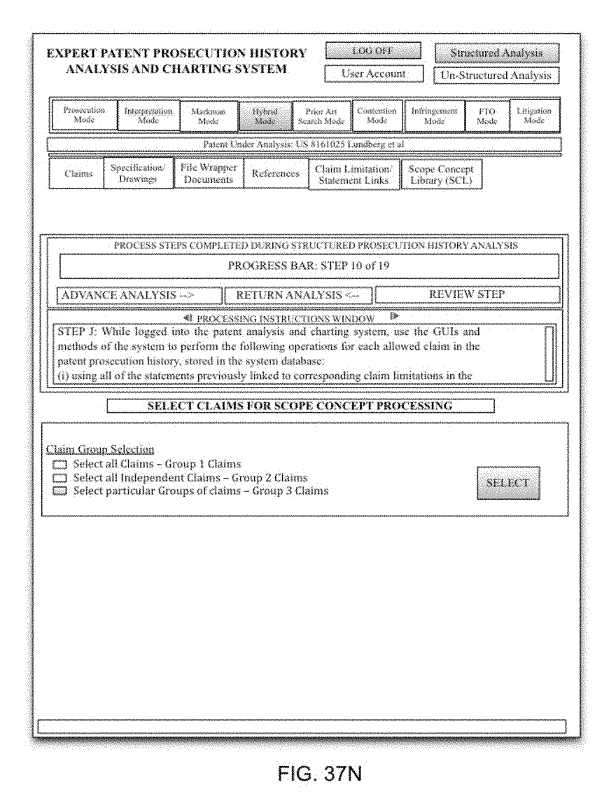

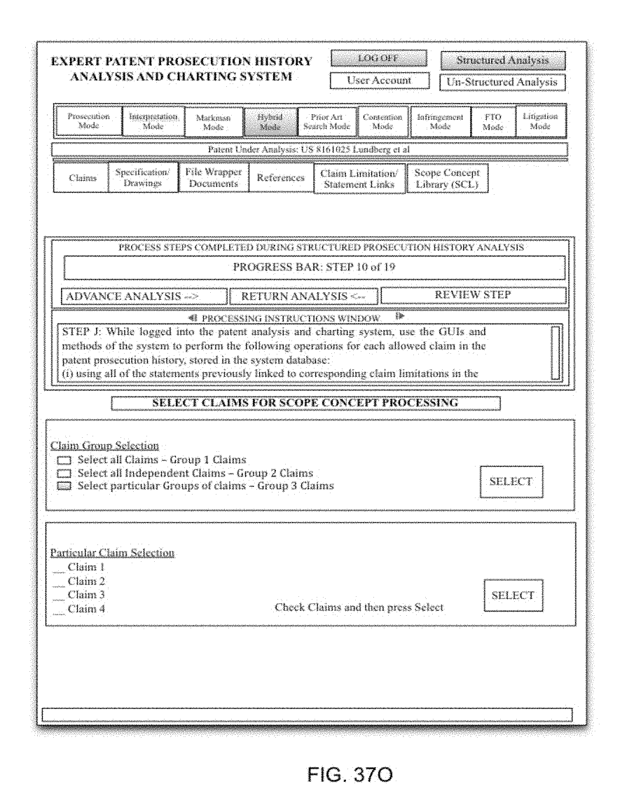

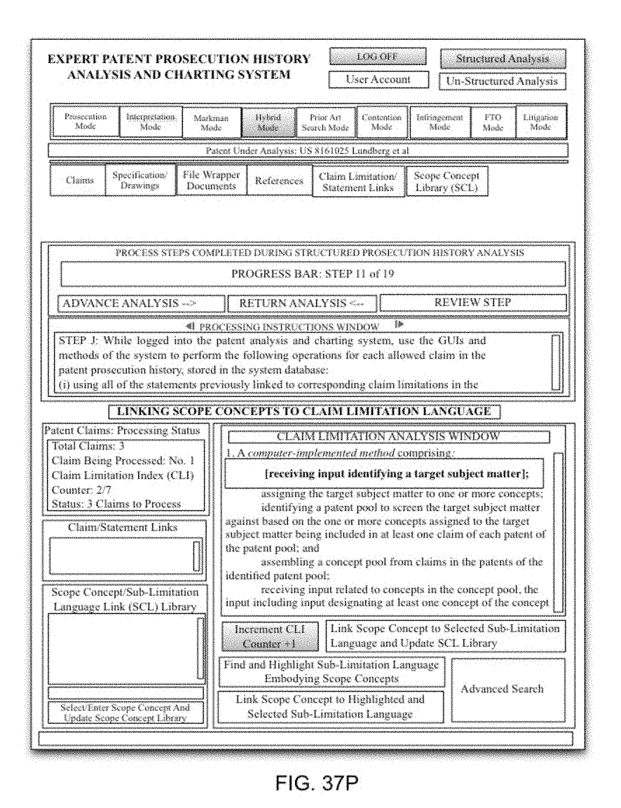

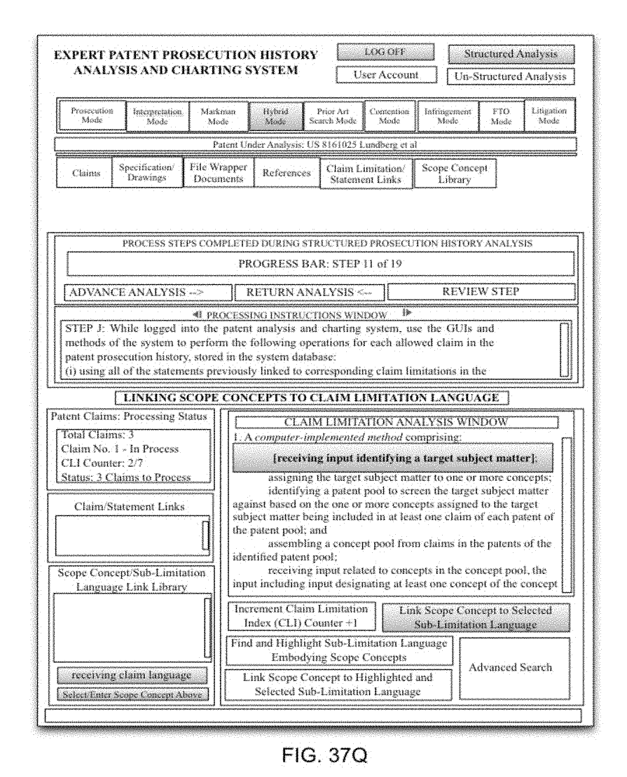

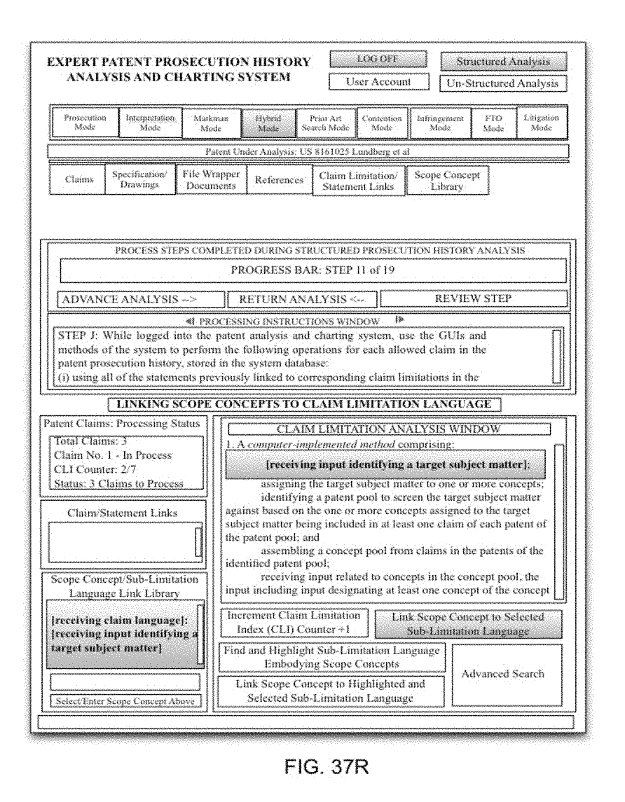

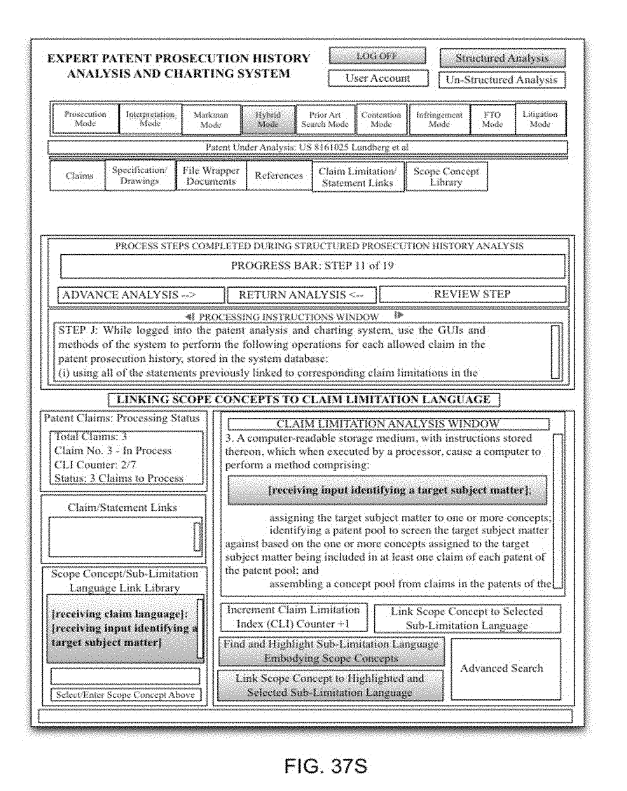

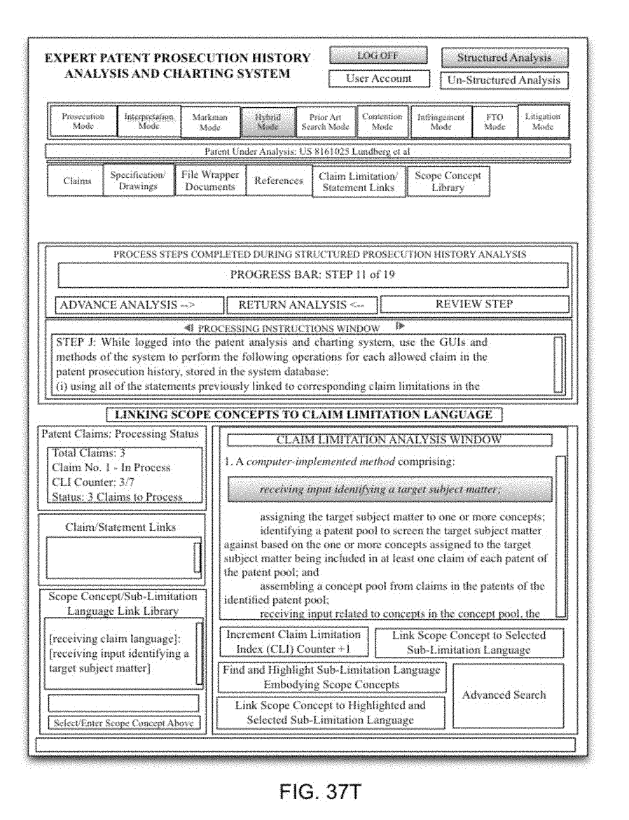

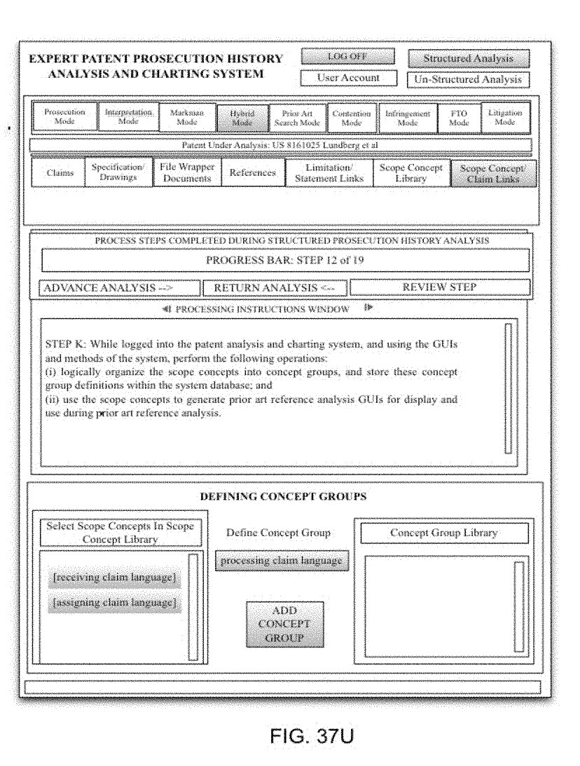

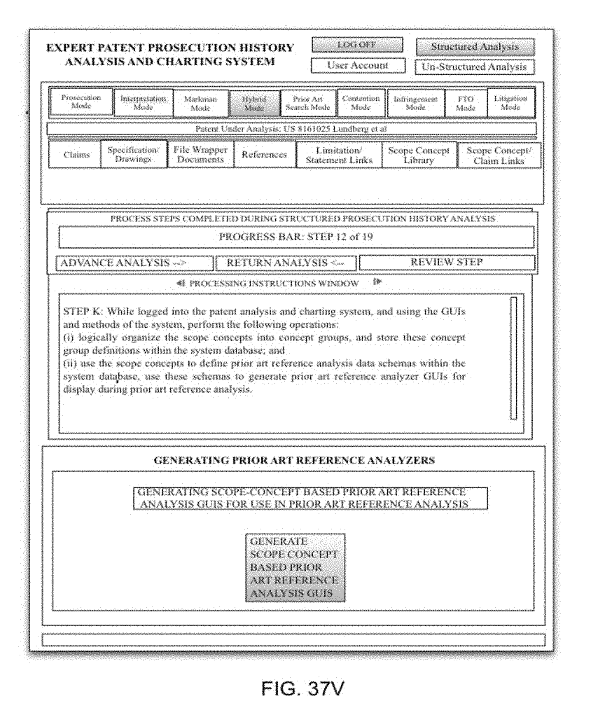

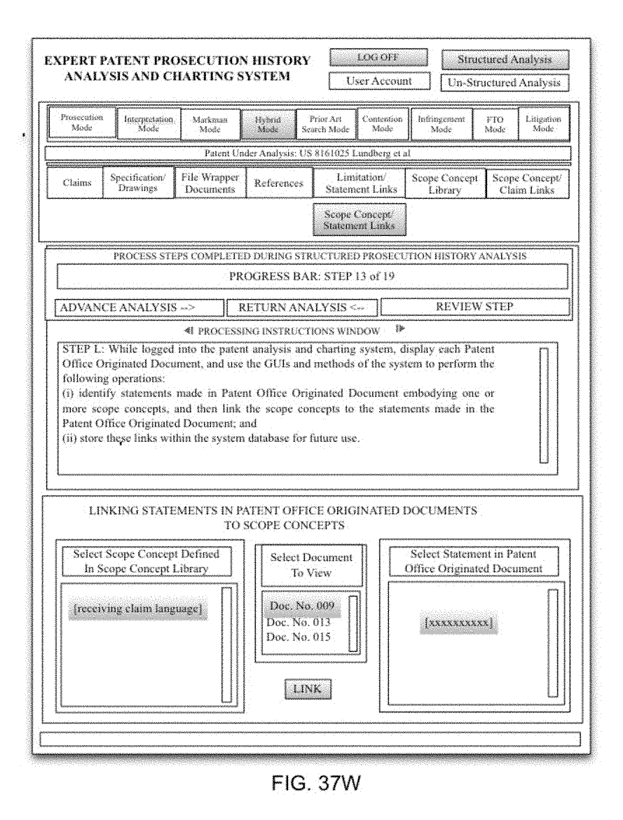

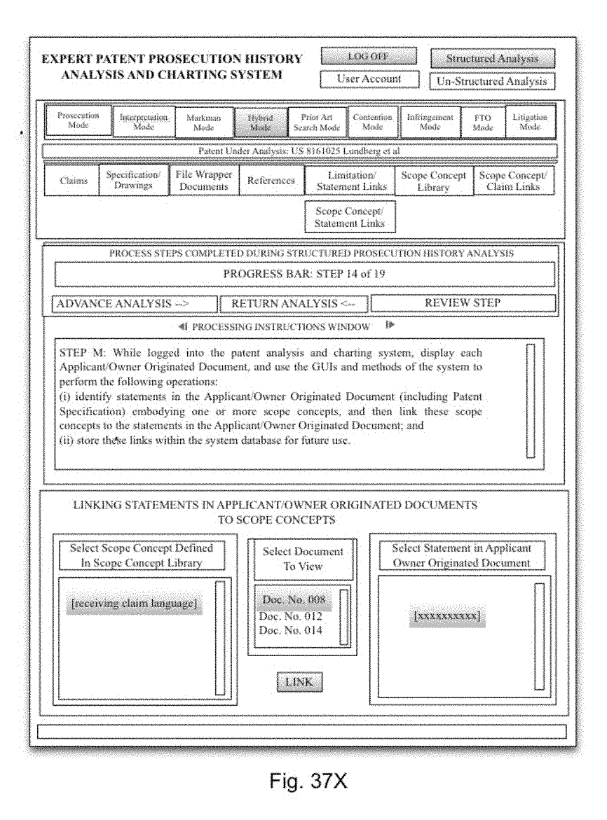

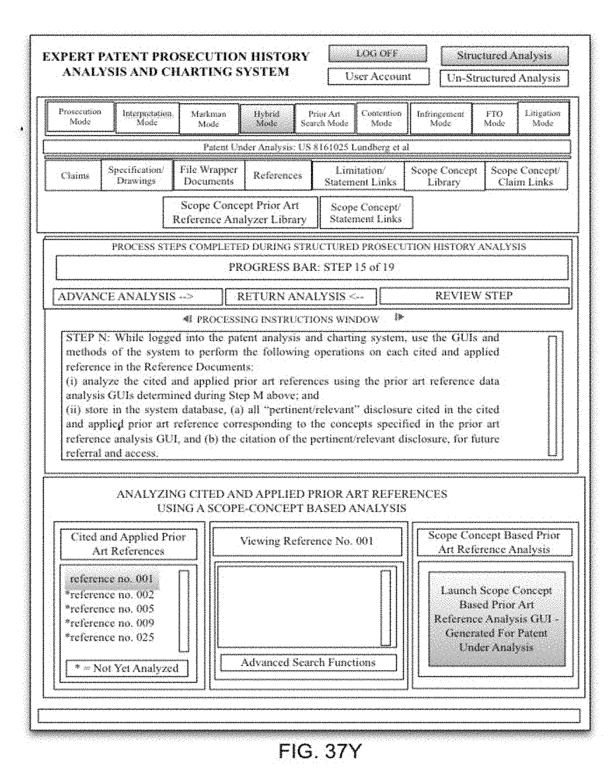

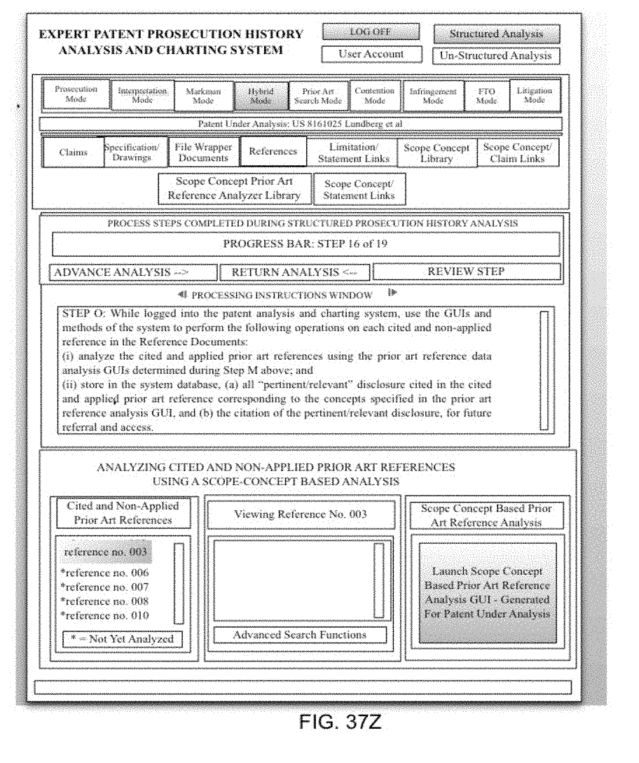

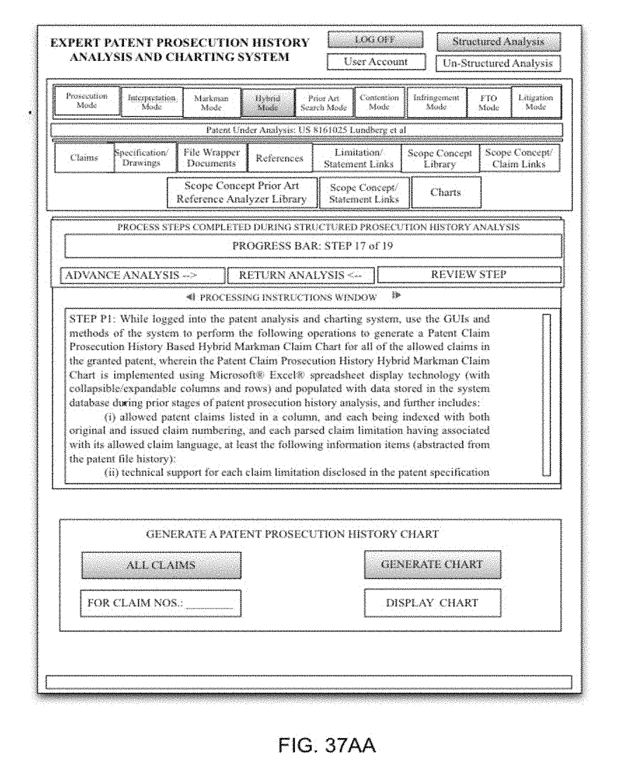

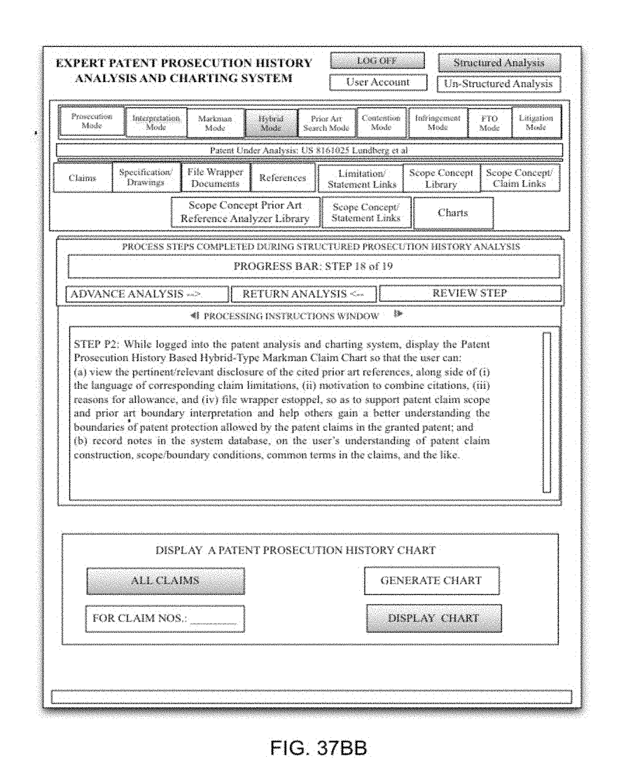

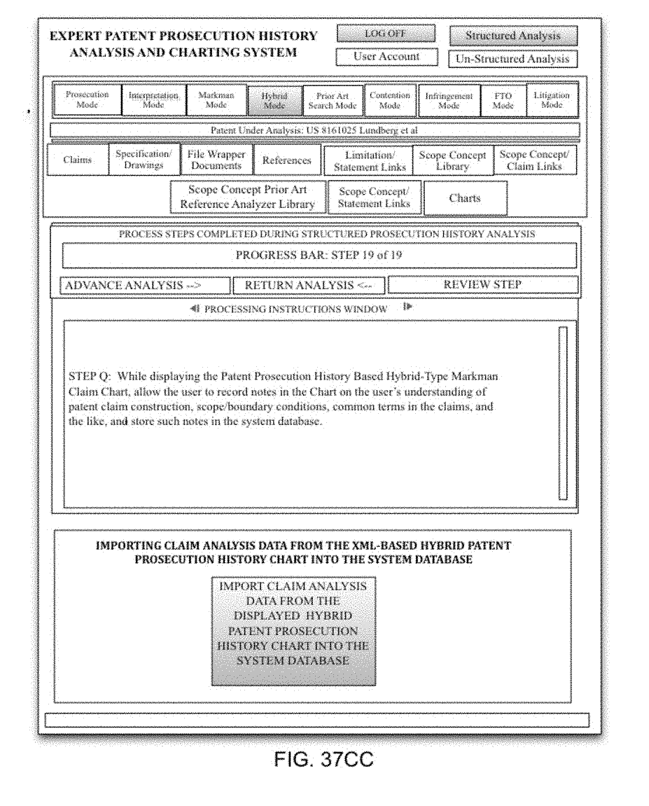

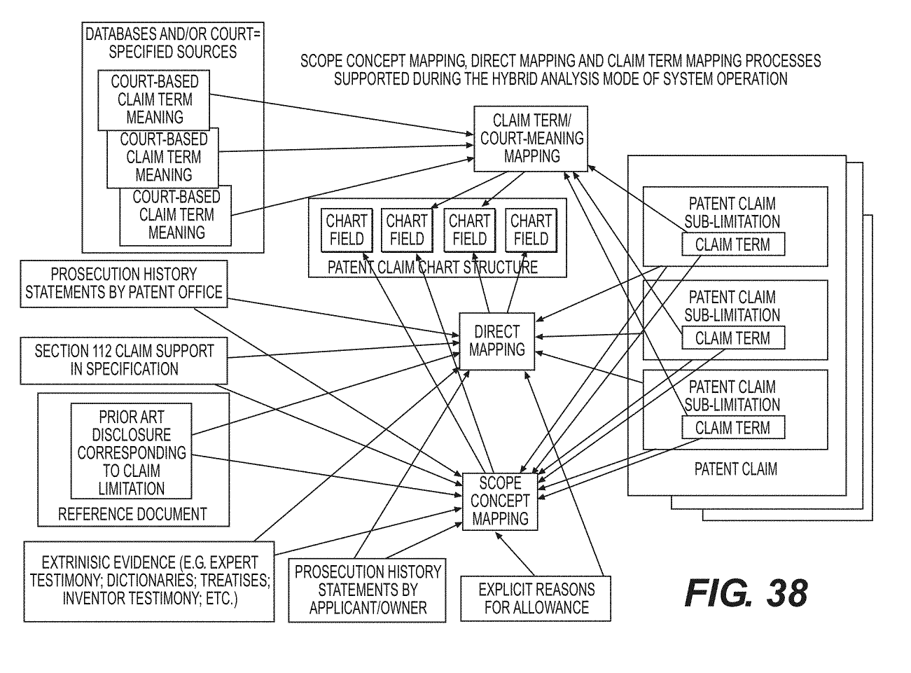

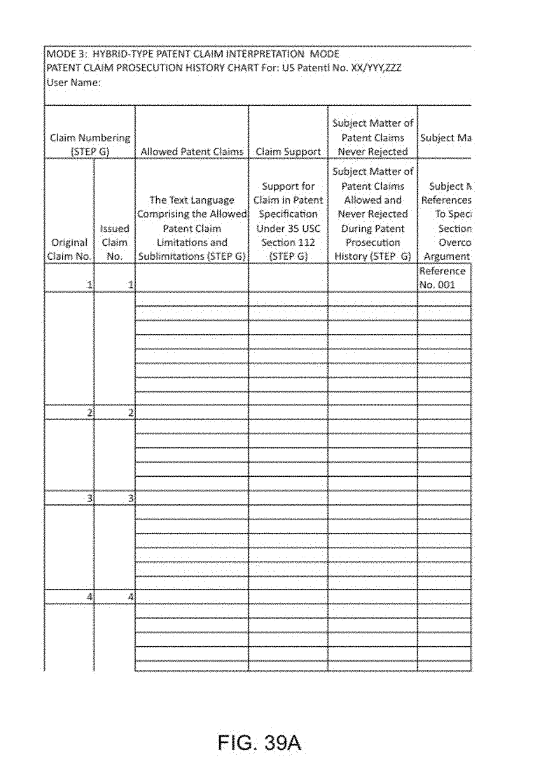

The workflow process specified in FIGS. 35A through 35E will be described now in greater detail with reference to corresponding wireframe GUIs shown in FIGS. 37A through 37CC and the information mapping process illustrated in FIGS. 34 and 38. Upon completion of the workflow process, the multi-mode system in its the patent claim prosecution mode will automatically (i.e. programmatically) generate and display an XML-based spreadsheet-based chart structure as illustrated in FIG. 33A through 33E, that can be used by various users in any given user work group, including patent attorneys, during patent claim scope/boundary interpretation and other analytical efforts.

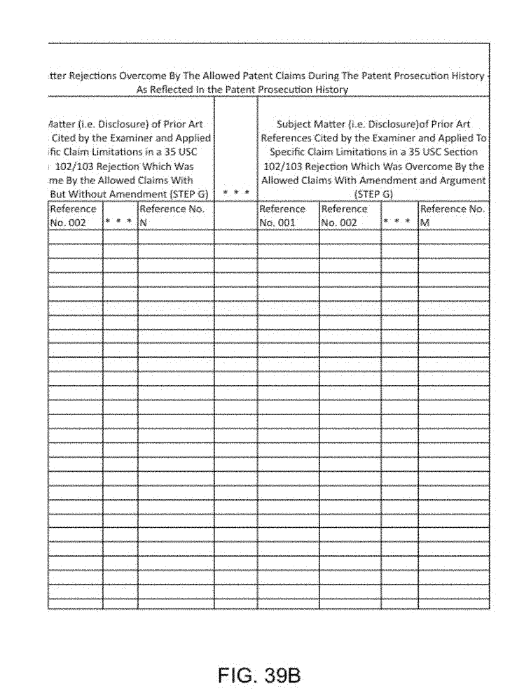

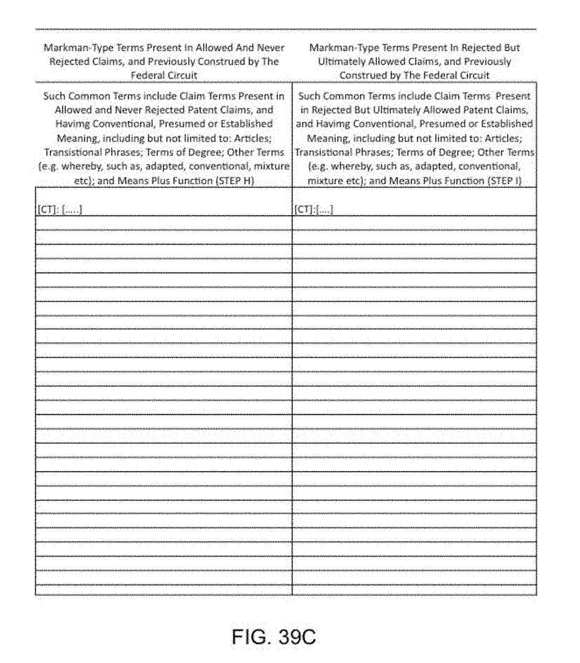

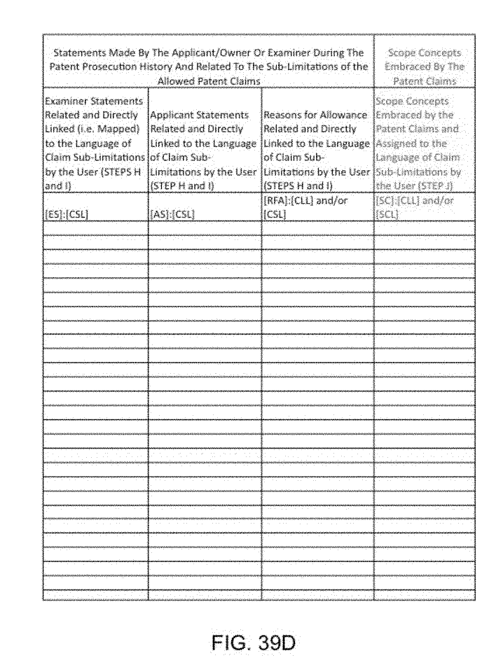

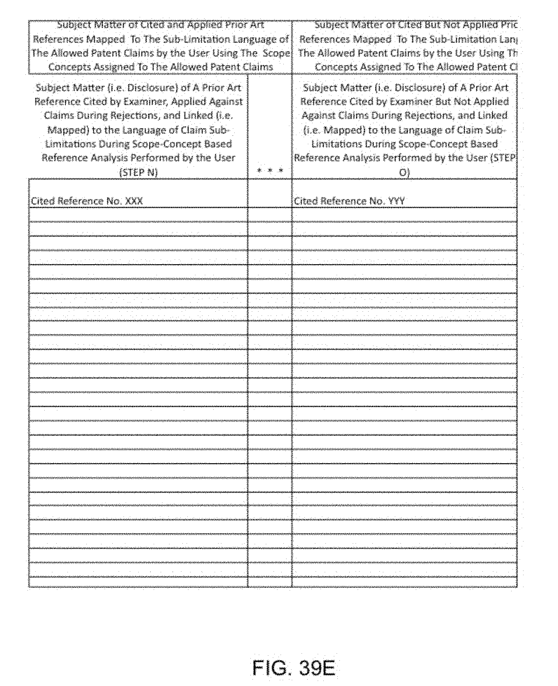

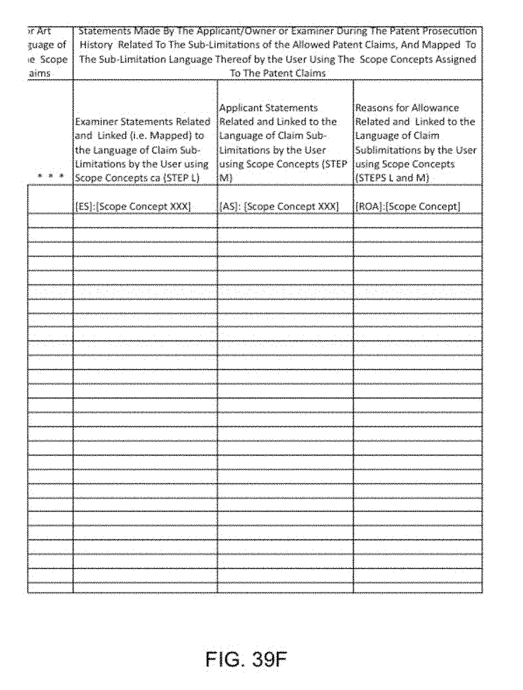

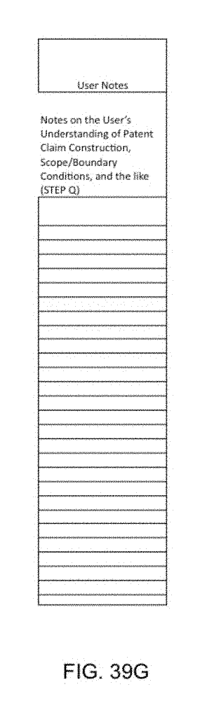

For presentation purposes only, the XML-based spreadsheet-based chart structure shown in FIGS. 39A through 39G has been broken down into several sections in the figure Drawings. For proper viewing, these figure drawings and should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

Method of Analyzing and Charting the Patent Prosecution History of a Granted Patent, Using a Patent Analysis and Charting System Configured in Hybrid Patent Claim Scope Interpretation/Markman Claim Term Analysis Mode of Operation, so as to Help Better Understand the Scope and Boundaries of Patent Protection Afforded by the Patent Claims of the Granted Patent

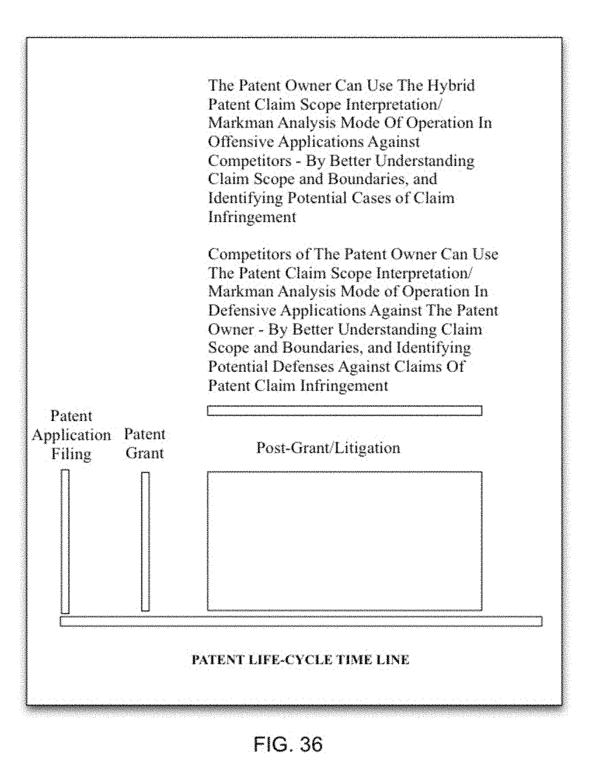

Referring now to the detailed flow chart set forth in FIGS. 35A through 35E, the Internet-based patent analysis and charting system of the present invention configured in its Hybrid Analysis Mode of system operation will be now described in detail, and showing how one or more users can efficiently analyze and chart the patent prosecution history of any granted patent involved in patent litigation, using the wireframe GUI screens set forth in FIGS. 37A through 37CC, the mapping techniques illustrated in FIGS. 34 and 38, and the patent prosecution history based chart structures described in FIGS. 39A through 39G. Various applications for the patent analysis and charting system configured in this mode of operation are illustrated in FIG. 36 and will be described in greater detail hereinbelow.

FIG. 28 illustrates the information mapping process supported by the system during its Hybrid Analysis Mode of system operation, wherein patent claim data and court-specified claim term meaning definitions for common claim terms are mapped to particular fields within the claim chart structures generated during this particular mode of system operation.

The workflow process specified in FIGS. 29AA through 29E will be described now in great detail with reference to corresponding wireframe GUIs shown in FIGS. 31A through 31M, and the information mapping processes illustrated in FIGS. 30 and 32. Upon completion of the workflow process, the multi-mode system in its Hybrid Analysis Mode will automatically generate and display an XML-based spreadsheet-based chart structure as illustrated in FIG. 33A through 33E, that can be used by various users in any given user work group, including patent attorneys, during patent claim scope/boundary interpretation and other analytical efforts.

For presentation purposes only, the XML-based spreadsheet-based chart structure shown in FIGS. 33A through 33E has been broken down into several sections in the figure Drawings, and should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

Method of Analyzing and Charting the Patent Prosecution History of a Granted Patent, Using a Patent Analysis and Charting System Configured in a Hybrid Patent Claim Scope Interpretation/Markman Claim Analysis Mode of Operation, so as to Help Better Understand Certain Terms in the Patent Claims of the Granted Patent

Referring now to the detailed flow chart set forth in FIGS. 35A through 35E, the Internet-based patent analysis and charting system of the present invention configured in its Hybrid Analysis Mode of system operation will be now described in detail, and showing how one or more users can efficiently analyze and chart the patent prosecution history of any granted patent, using the wireframe GUI screens set forth in FIGS. 37A through 37CC, the mapping techniques illustrated in FIGS. 34 and 38, and the XML-based patent prosecution history based chart structures described in FIGS. 39A through 39G. Various applications for the patent analysis and charting system configured in this mode of operation are illustrated in FIG. 36 and will be described in greater detail hereinbelow.

Upon completion of the workflow process, the multi-mode system in its the Hybrid Analysis Mode will automatically generate and display the XML-based spreadsheet-based chart structure as illustrated in FIG. 39A through 39G, that can be used by various users in any given user work group, including patent attorneys, during patent claim scope/boundary interpretation and other analytical efforts. For presentation purposes only, the XML-based spreadsheet-based chart structure shown in FIGS. 33A through 33E has been broken down into several sections in the figure Drawings, and should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

As shown in FIG. 34, during the Hybrid Analysis Mode of system operation, the system supports several different types of data mapping, namely: (i) direct linking of court-specified meaning to common terms in the patent claims and/or claim limitations, which are in dispute between the parties involved in a patent litigation; (ii) direct mapping of court-specified meaning and common claim terms identified in the patent claims by the parties to patent litigation; and (iii) scope concept mapping of patent claim limitations and specific portions of patent prosecution history documents including cited prior art references. As will be explained hereinafter, by using these different types of data mapping the users can generate powerful claim scope schema (CSS) based claim chart structures that help users better understand the scope and boundaries of the allowed patent claims, and provides a rich record of patent analysis that can leveraged at the time and place of patent claim construction.

The steps of the process described in FIGS. 35A through 35E will be described in detail below.

As indicated in Step A in FIG. 35A, Web, application and database servers on a network are used to deploy an Internet-based object-oriented system platform that supports a computer-assisted analysis and charting of the prosecution history of any patent granted in a national patent protection system. As shown in FIG. 5, the network is connected to the network information infrastructure and servers of national patent protection systems, and patent and published patent application depositories containing composite patent file history data documents for granted patents and pending (or abandoned) patent applications.

As indicated in Step B in FIG. 35A, web-enabled client machines are used to allow authorized users to log into the deployed patent analysis and charting system and perform the following operations specified below. As exemplary login GUI screen is shown in FIG. 37A for that purpose. In FIG. 37B, a GUI screen is shown for managing User Account information on the platform.

As indicated in Step C in FIG. 35A, the user employs a GUI as shown in FIG. 37B to configure the patent analysis and charting system in its Hybrid Analysis Mode of system operation, for computer-assisted analysis and charting of a particular patent application, prior to patent grant. In general, the patent analysis and charting system comprises a database for storing the patent file history data, patent claim data, and prior art reference data, and supporting methods, procedures, GUIs, etc. during patent prosecution analysis. The purpose of this step in the process is to select the mode of system operation to be configured on the system platform of the present invention.

As indicated in Step D in FIG. 35A, the user employs a GUI screen as shown in FIG. 37C to provide the Internet-based system with the patent number of the patent granted in a national patent protection system. Then, using a GUI screen as shown in FIG. 37D, all patent file history data of the granted patent, including file wrapper history documents, patent claim data, cited prior art reference documents, etc., are uploaded from patent servers shown in FIG. 5, into the database 15 of the Internet-based system, in a format suitable for parsing and search analysis, and associate this patent file history data with the patent application serial number.

As indicated in Substep E1 in FIG. 35A, a GUI screen as shown in FIG. 37E is employed so that, whenever necessary, the system uses optical character recognition (OCR) and/or other technologies to convert all documents in the patent prosecution (i.e. file) history data set into text searchable documents, as and where necessary, so that each such document is text searchable during the method of prosecution history analysis and charting according to the present invention.

As indicated in Substep E2 in FIG. 35A, a GUI screen as shown in FIG. 37F is employed so that all documents in the patent file history data set of the granted patent are indexed by first assigning a unique document number to each and every document in the patent file history data set of the patent application, and then second by compiling a complete list of indexed documents from the indexed patent file history data set.

As indicated in Substep E3 in FIG. 35A, a GUI screen as shown in FIG. 37G is employed so that each document in the complete list of indexed patent file history documents, is cataloged into one of the three document categories: (i) Patent Office Originated Documents; (ii) Applicant/Owner Originated Documents (including Patent Specification and Claims); and (iii) Reference Documents Originated by the Patent Office, Applicant/Owner, or any party or entity.

As indicated in Step F in FIG. 35A, a GUI screen as shown in FIG. 37H is employed so that, while logged into the patent analysis and charting system, the system displays a complete list of Reference documents, and for each such reference document in the list, the user uses the GUIs and methods of the system to identify and classify the cited reference as either: (i) cited and applied in claim rejection; (ii) cited and not applied in claim rejection; or (iii) cited but not prior art; and then store these reference classifications in the system database

As indicated in Step G in FIG. 35A, GUI screens as shown in FIGS. 371 and 37J are employed, so that the system enables the recording of the current history of the patent claims in the system database, including a concise status of patent claims, patent claim amendments, and patent claim examination during the patent prosecution history of the patent application. In the illustrative embodiment, this is achieved as follows. As shown, while logged into the patent analysis and charting system, the system displays a complete list of Applicant/Owner Originated documents, and then each such document, including an Amendment to the Claims is analyzed by the user using the GUIs and methods of the system so as to build and record a patent claim history (PCH) within the system database 15.

In the illustrative embodiment, the patent claim history (PCH) comprises:

(i) specification of all patent claims presented during the patent prosecution history, including the language of each originally filed claim, as filed and using original claim numbering;

(ii) specification of the date each patent claim was amended and/or canceled, voluntarily, and not in response to an examiner's claim rejection;

(iii) specification of which patent claims were allowed without rejection, and specify the date of allowance and the Examiner who made the allowance;

(iv) specification of which claims were rejected, identify the statutory basis of each such rejection (e.g. 35 USC Section 102 and/or 103) and prior art references upon which the claim rejection was made, and specify the date of the claim rejection and the Patent Examiner who made the rejection;

(v) specification of the language of each claim amendment, identify when the amendment was made and by whom (i.e. using USPTO Attorney/Agent Registration Number for registered agents and attorneys, and Applicant's name for pro se applications);

(vi) specification of which claims where allowed after rejection in response to an argument for patentability and request for reconsideration, and a specification of the language of each such allowed claim; and

(vii) specification of which claims where allowed after rejection in response to an argument for patentability, an amendment to the claims, and a request for reconsideration, and a specification of the language of each such allowed claim.

As indicated in Step H in FIG. 35B, a GUI screen as shown in FIG. 37K is employed, so that the user can link examiner and/or applicant statements made during the patent prosecution history to the limitations, sub-limitations and/or common terms of allowed and never rejected patent claims, and then store each link in the system database.

Specifically, while logged into the patent analysis and charting system, the user uses the GUIs and methods of the system to perform the following operations for each claim that was allowed and never rejected by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure (e.g. searchable text and/or searchable graphics and/or images) found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

As indicated in Step I in FIG. 35C, a GUI screen as shown in FIG. 37L is employed, so that the user can link examiner and/or applicant statements made during the patent prosecution history to the limitations, sub-limitations and/or common terms of rejected but ultimately allowed patent claims, and storing each link in the system database.

Specifically, while logged into the patent analysis and charting system, the user uses the GUIs and methods of the system to perform the following operations for each claim that was rejected, but eventually allowed by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure (e.g. searchable text and/or searchable graphics and/or images) found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

As indicated in Step J in FIG. 35D, GUI screens as shown in FIGS. 37M through 37T are employed, so that the user can define and formulate scope concepts based on analysis of stored links, then link claim limitation language of each allowed patent claim to one or more scope concepts, and ultimately store each scope concept and link in the system database. Specifically, while logged into the patent analysis and charting system, the user uses the GUIs and methods of the system to perform the following operations for each allowed claim in the patent prosecution history, stored in the system database 15:

(i) display the allowed patent claims using final patent numbering, or any selected group of claims (e.g. all claims, all independent claims, or a particular subset of claims);

(ii) using the statements previously linked to corresponding claim limitations in the allowed patent claim, identify and formulate one or more scope concepts expressed in and/or embraced by or embodied within the claim limitation language of each allowed patent claim, and store these scope concepts in the system database;

(iii) for each claim limitation, link a scope concept to the corresponding language of the claim sub-limitation that supports the scope concept and store these claim limitation/scope concept links in the system database; and

(iv) repeat step (iii) above for each claim limitation, as necessary to capture essential scope concepts embodied within the allowed claim.

The scope concept formulation, assignment and linkage method described in FIGS. 24 through 26 can be used to practice Step J of this method of patent claim analysis supported by the system of the present invention.

During the process of claim scope concept analysis and scope concept formulation described above, the user assigns one or more scope concepts to each patent claim in the set of patent claims under analysis. Then, for the set of patent claims, the system automatically forms and maintains a Library of Scope Concepts (“Scope Concept Library”) stored in the system database 15. At any time, the user can review the Scope Concept Library for any given set of patent claims under analysis by clicking on the Scope Concept Library graphical icon presented with the GUI screens displayed by the system, as shown in FIG. 37U, for example.

For each patent claim that has been scope concept analyzed, the system automatically generates a Claim Scope Concept Profile, as shown in FIG. 26B, comprising a complete List of Scope Concepts that have been assigned to corresponding language in the claim limitations and/or sub-limitations of the Patent Claim. The system also maintains a Library of Scope Concept/Claim links, as shown in FIG. 37U.

As indicated in Step K in FIG. 35D, GUI screens as shown in FIGS. 37U and 37V are employed, so that the user can define concept groups and store them in the system database and generate scope concept based prior art reference analysis GUIs shown in FIG. 26C for use during prior art reference analysis. Specifically, while logged into the patent analysis and charting system, and using the GUIs and methods of the system, the user performs the following operations: (i) logically organizes the scope concepts into concept groups, and stores these concept group definitions within the system database; and (ii) uses the scope concepts to define prior art reference analysis GUIS 26C for display during prior art reference analysis.

As indicated in Step L in FIG. 35D, a GUI screen as shown in FIG. 37W is employed, so that the user can link statements in patent office originated documents to one or more scope concepts defined above, and then store each link in the system database. Specifically, while logged into the patent analysis and charting system, display each Patent Office Originated Document, and use the GUIs and methods of the system to perform the following operations: (i) identify statements made in Patent Office Originated Document embodying one or more scope concepts, and then link the scope concepts to the statements made in the Patent Office Originated Document; and (ii) store these links within the system database for future use.

As indicated in Step M in FIG. 35D, a GUI screen as shown in FIG. 37X is employed, so that the user can link statements in Applicant/Owner originated documents to one or more scope concepts defined above, and store each link in the system database. Specifically, while logged into the patent analysis and charting system, display each Applicant/Owner Originated Document, and use the GUIs and methods of the system to perform the following operations: (i) identify statements in the Applicant/Owner Originated Document (including Patent Specification) embodying one or more scope concepts, and then link these scope concepts to the statements in the Applicant/Owner Originated Document; and (ii) store these links within the system database for future use.

As indicated in Step N in FIG. 35D, a GUI screen as shown in FIG. 37Y is employed, so that the user can analyze cited and applied prior art references using the scope concept based prior art reference analysis GUIs shown in FIG. 26C, and store the analysis in the system database 15. Specifically, while logged into the patent analysis and charting system, the user uses the GUIs and methods of the system to perform the following operations on each cited and applied reference in the Reference Documents: (i) analyze the cited and applied prior art references using the prior art reference data analysis GUIs determined during Step M above; and (ii) store in the system database, (a) all “pertinent/relevant” disclosure cited in the cited and applied prior art reference corresponding to the concepts specified in the prior art reference analysis GUI, and (b) the citation of the pertinent/relevant disclosure, for future referral and access.

As indicated in Step O in FIG. 35D, a GUI screen as shown in FIG. 37Z is employed so that the user can analyze cited and non-applied prior art references using the scope concept based prior art reference analysis GUIs, and store the analysis in the system database. Specifically, while logged into the patent analysis and charting system, use the GUIs and methods of the system to perform the following operations on each cited and non-applied reference in the Reference Documents: (i) analyze the cited and non-applied prior art reference using the prior art reference data analysis GUIs determined during Step M above; and (ii) store in the system database (a) all “pertinent/relevant” disclosure cited in the cited and non-applied prior art reference corresponding to the concepts specified in the prior art reference analysis GUI, and (b) the citation of the pertinent/relevant disclosure, for future referral and access.

As indicated in Step P in FIG. 35E, GUI screens as shown in FIGS. 37AA and 37BB are employed, so that the user can generate and display a claim scope schema (CSS) based claim chart for the selected allowed claims in the granted patent. Specifically, during Substep P1, while logged into the patent analysis and charting system, the user uses the GUI of FIG. 37AA and methods of the system to generate a CSS-based claim chart structure for all of the allowed claims in the granted patent, wherein the CSS-based claim chart structure is implemented using XML-based Microsoft® Excel® spreadsheet display technology (with collapsible/expandable columns and rows) and populated with data recorded in the system database during prior stages of patent prosecution history analysis.

As shown in FIGS. 39A through 39G, the patent prosecution history based claim scope schema (CSS) chart structure, for the hybrid-type analysis mode, comprises data fields for presenting graphical representations of the following graphical objects:

(i) the text language comprising the allowed patent claim limitations and sub-limitations (Step G) listed in a column, and each being indexed with both original and issued claim numbering, and each parsed claim limitation having associated with its allowed claim language, at least the following information items (abstracted from the patent file history):

(ii) technical support for each claim limitation disclosed in the patent specification under 35 USC Section 112 (Step G) listed in a separate column (can be generated automatically by the system);

(iii) subject matter (language) of patent claims allowed and never rejected during patent prosecution history (Step G);

(iv) subject matter rejections overcome by the allowed patent claims during the patent prosecution history—as reflected in the patent prosecution history—including a concise statement of each prior art rejection (e.g. Section 101, 102, and/or 112) or rejection combinations (e.g. Section 103) made by Examiner and overcome by Applicant(s) listed in a separate column;

subject matter (i.e. disclosure) of prior art references cited by the examiner and applied to specific claim limitations in a 35 USC Section 102/103 rejection which was overcome by the allowed claims with argument but without amendment (Step G);

subject matter (i.e. disclosure) of prior art references cited by the examiner and applied to specific claim limitations in a 35 USC Section 102/103 rejection which was overcome by the allowed claims with amendment and argument (Step G);

(v) Markman-type terms present in allowed and never rejected claims, and previously construed by the Federal Circuit—such common terms including claim terms present in allowed and never rejected patent claims, and having conventional, presumed or established meaning, including but not limited to: articles, transitional phrases, terms of degree, other terms (e.g. whereby, such as, adapted, conventional, mixture etc), and means plus function (Step H);

(vi) Markman-type terms present in rejected but ultimately allowed claims, and previously construed by the Federal Circuit—such common terms including claim terms present in rejected but ultimately allowed patent claims, and having conventional, presumed or established meaning, including but not limited to: articles, transitional phrases, terms of degree, other terms (e.g. whereby, such as, adapted, conventional, mixture etc), and means plus function (Step I);

(vii) examiner statements related and directly linked (i.e. mapped) to the language of claim sub-limitations by the user (Steps H and I);

(viii) applicant statements related and directly linked to the language of claim sub-limitations by the user (Step H and I);

(ix) reasons for allowance related and directly linked to the language of claim sub-limitations by the user (Steps H and I);

(x) scope concepts embraced by the patent claims and assigned to the language of claim sub-limitations by the user (Step J);

(xi) subject matter of cited and applied prior art references mapped to the sub-limitation language of the allowed patent claims by the user during scope concept based reference analysis performed by the user and using the scope concepts assigned to the allowed patent claims (Step N);

(xii) subject matter of cited but not applied prior art references mapped to the sub-limitation language of the allowed patent claims by the user during scope concept based reference analysis performed by the user and using the scope concepts assigned to the allowed patent claims (Step O);

(xiii) statements made by the examiner during the patent prosecution history, transparently linked to claim sub-limitations in the allowed claims, and listed in a separate column, using the claim concept linking/mapping process of the present invention carried out by the system (Step L);

(xiv) statements made by the applicants/owner during the patent prosecution history, transparently linked to claim sub-limitations in the allowed claims, and listed in a separate column, using the claim concept linking/mapping process of the present invention carried out by the system (Step M);

(xv) “reasons for allowance” statements made by the examiner and possibly commented upon by applicant during the patent prosecution history, transparently linked to claim sub-limitations in the allowed claims, and listed in a separate column, using the scope concept linking/mapping process of the present invention carried out by the system (Steps L and M); and

(xvi) notes on the user's understanding of patent claim construction, scope/boundary conditions, and the like (Step Q).

During the patent claim understanding/interpretation process, the claim scope schema (CSS) structure, comprising all information from the patent prosecution history linked together by claim scope concepts (CSC) and contained within the spreadsheet-type chart structure, functions as a framework that helps organize information relating to the scope and meaning of any allowed patent claim represented in the chart structure, to assist anyone interested in better understanding the scope and boundaries offered by allowed patent claims.

During Substep P2, while logged into the patent analysis and charting system, the system displays the patent prosecution history based CSS chart structure so that the user can view the pertinent/relevant disclosure of the cited prior art references, along side of (i) the language of corresponding claim limitations, (ii) motivation to combine citations, (iii) reasons for allowance, and (iv) file wrapper estoppel, so as to support patent claim scope and prior art boundary interpretation and help others gain a better understanding of the boundaries of patent protection allowed by the patent claims in the granted patent.

As indicated in Step Q in FIG. 35E, a GUI screen as shown in FIG. 37CC is employed, so that the user can record notes on the user's understanding of patent claim construction, scope/boundary conditions, common terms in the claims, and the like, and storing such notes in the system database. Specifically, while the claim scope schema (CSS) chart structure is being displayed, the user can record notes in the chart structure on the user's understanding of patent claim construction, scope/boundary conditions, common terms in the claims, and the like, and store such notes in the system database.

This note field in the chart will be a read/write field, whereas most all other fields will be read only, for the reasons explained above. If the XML-based chart structure is displayed from a web-based client system while logged into the system servers, any notes added to the Notes field will be automatically updated and stored in the system database, or like persistent data-storage device. If the XML-based chart structure is generated an XML-based file and then moved to another client machine, while logged off from the system servers, the users can make notes in the notes field, and subsequently, the XML-based chart structure can be uploaded to the system by any client logged into the system, and requesting that the data be imported into the system database, as indicated in the lower half of the exemplary GUI screen shown in FIG. 22CC.

FIG. 36 illustrates the application of the multi-mode patent analysis and charting system configured in its hybrid analysis mode of system operation, and deployed during particular phases of the patent life-cycle time line, by both the patent owner and its competitors. In particular, the patent owner can use the hybrid analysis mode of operation in offensive applications against competitors, namely, by (i) better understanding the scope and boundaries of the allowed patent claims, against a landscape of scope concept mapped prior art references displayed in the chart structure, (ii) identifying potential future cases of claim infringement (requiring deeper patent claim infringement analysis). Also, defendants can use the hybrid analysis mode of operation in defensive applications against the patent owner, by better understanding the scope and boundaries of patent protection afforded by the claims, and identifying potential defenses of potential claims of patent claim infringement.

### Specification of the Multi-Mode Patent Analysis and Charting System of the Present Invention Configured in its Prior/Present Art Search Analysis Mode of System Operation (Mode 4)

FIG. 40 is illustrates the information mapping process supported by the system during its prior/present art search analysis mode of system operation, wherein patent claim data, prosecution history data (and court-specified claim term meaning definitions for common claim terms in the case of granted patents involved in litigation) are mapped to particular fields within the search vectors produced during this particular mode of system operation.

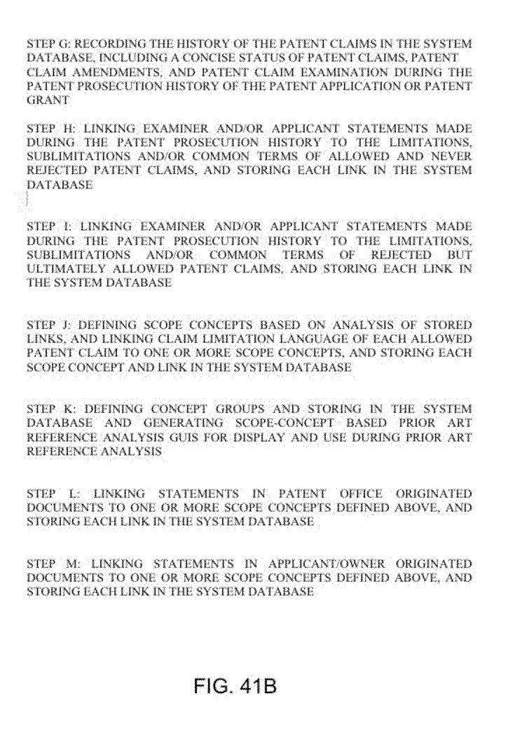

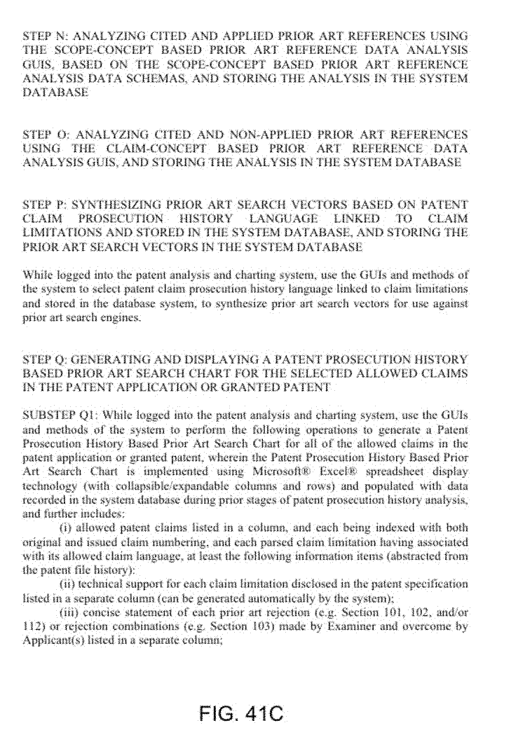

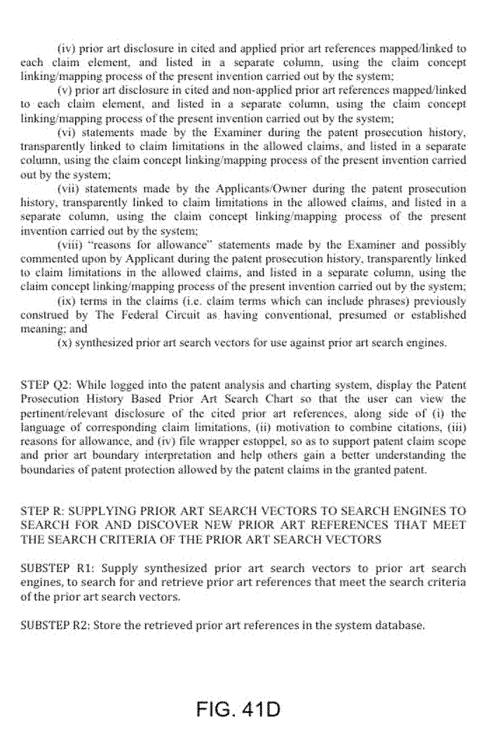

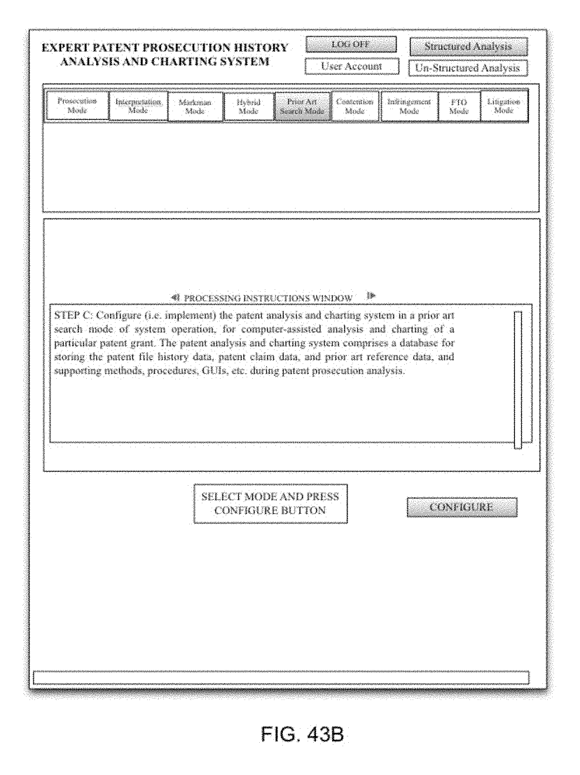

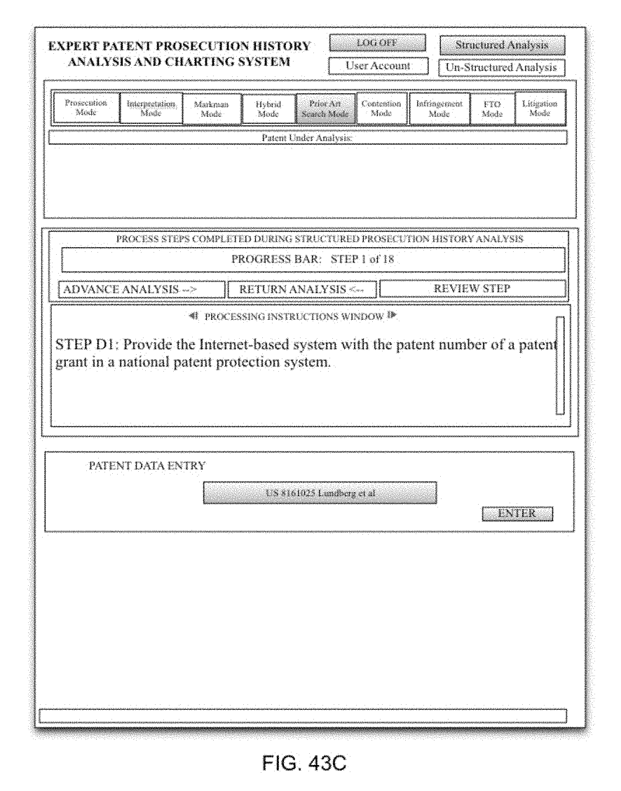

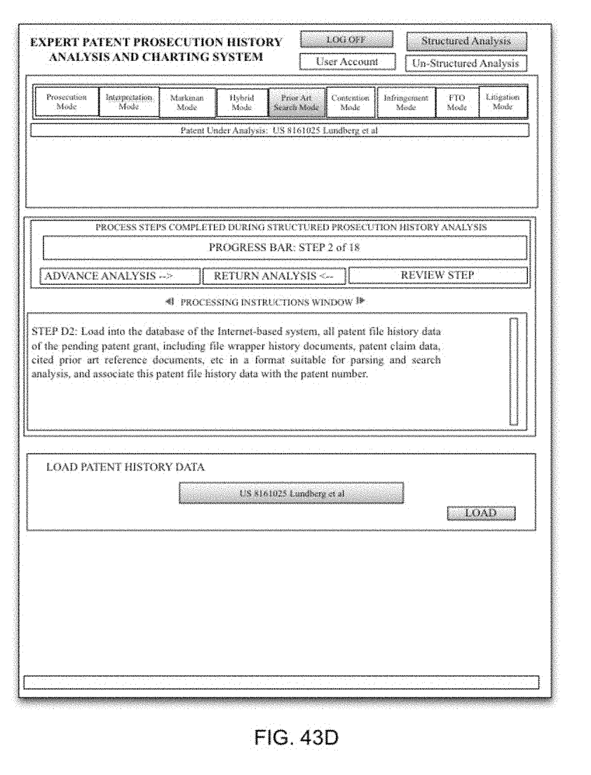

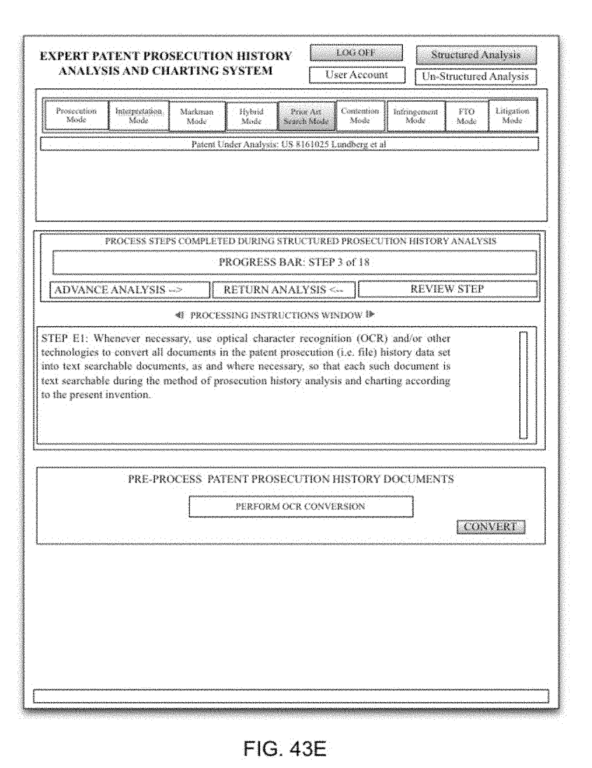

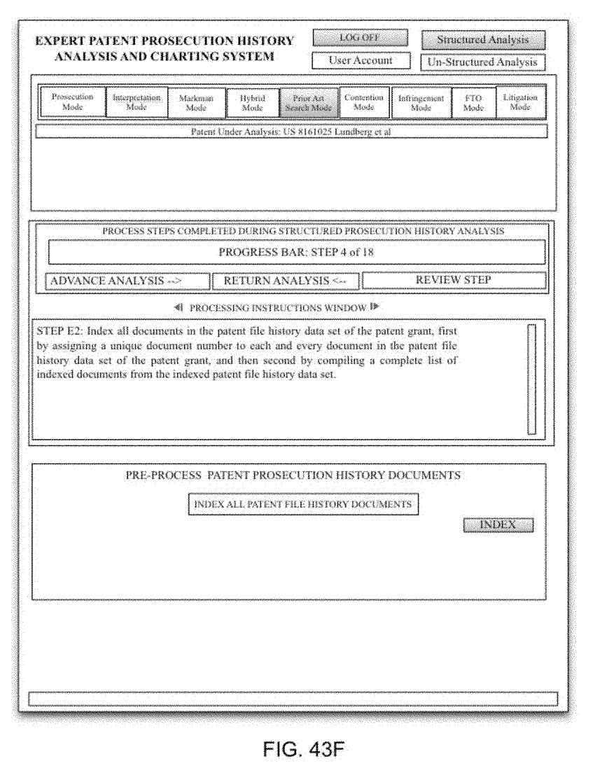

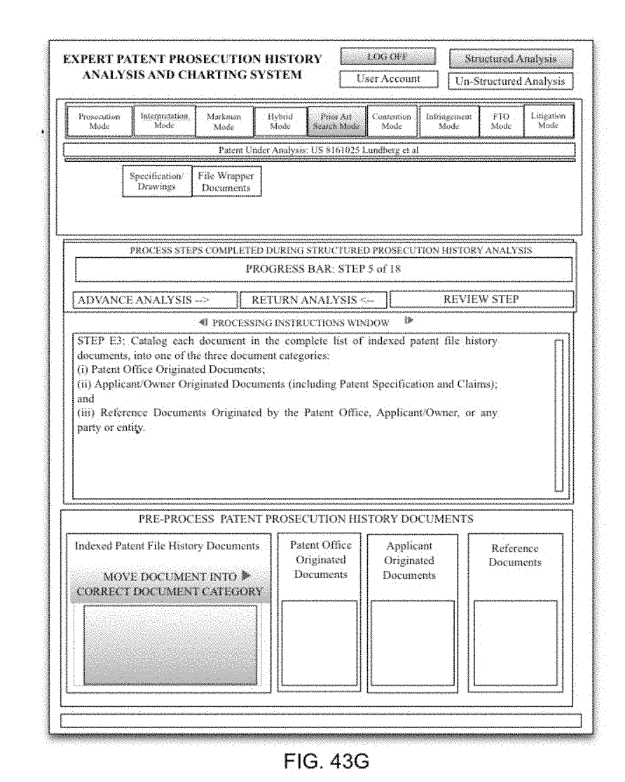

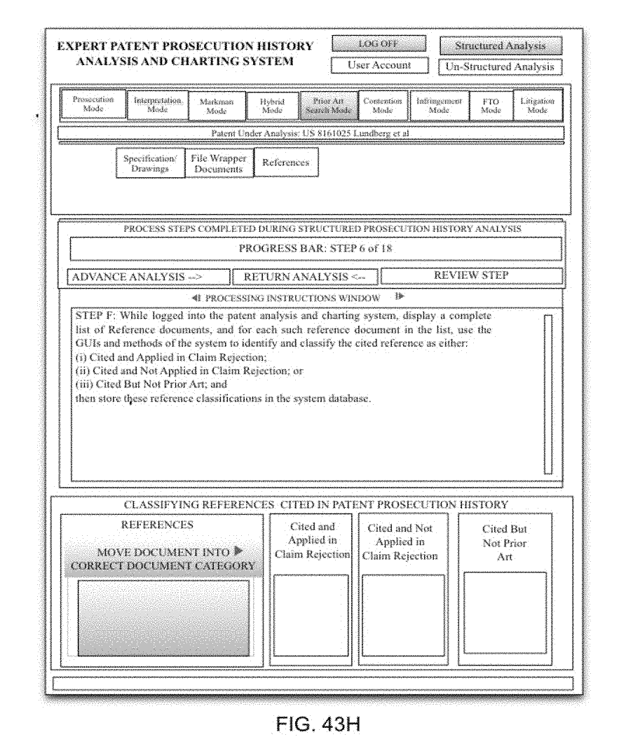

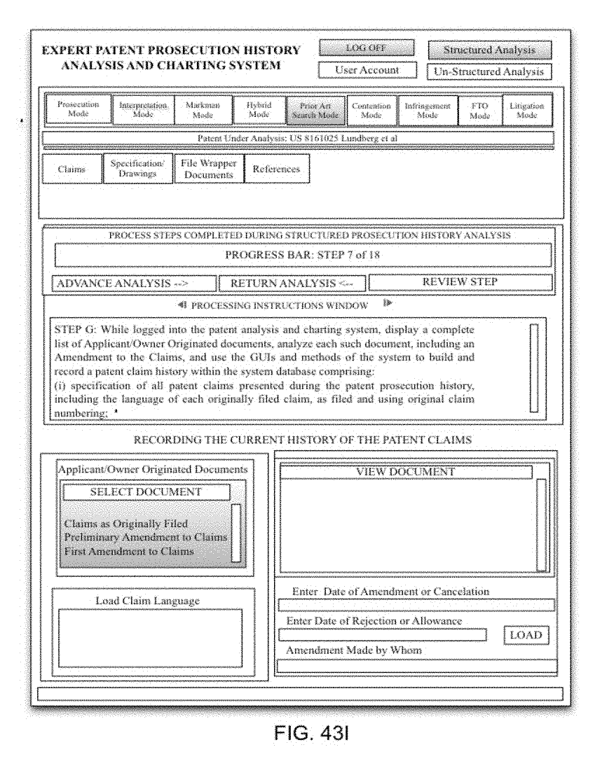

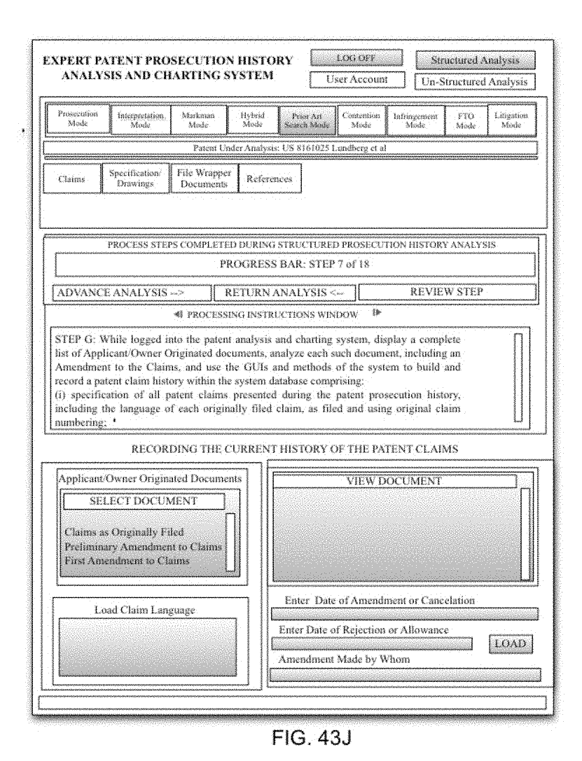

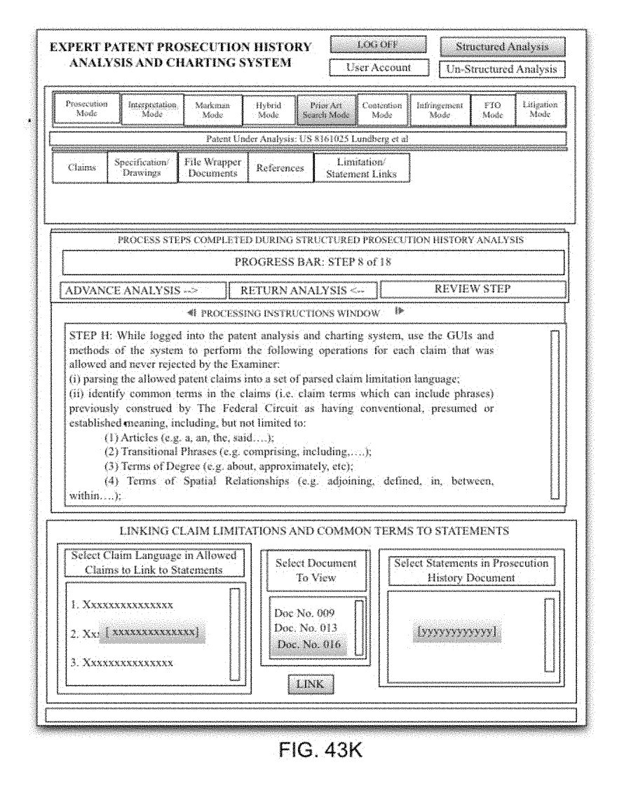

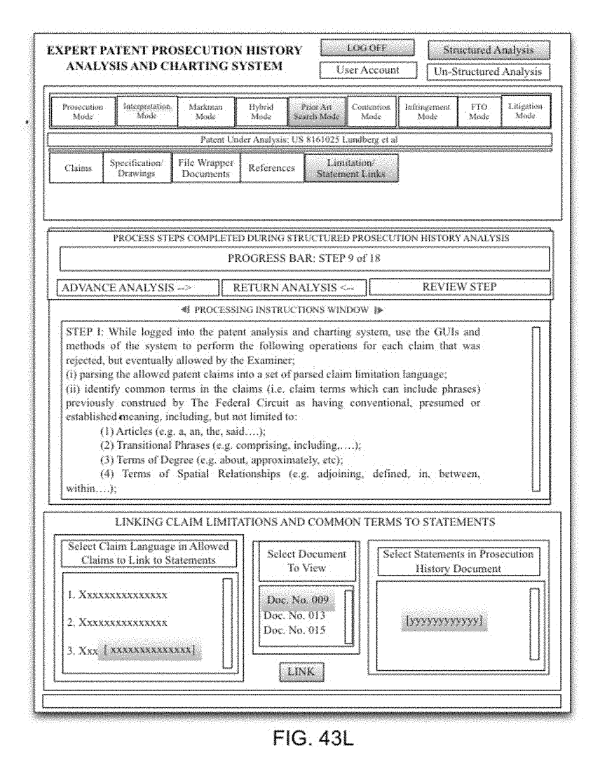

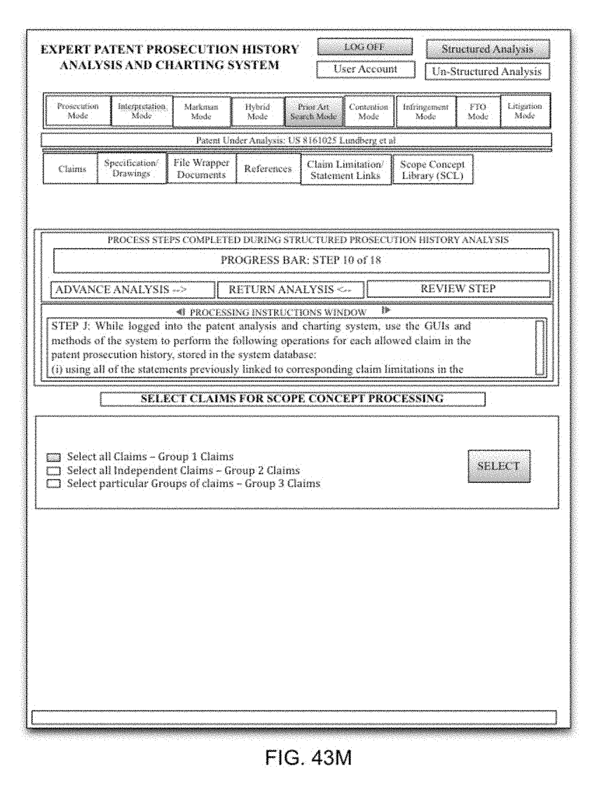

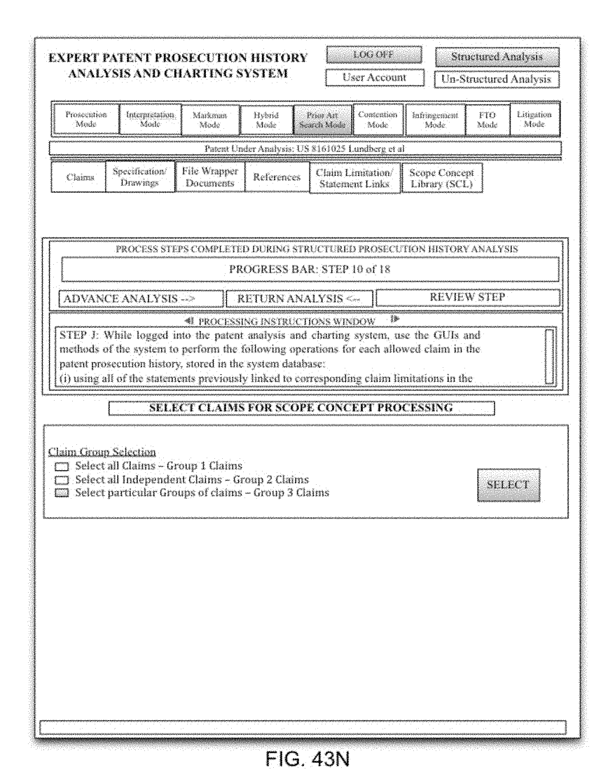

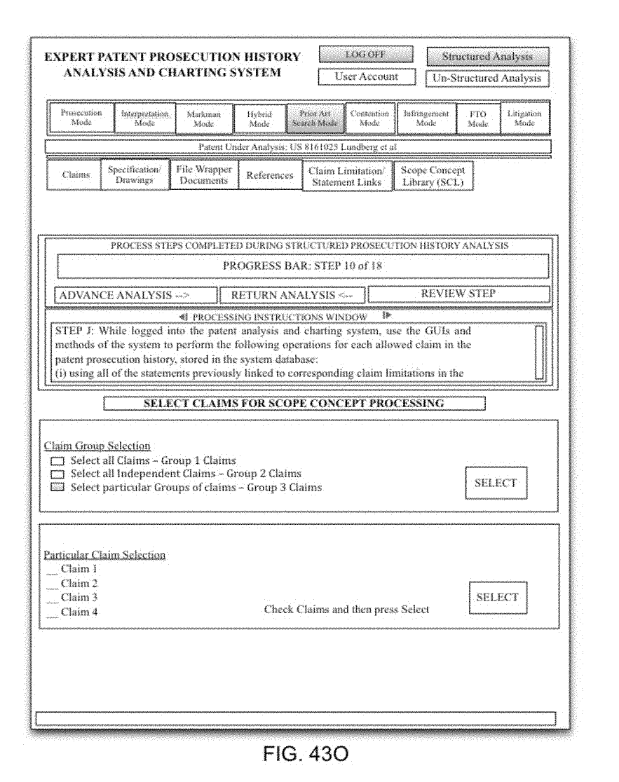

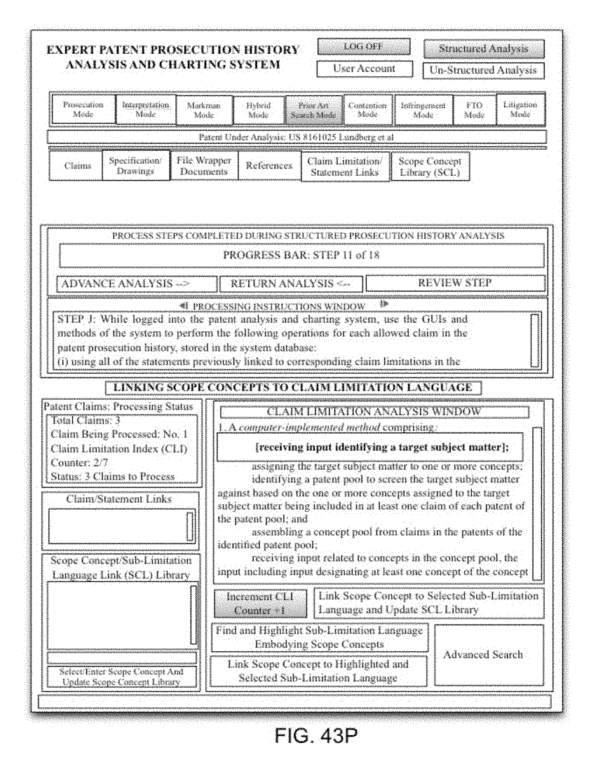

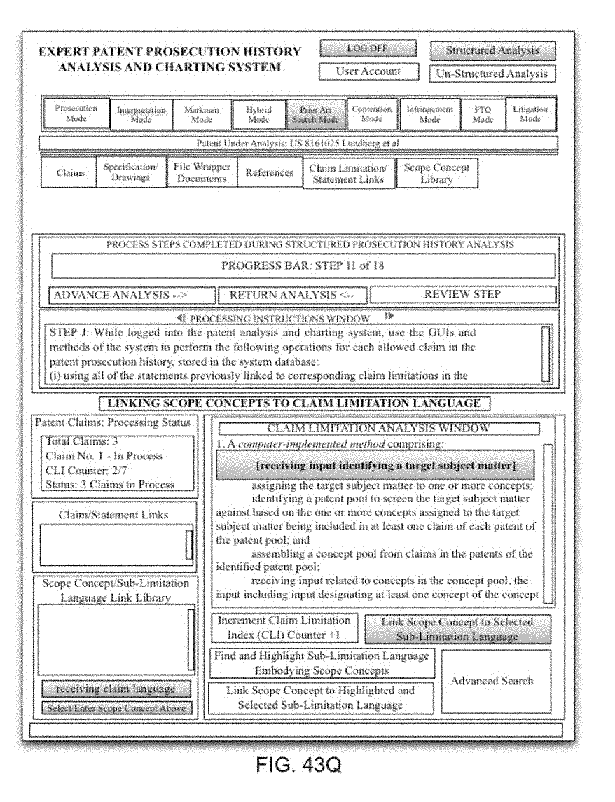

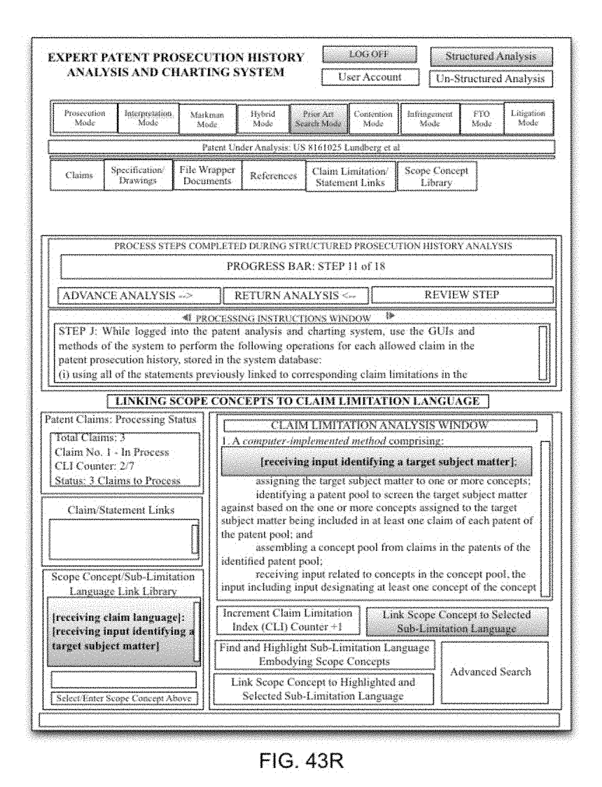

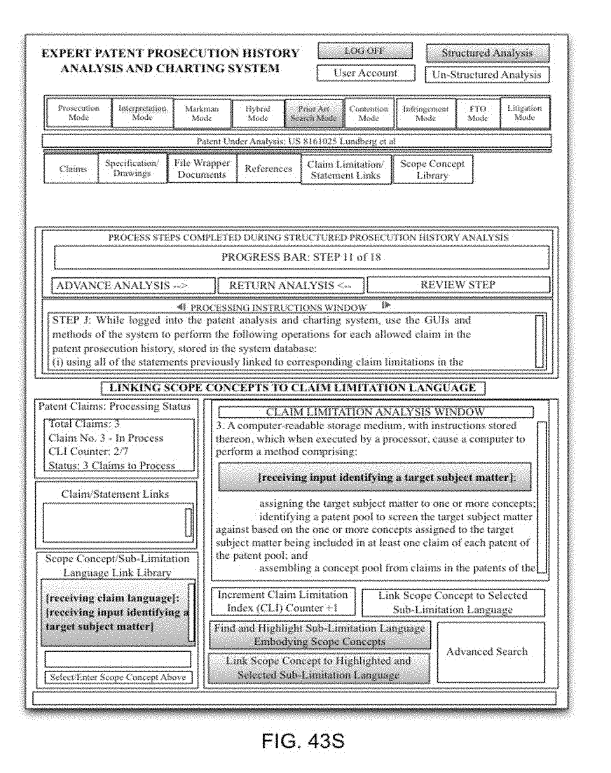

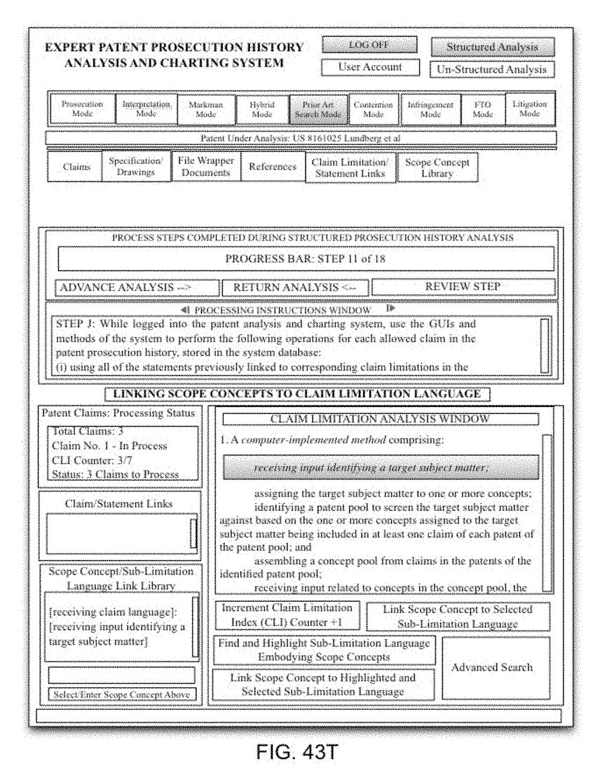

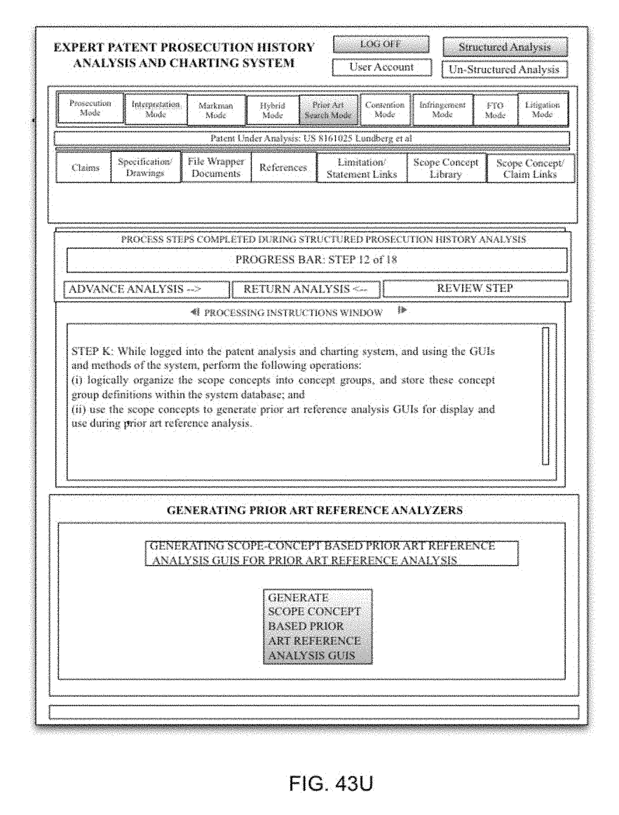

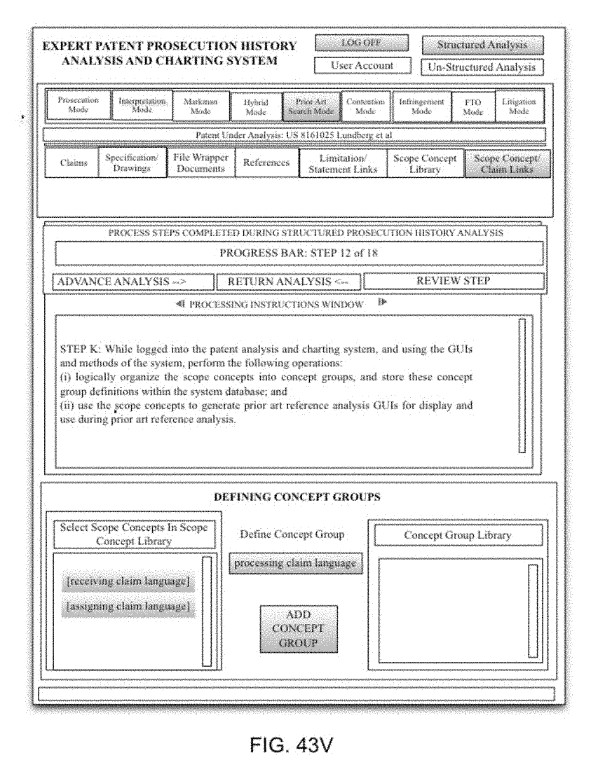

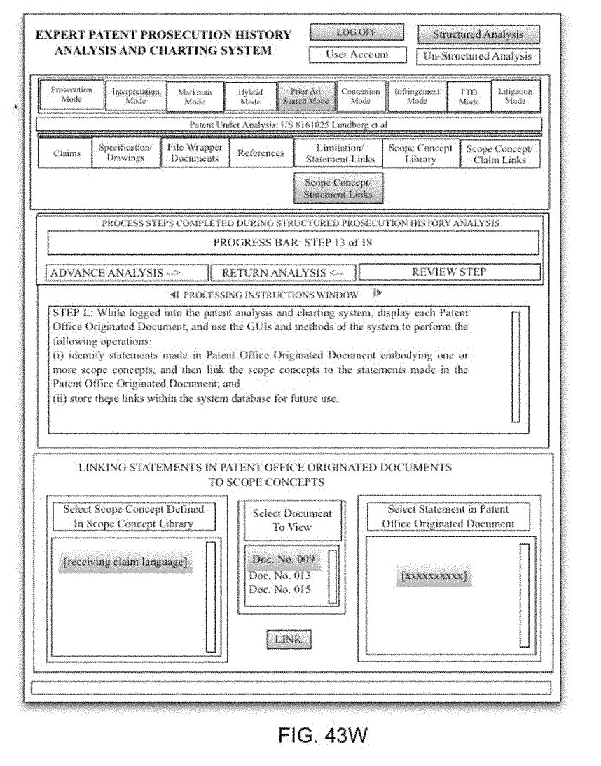

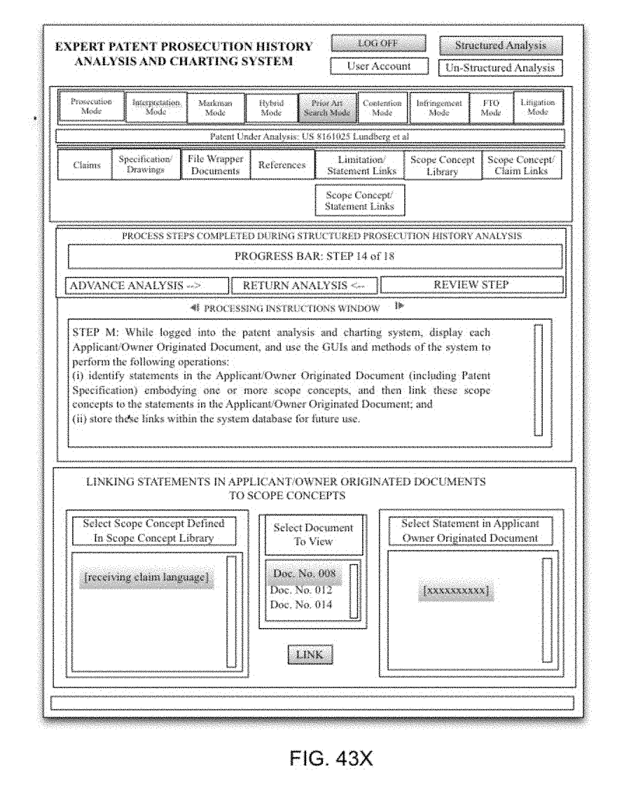

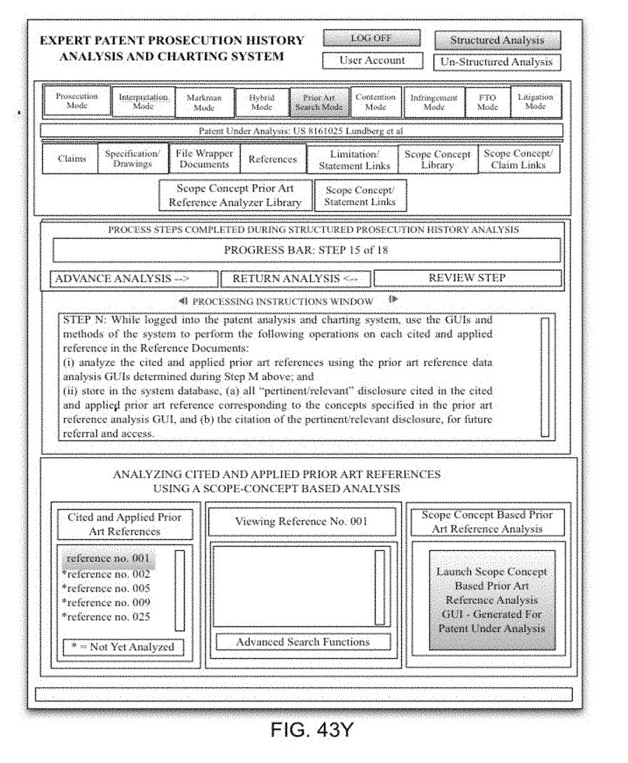

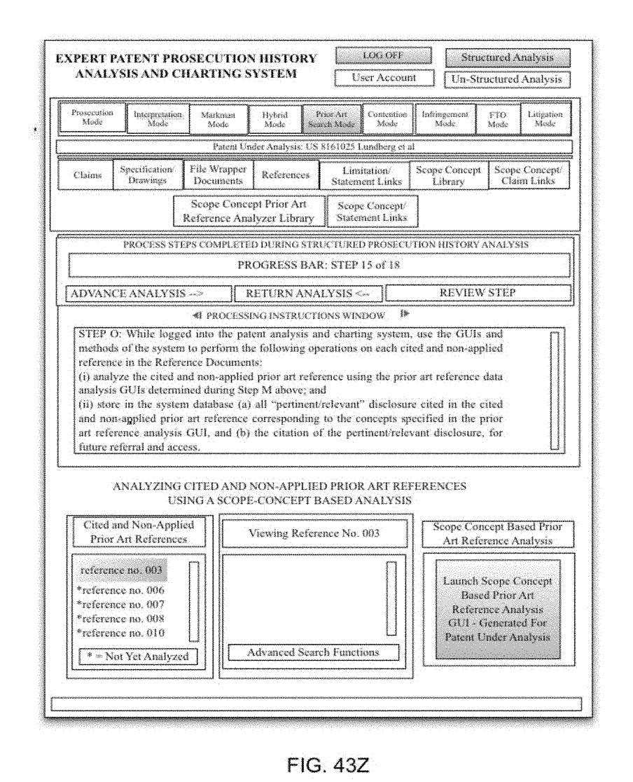

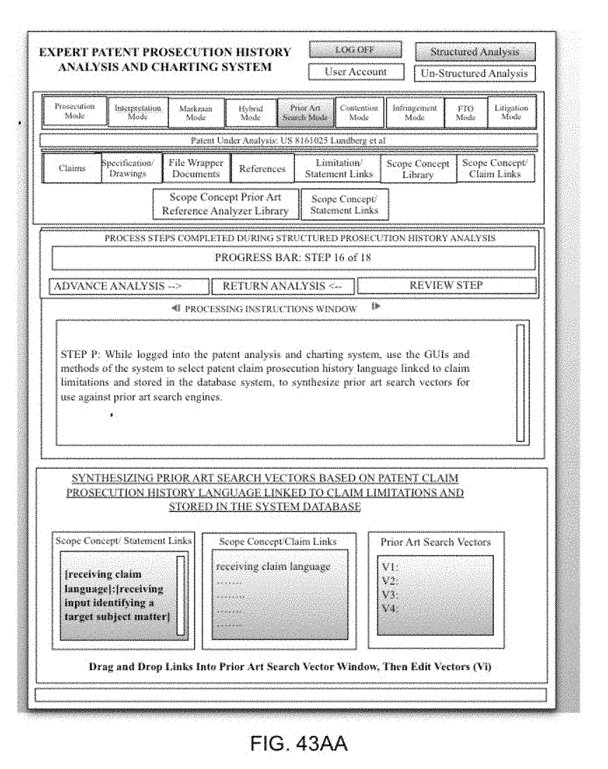

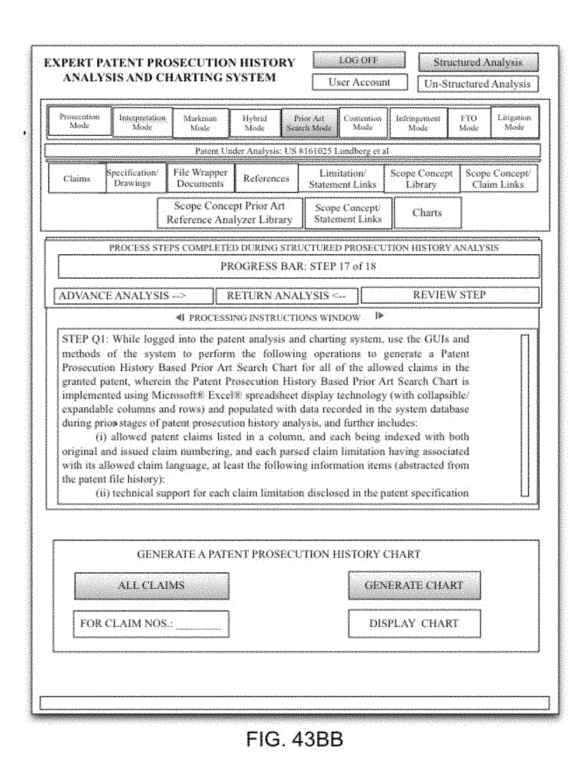

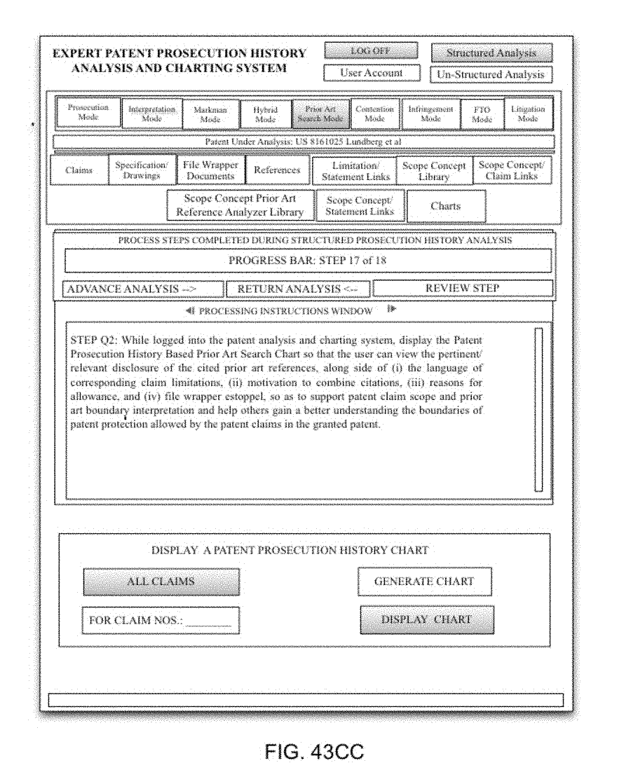

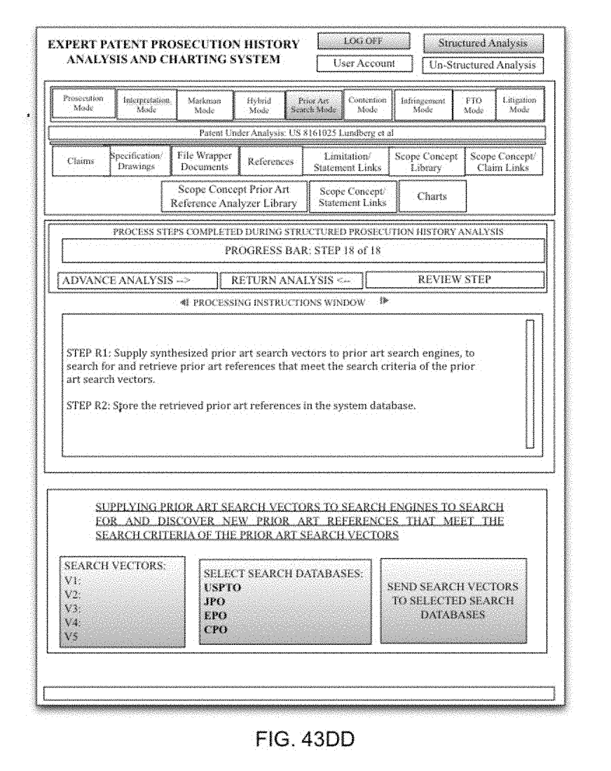

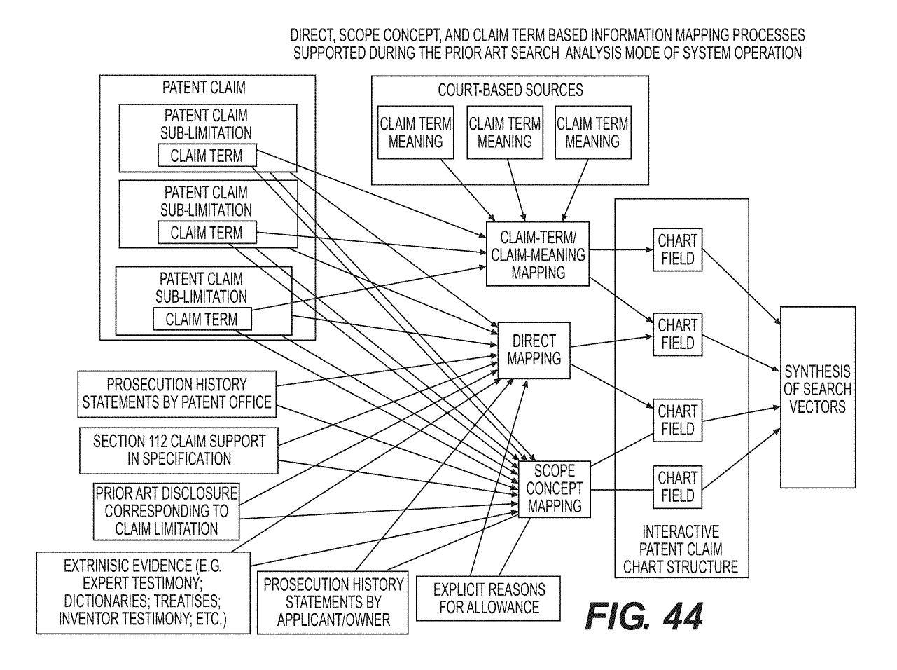

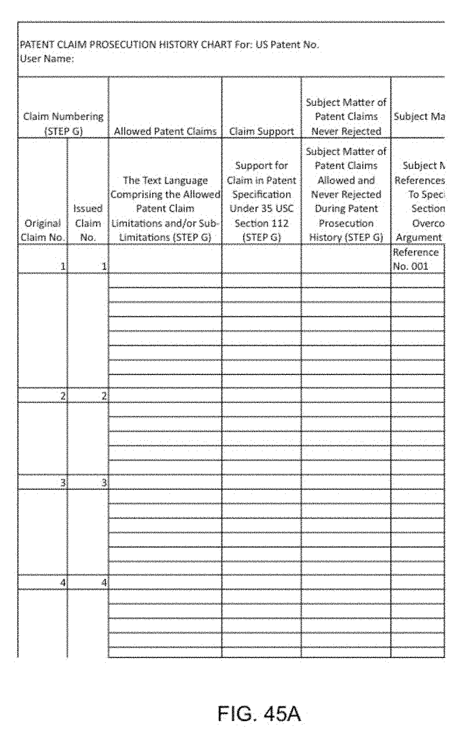

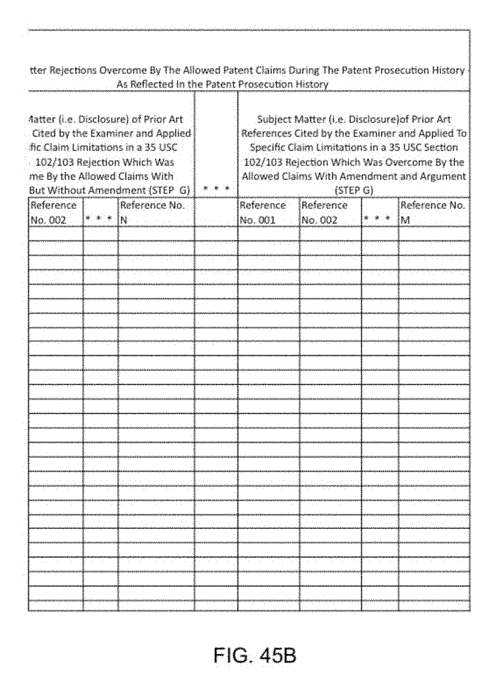

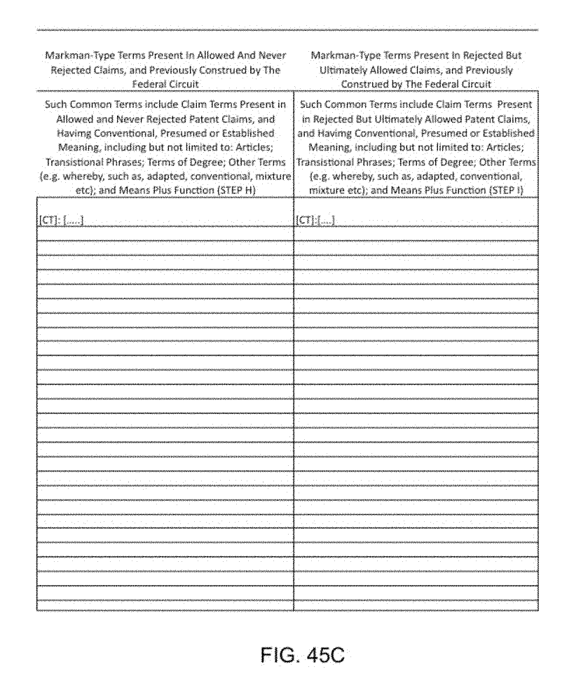

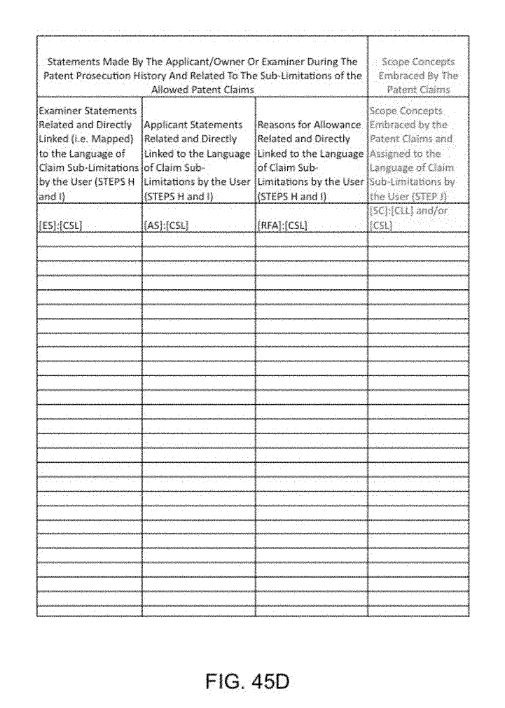

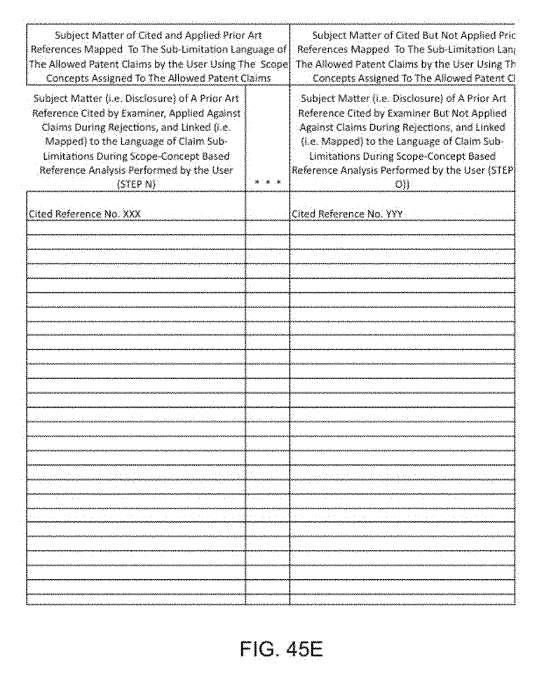

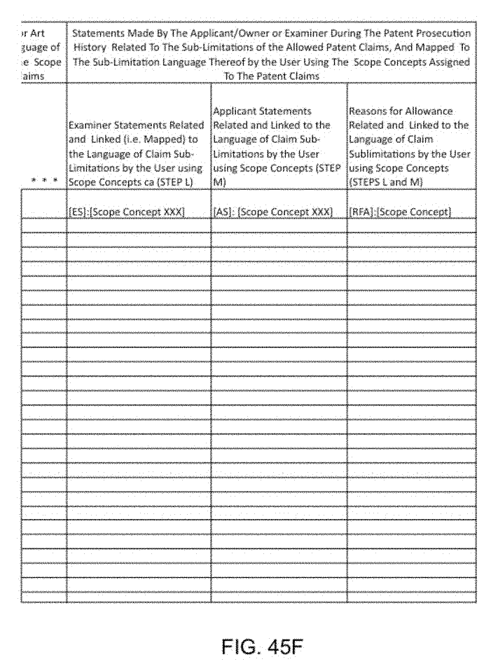

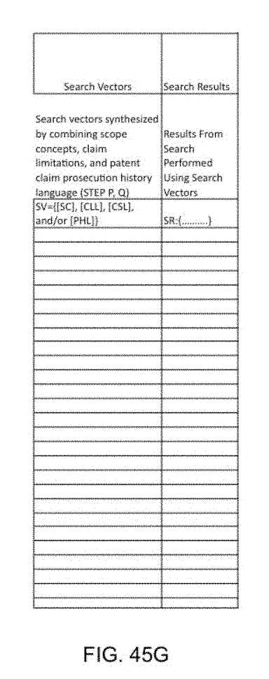

The workflow process specified in FIGS. 41A through 41D will be described now in greater detail with reference to corresponding wireframe GUIs shown in FIGS. 43A through 43EE, and the information mapping process illustrated in FIGS. 40 and 44. Upon completion of the workflow process, the multi-mode system in its the patent claim prosecution mode will automatically generate and display an XML-based spreadsheet-based chart structure as illustrated in FIG. 45A through 45G, that can be used by various users in any given user work group, including patent attorneys, during patent claim scope/boundary interpretation and other analytical efforts.

For presentation purposes only, the XML-based spreadsheet-based chart structure shown in FIGS. 45A through 45G has been broken down into several sections in the figure Drawings. For proper viewing, these figure drawings should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

Method of Analyzing and Charting the Patent Prosecution History of a Granted Patent Using a Patent Analysis and Charting System Configured in a Prior/Present Art Search Analysis Mode of Operation, and Generating Prior Art Search Vectors for Use in Searching for and Discovering New Prior Art References Related to the Subject Matter of the Patent Claims

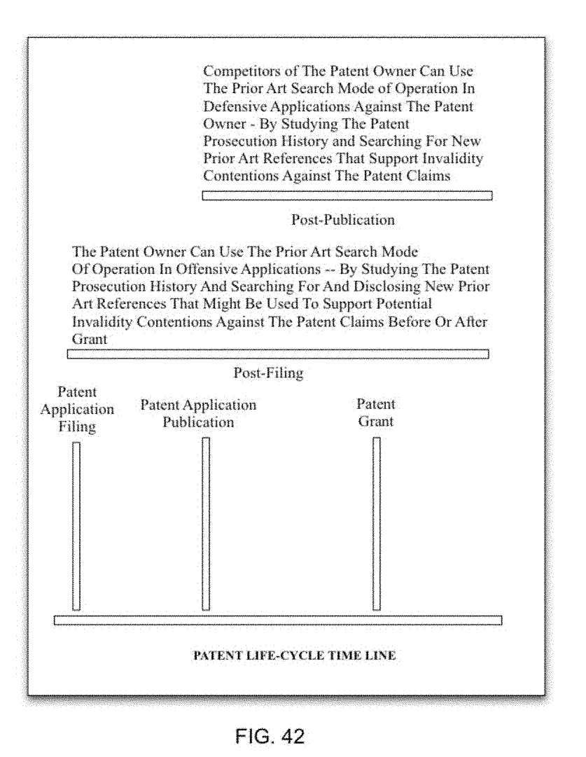

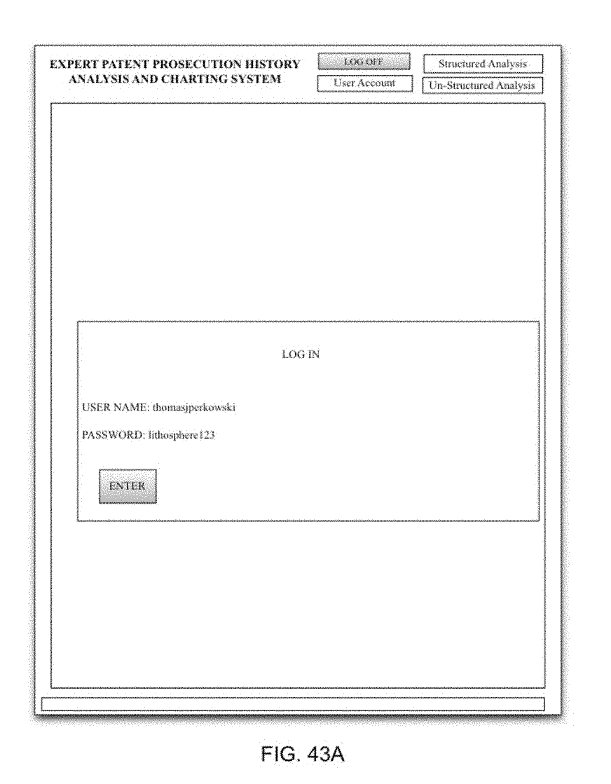

Referring now to the detailed flow chart set forth in FIGS. 41A through 41D, the Internet-based patent analysis and charting system of the present invention configured in its prior/present art search analysis mode of system operation will be now described in detail, and showing how one or more users can efficiently analyze and chart the patent prosecution history of any pending patent application or granted patent, using the wireframe GUI screens set forth in FIGS. 43A through 43EE, the mapping techniques illustrated in FIGS. 40 and 44, and the patent prosecution history based chart structures described in FIGS. 45A through 45G. Various applications for the patent analysis and charting system configured in this mode of operation are illustrated in FIG. 42 and will be described in greater detail hereinbelow.

The steps of the process described in FIGS. 41A through 41D will be described in detail below.

As indicated in Step A in FIG. 41A, Web, application and database servers on a network are used to deploy an Internet-based object-oriented system platform that supports a computer-assisted analysis and charting of the prosecution history of any patent granted in a national patent protection system. As shown in FIG. 5, the network is connected to the network information infrastructure and servers of national patent protection systems, and patent and published patent application depositories containing composite patent file history data documents for granted patents and pending (or abandoned) patent applications.

As indicated in Step B in FIG. 41A, web-enabled client machines are used to allow authorized users to log into the deployed patent analysis and charting system and perform the following operations specified below. As exemplary login GUI screen is shown in FIG. 43A for that purpose. In FIG. 43B, a GUI screen is shown for managing User Account information on the platform.

As indicated in Step C in FIG. 41A, the user employs a GUI as shown in FIG. 43B to configure the patent analysis and charting system in its prior/present art search analysis mode of system operation, for computer-assisted analysis and charting of a particular patent application, prior to patent grant. In general, the patent analysis and charting system comprises a database for storing the patent file history data, patent claim data, and prior art reference data, and supporting methods, procedures, GUIs, etc. during patent prosecution analysis. The purpose of this step in the process is to select the mode of system operation to be configured on the system platform of the present invention.

As indicated in Step D in FIG. 41A, the user employs a GUI screen as shown in FIG. 43C, to provide the Internet-based system with the patent number of the patent granted in a national patent protection system. Then, using a GUI screen as shown in FIG. 43D, all patent file history data of the granted patent, including file wrapper history documents, patent claim data, cited prior art reference documents, etc., are uploaded from patent servers shown in FIG. 5 into the database 15 of the Internet-based system, in a format suitable for parsing and search analysis, and associate this patent file history data with the patent application serial number.

As indicated in Substep E1 in FIG. 41A, a GUI screen as shown in FIG. 43E is employed so that, whenever necessary, the system uses optical character recognition (OCR) and/or other technologies to convert all documents in the patent prosecution (i.e. file) history data set into text searchable documents, as and where necessary, so that each such document is text searchable during the method of prosecution history analysis and charting according to the present invention.

As indicated in Substep E2 in FIG. 41A, a GUI screen as shown in FIG. 43F is employed so that all documents in the patent file history data set of the granted patent are indexed by first assigning a unique document number to each and every document in the patent file history data set of the patent application, and then second by compiling a complete list of indexed documents from the indexed patent file history data set.

As indicated in Substep E3 in FIG. 41A, a GUI screen as shown in FIG. 43G is employed so that each document in the complete list of indexed patent file history documents, is cataloged into one of the three document categories: (i) Patent Office Originated Documents; (ii) Applicant/Owner Originated Documents (including Patent Specification and Claims); and (iii) Reference Documents Originated by the Patent Office, Applicant/Owner, or any party or entity.

As indicated in Step F in FIG. 41A, a GUI screen as shown in FIG. 43H is employed so that, while logged into the patent analysis and charting system, the system displays a complete list of Reference Documents, and for each such reference document in the list, the user uses the GUIs and methods of the system to identify and classify the cited reference as either: (i) cited and applied in claim rejection; (ii) cited and not applied in claim rejection; or (iii) cited but not prior art; and then store these reference classifications in the system database

As indicated in Step G in FIG. 41B, GUI screens as shown in FIGS. 431 and 43J are employed, so that the system enables the recording of the current history of the patent claims in the system database, including a concise status of patent claims, patent claim amendments, and patent claim examination during the patent prosecution history of the patent application. In the illustrative embodiment, this is achieved as follows. As shown, while logged into the patent analysis and charting system, the system displays a complete list of Applicant/Owner Originated documents, and then each such document, including an Amendment to the Claims is analyzed by the user using the GUIs and methods of the system so as to build and record a patent claim history (PCH) within the system database 15.

In the illustrative embodiment, the patent claim history comprises:

(i) specification of all patent claims presented during the patent prosecution history, including the language of each originally filed claim, as filed and using original claim numbering;

(ii) specification of the date each patent claim was amended and/or canceled, voluntarily, and not in response to an examiner's claim rejection;

(iii) specification of which patent claims were allowed without rejection, and specify the date of allowance and the Examiner who made the allowance;

(iv) specification of which claims were rejected, identify the statutory basis of each such rejection (e.g. 35 USC Section 102 and/or 103) and prior art references upon which the claim rejection was made, and specify the date of the claim rejection and the Patent Examiner who made the rejection;

(v) specification of the language of each claim amendment, identify when the amendment was made and by whom (i.e. using USPTO Attorney/Agent Registration Number for registered agents and attorneys, and Applicant's name for pro se applications);

(vi) specification of which claims where allowed after rejection in response to an argument for patentability and request for reconsideration, and a specification of the language of each such allowed claim; and

(vii) specification of which claims where allowed after rejection in response to an argument for patentability, an amendment to the claims, and a request for reconsideration, and a specification of the language of each such allowed claim.

As indicated in Step H in FIG. 41B, a GUI screen as shown in FIG. 43K is employed, so that the user can link examiner and/or applicant statements made during the patent prosecution history to the limitations, sub-limitations and/or common terms of allowed and never rejected patent claims, and then store each link in the system database.

Specifically, while logged into the patent analysis and charting system, the user uses the GUIs and methods of the system to perform the following operations for each claim that was allowed and never rejected by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure (e.g. searchable text and/or searchable graphics and/or images) found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

As indicated in Step I in FIG. 41B, a GUI screen as shown in FIG. 43L is employed, so that the user can link examiner and/or applicant statements made during the patent prosecution history to the limitations, sub-limitations and/or common terms of rejected but ultimately allowed patent claims, and storing each link in the system database.

Specifically, while logged into the patent analysis and charting system, the user uses the GUIs and methods of the system to perform the following operations for each claim that was rejected, but eventually allowed by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure (e.g. searchable text and/or searchable graphics and/or images) found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

As indicated in Step J in FIG. 41B, GUI screens as shown in FIGS. 43M through 37U are employed, so that the user can define and formulate scope concepts based on analysis of stored links, then link claim limitation language of each allowed patent claim to one or more scope concepts, and ultimately store each scope concept and link in the system database. Specifically, while logged into the patent analysis and charting system, the user uses the GUIs and methods of the system to perform the following operations for each allowed claim in the patent prosecution history, stored in the system database:

(i) display the allowed patent claims using final patent numbering, or any selected group of claims (e.g. all claims, all independent claims, or a particular subset of claims);

(ii) using the statements previously linked to corresponding claim limitations in the allowed patent claim, identify and formulate one or more scope concepts expressed in and/or embraced by or embodied within the claim limitation language of each allowed patent claim, and store these scope concepts in the system database;

(iii) for each claim limitation, link a scope concept to the corresponding language of the claim sub-limitation that supports the scope concept and store these claim limitation/scope concept links in the system database; and

(iv) repeat step (iii) above for each claim limitation, as necessary to capture essential scope concepts embodied within the allowed claim.

The scope concept formulation, assignment and linkage method described in FIGS. 24 through 26 can be used to practice Step J of this method of patent claim analysis supported by the system of the present invention.

As indicated in Step K in FIG. 41B, GUI screens as shown in FIGS. 43V and 43W are employed, so that the user can define concept groups and store them in the system database and generate scope concept based prior art reference analysis GUIs as shown in FIG. 26C for use during prior art reference analysis. Specifically, while logged into the patent analysis and charting system, and using the GUIs and methods of the system, the user performs the following operations: (i) logically organizes the scope concepts into concept groups, and stores these concept group definitions within the system database; and (ii) uses the scope concepts to define prior art reference analysis GUIs for display and use during prior art reference analysis.

As indicated in Step L in FIG. 41B, a GUI screen as shown in FIG. 43X is employed, so that the user can link statements in patent office originated documents to one or more scope concepts defined above, and then store each link in the system database. Specifically, while logged into the patent analysis and charting system, display each Patent Office Originated Document, and use the GUIs and methods of the system to perform the following operations: (i) identify statements made in Patent Office Originated Document embodying one or more scope concepts, and then link the scope concepts to the statements made in the Patent Office Originated Document; and (ii) store these links within the system database for future use.

As indicated in Step M in FIG. 41B, a GUI screen as shown in FIG. 43Y is employed, so that the user can link statements in Applicant/Owner originated documents to one or more scope concepts defined above, and store each link in the system database. Specifically, while logged into the patent analysis and charting system, display each Applicant/Owner Originated Document, and use the GUIs and methods of the system to perform the following operations: (i) identify statements in the Applicant/Owner Originated Document (including Patent Specification) embodying one or more scope concepts, and then link these scope concepts to the statements in the Applicant/Owner Originated Document; and (ii) store these links within the system database for future use.

As indicated in Step N in FIG. 41C, a GUI screen as shown in FIG. 43Z is employed, so that the user can analyze cited and applied prior art references using the scope concept based prior art reference analysis GUIs, and store the analysis in the system database. Specifically, while logged into the patent analysis and charting system, use the GUIs and methods of the system to perform the following operations on each cited and applied reference in the Reference Documents: (i) analyze the cited and applied prior art references using the prior art reference data analysis GUIs determined during Step M above; and (ii) store in the system database, (a) all “pertinent/relevant” disclosure cited in the cited and applied prior art reference corresponding to the concepts specified in the prior art reference analysis GUI, and (b) the citation of the pertinent/relevant disclosure, for future referral and access.

As indicated in Step O in FIG. 41C, a GUI screen as shown in FIG. 43AA is employed, so that the user can analyze cited and non-applied prior art references using the scope concept based prior art reference analysis GUIs, and store the analysis in the system database. Specifically, while logged into the patent analysis and charting system, use the GUIs and methods of the system to perform the following operations on each cited and non-applied reference in the Reference Documents: (i) analyze the cited and non-applied prior art reference using the prior art reference data analysis GUIs determined during Step M above; and (ii) store in the system database (a) all “pertinent/relevant” disclosure cited in the cited and non-applied prior art reference corresponding to the concepts specified in the prior art reference analysis GUI, and (b) the citation of the pertinent/relevant disclosure, for future referral and access.

As indicated in Step P in FIG. 41C, GUI screens as shown in FIGS. 43BB and 37BB are employed, so that the user can easily synthesize search vectors, based on patent claim prosecution history language linked to claim limitations, and then store these search vectors in the system database. Specifically, while logged into the patent analysis and charting system, use the GUIs and methods of the system to select scope concept definitions and patent claim prosecution history language linked to claim limitations and stored in the database system, to synthesize search vectors for use against prior art search engines. Automated methods for scope concept based search vector based searching, and prior art reference retrieval, tagging and mapping to corresponding scope concept query fields in scope concept based prior art reference analysis GUIs will be described in great technical detail below, after description of the workflow process of Mode 4.

As indicated in Step Q in FIG. 41C, GUI screens as shown in FIGS. 43CC and 43DD are employed, so that the user can generate and display a patent prosecution history based prior art search chart for the selected allowed claims in the granted patent. Specifically, during Substep Q1, while logged into the patent analysis and charting system, the user uses the GUI of FIG. 43CC and methods of the system to generate a claim scope schema (CSS) prior art search chart for all of the allowed claims in the granted patent. The CSS prior art search chart is implemented using Microsoft® Excel® spreadsheet display technology (with collapsible/expandable columns and rows) and populated with data recorded in the system database during prior stages of patent prosecution history analysis.

As shown in FIGS. 45A through 45G, the patent prosecution history based prior art search chart comprises data fields for presenting graphical representations of the following graphical objects:

(i) the text language comprising the allowed patent claim limitations and sub-limitations (Step G) listed in a column, and each being indexed with both original and issued claim numbering, and each parsed claim limitation having associated with its allowed claim language, at least the following information items (abstracted from the patent file history):

(ii) technical support for each claim limitation disclosed in the patent specification under 35 USC Section 112 (Step G) listed in a separate column (can be generated automatically by the system);

(iii) subject matter (language) of patent claims allowed and never rejected during patent prosecution history (Step G);

(iv) subject matter rejections overcome by the allowed patent claims during the patent prosecution history—as reflected in the patent prosecution history—including a concise statement of each prior art rejection (e.g. Section 101, 102, and/or 112) or rejection combinations (e.g. Section 103) made by Examiner and overcome by Applicant(s) listed in a separate column;

subject matter (i.e. disclosure) of prior art references cited by the examiner and applied to specific claim limitations in a 35 USC Section 102/103 rejection which was overcome by the allowed claims with argument but without amendment (Step G);

subject matter (i.e. disclosure) of prior art references cited by the examiner and applied to specific claim limitations in a 35 USC Section 102/103 rejection which was overcome by the allowed claims with amendment and argument (Step G);

(v) Markman-type terms present in allowed and never rejected claims, and previously construed by the Federal Circuit—such common terms including claim terms present in allowed and never rejected patent claims, and having conventional, presumed or established meaning, including but not limited to: articles, transitional phrases, terms of degree, other terms (e.g. whereby, such as, adapted, conventional, mixture etc), and means plus function (Step H);

(vi) Markman-type terms present in rejected but ultimately allowed claims, and previously construed by the Federal Circuit—such common terms including claim terms present in rejected but ultimately allowed patent claims, and having conventional, presumed or established meaning, including but not limited to: articles, transitional phrases, terms of degree, other terms (e.g. whereby, such as, adapted, conventional, mixture etc), and means plus function (Step I);

(vii) examiner statements related and directly linked (i.e. mapped) to the language of claim sub-limitations by the user (Steps H and I);

(viii) applicant statements related and directly linked to the language of claim sub-limitations by the user (Step H and I);

(ix) reasons for allowance related and directly linked to the language of claim sub-limitations by the user (Steps H and I);

(x) scope concepts embraced by the patent claims and assigned to the language of claim sub-limitations by the user (Step J);

(xi) subject matter of cited and applied prior art references mapped to the sub-limitation language of the allowed patent claims by the user during scope concept based reference analysis performed by the user and using the scope concepts assigned to the allowed patent claims (Step N);

(xii) subject matter of cited but not applied prior art references mapped to the sub-limitation language of the allowed patent claims by the user during scope concept based reference analysis performed by the user and using the scope concepts assigned to the allowed patent claims (Step O);

(xiii) statements made by the examiner during the patent prosecution history, transparently linked to claim sub-limitations in the allowed claims, and listed in a separate column, using the claim concept linking/mapping process of the present invention carried out by the system (Step L);

(xiv) statements made by the applicants/owner during the patent prosecution history, transparently linked to claim sub-limitations in the allowed claims, and listed in a separate column, using the claim concept linking/mapping process of the present invention carried out by the system (Step M);

(xv) “reasons for allowance” statements made by the examiner and possibly commented upon by applicant during the patent prosecution history, transparently linked to claim sub-limitations in the allowed claims, and listed in a separate column, using the scope concept linking/mapping process of the present invention carried out by the system (Steps L and M); and

(xvi) search vectors synthesized by combining scope concepts, claim limitations, and patent claim prosecution history language (Steps P, Q), as required to discover relevant prior art disclosure (e.g. searchable text and/or searchable graphics and/or images) that substantiates or otherwise discloses, teaches or suggests the subject matter of the claim limitation language string (CSS) for which the search vectors have been formulated.

During the patent claim understanding/interpretation process, the claim scope schema (CSS) structure, comprising all information from the patent prosecution history linked together by claim scope concepts (CSC) and contained within the spreadsheet-type chart structure, functions as a framework that helps organize information relating to the scope and meaning of any allowed patent claim represented in the chart structure, to assist anyone interested in better understanding the scope and boundaries offered by allowed patent claims.

During Substep Q2, while logged into the patent analysis and charting system, and using the GUI screen shown in FIG. 43DD, the user displays the CSS-based search chart structure so that the he or she can view the pertinent/relevant disclosure of the cited prior art references, along side of (i) the language of corresponding claim limitations, (ii) motivation to combine citations, (iii) reasons for allowance, and (iv) file wrapper estoppel, so as to support patent claim scope and prior art boundary interpretation and help others gain a better understanding the boundaries of patent protection allowed by the patent claims in the granted patent. At this stage, the user may add notes to provided read/write note fields, as well as modify the search vector fields, as desired or required.

The XML-based chart structure can be uploaded back to the system database using XML techniques described hereinbefore if the chart structure has been downloaded as a file stored on a client machine, or instantly uploaded if the chart structure is displayed on a client machine using the system servers.

As indicated in Step R in FIG. 41D, the GUI screen as shown in FIG. 43EE is employed, so that search vectors can be supplied to search engines to search for and discover new prior art references that meet the search criteria of the search vectors. Specifically, during Substep R1, the synthesized search vectors are supplied to prior art search engines, to search for and retrieve prior art references that meet the search criteria of the search vectors. Then during Substep R2, the retrieved prior art references are stored in the system database.

FIG. 42 illustrates the application of the multi-mode patent analysis and charting system configured in its prior/present art search analysis mode of system operation, and deployed during particular phases of the patent life-cycle time line, by both the patent owner and its competitors. In particular, the competitors can use the prior/present art search analysis mode of operation in defensive applications against the patent owner, namely, by studying the patent prosecution history and searching for new prior art references that support claim invalidity contentions against the allowed patent claims of the granted patent. Also, the patent owners can use the prior/present art search analysis mode of operation in offensive applications, by studying the patent prosecution history and searching for and disclosing new prior art references during post grant proceeding, reexaminations etc, that might be otherwise used by competitors to support potential claim invalidity contentions against the patent claims before or after patent grant, as the case may be.

The multi-mode patent analysis and charting system of the present invention, when configured in its prior art search mode (Mode 4) described above, can be readily adapted to provide a novel prior/present art searching system, employing advanced search methods, described above, having the capacity to (i) generate patent prosecution history based search vectors for use in searching for prior art information on patents, patent application publications, companies, products, services and people related to the subject matter of a set of patent claims under investigation, and (ii) generate detailed prior art search reports based on such search efforts.

Also, the multi-mode patent analysis and charting system of the present invention, when configured in its present art search mode (Mode 4) described above, also can be readily adapted to provide a novel patent opportunity prospecting system, employing advanced search methods having the capacity to (i) generate patent prosecution history (PPH) based search vectors for use in “present art” searching for news and present art information on companies, products, services and people related to the subject matter of a set of patent claims under investigation, and (ii) generate present art search reports based on such search efforts. Notably, the generation of PHH-based search vectors will include claim scope concepts (CSCs) and others terms, phrases and words abstracted during prosecution history analysis.

### Automated Methods for Claim Scope Concept (CSC) Based Search Vector Based Searching, and Prior Art Reference Retrieval, Tagging and Mapping to Corresponding Scope Concept Query Fields in Scope Concept Based Prior Art Reference Analysis GUIs

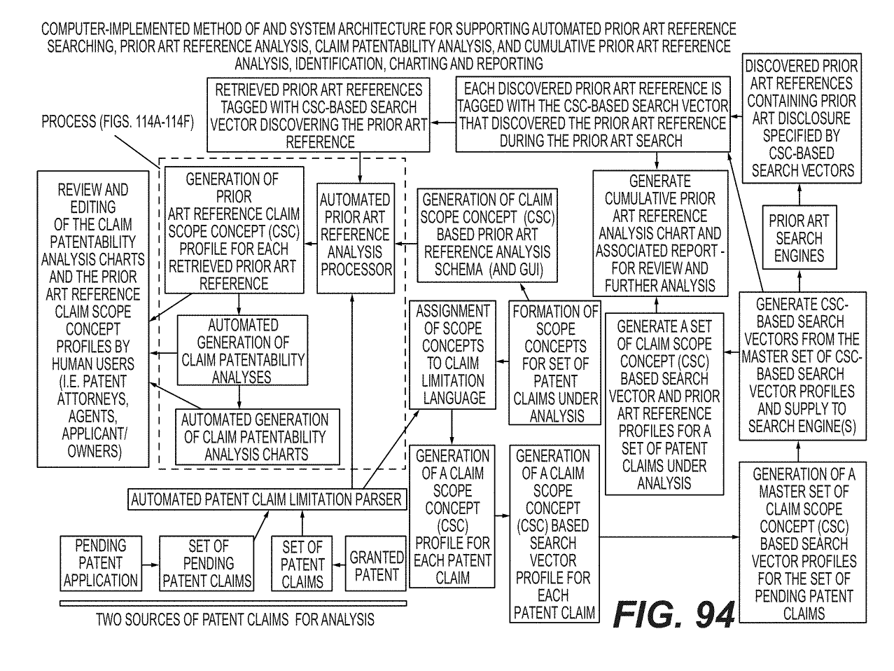

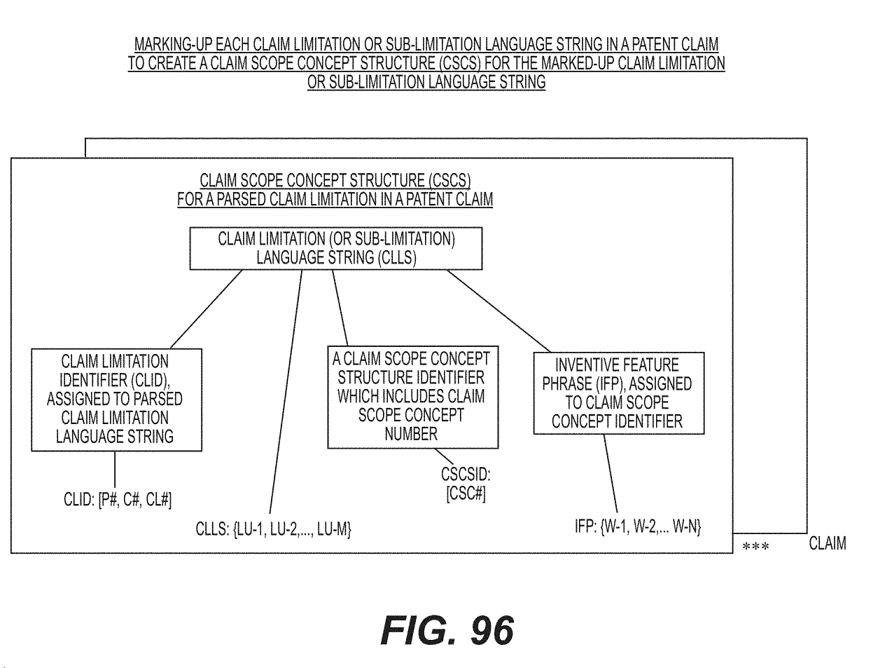

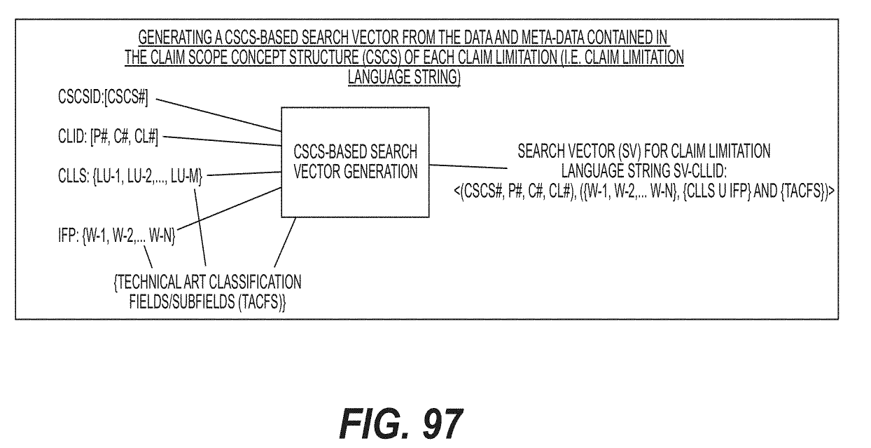

Once a set of patent claims have been scope concept analyzed (e.g. indexed or marked-up with claim scope concepts) in accordance with the principles of the present invention, CSC-based search vectors can be derived for each corresponding set of scope concepts assigned to particular parsed claim limitation and/or sub-limitation language strings in any given patent claim. FIGS. 96 and 97 illustrate CSC-based search vector generation for the system of FIG. 94, wherein the claim scope concept structure (CSCS) schema of FIG. 93 is employed during claim scope concept mark-up or indexing. In the search analysis mode of the system (i.e. mode 4), such claim scope concept indexing techniques can be used, as well as the method described in FIGS. 25A through 26D.

Once a given set of claims have been scope concept indexed or marked-up, and then CSC-based search vectors have been generated, the system can programmatically (i.e. automatically) initiate and manage prior art or present art searching, across patent and technical databases, as well as anywhere along the Web, using the CSC-based search vectors generated for the scope concept indexing patent claims.

Then, in response to the search, prior art reference documents will be retrieved and then tagged with scope concept based search vector tags. These claim scope concept (CSC) based search vectors, can be formulated as CSC-based search vector tags, which can be then used in several ways: (1) automatically (i.e. programmatically) map the retrieved prior art references to corresponding scope concept query fields in the Scope Concept Based Prior Art Reference Analysis GUI, as shown in FIG. 26C, so human subject matter experts can review the prior art disclosure contained in these prior art references, and select which prior art references, if any, should be entered into the CSC-based prior art reference analysis GUI; and/or (2) automatically map relevant portions of the retrieved prior art references to corresponding scope concept query fields in the Scope Concept Based Prior Art Reference Analysis GUI of FIG. 26C, so human subject matter experts can review and confirm that these prior art reference disclosure mappings are technically correct, or review and reject these prior art reference mapping as being technically incorrect and should not be entered into the system.

### Specification of the Multi-Mode Patent Analysis and Charting System of the Present Invention Configured in its Patent Claim Invalidity Contention Analysis Mode (Mode 5) of System Operation

FIG. 46 illustrates the information mapping process supported by the system during its patent claim invalidity contention analysis mode of system operation, wherein patent claim data, prosecution history data and court-specified claim term meaning definitions for common claim terms are mapped to particular fields within the claim chart structures generated during this particular mode of system operation.

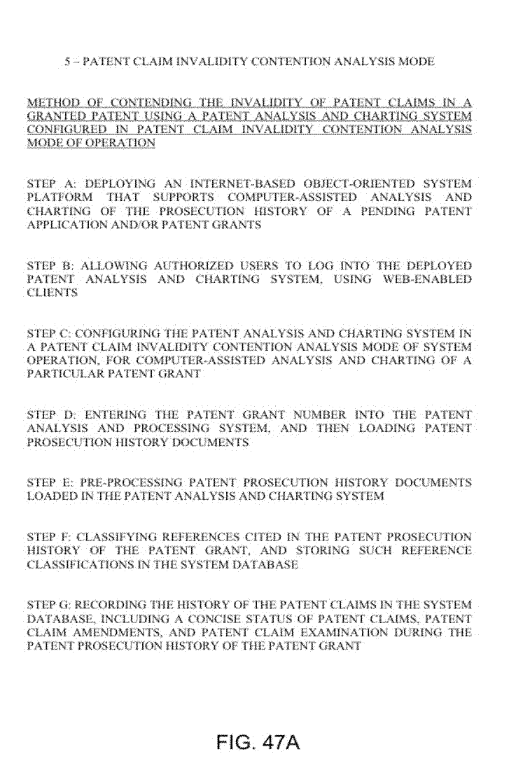

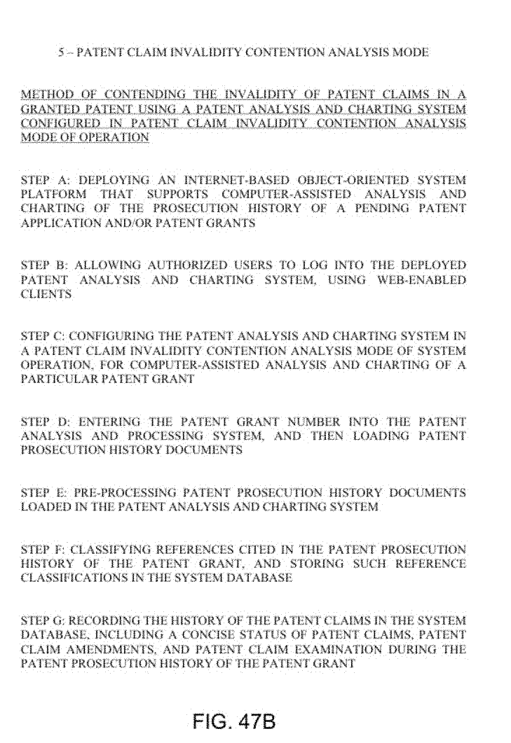

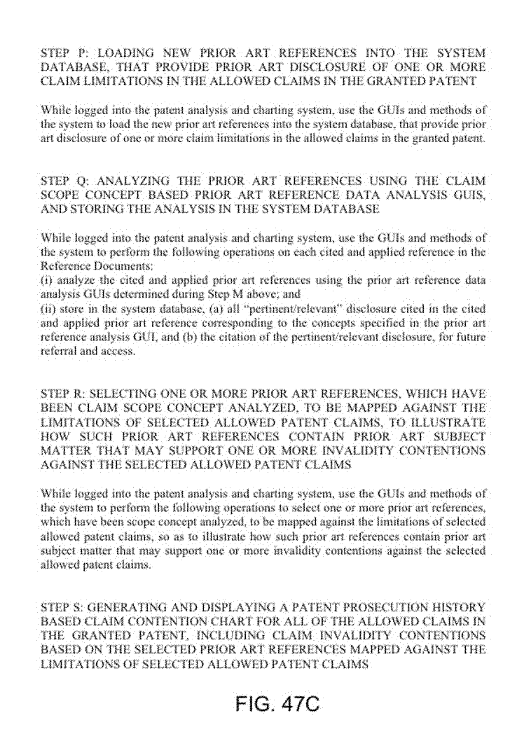

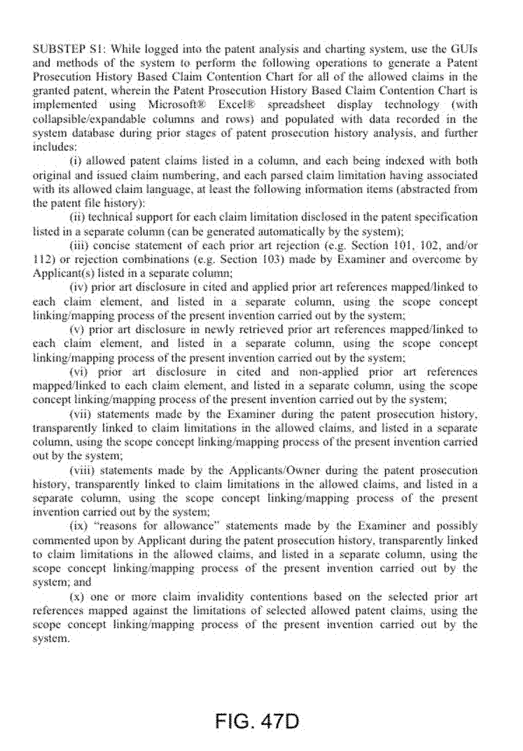

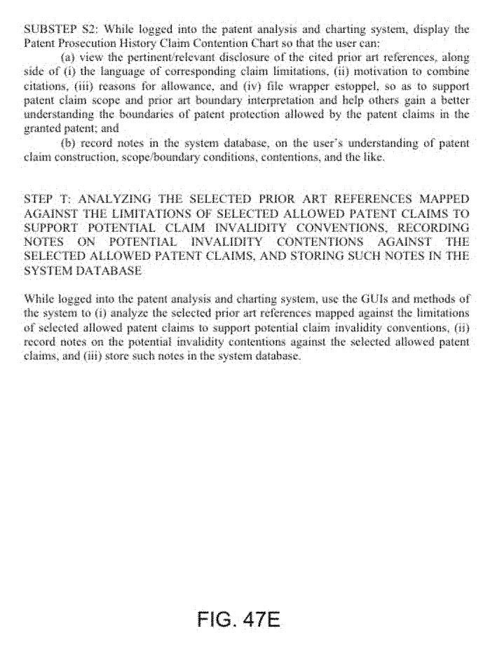

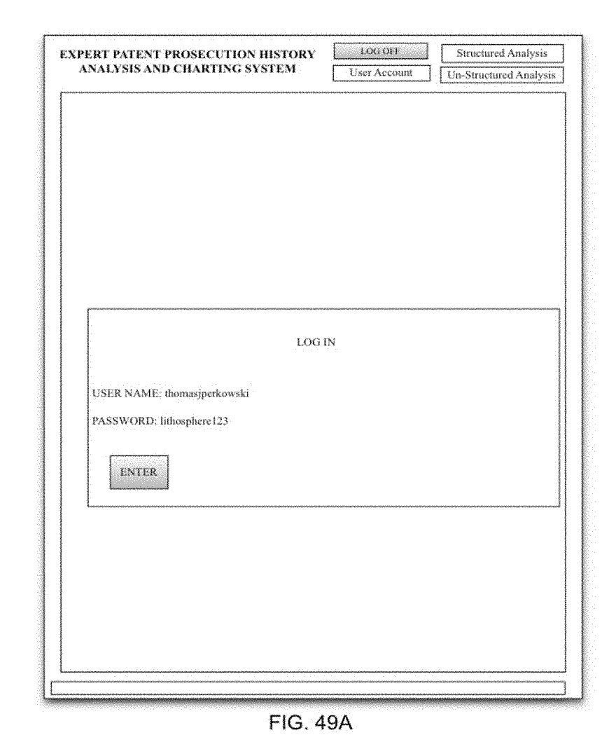

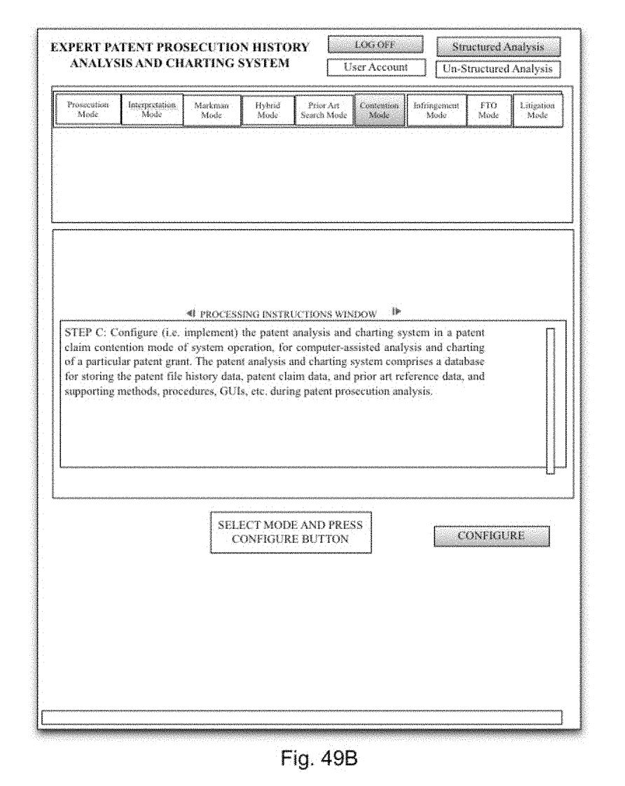

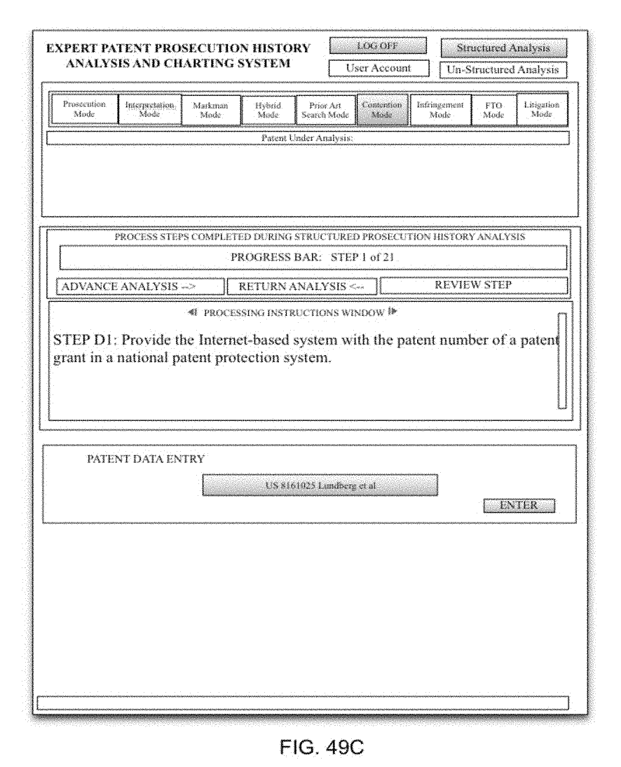

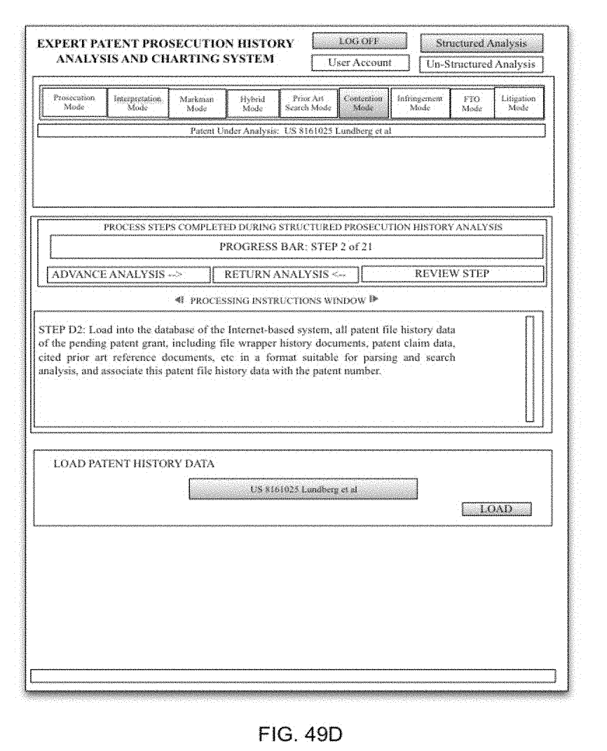

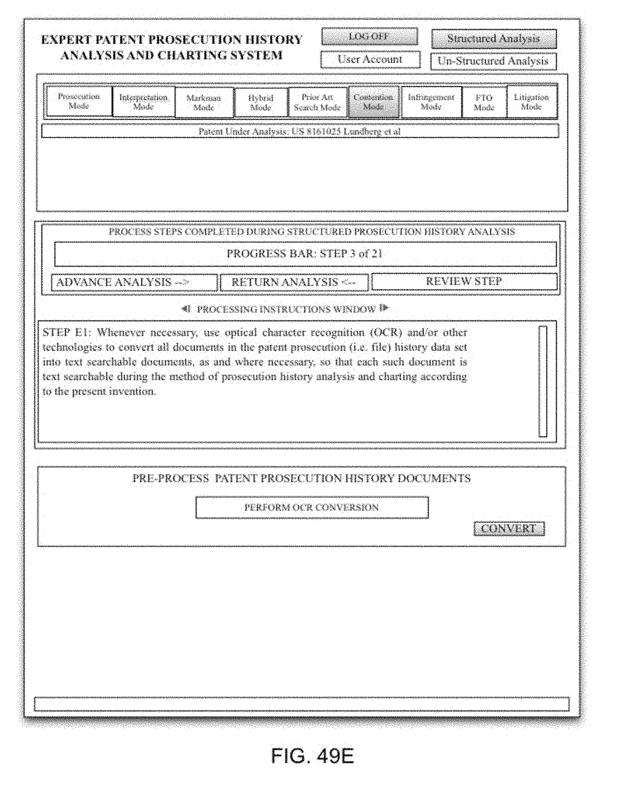

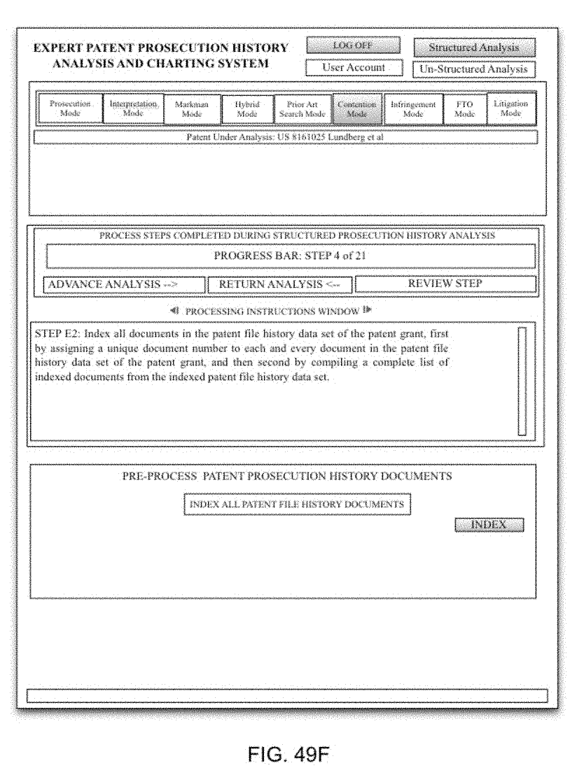

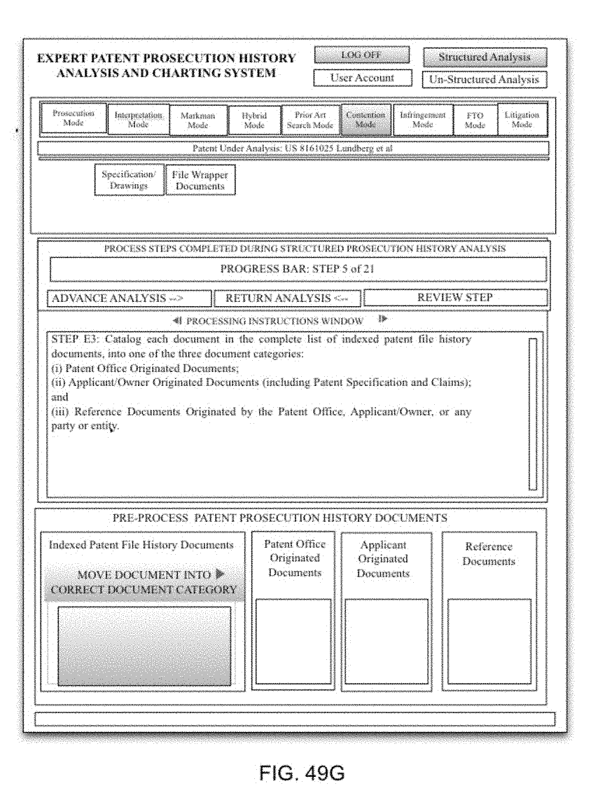

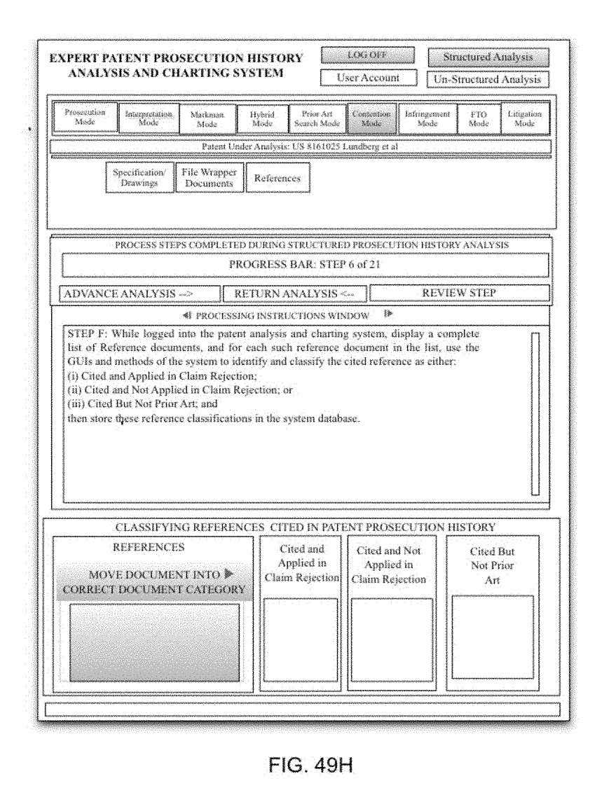

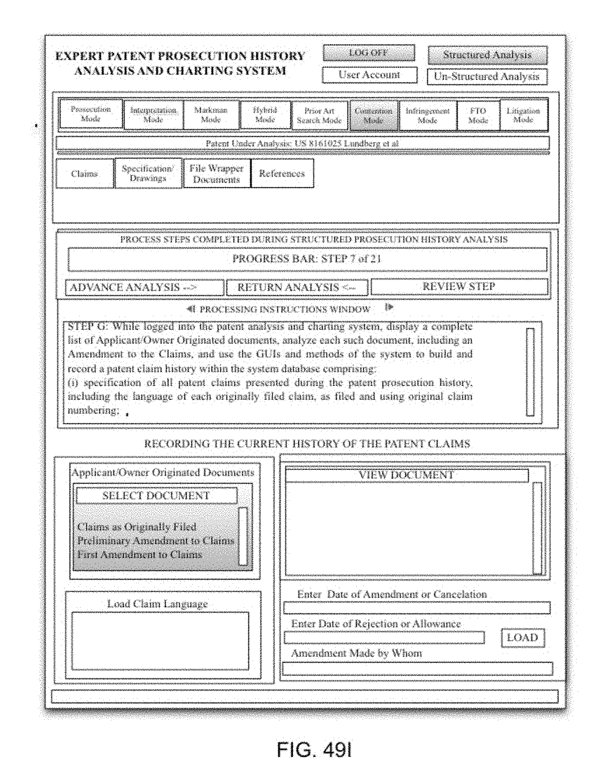

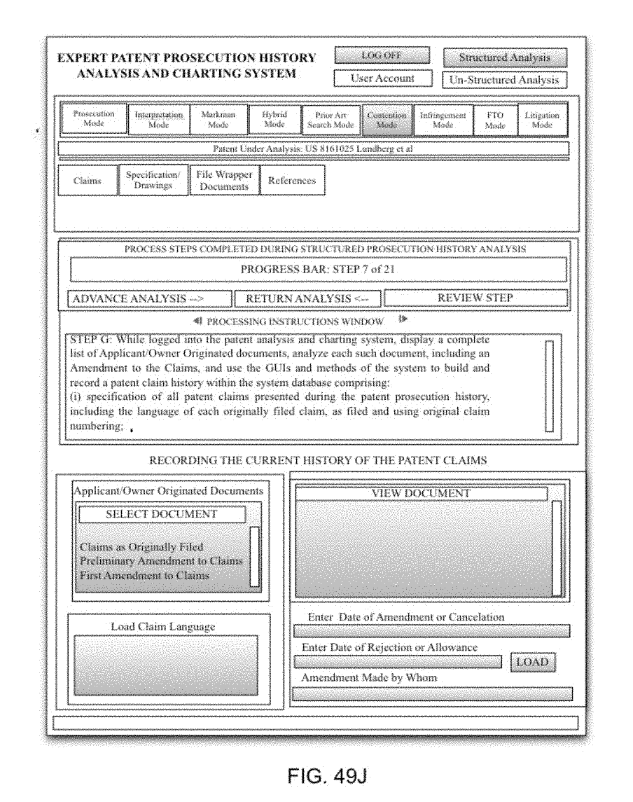

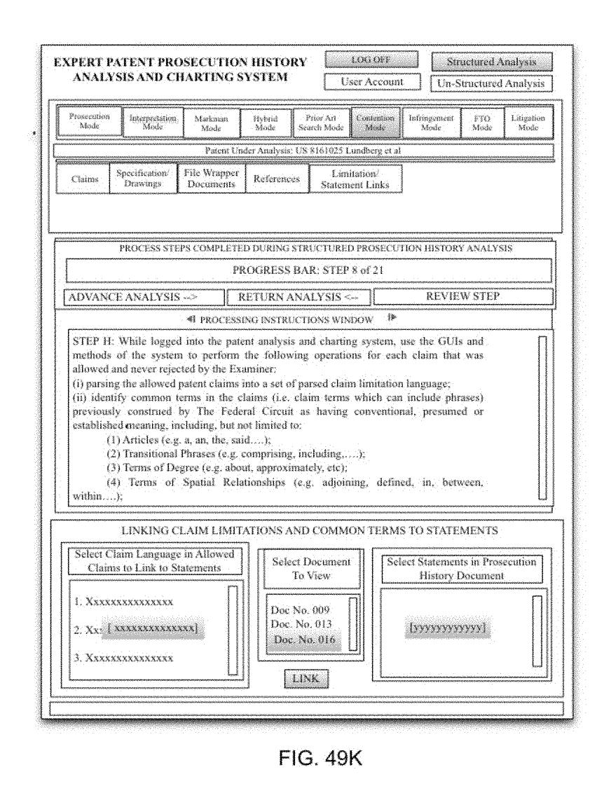

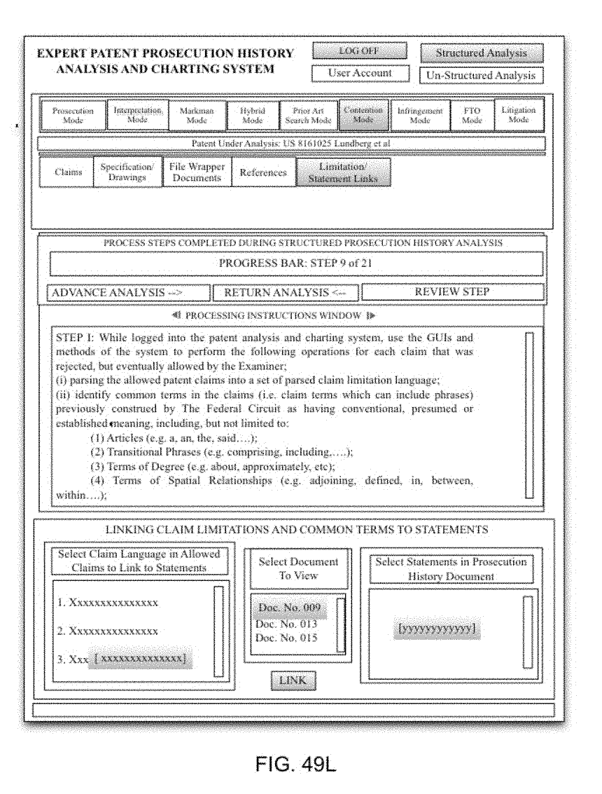

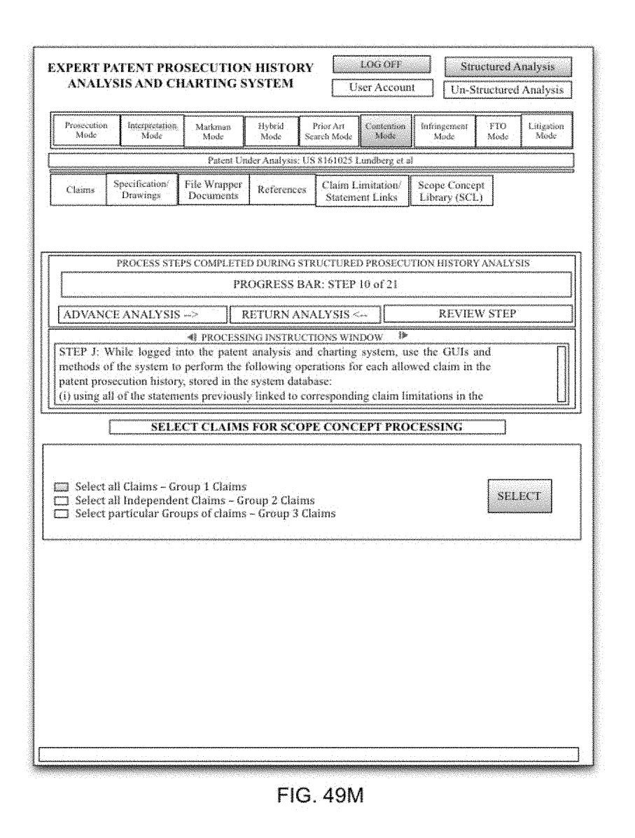

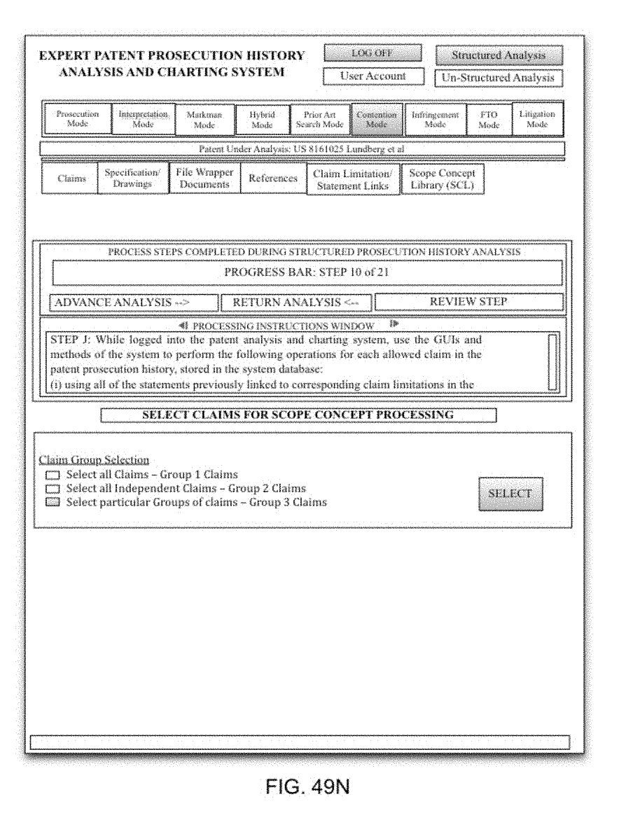

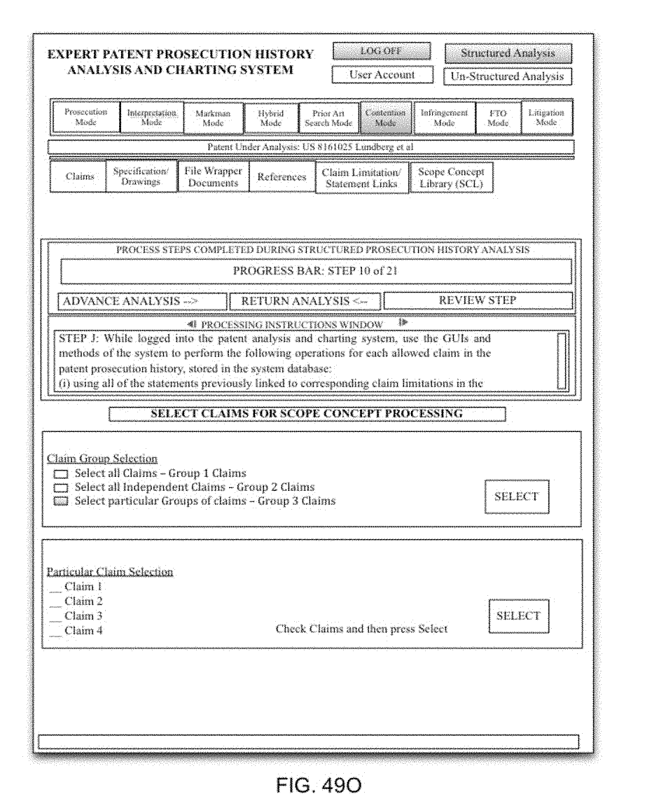

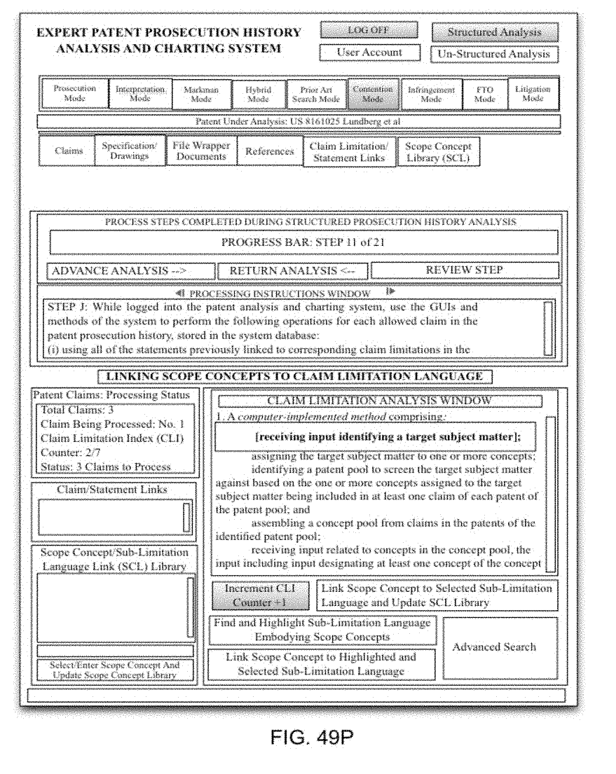

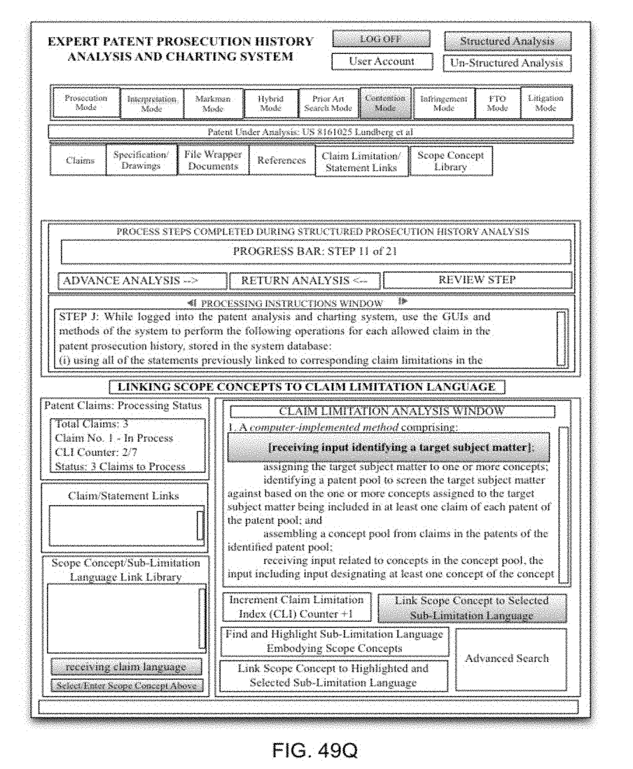

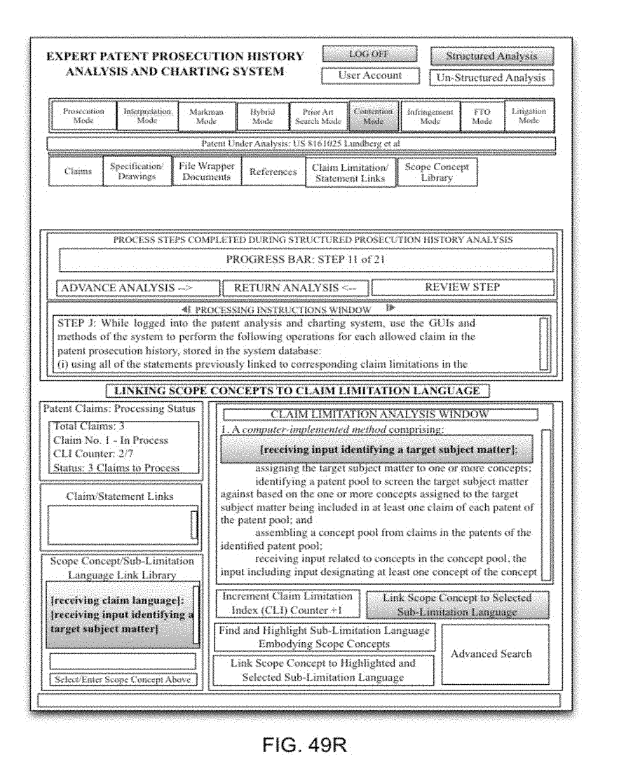

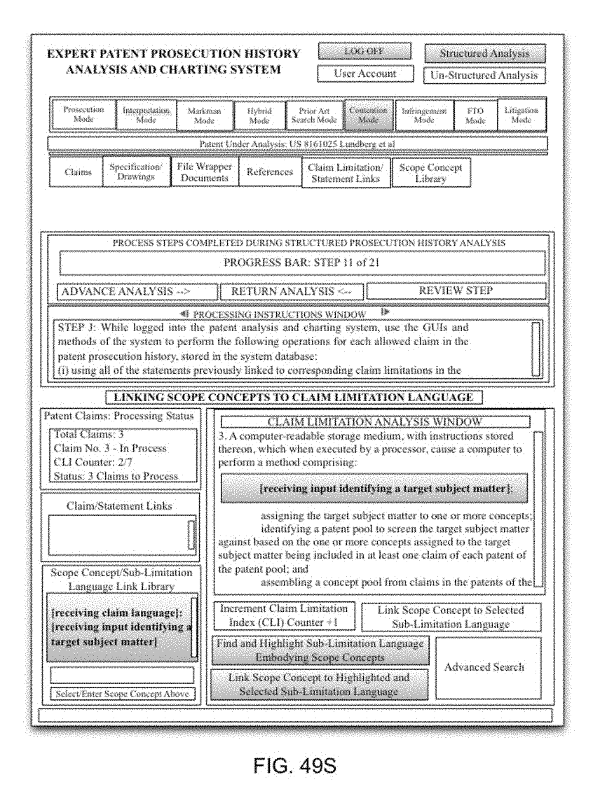

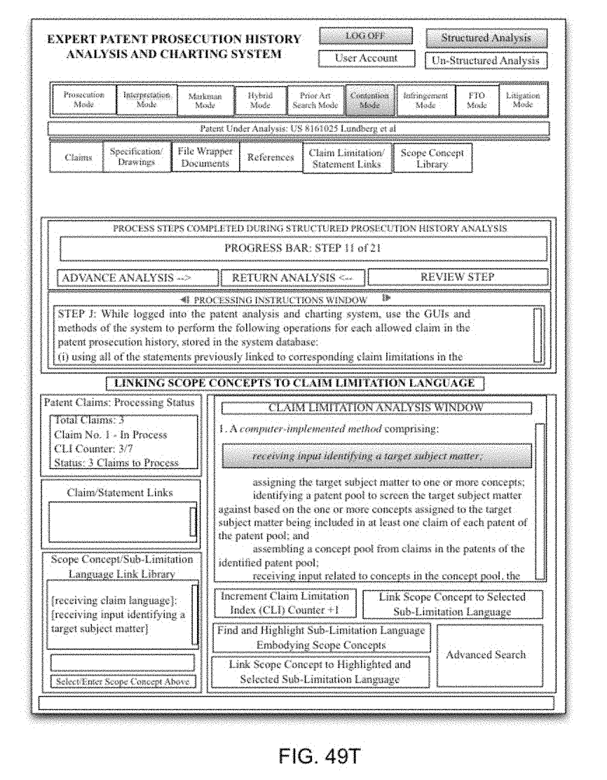

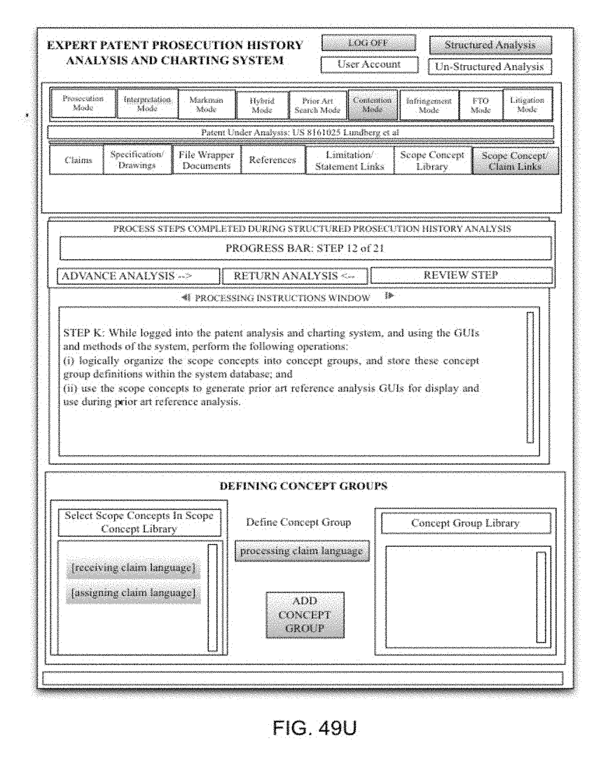

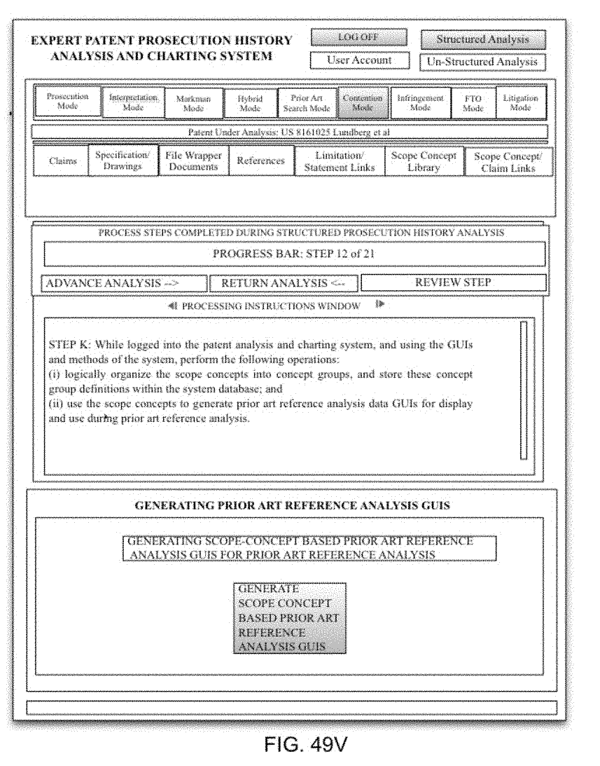

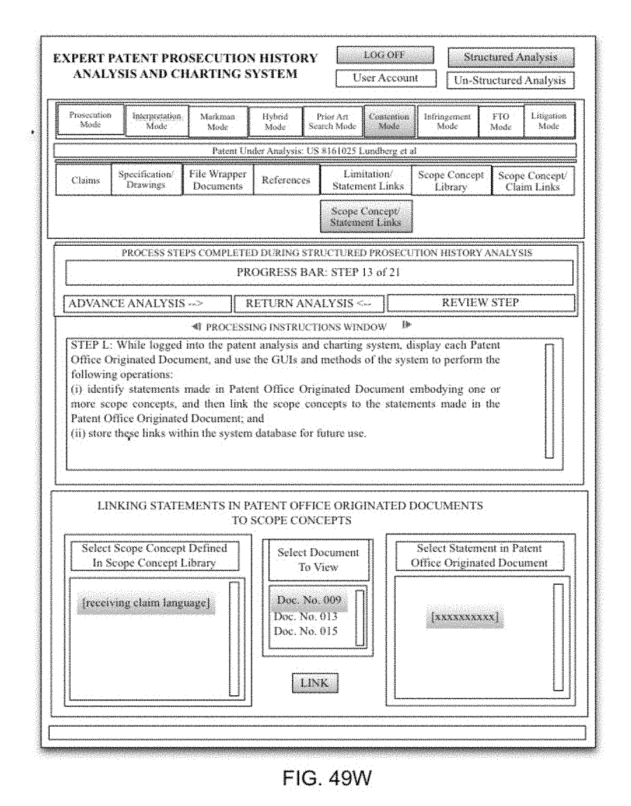

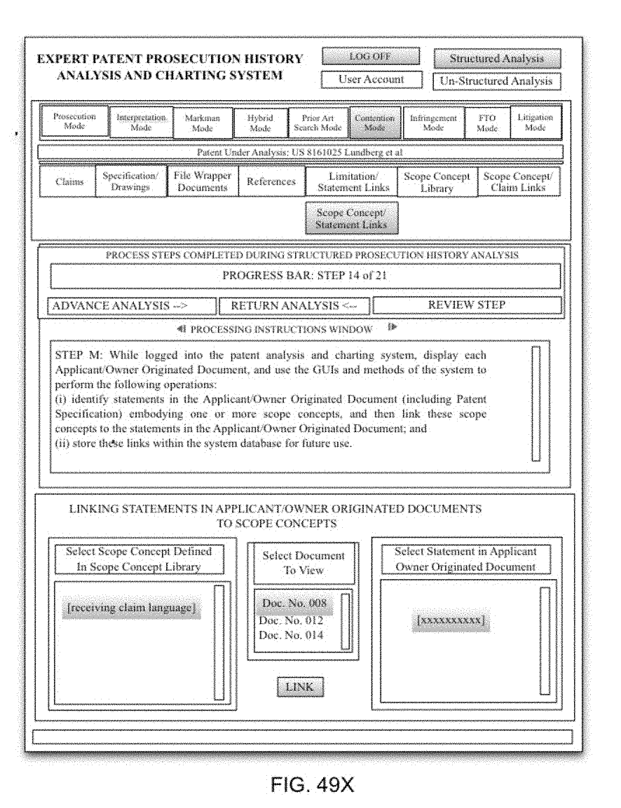

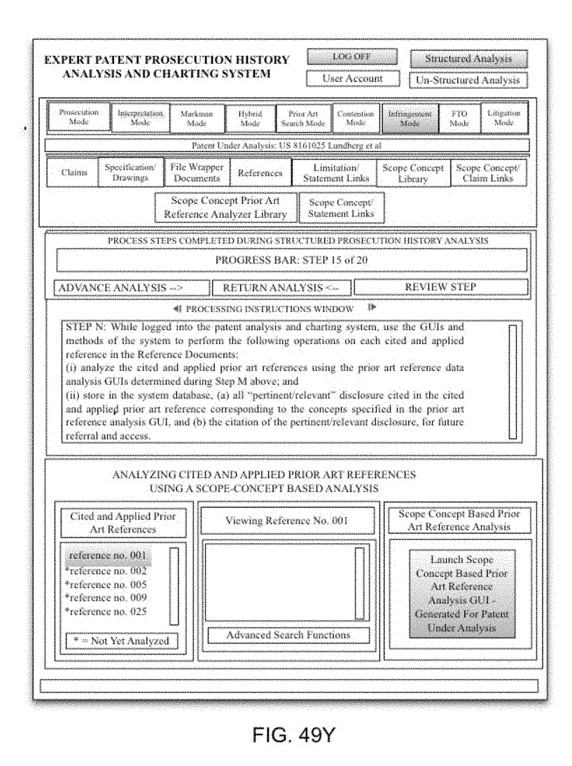

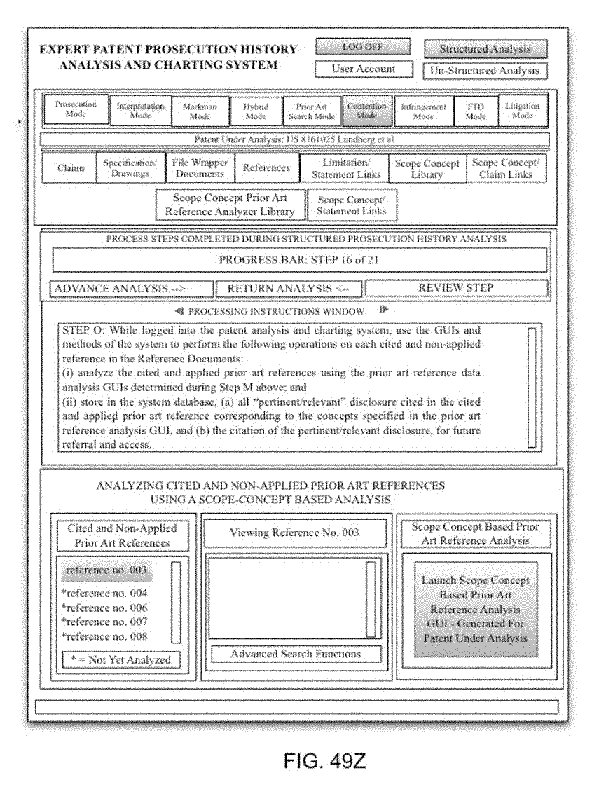

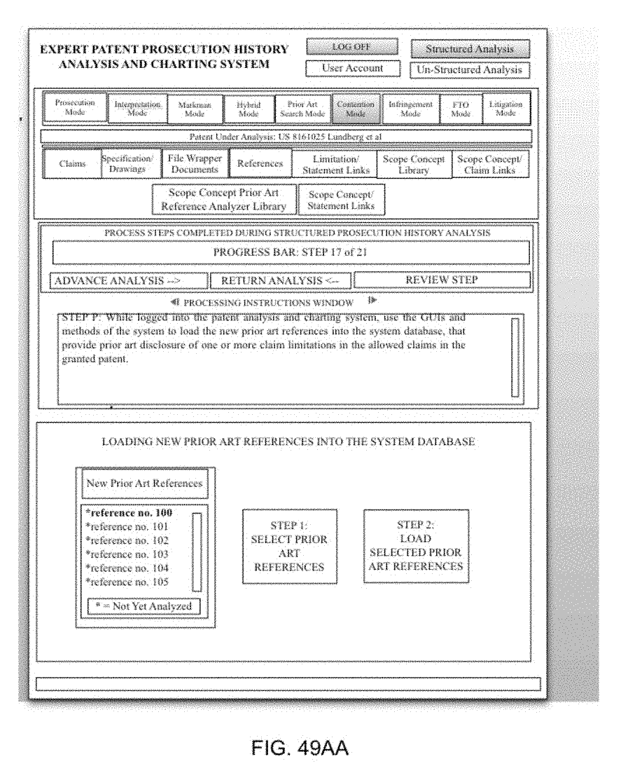

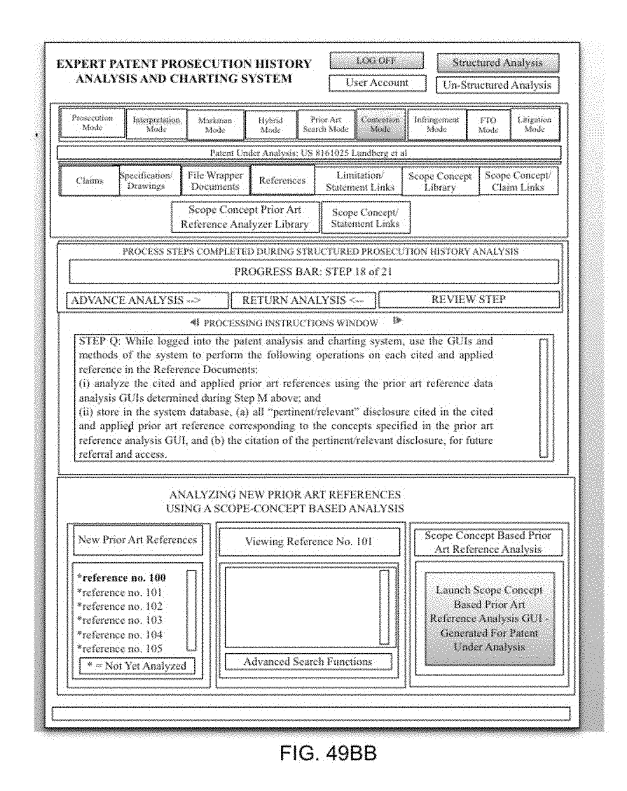

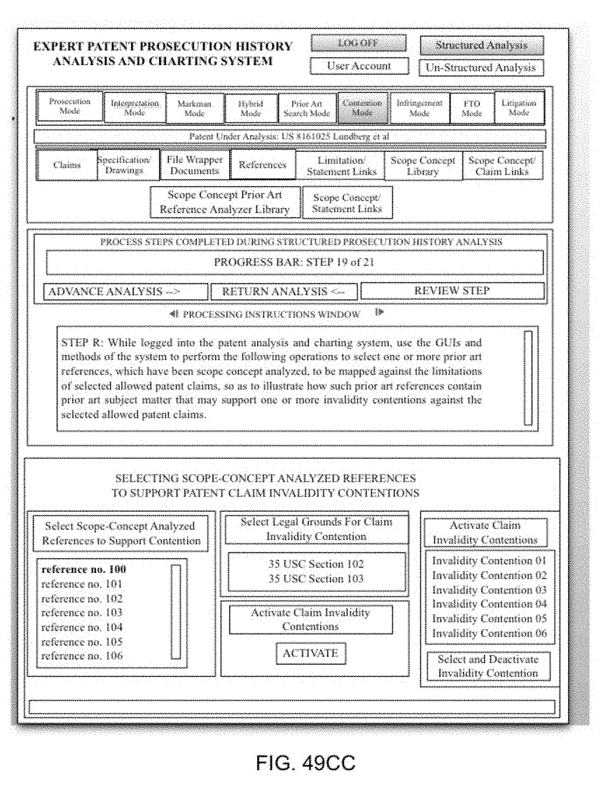

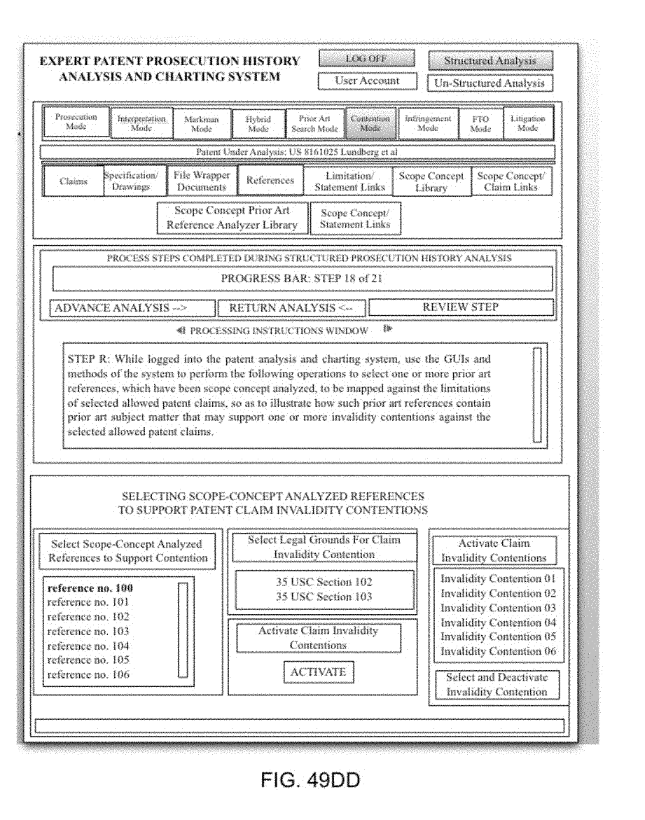

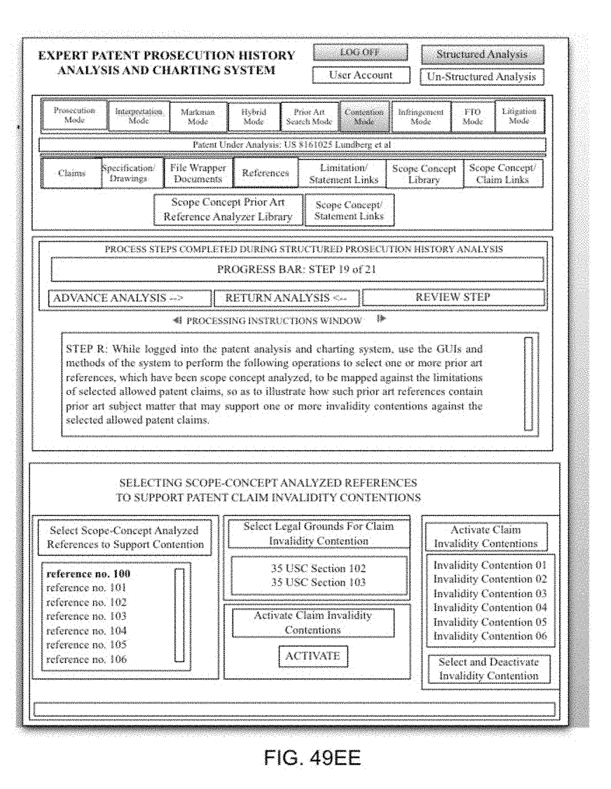

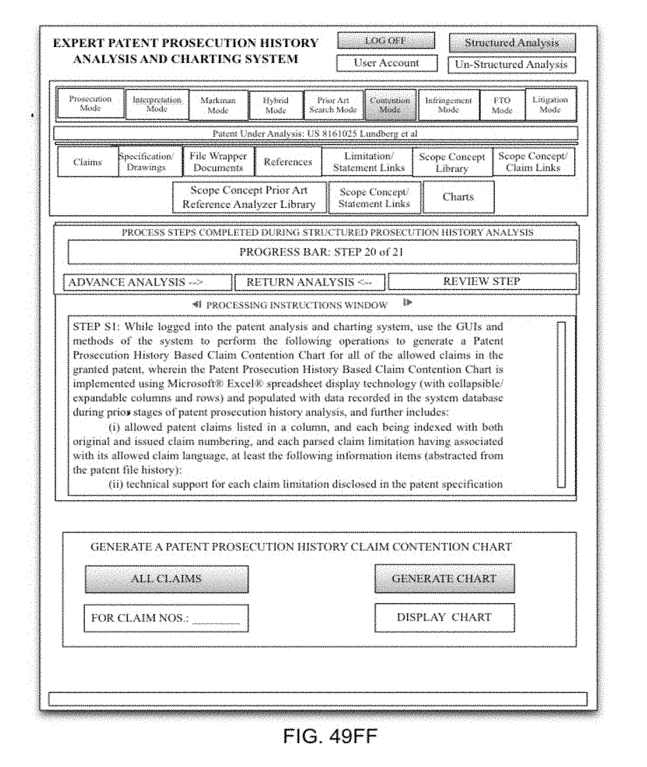

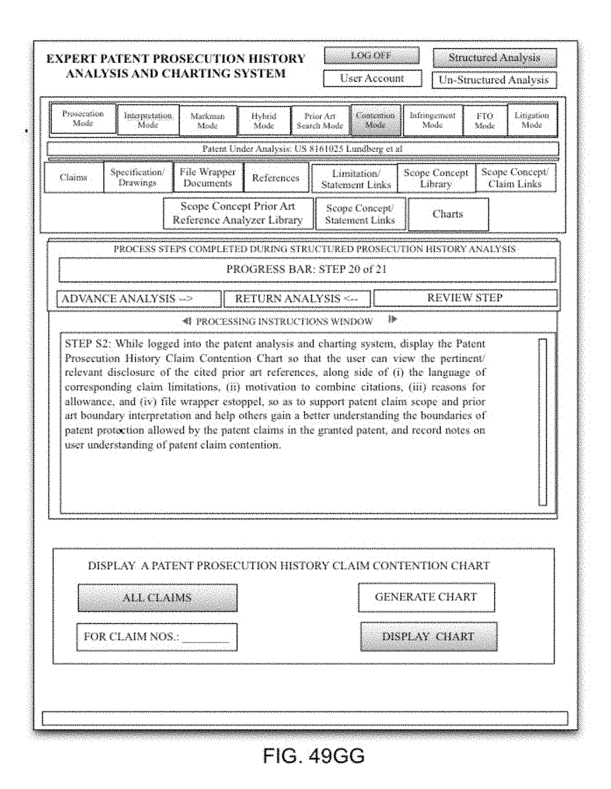

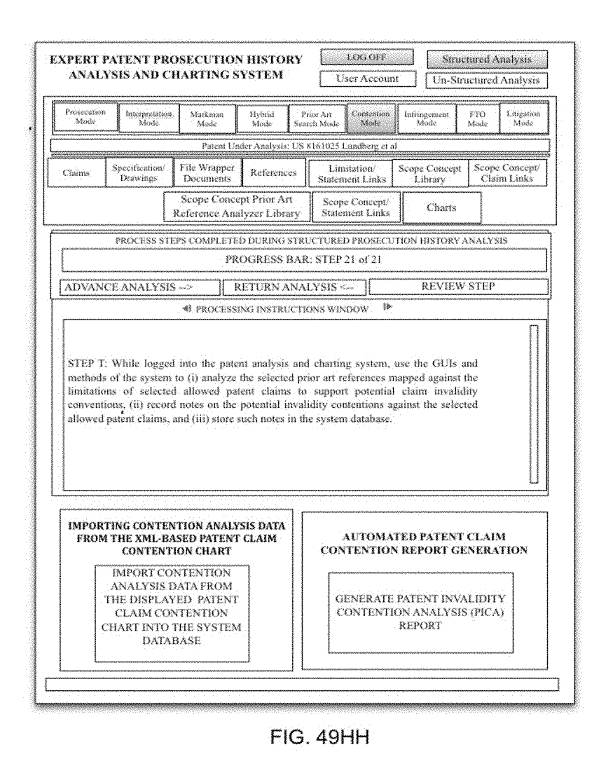

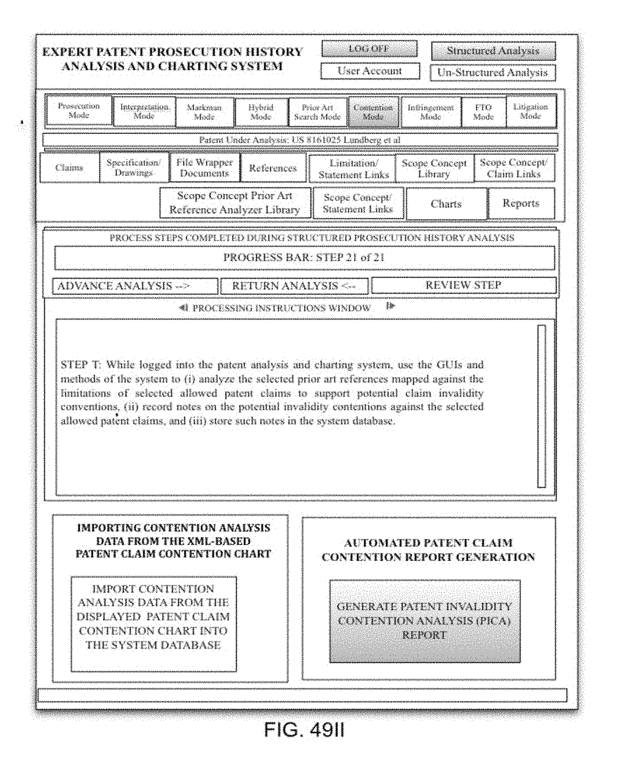

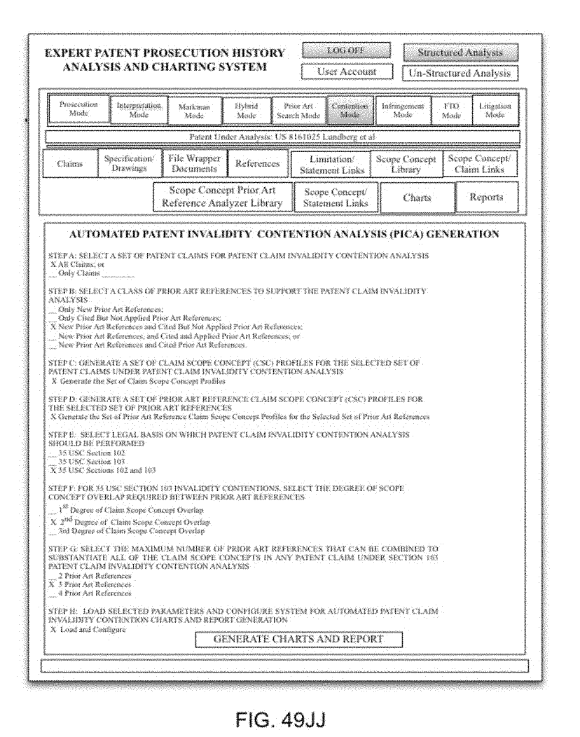

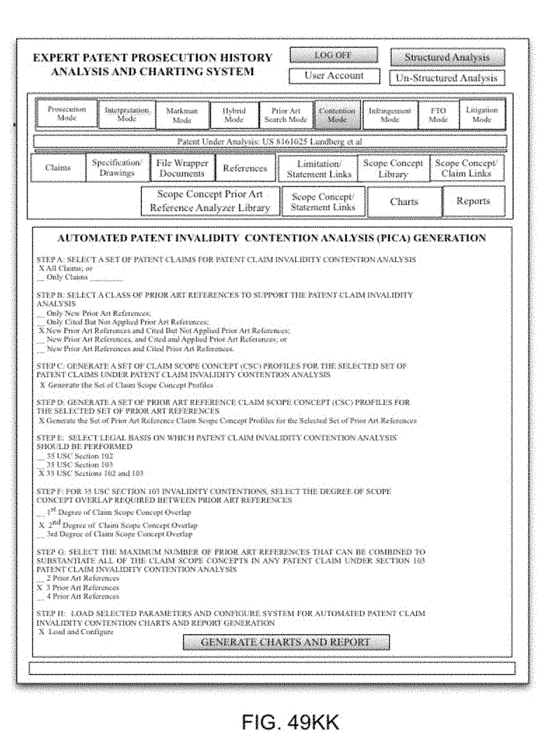

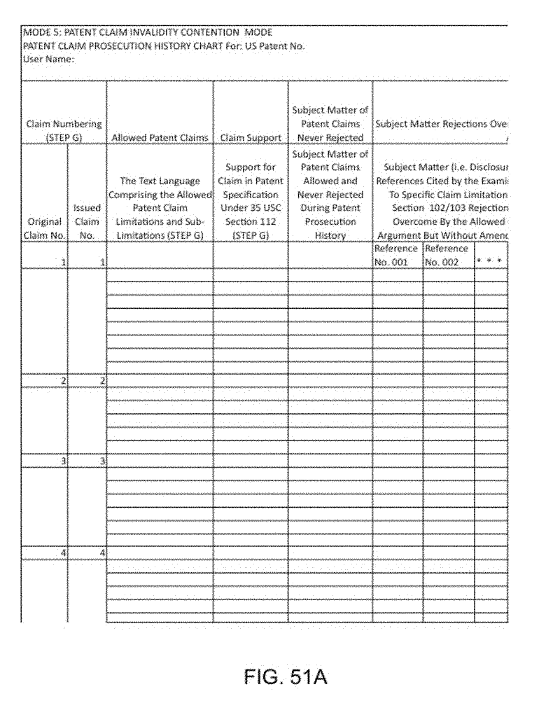

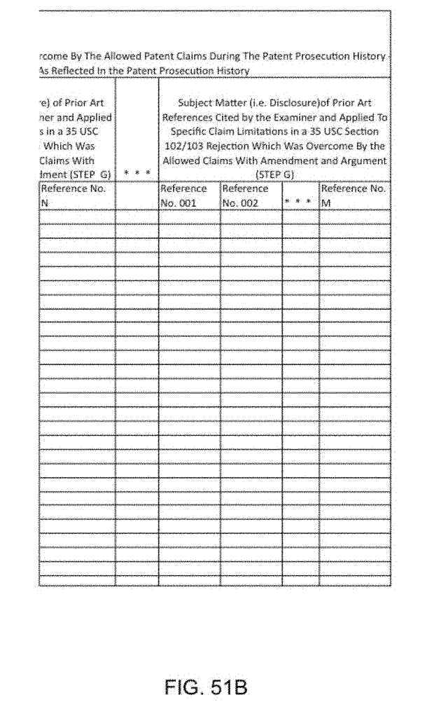

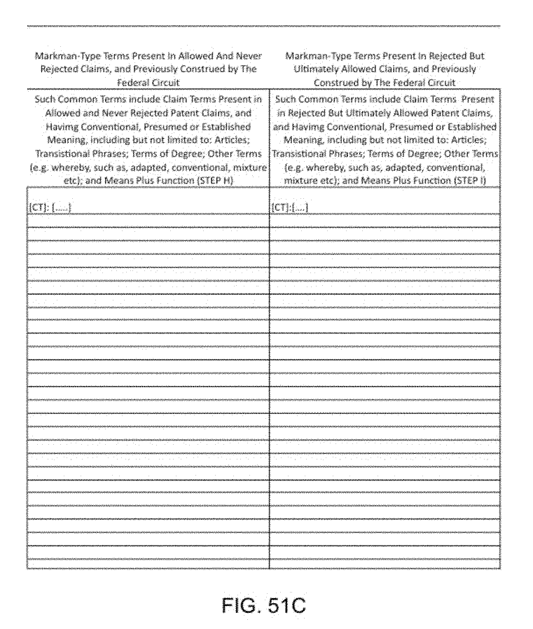

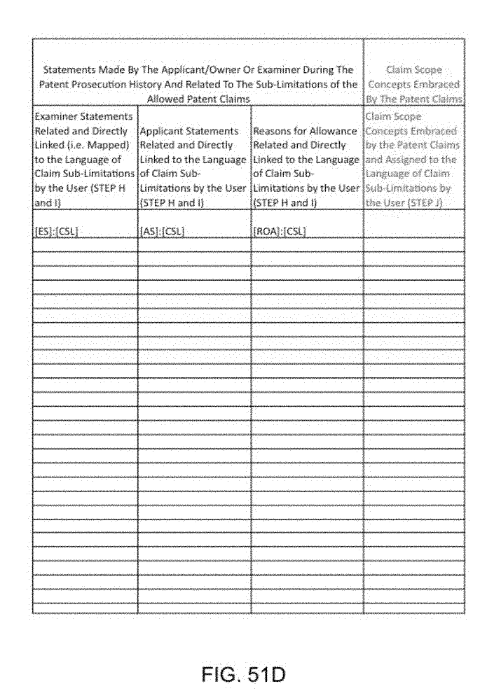

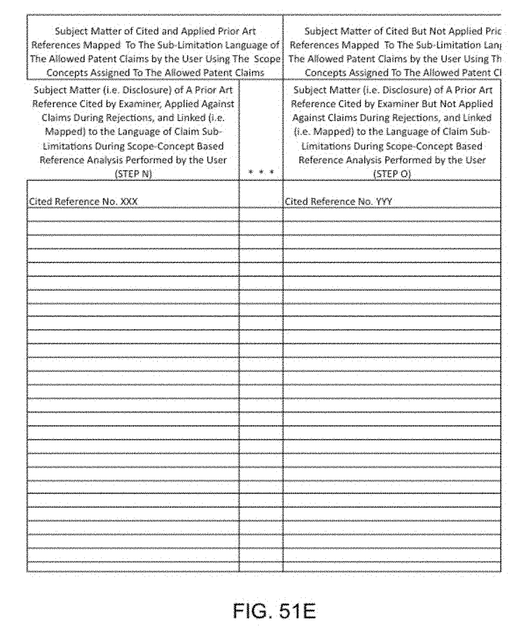

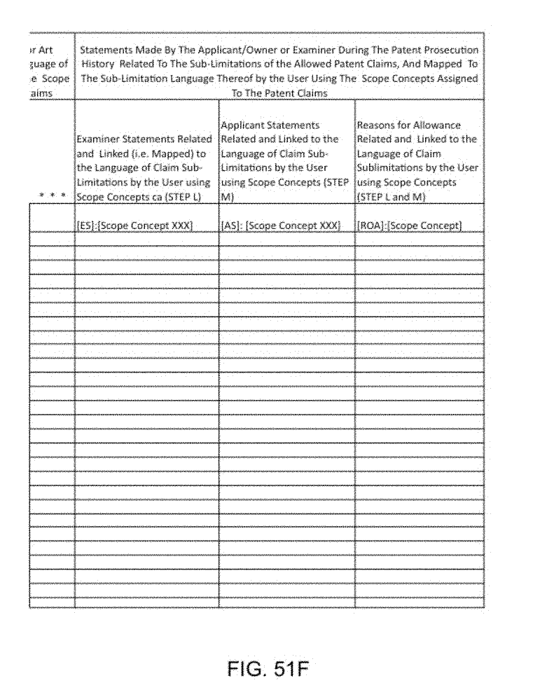

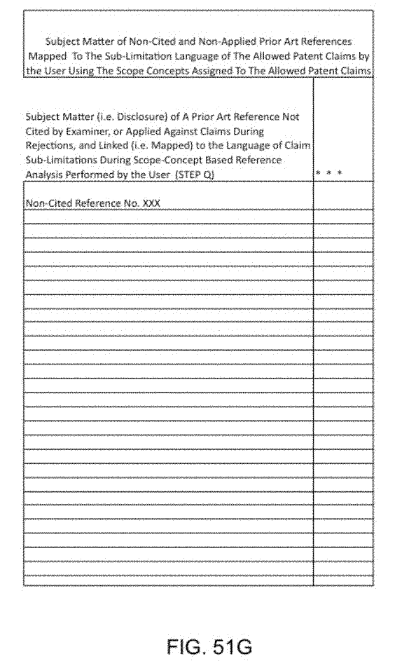

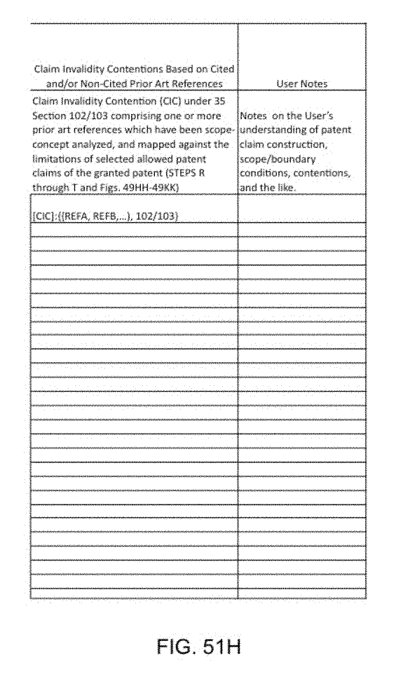

The workflow process specified in FIGS. 47A through 47E will be described now in greater detail with reference to the corresponding wireframe GUIs shown in FIGS. 49A through 49II, and the information mapping process illustrated in FIGS. 46 and 50A. Upon completion of the workflow process, the multi-mode system in its the patent claim invalidity contention analysis mode will automatically generate and display an XML-based spreadsheet-based chart structure as illustrated in FIG. 51A through 51H, that can be used by various users in any given user work group, including patent attorneys, during patent claim scope/boundary interpretation and other analytical efforts.

For presentation purposes only, the XML-based spreadsheet-based chart structure shown in FIGS. 51A through 51H has been broken down into several sections in the figure Drawings, and should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

### Method of Contending the Invalidity of Patent Claims in a Granted Patent Using a Patent Analysis and Charting System Configured in Patent Claim Invalidity Contention Analysis Mode of Operation

Referring now to the detailed flow chart set forth in FIGS. 47A through 47E, the Internet-based patent analysis and charting system of the present invention configured in its patent claim prosecution (history) analysis mode of system operation will be now described in detail, and showing how one or more users can efficiently analyze and chart the patent prosecution history of any granted patent or allowed patent application using the wireframe GUI screens set forth in FIGS. 49A through 49KK, the mapping techniques illustrated in FIGS. 46 and 50A, and the patent prosecution history based chart structures described in FIGS. 51A through 51H. Various applications for the patent analysis and charting system configured in this mode of operation are illustrated in FIG. 46 and will be described in greater detail hereinbelow.

The steps of the process described in FIGS. 47A through 47D will be described in detail below.

As indicated in Step A in FIG. 47A, Web, application and database servers on a network are used to deploy an Internet-based object-oriented system platform that supports a computer-assisted analysis and charting of the prosecution history of any patent granted in a national patent protection system. As shown in FIG. 5, the network is connected to the network information infrastructure and servers of national patent protection systems, and patent and published patent application depositories containing composite patent file history data documents for granted patents and pending (or abandoned) patent applications.

As indicated in Step B in FIG. 47A, web-enabled client machines are used to allow authorized users to log into the deployed patent analysis and charting system and perform the following operations specified below. As exemplary login GUI screen is shown in FIG. 49A for that purpose. In FIG. 49B, a GUI screen is shown for managing User Account information on the platform.

As indicated in Step C in FIG. 47A, the user employs a GUI as shown in FIG. 49B to configure the patent analysis and charting system in its patent claim invalidity contention analysis mode of system operation, for computer-assisted analysis and charting of a particular patent application, prior to patent grant. In general, the patent analysis and charting system comprises a database for storing the patent file history data, patent claim data, and prior art reference data, and supporting methods, procedures, GUIs, etc. during patent prosecution analysis. The purpose of this step in the process is to select the mode of system operation to be configured on the system platform of the present invention.

As indicated in Step D in FIG. 47A, the user employs GUI screen as shown in FIG. 49C, to provide the Internet-based system with the patent number of the patent granted in a national patent protection system. Then, using a GUI screen as shown in FIG. 49D, all patent file history data of the granted patent, including file wrapper history documents, patent claim data, cited prior art reference documents, etc., are uploaded from patent servers shown in FIG. 5, into the database 15 of the Internet-based system, in a format suitable for parsing and search analysis, and associate this patent file history data with the patent application serial number.

As indicated in Substep E1 in FIG. 47A, a GUI screen as shown in FIG. 49E is employed so that, whenever necessary, the system uses optical character recognition (OCR) and/or other technologies to convert all documents in the patent prosecution (i.e. file) history data set into text searchable documents, as and where necessary, so that each such document is text searchable during the method of prosecution history analysis and charting according to the present invention.

As indicated in Substep E2 in FIG. 47A, a GUI screen as shown in FIG. 49F is employed so that all documents in the patent file history data set of the granted patent are indexed by first assigning a unique document number to each and every document in the patent file history data set of the patent application, and then second by compiling a complete list of indexed documents from the indexed patent file history data set.

As indicated in Substep E3 in FIG. 47A, a GUI screen as shown in FIG. 49G is employed so that each document in the complete list of indexed patent file history documents, is cataloged into one of the three document categories: (i) Patent Office Originated Documents; (ii) Applicant/Owner Originated Documents (including Patent Specification and Claims); and (iii) Reference Documents Originated by the Patent Office, Applicant/Owner, or any party or entity.

As indicated in Step F in FIG. 47A, a GUI screen as shown in FIG. 49H is employed so that, while logged into the patent analysis and charting system, the system displays a complete list of Reference Documents, and for each such reference document in the list, the user uses the GUIs and methods of the system to identify and classify the cited reference as either: (i) cited and applied in claim rejection; (ii) cited and not applied in claim rejection; or (iii) cited but not prior art; and then store these reference classifications in the system database

As indicated in Step G in FIG. 47B, GUI screens as shown in FIGS. 491 and 49J are employed, so that the system enables the recording of the current history of the patent claims in the system database, including a concise status of patent claims, patent claim amendments, and patent claim examination during the patent prosecution history of the patent application. In the illustrative embodiment, this is achieved as follows. As shown, while logged into the patent analysis and charting system, the system displays a complete list of Applicant/Owner Originated documents, and then each such document, including an Amendment to the Claims is analyzed by the user using the GUIs and methods of the system so as to build and record a patent claim history (PCH) within the system database 15. In the illustrative embodiment, the patent claim history comprises:

(i) specification of all patent claims presented during the patent prosecution history, including the language of each originally filed claim, as filed and using original claim numbering;

(ii) specification of the date each patent claim was amended and/or canceled, voluntarily, and not in response to an examiner's claim rejection;

(iii) specification of which patent claims were allowed without rejection, and specify the date of allowance and the Examiner who made the allowance;

(iv) specification of which claims were rejected, identify the statutory basis of each such rejection (e.g. 35 USC Section 102 and/or 103) and prior art references upon which the claim rejection was made, and specify the date of the claim rejection and the Patent Examiner who made the rejection;

(v) specification of the language of each claim amendment, identify when the amendment was made and by whom (i.e. using USPTO Attorney/Agent Registration Number for registered agents and attorneys, and Applicant's name for pro se applications);

(vi) specification of which claims where allowed after rejection in response to an argument for patentability and request for reconsideration, and a specification of the language of each such allowed claim; and

(vii) specification of which claims where allowed after rejection in response to an argument for patentability, an amendment to the claims, and a request for reconsideration, and a specification of the language of each such allowed claim.

As indicated in Step H in FIG. 47B, a GUI screen as shown in FIG. 49K is employed, so that the user can link examiner and/or applicant statements made during the patent prosecution history to the limitations, sub-limitations and/or common terms of allowed and never rejected patent claims, and then store each link in the system database. Specifically, while logged into the patent analysis and charting system, the user uses the GUIs and methods of the system to perform the following operations for each claim that was allowed and never rejected by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure (e.g. searchable text and/or searchable graphics and/or images) found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

For cases where the granted patent is not involved in patent litigation, the Markman mapping operations set forth in substep (ii) above will be disabled from the system configuration.

As indicated in Step I in FIG. 47B, a GUI screen as shown in FIG. 49L is employed, so that the user can link examiner and/or applicant statements made during the patent prosecution history to the limitations, sub-limitations and/or common terms of rejected but ultimately allowed patent claims, and storing each link in the system database.

Specifically, while logged into the patent analysis and charting system, the user uses the GUIs and methods of the system to perform the following operations for each claim that was rejected, but eventually allowed by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure (e.g. searchable text and/or searchable graphics and/or images) found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

For cases where the granted patent is not involved in patent litigation, the Markman mapping operations set forth in substep (ii) above will be disabled from the system configuration.

As indicated in Step J in FIG. 47B, GUI screens as shown in FIGS. 49M through 49T are employed, so that the user can define and formulate scope concepts based on analysis of stored links, then link claim limitation language of each allowed patent claim to one or more scope concepts, and ultimately store each scope concept and link in the system database. Specifically, while logged into the patent analysis and charting system, the user uses the GUIs and methods of the system to perform the following operations for each allowed claim in the patent prosecution history, stored in the system database 15:

(i) display the allowed patent claims using final patent numbering, or any selected group of claims (e.g. all claims, all independent claims, or a particular subset of claims);

(ii) using the statements previously linked to corresponding claim limitations in the allowed patent claim, identify and formulate one or more scope concepts expressed in and/or embraced by or embodied within the claim limitation language of each allowed patent claim, and store these scope concepts in the system database 15;

(iii) for each claim limitation, link a scope concept to the corresponding language of the claim sub-limitation that supports the scope concept and store these claim limitation/scope concept links in the system database; and

(iv) repeat step (iii) above for each claim limitation, as necessary to capture essential scope concepts embodied within the allowed claim.

The scope concept formulation, assignment and linkage method described in FIGS. 24 through 26 can be used to practice Step J of this method of patent claim analysis supported by the system of the present invention.

During the process of claim scope concept analysis and scope concept formulation/formation described above, the user assigns one or more scope concepts to each patent claim in the set of patent claims under analysis. Then, for the set of patent claims, the system automatically forms and maintains a Library of Scope Concepts (“Scope Concept Library”, and also a “Set of Claim Scope Concept Profiles”) stored in the system database 15. At any time, the user can review the Scope Concept Library for any given set of patent claims under analysis by clicking on the Scope Concept Library graphical icon presented with the GUI screens displayed by the system, as shown in FIG. 49U, for example.

For each patent claim that has been scope concept analyzed, the system automatically generates a Claim Scope Concept Profile, as shown in FIG. 26B, comprising a complete List of Scope Concepts that have been assigned to corresponding language in the claim limitations and/or sub-limitations of the Patent Claim. The system also maintains a Library of Scope Concept/Claim links, as shown in FIG. 49U.

As indicated in Step K in FIG. 47B, GUI screens as shown in FIGS. 49U and 49V are employed, so that the user can define concept groups and store them in the system database and generate scope concept based prior art reference analysis GUIs shown in FIG. 26C during prior art reference analysis. Specifically, while logged into the patent analysis and charting system, and using the GUIs and methods of the system, the user performs the following operations: (i) logically organizes the scope concepts into concept groups, and stores these concept group definitions within the system database; and (ii) uses the scope concepts to define prior art reference analysis GUIs shown in FIG. 26C for display during prior art reference analysis.

As indicated in Step L in FIG. 47B, a GUI screen as shown in FIG. 49W is employed, so that the user can link statements in patent office originated documents to one or more scope concepts defined above, and then store each link in the system database. Specifically, while logged into the patent analysis and charting system, display each Patent Office Originated Document, and use the GUIs and methods of the system to perform the following operations: (i) identify statements made in Patent Office Originated Document embodying one or more scope concepts, and then link the scope concepts to the statements made in the Patent Office Originated Document; and (ii) store these links within the system database for future use.

As indicated in Step M in FIG. 47B, a GUI screen as shown in FIG. 49X is employed, so that the user can link statements in Applicant/Owner originated documents to one or more scope concepts defined above, and store each link in the system database. Specifically, while logged into the patent analysis and charting system, display each Applicant/Owner Originated Document, and use the GUIs and methods of the system to perform the following operations: (i) identify statements in the Applicant/Owner Originated Document (including Patent Specification) embodying one or more scope concepts, and then link these scope concepts to the statements in the Applicant/Owner Originated Document; and (ii) store these links within the system database for future use.

As indicated in Step N in FIG. 47B, a GUI screen as shown in FIG. 49Y is employed, so that the user can analyze cited and applied prior art references using the scope concept based prior art reference analysis GUI of FIG. 26C, and store the analysis in the system database. Specifically, while logged into the patent analysis and charting system, use the GUIs and methods of the system to perform the following operations on each cited and applied reference in the Reference Documents: (i) analyze the cited and applied prior art references using the prior art reference data analysis GUIs determined during Step M above; and (ii) store in the system database, (a) all “pertinent/relevant” disclosure cited in the cited and applied prior art reference corresponding to the concepts specified in the prior art reference analysis GUI, and (b) the citation of the pertinent/relevant disclosure, for future referral and access.

After each prior art reference is analyzed using the Scope Concept Based Prior Art Reference Analysis GUI during scope concept based prior art analysis in Step N, then a Prior Art Reference Scope Concept Profile is automatically generated for the prior art reference that has been scope concept analyzed, as illustrated in FIG. 26D. As shown in FIG. 26D, the Prior Art Reference Scope Concept Profile for each Prior Art Reference comprises: (i) a Master Scope Concept List indicating which scope concepts (assigned to the set of Claims) have and have not been substantiated by disclosure from the prior art reference, and (ii) a Claim Scope Concept Profile, for each patent claim, indicating which scope concepts in each patent claim have and have not been substantiated by disclosure from the Prior Art Reference, with a citation from the prior art reference as to where the substantiating disclosure can be found in the prior art reference.

As indicated in Step O in FIG. 47B, a GUI screen as shown in FIG. 49Z is employed, so that the user can analyze cited and non-applied prior art references using the scope concept based prior art reference analysis GUI of FIG. 26C, and store the analysis in the system database. Specifically, while logged into the patent analysis and charting system, use the GUIs and methods of the system to perform the following operations on each cited and non-applied reference in the Reference Documents: (i) analyze the cited and non-applied prior art reference using the prior art reference data analysis GUIs determined during Step M above; and (ii) store in the system database (a) all “pertinent/relevant” disclosure cited in the cited and non-applied prior art reference corresponding to the concepts specified in the prior art reference analysis GUI, and (b) the citation of the pertinent/relevant disclosure, for future referral and access.

After each prior art reference is analyzed using the Scope Concept Based Prior Art Reference Analysis GUI during scope concept based prior art analysis in Step O, then a Prior Art Reference Scope Concept Profile is automatically generated for the prior art reference that has been scope concept analyzed, as illustrated in FIG. 26D. As shown in FIG. 26D, the Prior Art Reference Scope Concept Profile for each Prior Art Reference comprises: (i) a Master Scope Concept List indicating which scope concepts (assigned to the set of Claims) have and have not been substantiated by disclosure from the prior art reference, and (ii) A Claim Scope Concept Profile, for each patent claim, indicating which scope concepts in each patent claim have and have not been substantiated by disclosure from the Prior Art Reference, with a citation from the prior art reference as to where the substantiating disclosure can be found in the prior art reference.

As indicated in Step P in FIG. 47C, a GUI screen as shown in FIG. 49AA is employed, so that the user can load new prior art references into the system database, that provide prior art disclosure (e.g. searchable text and/or searchable graphics and/or images) substantiating or otherwise relevant to one or more claim limitations in the allowed claims in the granted patent. Specifically, while logged into the patent analysis and charting system, the user uses this GUI and methods of the system associated therewith to load the new prior art references into the system database 15, that provide prior art disclosure (e.g. searchable text and/or searchable graphics and/or images) substantiating or otherwise relevant to one or more claim limitations in the allowed claims in the granted patent.

As indicated in Step Q in FIG. 47C, a GUI screen as shown in FIG. 49BB is employed, so that the user can analyze the prior art references using the scope concept based prior art reference analysis GUI, and store the analysis in the system database. Specifically, while logged into the patent analysis and charting system, the user uses the GUIs and methods of the system to perform the following operations on each cited and applied reference in the Reference Documents: (i) analyze the cited and applied prior art references using the prior art reference data analysis GUIs determined during Step M above; and (ii) store in the system database, (a) all “pertinent/relevant” disclosure cited in the cited and applied prior art reference corresponding to the concepts specified in the prior art reference analysis GUI, and (b) the citation of the pertinent/relevant disclosure, for future referral and access.

As indicated in Step R in FIG. 47C, GUI screens as shown in FIGS. 49CC through 49EE are employed, so that the user can select one or more prior art references, which have been scope concept analyzed, to be mapped against the limitations of selected allowed patent claims, to illustrate how such prior art references contain prior art subject matter that may support one or more invalidity contentions against the selected allowed patent claims. Specifically, while logged into the patent analysis and charting system, the user uses the GUIs and methods of the system to perform the following operations to select one or more prior art references, which have been scope concept analyzed, to be mapped against the limitations of selected allowed patent claims, so as to illustrate how such prior art references contain prior art subject matter that may support one or more invalidity contentions against the selected allowed patent claims.

As indicated in Step S in FIGS. 47C, 47D and 47E, GUI screens as shown in FIGS. 49FF and 49GG are employed, so that the user can generate and display a claim scope schema (CSS) based claim contention chart for all of the allowed claims in the granted patent, including claim invalidity contentions based on the selected prior art references mapped against the limitations of selected allowed patent claims. Specifically, during Substep S1, while logged into the patent analysis and charting system, the user uses the GUIs set forth in FIG. 49FF and methods of the system to generate a patent prosecution history based claim contention chart for all of the allowed claims in the granted patent.

The claim scope schema (CSS) based claim contention chart is implemented using Microsoft® Excel® spreadsheet display technology (with collapsible/expandable columns and rows) and populated with data recorded in the system database during prior stages of patent prosecution history analysis.

As shown in FIGS. 51A through 51H, claim scope concept (CSS) based claim invalidity contention chart comprises data fields for presenting graphical representations of the following graphical objects:

(i) the text language comprising the allowed patent claim limitations and sub-limitations (Step G) listed in a column, and each being indexed with both original and issued claim numbering, and each parsed claim limitation having associated with its allowed claim language, at least the following information items (abstracted from the patent file history):

(ii) technical support for each claim limitation disclosed in the patent specification under 35 USC Section 112 (Step G) listed in a separate column (can be generated automatically by the system);

(iii) subject matter (language) of patent claims allowed and never rejected during patent prosecution history (Step G);

(iv) subject matter rejections overcome by the allowed patent claims during the patent prosecution history—as reflected in the patent prosecution history—including a concise statement of each prior art rejection (e.g. Section 101, 102, and/or 112) or rejection combinations (e.g. Section 103) made by Examiner and overcome by Applicant(s) listed in a separate column;

subject matter (i.e. disclosure) of prior art references cited by the examiner and applied to specific claim limitations in a 35 USC Section 102/103 rejection which was overcome by the allowed claims with argument but without amendment (Step G);

subject matter (i.e. disclosure) of prior art references cited by the examiner and applied to specific claim limitations in a 35 USC Section 102/103 rejection which was overcome by the allowed claims with amendment and argument (Step G);

(v) Markman-type terms present in allowed and never rejected claims, and previously construed by the Federal Circuit—such common terms including claim terms present in allowed and never rejected patent claims, and having conventional, presumed or established meaning, including but not limited to: articles, transitional phrases, terms of degree, other terms (e.g. whereby, such as, adapted, conventional, mixture etc), and means plus function (Step H);

(vi) Markman-type terms present in rejected but ultimately allowed claims, and previously construed by the Federal Circuit—such common terms including claim terms present in rejected but ultimately allowed patent claims, and having conventional, presumed or established meaning, including but not limited to: articles, transitional phrases, terms of degree, other terms (e.g. whereby, such as, adapted, conventional, mixture etc), and means plus function (Step I);

(vii) examiner statements related and directly linked (i.e. mapped) to the language of claim sub-limitations by the user (Steps H and I);

(viii) applicant statements related and directly linked to the language of claim sub-limitations by the user (Step H and I);

(ix) reasons for allowance related and directly linked to the language of claim sub-limitations by the user (Steps H and I);

(x) scope concepts embraced by the patent claims and assigned to the language of claim sub-limitations by the user (Step J);

(xi) subject matter of cited and applied prior art references mapped to the sub-limitation language of the allowed patent claims by the user during scope concept based reference analysis performed by the user and using the scope concepts assigned to the allowed patent claims (Step N);

(xii) subject matter of cited but not applied prior art references mapped to the sub-limitation language of the allowed patent claims by the user during scope concept based reference analysis performed by the user and using the scope concepts assigned to the allowed patent claims (Step O);

(xiii) statements made by the examiner during the patent prosecution history, transparently linked to claim sub-limitations in the allowed claims, and listed in a separate column, using the claim concept linking/mapping process of the present invention carried out by the system (Step L);

(xiv) statements made by the applicants/owner during the patent prosecution history, transparently linked to claim sub-limitations in the allowed claims, and listed in a separate column, using the claim concept linking/mapping process of the present invention carried out by the system (Step M);

(xv) “reasons for allowance” statements made by the examiner and possibly commented upon by applicant during the patent prosecution history, transparently linked to claim sub-limitations in the allowed claims, and listed in a separate column, using the scope concept linking/mapping process of the present invention carried out by the system (Steps L and M);

(xvi) subject matter of non-cited and non-applied prior art references mapped to the sub-limitation language of the allowed patent claims by the user during scope concept based reference analysis performed by the user, and using the scope concepts assigned to the allowed patent claims (Step Q);

(xvii) claim invalidity contentions (CIC) based on cited and/or non-cited prior art references—under 35 USC Section 102/103—comprising one or more prior art references which have been scope concept analyzed, and mapped against the limitations of selected allowed patent claims of the granted patent (Step R); and

(xviii) notes on the user's understanding of patent claim construction, scope/boundary conditions, contentions, and the like.

During the patent claim understanding/interpretation process, the claim scope schema (CSS) structure, comprising all information from the patent prosecution history linked together by claim scope concepts (CSC) and contained within the spreadsheet-type chart structure, functions as a framework that helps organize information relating to the scope and meaning of any allowed patent claim represented in the chart structure, to assist anyone interested in better understanding the scope and boundaries offered by allowed patent claims.

Then during Substep S2, while logged into the patent analysis and charting system, display the CSS-based claim contention chart so that the user can: (a) view the pertinent/relevant disclosure of the cited prior art references, along side of (i) the language of corresponding claim limitations, (ii) motivation to combine citations, (iii) reasons for allowance, and (iv) file wrapper estoppel, so as to support patent claim scope and prior art boundary interpretation and help others gain a better understanding the boundaries of patent protection allowed by the patent claims in the granted patent; and (b) record notes in the system database, on the user's understanding of patent claim construction, scope/boundary conditions, contentions, and the like.

As indicated in Step T in FIG. 47E, GUI screens as shown in FIGS. 49HH and 49II are employed, so that the user can (i) analyze the selected prior art references mapped against the limitations of selected allowed patent claims to support potential claim invalidity conventions, (ii) record notes on the potential invalidity contentions against the selected allowed patent claims, and (iii) store such notes in the system database 15.

In the GUI screens shown in FIGS. 49AA through 49GG and described above, a manual method of generating patent claim invalidity contentions has been described in detail. However, in many instances, it will be helpful for the system of the present invention to rapidly and automatically generate all rationally possible patent claim invalidity contentions, based on any given set of set of prior art references being scope concept analyzed against a particular set of scope concept modeled patent claims, whose presumption of validity is being contended. Often times, with large data sets, there will be numerous rationally possible sets of patent claim invalidity contentions to be carefully reviewed by the user, before taking a position and advancing a contention to an opponent and/or court. As show in FIGS. 49JJ and 49KK, the system also provides a powerful automated patent claim invalidity contention reporting and generation capability, that allows for patent claim invalidity contention reports to be quickly generated and easily reviewed, and thereafter, for actual patent claim invalidity contentions to be generated and charted against the patent claims under contention, in accordance with the principles of the present invention. The technical specifications associated with the automated patent claim invalidity contention reporting and generation capabilities of the present invention will now be described in detail below with reference to FIGS. 50B through 50T.

FIG. 50B shows the system architecture enabling the automated generation of all rational sets of patent claim invalidity contentions and charts therefor, as shown in FIGS. 51A through 51H, based on the set of patent claims under patent claim invalidity analysis and a given set of prior art references involved in the patent claim invalidity contention analysis, in accordance with the principles of the present invention. As will be described in greater detail hereinafter, the system architecture of the present invention is also capable of automated generation of summary reports on patent invalidity contention analysis, as shown in FIG. 50T.

Underlying the automated patent claim invalidity contention generation process of the present invention are several important data structures graphically illustrated in FIGS. 50C, 50D and 50E.

FIG. 50C shows a set of Claim Scope Concept Profiles for the set of patent claims that are the subject of a patent claim invalidity contention analysis. This set of claim scope concept profiles are automatically generated by the system when the user scope concept analyzes the set of patent claims that are to be involved in patent claim invalidity contention analysis, although the patent claims could have been scope concept analyzed during different mode of system operation, and stored in the system database 15, for future use. As shown in FIG. 50C, the Claim Scope Concept Profile for each patent claim comprises a List of Scope Concepts that have been assigned to corresponding language in the claim limitations and/or sub-limitations of the patent claim.

FIG. 50D shows a Scope Concept Based Prior Art Reference Analysis GUI for use in scope concept analyzing a set of prior art references in view of a specific set of patent claims under patent claim invalidity contention analysis. The scope concept based prior art reference analysis GUI has been described in greater detail with reference to the patent claim scope interpretation/construction analysis mode (i.e. Mode 1), hereinabove. The scope concept based prior art reference analysis GUI generated for a given set of patent claims comprises query fields based on the entire set of scope concepts formulated for the entire set of patent claims so that during a one-pass analysis through a prior art reference, using the scope concept based prior art reference analysis GUI, the user will be able to capture prior art disclosure (e.g. searchable text and/or searchable graphics and/or images) that substantiates the scope concepts which the prior art reference can substantiate by its own prior art disclosure (e.g. searchable text and/or searchable graphics and/or images). In essence, this GUI contains query fields for the user to enter disclosure from the analyzed prior art reference, that substantiates or otherwise provides prior art support for the scope concept on which the query field is based. All of the collected prior art disclosure (e.g. searchable text and/or searchable graphics and/or images) is stored in the system database, indexed against the prior art reference, the scope concept to which it relates, the patent claim(s) to which the scope concept has been assigned, and the specific language of the claim limitation and/or claim sub-limitation to which the scope concept has been linked in the system database, for a given user group.

FIG. 50E shows a Set of Prior Art Reference Scope Concept Profiles for the set of prior art references that have been scope concept analyzed during patent claim invalidity contention analysis using the scope concept based prior art reference analysis GUI shown in FIG. 50D. As shown, and described hereinabove, the set of prior art reference scope concept profiles are generated for the set of prior art references that have been analyzed during prior art reference analysis using the Scope Concept Based Prior Art Reference Analysis GUI of FIG. 50D. The prior art reference scope concept profile for each Prior Art Reference comprises: (i) a master scope concept list indicating which scope concepts have and have not been substantiated by disclosure from the prior art reference, and (ii) a claim scope concept list, for each patent claim, indicating which scope concepts in each patent claim have and have not been substantiated by disclosure from the prior art reference, with a citation from the prior art reference as to where the substantiating disclosure can be found in the prior art reference.

Referring now to the flow chart set forth in FIGS. 50F through 50L, a automated method will now be described in detail, for rationally generating patent claim invalidity contention analysis reports, and patent claim invalidity contention charts, using an automatic (i.e. programmed) patent claim invalidity contention analysis and generation module within the patent analysis and charting system of the present invention.

As indicated in Step 1 in FIG. 50F, the user provides a set of patent claims to be challenged during patent claim invalidity contention analysis, carried out on the system of the present invention, where the set of patent claims may be selected from one or more granted patents, as the case may require.

As indicated in Step 2 in FIG. 50F, the user also provides a set of prior art references (e.g. patents, patent application publications, and other printed publications) for use during the patent claim invalidity contention analysis. Notably, each prior art reference may be in any one of the following classes of prior art references selected from the group consisting: only new prior art references; only cited but not applied prior art references; new prior art references and cited but not applied prior art references; new prior art references, and cited and applied prior art references; and new prior art references and cited prior art references.

As indicated in Step 3 in FIG. 50F, during claim scope concept analysis, formulation and assignment, described in detail with reference to FIGS. 24 through 26D, the user assigns one or more scope concepts to each patent claim in the set of patent claims under patent claim invalidity contention analysis. Notably, one or more scope concepts form a library of scope concept (“scope concept library”) for the set of patent claims, maintained in the system database, and accessible by clicking on a scope concept library icon display on the system GUIs.

As indicated in Step 4 in FIG. 50F, the system automatically generates a set of claim scope concept profiles for the set of patent claims that have been scope concept analyzed during patent claim invalidity contention analysis. The claim scope concept profile for each patent claim comprises a list of scope concepts that have been assigned to corresponding language in the claim limitations and/or sub-limitations of the patent claim.

As indicated in Step 5 in FIG. 50G, the system generates a scope concept based prior art reference analysis GUI based on the set of one or more scope concepts. The scope concept based prior art reference analysis GUI comprises query fields based on the entire set of scope concepts formulated for the entire set of patent claims so that, during a one-pass analysis through a prior art reference, using the scope concept based prior art reference analysis GUI, the user will be able to capture prior art disclosure (e.g. searchable text and/or searchable graphics and/or images) that substantiates the scope concepts which the prior art reference can substantiate by the substance of its own prior art disclosure (e.g. searchable text and/or searchable graphics and/or images).

As indicated in Step 6 in FIG. 50G, the user (e.g. preferably a technical subject matter expert) uses the scope concept based prior art reference analysis GUI generated in Step 5 to (i) analyze each prior art reference in the set of prior art references, and (ii) enter disclosure language from the prior art reference (and/or a citation in the prior art reference) into the corresponding query field of the GUI, as being disclosure in the prior art reference that corresponds to the scope concept.

As indicated in Step 7 in FIG. 50G, the system automatically generates a set of prior art reference scope concept profiles for the set of prior art references that have been analyzed during prior art reference analysis using the scope concept based prior art reference analysis GUI. Notably, the prior art reference scope concept profile for each prior art reference comprises: (i) a master scope concept list indicating which scope concepts have been substantiated by disclosure from the prior art reference; and (ii) a claim scope concept list, for each patent claim, indicating which scope concepts in each patent claim have been substantiated by disclosure from the prior art reference, with a citation from the prior art reference as to where the substantiating disclosure can be found in the prior art reference.

As indicated in Step 8 in FIG. 50G, the user selects the legal basis on which automated patent claim invalidity contention analysis should be performed (i.e. 35 USC Section 102, and/or 35 USC Section 103) during the automated patent claim invalidity contention analysis and chart and report generation process of the present invention.

As indicated in Step 9 in FIG. 50H, the user selects the class of prior art references which shall be used during automated patent claim invalidity contention analysis and generation process. The class of prior art references is selected from the group comprising: only new prior art references; only cited but not applied prior art references, new prior art references and cited but not applied prior art references, new prior art references, cited and applied prior art references, or new prior art references and cited prior art references.

As indicated in Step 10 in FIG. 50H, for 35 USC Section 103 Invalidity Contentions, the user is asked to select values for two process parameters/variables, namely: (i) the Degree of Scope Concept Overlap required between prior art references (e.g. 1^{st} Degree of Scope Concept Overlap=each reference In the configured/combined set of prior art references has one substantiated scope concept in common, 2nd Degree of Scope Concept Overlap=each reference In the configured/combined set of prior art references has two substantiated scope concepts in common, and 3rd Degree of Scope Concept Overlap=each reference In the configured/combined set of prior art references has three substantiated scope concepts in common); and also (ii) the maximum number of prior art references that can be combined to substantiate all of the scope concepts in any patent claim under patent claim invalidity contention analysis.

As indicated in Step 11 in FIG. 50H, the system automatically configures its automatic patent claim invalidity contention analysis and chart and report generation module using the selections made in Steps 8, 9 and 10 above.

As indicated in Step 12 in FIG. 50H, the system then load the following data items into buffer memory within the automatic patent claim invalidity contention analysis and chart and report generation module: (i) the selected class of prior art references; (ii) the generated set of Claim Scope Concept Profiles; and (iii) the generated set of prior art reference scope concept profiles.

In illustrative embodiment, system GUI screens supporting Steps 1, 2, 8, 9, 10, 11 and 12 above are selected in GUI screens set forth in FIGS. 49HH and 49II, and displayed in the GUI screens of FIGS. 49JJ and 49KK, showing user Steps A, B, C, D, E, F, G, and H, described below:

### Step A: Select a Set of Patent Claims for Patent Claim Invalidity Contention Analysis

All Claims; or

Only Claims ______

### Step B: Select a Class of Prior Art References to Support the Patent Claim Invalidity Analysis

Only New Prior Art References;

Only Cited But Not Applied Prior Art References;

New Prior Art References and Cited But Not Applied Prior Art References;

New Prior Art References, and Cited and Applied Prior Art References; or

New Prior Art References and Cited Prior Art References.

### Step C: Generate a Set of Claim Scope Concept Profiles for the Selected Set of Patent Claims Under Patent Claim Invalidity Contention Analysis

Generate the Set of Claim Scope Concept Profiles

### Step D: Generate a Set of Prior Art Reference Scope Concept Profiles for the Selected Set of Prior Art References

Generate the Set of Prior Art Scope Concept Profiles for the Selected Set of Prior Art References

Step E: Select Legal Basis on which Patent Claim Invalidity Contention Analysis should be Performed

35 USC Section 102

35 USC Section 103

35 USC Sections 102 and 103

### Step F: For 35 USC Section 103 Invalidity Contentions, Select the Degree of Scope Concept Overlap Required Between Prior Art References

1^{st} Degree of Scope Concept Overlap

2^{nd} Degree of Scope Concept Overlap

3rd Degree of Scope Concept Overlap

Step G: Select the Maximum Number of Prior Art References that can be Combined to Substantiate all of the Scope Concepts in any Patent Claim Under Section 103 Patent Claim Invalidity Contention Analysis

2 Prior Art References

3 Prior Art References

4 Prior Art References

### Step H: Load Selected Parameters and Configure System for Automated Patent Claim Invalidity Contention Report Generation

Load and Configure

### Processing Logic for 35 USC Section 102 Patent Claim Invalidity Contention Analysis and Generation

As indicated in Step 13 of FIG. 50I, if 35 USC Section 102 Legal Basis has been selected by the user during Step 8, then the system 5 performs the following operations in an automated manner.

As indicated in Substep (A) of FIG. 50I, the system analyzes the Prior Art Reference Scope Concept Profile that has been generated for each analyzed Prior Art Reference, and identifies each Claim Scope Concept Profile having all of its Scope Concepts substantiated by the Prior Art Reference. This step is achieved by determining/confirming that the prior art reference contains prior art disclosure (e.g. searchable text and/or searchable graphics and/or images) that was mapped to a scope concept based search query in the corresponding Scope Concept Based Prior Art Reference Analysis GUI, which in turn, automatically populated the corresponding scope concept contained in the Prior Art Reference Scope Concept Profile.

As indicated in Substep (B) of FIG. 50I, based on the results of Substep (A) above, the system generates a List of Section 102 Patent Claim Invalidity Contentions, wherein each Section 102 Patent Claim Invalidity Contention comprises:

(i) each Patent Claim in the Set of Patent Claims having all of its Scope Concepts substantiated by the Prior Art Reference;

(ii) identification of the Prior Art Reference; and

(iii) the Claim Scope Concept Profile for the Patent Claim, and cited disclosure from the Prior Art Reference mapped against the corresponding Scope Concepts, and corresponding limitations and/or sub-limitations in the Patent Claim.

As indicated in Substep (C) of FIG. 50I, the system indexes the List of Section 102 Patent Claim Invalidity Contentions by the data items loaded into buffer memory in Step (12), and stores the indexed List of Section 102 Patent Claim Invalidity Contentions, in the system database.

As indicated in Substep (D) of FIG. 50I, using the GUI screen shown in FIG. 49II, the system commands the system to generate a Patent Claim Invalidity Contention Analysis Report containing an indexed List of Section 102 Patent Claim Invalidity Contentions, for review and subsequent analysis.

As indicated in Substep (E) of FIG. 50I, using the GUI screen shown in FIGS. 49JJ and 49KK, the user commands the system to automatically generates a Patent Claim Invalidity Contention Chart for each Section 102 Patent Claim Invalidity Contention listed in the Report generated in Substep (D), for subsequent display, review and analysis.

Processing Logic for 35 USC Section 103 Patent Claim Invalidity Contention Analysis and Generation—Involving n=N Number of Stages of Claim Scope Concept Profile Processing, Performed Over m=M Number of Primary Prior Art Reference (PPAR) Candidates, for a Total of M×N Stages of Processing, where N is the Total Patent Claims Under Analysis {n=1, 2, . . . , N−1, N}, and M is the Total Number of Prior Art References {m=1, 2, . . . , M−1, M

As indicated in Step 14 of FIGS. 50J, 50K and 50, if the 35 USC Section 103 Legal Basis has been selected by the user in Step 8, then the system performs the following operations.

As indicated in Substep (A) of FIG. 50J, the system accesses the Prior Art Reference Scope Concept Profile that has been generated for each m-th Prior Art Reference in the Selected Class of Prior Art References, and buffer these M Prior Art Reference Scope Concept Profiles in system memory.

As indicated in Substep (B) of FIG. 50J, for each m-th Prior Art Reference Scope Concept Profile, the system indexes its corresponding Prior Art Reference as a (Primary) Prior Art Reference (PPAR) for patent claim invalidity contention analysis purposes, and then performs the following operations for the m-th (Primary) Prior Art Reference, where m is the reference index defined a m={1, 2, 3, . . . , N−1, N}, and the Prior Art Reference Scope Concept Profile Processing Loop starts with the (m=1)th Prior Art Reference Scope Concept Profile.

As indicated in Substep (C) of FIG. 50J, for each n-th Claim Scope Concept Profile in the Prior Art Reference Scope Concept Profile for the m-th analyzed Prior Art Reference, the system performs the following operations for the n-th Claim Scope Concept Profile, where n is the claim index defined as n={1, 2, 3, . . . , N−1, N} and the Claim Scope Concept Profile Processing Loop starts with the (n=1)th Claim Scope Concept Profile:

(1) analyze the n-th Claim Scope Concept Profile, and if it has at least one, but not all, of its Scope Concepts substantiated) by cited disclosure in the Prior Art Reference (i.e. represented by prior art disclosure/citation), then further analyze the corresponding n-th Claim Scope Concept Profile in the Prior Art Reference Scope Concept Profile for all of the remaining (M−1)th (Secondary) Prior Art References in the Selected Class of Prior Art References, so as to identify each set of remaining (Secondary) Prior Art References that has disclosure to substantiate all of the Scope Concepts that the first (Primary) Prior Art Reference failed to substantiate, and wherein the first (Primary) Prior Art Reference and the remaining (Secondary) Prior Art References satisfy the Degree of Scope Concept Overlap required between the Prior Art References selected in Step 10 and the total number of Prior Art References does not exceed the total number selected in Step 10; and

(2) for each identified set of remaining (M−1)th (Secondary) Prior Art References identified in Substep (1) above, which has disclosure that substantiates all of the Scope Concepts which the first (Primary) Prior Art Reference fails to substantiate (i.e. does not contain prior art disclosure corresponding to at least one Claim Scope Concept), the system performs the following operations:

(a) automatically combine the identified set of remaining (Secondary) Prior Art References with the first (Primary) Prior Art Reference so as to form a candidate subset of Prior Art of References that may substantiate a patent claim invalidity contention for the first Patent Claim identified by its Claim Scope Concept Profile in the Prior Art Reference Scope Concept Profile for the first analyzed (Primary) Prior Art Reference;

(b) add each such Subset of Prior Art References to a List of Section 103 Patent Claim Invalidity Contentions that is stored within the system database 15, wherein each Section 103 Patent Claim Invalidity Contention comprises each Patent Claim in the Set of Patent Claims having all of its Scope Concepts substantiated by a Subset of (Primary and Secondary) Prior Art References, an identification of the Subset of (Primary and Secondary) Prior Art References, and the Claim Scope Concept Profile for the Patent Claim, and cited disclosure from the set of Prior Art References mapped against the corresponding Scope Concepts;

(c) index the List of Section 103 Patent Claim Invalidity Contentions by the data items loaded into buffer memory in Step 12;

(d) store the indexed List of Section 103 Patent Claim Invalidity Contentions, in the system database 15;

(e) (1) if patent claim index n<N, then return to Substep (C), remain in the Claim Scope Concept Profile Processing Loop, increment the claim index n by 1, repeat operations in Substep (C) for each n-th Claim Scope Concept Profile, until all N Claim Scope Concept Profiles have been processed;

(e) (2) however, if n=N, then advance to Substep (f) below; and

(f) if prior art reference index m<M, then return to Substep (B), remain in the Prior Art Reference Scope Concept Profile Processing Loop, increment the reference index by 1, repeat operations in Substep (B) for each m-th Prior Art Reference Scope Concept Profile, until all M Prior Art Reference Scope Concept Profiles have been processed, so that each m-th Prior Art Reference has been considered and processed as a (Primary) Prior Art Reference during Patent Claim Invalidity Contention Analysis;

however, if m=M, then advance to Substep (D) below.

As indicated in Substep (D) in FIG. 50L, the system indexes the List of Section 103 Patent Claim Invalidity Contentions by the data items loaded into buffer memory in Step (12), and stores the indexed List of Section 103 Patent Claim Invalidity Contentions, in the system database 15.

As indicated in Substep (E) in FIG. 50L, using the GUI screens shown in FIGS. 49HH and 49II, the user commands the system to generate a Patent Claim Invalidity Contention Analysis Report containing the indexed List of Section 103 Patent Claim Invalidity Contentions, for review and subsequent analysis.

As indicated in Substep (F) in FIG. 50L, using the GUI screens shown in FIGS. 49JJ and 49KK, the user commands the system to generate a Patent Claim Invalidity Contention Chart for each Section 103 Patent Claim Invalidity Contention listed in the Report generated in Substep (E), for subsequent display, review and analysis.

Graphical Illustration of the N Number of Claim Scope Concept Profile Processing Stages Carried Out within the M Number of Stages of Primary Prior Art Reference Processing, During the Automated Generation of Patent Claim Invalidity Contentions, and Related Summary Patent Claim Invalidity Contention Analysis Reports, in Accordance with the Principles of the Present Invention

FIG. 50M illustrates a processing stage, within the multi-mode patent analysis and charting system of the present invention, configured in its patent claim invalidity contention analysis mode, involving the Claim Scope Concept List for the (n=1)th patent claim in the Prior Art Reference (Claim) Scope Concept Profile that has been generated for the (m=1)th analyzed prior art reference being considered as a Primary Prior Art Reference (PPAR).

FIG. 50N illustrates a processing stage, within the multi-mode patent analysis and charting system of the present invention, configured in its patent claim invalidity contention analysis mode, involving the Claim Scope Concept List for the (n=N)th patent claim in the Prior Art Reference (Claim) Scope Concept Profile for the (m=1)th analyzed prior art reference being considered as a Primary Prior Art Reference (PPAR).

FIG. 50O illustrates a processing stage, within the multi-mode patent analysis and charting system of the present invention, configured in its patent claim invalidity contention analysis mode, involving the Claim Scope Concept List for the (n=1)th patent claim in the Prior Art Reference (Claim) Scope Concept Profile that has been generated for the (m=2)th analyzed prior art reference being considered as a Primary Prior Art Reference (PPAR).

FIG. 50P illustrates a processing stage, within the multi-mode patent analysis and charting system of the present invention, configured in its patent claim invalidity contention analysis mode, involving the Claim Scope Concept List for the (n=N)th patent claim in the Prior Art Reference (Claim) Scope Concept Profile that has been generated for the (m=2)th analyzed prior art reference being considered as a Primary Prior Art Reference (PPAR).

FIG. 50Q illustrates a processing stage, within the multi-mode patent analysis and charting system of the present invention, configured in its patent claim invalidity contention analysis mode, involving the Claim Scope Concept List for the (n=1)th patent claim in the Prior Art Reference (Claim) Scope Concept Profile for the (m=M)th analyzed prior art reference being considered as a Primary Prior Art Reference (PPAR).

FIG. 50R illustrates a processing stage, within the multi-mode patent analysis and charting system of the present invention, configured in its patent claim invalidity contention analysis mode, involving the Claim Scope Concept List for the (n=N)th patent claim in the Prior Art Reference (Claim) Scope Concept Profile that has been generated for the (m=M)th analyzed prior art reference being considered as a Primary Prior Art Reference (PPAR).

After performing N×M of these processing stages in an automated manner, the system will rationally generate up to N×M possible claim invalidity analyses (but most likely significantly less each processing run) and corresponding claim invalidity contention charts indicating computed combinations of prior art references which should or is likely to contain prior art disclosure that is very likely to be relevant to the issue of validity/invalidity of the claim to which each generated chart corresponds. The user can then analyze these generated charts and quickly determine which prior art references are in fact very relevant, somewhat relevant, or irrelevant, as the case may be. If the claims were properly scope concept analyzed and the prior art references were properly analyzed using the Claim Scope Concept (CSC) Based Prior Art Reference Analysis GUI (generated for the set of claims under analysis), then it is expected that the results of this automated rational claim invalidity contention analysis should be of high quality, and of great value to the analysis of the claims before the user/analyzer.

FIG. 50S illustrates a sample patent claim invalidity contention report generated by the multi-mode system 5 while configured in its patent claim invalidity contention analysis mode of system operation. As shown, this sample report contains the following information:

### SAMPLE PATENT CLAIM INVALIDITY CONTENTION REPORT

### START OF REPORT

### PATENT AND CLAIMS ANALYZED:

US Patent No. XYZ

### Claim Nos. 1-4

### Prior Art References Analyzed:

### New Un-Cited Prior Art References (Retrieved During Invalidity Search): Total 25

### List of References:

### Cited and Non-Applied Prior Art References (During Patent Prosecution): Total 45

### List of References:

### Cited and Applied Prior Art References (During Patent Prosecution): Total 4

### List of References:

### All Prior Art References Under Analysis: Total 74

### List of References:

### RATIONAL PATENT CLAIM INVALIDITY CONTENTIONS GENERATED AGAINST CLAIM 1

### Under 35 USC Section 102:

### Based on New Un-Cited Prior Art References: Total 2

### Using Cited and Non-Applied Prior Art References: Total 0

### Using Cited and Applied Prior Art References: Total 0

### Using All Prior Art References: Total 2

### Under 35 USC Section 103:

### Maximum Number of Prior Art References That Can Be Combined: Total 3 Based on

### New Un-Cited Prior Art References:

### With 1^{st} Degree of Concept Scope Concept Overlap: Total 30

### With 2nd Degree of Concept Scope Concept Overlap: Total 20

### With 3rd Degree of Concept Scope Concept Overlap: Total 10

### Under 35 USC Section 103:

### Maximum Number of Prior Art References That Can Be Combined: Total 3 Based on

### Cited and Non-Applied Prior Art References:

### With 1^{st} Degree of Concept Scope Concept Overlap: Total 12

### With 2nd Degree of Concept Scope Concept Overlap: Total 8

### With 3rd Degree of Concept Scope Concept Overlap: Total 4

### Under 35 USC Section 103:

### Maximum Number of Prior Art References That Can Be Combined: Total 3 Based on

### New and Cited and Applied Prior Art References:

### With 1^{st} Degree of Concept Scope Concept Overlap: Total 35

### With 2nd Degree of Concept Scope Concept Overlap: Total 25

### With 3rd Degree of Concept Scope Concept Overlap: Total 15

*

### END OF REPORT

Improving the Resolution of Patent Claim Scope Determination when Both Patent Owner and Competitors Use the Multi-Mode Patent Analysis and Charting System Configured in its Patent Claim Invalidity Contention Analysis Mode of System Operation

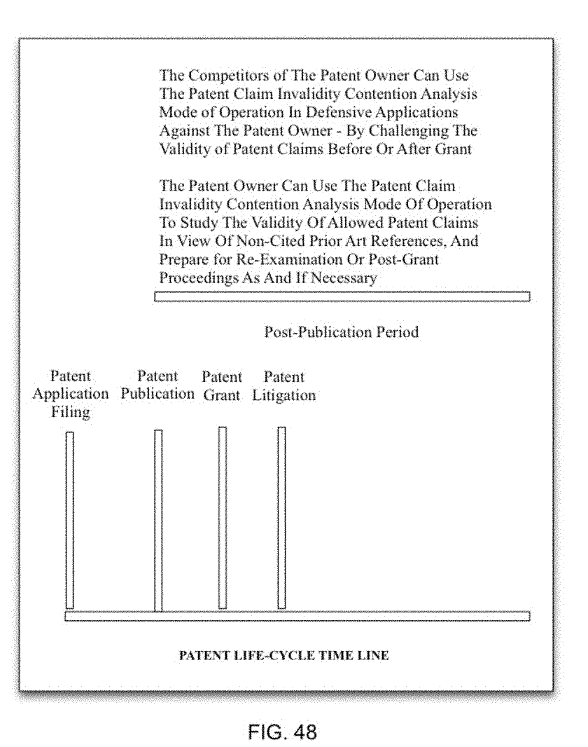

FIG. 48 illustrates the application of the multi-mode patent analysis and charting system configured in its patent claim invalidity contention analysis mode of system operation, and deployed during particular phases of the patent life-cycle time line, by both the patent owner and its competitors. As shown, the competitor can use the patent claim invalidity contention analysis mode of operation in defensive applications against the patent owner, namely, by (i) better understanding the scope and boundaries of the allowed patent claims, against a landscape of scope concept mapped prior art references displayed in the claim scope schema (CSS) chart structures, and (ii) identifying claim invalidity contention cases using new prior art references scope concept mapped against the allowed patent claims in the CSS chart structures. Also, patent owner can use the patent claim invalidity contention analysis mode of operation in defensive applications against competitors, by (i) better understanding the scope and boundaries of patent protection afforded by the claims, and (ii) mapping the prior art references in claim invalidity contentions against the allowed patent claims and cited prior art references, in the CSS chart structure, so as determine when new non-cited prior art references, applied by defendant/competitors in patent claim invalidity contentions (e.g. during patent claim disputes or litigation proceedings) are merely duplicative prior art that has already been considered by the patent by examiner during patent prosecution. Thus the system provides patent owners with a powerful tool to counter-challenge patent invalidity contentions raised against the patent owners' patent claims. The ability of the system to be used by both patent owners and competitors provides an opportunity for better resolution of patent claim scope and boundaries, and a true and proper determination of patent protection afforded by the patent claims.

### Specification of the Multi-Mode Patent Analysis and Charting System of the Present Invention Configured in its Patent Claim Infringement Analysis Mode of System Operation (Mode 6)

FIG. 52 is a schematic diagram illustrating the information mapping process supported by the system during its patent claim infringement analysis mode of system operation, wherein patent claim data, prosecution history data, court-specified claim term meaning definitions for common claim terms, and product and/or service data relating to products and/or services under investigation, are mapped to particular fields within the claim chart structures generated during this particular mode of system operation.

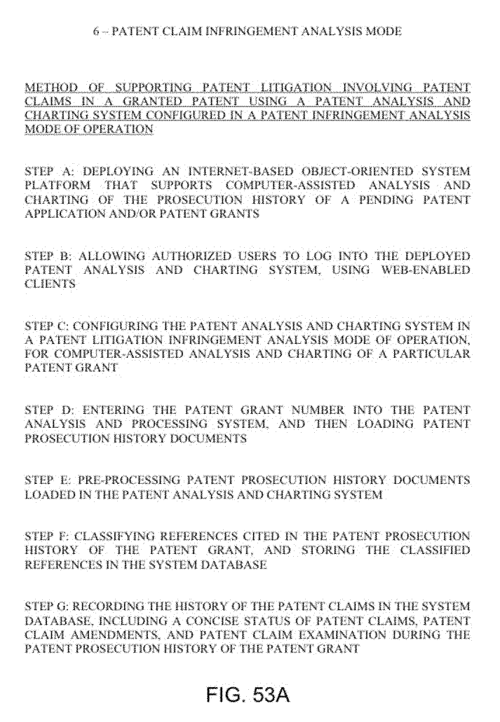

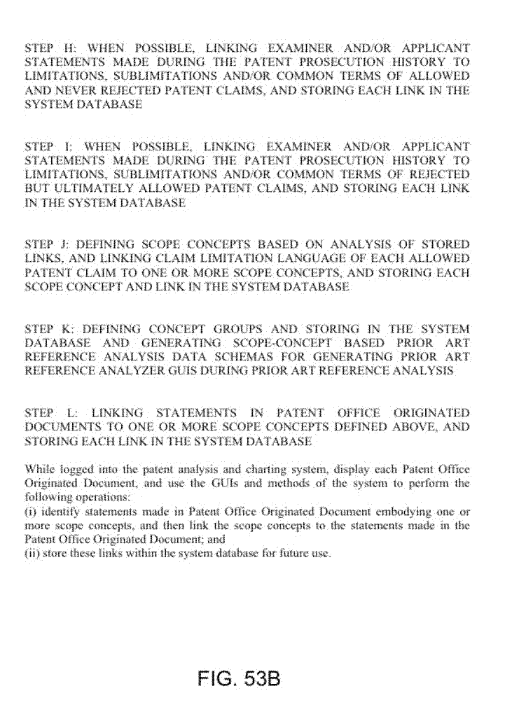

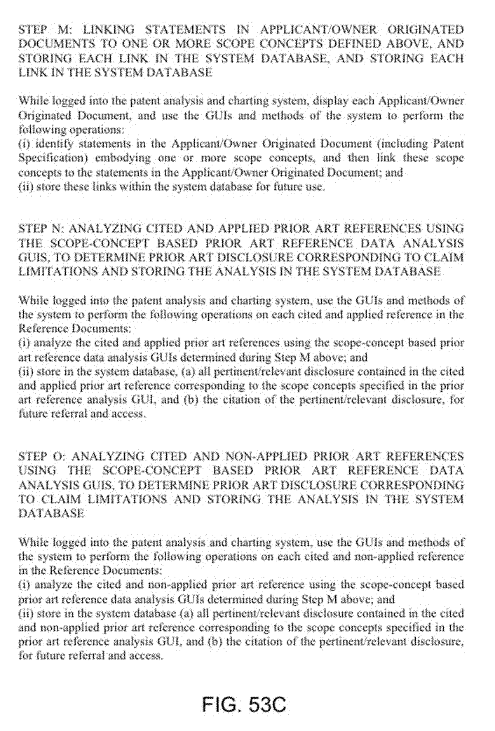

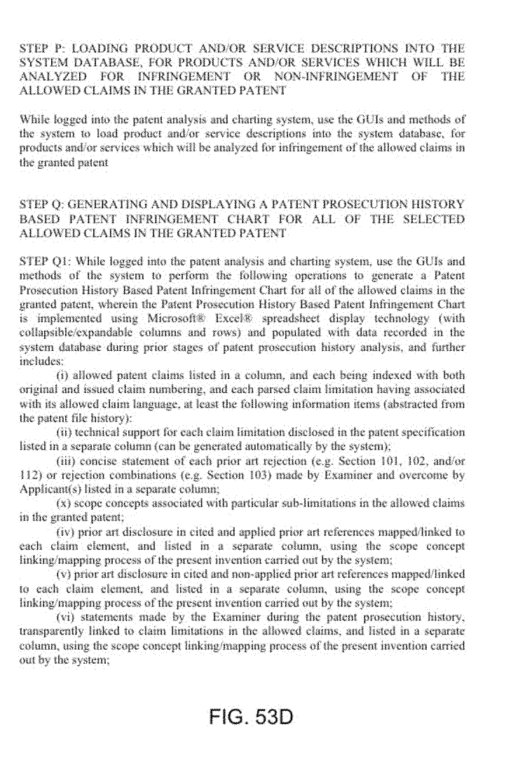

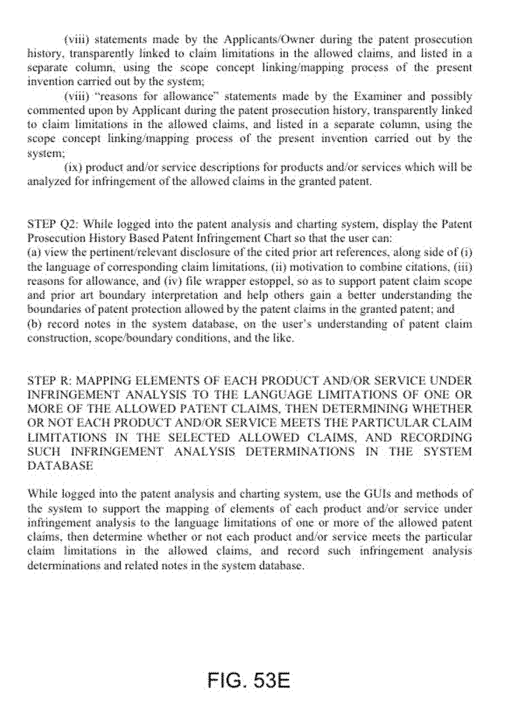

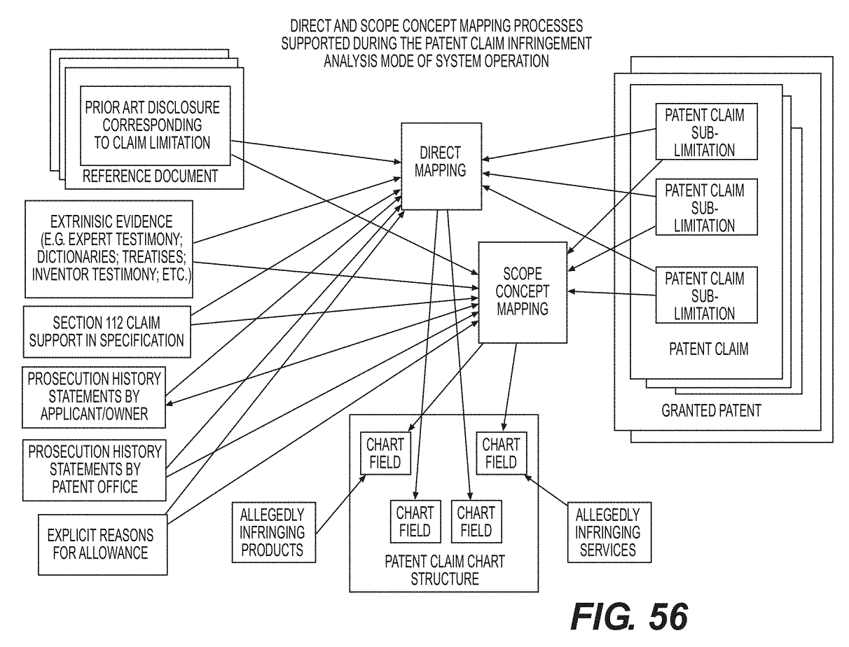

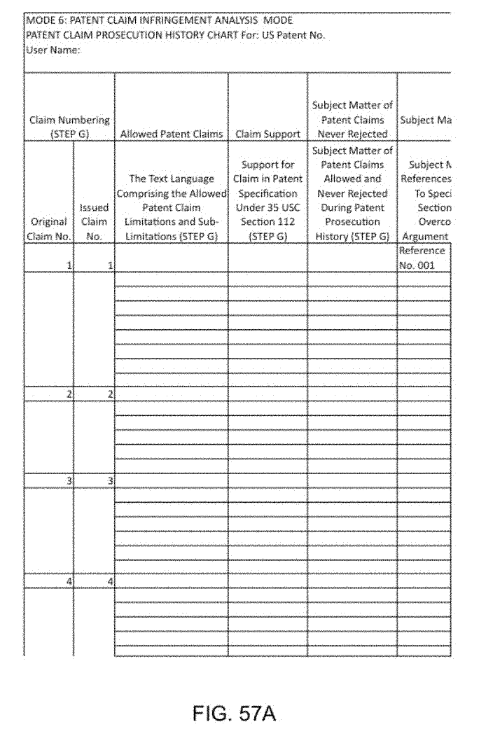

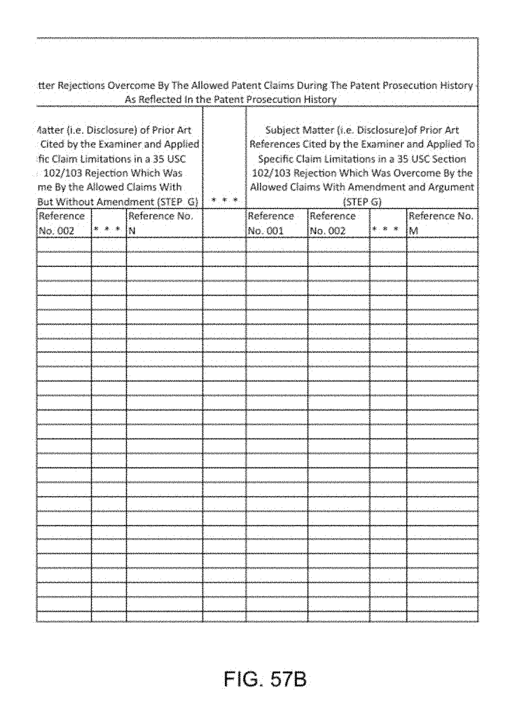

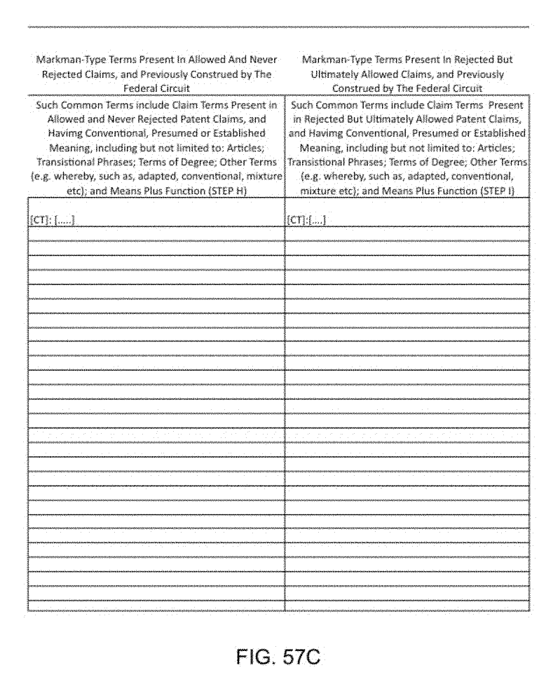

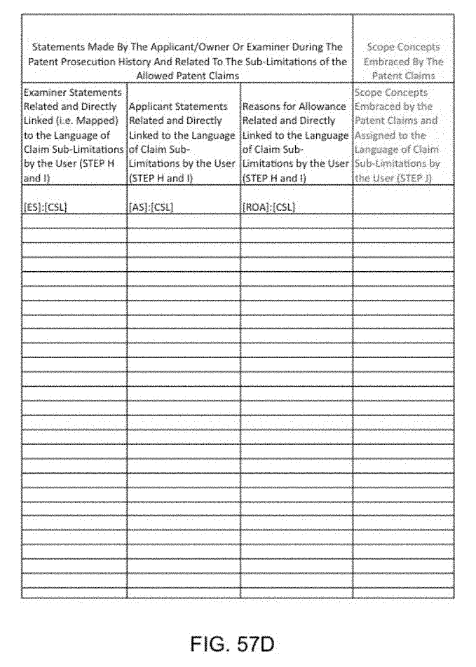

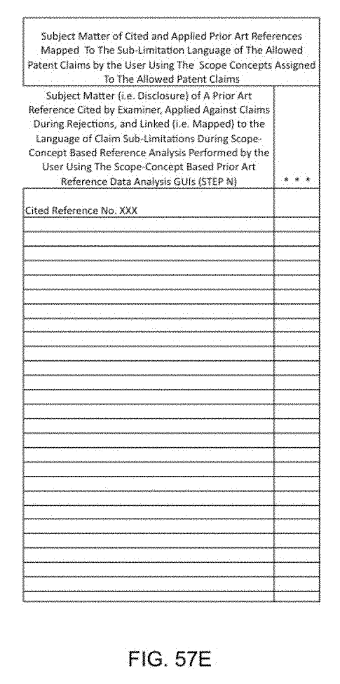

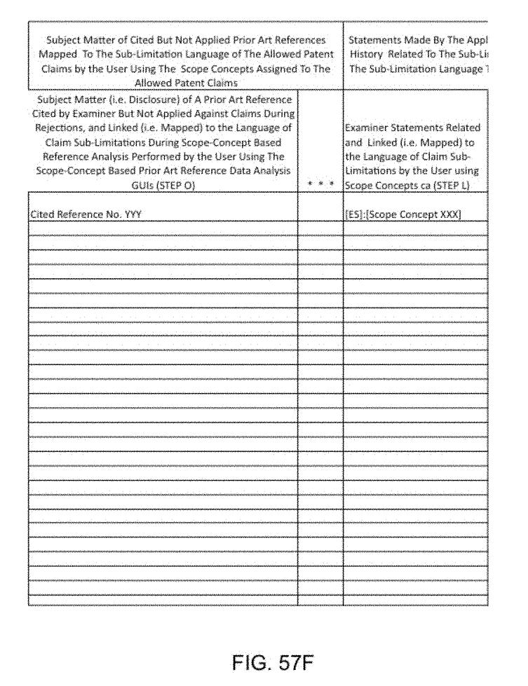

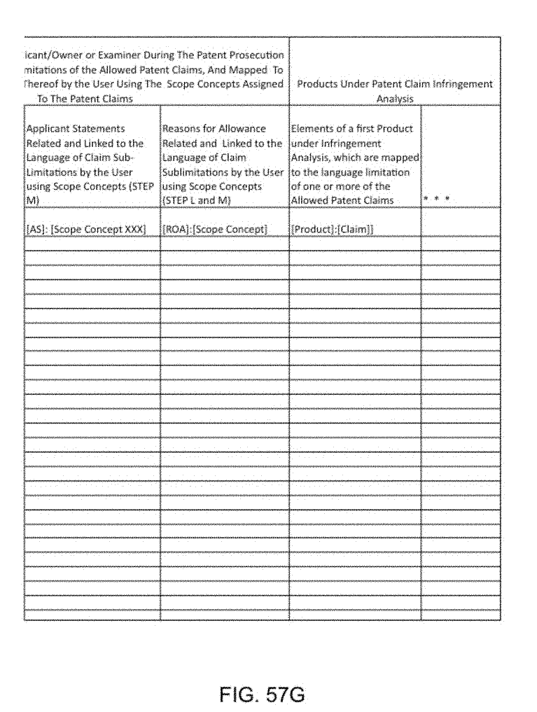

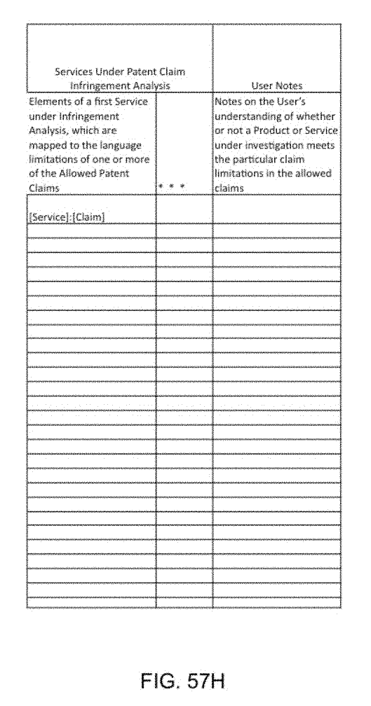

The workflow process specified in FIGS. 53A through 53DD will be described now in greater detail with reference to corresponding wireframe GUIs shown in FIGS. 57A through 57H, and the information mapping process illustrated in FIGS. 52 and 56. Upon completion of the workflow process, the multi-mode system in its the patent claim infringement analysis mode will automatically generate and display an XML-based spreadsheet-based claim scope schema (CSS) chart structure as illustrated in FIG. 57A through 57H, that can be used by various users in any given user work group, including patent attorneys, during patent claim scope/boundary interpretation and other analytical efforts.

For presentation purposes only, the XML-based spreadsheet-based CSS chart structure shown in FIGS. 57A through 57H has been broken down into several sections in the figure Drawings, and should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

### Method of Supporting Patent Litigation Involving Patent Claims in a Granted Patent Using a Patent Analysis and Charting System Configured in a Patent Infringement Analysis Mode of Operation (Mode 6)

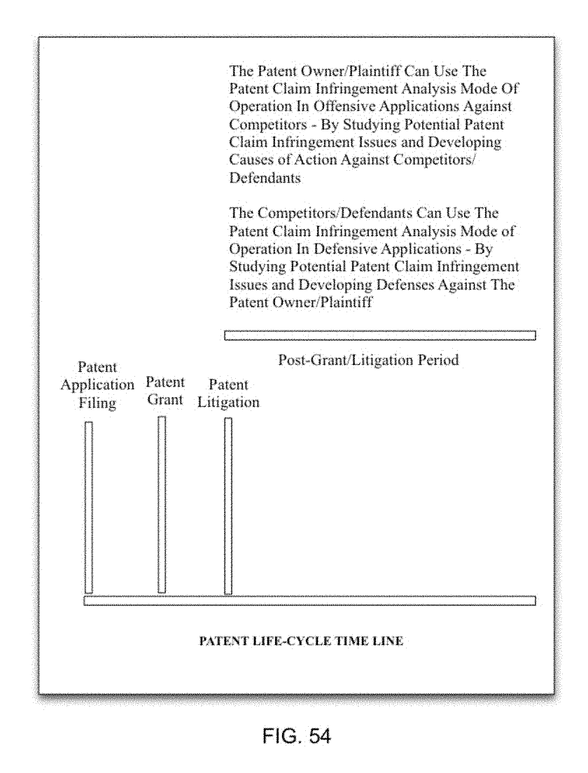

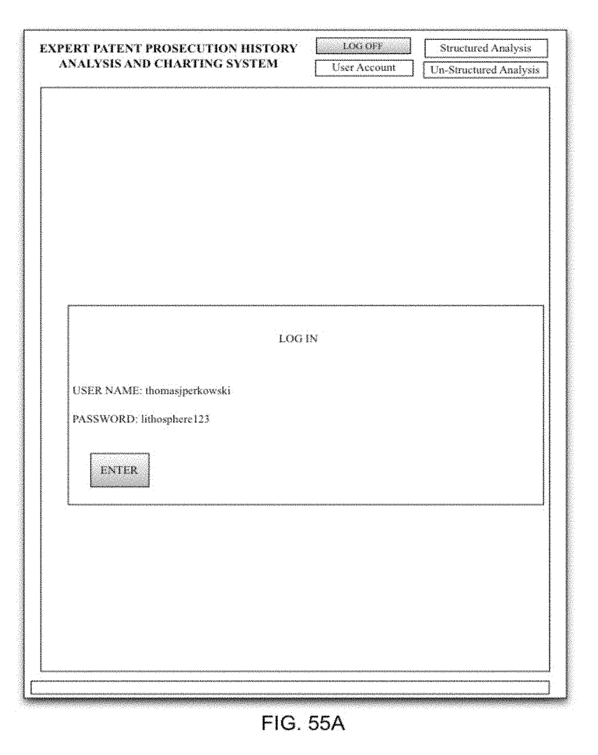

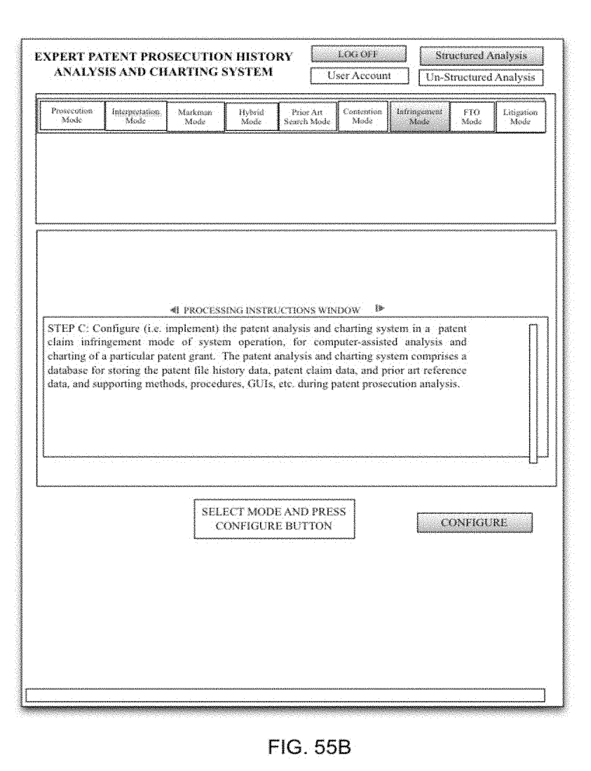

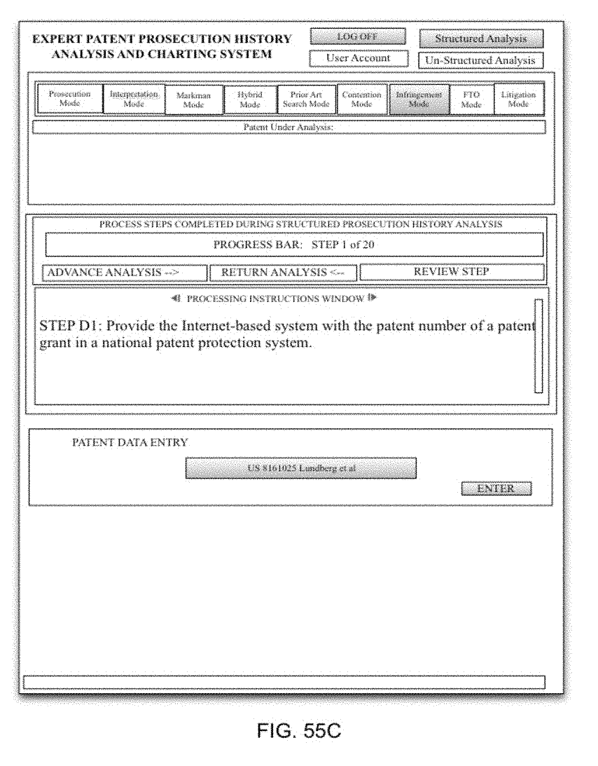

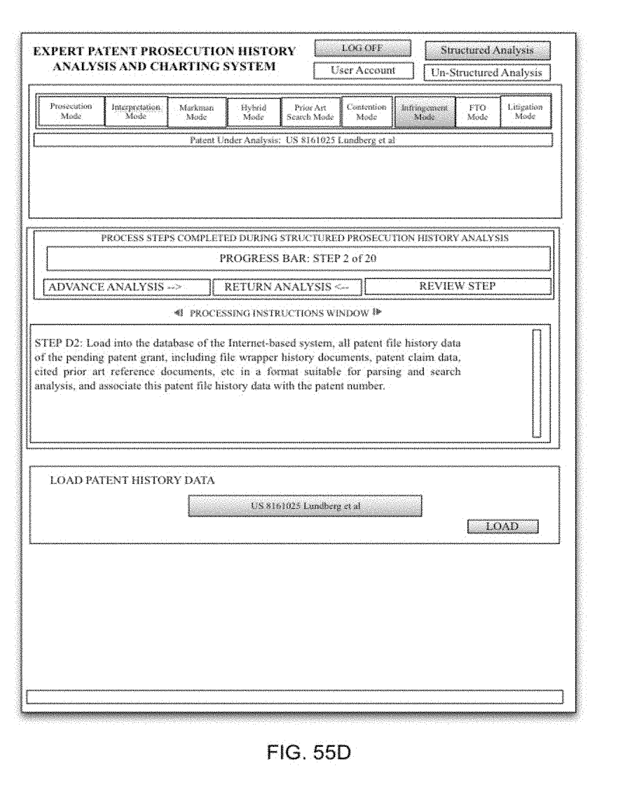

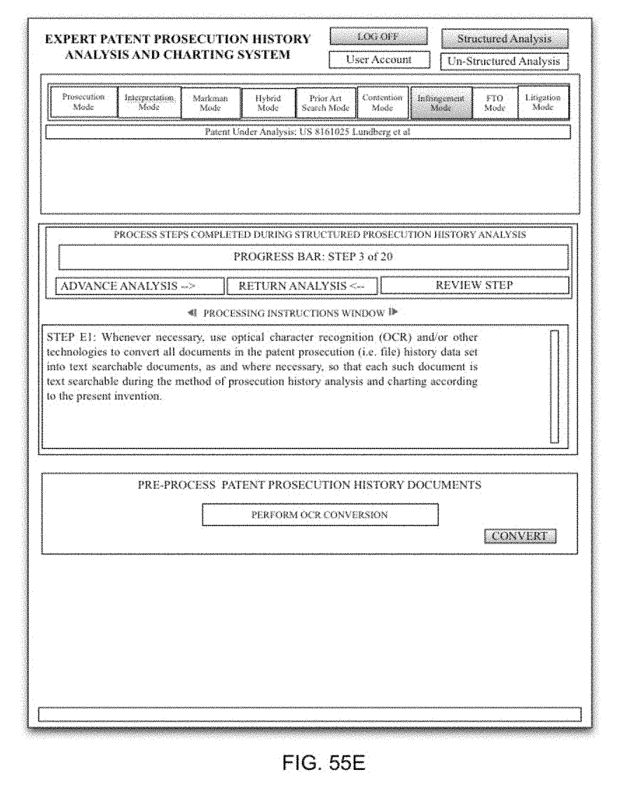

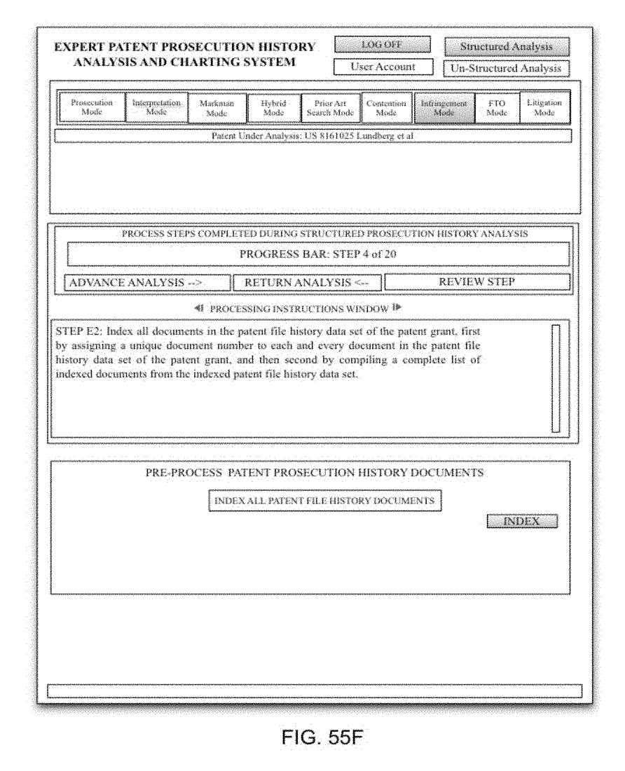

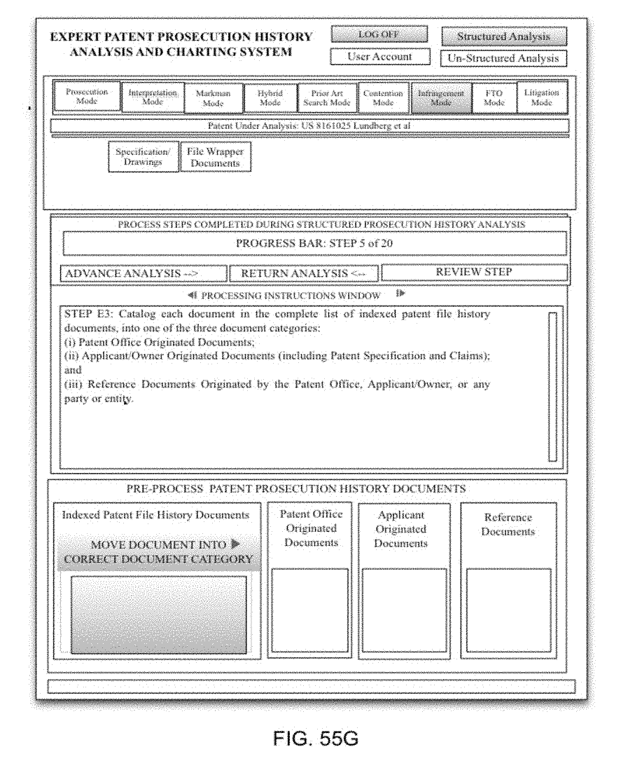

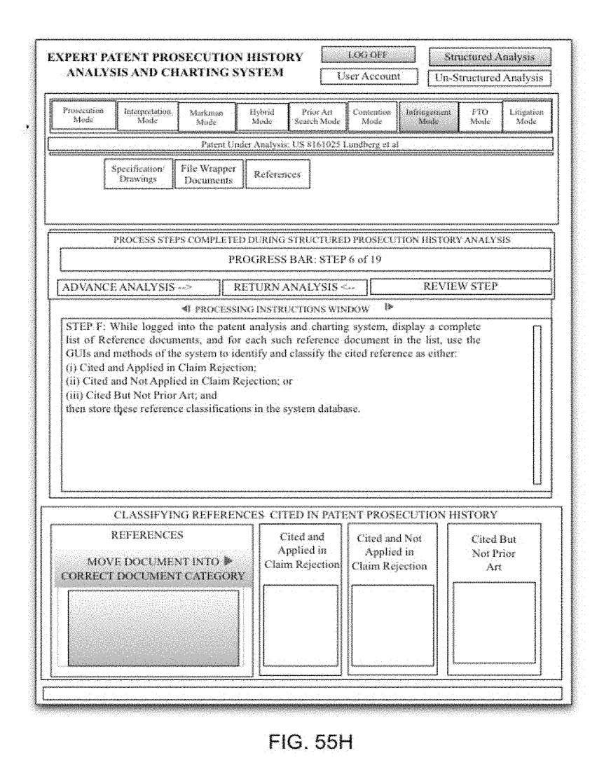

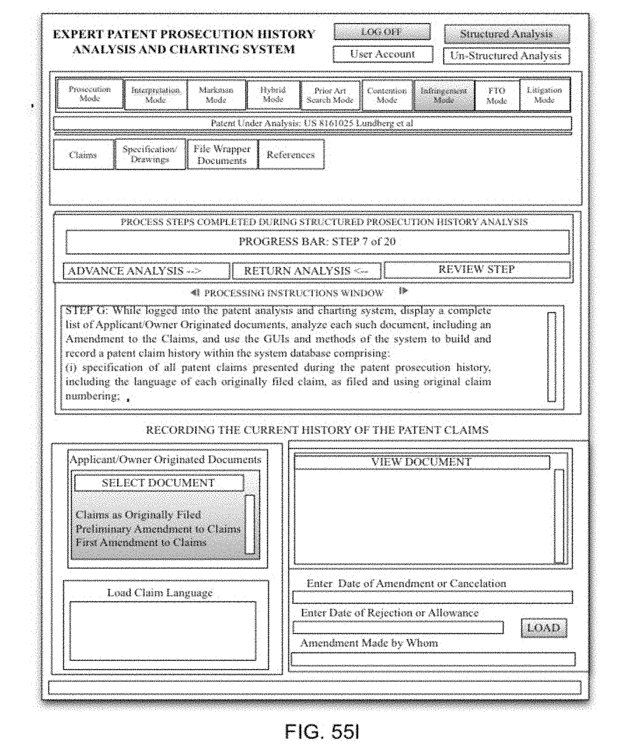

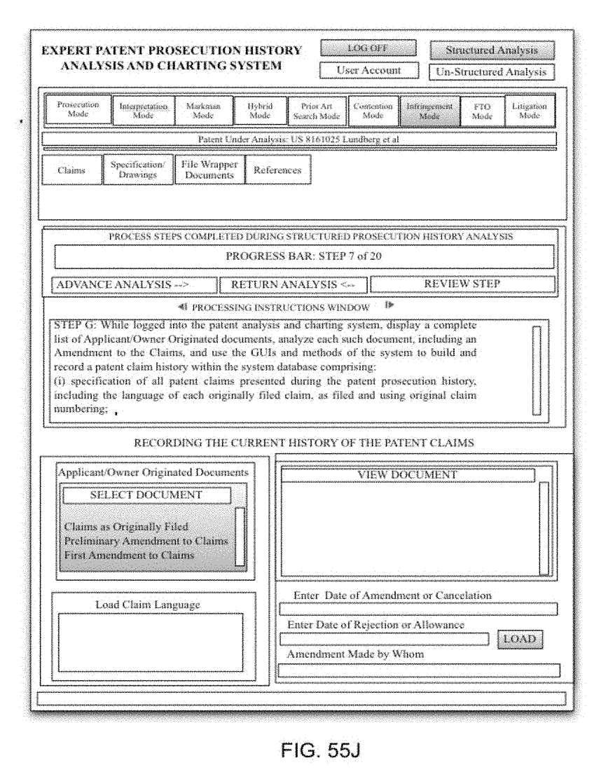

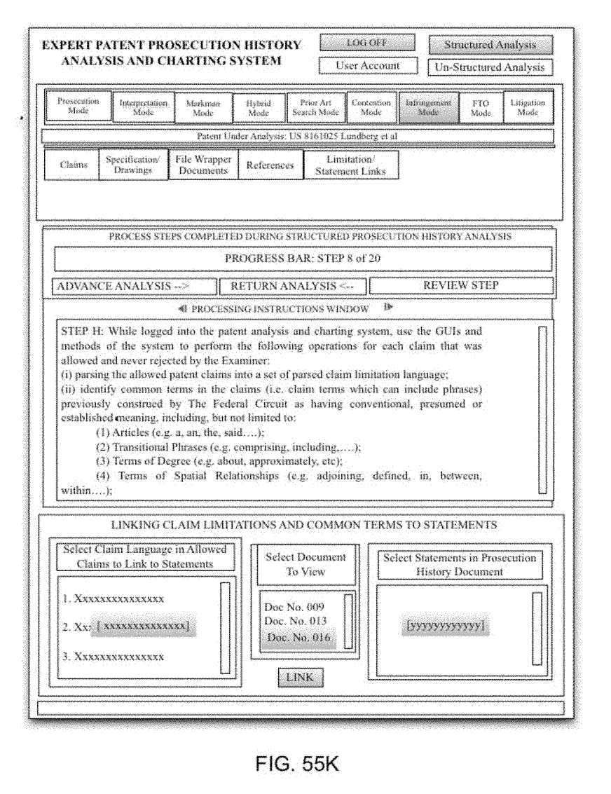

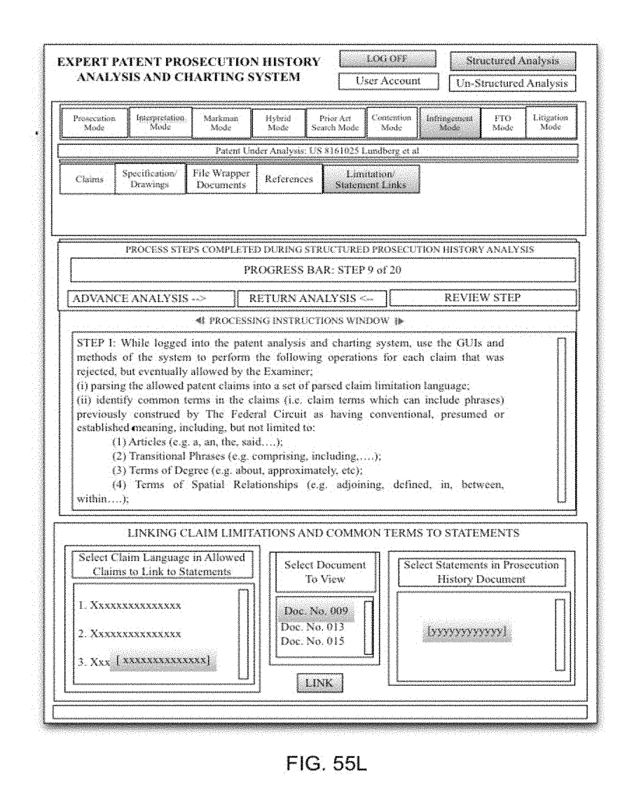

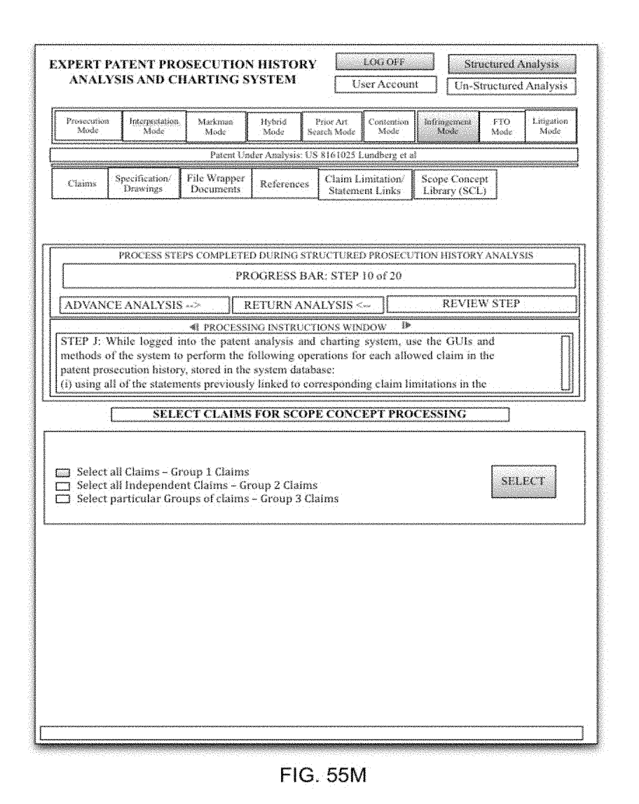

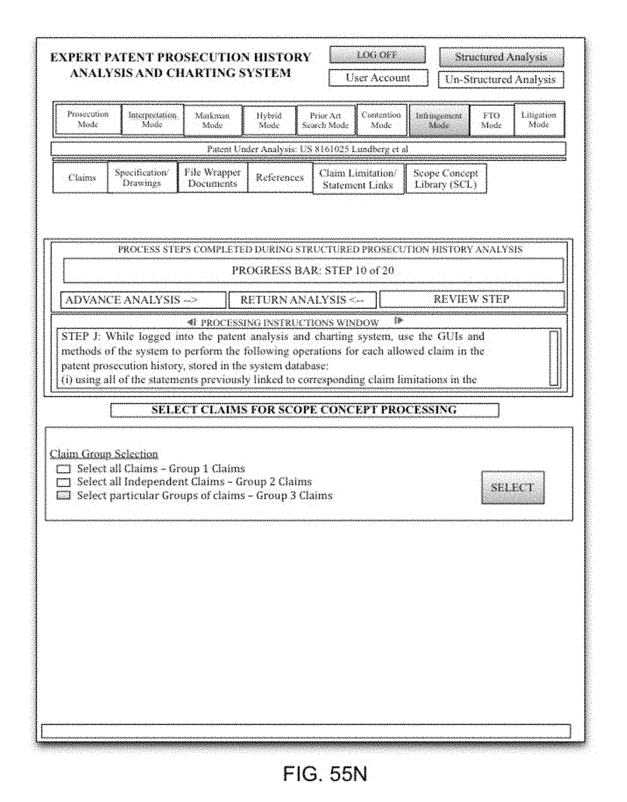

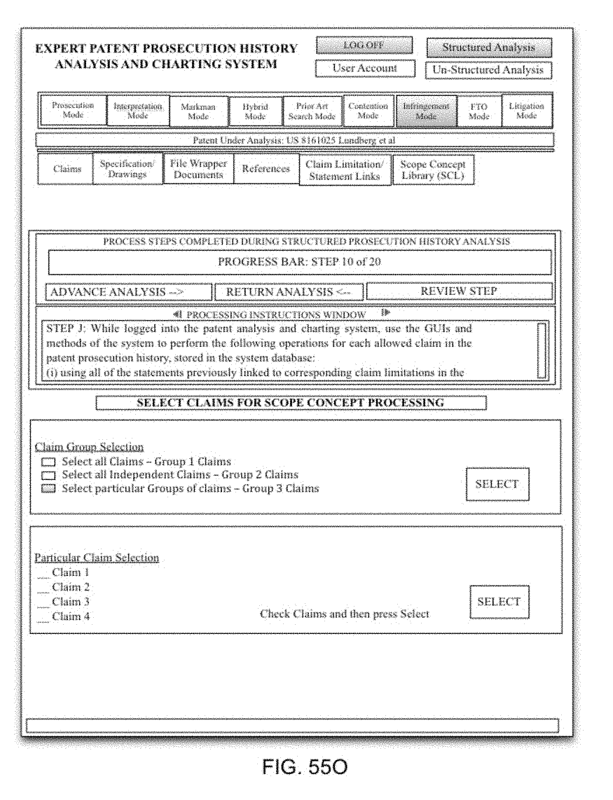

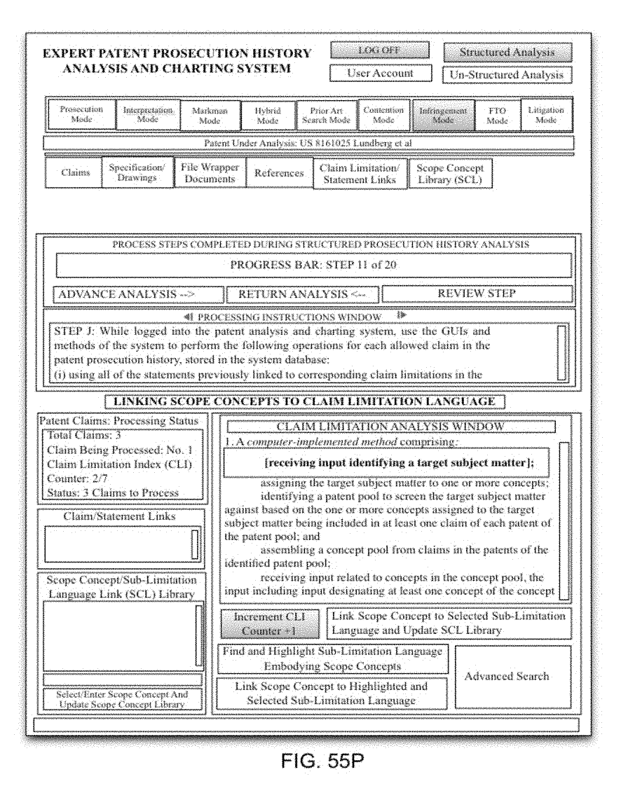

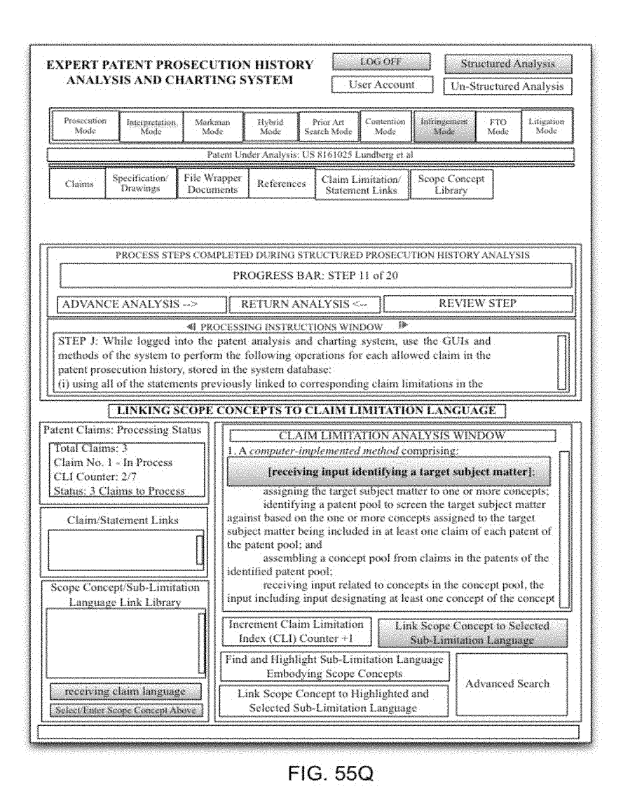

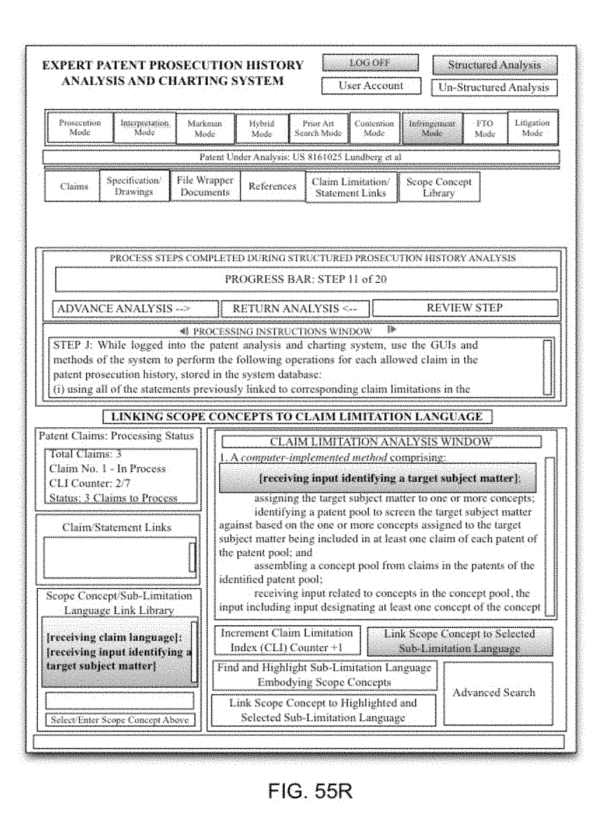

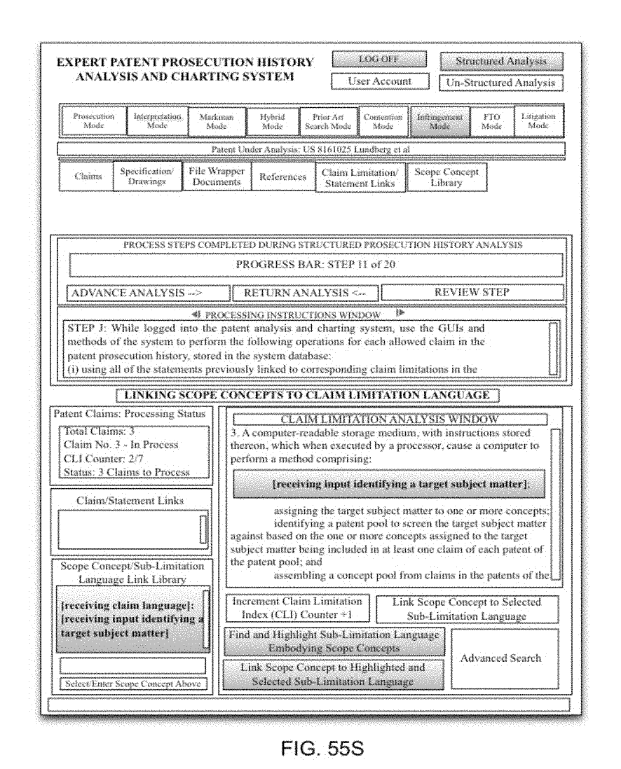

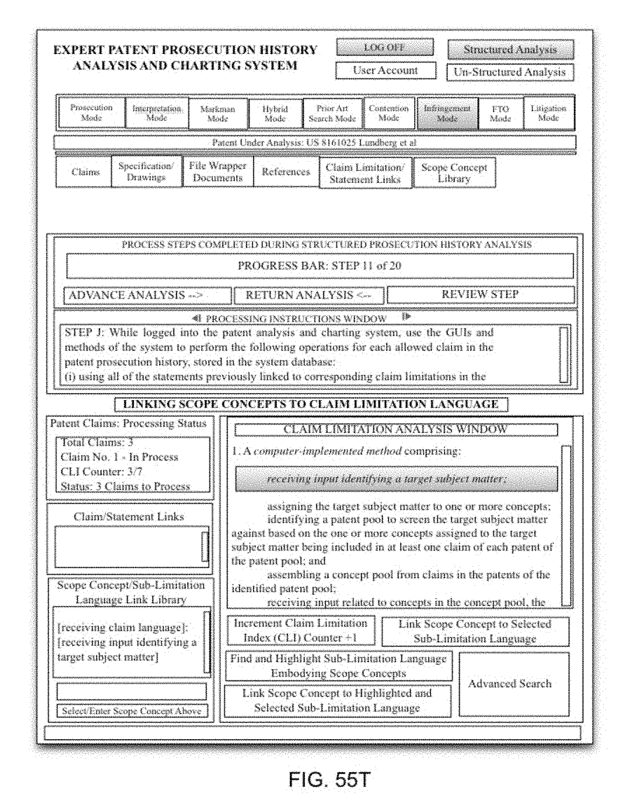

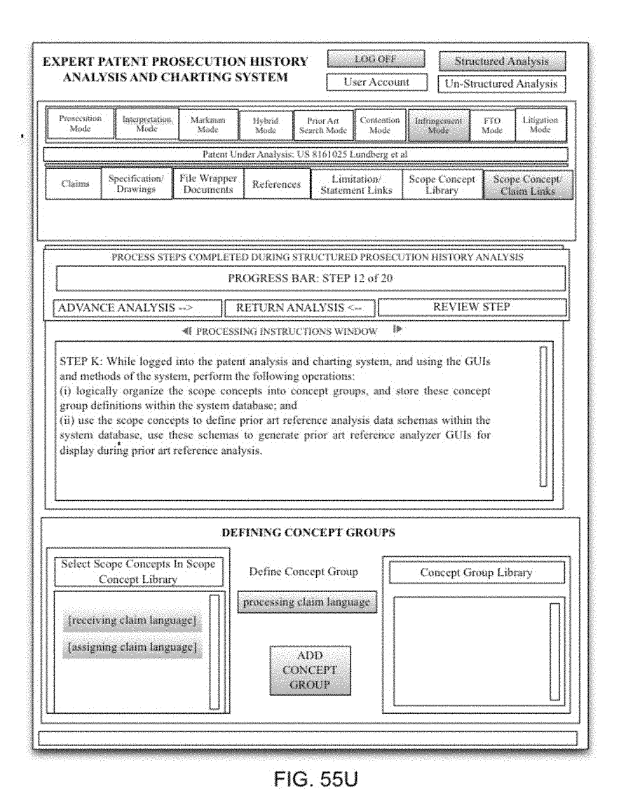

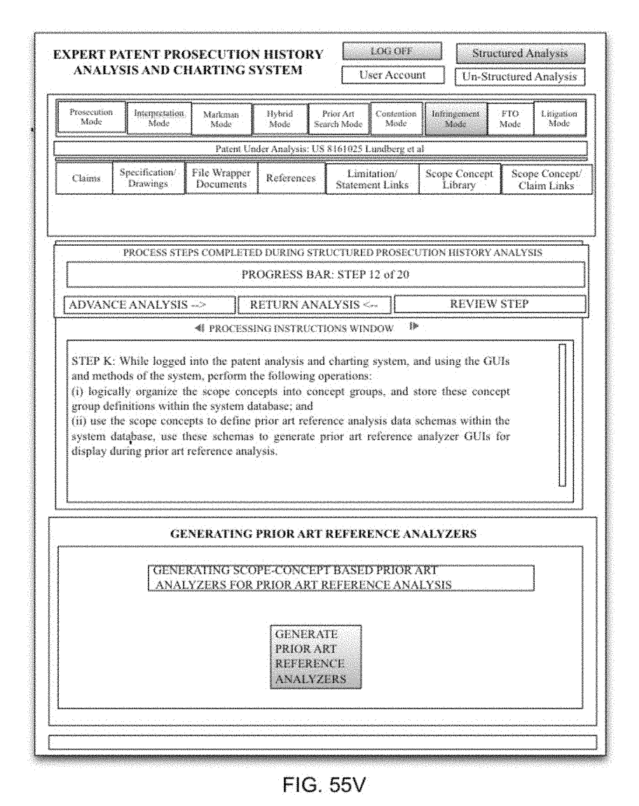

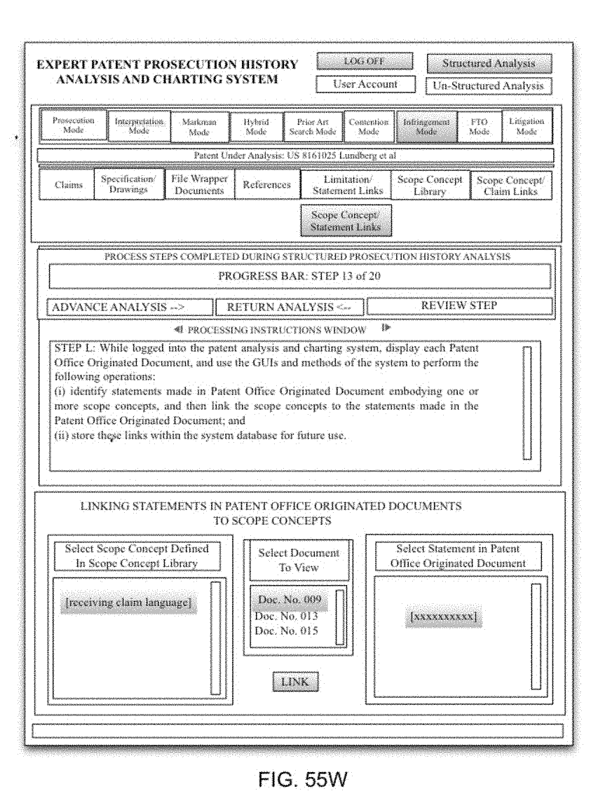

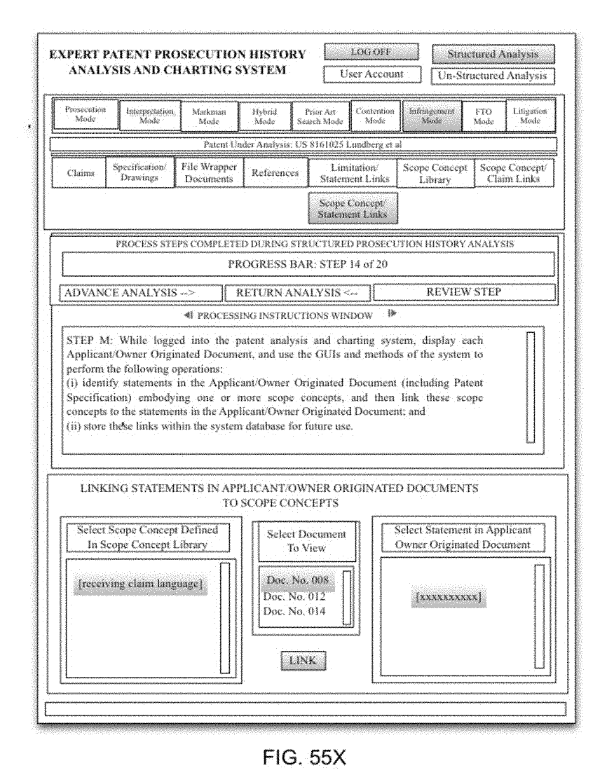

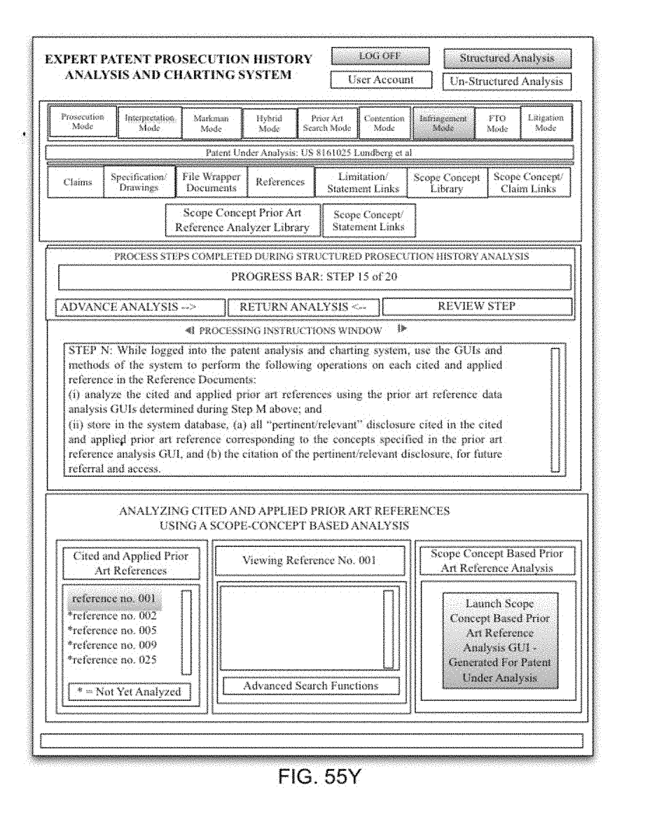

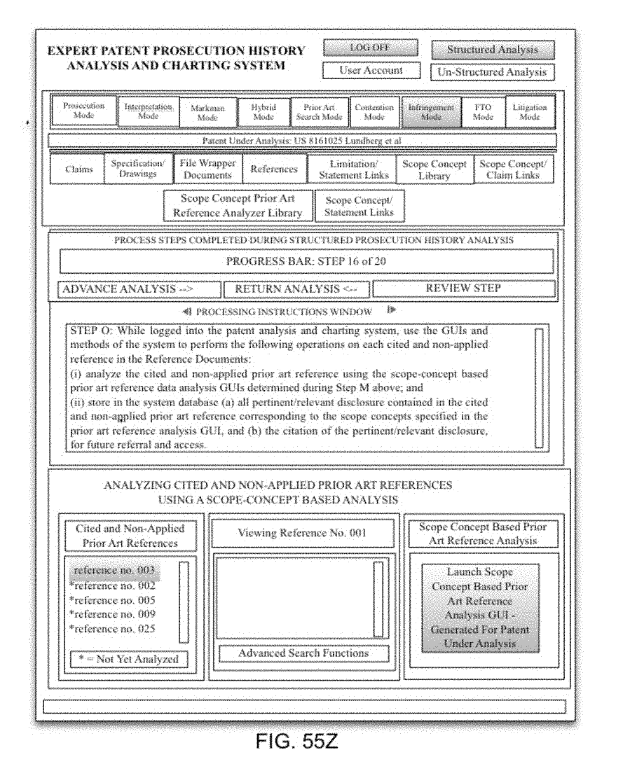

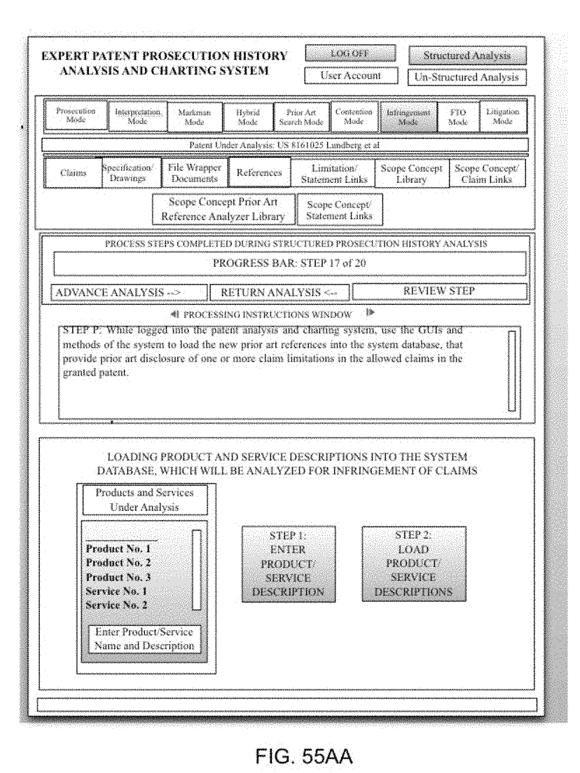

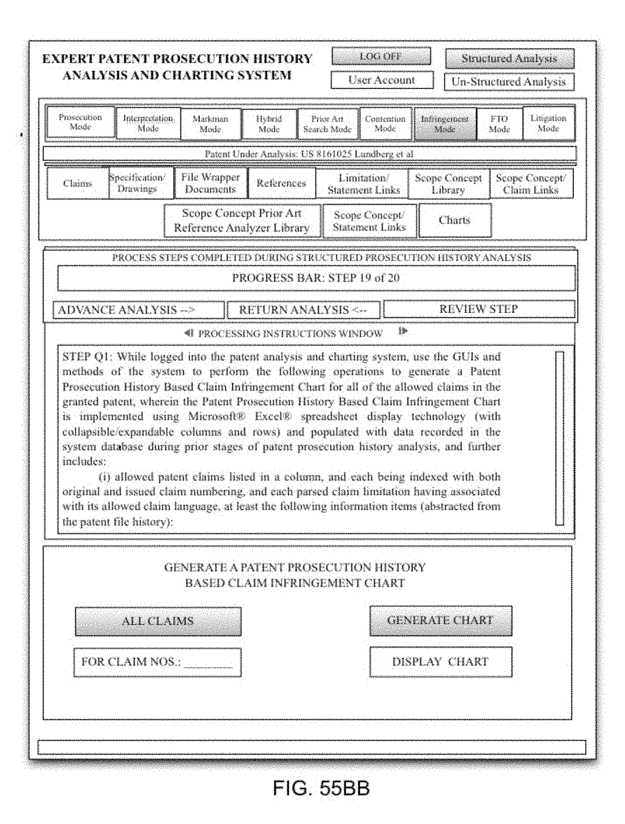

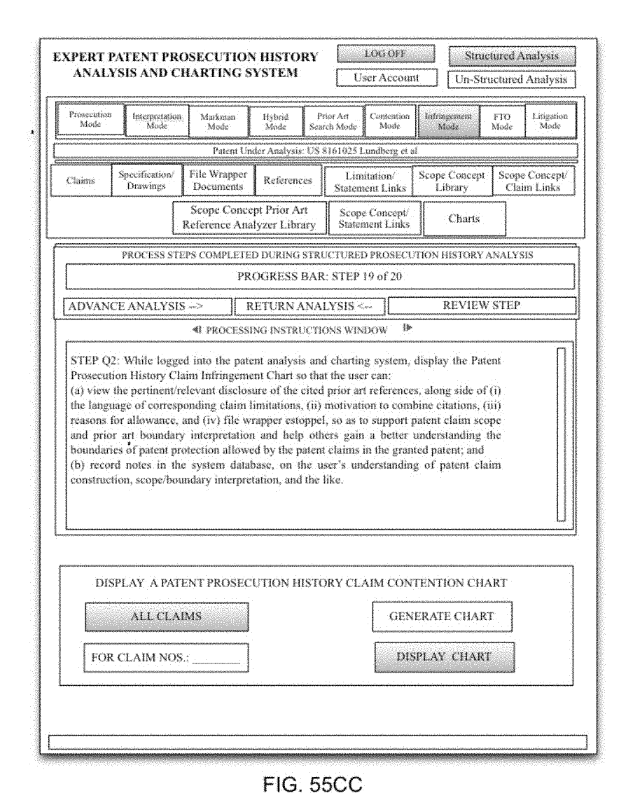

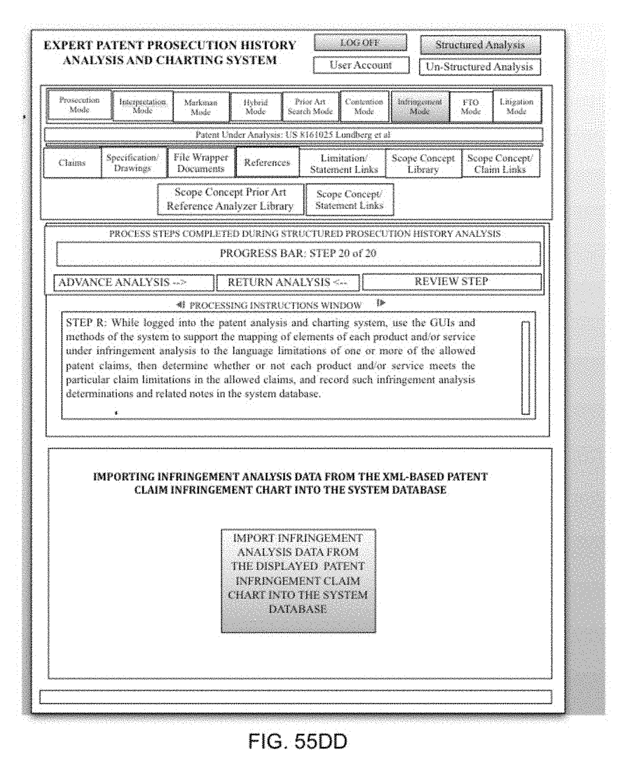

Referring now to the detailed flow chart set forth in FIGS. 53A through 53E, the Internet-based patent analysis and charting system of the present invention configured in its patent claim infringement analysis mode of system operation will be now described in detail, and showing how one or more users can efficiently analyze and chart the patent prosecution history of any granted patent using the wireframe GUI screens set forth in FIGS. 55A through 55DD, the mapping techniques illustrated in FIGS. 52 and 56, and the patent prosecution history based chart structures described in FIGS. 57A through 57H. Various applications for the patent analysis and charting system configured in this mode of operation are illustrated in FIG. 54 and will be described in greater detail hereinbelow.

The steps of the process described in FIGS. 53A through 53E will be described in detail below.

As indicated in Step A in FIG. 53A, Web, application and database servers on a network are used to deploy an Internet-based object-oriented system platform that supports a computer-assisted analysis and charting of the prosecution history of any patent granted in a national patent protection system. As shown in FIG. 5, the network is connected to the network information infrastructure and servers of national patent protection systems, and patent and published patent application depositories containing composite patent file history data documents for granted patents and pending (or abandoned) patent applications.

As indicated in Step B in FIG. 53A, web-enabled client machines are used to allow authorized users to log into the deployed patent analysis and charting system and perform the following operations specified below. As exemplary login GUI screen is shown in FIG. 55A for that purpose.

As indicated in Step C in FIG. 53A, the user employs a GUI as shown in FIG. 55B to configure the patent analysis and charting system in its patent claim infringement analysis mode of system operation, for computer-assisted analysis and charting of a particular patent application, prior to patent grant. In general, the patent analysis and charting system comprises a database for storing the patent file history data, patent claim data, and prior art reference data, and supporting methods, procedures, GUIs, etc. during patent prosecution analysis. The purpose of this step in the process is to select the mode of system operation to be configured on the system platform of the present invention.

As indicated in Step D in FIG. 53A, the user employs GUI screen as shown in FIG. 55C, to provide the Internet-based system with the patent number of the patent granted in a national patent protection system. Then, using a GUI screen as shown in FIG. 55D, all patent file history data of the granted patent, including file wrapper history documents, patent claim data, cited prior art reference documents, etc., are uploaded from patent servers shown in FIG. 5, into the database 15 of the Internet-based system, in a format suitable for parsing and search analysis, and associate this patent file history data with the patent application serial number.

As indicated in Substep E1 in FIG. 53A, a GUI screen as shown in FIG. 55E is employed so that, whenever necessary, the system uses optical character recognition (OCR) and/or other technologies to convert all documents in the patent prosecution (i.e. file) history data set into text searchable documents, as and where necessary, so that each such document is text searchable during the method of prosecution history analysis and charting according to the present invention.

As indicated in Substep E2 in FIG. 53A, a GUI screen as shown in FIG. 55F is employed so that all documents in the patent file history data set of the granted patent are indexed by first assigning a unique document number to each and every document in the patent file history data set of the patent application, and then second by compiling a complete list of indexed documents from the indexed patent file history data set.

As indicated in Substep E3 in FIG. 53A, a GUI screen as shown in FIG. 55G is employed so that each document in the complete list of indexed patent file history documents, is cataloged into one of the three document categories: (i) Patent Office Originated Documents; (ii) Applicant/Owner Originated Documents (including Patent Specification and Claims); and (iii) Reference Documents Originated by the Patent Office, Applicant/Owner, or any party or entity.

As indicated in Step F in FIG. 53A, a GUI screen as shown in FIG. 55H is employed so that, while logged into the patent analysis and charting system, the system displays a complete list of Reference Documents, and for each such reference document in the list, the user uses the GUIs and methods of the system to identify and classify the cited reference as either: (i) cited and applied in claim rejection; (ii) cited and not applied in claim rejection; or (iii) cited but not prior art; and then store these reference classifications in the system database.

As indicated in Step G in FIG. 53B, GUI screens as shown in FIGS. 551 and 55J are employed, so that the system enables the recording of the current history of the patent claims in the system database, including a concise status of patent claims, patent claim amendments, and patent claim examination during the patent prosecution history of the patent application. In the illustrative embodiment, this is achieved as follows. As shown, while logged into the patent analysis and charting system, the system displays a complete list of Applicant/Owner Originated documents, and then each such document, including an Amendment to the Claims is analyzed by the user using the GUIs and methods of the system so as to build and record a patent claim history (PCH) within the system database 15. In the illustrative embodiment, the patent claim history comprises:

(i) specification of all patent claims presented during the patent prosecution history, including the language of each originally filed claim, as filed and using original claim numbering;

(ii) specification of the date each patent claim was amended and/or canceled, voluntarily, and not in response to an examiner's claim rejection;

(iii) specification of which patent claims were allowed without rejection, and specify the date of allowance and the Examiner who made the allowance;

(iv) specification of which claims were rejected, identify the statutory basis of each such rejection (e.g. 35 USC Section 102 and/or 103) and prior art references upon which the claim rejection was made, and specify the date of the claim rejection and the Patent Examiner who made the rejection;

(v) specification of the language of each claim amendment, identify when the amendment was made and by whom (i.e. using USPTO Attorney/Agent Registration Number for registered agents and attorneys, and Applicant's name for pro se applications);

(vi) specification of which claims where allowed after rejection in response to an argument for patentability and request for reconsideration, and a specification of the language of each such allowed claim; and

(vii) specification of which claims where allowed after rejection in response to an argument for patentability, an amendment to the claims, and a request for reconsideration, and a specification of the language of each such allowed claim.

As indicated in Step H in FIG. 53B, a GUI screen as shown in FIG. 55K is employed, so that the user can link examiner and/or applicant statements made during the patent prosecution history to the limitations, sub-limitations and/or common terms of allowed and never rejected patent claims, and then store each link in the system database.

Specifically, while logged into the patent analysis and charting system, the user uses the GUIs and methods of the system to perform the following operations for each claim that was allowed and never rejected by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

For cases where the granted patent is not involved in patent litigation, the Markman mapping operations set forth in substep (ii) will be disabled from the system configuration.

As indicated in Step I in FIG. 53B, a GUI screen as shown in FIG. 55L is employed, so that the user can link examiner and/or applicant statements made during the patent prosecution history to the limitations, sub-limitations and/or common terms of rejected but ultimately allowed patent claims, and storing each link in the system database. Specifically, while logged into the patent analysis and charting system, the user uses the GUIs and methods of the system to perform the following operations for each claim that was rejected, but eventually allowed by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

For cases where the granted patent is not involved in patent litigation, the Markman mapping operations set forth in substep (ii) will be disabled from the system configuration.

As indicated in Step J in FIG. 53B, GUI screens as shown in FIGS. 55M through 55T are employed, so that the user can define and formulate scope concepts based on analysis of stored links, then link claim limitation language of each allowed patent claim to one or more scope concepts, and ultimately store each scope concept and link in the system database. Specifically, while logged into the patent analysis and charting system, the user uses the GUIs and methods of the system to perform the following operations for each allowed claim in the patent prosecution history, stored in the system database:

(i) display the allowed patent claims using final patent numbering, or any selected group of claims (e.g. all claims, all independent claims, or a particular subset of claims);

(ii) using the statements previously linked to corresponding claim limitations in the allowed patent claim, identify and formulate one or more scope concepts expressed in and/or embraced by or embodied within the claim limitation language of each allowed patent claim, and store these scope concepts in the system database;

(iii) for each claim limitation, link a scope concept to the corresponding language of the claim sub-limitation that supports the scope concept and store these claim limitation/scope concept links in the system database; and

(iv) repeat step (iii) above for each claim limitation, as necessary to capture essential scope concepts embodied within the allowed claim.

The scope concept formulation, assignment and linkage method described in FIGS. 24 through 26 can be used to practice Step J of this method of patent claim analysis supported by the system of the present invention.

During the process of claim scope concept analysis and scope concept formulation described above, the user assigns one or more scope concepts to each patent claim in the set of patent claims under analysis. Then, for the set of patent claims, the system automatically forms and maintains a Library of Scope Concepts (“Scope Concept Library”) stored in the system database 15. At any time, the user can review the Scope Concept Library for any given set of patent claims under analysis by clicking on the Scope Concept Library graphical icon presented with the GUI screens displayed by the system, as shown in FIG. 55U, for example.

For each patent claim that has been scope concept analyzed, the system automatically generates a Claim Scope Concept Profile, as shown in FIG. 26B, comprising a complete List of Scope Concepts that have been assigned to corresponding language in the claim limitations and/or sub-limitations of the Patent Claim. The system also maintains a Library of Scope Concept/Claim links, as shown in FIG. 55U.

As indicated in Step K in FIG. 53B, GUI screens as shown in FIGS. 55U and 55V are employed, so that the user can define concept groups and store them in the system database and generate scope concept based prior art reference analysis GUI of FIG. 26C during prior art reference analysis. Specifically, while logged into the patent analysis and charting system, and using the GUIs and methods of the system, the user performs the following operations: (i) logically organizes the scope concepts into concept groups, and stores these concept group definitions within the system database; and (ii) uses the scope concepts to define prior art reference analysis GUI of FIG. 26C for display during prior art reference analysis.

As indicated in Step L in FIG. 53B, a GUI screen as shown in FIG. 55W is employed, so that the user can link statements in patent office originated documents to one or more scope concepts defined above, and then store each link in the system database. Specifically, while logged into the patent analysis and charting system, display each Patent Office Originated Document, and use the GUIs and methods of the system to perform the following operations: (i) identify statements made in Patent Office Originated Document embodying one or more scope concepts, and then link the scope concepts to the statements made in the Patent Office Originated Document; and (ii) store these links within the system database for future use.

As indicated in Step M in FIG. 53C, a GUI screen as shown in FIG. 55X is employed, so that the user can link statements in Applicant/Owner originated documents to one or more scope concepts defined above, and store each link in the system database. Specifically, while logged into the patent analysis and charting system, display each Applicant/Owner Originated Document, and use the GUIs and methods of the system to perform the following operations: (i) identify statements in the Applicant/Owner Originated Document (including Patent Specification) embodying one or more scope concepts, and then link these scope concepts to the statements in the Applicant/Owner Originated Document; and (ii) store these links within the system database for future use.

As indicated in Step N in FIG. 53C, a GUI screen as shown in FIG. 55Y is employed, so that the user can analyze cited and applied prior art references using the scope concept based prior art reference analysis GUI, to determine prior art disclosure corresponding to claim limitations, and store the analysis in the system database. Specifically, while logged into the patent analysis and charting system, use the GUIs and methods of the system to perform the following operations on each cited and applied reference in the Reference Documents: (i) analyze the cited and applied prior art references using the prior art reference data analysis GUIs determined during Step M above; and (ii) store in the system database, (a) all “pertinent/relevant” disclosure cited in the cited and applied prior art reference corresponding to the concepts specified in the prior art reference analysis GUI, and (b) the citation of the pertinent/relevant disclosure, for future referral and access.

After each prior art reference is analyzed using the Scope Concept Based Prior Art Reference Analysis GUI during scope concept based prior art analysis in Step N, then a Prior Art Reference Scope Concept Profile is automatically generated for the prior art reference that has been scope concept analyzed, as illustrated in FIG. 26D. As shown in FIG. 26D, the Prior Art Reference Scope Concept Profile for each Prior Art Reference comprises: (i) a Master Scope Concept List indicating which scope concepts (assigned to the set of Claims) have and have not been substantiated by disclosure from the prior art reference, and (ii) A Claim Scope Concept Profile, for each patent claim, indicating which scope concepts in each patent claim have and have not been substantiated by disclosure from the Prior Art Reference, with a citation from the prior art reference as to where the substantiating disclosure can be found in the prior art reference.

As indicated in Step O in FIG. 53C, a GUI screen as shown in FIG. 55Z is employed, so that the user can analyze cited and applied prior art references using the scope concept based prior art reference analysis GUIs, to determine prior art disclosure corresponding to claim limitations and storing the analysis in the system database. Specifically, while logged into the patent analysis and charting system, the user uses the GUI screen of FIG. 53C and methods of the system to perform the following operations on each cited and applied reference in the Reference Documents: (i) analyze the cited and applied prior art references using the scope concept based prior art reference analysis GUIs determined during Step M above; and (ii) store in the system database, (a) all pertinent/relevant disclosure contained in the cited and applied prior art reference corresponding to the scope concepts specified in the prior art reference analysis GUI, and (b) the citation of the pertinent/relevant disclosure, for future referral and access.

After each prior art reference is analyzed using the Scope Concept Based Prior Art Reference Analysis GUI during scope concept based prior art analysis in Step O, then a Prior Art Reference Scope Concept Profile is automatically generated for the prior art reference that has been scope concept analyzed, as illustrated in FIG. 26D. As shown in FIG. 26D, the Prior Art Reference Scope Concept Profile for each Prior Art Reference comprises: (i) a Master Scope Concept List indicating which scope concepts (assigned to the set of Claims) have and have not been substantiated by disclosure from the prior art reference, and (ii) A Claim Scope Concept Profile, for each patent claim, indicating which scope concepts in each patent claim have and have not been substantiated by disclosure from the Prior Art Reference, with a citation from the prior art reference as to where the substantiating disclosure can be found in the prior art reference.

As indicated in Step P in FIG. 53D, a GUI screen as shown in FIG. 55AA is employed, so that while logged into the patent analysis and charting system, the user can load product and/or service descriptions into the system database, for products and/or services which will be analyzed for infringement or non-infringement of the allowed claims in the granted patent.

As indicated in Step Q in FIG. 53D, GUI screens as shown in FIGS. 55BB and 55CC are employed, so that the user can generate and display a claim scope schema (CSS) based patent infringement chart structure for all of the selected allowed claims in the granted patent. Specifically, during Substep Q1, while logged into the patent analysis and charting system, the user uses the GUI of FIG. 55BB and methods of the system to generate a CSS-based patent infringement chart for all of the allowed claims in the granted patent. The CSS-based patent infringement chart structure is implemented using Microsoft® Excel® spreadsheet display technology (with collapsible/expandable columns and rows) and populated with data recorded in the system database during prior stages of patent prosecution history analysis.

As shown in FIGS. 57A through 57H, the CSS-based patent claim infringement chart structure comprises data fields for presenting graphical representations of the following graphical objects:

(i) the text language comprising the allowed patent claim limitations and sub-limitations (Step G) listed in a column, and each being indexed with both original and issued claim numbering, and each parsed claim limitation having associated with its allowed claim language, at least the following information items (abstracted from the patent file history):

(ii) technical support for each claim limitation disclosed in the patent specification under 35 USC Section 112 (Step G) listed in a separate column (can be generated automatically by the system);

(iii) subject matter (language) of patent claims allowed and never rejected during patent prosecution history (Step G);

(iv) subject matter rejections overcome by the allowed patent claims during the patent prosecution history—as reflected in the patent prosecution history—including a concise statement of each prior art rejection (e.g. Section 101, 102, and/or 112) or rejection combinations (e.g. Section 103) made by Examiner and overcome by Applicant(s) listed in a separate column;

subject matter (i.e. disclosure) of prior art references cited by the examiner and applied to specific claim limitations in a 35 USC Section 102/103 rejection which was overcome by the allowed claims with argument but without amendment (Step G);

subject matter (i.e. disclosure) of prior art references cited by the examiner and applied to specific claim limitations in a 35 USC Section 102/103 rejection which was overcome by the allowed claims with amendment and argument (Step G);

(v) Markman-type terms present in allowed and never rejected claims, and previously construed by the Federal Circuit—such common terms including claim terms present in allowed and never rejected patent claims, and having conventional, presumed or established meaning, including but not limited to: articles, transitional phrases, terms of degree, other terms (e.g. whereby, such as, adapted, conventional, mixture etc), and means plus function (Step H);

(vi) Markman-type terms present in rejected but ultimately allowed claims, and previously construed by the Federal Circuit—such common terms including claim terms present in rejected but ultimately allowed patent claims, and having conventional, presumed or established meaning, including but not limited to: articles, transitional phrases, terms of degree, other terms (e.g. whereby, such as, adapted, conventional, mixture etc), and means plus function (Step I);

(vii) examiner statements related and directly linked (i.e. mapped) to the language of claim sub-limitations by the user (Steps H and I);

(viii) applicant statements related and directly linked to the language of claim sub-limitations by the user (Step H and I);

(ix) reasons for allowance related and directly linked to the language of claim sub-limitations by the user (Steps H and I);

(x) scope concepts embraced by the patent claims and assigned to the language of claim sub-limitations by the user (Step J);

(xi) subject matter of cited and applied prior art references mapped to the sub-limitation language of the allowed patent claims by the user during scope concept based reference analysis performed by the user and using the scope concepts assigned to the allowed patent claims (Step N);

(xii) subject matter of cited but not applied prior art references mapped to the sub-limitation language of the allowed patent claims by the user during scope concept based reference analysis performed by the user and using the scope concepts assigned to the allowed patent claims (Step O);

(xiii) statements made by the examiner during the patent prosecution history, transparently linked to claim sub-limitations in the allowed claims, and listed in a separate column, using the claim concept linking/mapping process of the present invention carried out by the system (Step L);

(xiv) statements made by the applicants/owner during the patent prosecution history, transparently linked to claim sub-limitations in the allowed claims, and listed in a separate column, using the claim concept linking/mapping process of the present invention carried out by the system (Step M);

(xv) “reasons for allowance” statements made by the examiner and possibly commented upon by applicant during the patent prosecution history, transparently linked to claim sub-limitations in the allowed claims, and listed in a separate column, using the scope concept linking/mapping process of the present invention carried out by the system (Steps L and M);

(xvi) products under patent claim infringement analysis—which are mapped to the language limitation of one or more of the allowed patent claims;

(xvii) services under patent claim infringement analysis—which are mapped to the language limitations of one or more of the allowed patent claims;

(xviii) notes on the user's understanding of whether or not a product or service under investigation meets the particular claim limitations in the allowed claims.

During the patent claim understanding/interpretation process, the claim scope schema (CSS) structure, comprising all information from the patent prosecution history linked together by claim scope concepts (CSC) and contained within the spreadsheet-type chart structure, functions as a framework that helps organize information relating to the scope and meaning of any allowed patent claim represented in the chart structure, to assist anyone interested in better understanding the scope and boundaries offered by allowed patent claims.

During Substep Q2, while logged into the patent analysis and charting system, the users uses the GUI screen of FIG. 55BB to display the CSS-based patent claim infringement chart structure so that the user can: (a) view the pertinent/relevant disclosure of the cited prior art references, along side of (i) the language of corresponding claim limitations, (ii) motivation to combine citations, (iii) reasons for allowance, and (iv) file wrapper estoppel, so as to support patent claim scope and prior art boundary interpretation and help others gain a better understanding the boundaries of patent protection allowed by the patent claims in the granted patent; and (b) record notes in the system database, on the user's understanding of patent claim construction, scope/boundary conditions, and the like.

As indicated in Step R in FIG. 53D, a GUI screen as shown in FIG. 55DD is employed, so that while logged into the patent analysis and charting system, the user can use the GUIs and methods of the system to map elements of each product and/or service under infringement analysis to the language limitations of one or more of the allowed patent claims, then determining whether or not each product and/or service meets the particular claim limitations in the selected allowed claims, and recording such infringement analysis determinations in the system database 15.

FIG. 54 illustrates the application of the multi-mode patent analysis and charting system configured in its patent claim infringement analysis mode of system operation, and deployed during particular phases of the patent life-cycle time line, by both the patent owner and its competitors. In particular, the patent owner can use the patent claim infringement analysis mode of operation in offensive applications against competitors, namely, by (i) better understanding the scope and boundaries of the allowed patent claims, against a landscape of scope concept mapped prior art references displayed in the chart structure, (ii) identifying potential future cases of claim infringement (requiring deeper patent claim infringement analysis). Also, defendants can use the patent claim infringement analysis mode of operation in defensive applications against the patent owner, by better understanding the scope and boundaries of patent protection afforded by the claims, and identifying potential defenses of potential claims of patent claim infringement.

### Specification of the Multi-Mode Patent Analysis and Charting System of the Present Invention Configured in its Freedom-to-Operate (FTO) Analysis Mode of System Operation (Mode 7)

Freedom to operate (FTO) studies are commonly performed when attempting to clear as many potential patents and/or published patent applications, as possible, typically during the product/service design phase of most R&D projects. While much is written about the goals of FTO analysis, there is a great need for a rational workflow process that can be used to carry out FTO studies relating to both patented products and services, alike. Below, a high-level rational FTO workflow process will be described for use in conjunction with the multi-mode patent analysis and charting system while configured in its FTO analysis mode of system operation. Thereafter, the multi-mode system configured in its FTO analysis mode will be described in great technical detail.

### Specification of the Freedom-to-Operate (FTO) Investigation Process of the Present Invention

The first step in finding a group of patents/application for any FTO investigation is to produce a technical specification for the system and/or service design (e.g. products and/or services) which shall be the subject of the freedom-to-operate (FTO) study. Then, based on this technical specification, several different sets of “reference” features and functionalities should be drafted so that all of the core (and subordinate) architectural features and functionalities of the system (i.e. product and/or services) are technically and conceptually covered. Next, a set of scope concepts should be abstracted, or otherwise derived from the set of features and functionalities that represent the technical specifications drawn on the system and/or service design. Based on different combinations of the scope concepts, and the set of features and functionalities, a set of search vectors can be generated and then used to conduct one or more prior art patent searches having the primary goal of discovering relevant prior art patents and published patent applications, containing patent claims covering subject matter specified by the scope concepts and directed to the features and functionalities of the product and/or service design under investigation. From the retrieved set of patent references, non-relevant patent references should be filtered-out, and then the relevant patent references should be organized into a group of granted patents and published patent applications, for example, according to several different levels of relevance (e.g. 1, 2, 3). The result will be a group of patents/applications having claims that are likely to be relevant to the subject matter of the product and/or service design under investigation, and which might pose the risk of being asserted by its owners, against the planned product and/or service designs if released to the marketplace.

Once a group of relevant patents/applications have been obtained, it is appropriate to then configure the multi-mode system of the present invention into its FTO analysis mode of system operation (Mode 7). Once the system has been so configured, the next step is to load the retrieved group of patents/applications into the system database of the configured system. Also, the features and functionalities of each product and/or service design should be loaded into the system database as well.

Then, the patent claims associated with this group of patents/applications within the system can be analyzed by the human system user, so that scope concepts, formulated to embrace subject matter common to the claims of one or more of patents and/or applications in the group of patents/applications, can be defined, linked to claim language in patents where correspondence is determined to exist, and then these scope concept/claim-language links can be stored in the system database. Thereafter, a set of “scope group” (technology) categories can be defined, based on the defined set of scope concepts, and these scope concept categories can then be stored in the system database as well.

Having defined scope concepts across the entire group of patents/applications under FTO investigation, the product and/or service designs can be quickly analyzed for the presence of one or more scope concepts, without analyzing the finer details of the patents claims in the group, because each claim has been analyzed and represented in terms of concepts. The human analyzer can also indicate the relevance or likelihood which the analyzer believes such scope concepts are embraced, embodied or otherwise used by each product and/or service under FTO analysis.

During the FTO analysis, patent references (i.e. patents or published applications) that are linked to scope concepts that are not embraced, embodied or used by the products and/or services under analysis, can be eliminated as to potential risks of infringement with respect to the products and/or services under investigation. At the end of the study, a FTO claim chart structure will be generated for presentation to the client, and this chart can be used to explain the results of the FTO study, and identify what further legal analysis needs to performed to further reduce legal risks associated with the R&D project.

Having provided an overview of the FTO workflow process, it is appropriate now to described how the multi-mode system can be used in its FTO analysis mode to carried out relevant parts of this FTO workflow.

FIG. 58 illustrates the information mapping process supported by the system during its freedom to operate (FTO) analysis mode of system operation. As shown, patent claim data, prosecution history data court-specified claim term meaning definitions for common claim terms, and product and/or service data relating to products and/or services under FTO investigation, are mapped to particular fields within the claim chart structures generated during this particular mode of system operation.

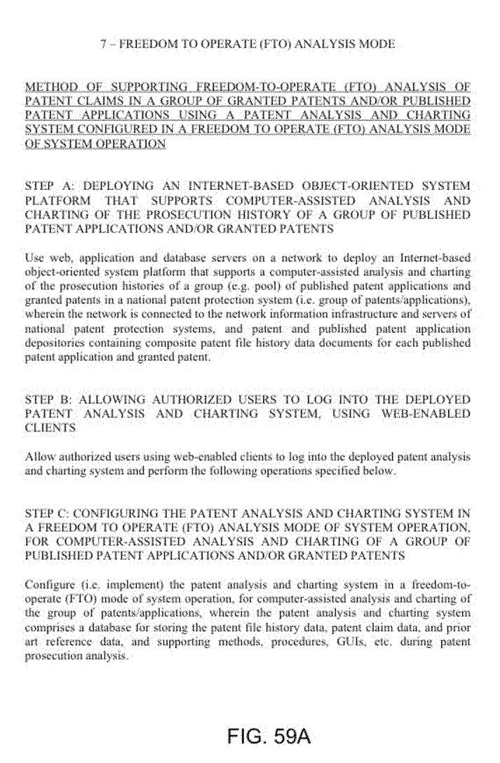

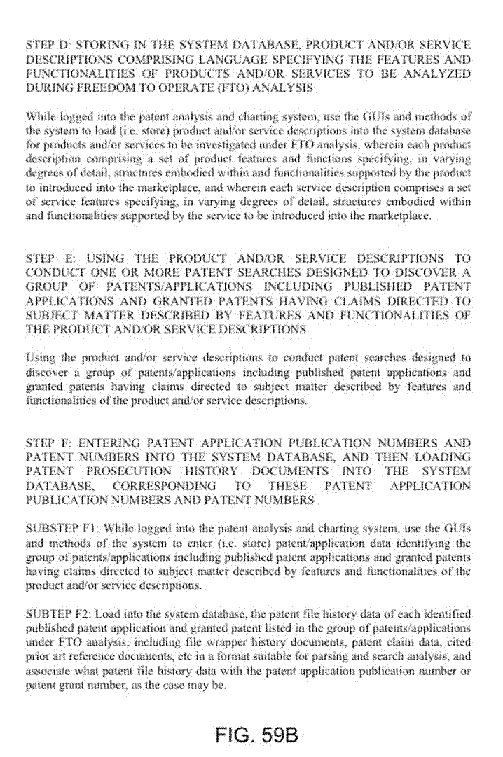

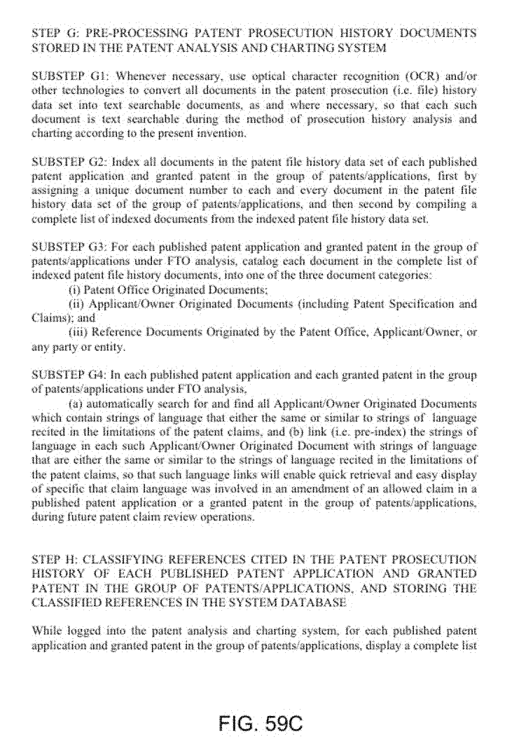

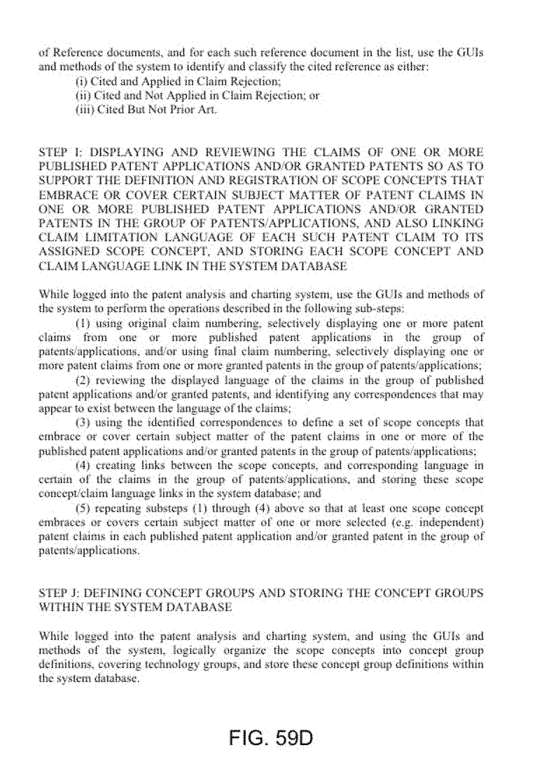

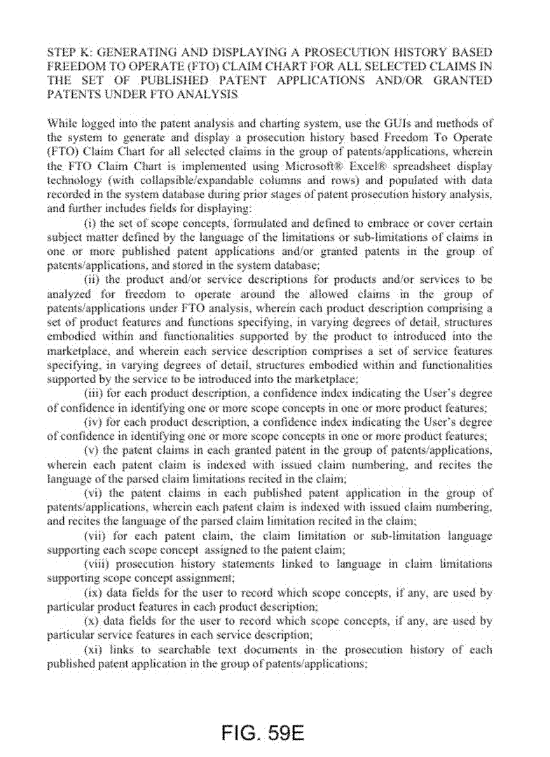

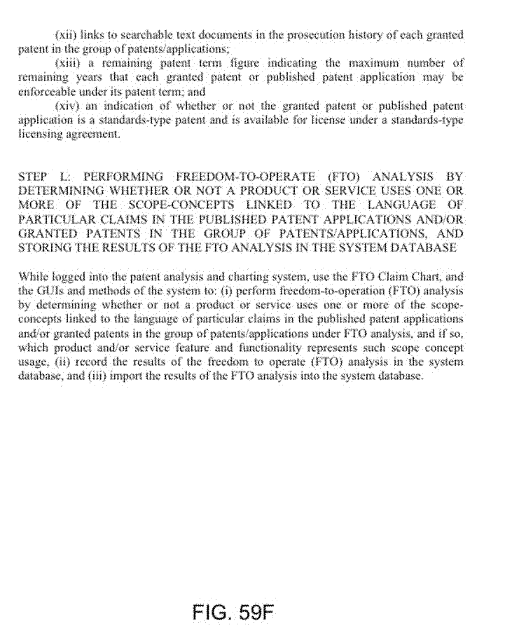

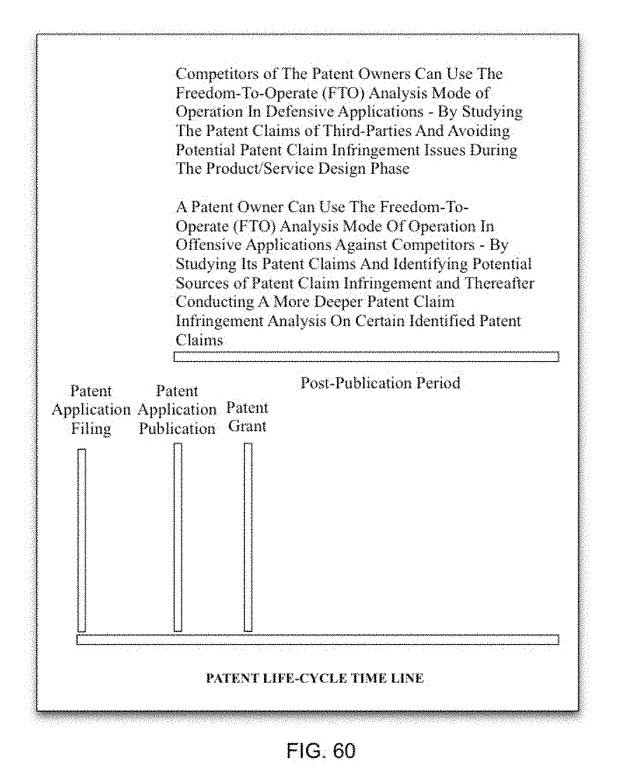

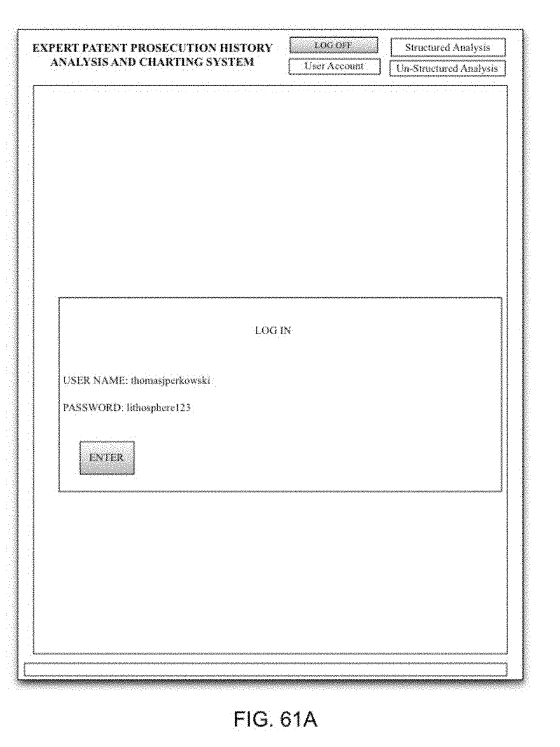

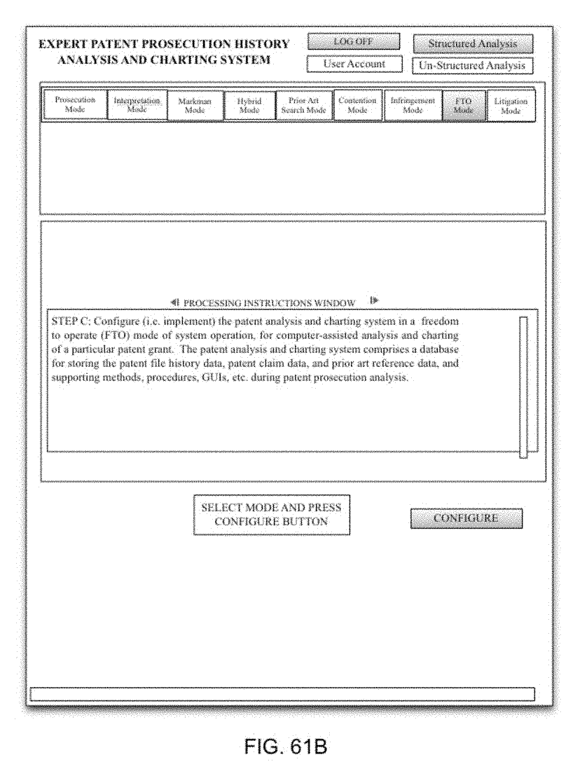

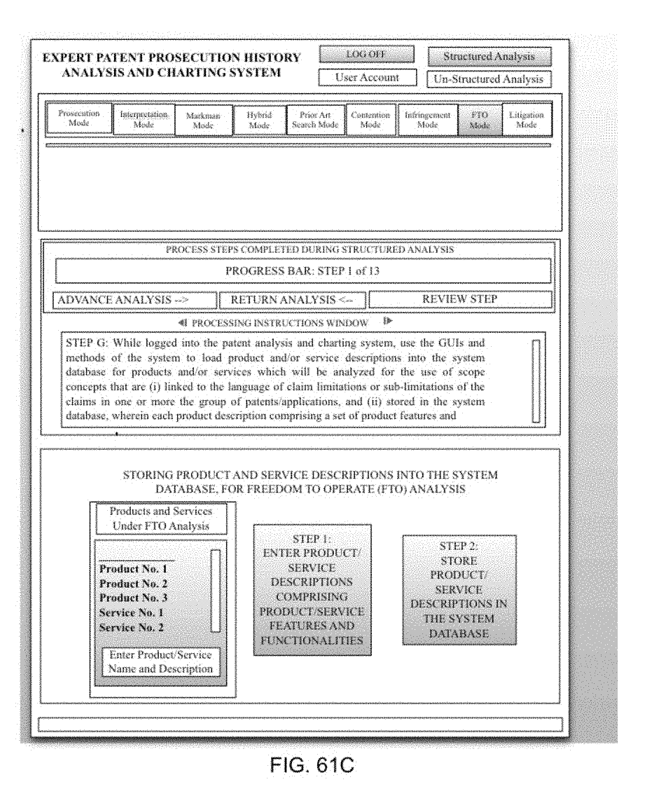

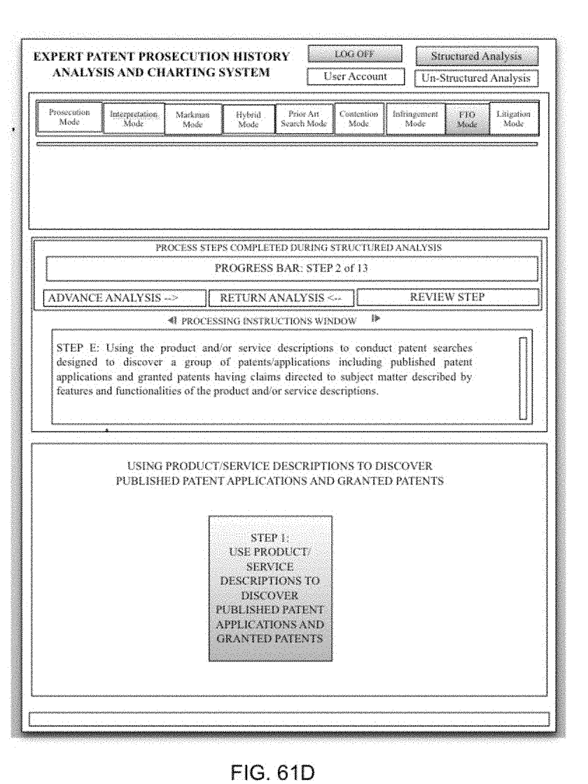

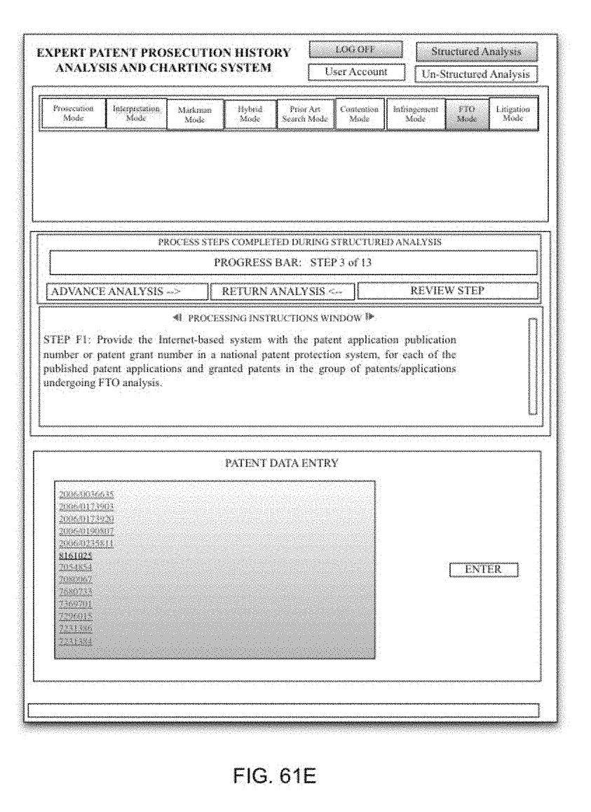

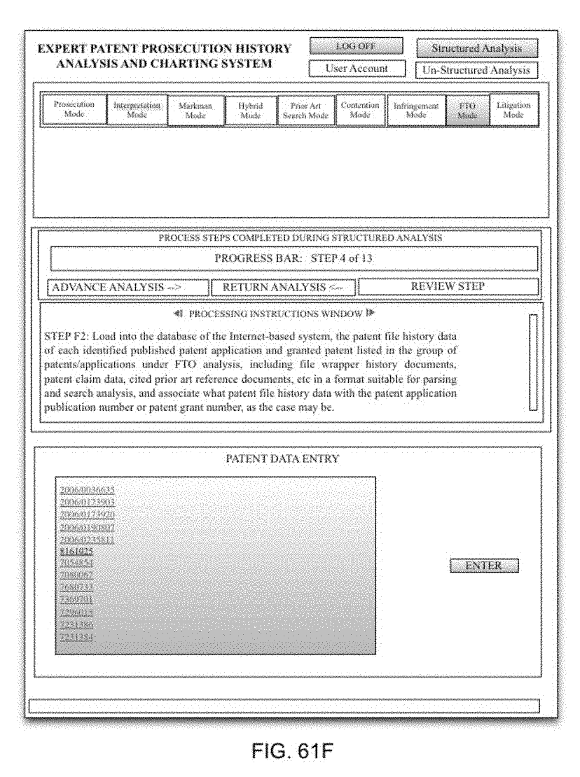

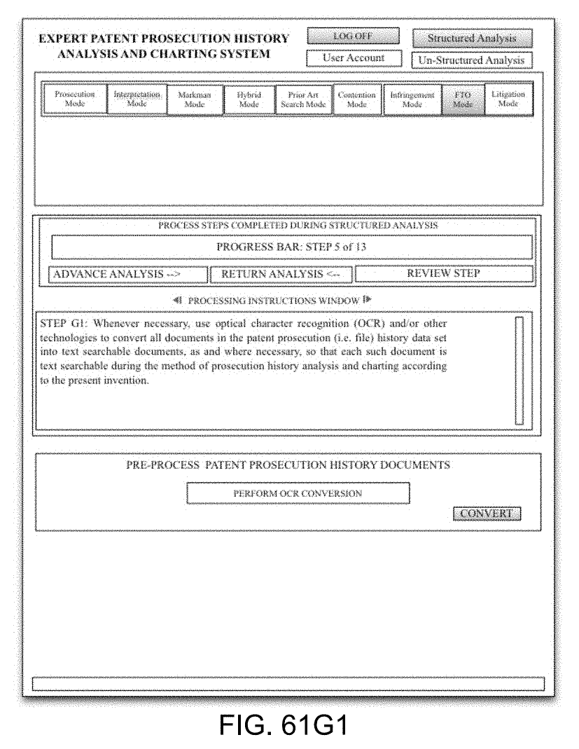

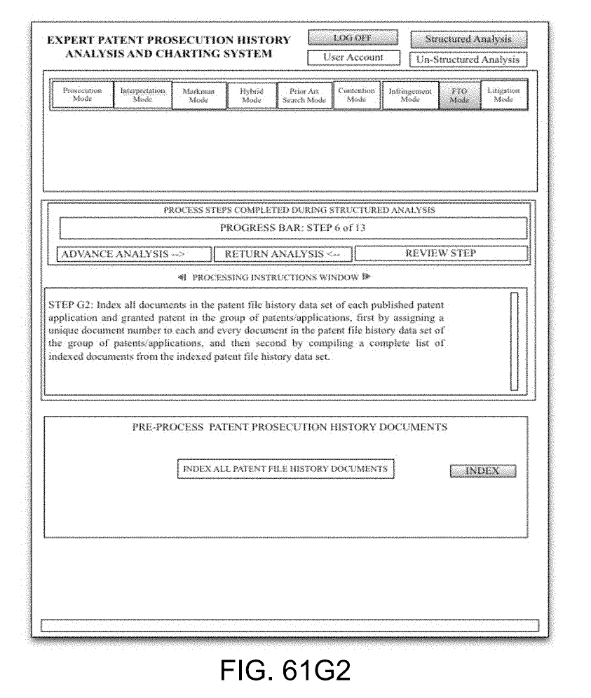

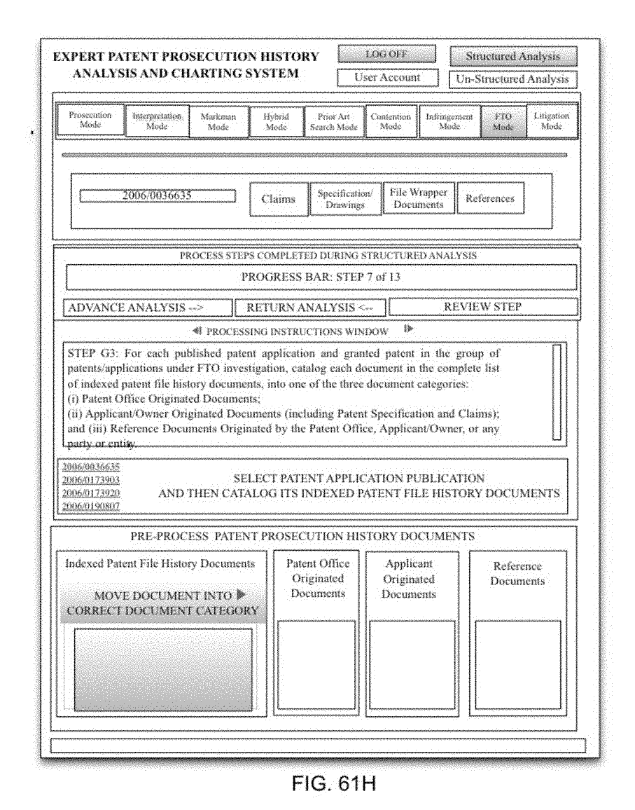

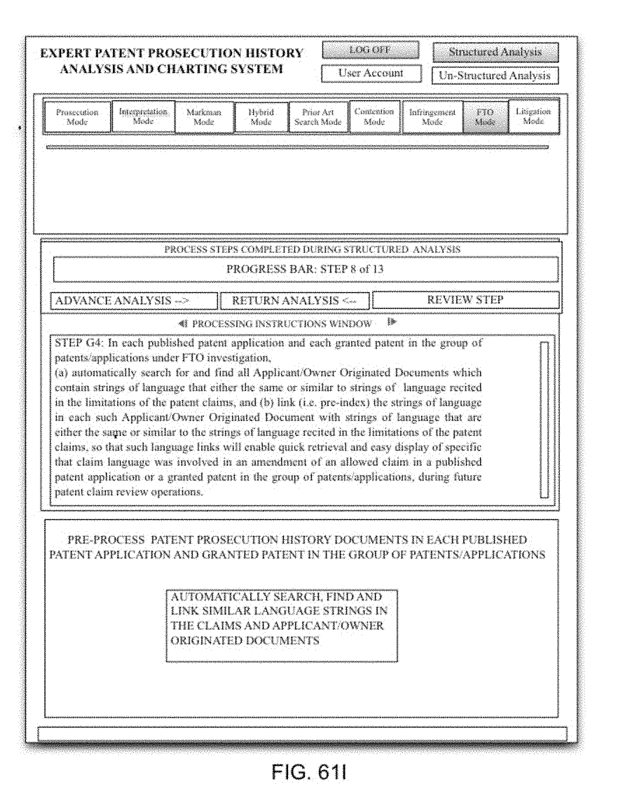

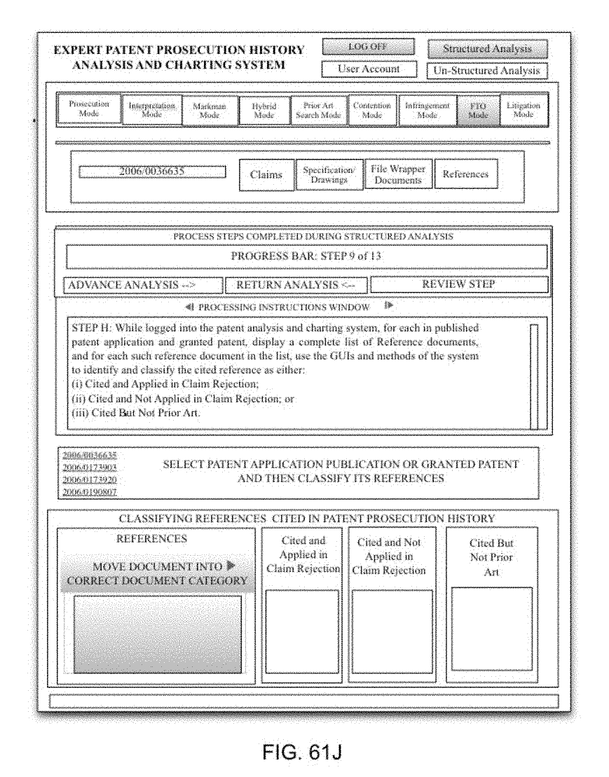

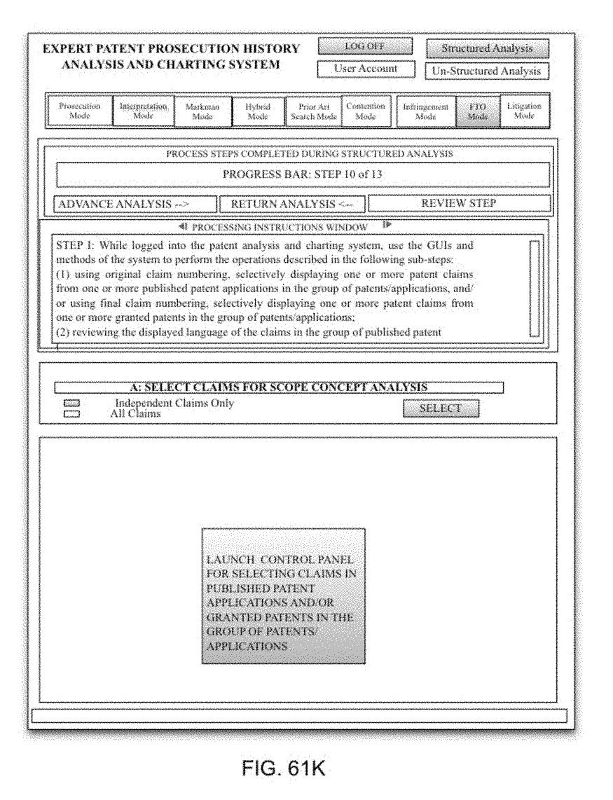

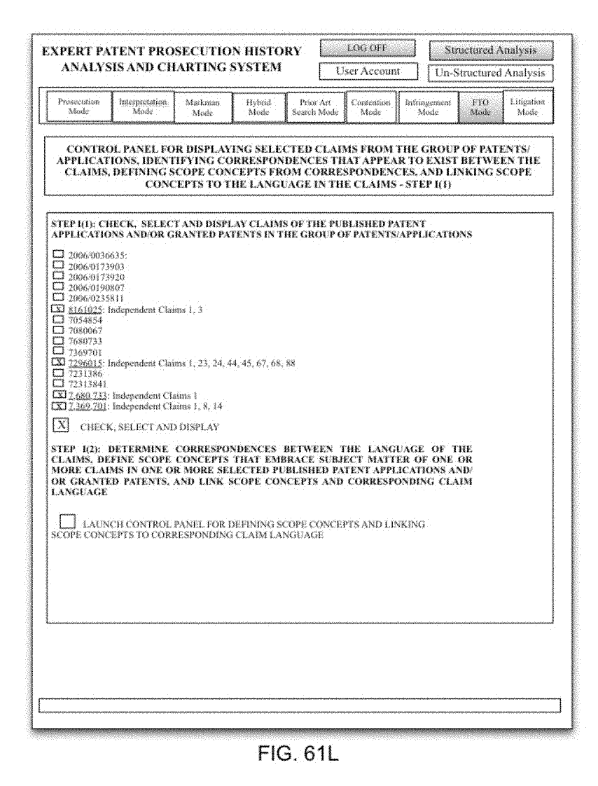

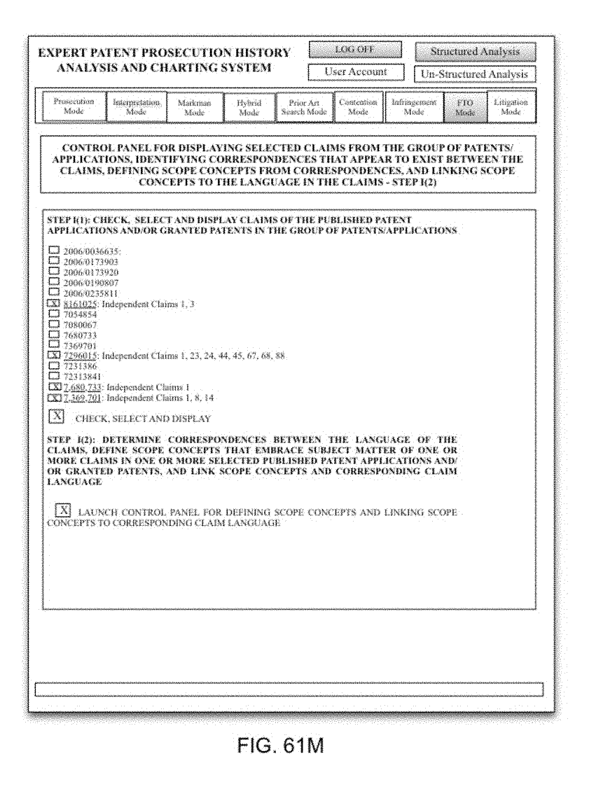

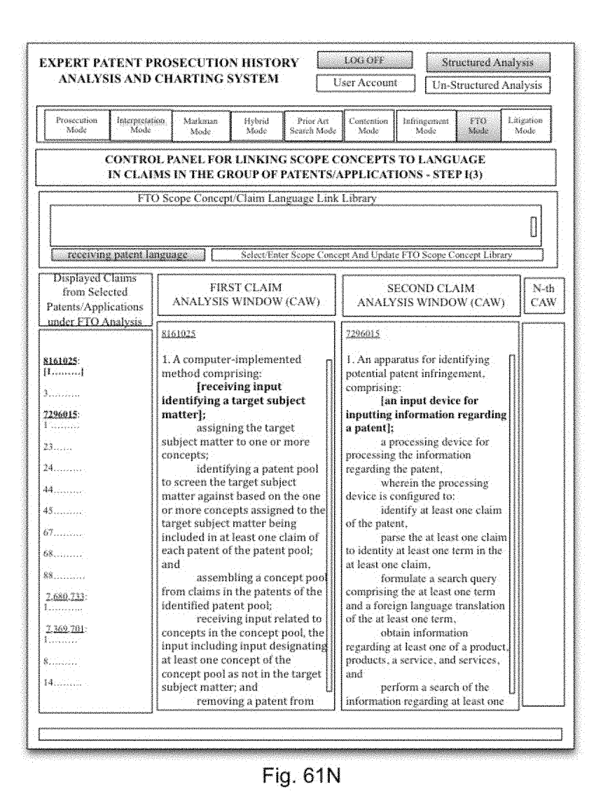

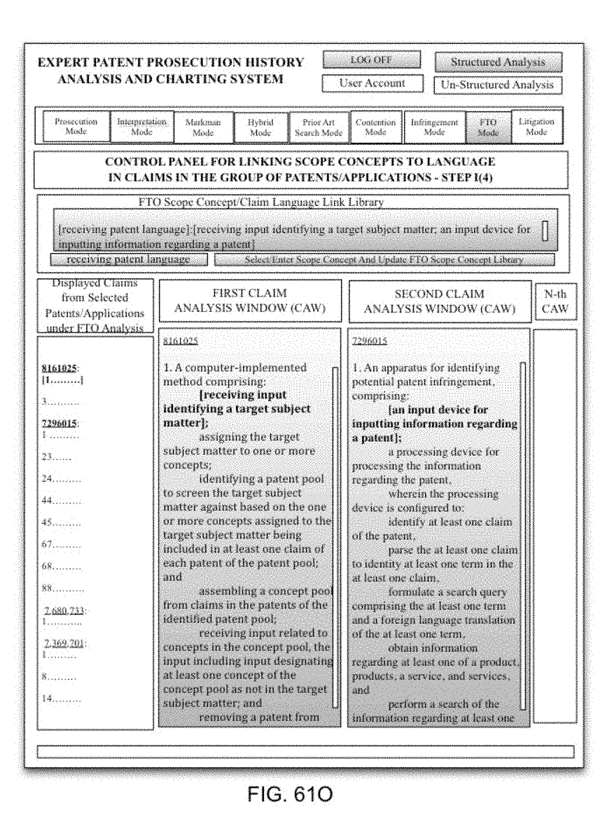

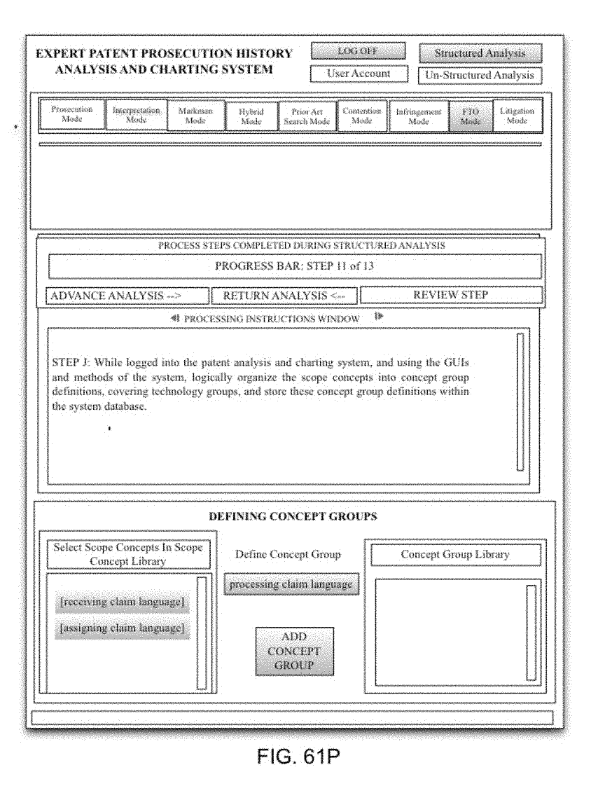

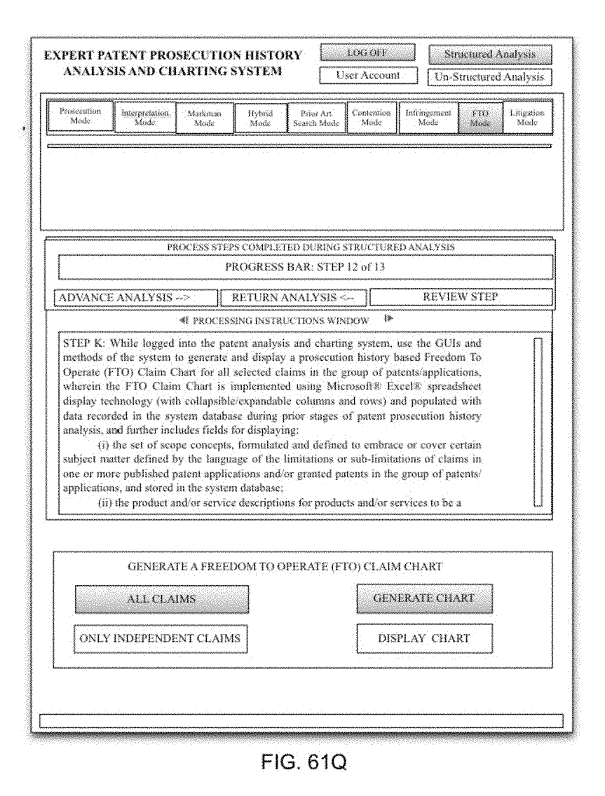

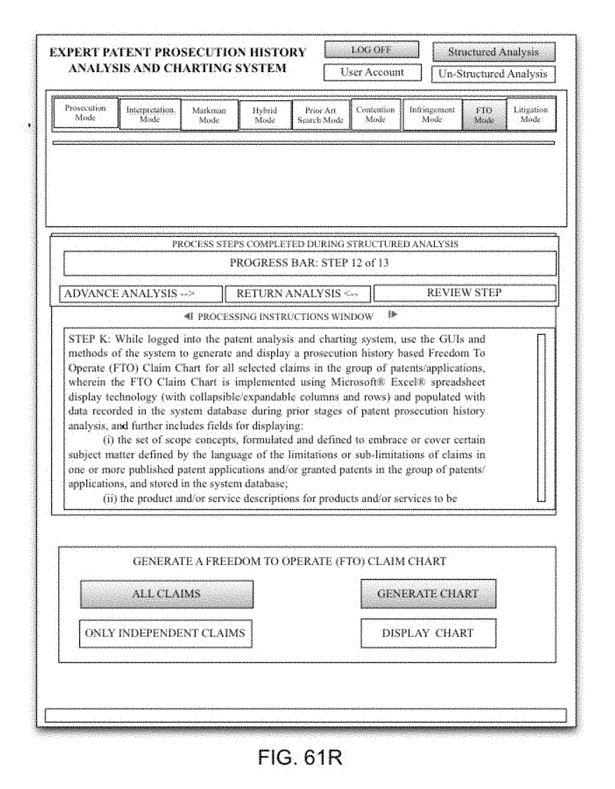

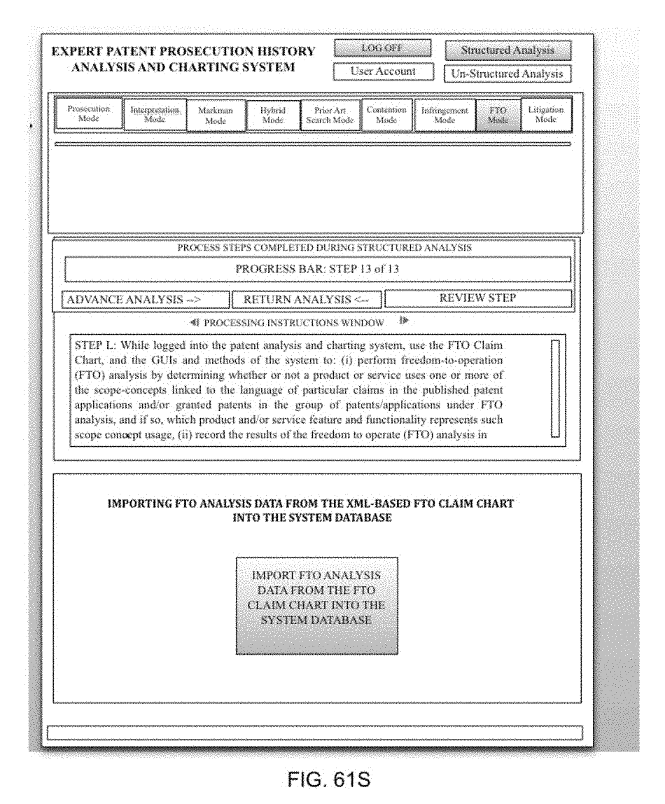

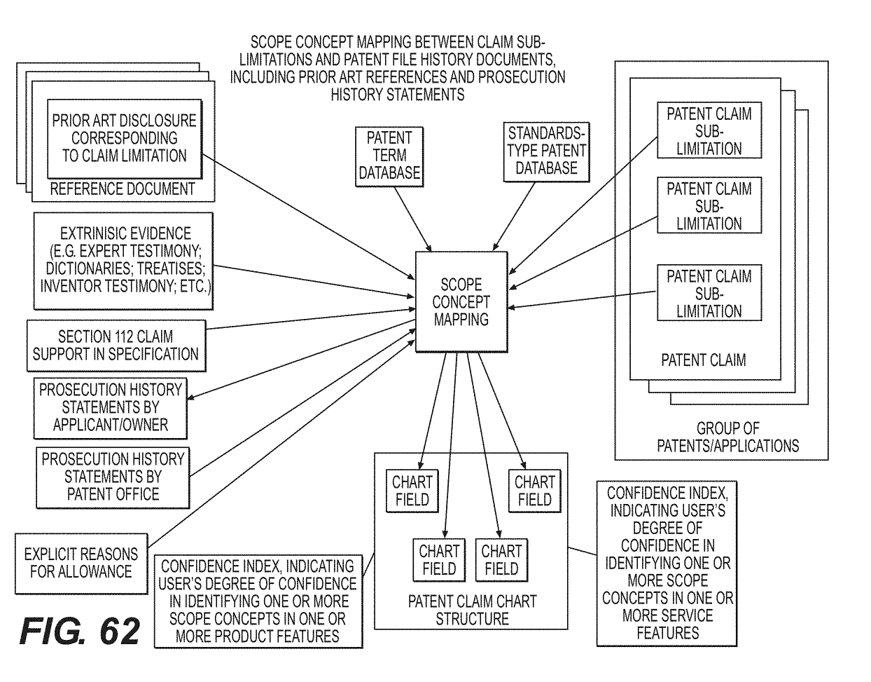

The workflow process specified in FIGS. 59A through 59F will be described now in greater detail with reference to corresponding wireframe GUIs shown in FIGS. 61A through 61S, and the information mapping process illustrated in FIGS. 60 and 62. Upon completion of the workflow process, the multi-mode system in its the patent claim prosecution mode is ready to automatically generate and display an XML-based spreadsheet-based chart structure as illustrated in FIG. 64A through 64I, that can be used by various users in any given user work group, including patent attorneys, during FTO analytical efforts.

For presentation purposes only, the XML-based spreadsheet-based chart structure shown in FIGS. 61A through 61S has been broken down into several sections in the figure Drawings, and should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

Method of Supporting Freedom-to-Operate (FTO) Analysis of Patent Claims in a Group of Granted Patents and/or Published Patent Applications Using a Patent Analysis and Charting System Configured in a Freedom to Operate (FTO) Analysis Mode of System Operation

Referring now to the detailed flow chart set forth in FIGS. 59A through 59F, the Internet-based patent analysis and charting system of the present invention configured in its patent claim prosecution (history) analysis mode of system operation will be now described in detail, and showing how one or more users can efficiently analyze and chart the patent prosecution history of any group of granted patents and/or published patent applications, using the wireframe GUI screens set forth in FIGS. 61A through 61S, the mapping techniques illustrated in FIGS. 58 and 62, and the patent prosecution history based chart structures described in FIGS. 64A through 64I. Various applications for the patent analysis and charting system configured in this mode of operation are illustrated in FIG. 60 and will be described in greater detail hereinbelow.

The steps of the process described in FIGS. 59A through 59F will be described in detail below.

As indicated in Step A in FIG. 59A, Web, application and database servers on a network are used to deploy an Internet-based object-oriented system platform that supports a computer-assisted analysis and charting of the prosecution histories of a group (i.e. pool) of patent published patent applications and/or granted patents in one or more national patent protection system(s). As shown in FIG. 5, the network is connected to the network information infrastructure and servers of national patent protection systems, and patent and published patent application depositories containing composite patent file history data documents for granted patents and pending (or abandoned) patent applications.

As indicated in Step B in FIG. 59A, web-enabled client machines are used to allow authorized users to log into the deployed patent analysis and charting system and perform the following operations specified below. As exemplary login GUI screen is shown in FIG. 61A for that purpose.

As indicated in Step C in FIG. 59A, the user employs a GUI as shown in FIG. 61B to configure the patent analysis and charting system in its freedom to operate (FTO) analysis mode of system operation, for computer-assisted analysis and charting of the group of patents/applications. In general, the patent analysis and charting system comprises a database for storing the patent file history data, patent claim data, and prior art reference data, and supporting methods, procedures, GUIs, etc. during patent prosecution analysis. The purpose of this step in the process is to select the mode of system operation to be configured on the system platform of the present invention.

As indicated in Step D in FIG. 59B, the user employs GUI screen as shown (as a Step G) in FIG. 61C, to store in the system database 15, product and/or service descriptions comprising language specifying the features and functionalities of products and/or services to be analyzed during freedom to operate (FTO) analysis. Specifically, while logged into the patent analysis and charting system, the user uses the GUI screen of FIG. 61C and methods of the system to load (i.e. store) product and/or service descriptions into the system database 15 for products and/or services to be investigated under FTO analysis, wherein each product description comprising a set of product features and functions specifying, in varying degrees of detail, structures embodied within and functionalities supported by the product to introduced into the marketplace. Each service description comprises a set of service features specifying, in varying degrees of detail, structures embodied within and functionalities supported by the service to be introduced into the marketplace.

As indicated in Step E in FIG. 59B, the user employs GUI screen as shown in FIG. 61D, so that the user can use the product and/or service descriptions, to conduct one or more patent searches designed to discover a group of patents/applications including published patent applications and granted patents having claims directed to subject matter described by features and functionalities of the product and/or service descriptions.

As indicated in Step F in FIG. 59B, the user employs GUI screen as shown in FIG. 61E, so that the user can enter patent application publication numbers and patent numbers into the system database, and then load patent prosecution history documents into the system database, corresponding to these patent application publication numbers and patent numbers. Specifically, during Substep F1, while logged into the patent analysis and charting system, the user uses the GUI screen of FIG. 61E and methods of the system to enter (i.e. store) patent/application data identifying the group of patents/applications including published patent applications and granted patents having claims directed to subject matter described by features and functionalities of the product and/or service descriptions. During Substep F2 (FIG. 61F), the user loads into the system database, the patent file history data of each identified published patent application and granted patent listed in the group of patents/applications under FTO analysis, including file wrapper history documents, patent claim data, cited prior art reference documents, etc in a format suitable for parsing and search analysis, and associate what patent file history data with the patent application publication number or patent grant number, as the case may be.

As indicated in Step G in FIG. 59C, the user employs GUI screens as shown in FIGS. 61G1, 61G2, 61H and 61I, so that the user can initiate the pre-processing of patent prosecution history documents stored in the patent analysis and charting system. During Substep G1, whenever necessary, the user uses optical character recognition (OCR) and/or other technologies to convert all documents in the patent prosecution (i.e. file) history data set into text searchable documents, as and where necessary, so that each such document is text searchable during the method of prosecution history analysis and charting according to the present invention. During Substep G2, the user uses the system to index all documents in the patent file history data set of each published patent application and granted patent in the group of patents/applications. In the illustrative embodiment, indexing is achieved by first by assigning a unique document number to each and every document in the patent file history data set of the group of patents/applications, and then second by compiling a complete list of indexed documents from the indexed patent file history data set. During Substep G3, for each published patent application and granted patent in the group of patents/applications under FTO analysis, the user uses the system to catalog each document in the complete list of indexed patent file history documents, into one of the three document categories: (i) Patent Office Originated Documents; (ii) Applicant/Owner Originated Documents (including Patent Specification and Claims); and (iii) Reference Documents Originated by the Patent Office, Applicant/Owner, or any party or entity. Notably, this step can be easily automated using pre-constructed tables that map USPTO file document names to one of the above document categories.

During Substep G4, in each published patent application and each granted patent in the group of patents/applications under FTO analysis, (a) automatically search for and find all Applicant/Owner Originated Documents which contain strings of language that either the same or similar to strings of language recited in the limitations of the patent claims, and (b) link (i.e. pre-index) the strings of language in each such Applicant/Owner Originated Document with strings of language that are either the same or similar to the strings of language recited in the limitations of the patent claims, so that such language links will enable quick retrieval and easy display of specific that claim language was involved in an amendment of an allowed claim in a published patent application or a granted patent in the group of patents/applications, during future patent claim review operations.

As indicated in Step H in FIG. 59C, the user employs a GUI screen as shown in FIG. 61J, so that the user can classify references cited in the patent prosecution history of each published patent application and granted patent in the group of patents/applications, and then store the classified references in the system database. Specifically, while logged into the patent analysis and charting system, for each published patent application and granted patent in the group of patents/applications, the user uses the system to display a complete list of Reference documents, and for each such reference document in the list, uses the GUIs and methods of the system to identify and classify the cited reference as either: (i) Cited and Applied in Claim Rejection; (ii) Cited and Not Applied in Claim Rejection; or (iii) Cited But Not Prior Art.

As indicated in Step I in FIG. 59D, the user employs GUI screen as shown in FIG. 61K, so that the user can (i) display and review the claims of one or more published patent applications and/or granted patents so as to support the definition and registration of scope concepts that embrace or cover certain subject matter of patent claims in one or more published patent applications and/or granted patents in the group of patents/applications, and also (ii) link claim limitation language of each such patent claim to its assigned scope concept, and storing each scope concept and claim language link in the system database. Specifically, this can be carried out as follows. While logged into the patent analysis and charting system, the user uses the GUI screen of FIG. 61K and methods of the system to perform the operations described in the following sub-steps:

(1) using original claim numbering, selectively displaying one or more patent claims from one or more published patent applications in the group of patents/applications, and/or using final claim numbering, selectively displaying one or more patent claims from one or more granted patents in the group of patents/applications (See GUI screen shown in FIG. 61L);

(2) reviewing the displayed language of the claims in the group of published patent applications and/or granted patents, and identifying any correspondences that may appear to exist between the language of the claims (See GUI screen shown in FIGS. 61M and 61N);

(3) using the identified correspondences to define a set of scope concepts that embrace or cover certain subject matter of the patent claims in one or more of the published patent applications and/or granted patents in the group of patents/applications (See GUI Screen shown in FIG. 61N);

(4) creating links between the scope concepts, and corresponding language in certain of the claims in the group of patents/applications, and storing these scope concept/claim language links in the system database (See GUI Screen in FIG. 61O); and

(5) repeating substeps (1) through (4) above so that at least one scope concept embraces or covers certain subject matter of one or more selected (e.g. independent) patent claims in each published patent application and/or granted patent in the group of patents/applications.

As indicated in Step J in FIG. 59D, the user employs GUI screen as shown in FIG. 61P, so that the user defines concept groups and stores the concept groups within the system database. Specifically, while logged into the patent analysis and charting system, and using the GUIs and methods of the system, the user logically organizes the scope concepts into concept group definitions, covering technology groups, and stores these concept group definitions within the system database.

As indicated in Step K in FIG. 59E, the user employs GUI screens as shown in FIGS. 61Q and 61R, so that the user can generate and display a prosecution history based freedom to operate (FTO) claim chart for all selected claims in the set of published patent applications and/or granted patents under FTO analysis. Specifically, while logged into the patent analysis and charting system, the user uses the GUI of FIGS. 61P and 61Q and methods of the system to generate and display a Freedom To Operate (FTO) claim chart structure for all selected claims in the group of patents/applications. The FTO claim chart structure is implemented using Microsoft® Excel® spreadsheet display technology (with collapsible/expandable columns and rows) and populated with data recorded in the system database.

As shown in FIGS. 64A through 64I, the Freedom-To-Operate (FTO) chart structure comprises data fields for presenting graphical representations of the following graphical objects:

(i) the set of scope concepts, formulated and defined to embrace or cover certain subject matter defined by the language of the limitations or sub-limitations of claims in one or more published patent applications and/or granted patents in the group of patents/applications, and stored in the system database;

(ii) the product and/or service descriptions for products and/or services to be analyzed for freedom to operate around the allowed claims in the group of patents/applications under FTO analysis, wherein each product description comprising a set of product features and functions specifying, in varying degrees of detail, structures embodied within and functionalities supported by the product to introduced into the marketplace, and wherein each service description comprises a set of service features specifying, in varying degrees of detail, structures embodied within and functionalities supported by the service to be introduced into the marketplace;

(iii) for each product description, a confidence index indicating the User's degree of confidence in identifying one or more scope concepts in one or more product features;

(iv) for each product description, a confidence index indicating the User's degree of confidence in identifying one or more scope concepts in one or more product features;

(v) the patent claims in each granted patent in the group of patents/applications, wherein each patent claim is indexed with issued claim numbering, and recites the language of the parsed claim limitations recited in the claim;

(vi) the patent claims in each published patent application in the group of patents/applications, wherein each patent claim is indexed with issued claim numbering, and recites the language of the parsed claim limitation recited in the claim;

(vii) for each patent claim, the language of the claim limitation or sub-limitation supporting each scope concept assigned to the patent claim;

(viii) prosecution history statements linked to language in claim limitations or sub-limitations supporting scope concept assignment;

(ix) scope concept reliability (SCR) index assigned by the user to each scope concept that is assigned to the language of the claim limitation or sub-limitation;

(x) data fields for the user to record which scope concepts, if any, are used by particular product features in each product description;

(xi) data fields for the user to record which scope concepts, if any, are used by particular service features in each service description;

(xi) links to searchable text documents in the prosecution history of each published patent application in the group of patents/applications;

(xiii) links to searchable text documents in the prosecution history of each granted patent in the group of patents/applications;

(xiv) a remaining patent term figure indicating the maximum number of remaining years that each granted patent or published patent application may be enforceable under its patent term; and

(xv) an indication of whether or not the granted patent or published patent application is a standards-type patent and is available for license under a standards-type licensing agreement.

As indicated in Step L in FIG. 59F, the user employs the displayed FTO chart structure to assist in performing freedom-to-operate (FTO) analysis, wherein the user determines whether or not a product or service uses one or more of the scope concepts linked to the language of particular claims in the published patent applications and/or granted patents in the group of patents/applications, and stores the results of the FTO analysis in the system database. Specifically, while logged into the patent analysis and charting system, the user employs the displayed FTO claim chart structure, and methods of the system to: (i) perform freedom-to-operation (FTO) analysis by determining whether or not a product or service uses one or more of the scope concepts linked to the language of particular claims in the published patent applications and/or granted patents in the group of patents/applications under FTO analysis, and if so, which product and/or service feature and functionality represents such scope concept usage; (ii) record the results of the freedom to operate (FTO) analysis in the system database; and (iii) import the results of the FTO analysis into the system database, using the import FTO analysis data button on the GUI screen shown in FIG. 61S, which initiates XML importation of data from the XML-based FTO chart structure into the system database, in a manner similar to that described for other XML-based chart structures described hereinabove.

Specification of Preferred Method of Forming Scope Concepts During Freedom to Operate (FTO) Analysis Involving One or More Products and/or Services, and Linking Scope Concepts to Language in the Claims of Published Patent Applications and/or Granted Patents in a Group of Patents/Applications

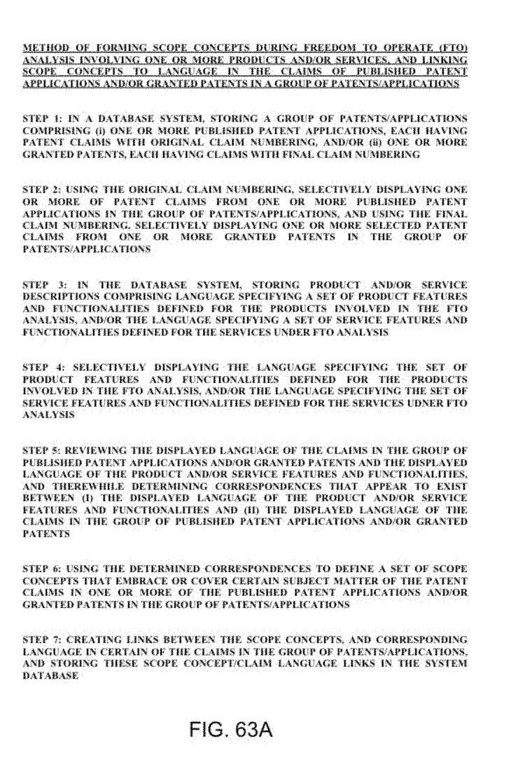

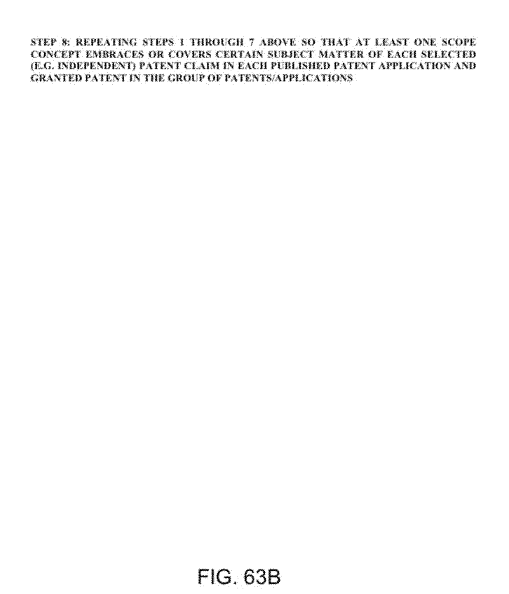

Preferably, the step of defining scope concepts and linking them to certain language in the claims of the group of patents/applications, as indicated at Step I in FIG. 59D, is carried out using the scope concept formulation and linkage method (i.e. process) described in the flow chart set forth in FIGS. 63A and 63B. This method will be specified in greater detail below.

As indicated in Step 1 in the flow chart of FIG. 63A, the method requires that the FTO analyzer (i.e. user) store in the system database, a group of patents/applications comprising (i) one or more published patent applications, each having patent claims with original claim numbering, and/or (ii) one or more granted patents, each having claims with final claim numbering. This step has been described previously above.

As indicated in Step 2 in the flow chart of FIG. 63A, one or more selected patent claims from one or more granted patents in the group of patents/applications are selectively displayed using the original claim numbering, and one or more of patent claims from one or more published patent applications in the group of patents/applications are selectively displayed using the final claim numbering.

As indicated in Step 3 in the flow chart of FIG. 63A, the user stores in the database system, product and/or service descriptions comprising language specifying a set of product features and functionalities defined for the products involved in the FTO analysis, and/or the language specifying a set of service features and functionalities defined for the services under FTO analysis.

As indicated in Step 4 in the flow chart of FIG. 63A, using the system, the user selectively displays the language specifying the set of product features and functionalities defined for the products involved in the FTO analysis, and/or the language specifying the set of service features and functionalities defined for the services under FTO analysis.

As indicated in Step 5 in the flow chart of FIG. 63A, the user reviews the displayed language of the claims in the group of published patent applications and/or granted patents and the displayed language of the product and/or service features and functionalities, and therewhile determining correspondences that appear to exist between (i) the displayed language of the product and/or service features and functionalities and (ii) the displayed language of the claims in the group of published patent applications and/or granted patents.

As indicated in Step 6 in flow chart of FIG. 63A, using system GUIs, the user uses determined correspondences to define a set of scope concepts that embrace or cover certain subject matter of the patent claims in one or more of the published patent applications and/or granted patents in the group of patents/applications.

As indicated in Step 7 of FIG. 63A, the user uses system GUIs to create links between the scope concepts, and corresponding language in certain of the claims in the group of patents/applications, and storing these scope concept/claim language links in the system database.

As indicated in Step 8 in FIG. 63B, the user repeats steps 1 through 7 above so that at least one scope concept embraces or covers certain subject matter of each selected (e.g. independent) patent claim in each published patent application and granted patent in the group of patents/applications.

FIG. 60 illustrates the application of the multi-mode patent analysis and charting system configured in its FTO analysis mode of system operation, and deployed during particular phases of the patent life-cycle time line, by both the patent owner and its competitors. In particular, the patent owner can use the FTO analysis mode of operation in defensive applications, by (i) studying the patent claims of third-parties and avoiding potential patent claim infringement issues during the product/service design phase. Also, the patent owner can use the FTO analysis mode of operation in offensive applications, by studying its patent claims and identifying potential sources of patent claim infringement and thereafter conducting a more deeper patent claim infringement analysis on certain identified patent claims.

### Specification of the Multi-Mode Patent Analysis and Charting System of the Present Invention Configured in its Patent Litigation-Storyboard Analysis Mode of System Operation (Mode 8)

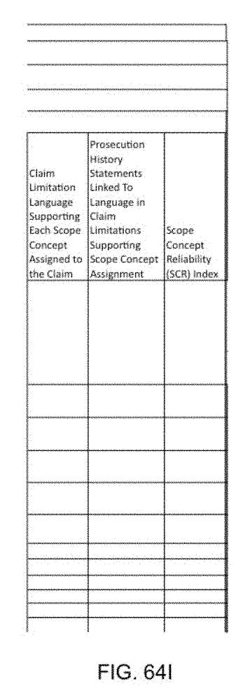

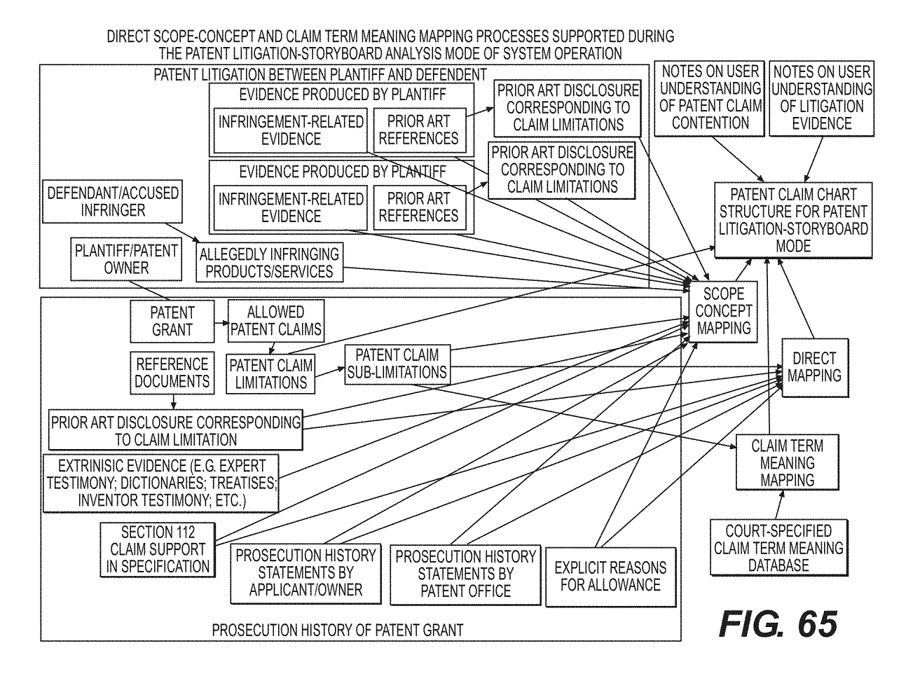

FIG. 65 illustrate the information mapping process supported by the system during its patent litigation-storyboard analysis mode of system operation, wherein patent claim data, prosecution history data court-specified claim term meaning definitions for common claim terms, product and/or service data relating to products and/or services involved in litigation, as well as plaintiff-produced evidence and defendant-produced evidence, are mapped to particular fields within the claim chart structures generated during this particular mode of system operation.

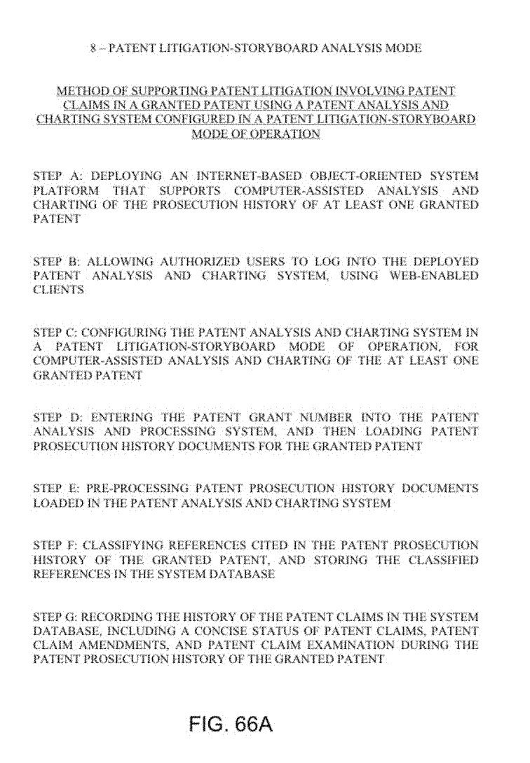

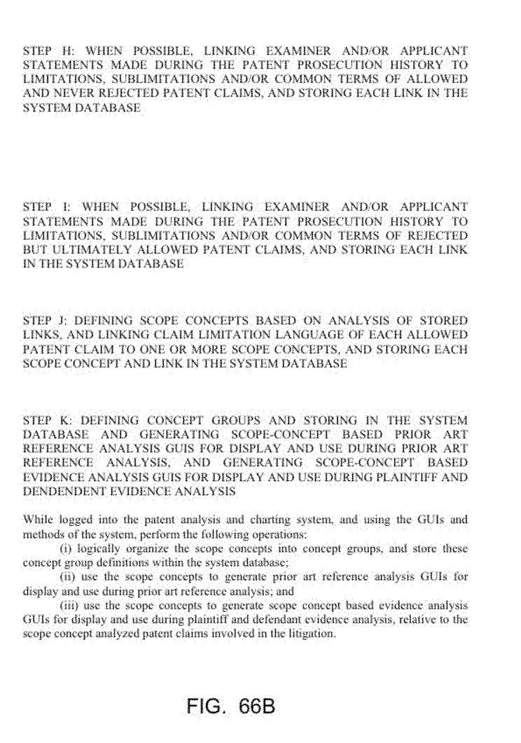

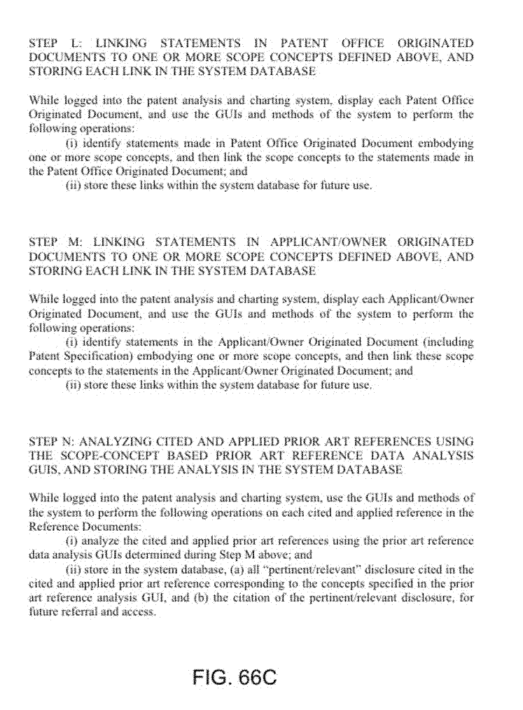

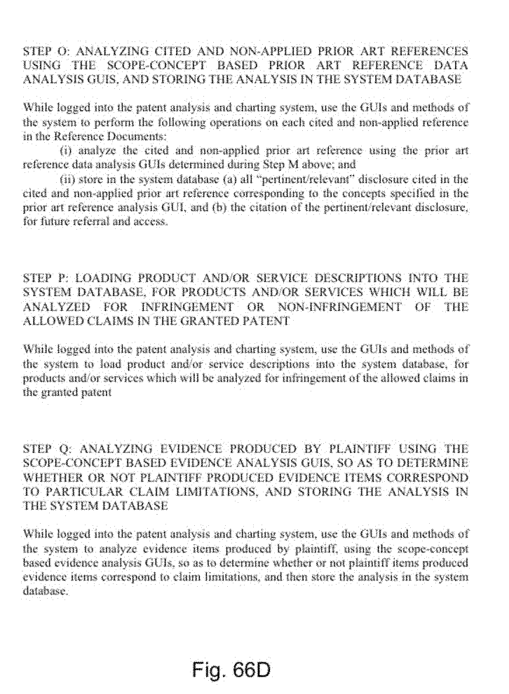

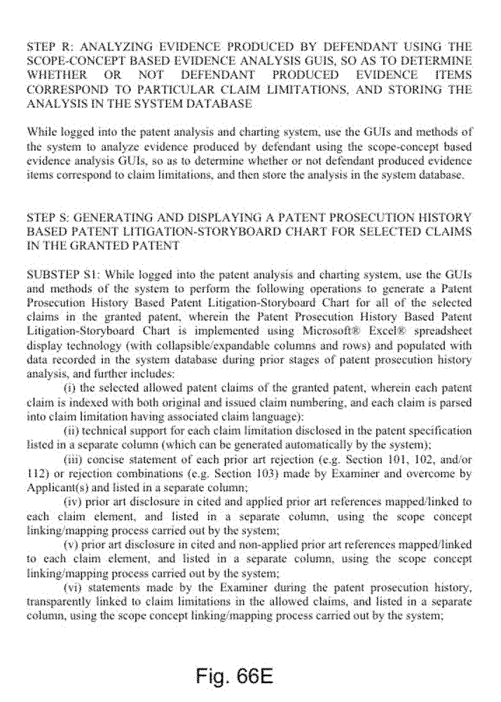

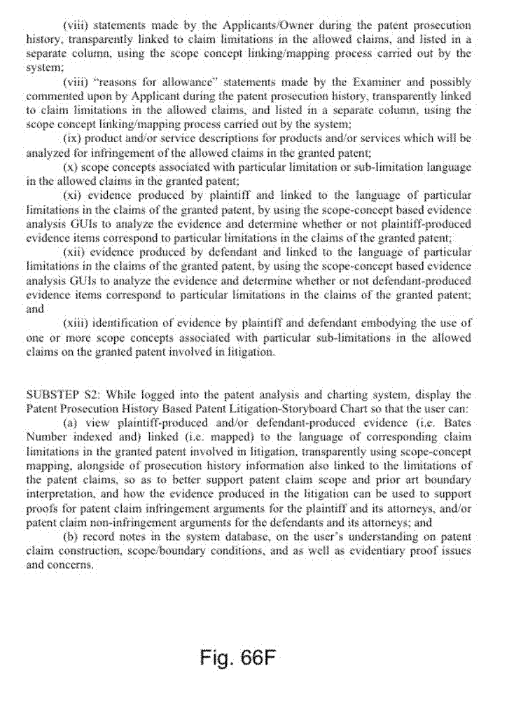

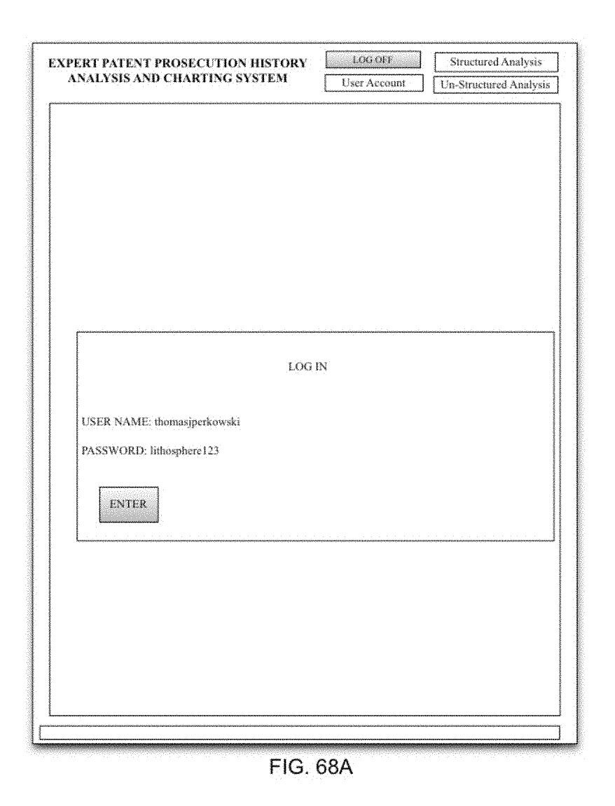

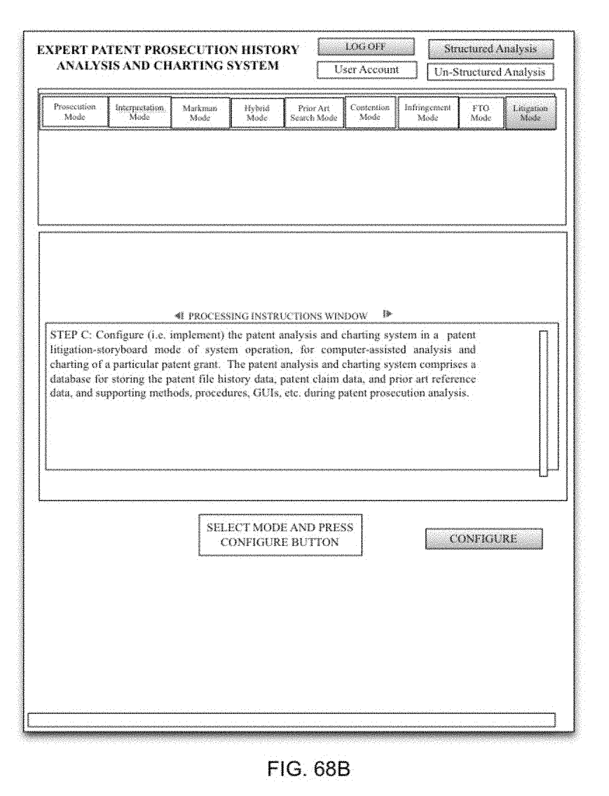

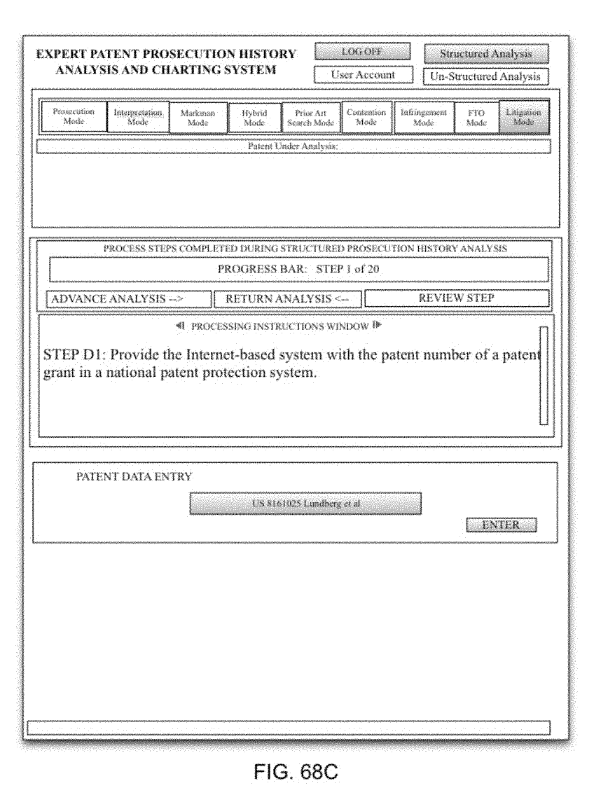

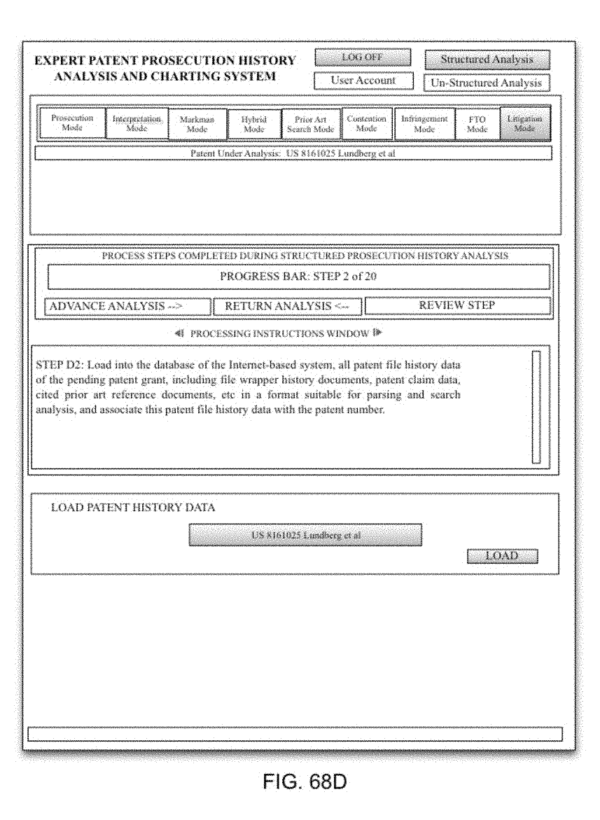

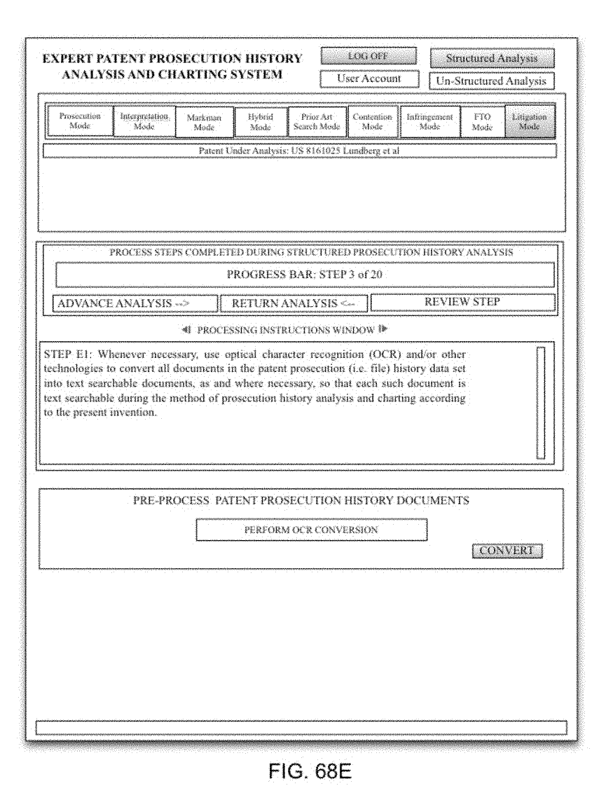

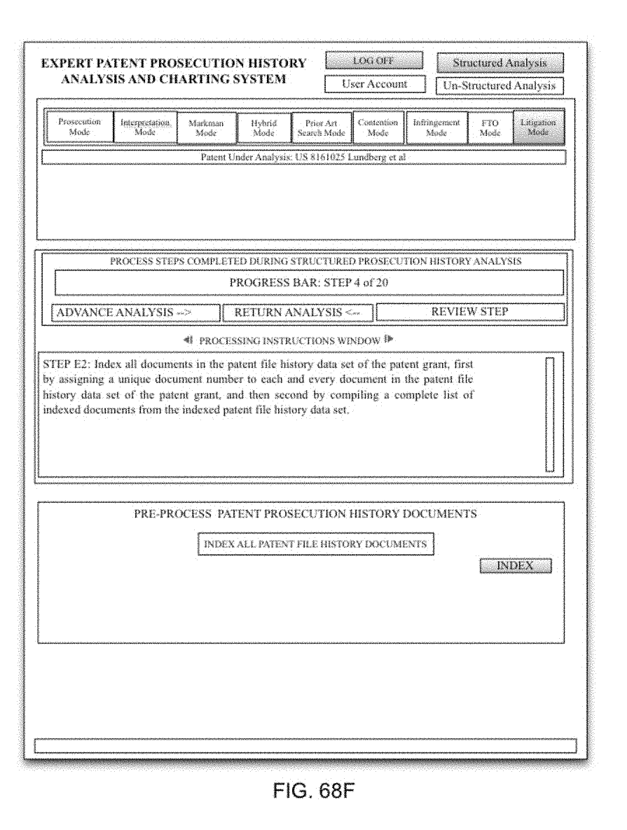

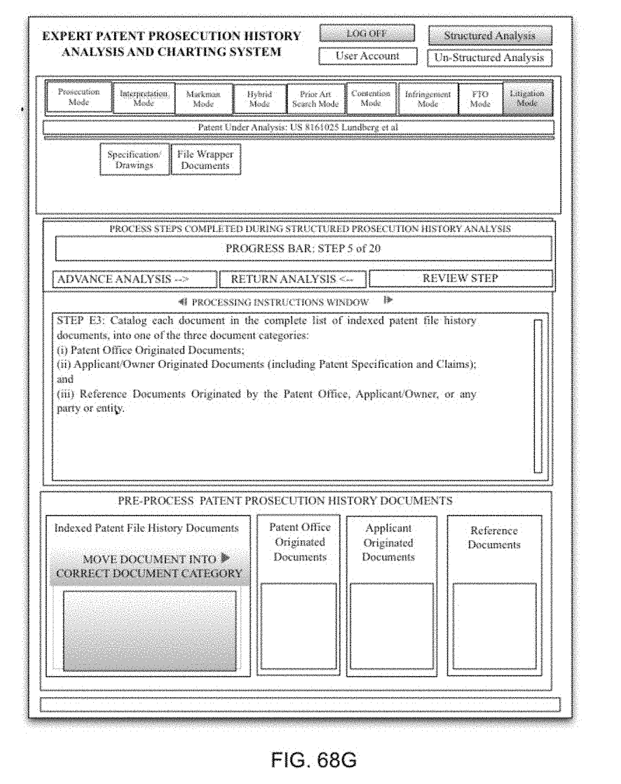

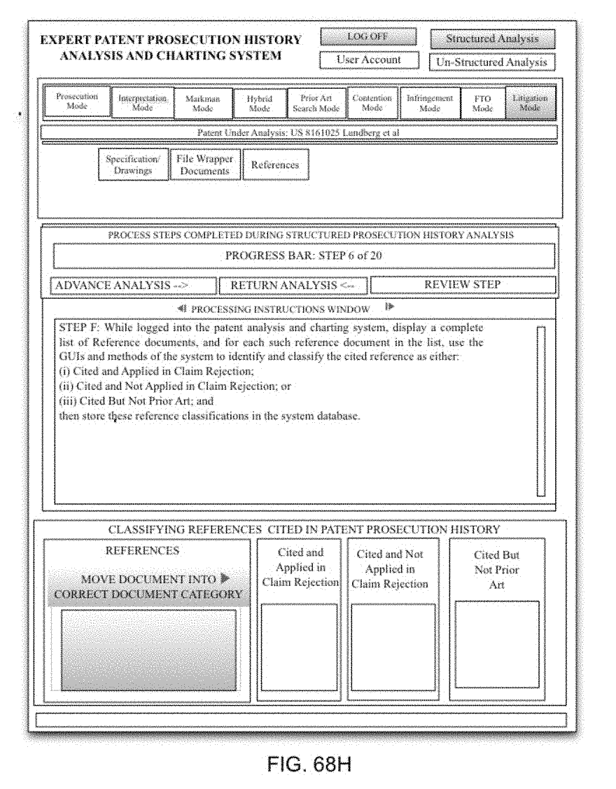

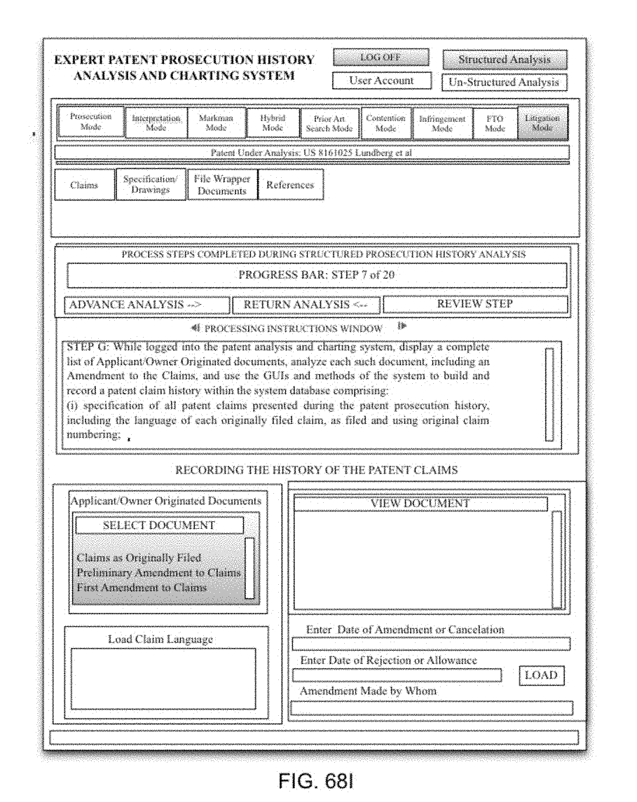

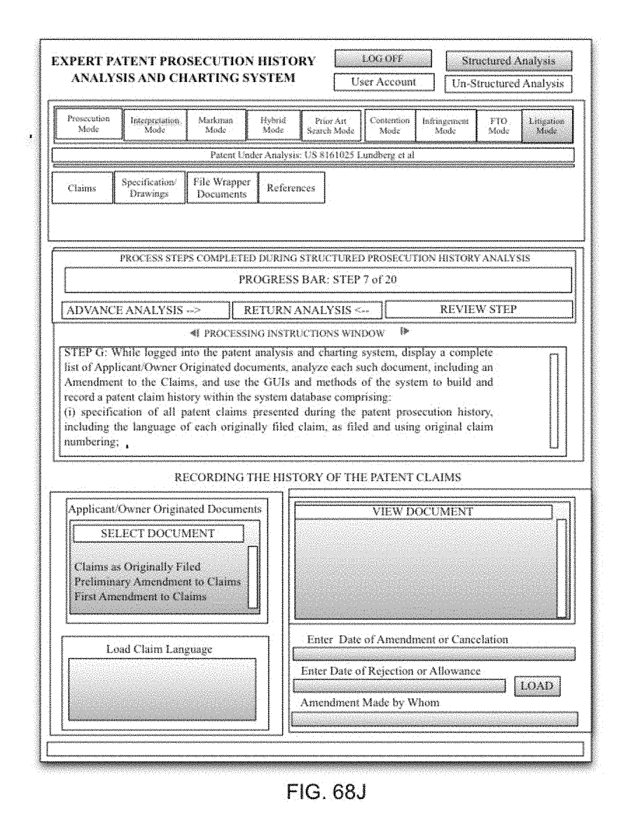

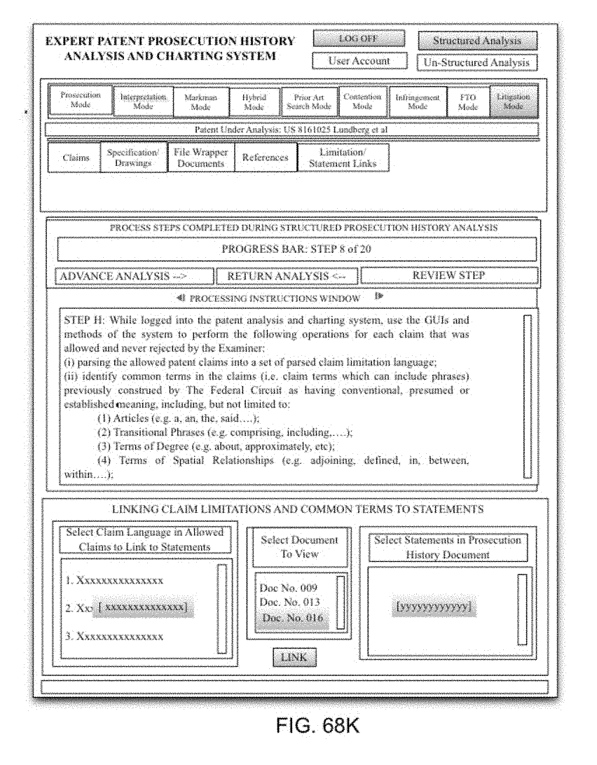

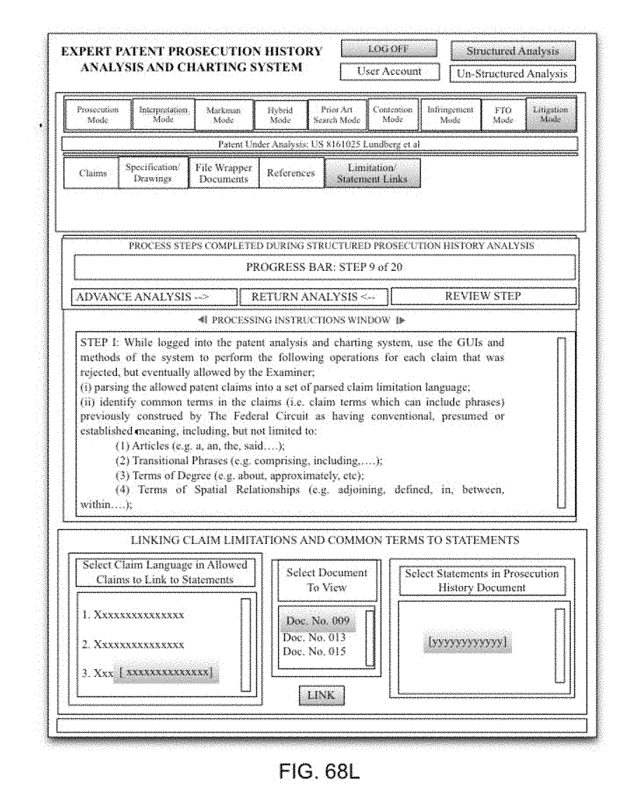

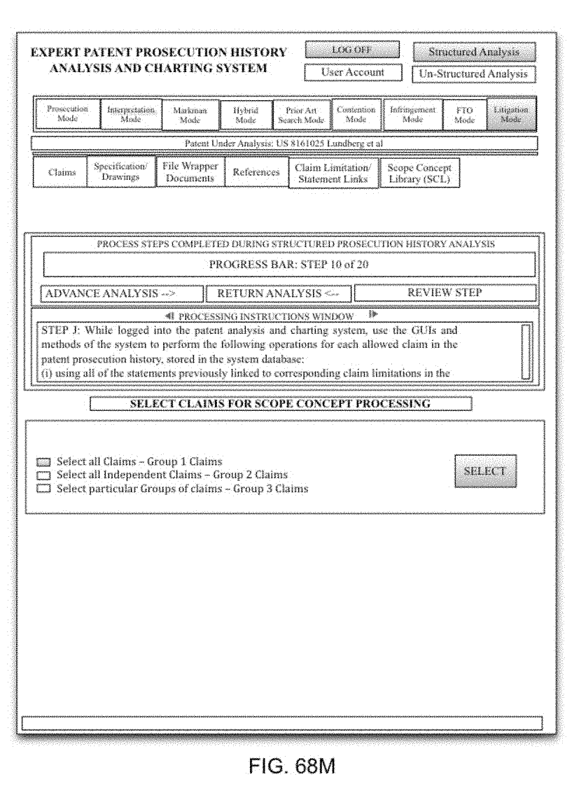

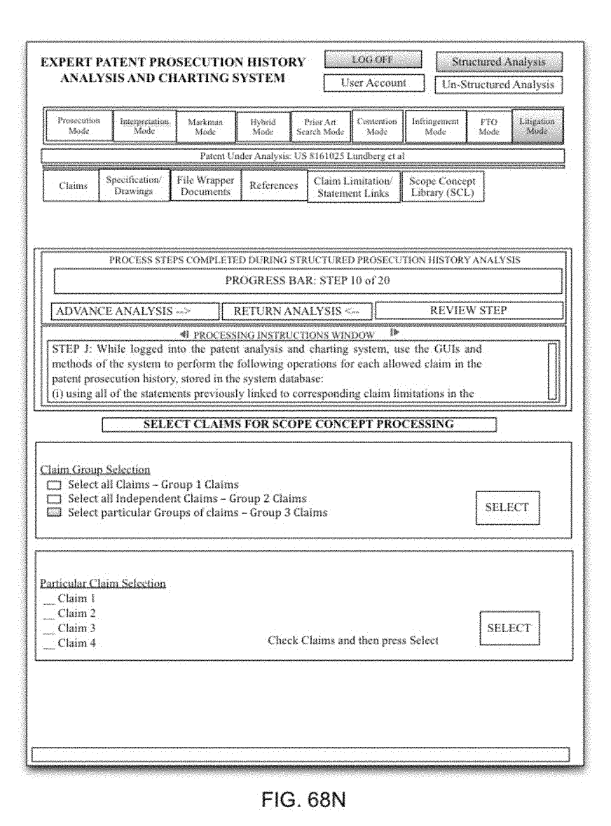

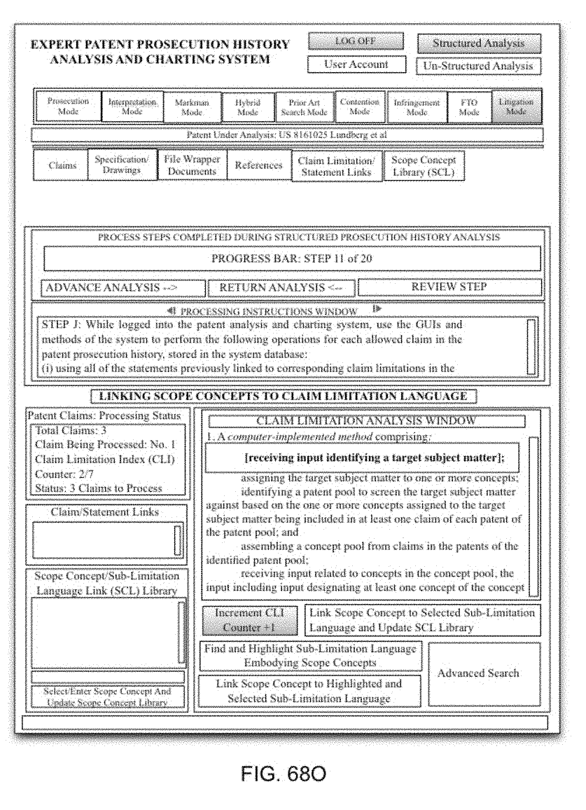

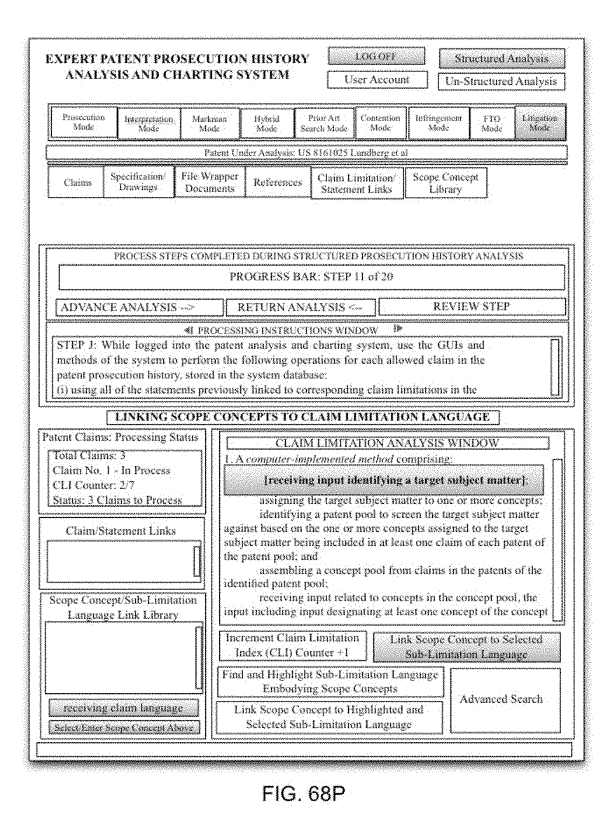

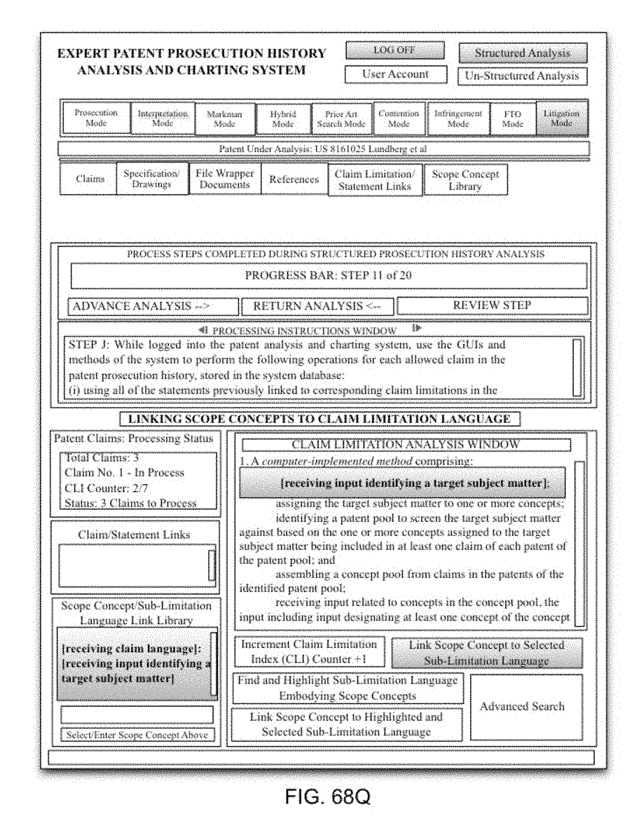

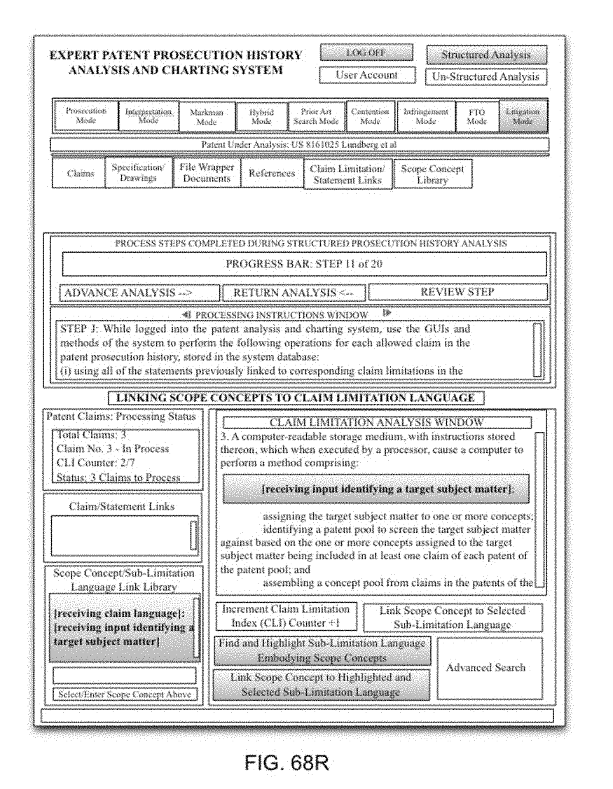

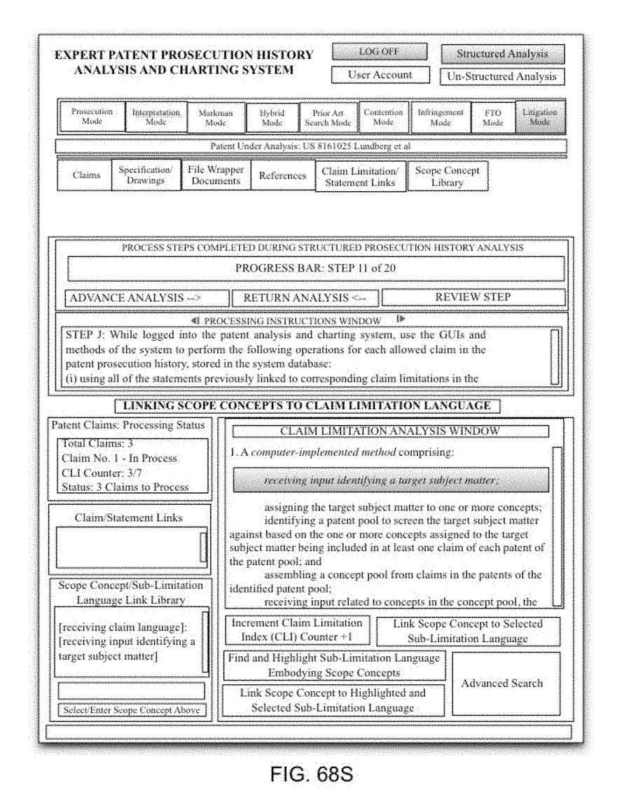

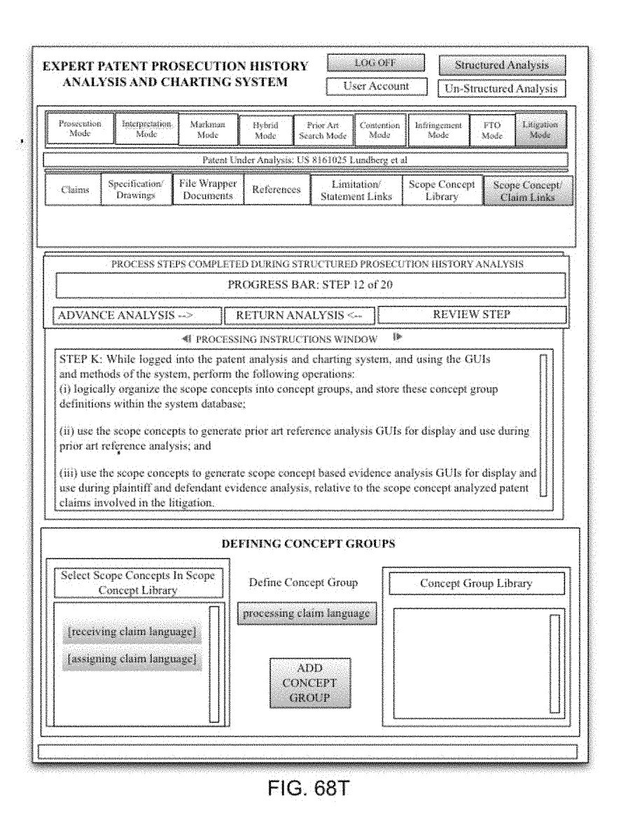

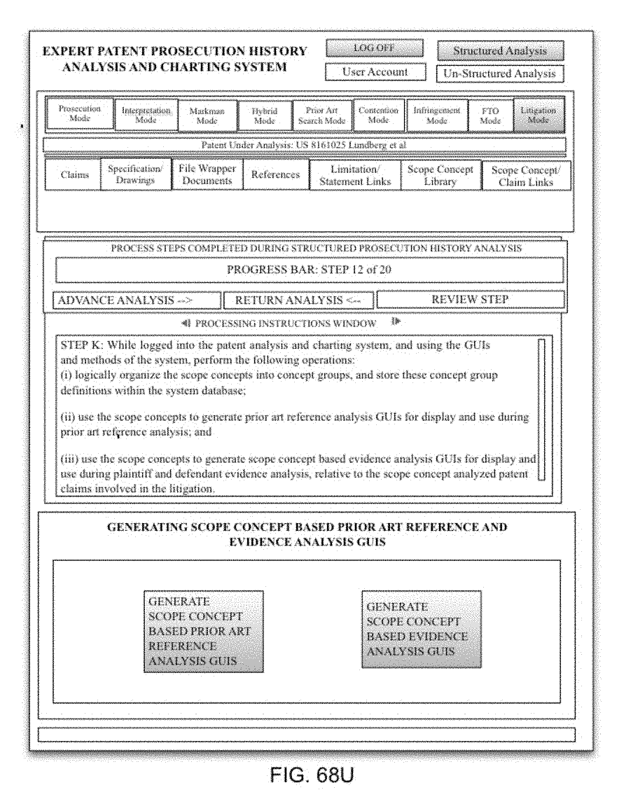

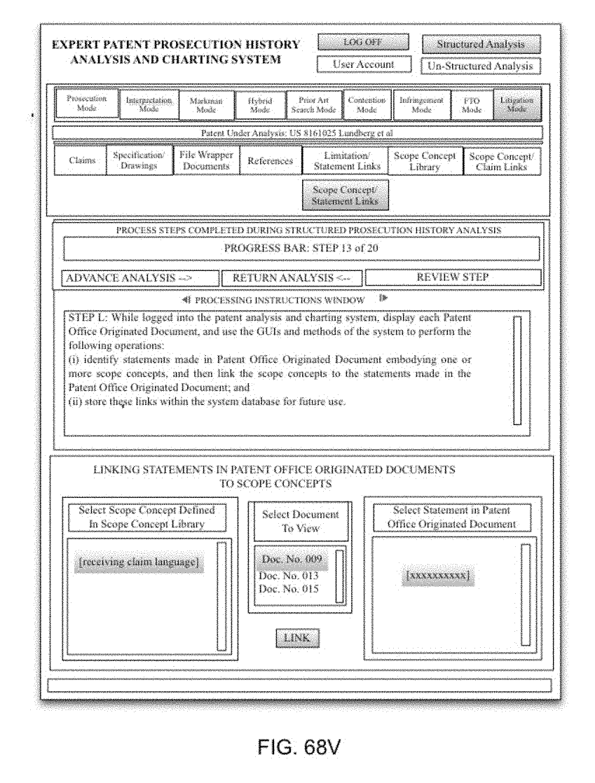

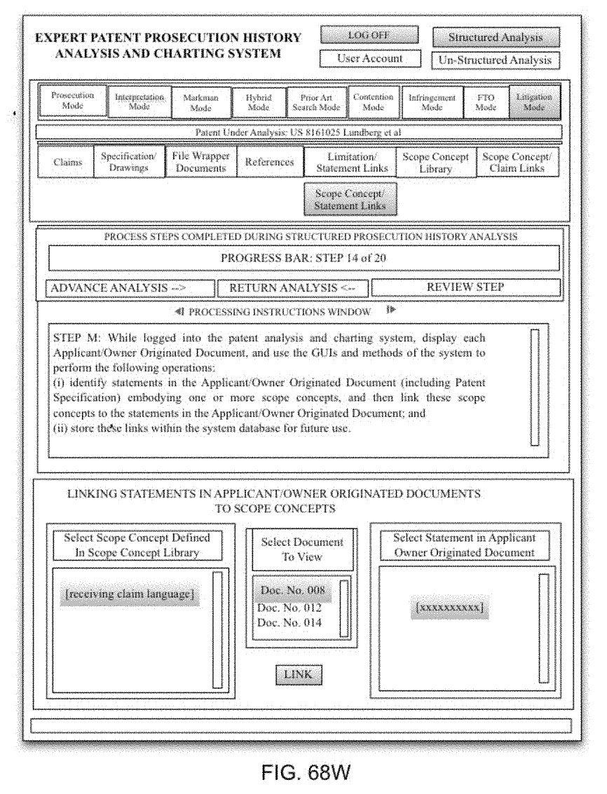

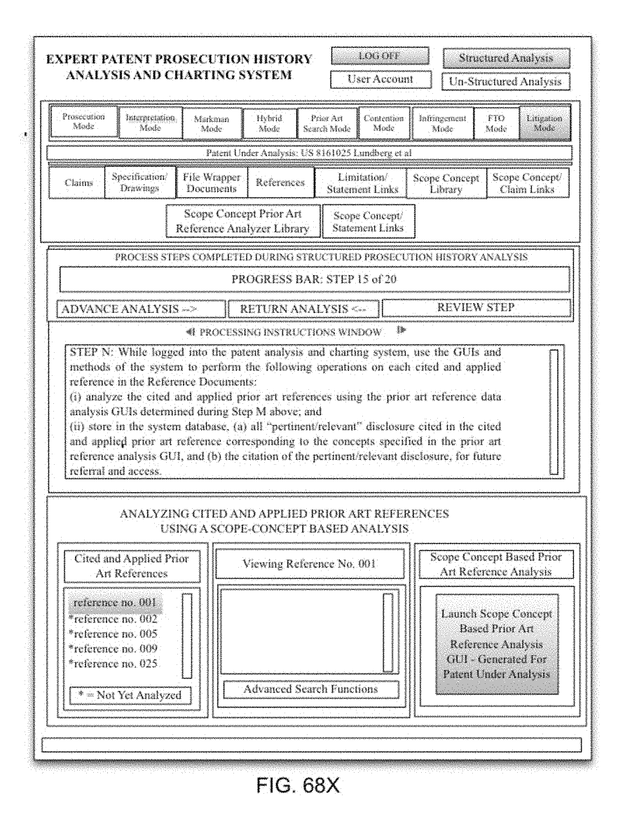

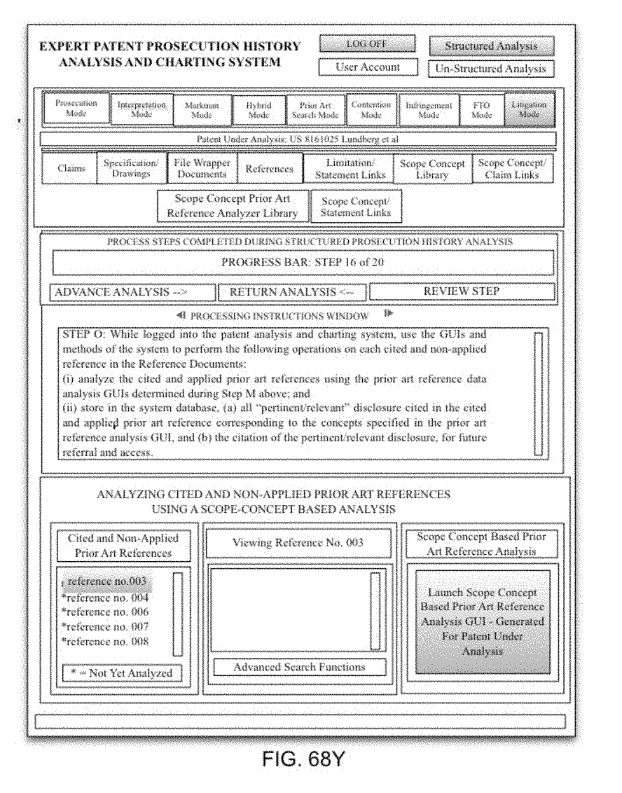

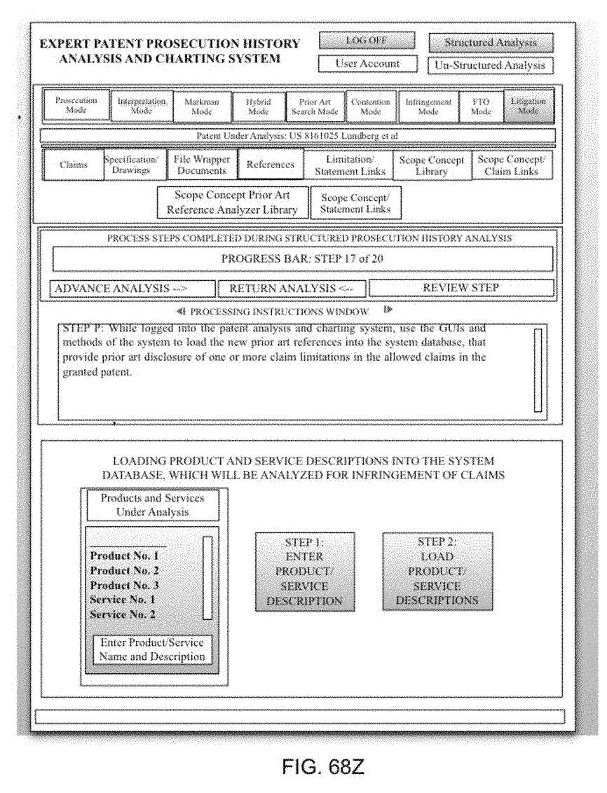

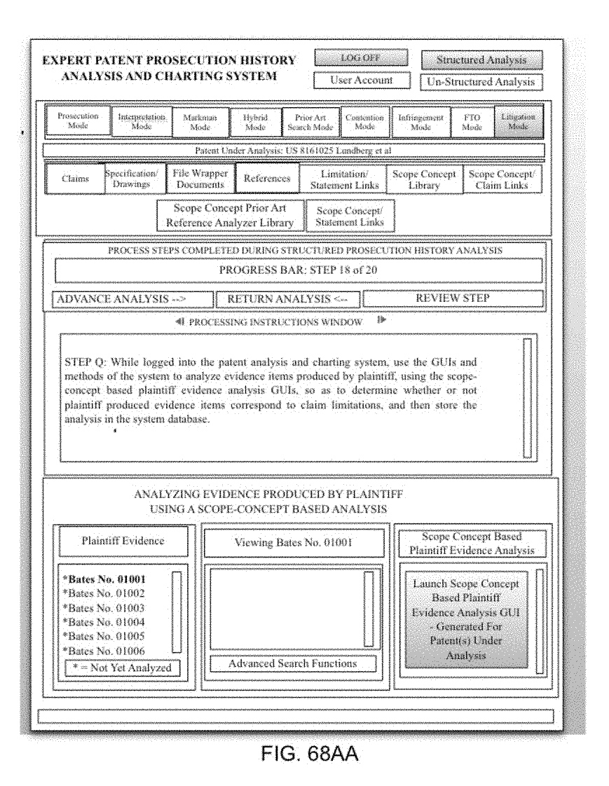

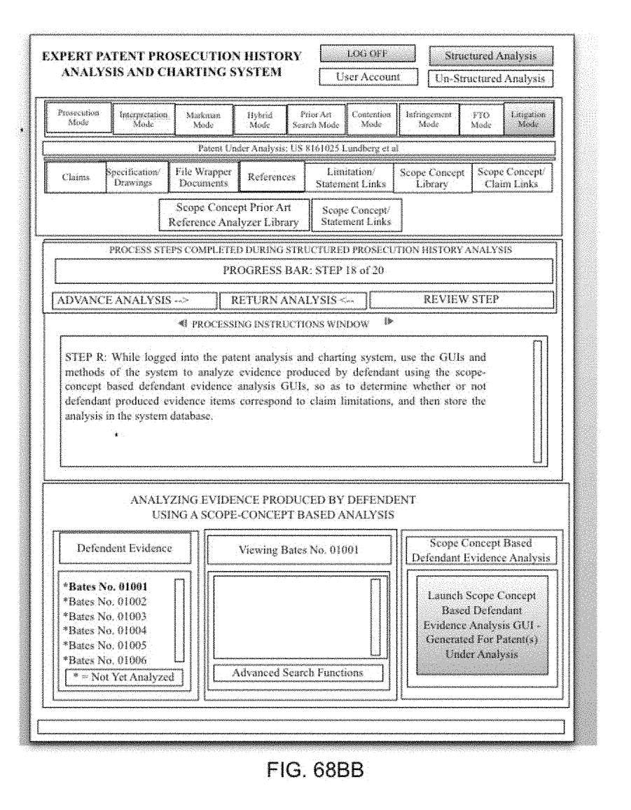

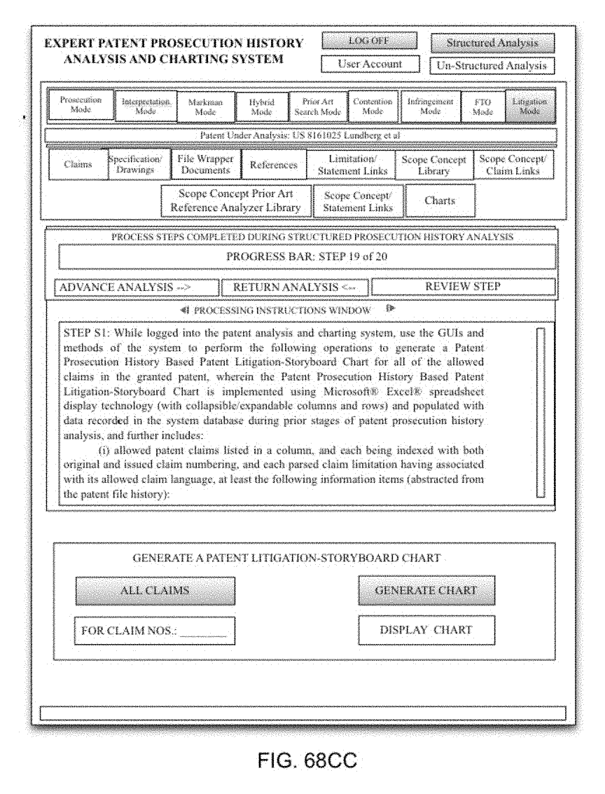

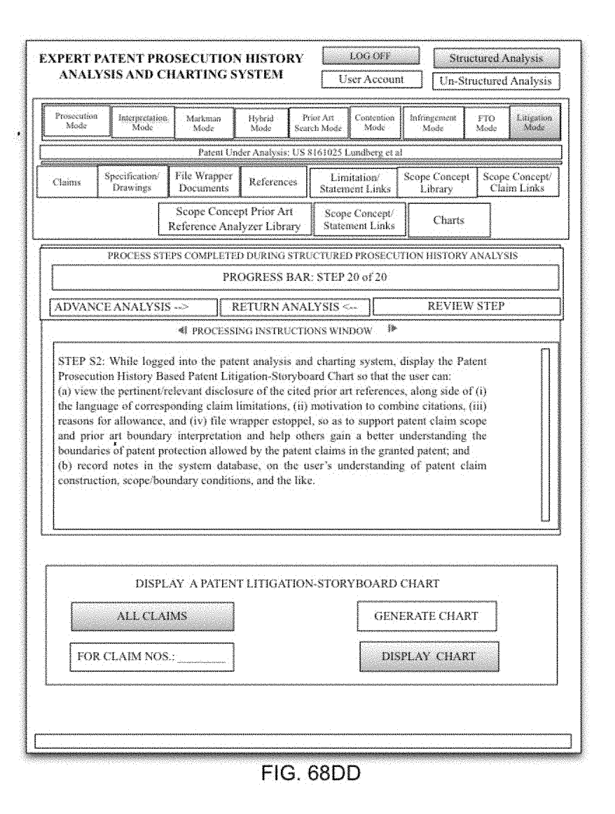

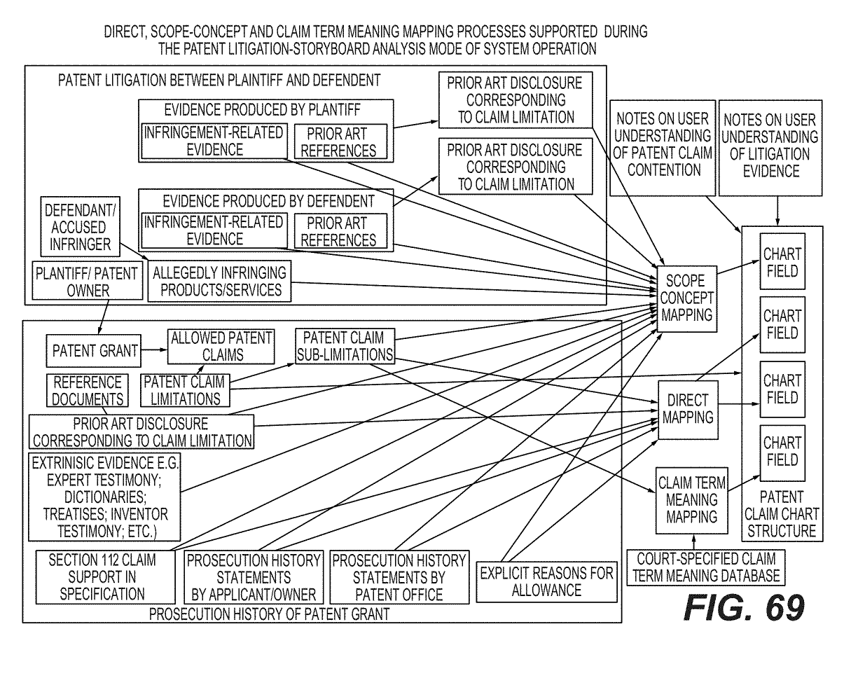

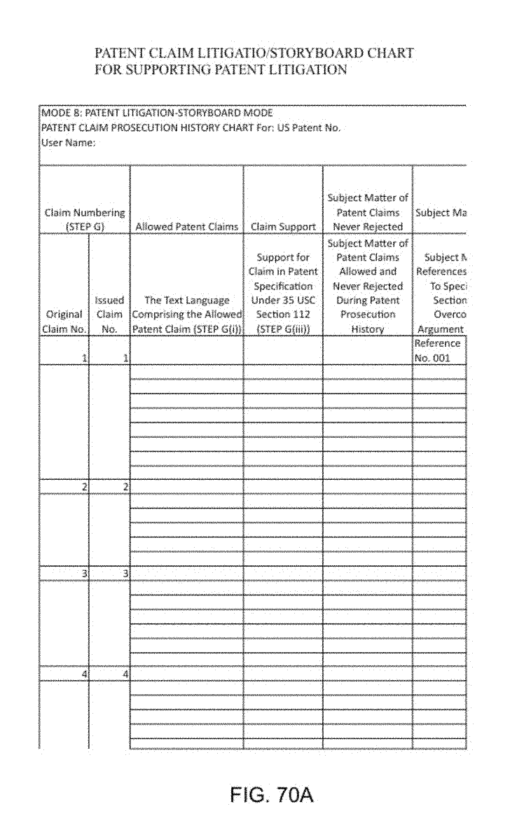

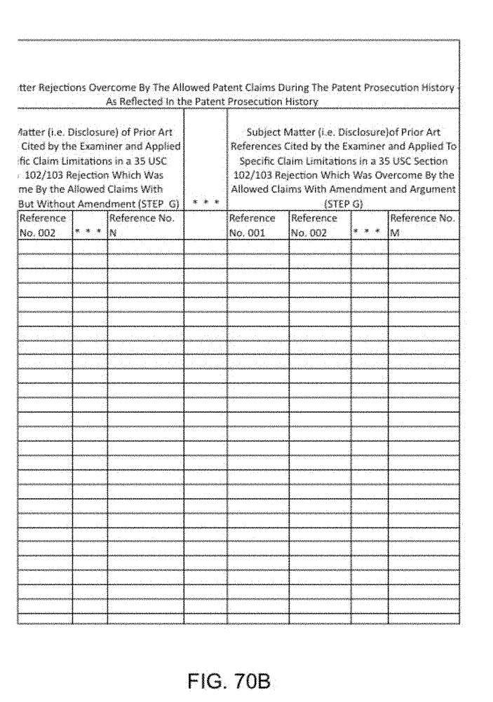

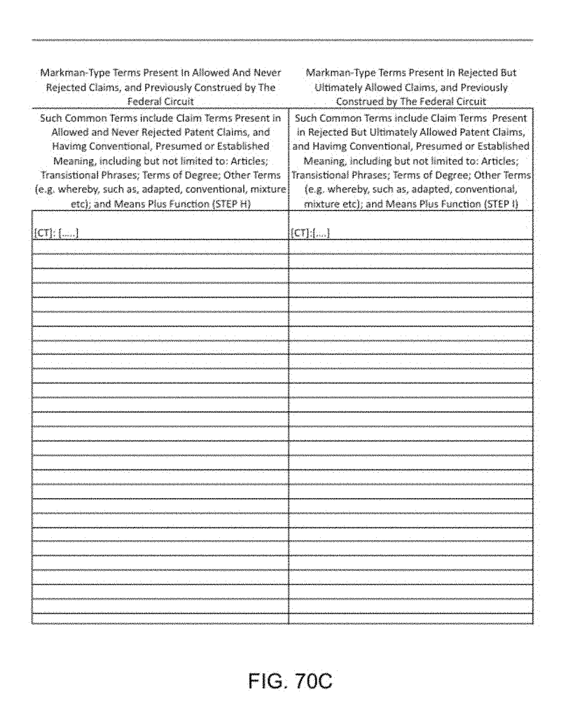

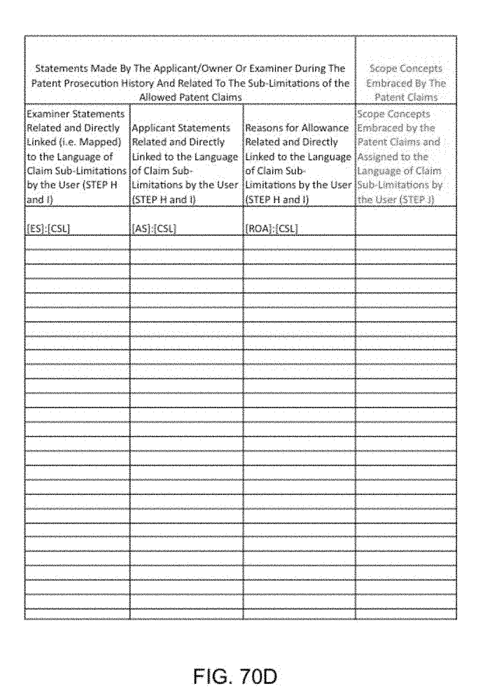

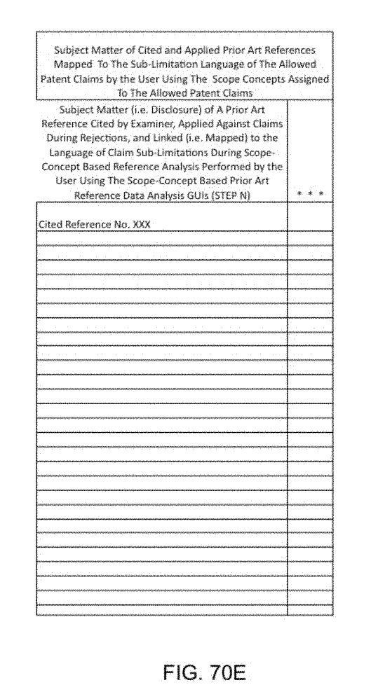

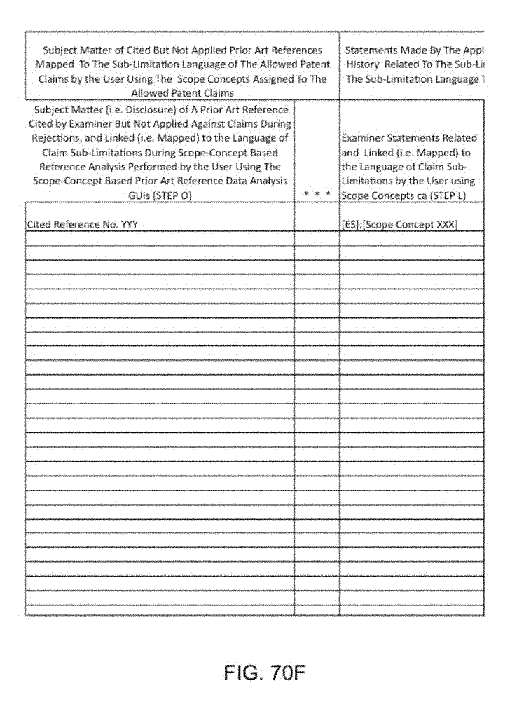

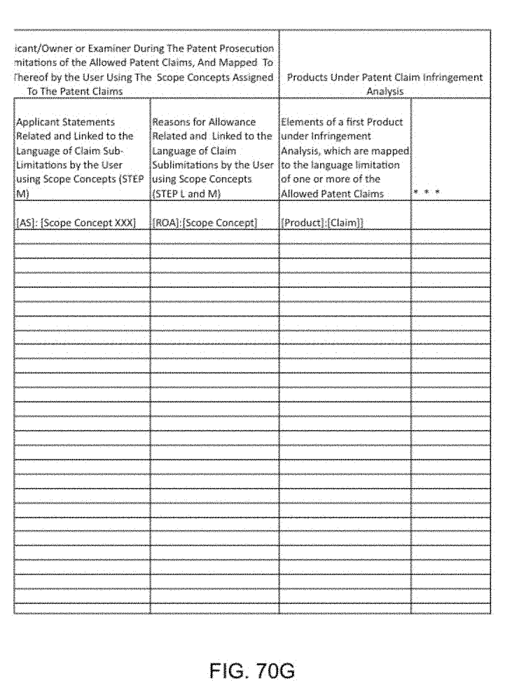

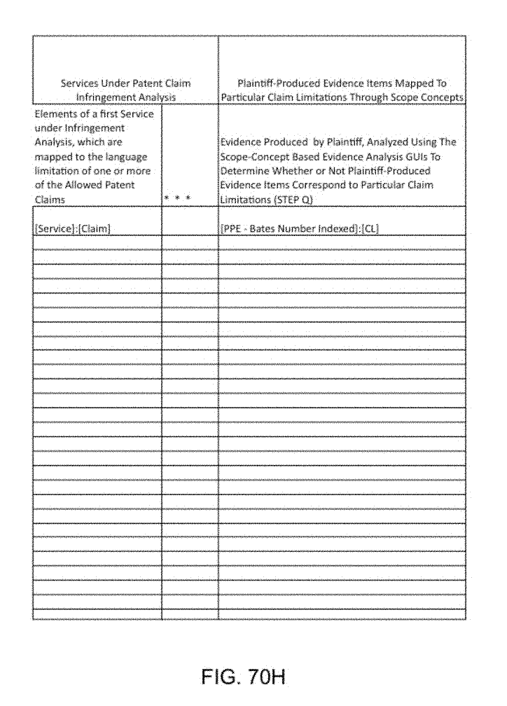

The workflow process specified in FIGS. 66A through 66C will be described now in greater detail with reference to corresponding wireframe GUIs shown in FIGS. 68A through 68CC, and the information mapping process illustrated in FIGS. 65 and 69. Upon completion of the workflow process, the multi-mode system in its the patent claim prosecution mode will automatically generate and display an XML-based spreadsheet-based chart structure as illustrated in FIG. 70A through 70I, that can be used by various users in any given user work group, including patent attorneys, during patent claim scope/boundary interpretation and other analytical efforts.

For presentation purposes only, the XML-based spreadsheet-based chart structure shown in FIGS. 70A through 70I has been broken down into several sections in the figure Drawings. For proper viewing, these figure drawings should be visually reassembled, in a side-by-side manner, to reconstruct the chart structure into an integrated form, as would be experienced by any user when reviewing the chart structure during system operation using a conventional spreadsheet program, such as Microsoft® Excel® spreadsheet modeling program, or functionally equivalent program, or as a downloaded XML-based spreadsheet document opened and viewed using a suitable spreadsheet program.

### Method of Supporting Patent Litigation Involving Patent Claims in a Granted Patent Using a Patent Analysis and Charting System Configured in a Patent Litigation-Storyboard Mode of Operation

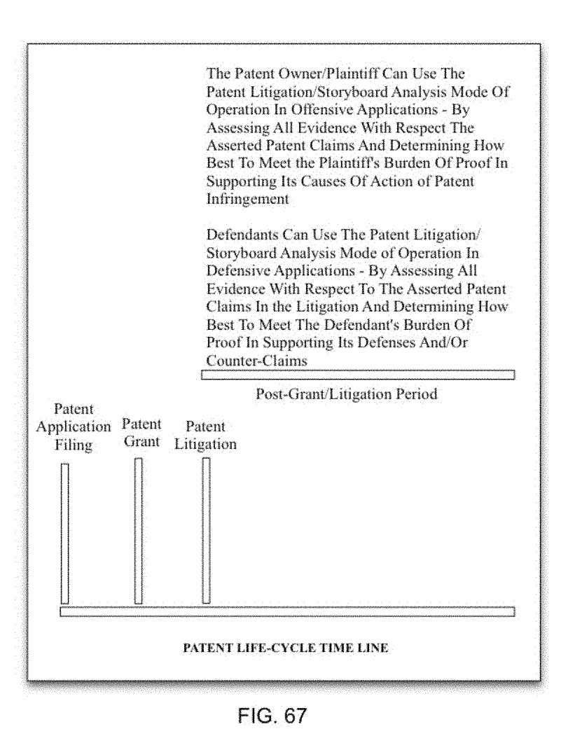

Referring now to the detailed flow chart set forth in FIGS. 66A through 66F, the Internet-based patent analysis and charting system of the present invention configured in its patent claim prosecution (history) analysis mode of system operation will be now described in detail, and showing how one or more users can efficiently analyze and chart the patent prosecution history of one or more granted patents involved in patent litigation, using the wireframe GUI screens set forth in FIGS. 68A through 68CC, the mapping techniques illustrated in FIGS. 65 and 69, and the patent prosecution history based chart structures described in FIGS. 70A through 70I. Various applications for the patent analysis and charting system configured in this mode of operation are illustrated in FIG. 67 and will be described in greater detail hereinbelow.

The steps of the process described in FIGS. 66A through 66F will be described in detail below.

As indicated in Step A in FIG. 66A, Web, application and database servers on a network are used to deploy an Internet-based object-oriented system platform that supports a computer-assisted analysis and charting of the prosecution history of any patent granted in a national patent protection system. As shown in FIG. 5, the network is connected to the network information infrastructure and servers of national patent protection systems, and patent and published patent application depositories containing composite patent file history data documents for granted patents and pending (or abandoned) patent applications.

As indicated in Step B in FIG. 66A, web-enabled client machines are used to allow authorized users to log into the deployed patent analysis and charting system and perform the following operations specified below. As exemplary login GUI screen is shown in FIG. 68A for that purpose.

As indicated in Step C in FIG. 66A, the user employs a GUI as shown in FIG. 68B to configure the patent analysis and charting system in its patent litigation/storybook analysis mode of system operation, for computer-assisted analysis and charting of a particular patent application, prior to patent grant. In general, the patent analysis and charting system comprises a database for storing the patent file history data, patent claim data, and prior art reference data, and supporting methods, procedures, GUIs, etc. during patent analysis and charting. The purpose of this step in the process is to select the mode of system operation to be configured on the system platform of the present invention.

As indicated in Step D in FIG. 66A, the user employs GUI screen as shown in FIG. 68C, to provide the Internet-based system with the patent number of the patent granted in a national patent protection system. Then, using a GUI screen as shown in FIG. 68D, all patent file history data of the granted patent, including file wrapper history documents, patent claim data, cited prior art reference documents, etc., are uploaded into the database of the Internet-based system, in a format suitable for parsing and search analysis, and associate this patent file history data with the patent application serial number.

As indicated in Substep E1 in FIG. 66A, a GUI screen as shown in FIG. 68E is employed so that, whenever necessary, the system uses optical character recognition (OCR) and/or other technologies to convert all documents in the patent prosecution (i.e. file) history data set into text searchable documents, as and where necessary, so that each such document is text searchable during the method of prosecution history analysis and charting according to the present invention.

As indicated in Substep E2 in FIG. 66A, a GUI screen as shown in FIG. 68F is employed so that all documents in the patent file history data set of the granted patent are indexed by first assigning a unique document number to each and every document in the patent file history data set of the patent application, and then second by compiling a complete list of indexed documents from the indexed patent file history data set.

As indicated in Substep E3 in FIG. 66A, a GUI screen as shown in FIG. 68G is employed so that each document in the complete list of indexed patent file history documents, is cataloged into one of the three document categories: (i) Patent Office Originated Documents; (ii) Applicant/Owner Originated Documents (including Patent Specification and Claims); and (iii) Reference Documents Originated by the Patent Office, Applicant/Owner, or any party or entity.

As indicated in Step F in FIG. 66A, a GUI screen as shown in FIG. 68H is employed so that, while logged into the patent analysis and charting system, the system displays a complete list of Reference Documents, and for each such reference document in the list, the user uses the GUIs and methods of the system to identify and classify the cited reference as either: (i) cited and applied in claim rejection; (ii) cited and not applied in claim rejection; or (iii) cited but not prior art; and then store these reference classifications in the system database.

As indicated in Step G in FIG. 66A, GUI screens as shown in FIGS. 681 and 68J are employed, so that the system enables the recording of the current history of the patent claims in the system database, including a concise status of patent claims, patent claim amendments, and patent claim examination during the patent prosecution history of the patent application. In the illustrative embodiment, this is achieved as follows. As shown, while logged into the patent analysis and charting system, the system displays a complete list of Applicant/Owner Originated documents, and then each such document, including an Amendment to the Claims is analyzed by the user using the GUIs and methods of the system so as to build and record a patent claim history (PCH) within the system database 15. In the illustrative embodiment, the patent claim history comprises:

(i) specification of all patent claims presented during the patent prosecution history, including the language of each originally filed claim, as filed and using original claim numbering;

(ii) specification of the date each patent claim was amended and/or canceled, voluntarily, and not in response to an examiner's claim rejection;

(iii) specification of which patent claims were allowed without rejection, and specify the date of allowance and the Examiner who made the allowance;

(iv) specification of which claims were rejected, identify the statutory basis of each such rejection (e.g. 35 USC Section 102 and/or 103) and prior art references upon which the claim rejection was made, and specify the date of the claim rejection and the Patent Examiner who made the rejection;

(v) specification of the language of each claim amendment, identify when the amendment was made and by whom (i.e. using USPTO Attorney/Agent Registration Number for registered agents and attorneys, and Applicant's name for pro se applications);

(vi) specification of which claims where allowed after rejection in response to an argument for patentability and request for reconsideration, and a specification of the language of each such allowed claim; and

(vii) specification of which claims where allowed after rejection in response to an argument for patentability, an amendment to the claims, and a request for reconsideration, and a specification of the language of each such allowed claim.

As indicated in Step H in FIG. 66B, a GUI screen as shown in FIG. 68K is employed, so that the user can link examiner and/or applicant statements made during the patent prosecution history to the limitations, sub-limitations and/or common terms of allowed and never rejected patent claims, and then store each link in the system database 15.

Specifically, while logged into the patent analysis and charting system, the user uses the GUIs and methods of the system to perform the following operations for each claim that was allowed and never rejected by the Examiner:

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

For cases where the granted patent is not involved in patent litigation, the Markman mapping operations set forth in substep (ii) above will be disabled from the system configuration.

As indicated in Step I in FIG. 66B, a GUI screen as shown in FIG. 68L is employed, so that the user can link examiner and/or applicant statements made during the patent prosecution history to the limitations, sub-limitations and/or common terms of rejected but ultimately allowed patent claims, and storing each link in the system database.

Specifically, while logged into the patent analysis and charting system, the user uses the GUIs and methods of the system to perform the following operations for each claim that was rejected, but eventually allowed by the Examiner;

(i) parse the allowed patent claims into a set of parsed claim limitations comprising a set of natural language strings representing the set of parsed claim limitations;

(ii) identify common terms in the claims (i.e. claim terms which can include phrases) previously construed by The Federal Circuit as having conventional, presumed or established meaning, including, but not limited to:

(1) Articles (e.g. a, an, the, said . . . );

(2) Transitional Phrases (e.g. comprising, including, . . . );

(3) Terms of Degree (e.g. about, approximately, etc);

(4) Terms of Spatial Relationships (e.g. adjoining, defined, in, between, within . . . );

(5) Other Terms (e.g. whereby, conventional, mixture, such as, may, adapted, . . . );

(6) Means Plus Function Terms;

(iii) for Terms of Degree identified in the patent claims, identify statements made in the Specification pertaining to such terms of degree, and link these Specification-based statements to such terms of degree, and store this data within the system database for future use;

(iv) for other common terms in the claims, previously construed by The Federal Circuit as having conventional, presumed or established meaning, link the construed meaning to such common terms, and store the link data in the system database for future use;

(v) identify all statements made by the Examiner, as well as the Applicants, pertaining to prior art disclosure found in a cited (and applied or non-applied) reference, which corresponds to a particular claim limitation in the allowed claim, and link these prior art disclosure statements to corresponding claims and claim limitations, and store these links in the system database;

(vi) identify any explicit “Reasons for Allowance” statements made by the Examiner and/or Applicant during the patent prosecution history, and link these statements to corresponding claims and claim limitations, and store these links in the system database;

(vii) identify any express statements made by the Applicant(s) in the patent prosecution history, which may be considered a reason for allowance or patentability, or a basis for file wrapper estoppel (i.e. a statement made stating what particular subject matter a specified patent claim does or does not cover), and link these statements to corresponding claims and claim limitations, and store these links in the system database; and

(viii) identify any cited reference statements disclosing a motivation to combine the prior art references, cited by the Examiner, during specific claim rejections under Section 35 USC Section 103, and link these statements to corresponding claims and claim limitations, and store these links in the system database.

For cases where the granted patent is not involved in patent litigation, the Markman mapping operations set forth in substep (ii) above will be disabled from the system configuration.

As indicated in Step J in FIG. 66B, GUI screens as shown in FIGS. 68M through 55S are employed, so that the user can define and formulate scope concepts based on analysis of stored links, then link claim limitation language of each allowed patent claim to one or more scope concepts, and ultimately store each scope concept and link in the system database.

Specifically, while logged into the patent analysis and charting system, the user uses the GUIs and methods of the system to perform the following operations for each allowed claim in the patent prosecution history, stored in the system database:

(i) display the allowed patent claims using final patent numbering, or any selected group of claims (e.g. all claims, all independent claims, or a particular subset of claims);

(ii) using the statements previously linked to corresponding claim limitations in the allowed patent claim, identify and formulate one or more scope concepts expressed in and/or embraced by or embodied within the claim limitation language of each allowed patent claim, and store these scope concepts in the system database;

(iii) for each claim limitation, link a scope concept to the corresponding language of the claim sub-limitation that supports the scope concept and store these claim limitation/scope concept links in the system database; and

(iv) repeat step (iii) above for each claim limitation, as necessary to capture essential scope concepts embodied within the allowed claim.

The scope concept formulation, assignment and linkage method described in FIGS. 24 through 26 can be used to practice Step J of this method of patent claim analysis supported by the system of the present invention.

During the process of claim scope concept analysis and scope concept formulation described above, the user assigns one or more scope concepts to each patent claim in the set of patent claims under analysis. Then, for the set of patent claims, the system automatically forms and maintains a Library of Scope Concepts (“Scope Concept Library”) stored in the system database 15. At any time, the user can review the Scope Concept Library for any given set of patent claims under analysis by clicking on the Scope Concept Library graphical icon presented with the GUI screens displayed by the system, as shown in FIG. 68T, for example.

For each patent claim that has been scope concept analyzed, the system automatically generates a Claim Scope Concept Profile, as shown in FIG. 26B, comprising a complete List of Scope Concepts that have been assigned to corresponding language in the claim limitations and/or sub-limitations of the Patent Claim. The system also maintains a Library of Scope Concept/Claim links, as shown in FIG. 68T.

As indicated in Step K in FIG. 66B, GUI screens as shown in FIGS. 68T and 68U are employed, so that the user can define concept groups and store them in the system database and the system can generate scope concept based prior art reference analysis GUI of FIG. 26C during prior art reference analysis, and also generate scope concept based evidence analysis GUIS for use during plaintiff and defendant evidence analysis.

Specifically, while logged into the patent analysis and charting system, and using the GUIs and methods of the system, the user performs the following operations: (i) logically organizes the scope concepts into concept groups, and stores these concept group definitions within the system database; (ii) the system uses the scope concepts to define prior art reference analysis GUI for display during prior art reference analysis; and (iii) system uses the scope concepts to generate scope concept based evidence analyzer GUIs for display during plaintiff and defendant evidence analysis, relative to the patent claims involved in the litigation.

As indicated in Step L in FIG. 66C, a GUI screen as shown in FIG. 68V is employed, so that the user can link statements in patent office originated documents to one or more scope concepts defined above, and store each link in the system database. Specifically, while logged into the patent analysis and charting system, the system displays each Patent Office Originated Document, and the user uses the GUIs and methods of the system to perform the following operations: (i) identify statements made in Patent Office Originated Document embodying one or more scope concepts, and then link the scope concepts to the statements made in the Patent Office Originated Document; and (ii) store these links within the system database for future use.

As indicated in Step M in FIG. 66C, a GUI screen as shown in FIG. 68W is employed, so that the user can link statements in Applicant/Owner originated documents to one or more scope concepts defined above, and store each link in the system database. Specifically, while logged into the patent analysis and charting system, the system displays each Applicant/Owner Originated Document, and the user uses the GUIs and methods of the system to perform the following operations: (i) identify statements in the Applicant/Owner Originated Document (including Patent Specification) embodying one or more scope concepts, and then link these scope concepts to the statements in the Applicant/Owner Originated Document; and (ii) store these links within the system database for future use.

As indicated in Step N in FIG. 66C, a GUI screen as shown in FIG. 68X is employed, so that the user can analyze cited and applied prior art references using the scope concept based prior art reference analysis GUIs, and storing the analysis in the system database. Specifically, while logged into the patent analysis and charting system, use the GUIs and methods of the system to perform the following operations on each cited and applied reference in the Reference Documents: (i) analyze the cited and applied prior art references using the prior art reference data analysis GUIs determined during Step M above; and (ii) store in the system database, (a) all “pertinent/relevant” disclosure cited in the cited and applied prior art reference corresponding to the concepts specified in the prior art reference analysis GUI, and (b) the citation of the pertinent/relevant disclosure, for future referral and access.

As indicated in Step O in FIG. 66D, a GUI screen as shown in FIG. 68Y is employed, so that the user can analyze cited and non-applied prior art references using the scope concept based prior art reference analysis GUIs, and storing the analysis in the system database. Specifically, while logged into the patent analysis and charting system, use the GUIs and methods of the system to perform the following operations on each cited and non-applied reference in the Reference Documents: (i) analyze the cited and non-applied prior art reference using the prior art reference data analysis GUIs determined during Step M above; and (ii) store in the system database (a) all “pertinent/relevant” disclosure cited in the cited and non-applied prior art reference corresponding to the concepts specified in the prior art reference analysis GUI, and (b) the citation of the pertinent/relevant disclosure, for future referral and access.

As indicated in Step P in FIG. 66D, a GUI screen as shown in FIG. 68Z is employed so that the user can load product and/or service descriptions into the system database, for products and/or services which will be analyzed for infringement or non-infringement of the allowed claims in the granted patent.

As indicated in Step Q in FIG. 66D, a GUI screen as shown in FIG. 68AA is employed, so that the user can analyze evidence produced by plaintiff using the scope concept based evidence analysis GUIs, so as to determine whether or not plaintiff produced evidence items correspond to particular claim limitations, and store the analysis in the system database. Specifically, while logged into the patent analysis and charting system, the user uses the GUIs and methods of the system to analyze evidence items produced by plaintiff, using the scope concept based evidence analysis GUIs, so as to determine whether or not plaintiff items produced evidence items correspond to claim limitations, and then store the analysis in the system database.

As indicated in Step R in FIG. 66E, a GUI screen as shown in FIG. 68BB is employed, so that the user can analyze evidence produced by defendant using the scope concept based evidence analysis GUIs, so as to determine whether or not defendant produced evidence items correspond to particular claim limitations, and storing the analysis in the system database. Specifically, while logged into the patent analysis and charting system, use the GUIs and methods of the system to analyze evidence produced by defendant using the scope concept based evidence analysis GUIs, so as to determine whether or not defendant produced evidence items correspond to claim limitations, and then store the analysis in the system database.

As indicated in Step S in FIG. 66E, GUI screens as shown in FIGS. 68CC and 66DD are employed, so that the user can generate and display a patent prosecution history based patent litigation-storyboard chart for selected claims in the granted patent. During Substep S1, while logged into the patent analysis and charting system, the user uses the GUIs and methods of the system to perform the following operations to generate a claim scope schema (CSS) based patent litigation-storyboard chart structure for all of the selected claims in the granted patent. The CSS-based patent litigation-storyboard chart structure is implemented using Microsoft® Excel® spreadsheet display technology (with collapsible/expandable columns and rows) and populated with data recorded in the system database during prior stages of patent prosecution history analysis.

As shown in FIGS. 70A through 70I, the CSS-based patent litigation/storyboard chart structure comprises data fields for presenting graphical representations of the following graphical objects:

(i) the text language comprising the allowed patent claim limitations and sub-limitations (Step G) listed in a column, and each being indexed with both original and issued claim numbering, and each parsed claim limitation having associated with its allowed claim language, at least the following information items (abstracted from the patent file history):

(ii) technical support for each claim limitation disclosed in the patent specification under 35 USC Section 112 (Step G) listed in a separate column (can be generated automatically by the system);

(iii) subject matter (language) of patent claims allowed and never rejected during patent prosecution history (Step G);

(iv) subject matter rejections overcome by the allowed patent claims during the patent prosecution history—as reflected in the patent prosecution history—including a concise statement of each prior art rejection (e.g. Section 101, 102, and/or 112) or rejection combinations (e.g. Section 103) made by Examiner and overcome by Applicant(s) listed in a separate column;

subject matter (i.e. disclosure) of prior art references cited by the examiner and applied to specific claim limitations in a 35 USC Section 102/103 rejection which was overcome by the allowed claims with argument but without amendment (Step G);

subject matter (i.e. disclosure) of prior art references cited by the examiner and applied to specific claim limitations in a 35 USC Section 102/103 rejection which was overcome by the allowed claims with amendment and argument (Step G);

(v) Markman-type terms present in allowed and never rejected claims, and previously construed by the Federal Circuit—such common terms including claim terms present in allowed and never rejected patent claims, and having conventional, presumed or established meaning, including but not limited to: articles, transitional phrases, terms of degree, other terms (e.g. whereby, such as, adapted, conventional, mixture etc), and means plus function (Step H);

(vi) Markman-type terms present in rejected but ultimately allowed claims, and previously construed by the Federal Circuit—such common terms including claim terms present in rejected but ultimately allowed patent claims, and having conventional, presumed or established meaning, including but not limited to: articles, transitional phrases, terms of degree, other terms (e.g. whereby, such as, adapted, conventional, mixture etc), and means plus function (Step I);

(vii) examiner statements related and directly linked (i.e. mapped) to the language of claim sub-limitations by the user (Steps H and I);

(viii) applicant statements related and directly linked to the language of claim sub-limitations by the user (Step H and I);

(ix) reasons for allowance related and directly linked to the language of claim sub-limitations by the user (Steps H and I);

(x) scope concepts embraced by the patent claims and assigned to the language of claim sub-limitations by the user (Step J);

(xi) subject matter of cited and applied prior art references mapped to the sub-limitation language of the allowed patent claims by the user during scope concept based reference analysis performed by the user and using the scope concepts assigned to the allowed patent claims (Step N);

(xii) subject matter of cited but not applied prior art references mapped to the sub-limitation language of the allowed patent claims by the user during scope concept based reference analysis performed by the user and using the scope concepts assigned to the allowed patent claims (Step O);

(xiii) statements made by the examiner during the patent prosecution history, transparently linked to claim sub-limitations in the allowed claims, and listed in a separate column, using the claim concept linking/mapping process of the present invention carried out by the system (Step L);

(xiv) statements made by the applicants/owner during the patent prosecution history, transparently linked to claim sub-limitations in the allowed claims, and listed in a separate column, using the claim concept linking/mapping process of the present invention carried out by the system (Step M);

(xv) “reasons for allowance” statements made by the examiner and possibly commented upon by applicant during the patent prosecution history, transparently linked to claim sub-limitations in the allowed claims, and listed in a separate column, using the scope concept linking/mapping process of the present invention carried out by the system (Steps L and M);

(xvi) products under patent claim infringement analysis—which are mapped to the language limitation of one or more of the allowed patent claims;

(xvii) services under patent claim infringement analysis—which are mapped to the language limitation of one or more of the allowed patent claims;

(xviii) plaintiff-produced evidence items mapped to particular claim limitations through scope concepts—using the scope concept based evidence analysis GUIs to determine whether or not plaintiff-produced evidence items correspond to particular claim limitations (Step Q);

(xix) defendent-produced evidence items mapped to particular claim limitations through scope concepts—using the scope concept based evidence analysis GUIs to determine whether or not defendant-produced evidence items correspond to particular claim limitations (Step R); and

(xx) notes on the user's understanding on patent claim construction, scope/boundary conditions, and as well as evidentiary proof issues and concerns, such as identification of evidence by plaintiff and defendant embodying the use of one or more scope concepts associated with particular sub-limitations in the allowed claims on the granted patent involved in litigation. (Step S2).

During the patent claim understanding/interpretation process, the claim scope schema (CSS) structure, comprising all information from the patent prosecution history linked together by claim scope concepts (CSC) and contained within the spreadsheet-type chart structure, functions as a framework that helps organize information relating to the scope and meaning of any allowed patent claim represented in the chart structure, to assist anyone interested in better understanding the scope and boundaries offered by allowed patent claims.

During Substep S2, while logged into the patent analysis and charting system, the user displays the CSS-based patent litigation-storyboard chart structure so that the user can: (a) view plaintiff-produced and/or defendant-produced evidence (i.e. Bates Number indexed and) linked (i.e. mapped) to the language of corresponding claim limitations in the granted patent involved in litigation, transparently using scope concept mapping, alongside of prosecution history information also linked to the limitations of the patent claims, so as to better support patent claim scope and prior art boundary interpretation, and how the evidence produced in the litigation can be used to support proofs for patent claim infringement arguments for the plaintiff and its attorneys, and/or patent claim non-infringement arguments for the defendants and its attorneys; and (b) record notes in the system database, on the user's understanding on patent claim construction, scope/boundary conditions, and as well as evidentiary proof issues and concerns.

FIG. 67 illustrates the application of the multi-mode patent analysis and charting system configured in its patent litigation/storyboard analysis mode of system operation, and deployed during particular phases of the patent life-cycle time line, by both the patent owner and its competitors. In particular, the patent owner/plaintiff can use the patent litigation/storyboard analysis mode in offensive applications against competitor/defendants, namely, by assessing all evidence with respect to the asserted patent claims in litigation and determining how best to meet the plaintiff's burden of proof in supporting its causes of action of patent infringement. Also, defendants can use the patent litigation/storyboard analysis mode of operation in defensive applications against the patent owner/plaintiff, by assessing all evidence with respect to the asserted patent claims in litigation, and determining how best to meet the defendant's burden of proof in supporting its defenses and/or counter-claims in the litigation.

### Operating the Multi-Mode Patent Analysis and Charting System of the Present Invention in its Un-Structured Analysis Mode of Operation

In the patent analysis and charting system of the present invention has been described above, in each of its modes of patent analysis and system operation, and each of these system modes has supported a “structured” analysis, with step-by-step instructions, to ensure that each user is performing the selected method of patent analysis in a proper manner, and that essential steps are not skipped, and if so, for the system to inform the user and ensure that the structured analysis has been performed for each case, under a specific user account or group account. For most non-expert users, these nine (9) structured modes of system analysis should be highly informative and educational, and support high degrees of work productivity and efficiency.

However, some users, with expertise in patent analysis, or simply those who wish to perform other methods, or take short-cuts, can configure and use the multi-mode patent analysis and charting system of the present invention to support nine (9) “un-structured analysis modes, in addition to its nine-structured analysis modes. To configure the system for any particular “un-structured analysis” mode, the logged-in user simply selects or clicks on the “Un-Structured Analysis” icon shown in the top upper right corner of each system GUI, as shown in FIGS. 71A and 71B and other GUIs disclosed in the Drawings. Then, the user selects the mode of patent analysis to be supported by the system.

FIG. 71A shows a wireframe-type graphical user interface (GUI) that is served up from the Web and other servers of the Internet-based multi-mode patent analysis and charting system, to one or more of its Internet-based client machines 30, during the “un-structured” patent claim scope interpretation analysis mode (Mode 1). FIG. 71B shows a wireframe-type graphical user interface (GUI) that is served up from the Web and other servers of the Internet-based multi-mode patent analysis and charting system, to one or more of its Internet-based client machines 30, during the un-structured patent claim invalidity contention analysis mode (Mode 5). The seven remaining un-structured analysis modes are also supported by similar, but yet different, GUI screens, as shown and discussed before with respect to the structured analysis modes.

Once the system enters its “Un-Structured Analysis” system mode, the user is free to select any one of the nine (9) patent analysis and charting modes supported by the system and selectable by its corresponding icon in the top horizontal Mode Menu. As shown, the first selectable mode in the Mode Menu is “Prosecution Mode” which represents the Patent Prosecution History Analysis Mode, and the last selectable mode in the Mode Menu is “Litigation Mode” which represents the Patent Litigation/Storyboard Analysis Mode.

As shown in FIG. 71A, the “un-structured” Patent Claim Scope Interpretation Analysis Mode has been selected, and the system automatically configured in accordance therewith, and set up for a specific Patent Under Analysis: e.g. “U.S. Pat. No. 8,161,025 Lundberg et al.” To change the patent to be analyzed during this system mode, and listed in the Patent Case Menu, below the Mode Menu, the user will click on this Patent Case Menu and a new case selection menu will be automatically displayed within the WORKSPACE window of the GUI screen, allowing the user to select a different patent case to be analyzed. Once selecting a different patent case, the system will need to load corresponding patent prosecution history data files, preprocess these files and set up the patent case data set for analysis, and the user will be invited to assist in this process via menus displayed in the WORKSPACE window.

Tools associated with any selected mode, and functional block selected, will be automatically loaded onto the platform and their graphical icons will be displayed in the TOOLBAR window of the GUI screen for user review and selection. Each time the user selects a different function block icon, shown in the Function Block Menu, displayed below the Patent Case Menu, the system will automatically load a GUI within the WORKSPACE window, and corresponding tools in the TOOLBAR menu, for use with the selected Function Block. Ideally, these Function blocks will correspond closely with the functions and services supported during the corresponding “structured analysis” mode, with the exception that the user is provided a significantly greater degree of freedom to design and perform his or her own custom workflow that makes sense during the selected mode of patent analysis and charting.

Data loaded and generated during any particular mode of “structured analysis” will be made available to the user during its corresponding mode of “un-structured analysis”, and also during others modes of system operation, providing a great freedom to users and user groups seeking to leverage work done during one mode of patent analysis, across others modes of patent analysis, with respect to a particular patent or published patent application, or any set of patent claims from one or more granted patents and/or published patent applications involved in a particular patent analysis project on the multi-mode system platform of the present invention.

Internet-Based Patent Insurance Policy and Risk Mitigation Network of the Present Invention, for Procuring and Administering Patent Insurance Policies Containing Patent Invalidity Contention Analysis (PICA) Provisions, Supported by an Internet-Based Patent Claim Invalidity Contention Analysis (PICA) Generation, Charting and Reporting System

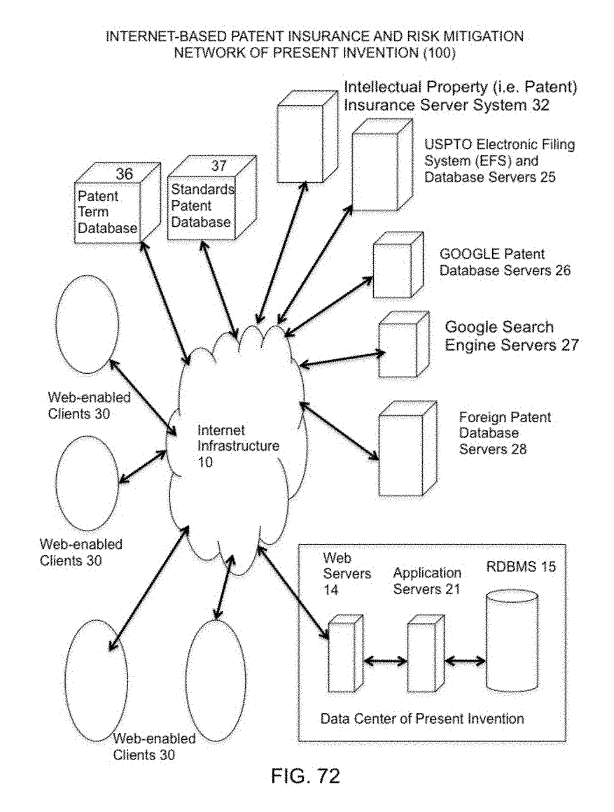

FIG. 72 shows the Internet-based patent insurance policy and risk mitigation network of the present invention, supported by the Internet-based multi-mode patent analysis and charting system 100 described hereinabove. The network supports the procurement, underwriting and administration of patent insurance policies containing patent invalidity contention analysis (PICA) provisions. When a notice of infringement/infringing event is received under a patent insurance policy containing a PICA service provision, compliance with the PICA service provision requires that the Internet-based multi-mode patent analysis and charting system shown in FIG. 5, and described above, be used to (i) support expert patent analysis and charting processes against the patent(s) linked to the notice of infringement/infringing event (by a patent attorney and subject matter experts), and subsequently (ii) deliver automated patent invalidity contention analysis (PICA) generation, charting and reporting services to patent insurance policy holders, patent insurance policy underwriters, as well as litigation counsel (engaged or bidding for defense/abatement work) to provide an unprecedented level of risk mitigation against improper or otherwise aggressive assertion of patent claims in highly competitive marketplaces.

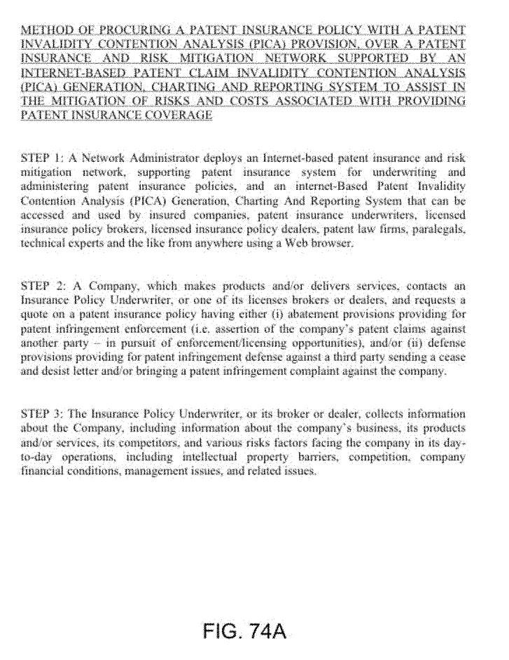

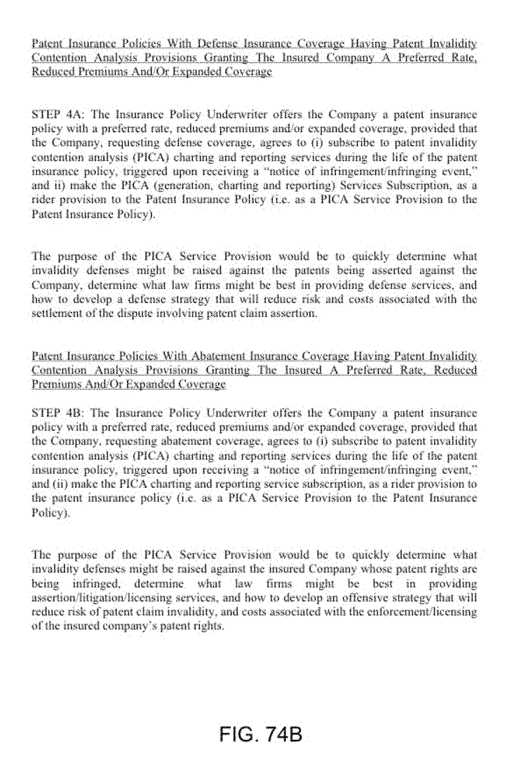

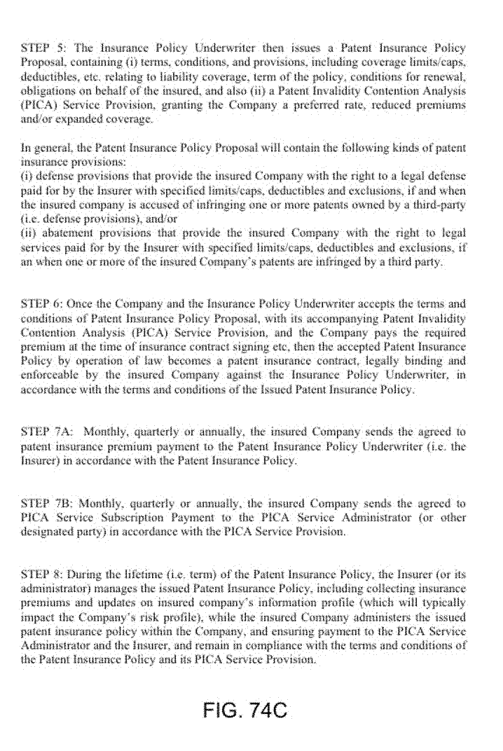

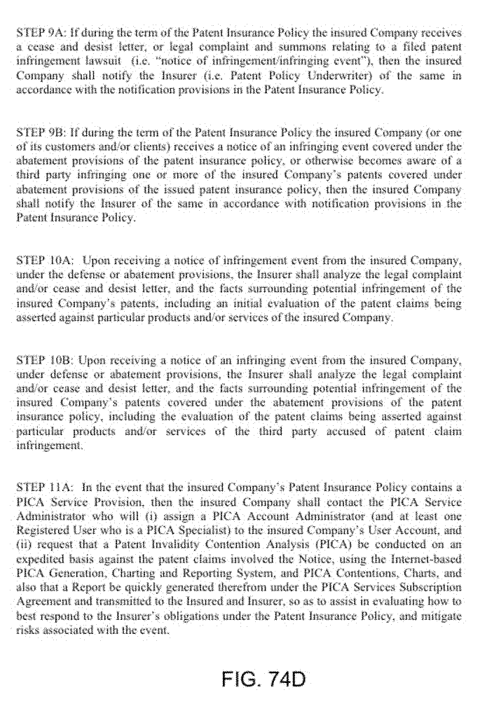

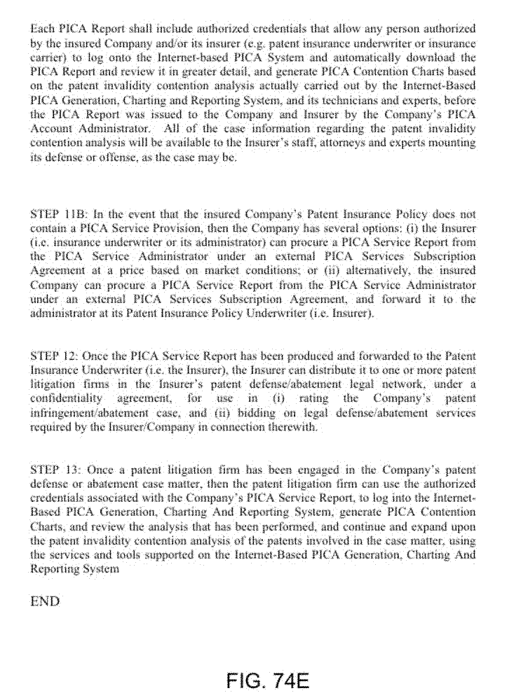

FIG. 73 illustrates the system architecture of the Internet-based patent insurance policy and risk mitigation network of the present invention. Also the flow chart in FIGS. 74A through 74E illustrates the general process that is supported by the network involving ordering, procuring, underwriting and administering patent insurance policies containing patent invalidity contention analysis (PICA) service provisions, in accordance with the principles of the present invention. Notably, in the illustrative embodiment, this network-centric process/method involves the use of the Internet-based multi-mode patent analysis and charting system of the present invention, to support automated (or semi-automated) PICA generation, charting and reporting services required by the PICA service provision. However, it is understood that any suitable patent invalidity contention analysis system, properly integrated within the network, can be used to practice the innovative patent insurance process of the present invention.

As shown in FIG. 73, the Internet-based patent insurance policy and risk mitigation network comprising: internet-based system for generating patent claim invalidity analysis (PICA) contentions, charts and reports; and patent insurance system for underwriting patent insurance policies with patent invalidity contention analysis (PICA) service provisions. As shown, the internet-based system for generating patent claim invalidity analysis contentions, charts and reports comprises: a patent invalidity contention analysis (PICA) generation module; a PICA chart generator; and a PICA report generator.

As shown in FIG. 73, the PICA contention generator receives a set of prior art references available during patent invalidity contention analysis (PICA), and a set of patent claims under the patent invalidity contention analysis (PICA) process. The set of patent claims is determined by the patents involved in the notice of infringement/infringing event, and the set of prior art references are discovered through scope concept based searching to invalidate the patent claims. A PICA Service Administrator is assigned to the insured Company and the insurer (i.e. patent insurance policy underwriter). The PICA Service Administrator assigns a User Account Administrator to the insured and insurer, who in turn assigns a PICA specialist to the insured Company, to do the actual PICA work on the system platform. Once a notice of an infringement/infringing event is received by the insured company, a series of operations occur across network, and within the system, in connection with a patent insurance policy containing a PICA service provision, according to the present invention. The details of these operations will be described below in connection with the method of procuring a patent insurance policy with a PICA service provision, over the patent insurance and risk mitigation network 100 of the present invention.

Method of Procuring a Patent Insurance Policy with a Patent Invalidity Contention Analysis (PICA) Provision, Over a Patent Insurance and Risk Mitigation Network of the Present Invention

As indicated STEP 1 in FIG. 74A, a Network Administrator deploys the Internet-based patent insurance and risk mitigation network 100 shown in FIG. 72, comprising: a Patent Insurance System for underwriting and administering patent insurance policies; and an internet-Based Patent Invalidity Contention Analysis (PICA) Generation, Charting And Reporting System that can be accessed and used by insured companies, patent insurance underwriters, licensed insurance policy brokers, licensed insurance policy dealers, patent law firms, paralegals, technical experts and the like from anywhere using an networked computer supporting a Web browser (e.g. HTML5 enabled).

As indicated in STEP 2 in FIG. 74B, a company, which makes products and/or delivers services, contacts an insurance policy underwriter, or one of its licenses brokers or dealers, and requests a quote on a patent insurance policy having either (i) abatement provisions providing for patent infringement enforcement (i.e. assertion of the company's patent claims against another party—in pursuit of enforcement/licensing opportunities), and/or (ii) defense provisions providing for patent infringement defense against a third party sending a cease and desist letter and/or bringing a patent infringement complaint against the company.

As indicated in STEP 3 in FIG. 74A, the insurance policy underwriter, or its broker or dealer, collects information about the company, including information about the company's business, its products and/or services, its competitors, and various risks factors facing the company in its day-to-day operations, including intellectual property barriers, competition, company financial conditions, management issues, and related issues.

Patent Insurance Policies with Defense Insurance Coverage Having Patent Invalidity Contention Analysis Provisions Granting the Insured Company a Preferred Rate, Reduced Premiums and/or Expanded Coverage

As indicated in STEP 4A in FIG. 74B, the insurance policy underwriter offers the Company a patent insurance policy with a preferred rate, reduced premiums and/or expanded coverage, provided that the company, requesting defense coverage, agrees to (i) subscribe to patent invalidity contention analysis (PICA) charting and reporting services during the life of the patent insurance policy, triggered upon receiving a “notice of infringement/infringing event,” and ii) make the PICA (generation, charting and reporting) services subscription, as a rider provision to the patent insurance policy (i.e. as a PICA service provision to the patent insurance policy). The purpose of the PICA Service Provision would be to quickly determine what invalidity defenses might be raised against the patents being asserted against the company, determine what law firms might be best in providing defense services, and how to develop a defense strategy that will reduce risk and costs associated with the settlement of the dispute involving patent claim assertion.

Patent Insurance Policies with Abatement Insurance Coverage Having Patent Invalidity Contention Analysis Provisions Granting the Insured a Preferred Rate, Reduced Premiums and/or Expanded Coverage

As indicated in STEP 4B in FIG. 74B, the insurance policy underwriter offers the company a patent insurance policy with a preferred rate, reduced premiums and/or expanded coverage, provided that the Company, requesting abatement coverage, agrees to (i) subscribe to patent invalidity contention analysis (PICA) charting and reporting services during the life of the patent insurance policy, triggered upon receiving a “notice of infringement/infringing event,” and (ii) make the PICA charting and reporting service subscription, as a rider provision to the patent insurance policy (i.e. as a PICA service provision to the patent insurance policy). The purpose of the PICA service provision would be to quickly determine what invalidity defenses might be raised against the insured company whose patent rights are being infringed, determine what law firms might be best in providing assertion/litigation/licensing services, and how to develop an offensive strategy that will reduce risk of patent claim invalidity, and costs associated with the enforcement/licensing of the insured company's patent rights.

As indicated in STEP 5 in FIG. 74C, the insurance policy underwriter then issues a patent insurance policy proposal, containing (i) terms, conditions, and provisions, including coverage limits/caps, deductibles, etc. relating to liability coverage, term of the policy, conditions for renewal, obligations on behalf of the insured, and also (ii) a patent invalidity contention analysis (PICA) service provision, granting the company a preferred rate, reduced premiums and/or expanded coverage.

In general, the patent insurance policy proposal will contain the following kinds of patent insurance provisions: (i) defense provisions that provide the insured company with the right to a legal defense paid for by the Insurer with specified limits/caps, deductibles and exclusions, if and when the insured company is accused of infringing one or more patents owned by a third-party (i.e. defense provisions), and/or (ii) abatement provisions that provide the insured company with the right to legal services paid for by the Insurer with specified limits/caps, deductibles and exclusions, if an when one or more of the insured company's patents are infringed by a third party.

As indicated in STEP 6 in FIG. 74C, once the company and the insurance policy underwriter accepts the terms and conditions of patent insurance policy proposal, with its accompanying patent invalidity contention analysis (PICA) service provision, and the company pays the required premium at the time of insurance contract signing etc, then the accepted patent insurance policy by operation of law becomes a patent insurance contract, legally binding and enforceable by the insured company against the insurance policy underwriter, in accordance with the terms and conditions of the issued patent insurance policy.

As indicated in STEP 7A in FIG. 74C, monthly, quarterly or annually, the insured company sends the agreed to patent insurance premium payment to the patent insurance policy underwriter (i.e. the insurer) in accordance with the patent insurance policy.

As indicated in STEP 7B in FIG. 74C, monthly, quarterly or annually, the insured company sends the agreed to PICA service subscription payment to the PICA service administrator (or other designated party) in accordance with the PICA service provision.

As indicated in STEP 8 in FIG. 74, during the lifetime (i.e. term) of the patent insurance policy, the insurer (or its administrator) manages the issued patent insurance policy, including collecting insurance premiums and updates on insured company's information profile (which will typically impact the company's risk profile), while the insured company administers the issued patent insurance policy within the company, and ensuring payment to the PICA service administrator and the insurer, and remain in compliance with the terms and conditions of the patent insurance policy and its PICA service provision.

As indicated in STEP 9A in FIG. 74D, if during the term of the patent insurance policy the insured company receives a cease and desist letter, or legal complaint and summons relating to a filed patent infringement lawsuit (i.e. “notice of infringement/infringing event”), then the insured company shall notify the Insurer (i.e. patent policy underwriter) of the same in accordance with the notification provisions in the patent insurance policy.

As indicated in STEP 9B in FIG. 74D, if during the term of the patent insurance policy the insured company (or one of its customers and/or clients) receives a notice of an infringing event covered under the abatement provisions of the patent insurance policy, or otherwise becomes aware of a third party infringing one or more of the insured company's patents covered under abatement provisions of the issued patent insurance policy, then the insured company shall notify the insurer of the same in accordance with notification provisions in the patent insurance policy.

As indicated in STEP 10A in FIG. 74D, upon receiving a notice of infringement event from the insured company, under the defense or abatement provisions, the insurer shall analyze the legal complaint and/or cease and desist letter, and the facts surrounding potential infringement of the insured company's patents, including an initial evaluation of the patent claims being asserted against particular products and/or services of the insured company.

As indicated in STEP 10B in FIG. 74E, upon receiving a notice of an infringement event from the insured company, under defense or abatement provisions, the insurer shall analyze the legal complaint and/or cease and desist letter, and the facts surrounding potential infringement of the insured company's patents covered under the abatement provisions of the patent insurance policy, including the evaluation of the patent claims being asserted against particular products and/or services of the third party accused of patent claim infringement.

As indicated in STEP 11A in FIG. 74D, in the event that the insured company's patent insurance policy contains a pica service provision, then the insured company shall contact the PICA service administrator who will (i) assign a PICA account administrator (and at least one PICA specialist) to the insured company's user account, and (ii) request that a patent invalidity contention analysis (PICA) be conducted on an expedited basis against the patent claims involved the Notice, using the Internet-based PICA generation, charting and reporting system, and PICA contentions, charts, and also that a report be quickly generated therefrom under the PICA services subscription agreement and transmitted to the insured and insurer, so as to assist in evaluating how to best respond to the insurer's obligations under the patent Insurance policy, and mitigate risks associated with the event.

Each PICA Report shall include authorized credentials that allow any person authorized by the insured company and/or its insurer (e.g. patent insurance underwriter or insurance carrier) to log onto the Internet-based PICA system and automatically download the PICA report and review it in greater detail, and generate PICA contention charts based on the patent invalidity contention analysis actually carried out by the Internet-Based PICA generation, charting and reporting system, and its technicians and experts, before the PICA report was issued to the company and Insurer by the company's PICA Account Administrator. All of the case information regarding the patent invalidity contention analysis will be available to the insurer's staff, attorneys and experts mounting its defense or offense, as the case may be.

As indicated in STEP 11B in FIG. 74E, in the event that the insured company's patent insurance policy does not contain a PICA service provision, then the company has several options: (i) the insurer (i.e. insurance underwriter or its administrator) can procure a PICA service report from the PICA service administrator under an external PICA services subscription agreement at a price based on market conditions; or (ii) alternatively, the insured company can procure a PICA service report from the PICA service administrator under an external PICA services subscription agreement, and forward it to the administrator at its patent insurance policy underwriter (i.e. insurer).

As indicated in STEP 12 in FIG. 74E, once the PICA service report has been produced and forwarded to the patent insurance underwriter (i.e. the insurer), the Insurer can distribute it to one or more patent litigation firms in the insurer's patent defense/abatement legal network, under a confidentiality agreement, for use in (i) rating the company's patent infringement/abatement case, and (ii) bidding on legal defense/abatement services required by the insurer/company in connection therewith.

As indicated in STEP 13 in FIG. 74E, once a patent litigation firm has been engaged in the Company's patent defense or abatement case matter, then the patent litigation firm can use the authorized credentials associated with the company's PICA service report, to log into the Internet-based PICA generation, charting and reporting system, generate PICA contention charts, and review the analysis that has been performed, and continue and expand upon the patent invalidity contention analysis of the patents involved in the case matter, using the services and tools supported on the Internet-based PICA generation, charting and reporting system.

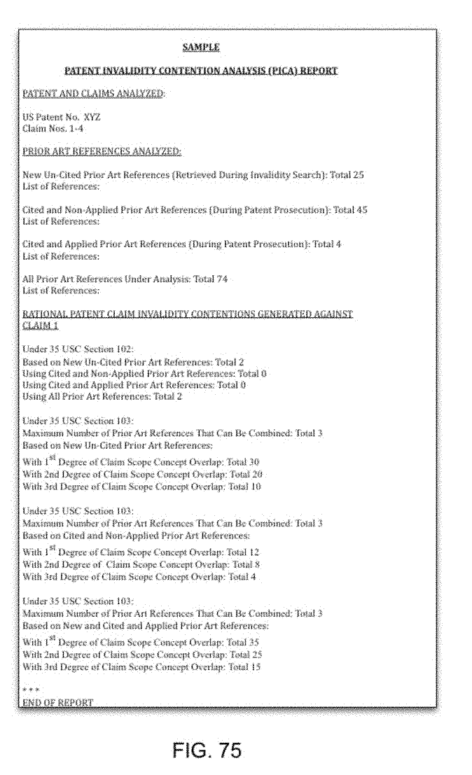

FIG. 75 shows a sample PICA service report that can be generated by the Internet-based PICA generation, charting and reporting system of the present invention. Notably, this PICA report is exemplary, and variations and modifications thereto will readily occur from embodiment to embodiment of the present invention.

In alternative embodiments of the patent insurance and risk mitigation network of the present invention, the rates, premiums, liability/indemnification limits, exclusions and scope of insurance coverage may be conditioned on several factors: (i) the summary results and other facts contained in the PICA report(s); and/or the legal grounds and prior art facts supporting the patent invalidity contentions contained in PICA contention charts.

While the PICA report will report what was discovered during prior art contention searches, and how many rational invalidity contentions have been generated therefrom against the patent claims under analysis, using the automated PICA contention generation methods of the present invention, illustrated in FIGS. 50B through 50S, it is understood that the corresponding PICA contention charts, stemming from the underlying PICA contentions, will provide the insurer, the insured, and their patent litigation firm, with the details of the rational patent invalidity contentions, which patent litigation counsel can use to assess the strength of the patent claims at issue and kick-start its defense strategy and tactics.

### The Internet-Based Patent Application Filing, Searching, Prior Art Disclosure, and Claim Examination System of the Present Invention Supporting Automated Claim Patentability Analysis and Chart and Report Generation

Referring to FIG. 76, the Internet-based (i.e. Cloud-based) patent application searching, filing, prior art disclosure, and claim examination system of the present invention 300 is shown comprising various system components, including an industrial-strength data collection and processing center comprising web servers, application servers and RDBMS servers, domestic and foreign patent database servers, USPTO electronic filing system (EFS) and related database servers, technical/scientific database servers and commercial Google patent database servers, configured and interfaced around the infrastructure of the Internet, and accessible by a plurality of Web-enabled client machines (e.g. desktop computers, mobile computers such as iPad, and other Internet-enabled computing devices with graphics display capabilities, etc).

As shown in FIG. 77, the system of the present invention is realized as an industrial-strength, carrier-class Internet-based network of object-oriented system design, deployed over a global data packet-switched TCP/IP communication network comprising numerous computing systems and networking components, as shown. As such, the information network of the present invention is often referred to herein as the “system” or “system network”.

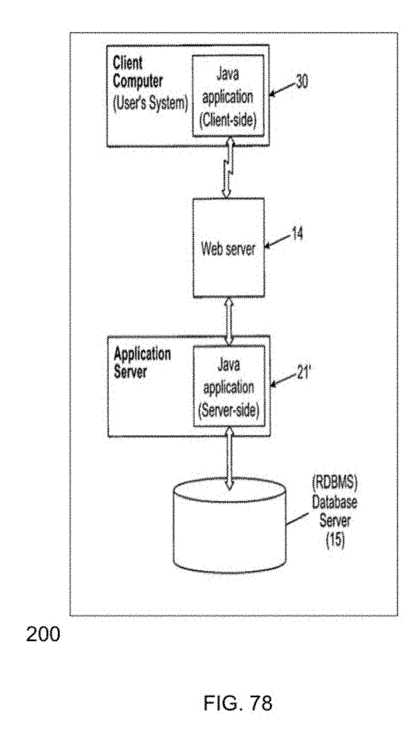

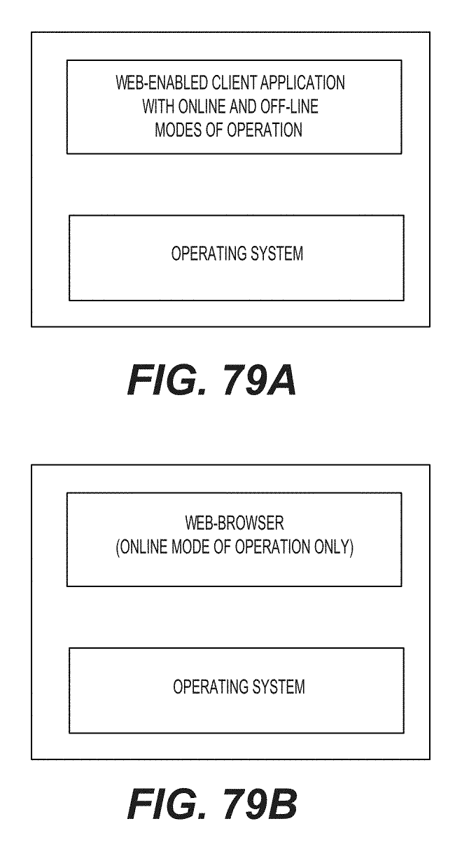

In general, the Internet-based system of the present invention shown in FIG. 77 can be implemented using any object-oriented integrated development environment (IDE) such as WebObjects 5.2 by Apple Computer Inc, Websphere IDE by IBM, or Weblogic IDE by BEA, or even an non-Java IDE such as Microsoft's .NET IDE. Two different Network implementations using the WebObjects IDE are illustrated in FIGS. 78 and 79 using Web-based and Java-client technology, respectively. Preferably, the entire system of the present invention can be designed according to object-oriented systems engineering (OOSE) methods using UML-based modeling tools, such as Rational ROSE Visual Modeling and XDE by Rational Software, Inc., or Together® Visual Modeling Software by Borland Software, using the industry-standard Rational Unified Process (RUP) or Enterprise Unified Process (EUP), both well known in the art. Implementation programming languages can include Java, C⁻, Objective C, PHP, and other computer programming languages known in the art. Preferably, the system is deployed as a three-tier server architecture with a double-firewall, and appropriate network switching and routing technologies well known in the art.

In one illustrative embodiment shown in FIG. 77, the system of the present invention is realized as a hosted service using an application service provider (ASP) model, using Web-based client machines. However, it is understood that some or all of the services provided by the system can be accessed using Java clients, preferably running behind a client enterprise firewall. As shown in FIG. 78, the Web-enabled or Internet-enabled clients can be realized using a web-enabled (http-enabled) client application running on the operating system of a computing platform, to support both online and off-line modes of system operation. Alternatively, as shown in FIG. 79, the Web-enabled (or Internet-enabled) clients can be realized using a web-browser application running on the operating system of a computing platform, to support online mode of system operation, only.

In FIG. 77 and through the present Specification, the RDBMS 15 in data center 200 can be realized using one or more database servers, each comprising: one or more central processing units (CPUs); a memory architecture with program memory (RAM), cache, and disc storage (e.g. RAID storage) and optionally one or more network attached storage (NAS) devices; a system bus architecture; power supplies; controllers; and an input/output architecture configured in a manner known in the art. The RDBMS 15 will support an operating system (e.g. Linux, OSX, Windows, Solaris, etc) and relational database software (e.g. mySQL, postgresSQL, Oracle Database software), designed and developed to support and perform the functions and services of the systems of the present invention described herein.

Each application server 21 in data center 200 can be realized using one or more application servers, each comprising: one or more central processing units (CPUs); a memory architecture with program memory (RAM), cache, and disc storage (e.g. RAID storage); a system bus architecture; power supplies; controllers; and an input/output architecture configured in a manner known in the art. Each application server 21 will support an operating system (e.g. Linux, OSX, Windows, Solaris, etc) and application software (e.g. written in Java, PHP, C⁻, etc) designed and developed to support and perform the functions and services of the system of the present invention described herein.

Similarly, each web server 14 in data center 200 can be realized using one or more web servers, each comprising: one or more central processing units (CPUs); a memory architecture with program memory (RAM), cache, and disc storage (e.g. RAID storage) and optionally one or more network attached storage (NAS) devices; a system bus architecture; power supplies; controllers; and an input/output architecture configured in a manner known in the art. Each web server 14 will support an operating system (e.g. Linux, OSX, Windows, Solaris, etc) and web server (http) software (e.g. Apache httpd software) configured and deployed so as to serve a large number of clients simultaneously, in a manner well known in the art. Preferably, load-balancing servers will be provided to ensure optimal load balancing of incoming http requests to the web servers 14 of the system.

It is understood, that any one or more of the RDBMS servers 15, application servers 21 and/or web servers 14 of system/network 300 can be realized using virtual operating system software (e.g. VMware software) running on one or more hardware servers, in a manner well know in the server art.

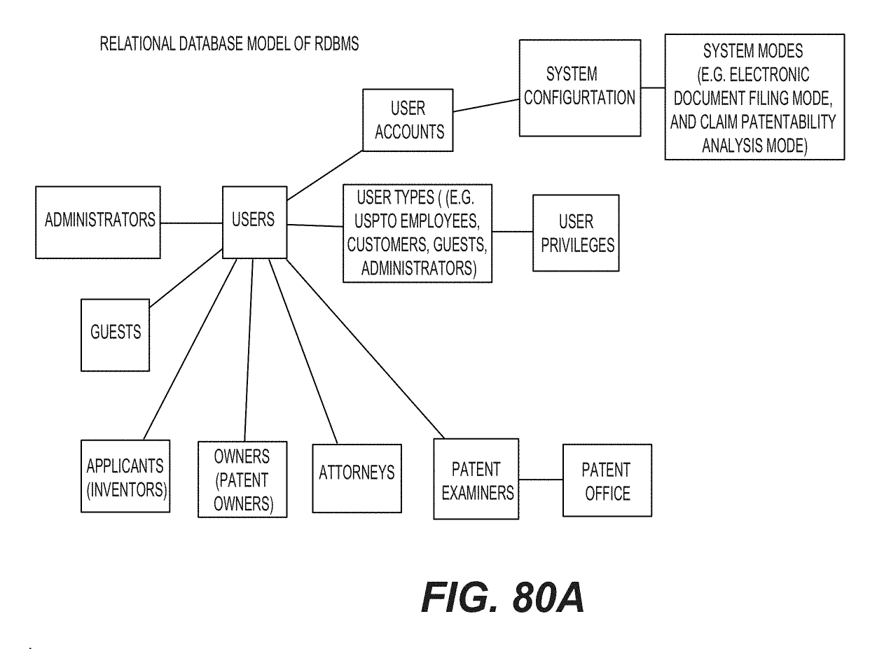

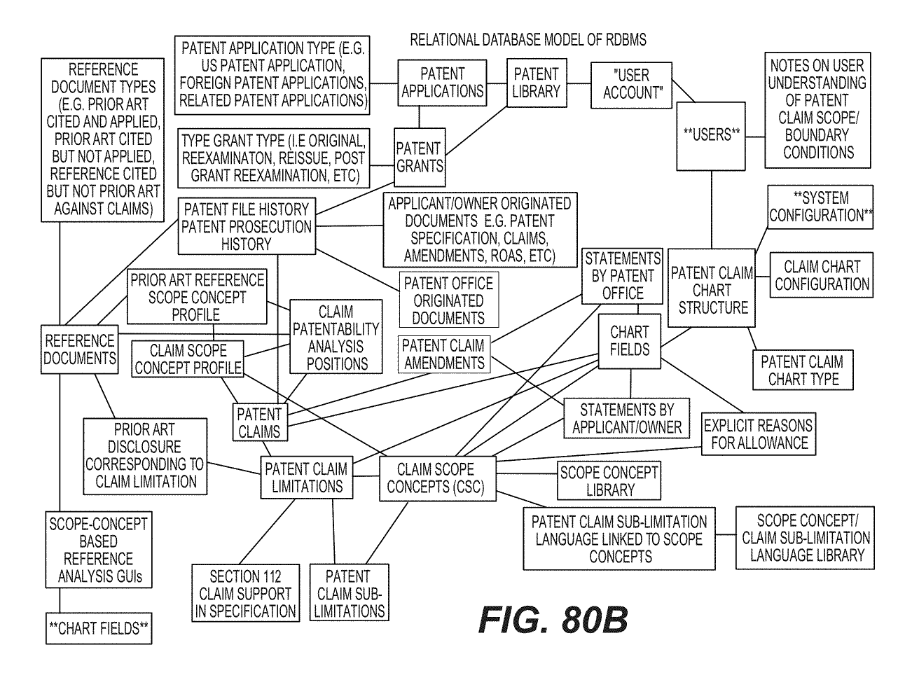

FIGS. 80A and 80B, taken together, set forth a relational database model for the RDBMS server employed in the system shown in FIG. 77. As shown, the relational database model specifies the various database tables that can be used when implementing the illustrative embodiment of the present invention. In the illustrative embodiment, particular terms are used to define particular interface, control and enterprise type objects used in the analysis, design and development of a preferred embodiment of the Internet-based system of the present invention. These enterprise-level objects, represented by the table structures in the relational database model shown in FIGS. 80A and 80B, and listed below, should be carefully considered while reading the present Specification.

### Enterprise-Level Objects Represented in the RDBMS of the System 300

### System Configuration

System Modes (e.g. Claim Patentability Analysis Mode, Search Mode, etc)

### Customers

### User Accounts

### Users

User Type (e.g. USPTO employees, Customers, Guests, Administrators)

### User Privileges

### Administrators

### Patent Office

### Patent Examiners

### Patent Grants

Patent Grant Type (i.e. Original, Reexamination, Post Grant, . . . )

### Applicants

### Owners (Patent Owners)

### Patent Applications

Patent Application Type (e.g. Foreign Patent Applications, Related Patent Applications)

### Patent File History (Patent Prosecution History)

### Patent Office Originated Documents

### Applicant/Owner Originated Documents

Reference Documents (e.g. Prior Art Cited and Applied, Prior Art Cited But Not Applied, Reference Cited But Not Prior Art Against Claims)
Reference Document Types (e.g. Prior Art Cited and Applied, Prior Art Cited But Not Applied, Reference Cited But Not Prior Art Against Claims, All Prior Art References)

### Patent Claim Amendments

### Patent Claims (Claims)

### Patent Specification

### Patent File History (Patent Prosecution History)

### Patent Claim Chart Structure

### Patent Claim Chart Type

### Patent Claim Chart Configuration

### Patents Classified as Standards

### Patent Duration (Enforcement Period)

### Notes User Understanding of Patent Claim Scope/Boundary Conditions

Prosecution History Statements By Applicant/Owner (e.g. Claim Limitation Disclaimer, . . . )

### Prosecution History Statements By Patent Office

### Reasons for Allowance

Patent Claims (original numbering, final numbering)

### Patent Claim Limitations

### Patent Claim Sub-Limitations

### Patent Claim Amendments

### Patent Grants

### Claim Support In Specification (Section 112)

### Prior Art Disclosure Corresponding to Claim Limitation

(Claim) Scope Concept (i.e. Applied To Patent Claims and Specifications)

### Scope Concept Library

Patent Claim Sub-Limitation Language linked to Scope Concepts

### Scope Concept/Sub-limitation Language Link Library

### Scope-Concept Based Reference Analysis GUI

### User Observations on Patent Claim Interpretation/Construction

### Prior Art Reference Scope Concept Profile

### Claim Scope Concept Profile

Patent Grant Type (e.g. Original, Re-Examination, Reissue, Post-Grant Re-Examination, etc)
Patent Application Type (e.g. US Patent Application, Foreign Patent Application, Related Patent Application)

### Patent Library

### Chart Fields

### Scope-Concept/Sub-Limitation Language Library

### Patent Claim Chart Structure

### Patent Claim Chart Configuration

### Prior Art Search Vectors for Patent Claims

As shown in 80B, the object named “Scope Concepts” is related to numerous other objects represented in FIG. 80B, including “Patent Claim Limitations”, “Patent Claim Sub-Limitations”, “Chart Fields” and many other objects shown. While the relationships among the many database objects are complex in the illustrative embodiment shown in FIG. 79, it is understood that different embodiments will have different database object relationships, to support the structures and methods employed in the implemented system. Such technical details are well known in the system engineering and relational database design arts, and will not be discussed in further detail hereinafter.

As recommended for the Internet-based patent analysis and charting system 5 described above, an industrial-strength enterprise-level object-oriented deployment platform will be also used to deploy the Internet-based patent application searching, filing, prior art disclosure, and claim examination system 300 over the infrastructure of the Internet. Each filed patent application, published patent application and granted patent in any national, regional or international patent system will be either stored in remotely accessible Internet-based database servers, or within the central database of the system, so that it is immediately available to each user or group of users, for patent analysis and charting purposes. Once deployed and loaded with case data from filed patent applications, pending applications and granted patents, the deployment platform is ready to serve customers and guests.

### Method of and System for Analyzing the Patentability of Claims in a Patent Application Before Filing a Patent Application in the Patent Office, During Examination of the Claims in the Patent Office, and Throughout the Claim Prosecution Process

Phase 1: The Applicant/Owner and/or its Patent Attorney or Agent Preparing Claims for a Patent Application, within a Privileged/Confidential Workspace (PCW) Supported by the Patent Office's Electronic Business Center

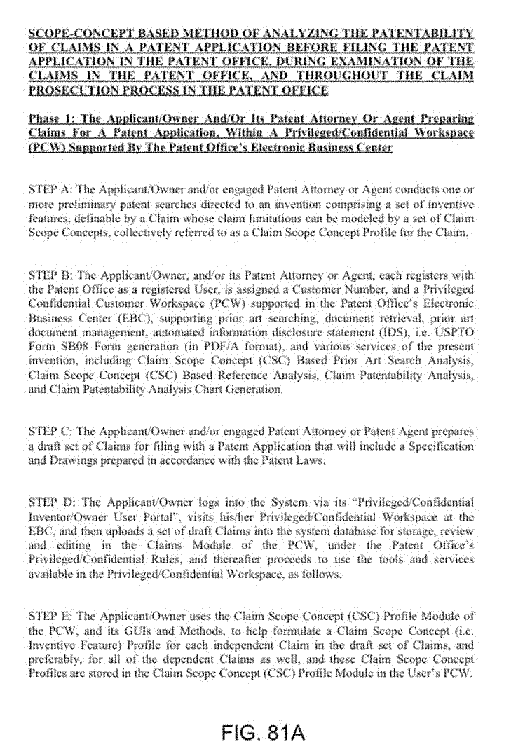

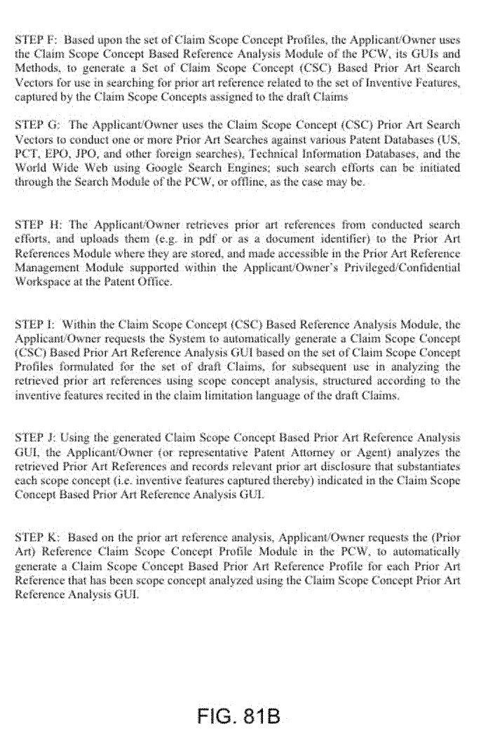

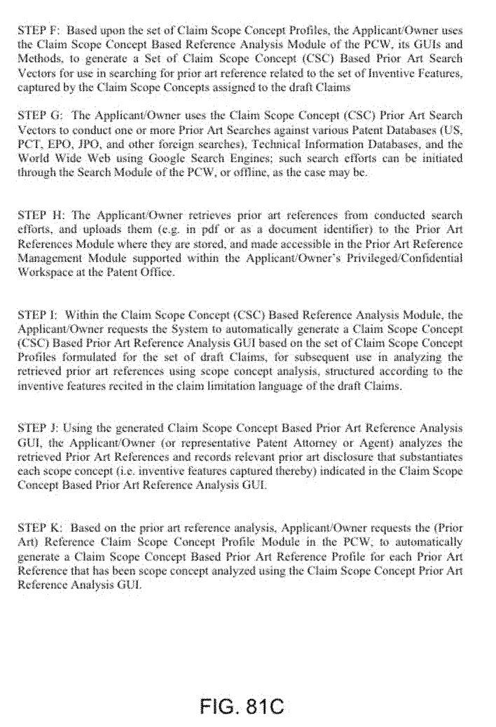

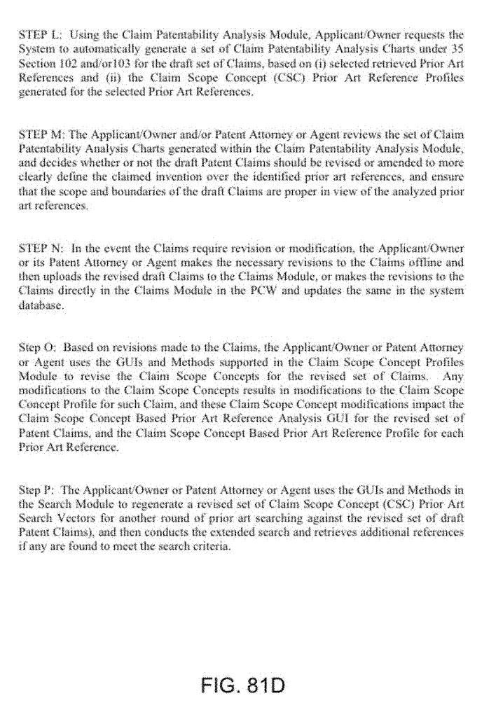

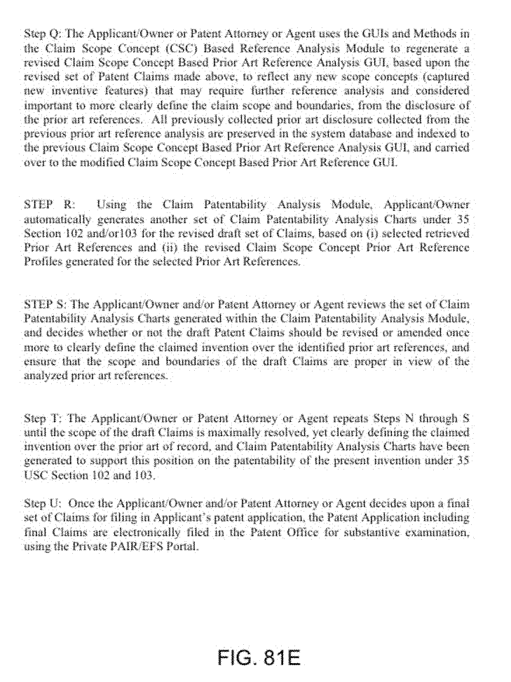

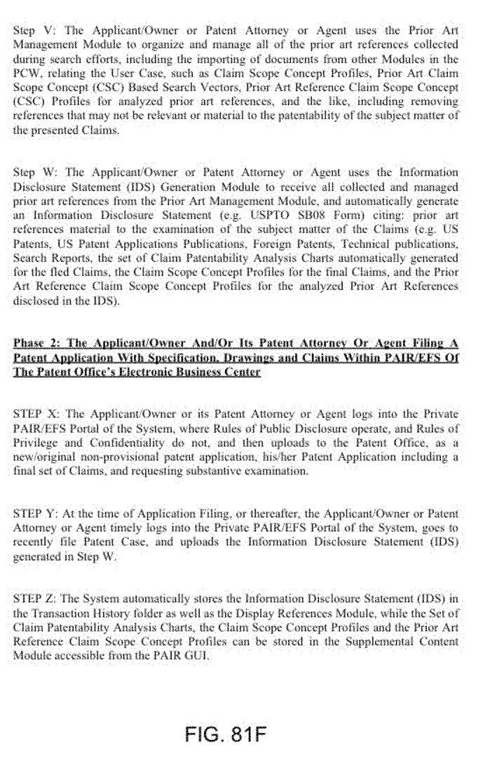

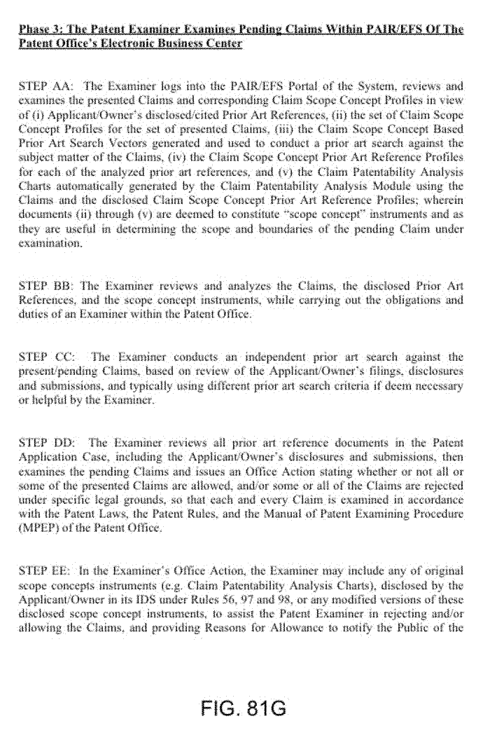

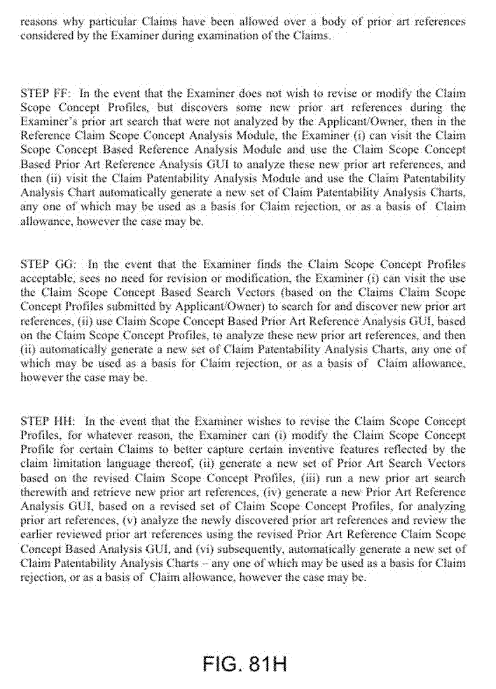

As indicated in STEP A in FIG. 81A, the Applicant/Owner and/or engaged Patent Attorney or Agent conducts one or more preliminary patent searches directed to an invention comprising a set of inventive features, definable by a claim whose claim limitations can be modeled by a set of scope concepts called claim scope concepts. Each claim limitation is modeled by assigning a scope concept to the claim limitation language, which typically will encompass one or more inventive features in the claim.

As indicated in STEP B in FIG. 81A, the Applicant/owner, and its Patent Attorney or Agent, each registers with the Patent Office as a registered User, is assigned a Customer Number, and a Privileged Confidential Workspace (PCW) supported in the Patent Office's Electronic Business Center (EBC). The PCW supports prior art searching, document retrieval, prior art document management, automated information disclosure statement (IDS), i.e. USPTO Form SB08 Form generation (in PDF/A format), and various services of the present invention, including Scope Concept Based Prior Art Search Analysis, Scope Concept Based Reference Analysis, Claim Patentability Analysis, and Claim Patentability Analysis Chart Generation.

As indicated in STEP C in FIG. 81A, the Applicant/Owner and/or engaged patent attorney or patent agent prepares a draft set of claims for filing with a patent application that will include a specification and drawings prepared in accordance with the Patent Laws.

As indicated in STEP D in FIG. 81A, the Applicant/Owner logs into the system 200 via its “Privileged/Confidential Workspace (PCW) Portal”, visits his/her assigned Privileged/Confidential Workspace (PWC) at the EBC (linked to the Applicant/Owner's Customer Number, and then uploads a set of draft Claims into the system database for storage, review and editing in the Claims Module of the PCW, under the Patent Office's privileged/confidential rules, and thereafter proceeds to use the tools and services available in the Privileged/Confidential Workspace, as follows.

As indicated in STEP E in FIG. 81A, the Applicant/Owner uses the Claim Scope Concept Profile Module of the PCW, and its GUIs and methods, to help formulate a Claim Scope Concept (i.e. Inventive Feature) Profile for each independent Claim in the draft set of Claims, and preferably, for all of the dependent Claims as well, and these Claim Scope Concept Profiles are stored in the Claim Scope Concept Profile Module in the User's PCW.

As indicated in STEP F in FIG. 81B, based upon the set of Claim Scope Concept Profiles, the Applicant/Owner uses the Scope Concept Based Reference Analysis Module of the PCW, its GUIs and methods, to generate a set of Scope Concept (Based) Prior Art Search Vectors for use in searching for prior art reference related to the set of Inventive Features, captured by the Scope Concepts assigned to the draft Claims.

As indicated in STEP G in FIG. 81B, the Applicant/Owner uses the Scope Concept Prior Art Search Vectors to conduct one or more prior art searches against various patent databases (US, PCT, EPO, JPO, and other foreign searches), technical information databases, and the World Wide Web using Google Search Engines; such search efforts can be initiated through the Search Module of the PCW, or offline, as the case may be.

As indicated in STEP H in FIG. 81B, the Applicant/Owner retrieves prior art references from conducted search efforts, and uploads them (e.g. in pdf or as a document identifier) to the Prior Art References Module where they are stored, and made accessible in the Prior Art Reference Management Module supported within the Applicant/Owner's Privileged/Confidential Workspace (PCW) at the Patent Office.

As indicated in STEP I in FIG. 81B, within the Scope Concept Based Reference Analysis Module, the Applicant/Owner requests the System to automatically generate a Scope Concept Based Prior Art Reference Analysis GUI based on the set of Claim Scope Concept Profiles formulated for the set of draft Claims, for subsequent use in analyzing the retrieved prior art references using scope concept analysis, structured according to the inventive features recited in the claim limitation language of the draft Claims.

As indicated in STEP J in FIG. 81B, using the generated Scope Concept Based Prior Art Reference Analysis GUI, the Applicant/Owner (or representative Patent Attorney or Agent) analyzes the retrieved Prior Art References and records relevant prior art disclosure that substantiates each scope concept (i.e. inventive features captured thereby) indicated in the Scope Concept Based Prior Art Reference Analysis GUI.

As indicated in STEP K in FIG. 81B, based on the prior art reference analysis, Applicant/Owner requests the Reference Scope Concept Profile Module in the PCW, to automatically generate a Scope Concept Based Prior Art Reference Profile for each Prior Art Reference that has been scope concept analyzed using the Scope Concept Prior Art Reference Analysis GUI.

As indicated in STEP L in FIG. 81D, using the Claim Patentability Analysis Module, Applicant/Owner requests the system to automatically generate a set of Claim Patentability Analysis Charts under 35 Section 102 and/or 103 for the draft set of Claims, based on (i) selected retrieved Prior Art References and (ii) the Scope Concept Prior Art Reference Profiles generated for the selected Prior Art References.

As indicated in STEP M in FIG. 81D, the Applicant/Owner and/or Patent Attorney or Agent reviews the set of Claim Patentability Analysis Charts generated within the Claim Patentability Analysis Module, and decides whether or not the draft Patent Claims should be revised or amended to more clearly define the claimed invention over the identified prior art references, and ensure that the scope and boundaries of the draft Claims are proper in view of the analyzed prior art references.

As indicated in STEP N in FIG. 81D, in the event the Claims require revision or modification, the Applicant/Owner or its Patent Attorney or Agent makes the necessary revisions to the Claims offline and then uploads the revised draft Claims to the Claims Module, or makes the revisions to the Claims directly in the Claims Module in the PCW, and then updates the same in the system database.

As indicate at STEP O in FIG. 81D, based on revisions made to the Claims, the Applicant/Owner or Patent Attorney or Agent uses the GUIs and methods supported in the Claim Scope Concept Profiles Module to revise the Claim Scope Concepts for the revised set of Claims. Any modifications to the Scope Concepts results in modifications to the Claim Scope Concept Profile for such Claim. These Scope Concept modifications impact the Scope Concept Based Prior Art Reference Analysis GUI for the revised set of Patent Claims, and also the Scope Concept Based Prior Art Reference Profile for each Prior Art Reference.

As indicated in Step P in FIG. 81D, the Applicant/Owner or Patent Attorney or Agent uses the GUIs and methods in the Search Module to regenerate a revised set of Scope Concept Prior Art Search Vectors for another round of prior art searching against the revised set of draft Patent Claims), and then conducts the extended search and retrieves additional references if any are found to meet the search criteria.

As indicated in Step Q in FIG. 81E, the Applicant/Owner or Patent Attorney or Agent uses the GUIs and methods in the Scope Concept Based Reference Analysis Module to regenerate a revised Scope Concept Based Prior Art Reference Analysis GUI, based upon the revised set of Patent Claims made above, to reflect any new scope concepts (formulated to capture new or overlooked Inventive Features) that may require further reference analysis and considered important to more clearly define the claim scope and boundaries, from the disclosure of the prior art references. All prior art disclosure previously collected from the previous round of prior art reference analysis is preserved in the system database and indexed to the previous Scope Concept Based Prior Art Reference Analysis GUI, and carried over to the modified Scope Concept Based Prior Art Reference GUI 26C.

As indicated in STEP R in FIG. 81E, using the Claim Patentability Analysis Module, Applicant/Owner automatically generates another set of Claim Patentability Analysis Charts under 35 Section 102 and/or 103 for the revised draft set of Claims, based on (i) selected retrieved Prior Art References and (ii) the revised Scope Concept Prior Art Reference Profiles generated for the selected Prior Art References.

As indicated in STEP S in FIG. 81E, the Applicant/Owner and/or Patent Attorney or Agent reviews the set of Claim Patentability Analysis Charts generated within the Claim Patentability Analysis Module, and decides whether or not the draft Patent Claims should be revised or amended once more to clearly define the claimed invention over the identified prior art references, and ensure that the scope and boundaries of the draft Claims are proper in view of the analyzed prior art references.

As indicated in Step T in FIG. 81E, the Applicant/Owner or Patent Attorney or Agent repeats Steps N through S until the scope of the draft Claims is maximally resolved, yet clearly defining the claimed invention over the prior art of record, and Claim Patentability Analysis Charts have been generated to support this position on the patentability of the present invention under 35 USC Sections 102 and/and 103.

As indicated in Step U in FIG. 81E, once the Applicant/Owner and/or Patent Attorney or Agent decides upon a final set of Claims for filing in Applicant's patent application, the Patent Application including final Claims are electronically filed in the Patent Office for substantive examination, using the Private PAIR/EFS Port depicted in FIG. 77.

As indicated in Step V in FIG. 81F, the Applicant/Owner or Patent Attorney or Agent uses the Prior Art Management Module to organize and manage all of the prior art references collected during search efforts, including the importing of documents from other Modules in the PCW, relating the User Case, such as Claim Scope Concept Profiles, Prior Art Scope Concept Based Search Vectors, Prior Art Reference Scope Concept Profiles for analyzed prior art references, and the like, including removing references that may not be relevant or material to the patentability of the subject matter of the presented Claims.

As indicated in Step W in FIG. 81F, the Applicant/Owner or Patent Attorney or Agent uses the Information Disclosure Statement (IDS) Generation Module to receive all collected and managed prior art references from the Prior Art Management Module, and automatically generate an Information Disclosure Statement (e.g. USPTO SB08 Form) citing: prior art references material to the examination of the subject matter of the Claims (e.g. US Patents, US Patent Applications Publications, Foreign Patents, Technical publications, Search Reports, the set of Claim Patentability Analysis Charts automatically generated for the fled Claims, the Claim Scope Concept Profiles for the final Claims, and the Prior Art Reference Scope Concept Profiles for the analyzed Prior Art References disclosed in the IDS).

Phase 2: The Applicant/Owner and/or its Patent Attorney or Agent Filing a Patent Application with Specification, Drawings and Claims within PAIR/EFS of the Patent Office's Electronic Business Center

As indicated in STEP X in FIG. 81F, the Applicant/Owner or its Patent Attorney or Agent logs into the Private PAIR/EFS Portal of the system, depicted in FIG. 77, where Rules of Public Disclosure operate, and Rules of Privilege and Confidentiality do not, and then uploads to the Patent Office, as a new/original non-provisional patent application, his/her Patent Application including a final set of Claims, and requesting substantive examination.

As indicated in STEP Y in FIG. 81F, at the time of Application Filing, or thereafter, the Applicant/Owner or Patent Attorney or Agent timely logs into the Private PAIR/EFS Portal of the System, goes to recently file Patent Case, and uploads the Information Disclosure Statement (IDS) generated in Step W.

As indicated in STEP Z in FIG. 81F, the system automatically stores the Information Disclosure Statement (IDS) in the Transaction History folder as well as the Display References Module, while the Set of Claim Patentability Analysis Charts, the Claim Scope Concept Profiles and the Prior Art Reference Scope Concept Profiles can be stored in the Supplemental Content Module accessible from the PAIR GUI.

Phase 3: The Patent Examiner Examines Pending Claims within PAIR/EFS of the Patent Office's Electronic Business Center

As indicated in STEP AA in FIG. 81G, the Examiner logs into the PAIR/EFS Portal of the system, reviews and examines the presented Claims and corresponding Claim Scope Concept Profiles in view of (i) Applicant/Owner's disclosed/cited Prior Art References, (ii) the set of Scope Concept Profiles for the set of presented Claims, (iii) the Scope Concept Based Prior Art Search Vectors generated and used to conduct a prior art search against the subject matter of the Claims, (iv) the Scope Concept Prior Art Reference Profiles for each of the analyzed prior art references, and (v) the Claim Patentability Analysis Charts automatically generated by the Claim Patentability Analysis Module using the Claims and the disclosed Scope Concept Prior Art Reference Profiles; wherein documents (ii) through (v) are deemed to constitute “scope concept” instruments and as they are useful in determining the scope and boundaries of the pending Claim under examination.

As indicated in STEP BB in FIG. 81G, the Examiner reviews and analyzes the Claims, the disclosed Prior Art References, and the scope concept instruments, while carrying out the obligations and duties of an Examiner within the Patent Office.

As indicated in STEP CC in FIG. 81G, the Examiner conducts an independent prior art search against the present/pending Claims, based on review of the Applicant/Owner's filings, disclosures and submissions, and typically using different prior art search criteria if deem necessary or helpful by the Examiner.

As indicated in STEP DD in FIG. 81G, the Examiner reviews all prior art reference documents in the Patent Application Case, including the Applicant/Owner's disclosures and submissions, then examines the pending Claims and issues an Office Action stating whether or not all or some of the presented Claims are allowed, and/or some or all of the Claims are rejected under specific legal grounds, so that each and every Claim is examined in accordance with the Patent Laws, the Patent Rules, and the Manual of Patent Examining Procedure (MPEP) of the Patent Office.

As indicated in STEP EE in FIG. 81G, in the Examiner's Office Action, the Examiner may include any of original scope concepts instruments (e.g. Claim Patentability Analysis Charts), disclosed by the Applicant/Owner in its IDS under Rules 56, 97 and 98, or any modified versions of these disclosed scope concept instruments, to assist the Patent Examiner in rejecting and/or allowing the Claims, and providing Reasons for Allowance to notify the Public of the reasons why particular Claims have been allowed over a body of prior art references considered by the Examiner during examination of the Claims.

As indicated in STEP FF in FIG. 81H, in the event that the Examiner does not wish to revise or modify the Claim Scope Concept Profiles, but discovers some new prior art references during the Examiner's prior art search that were not analyzed by the Applicant/Owner, then in the Reference Scope Concept Analysis Module, the Examiner (i) can visit the Scope Concept Based Reference Analysis Module and use the Scope Concept Based Prior Art Reference Analysis GUI to analyze these new prior art references, and then (ii) visit the Claim Patentability Analysis Module and use the Claim Patentability Analysis Chart automatically generate a new set of Claim Patentability Analysis Charts, any one of which may be used as a basis for Claim rejection, or as a basis of Claim allowance, however the case may be.

As indicated in STEP GG in FIG. 81H, in the event that the Examiner finds the Claim Scope Concept Profiles acceptable, sees no need for revision or modification, the Examiner (i) can visit the use the Scope Concept Based Search Vectors (based on the Claims Scope Concept Profiles submitted by Applicant/Owner) to search for and discover new prior art references, (ii) use Scope Concept Based Prior Art Reference Analysis GUI, based on the Claim Scope Concept Profiles, to analyze these new prior art references, and then (ii) automatically generate a new set of Claim Patentability Analysis Charts, any one of which may be used as a basis for Claim rejection, or as a basis of Claim allowance, however the case may be.

As indicated in STEP HH in FIG. 81H, in the event that the Examiner wishes to revise the Claim Scope Concept Profiles, for whatever reason, the Examiner can (i) modify the Claim Scope Concept Profile for certain Claims to better capture certain inventive features reflected by the claim limitation language thereof, (ii) generate a new set of Prior Art Search Vectors based on the revised Claim Scope Concept Profiles, (iii) run a new prior art search therewith and retrieve new prior art references, (iv) generate a new Prior Art Reference Analysis GUI, based on a revised set of Claim Scope Concept Profiles, for analyzing prior art references, (v) analyze the newly discovered prior art references and review the earlier reviewed prior art references using the revised Prior Art Reference Scope Concept Based Analysis GUI, and (vi) subsequently, automatically generate a new set of Claim Patentability Analysis Charts—any one of which may be used as a basis for Claim rejection, or as a basis of Claim allowance, however the case may be.

Phase 4: The Applicant/Owner and/or its Patent Attorney or Agent Prosecutes Pending Claims within PAIR/EFS of the Patent Office's Electronic Business Center

Upon receiving the Examiner's first Office Action from the Private PAIR/EFS, the Applicant/Owner reviews the Office Action and examination of the Claims, and determines how the Examiner disposed of the Patent Application.

In the event that the Examiner allows all pending Claims with stated Reasons for Allowance, then the Applicant/Owner can file a Response accepting the reasons for allowance, paying the Issue Fee due and waiting for the examined Patent Application to issue as a patent grant.

In the event that the Examiner allows all pending Claims with stated Reasons for Allowance, then the Applicant/Owner can file a Response commenting on the reasons for allowance, paying the Issue Fee due and waiting for the examined Patent Application to issue as a patent grant.

In the event that the Examiner rejects one or more pending Claims, then the Applicant/Owner can file a Response without amending the rejected Claims and presenting arguments for patentability, supported by scope concept instruments (e.g. Claim Patentability Analysis Charts), and requesting reconsideration and notice of allowance of the Claims.

In the event that the Examiner rejects one or more pending Claims, then the Applicant/Owner can file a Response amending the rejected Claims and presenting arguments for patentability, supported by scope concept instruments (e.g. Claim Patentability Analysis Charts), and requesting reconsideration and a notice of allowance of the Claims.

In the event that the Examiner rejects one or more pending Claims, then the Applicant/Owner can file a Response, canceling all rejected claims and amending any allowable claims in form for allowance, and requesting reconsideration and a notice of allowance of the Claims.

The Applicant/Owner or its Patent Attorney or Agent prepares a suitable Response to the Office Action, then logs into the Private PAIR/EFS Portal of the System, and files the response in effort to place the Application in condition for allowance.

Phase 5: The Examiner Reconsiders any Rejected Claims within PAIR/EFS of the Patent Office's Electronic Business Center

As indicated in Step KK in FIG. 81I, the Patent Examiner logs into the PAIR/EFS Portal of the System, analyses Applicant/Owner's filed Response to office action, and then either (i) allows the Patent Application and issues a Notice of Allowance and Issue Fee Due, or (ii) prepares and issues second office action, addressing the pending claims and any arguments made by the Applicant/Owner in the previous response to office action, and using any of the scope concept instruments made of record by Applicant/Owner, and/or scope concept instruments modified by the Examiner.

Phase 6: Subsequent Rounds of Claim Prosecution within PAIR/EFS of the Patent Office's Electronic Business Center

As indicated in Step LL in FIG. 81I, the Examiner and Applicant/Owner continue to prosecute the pending Claims in the Application, and described above, until either a final Office Action is issued by in the Case by the Examiner, or the Application is allowed, abandoned or appealed, as the case may be, in accordance with the Patent Rules.

### Method of Generating Rational Claim Patentability Analyses, Charts and Reports Using Services Supported by the Internet-Based Patent Application Filing, Prior Art Disclosure, and Claim Examination System of the Present Invention

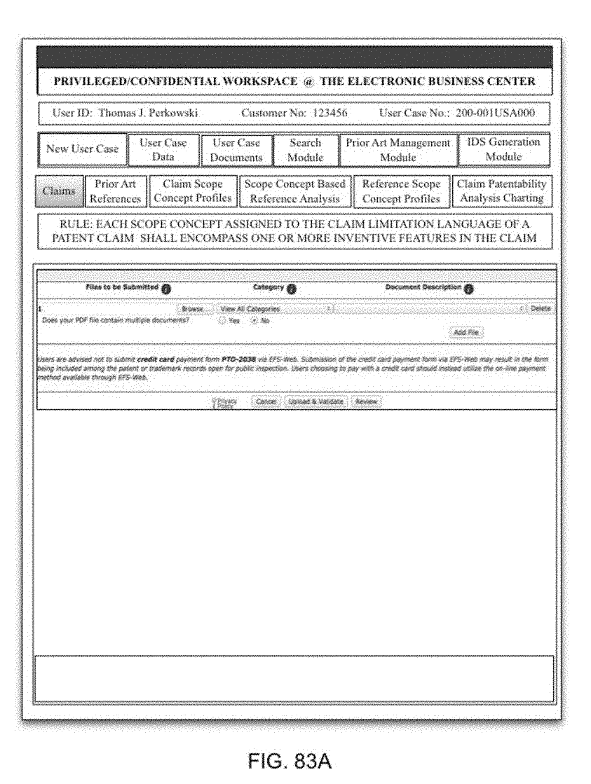

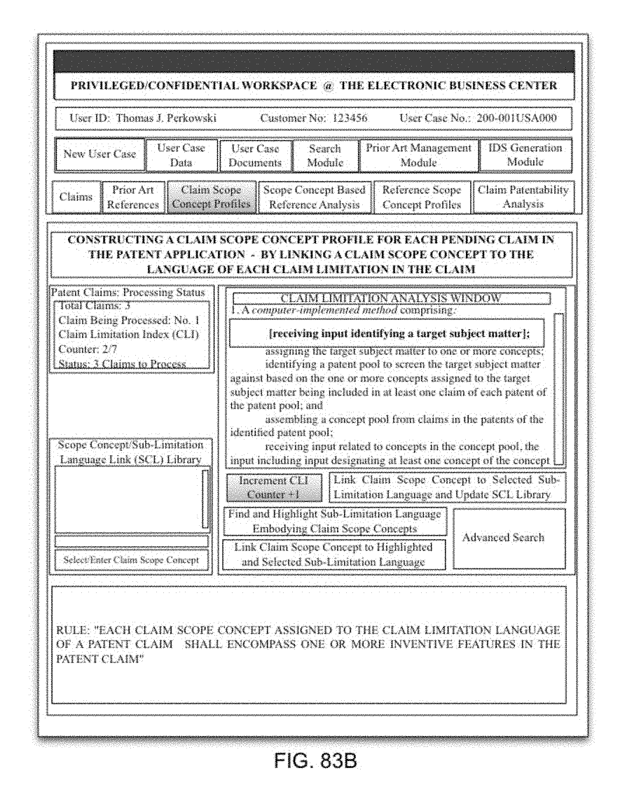

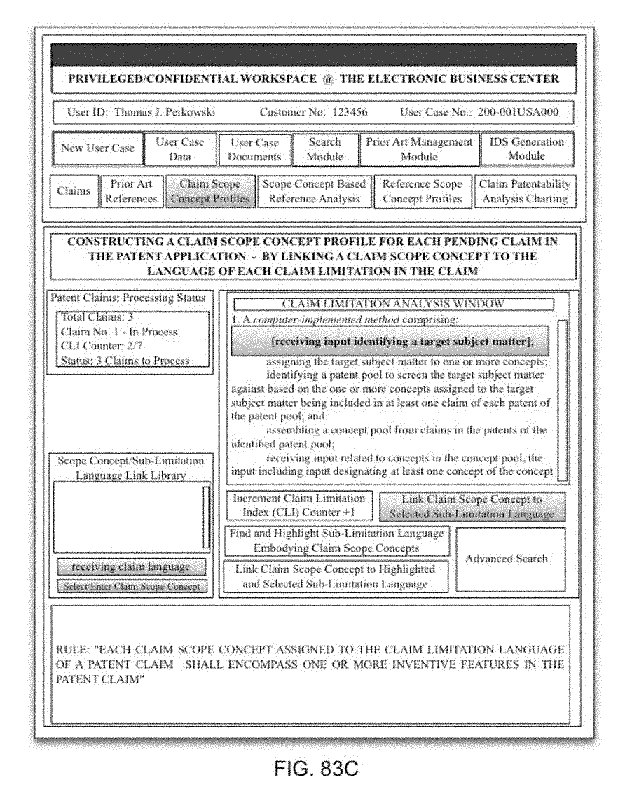

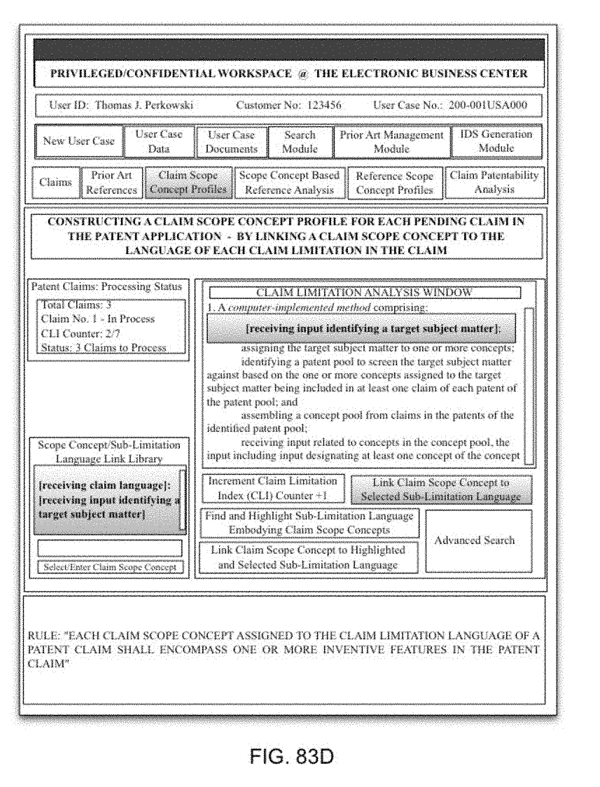

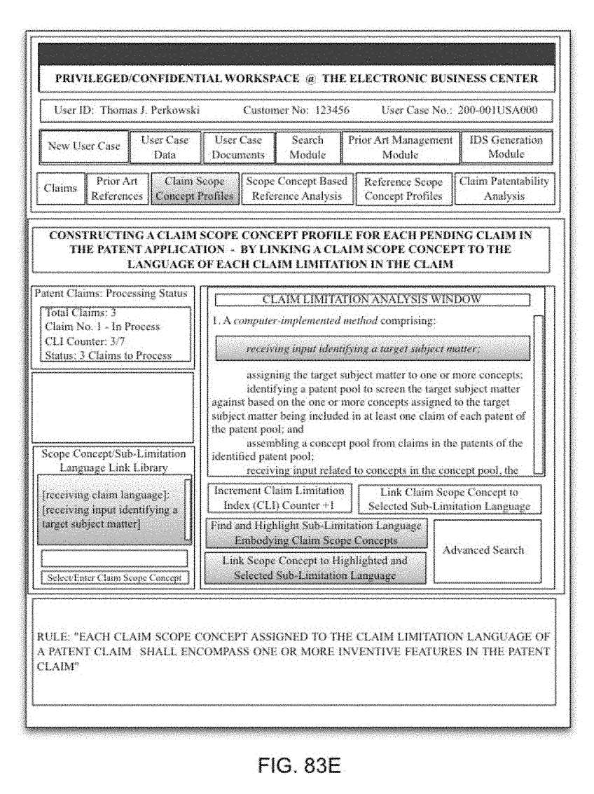

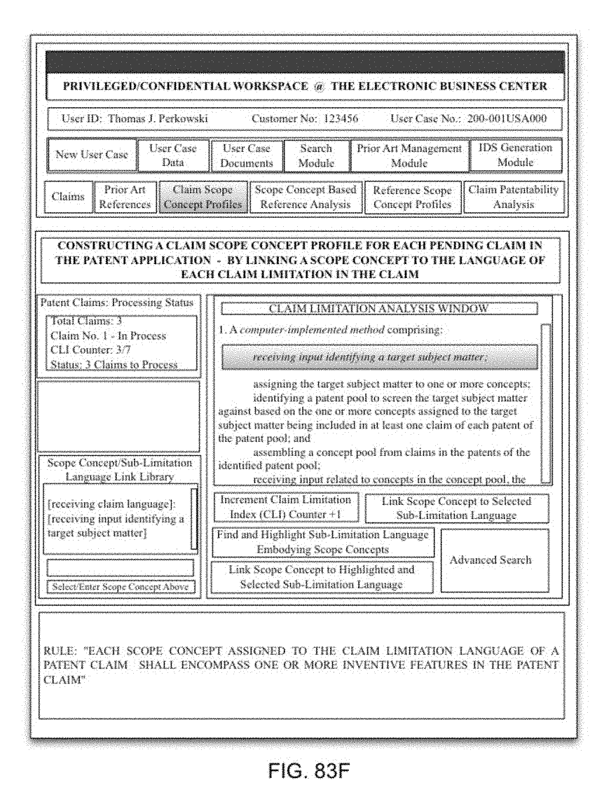

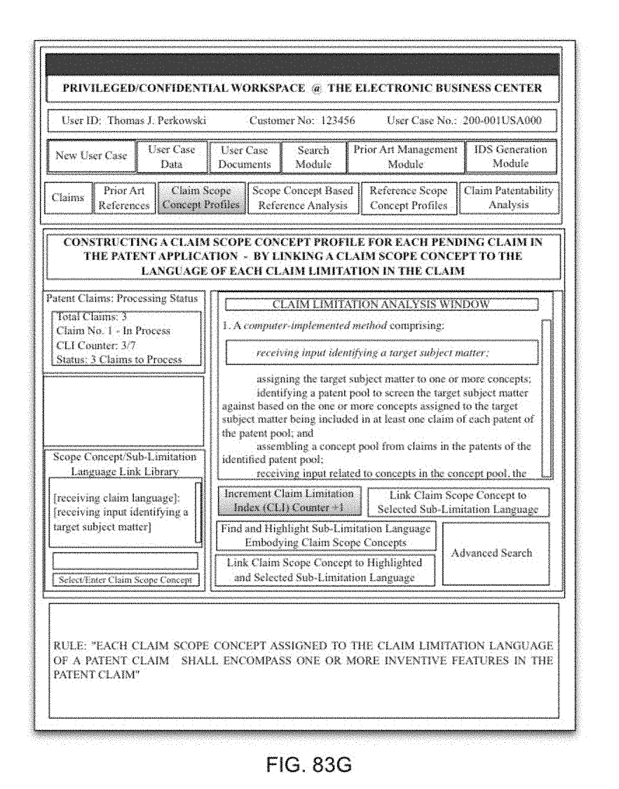

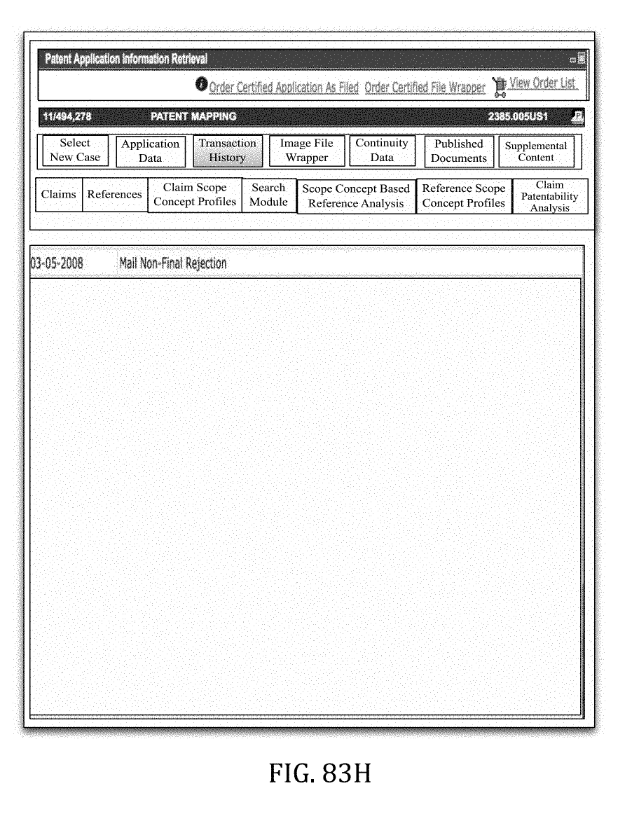

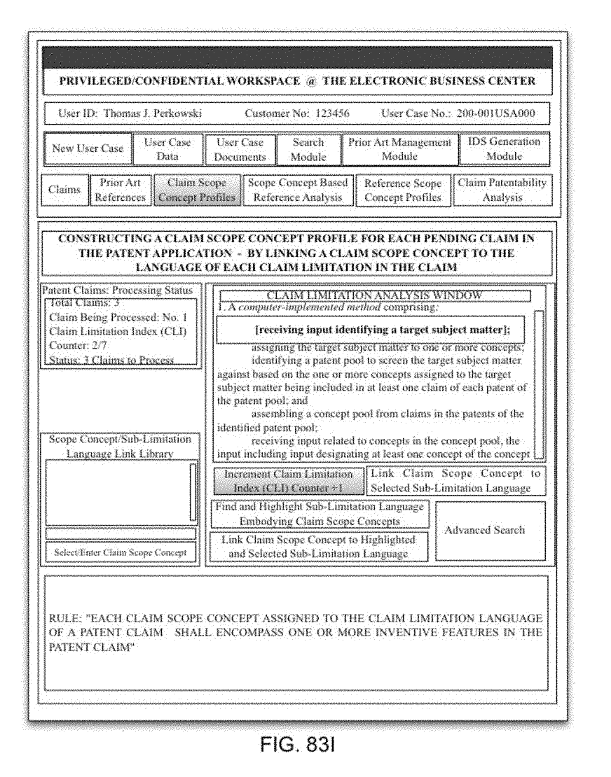

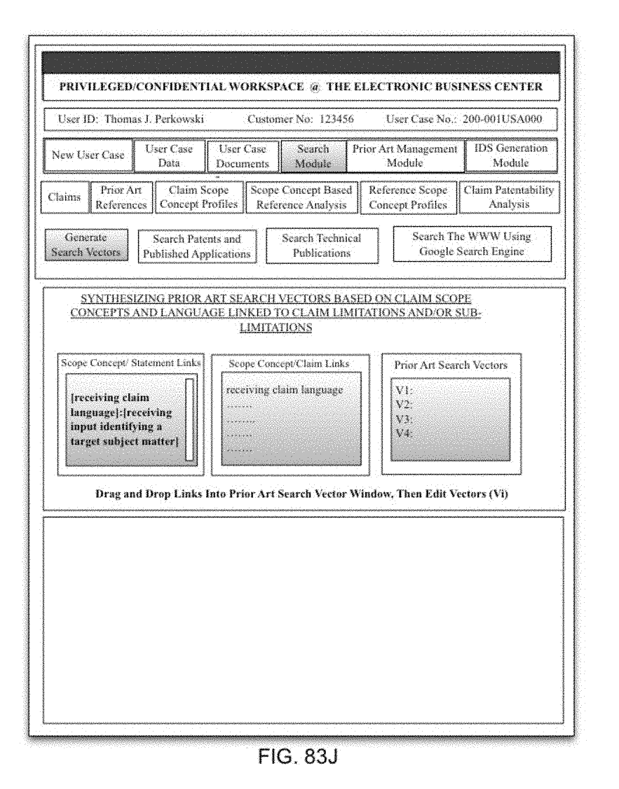

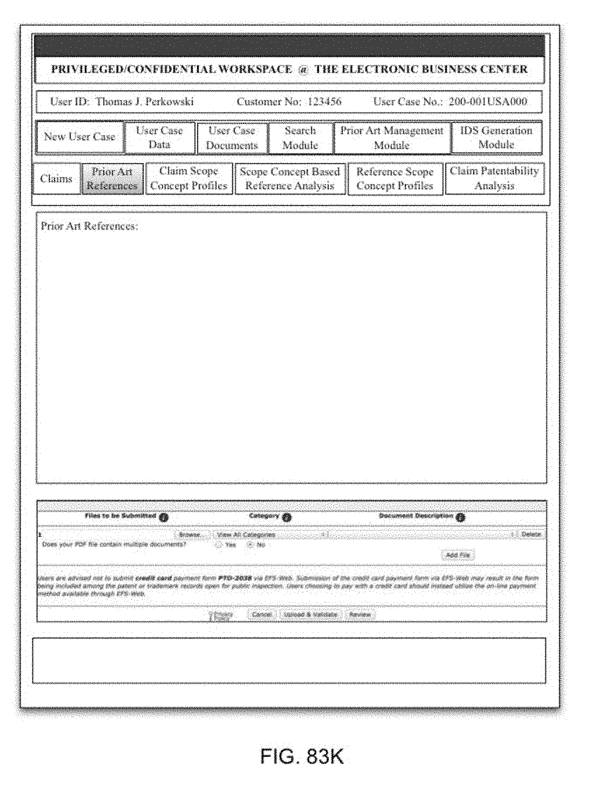

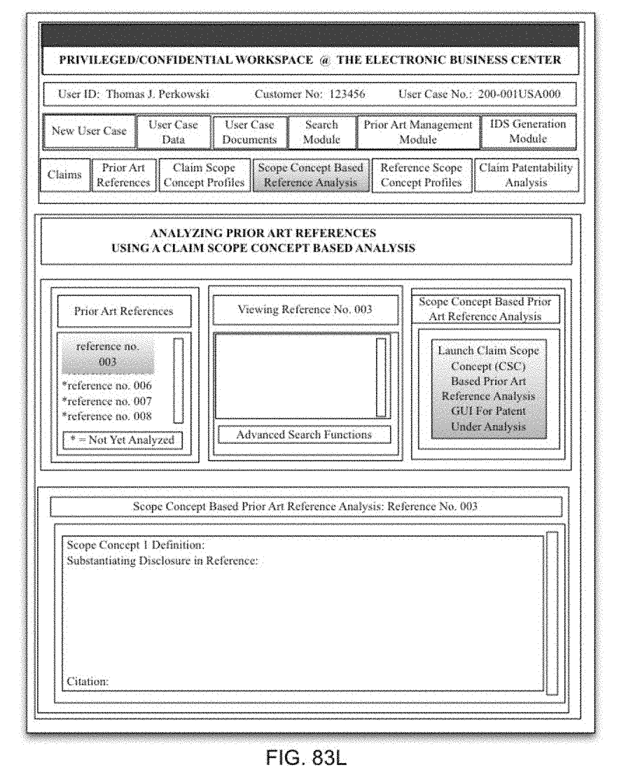

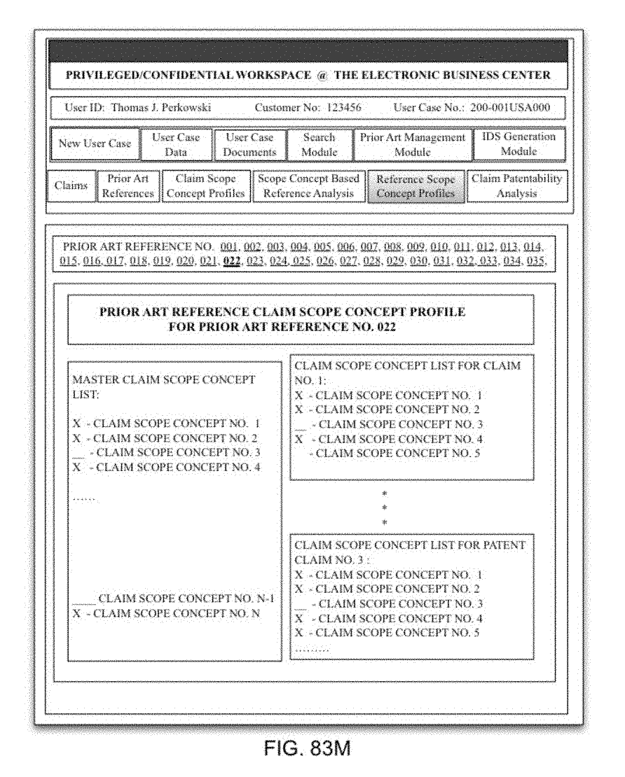

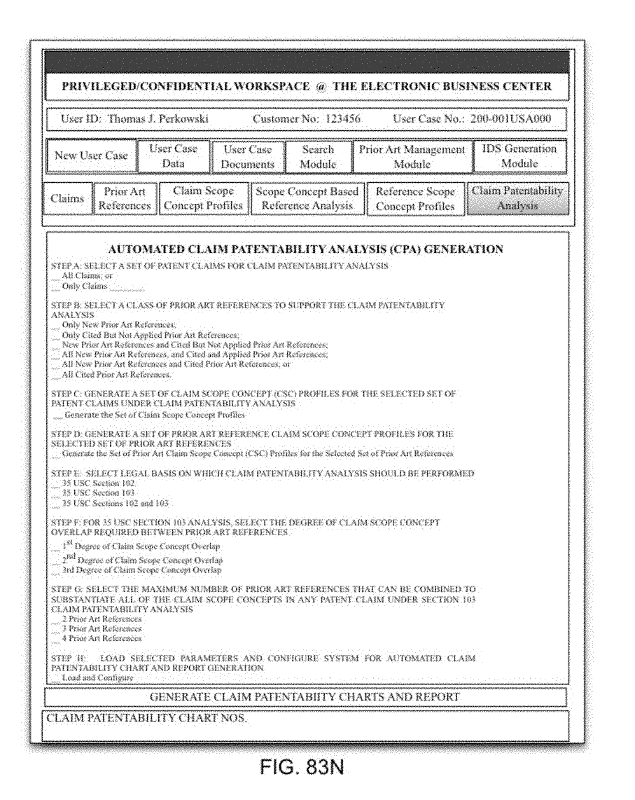

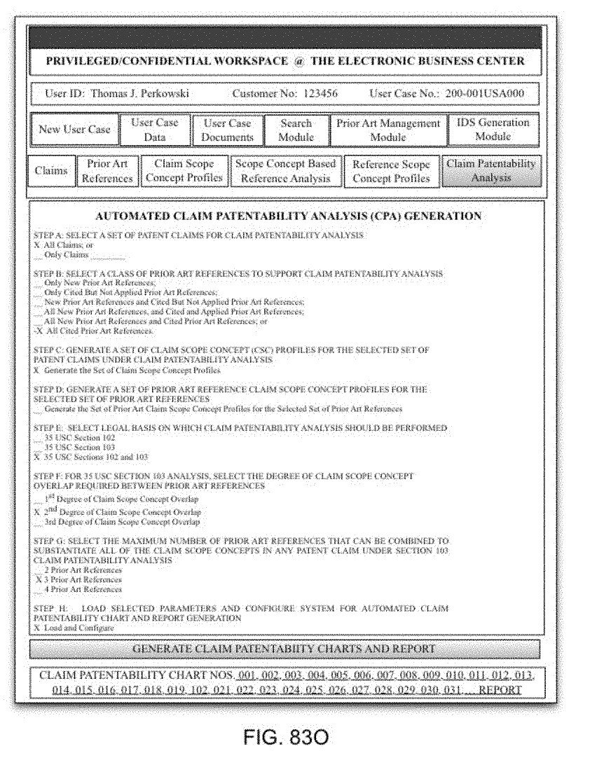

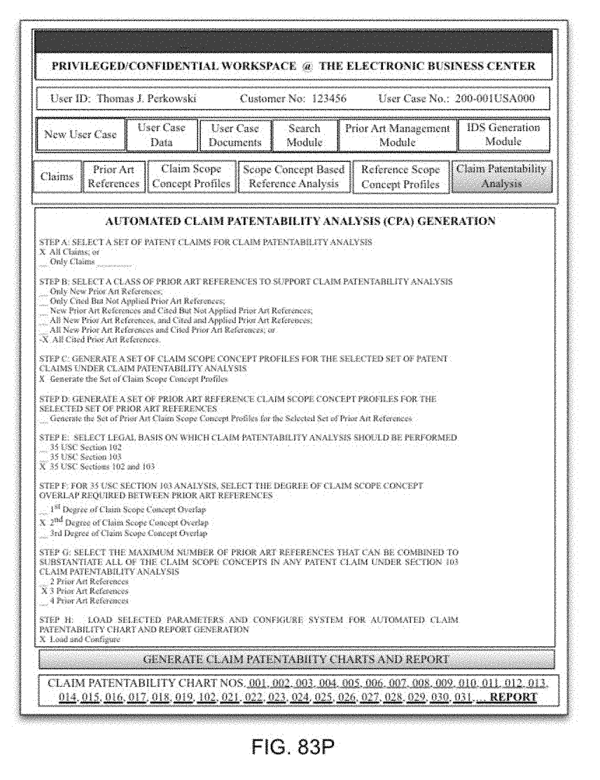

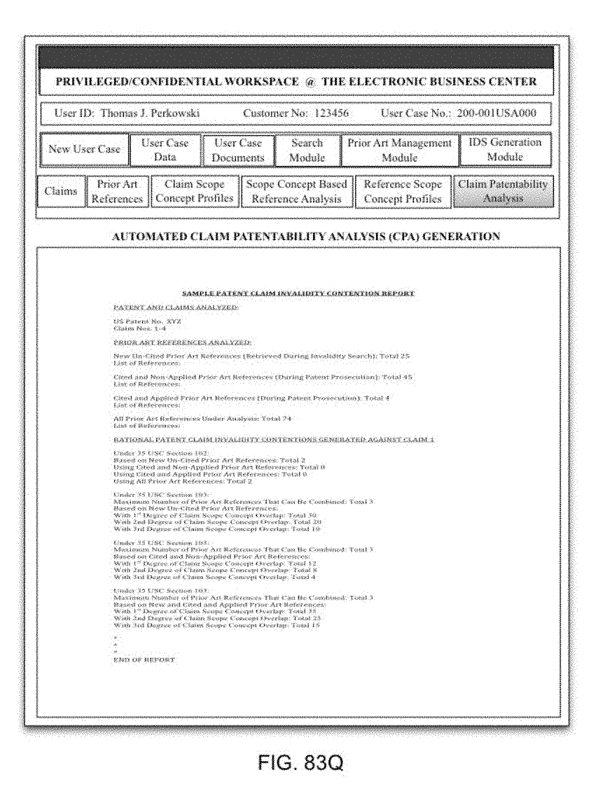

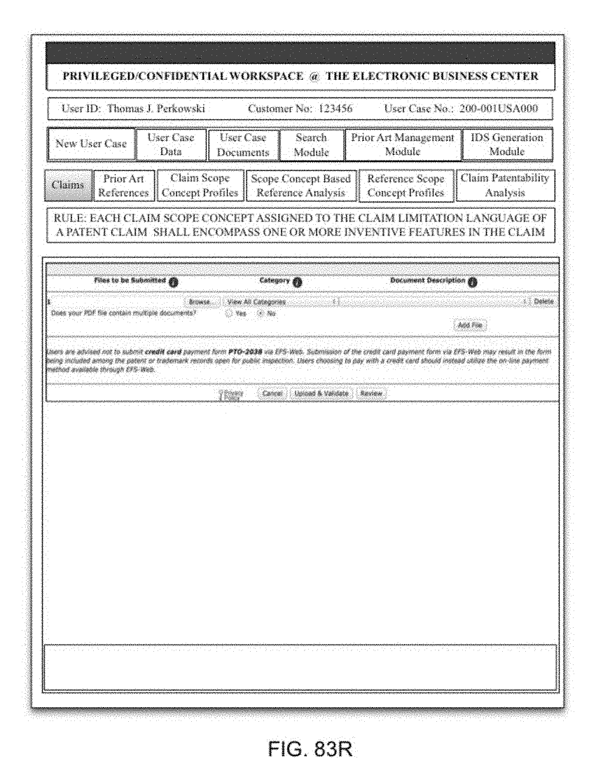

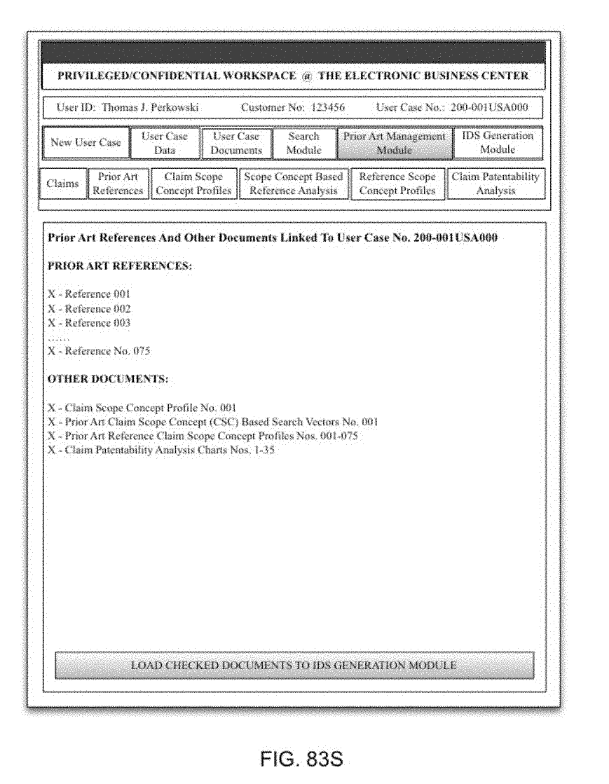

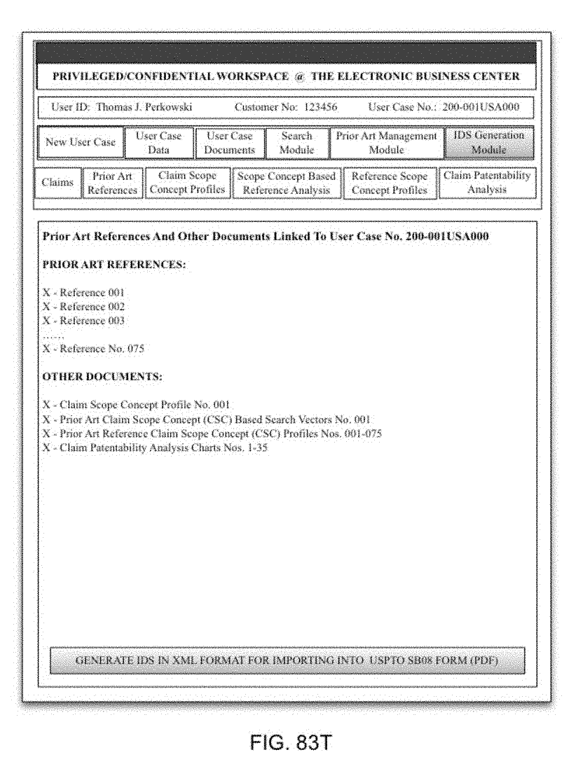

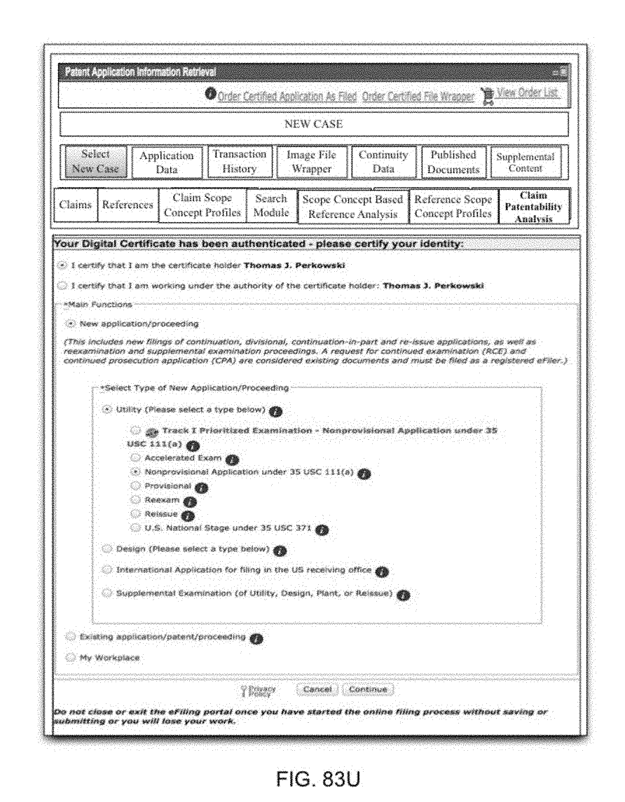

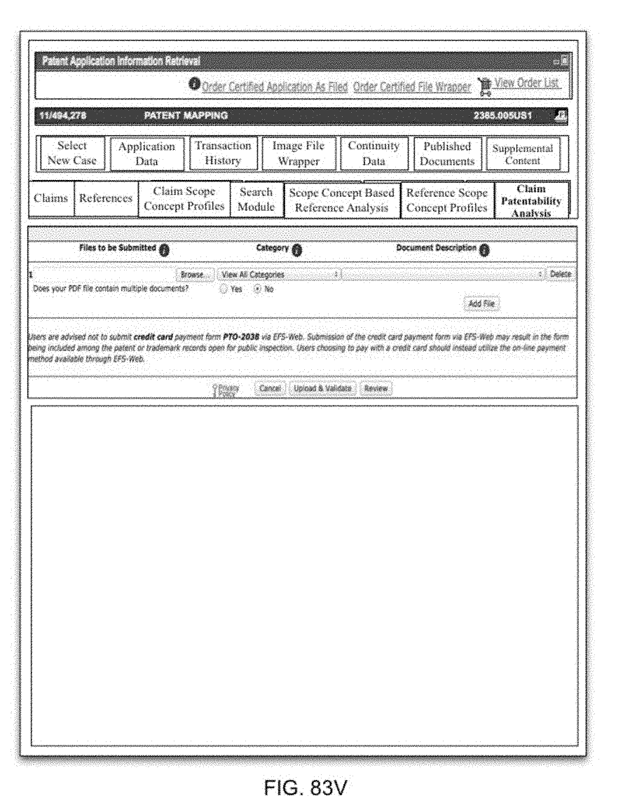

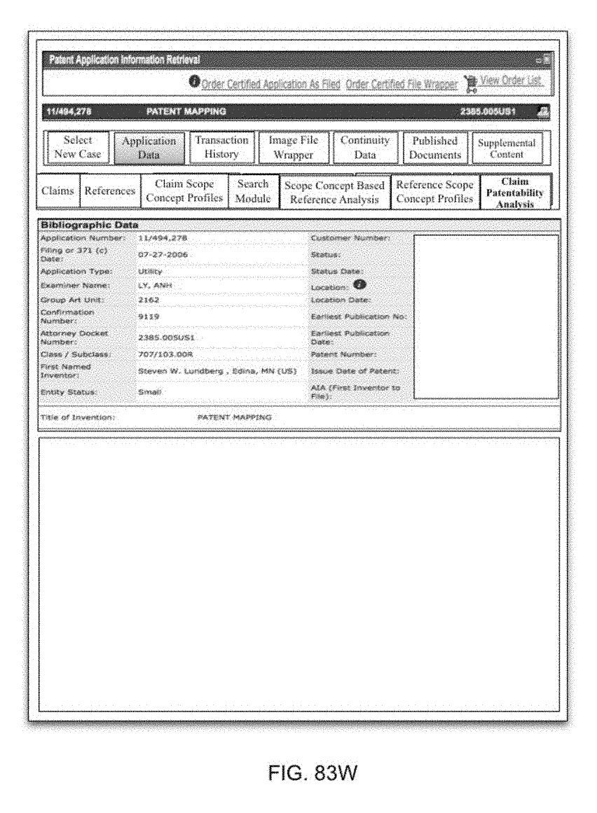

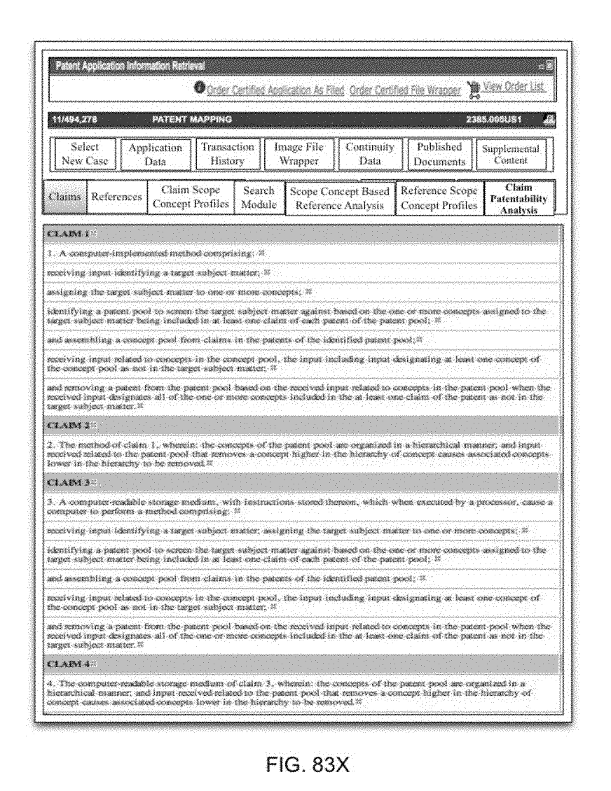

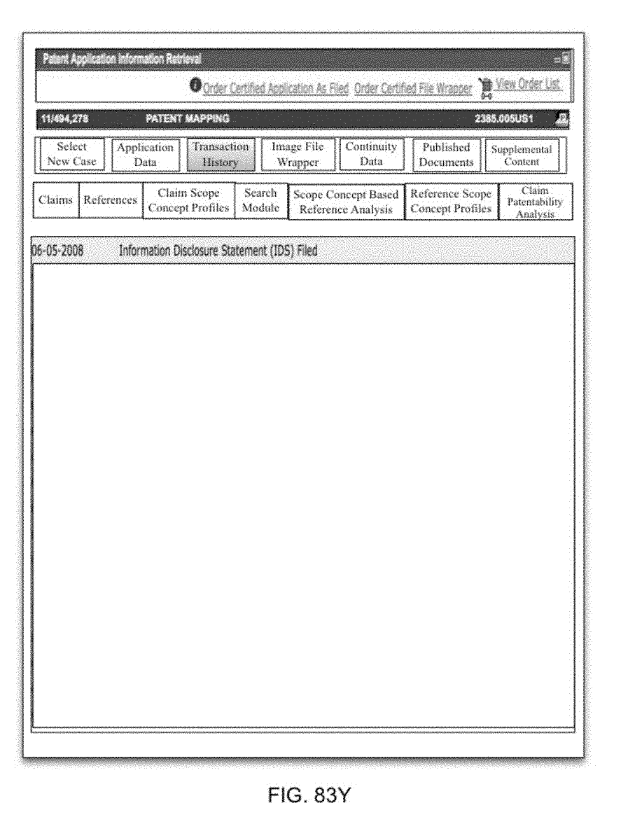

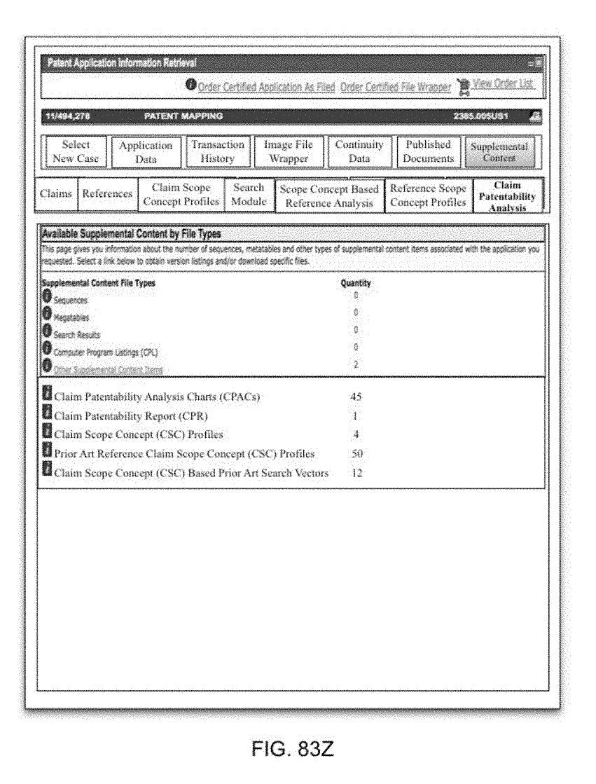

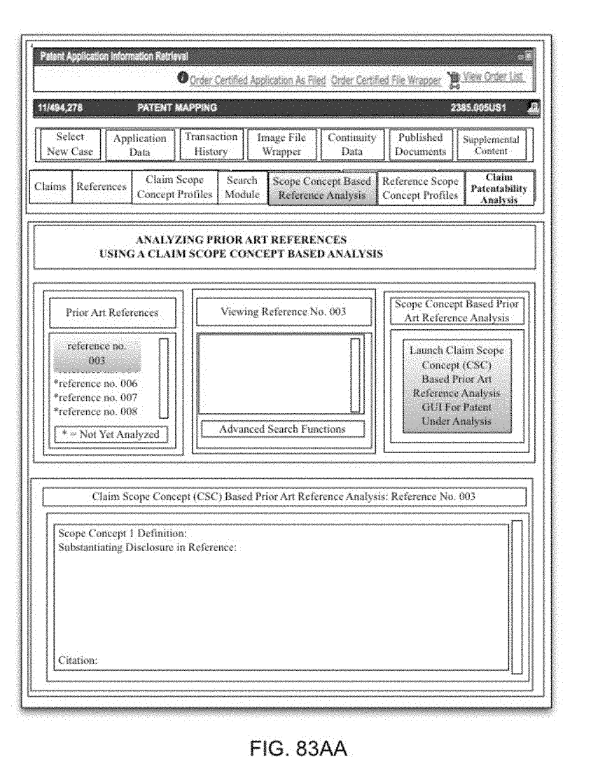

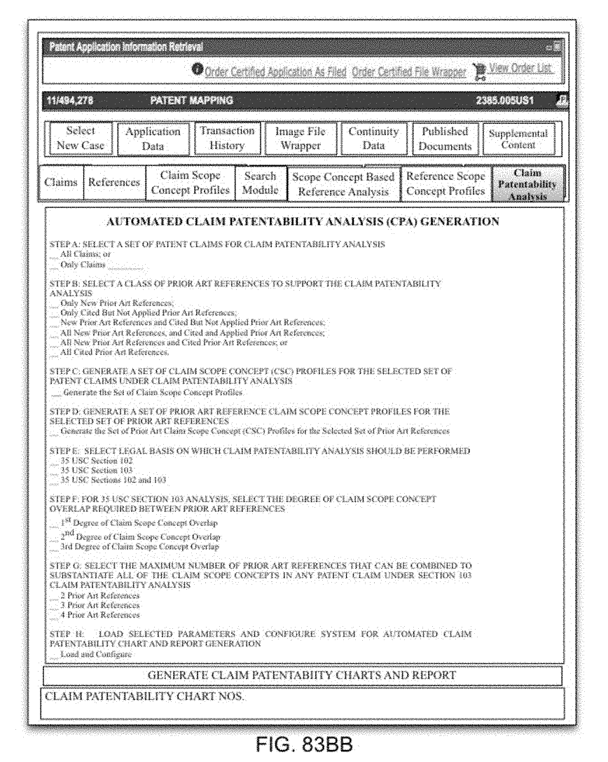

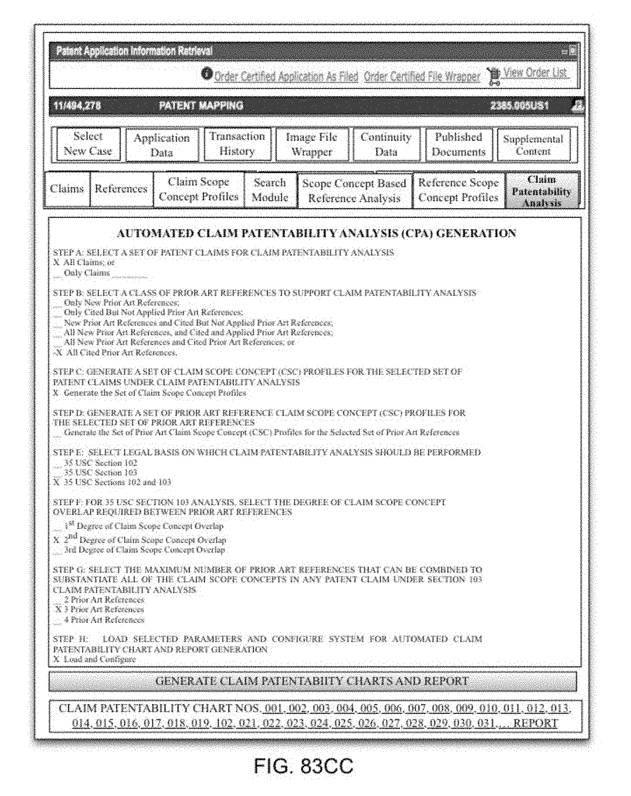

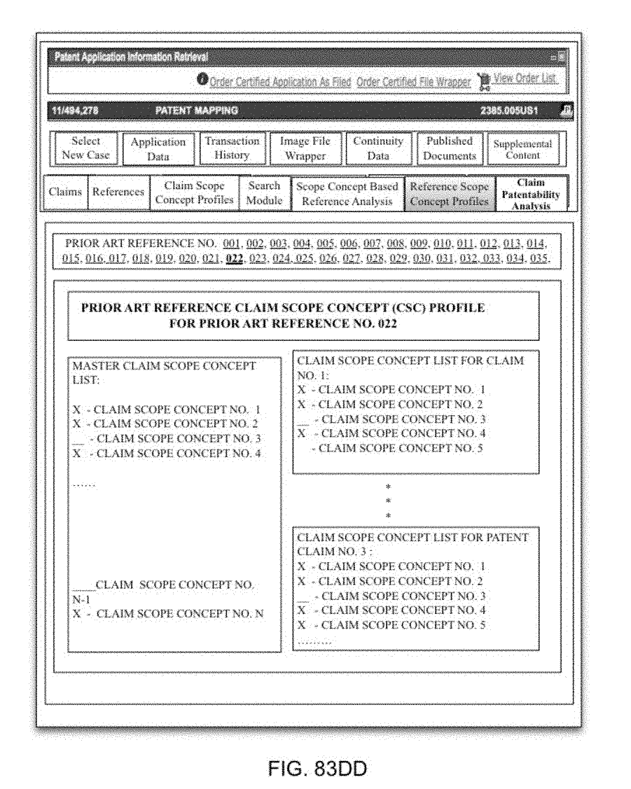

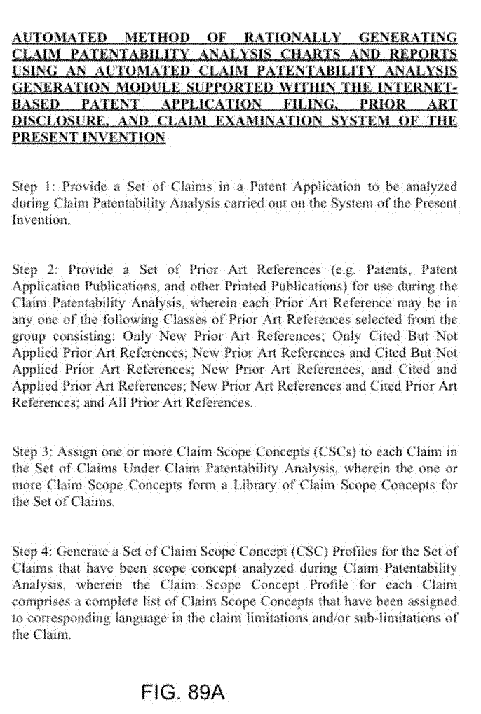

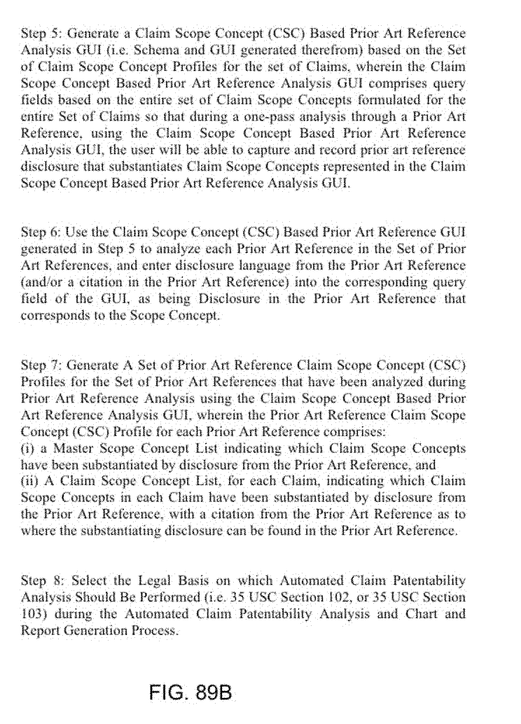

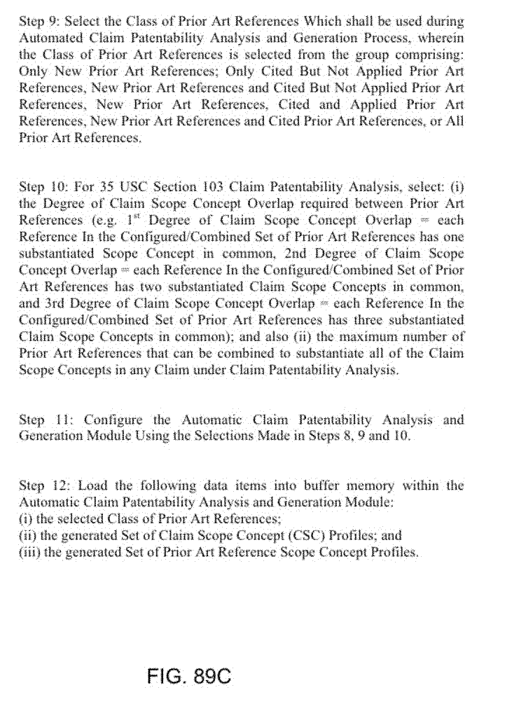

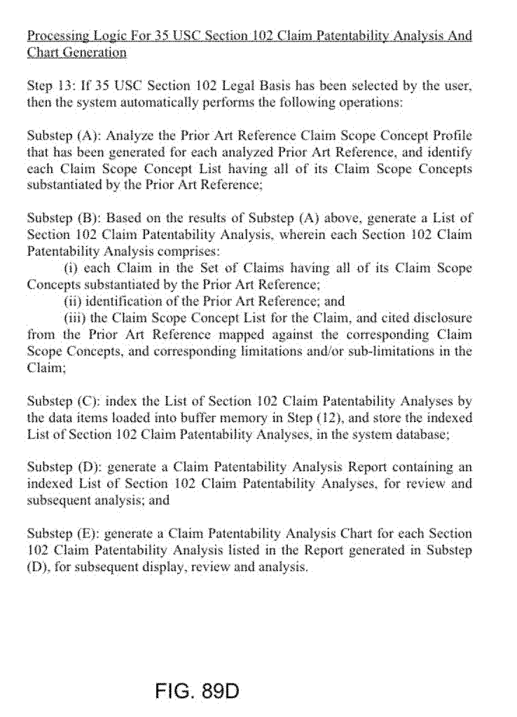

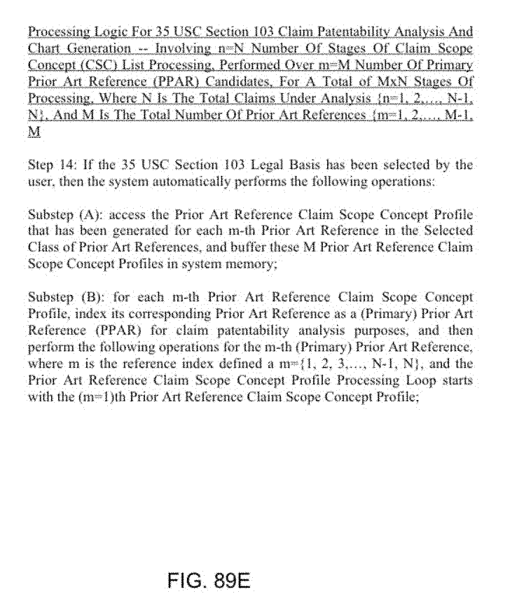

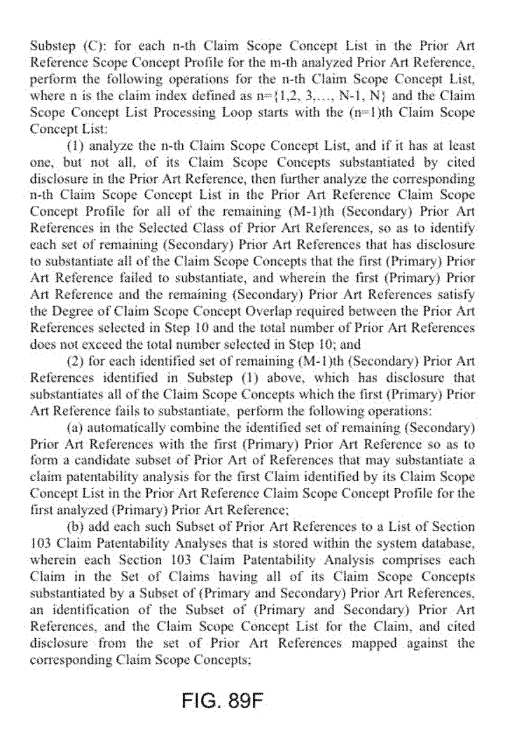

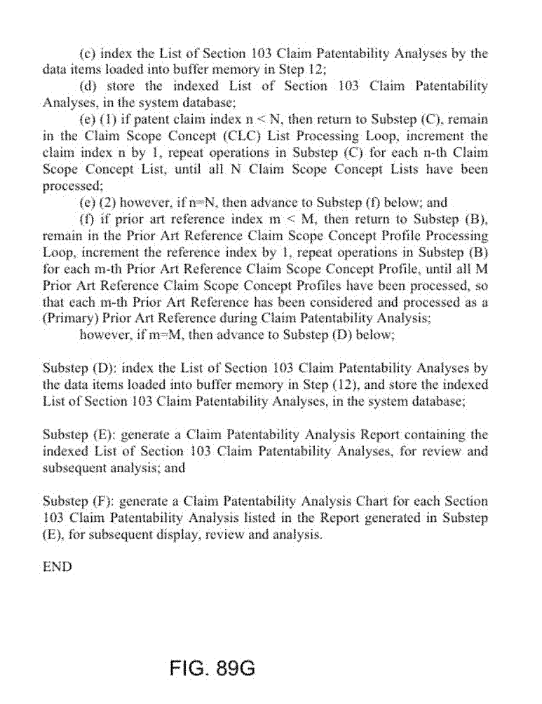

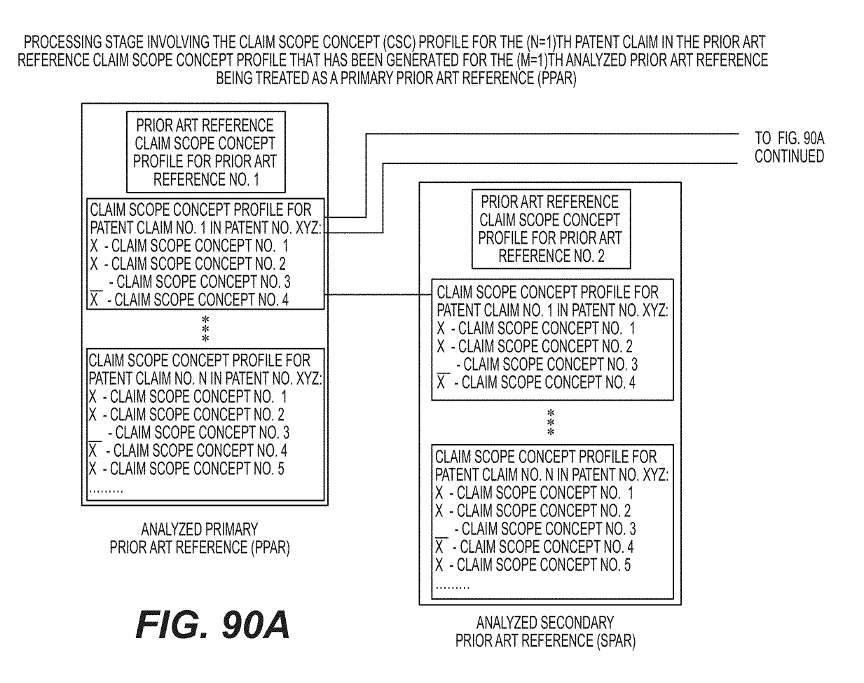

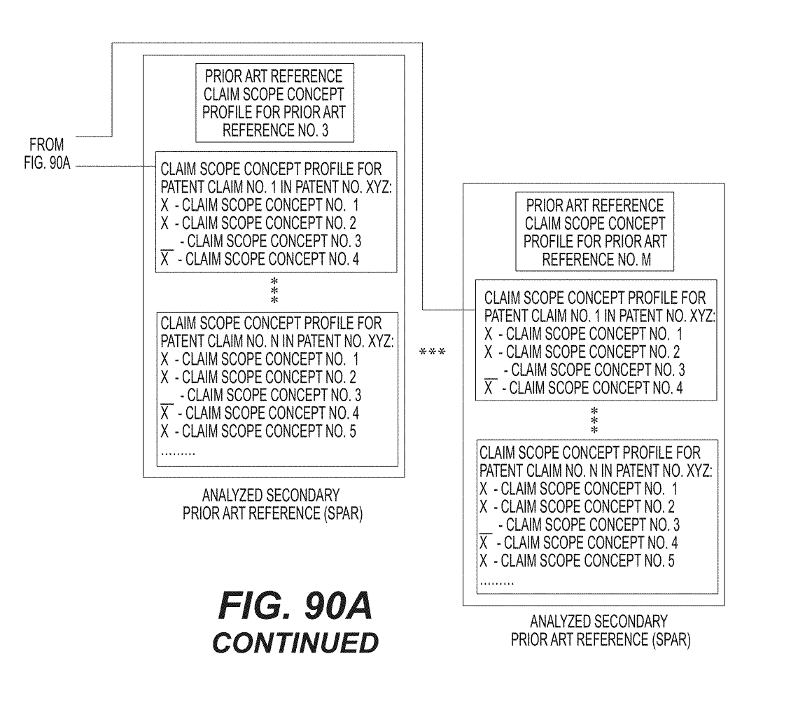

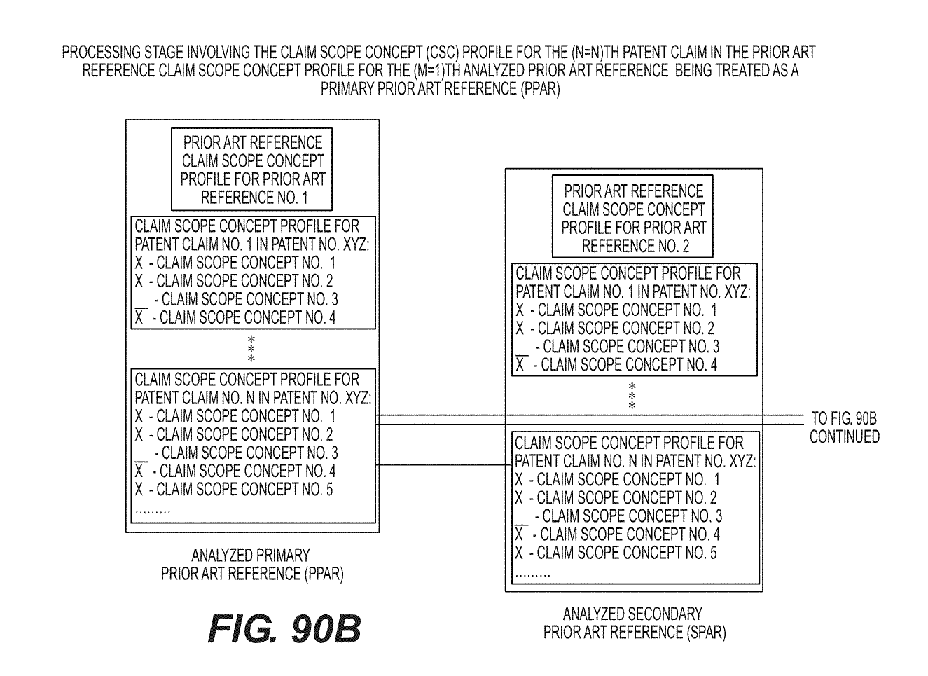

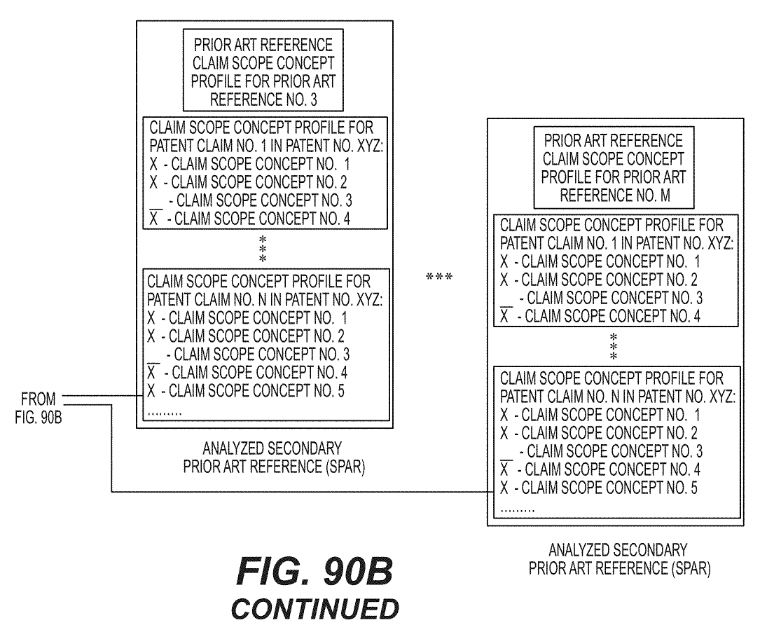

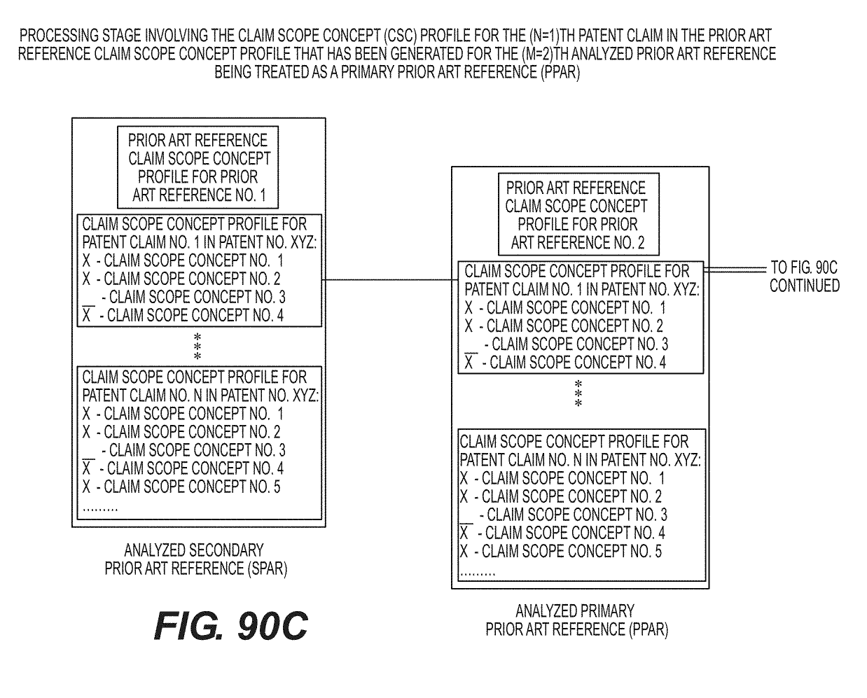

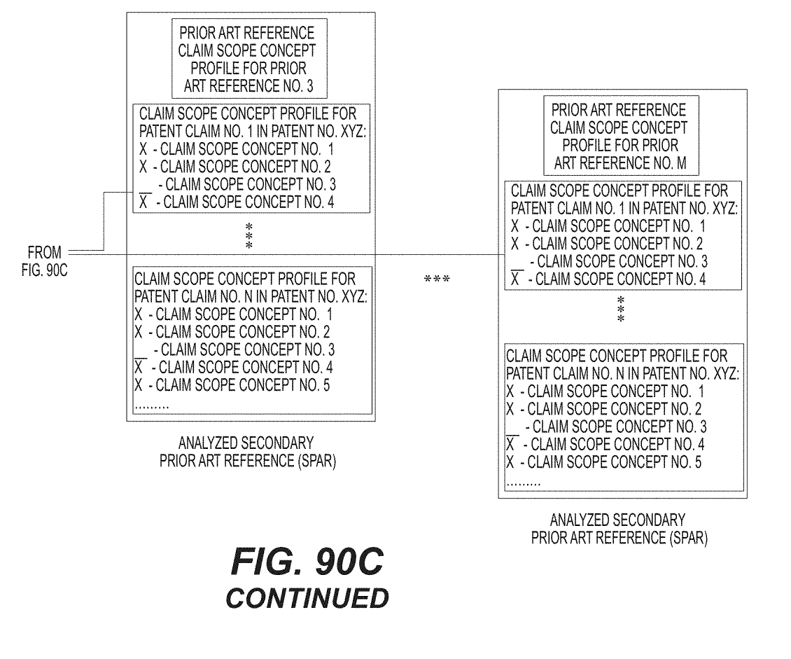

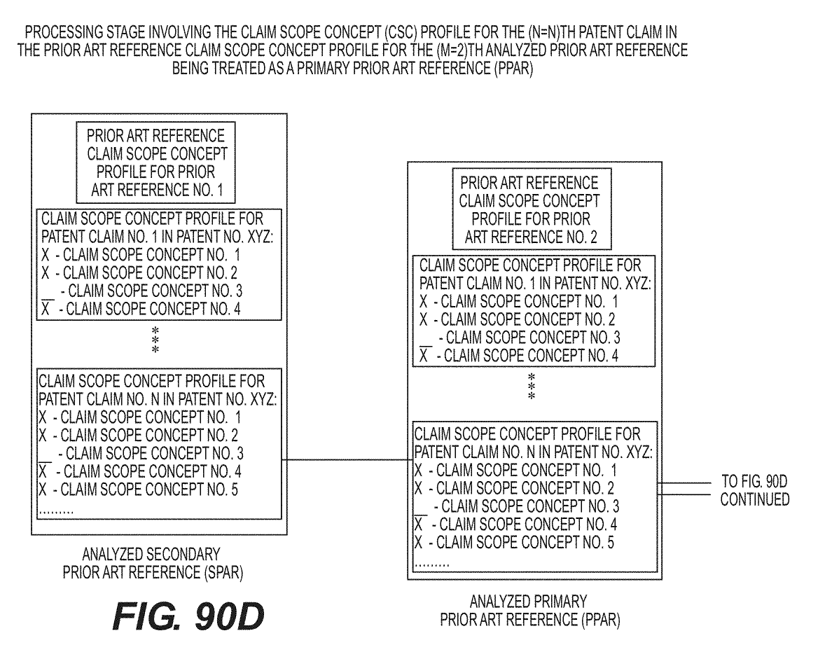

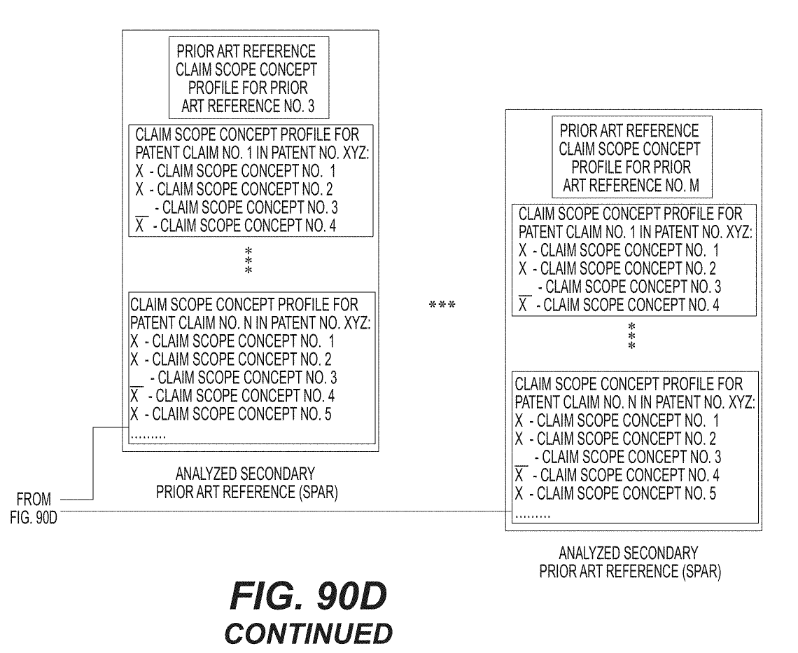

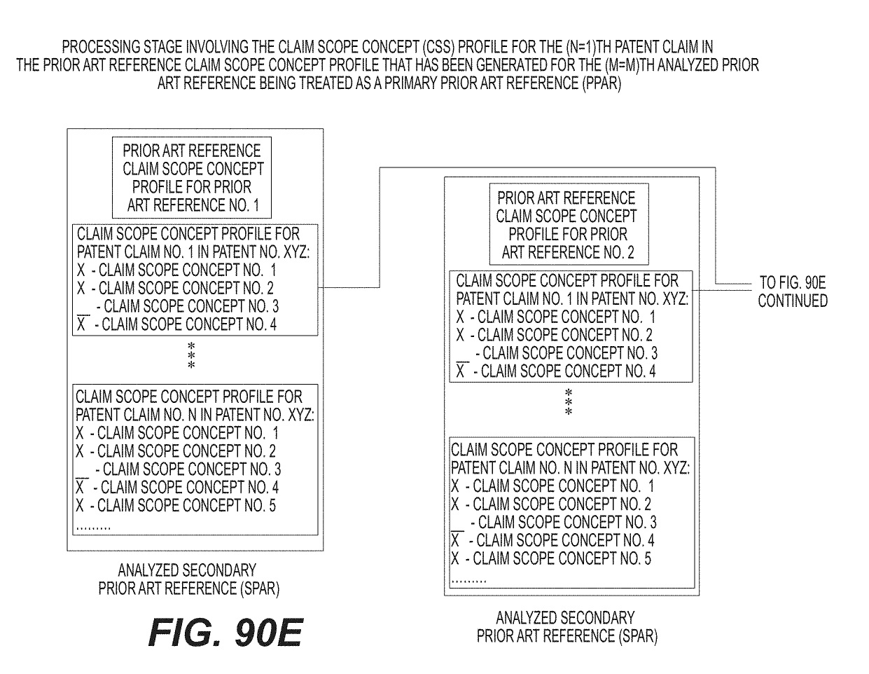

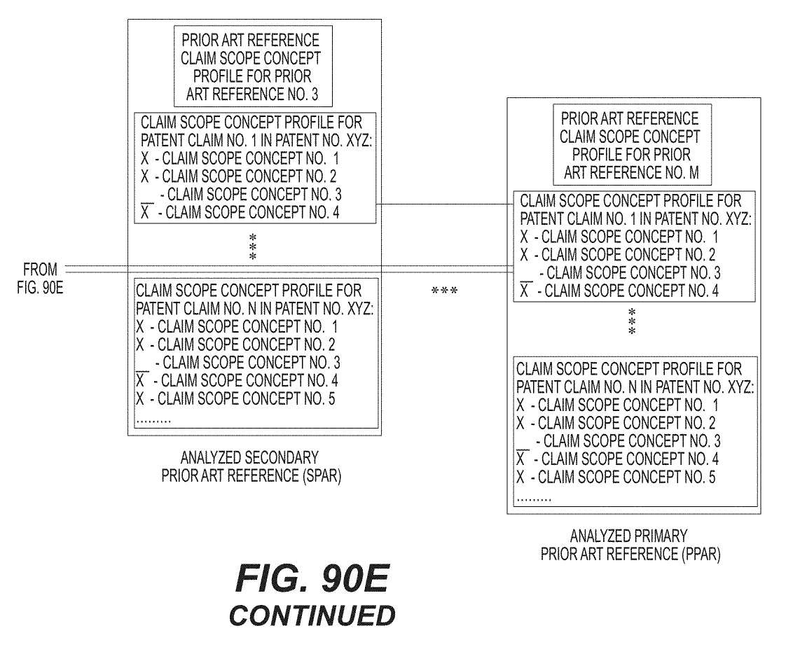

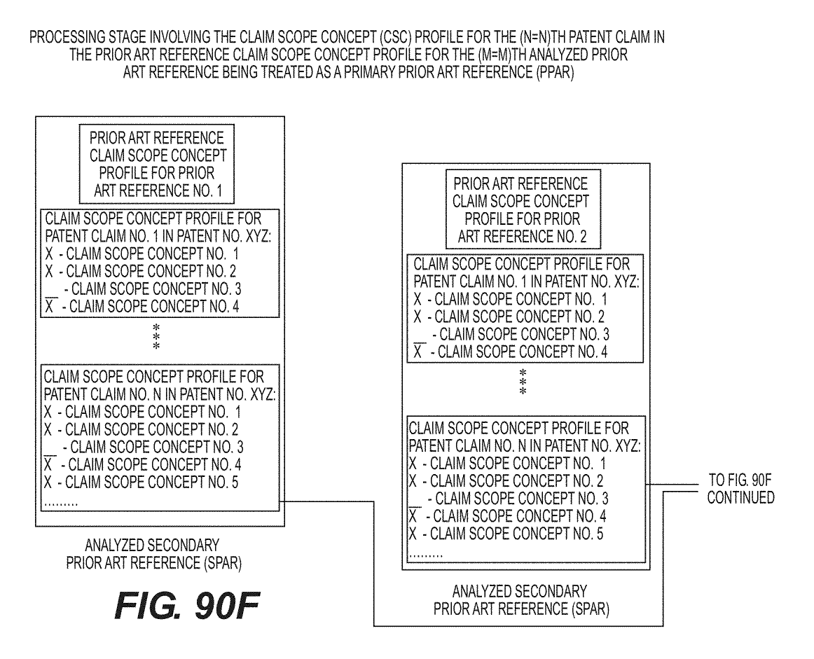

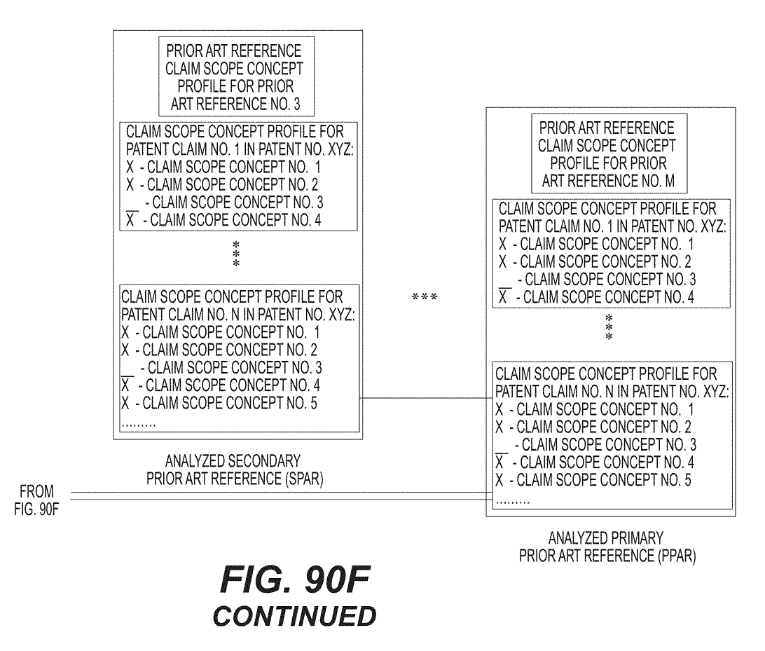

The method of automated claim patentability analysis generation and charting described in Step L of FIG. 81C, and supported by GUI screens shown in FIGS. 83N through 83Q, will be now described in greater technical below with reference the flow chart of FIGS. 89A through 89G and the schematic representations of FIGS. 89 through 90F.

As indicated in Step 1 of FIG. 89A, the Applicant/Owner or its Patent Attorney or Agent provides to the Internet-based system 200, a set of Claims in a patent application to be analyzed during claim patentability analysis carried out on the system.

As indicated in Step 2 of FIG. 89A, the Applicant/Owner or its patent attorney or agent provides to the Internet-based system of the present invention, set of prior art references (e.g. patents, patent application publications, and other printed publications) for use during the claim patentability analysis. Each prior art reference may be in any one of the following classes of prior art references selected from the group consisting: only new prior art references; only cited but not applied prior art references; new prior art references and cited but not applied prior art references; new prior art references, and cited and applied prior art references; new prior art references and cited prior art references; and all prior art references.

As indicated in Step 3 of FIG. 89A, using the GUI screens set forth in FIGS. 83B through 83G and 83I, the Applicant/Owner or its Patent Attorney or Agent assigns one or more Scope Concepts to each Claim in the set of claims under claim patentability analysis, wherein the one or more scope concepts form a Library of Scope Concepts for the set of Claims. This involves using the same innovative scope concept formation, linking assignment techniques previously described in greater detail hereinabove with reference to FIGS. 22P through 22T, first introduced in the patent prosecution history analysis mode of system operation (Mode 1), but applicable to all modes of patent claim analysis.

As indicated in Step 4 of FIG. 89A, the system automatically generates a set of Claim Scope Concept Profiles for the set of Claims that have been scope concept analyzed during Claim Patentability Analysis, wherein the Claim Scope Concept Profile for each Claim comprises a complete list of Scope Concepts that have been assigned to corresponding language in the claim limitations and/or sub-limitations of the Claim.

After assigning scope concepts to the Claims, Applicant/Owner or its Patent Attorney or Agent can use the GUI screen shown in FIG. 83J and methods supported by the system to generate Claim Scope Concept (CSC) based search vectors using the Search Vector Generation Module. In general, the set of Claim Scope Concept Profiles generated for the set of Claims under analysis will contain natural language directed to the Inventive Features of the invention being claimed, and as shown in FIG. 83J, the Search Vector Generation GUI allows the Applicant/Owner or its Patent Attorney or Agent to select which terms in the set of Claim Scope Concept Profiles, corresponding claim limitation language linked thereto and other search terms (e.g. relating to Primary Classes and Subclasses of technology classification scheme in the USPTO, and elsewhere, should be used to generate search vectors for prior art search efforts. Notably, the Applicant/Owner or its Patent Attorney or Agent has great flexibility in selecting search vector components, and this GUI and module should be designed to encourage the user to conduct prior art searches using scope concept based language and variants thereof that are likely to assist in the discovery of relevant prior art references in the field of invention to which the Claims pertain, that is, if such prior art references should exist for search-based discovery. Prior art references retrieved during prior art search efforts are easily uploaded to the Prior Art References Module shown in FIG. 83K, and from Module, can be simply copied and moved to the Prior Art Management Module supported by the Applicant/Owner or Patent Attorney's PCW.

As indicated in Step 5 of FIG. 89B, using the GUI screens set forth in FIG. 83L, the system generates a Scope Concept Based Prior Art Reference Analysis GUI based on the Set of Claim Scope Concept Profiles generated for the set of Claims. As shown in FIG. 83L, and also in greater schematic detail in FIG. 50D, the Scope Concept Based Prior Art Reference Analysis GUI comprises a set of query search fields based on the entire set of Scope Concepts formulated for the entire set of Claims so that, during a single-pass analysis through a Prior Art Reference, using the Scope Concept Based Prior Art Reference Analysis GUI, the user (preferably having expertise in the technical subject matter of the Claims) will be able to identify, recognize, capture and record prior art reference disclosure that is relevant to the subject matter of the Claims and substantiates Scope Concepts represented by the query search field in the Scope Concept Based Prior Art Reference Analysis GUI. The user can simply cut and paste the relevant prior art disclosure from the prior art reference, into the corresponding query search field, and also provide a citation on where the prior art disclosure can be found by a third-party subsequently seeking to find the prior art disclosure, elsewhere, at a different time and place. Alternatively, computer-based search tools can assist the user finding relevant text and/or graphical disclosure and inserting it into the corresponding query field. Also, each scope concept based query search field can also receive and store one or more graphical images, and even sound/audio files, as well as text-based natural language from diverse prior art sources.

The system database 15 should be designed to store all data formatted in a human natural languages known to mankind, and automatic natural language translation programs can be used to translate foreign language prior art disclosure specimens mapped and stored in corresponding scope-based query search fields in the Scope Concept Based Prior Art Reference Analysis GUI.

As Scope Concept Based Prior Art Reference Analysis GUI is an important search tool used during numerous modes of data analysis within the system of the present invention, great care should given to its design and implementation, so that scope-based analysis of prior art references becomes easy, efficient and enjoyable. In essence, the Scope Concept Based Prior Art Reference Analysis GUI functions as a scope-based filter helping its user to find relevant and material prior art disclosure in document-type references, so that such prior art disclosure can be automatically mapped and applied against corresponding claim limitation and/or sub-limitation language cited in the Claims under analysis, thereby allowing automated computing machinery to perform cognitive operations which were was once performed by human workers, without sacrificing human decision making and judgment where its application is essential in legal advice and counseling.

As indicated in Step 6 of FIG. 89B, and shown in FIG. 83L, the Applicant/Owner or Patent Attorney or Agent uses the Scope Concept Based Prior Art Reference Analysis GUI generated in Step 5 (using the Scope Concept Based Prior Art Reference Analysis Schema defined using the Set of Scope Concepts formulated for the Set of Patent Claims) to analyze each Prior Art Reference in the set of Prior Art References, and enter disclosure language from the Prior Art Reference (and/or a citation in the Prior Art Reference) into the corresponding query field of the GUI, as being prior art disclosure in the analyzed Prior Art Reference that corresponds to one or more Scope Concepts represented in the prior art reference analysis GUI.

As indicated in Step 7 of FIG. 89B, using the Scope Concept Based Prior Art Reference Analysis GUI set forth in FIG. 83L, the system generates a set of Prior Art Reference Scope Concept Profiles for the set of Prior Art References that have been analyzed during Prior Art Reference Analysis. The Prior Art Reference Scope Concept Profile for each Prior Art Reference comprises: (i) a Master Scope Concept List (for the set of Claims) indicating which Scope Concepts assigned to set of Claims have been substantiated by disclosure from the Prior Art Reference, and (ii) a Claim Scope Concept Profile, for each Claim, indicating which Scope Concepts in each Claim have been substantiated by disclosure from the Prior Art Reference, with a citation on the Prior Art Reference indicating precisely where the substantiating disclosure can be found in the Prior Art Reference.

As indicated in Step 8 of FIG. 89B, the Applicant/Owner or Patent Attorney or Agent selects the legal basis or grounds (i.e. 35 USC Section 102, or 35 USC Section 103), on which Automated Claim Patentability Analysis shall be performed during the Automated Claim Patentability Analysis and Chart and Report Generation Process supported by system 200.

As indicated in Step 9 of FIG. 89C, the Applicant/Owner or Patent Attorney or Agent selects the Class of Prior Art References which shall be used during the Automated Claim Patentability Analysis and Generation Process. As shown, the Class of Prior Art References is selected from the group comprising: Only New Prior Art References; Only Cited But Not Applied Prior Art References, New Prior Art References and Cited But Not Applied Prior Art References, New Prior Art References, Cited and Applied Prior Art References, New Prior Art References and Cited Prior Art References, or All Prior Art References.

As indicated in Step 10 of FIG. 89C, and illustrated in FIG. 83C, for 35 USC Section 103 Claim Patentability Analysis, the Applicant/Owner or Patent Attorney or Agent selects values for the following processing parameters: (i) the Degree of Scope Concept Overlap required between Prior Art References (e.g. 1^{st} Degree of Scope Concept Overlap=each Reference In the Configured/Combined Set of Prior Art References has one substantiated Scope Concept in common, 2nd Degree of Scope Concept Overlap=each Reference In the Configured/Combined Set of Prior Art References has two substantiated Scope Concepts in common, and 3rd Degree of Scope Concept Overlap=each Reference In the Configured/Combined Set of Prior Art References has three substantiated Scope Concepts in common); and also (ii) the maximum number of Prior Art References that can be combined to substantiate all of the Scope Concepts in any Claim under Claim Patentability Analysis.

As indicated in Step 11 of FIG. 89C, and illustrated in FIG. 83N, the Applicant/Owner or Patent Attorney or Agent automatically configures the Automatic Claim Patentability Analysis Module using the user selections made in Steps 8, 9 and 10.

As indicated in Step 12 of FIG. 89C, and illustrated in FIG. 83O, the Applicant/Owner or Patent Attorney or Agent commands the system to automatically load the following data items into buffer memory within the Automatic Claim Patentability Analysis and Generation Module: (i) the selected Class of Prior Art References; (ii) the generated Set of Claim Scope Concept Profiles; and (iii) the generated Set of Prior Art Reference Scope Concept Profiles.

In illustrative embodiment, system GUI screens supporting Steps 1, 2, 8, 9, 10, 11 and 12 above are selected in GUI screens, set forth in FIGS. 83N and 83O, corresponding to user Steps A, B, C, D, E, F, G, and H, described below:

### Step A: Select a Set of Patent Claims for Claim Patentability Analysis

All Claims; or

Only Claims ______

### Step B: Select a Class of Prior Art References to Support the Patent Claim Invalidity Analysis

Only New Prior Art References;

Only Cited But Not Applied Prior Art References;

New Prior Art References and Cited But Not Applied Prior Art References;

New Prior Art References, and Cited and Applied Prior Art References;

New Prior Art References and Cited Prior Art References; or

All Prior Art References.

### Step C: Generate a Set of Claim Scope Concept Profiles for the Selected Set of Patent Claims Under Patent Claim Invalidity Contention Analysis

Generate the Set of Claim Scope Concept Profiles

### Step D: Generate a Set of Prior Art Reference Claim Scope Concept Profiles for the Selected Set of Prior Art References

Generate the Set of Prior Art Reference Claim Scope Concept Profiles for the Selected Set of Prior Art References

Step E: Select Legal Basis on which Claim Patentability Analysis should be Performed

35 USC Section 102

35 USC Section 103

35 USC Sections 102 and 103

### Step F: For 35 USC Section 103 Claim Patentability Analysis, Select the Degree of Claim Scope Concept Overlap Required Between Prior Art References

1^{st} Degree of Claim Scope Concept Overlap

2^{nd} Degree of Claim Scope Concept Overlap

3rd Degree of Claim Scope Concept Overlap

Step G: Select the Maximum Number of Prior Art References that can be Combined to Substantiate all of the Claim Scope Concepts in any Patent Claim Under Section 103 Claim Patentability Analysis

2 Prior Art References

3 Prior Art References

4 Prior Art References

### Step H: Load Selected Parameters and Configure System for Automated Claim Patentability Analysis Report Generation

Load and Configure

### Processing Logic for 35 USC Section 102 Claim Patentability Analysis and Chart Generation

As indicated in Step 13 of FIG. 89D, if the 35 USC Section 102 legal basis has been selected by the Applicant/Owner or Patent Attorney or Agent, then the system 200 (i.e. using a programmed module) performs the following operations in an automated or automatic manner.

As indicated in Substep (A) of FIG. 89D, the system analyzes the Prior Art Reference Scope Concept Profile that has been generated for each analyzed Prior Art Reference, and identifies each Claim Scope Concept Profile having all of its Scope Concepts substantiated by the Prior Art Reference. This step is achieved by determining/confirming that the Prior Art Reference contains prior art disclosure that was mapped to a scope concept based search query in the corresponding Scope Concept Based Prior Art Reference Analysis GUI, which in turn, automatically populated the corresponding scope concept contained in the Prior Art Reference Scope Concept Profile.

As indicated in Substep (B) of FIG. 89D, based on the results of Substep (A) above, the system generates a List of Section 102 Claim Patentability Analysis, wherein each Section 102 Claim Patentability Analysis comprises:

(i) each Claim in the Set of Claims having all of its Scope Concepts substantiated by the Prior Art Reference;

(ii) identification of the Prior Art Reference; and

(iii) the Claim Scope Concept Profile for the Claim, and cited disclosure from the Prior Art Reference mapped against the corresponding Scope Concepts, and corresponding limitations and/or sub-limitations in the Claim.

As indicated in Substep (C) of FIG. 89D, the system indexes the List of Section 102 Claim Patentability Analyses by the data items loaded into buffer memory in Step (12), and stores the indexed List of Section 102 Claim Patentability Analyses, in the system database.

As indicated in Substep (D) of FIG. 89D, and illustrated in FIG. 83CC at the request of the Applicant/Owner or Patent Attorney or Agent, the system generates a Claim Patentability Analysis Report containing an indexed List of Section 102 Claim Patentability Analyses, for review and subsequent analysis.

As indicated in Substep (E) of FIG. 89D, and illustrated in FIG. 83CC at the request of the Applicant/Owner or Patent Attorney or Agent, the system generates a Claim Patentability Analysis Chart for each Section 102 Claim Patentability Analysis listed in the Report generated in Substep (D), for subsequent display, review and analysis.

### Processing Logic for 35 USC Section 103 Claim Patentability Analysis and Chart Generation

The Process involves n=N number of stages of Claim Scope Concept profile processing, performed over m=M number of Primary Prior Art Reference (PPAR) candidates, for a total of M×N stages of processing, where N is the total claims under analysis {n=1, 2, . . . , N−1, N}, and M is the total number of prior art references {m=1, 2, . . . , M−1, M}.

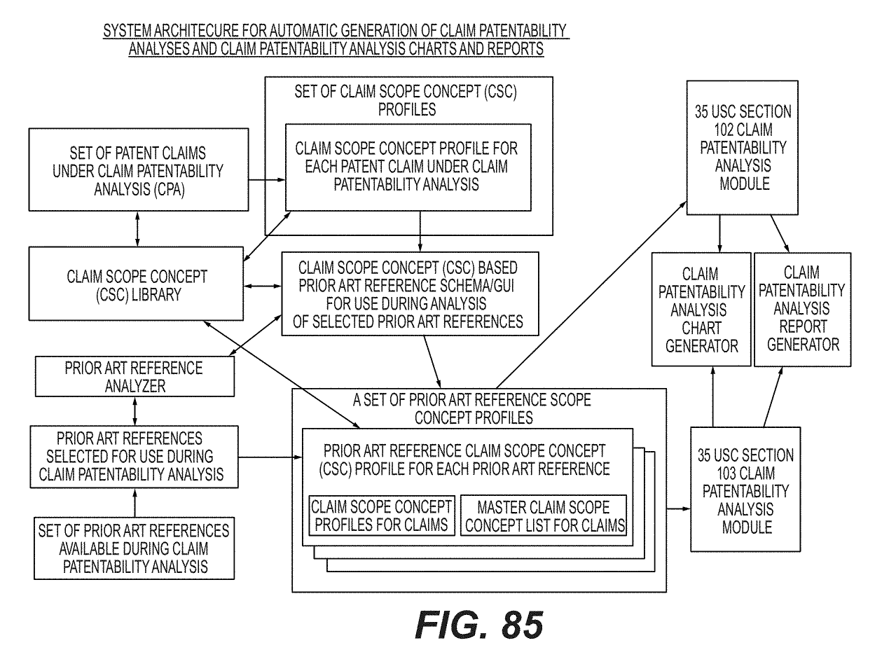

As indicated in Step 14 in FIG. 89D, and illustrated in FIG. 85, if the 35 USC Section 103 Legal Basis has been selected by the Applicant/Owner or Patent Attorney or Agent, then the system 200 performs the following operations in an automated or automatic manner.

As indicated in Substep (A) in FIG. 89D, the system accesses the Prior Art Reference Scope Concept Profile that has been generated for each m-th Prior Art Reference in the Selected Class of Prior Art References, and buffers these M Prior Art Reference Scope Concept Profiles in memory.

As indicated in Substep (B) in FIG. 89D, and illustrated in FIGS. 90A through 90F, for each m-th Prior Art Reference Scope Concept Profile, the system indexes its corresponding Prior Art Reference as a (Primary) Prior Art Reference (PPAR) for claim patentability analysis purposes, and then performs the following operations for the m-th (Primary) Prior Art Reference, where m is the reference index defined a m={1, 2, 3, . . . , N−1, N}, and the Prior Art Reference Scope Concept Profile Processing Loop starts with the (m=1)th Prior Art Reference Scope Concept Profile.

As indicated in Substep (C) in FIG. 89D, for each n-th Claim Scope Concept Profile in the Prior Art Reference Scope Concept Profile for the m-th analyzed Prior Art Reference, the system performs the following operations for the n-th Claim Scope Concept Profile, where n is the claim index defined as n={1, 2, 3, . . . , N−1, N} and the Claim Scope Concept Profile Processing Loop starts with the (n=1)th Claim Scope Concept Profile:

(1) analyze the n-th Claim Scope Concept Profile, and if it has at least one, but not all, of its Scope Concepts substantiated by cited disclosure in the Prior Art Reference, then further analyze the corresponding n-th Claim Scope Concept Profile in the Prior Art Reference Scope Concept Profile for all of the remaining (M−1)th (Secondary) Prior Art References in the Selected Class of Prior Art References, so as to identify each set of remaining (Secondary) Prior Art References that has disclosure to substantiate all of the Scope Concepts that the first (Primary) Prior Art Reference failed to substantiate, and wherein the first (Primary) Prior Art Reference and the remaining (Secondary) Prior Art References satisfy the Degree of Scope Concept Overlap required between the Prior Art References selected in Step 10 and the total number of Prior Art References does not exceed the total number selected in Step 10.

(2) for each identified set of remaining (M−1)th (Secondary) Prior Art References identified in Substep (1) above, which has disclosure that substantiates all of the Scope Concepts which the first (Primary) Prior Art Reference fails to substantiate, the system perform the following operations:

(a) automatically combines the identified set of remaining (Secondary) Prior Art References with the first (Primary) Prior Art Reference so as to form a candidate subset of Prior Art of References that may substantiate a claim patentability analysis for the first Claim identified by its Claim Scope Concept Profile in the Prior Art Reference Scope Concept Profile for the first analyzed (Primary) Prior Art Reference;

(b) adds each such Subset of Prior Art References to a List of Section 103 Claim Patentability Analyses that is stored within the system database, wherein each Section 103 Claim Patentability Analysis comprises each Claim in the Set of Claims having all of its Scope Concepts substantiated by a Subset of (Primary and Secondary) Prior Art References, an identification of the Subset of (Primary and Secondary) Prior Art References, and the Claim Scope Concept Profile for the Claim, and cited disclosure from the set of Prior Art References mapped against the corresponding Scope Concepts;

(c) indexes the List of Section 103 Claim Patentability Analyses by the data items loaded into buffer memory in Step 12;

(d) stores the indexed List of Section 103 Claim Patentability Analyses, in the system database;

(e) (1) if patent claim index n<N, then control returns to Substep (C), remains in the Claim Scope Concept Profile Processing Loop, increments the claim index n by 1, and repeats operations in Substep (C) for each n-th Claim Scope Concept Profile, until all N Claim Scope Concept Profiles have been processed;

(e) (2) however, if n=N, then advances to Substep (f) below; and

(f) if prior art reference index m<M, then control returns to Substep (B), remains in the Prior Art Reference Scope Concept Profile Processing Loop, increments the reference index by 1, and repeats operations in Substep (B) for each m-th Prior Art Reference Scope Concept Profile, until all M Prior Art Reference Scope Concept Profiles have been processed, so that each m-th Prior Art Reference has been considered and processed as a (Primary) Prior Art Reference during Claim Patentability Analysis;

however, if m=M, then the system advances to Substep (D) below.

As indicated in Substep (D) in FIG. 89D, the system indexes the List of Section 103 Claim Patentability Analyses by the data items loaded into buffer memory in Step (12), and store the indexed List of Section 103 Claim Patentability Analyses, in the system database.

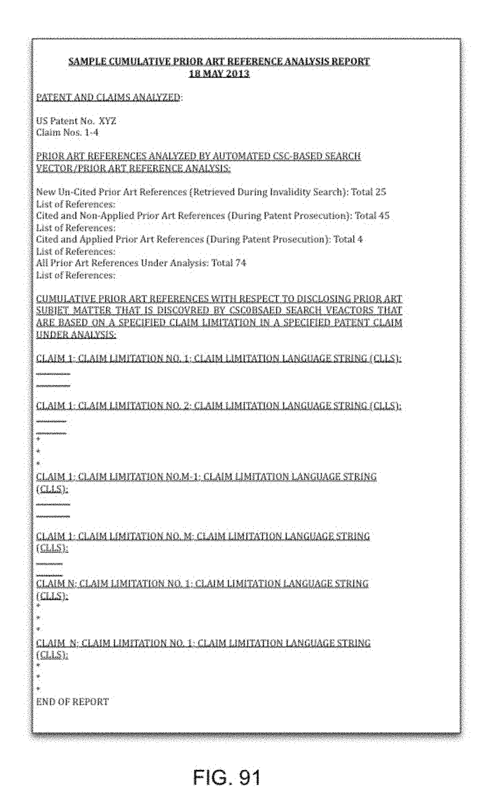

As indicated in Substep (E) in FIG. 89D, the system generates a Claim Patentability Analysis Report as shown in FIG. 91, containing the indexed List of Section 103 Claim Patentability Analyses, for review and subsequent analysis.

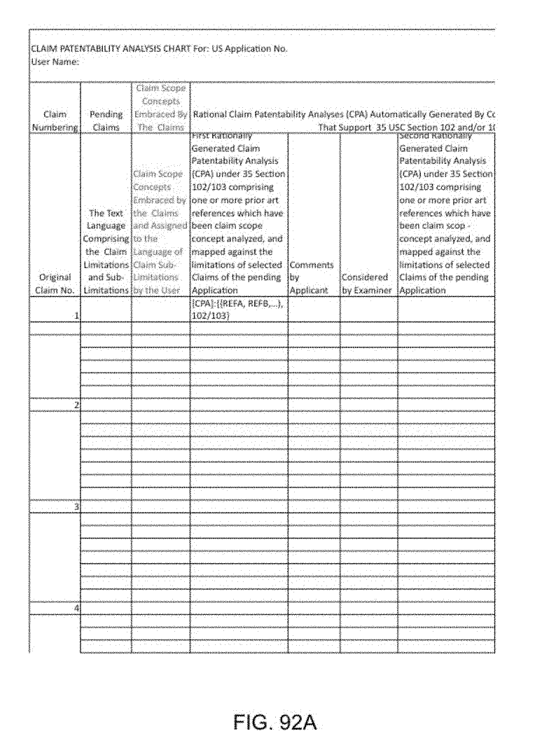

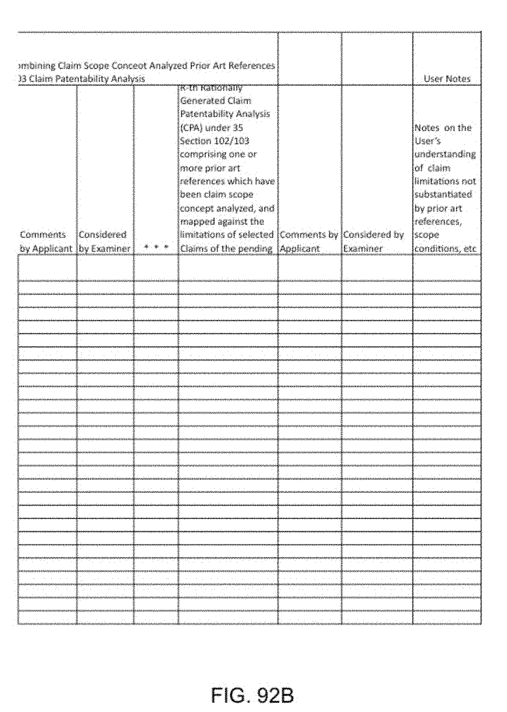

As indicated in Substep (F) in FIG. 89E, the system generates a Claim Patentability Analysis Chart for each Section 103 Claim Patentability Analysis listed in the Report generated in Substep (E), as shown in FIGS. 91A and 92B, for subsequent display, review and analysis.

As shown in FIGS. 92A and 92B, the claim patentability chart structure generated from the system 200 of the illustrative embodiment is realized as an XML-based spreadsheet file comprising a number of chart display fields, namely: (i) original claim numbering; (i) text language comprising the Claim Limitations and Sub-Limitations of each of the Claims; Rational Claim Patentability Analyses (CPA) automatically generated by combining Scope Concept Analyzed Prior Art References that support 35 USC Section 102 and/or 103 Claim Patentability Analysis including a plurality of Rationally Generated Claim Patentability Analyses (CPA) under 35 Section 102/103, each comprising one or more prior art references which have been scope concept analyzed, and mapped against the limitations of selected Claims of the pending Application; Comments by Applicant; Considered by Examiner; and Notes on the User's understanding of claim limitations not substantiated by prior art references, scope conditions, etc.

The automated methods of claim patentability analysis and chart generation described above have been disclosed in the context of an improved national patent application filing, examination and granting system. However, it is understood that such methods, including prior art reference management and automated IDS document generation services, can be readily integrated the Internet-based multi-mode patent claim analysis and charting system of the present invention, to provide additional modes of patent analysis, charting, prosecution support, and overall enhanced system functionality. Such an alternative embodiments will allow users to prepare draft patent claims, formulate claim scope concept profiles, conduct scope concept directed prior art searches, scope concept analyze prior art references, generate claim patent analysis charts, and disclose all of the above to the patent office during prosecution in order to expedite patent prosecution, secure higher quality patent grants, at lower costs, with increased levels of efficiency.

Graphical Illustration of the N Number of Claim Scope Concept Profile Processing Stages Carried Out within the M Number of Stages of Primary Prior Art Reference Processing, During the Automated Generation of Claim Patentability Analysis, and Related Summary Claim Patentability Analysis Reports, in Accordance with the Principles of the Present Invention

FIG. 90A illustrates a processing stage in the above process that is supported within the system of FIG. 200 and involves the Claim Scope Concept (CSC) List for the (n=1)th patent claim in the Prior Art Reference Claim Scope Concept Profile that has been generated for the (m=1)th analyzed prior art reference being considered as a Primary Prior Art Reference (PPAR).

FIG. 90B illustrates a processing stage in the above process that is supported within the system of FIG. 200 and involves the Claim Scope Concept (CSC) List for the (n=N)th patent claim in the Prior Art Reference Claim Scope Concept Profile for the (m=1)th analyzed prior art reference being considered as a Primary Prior Art Reference (PPAR).

FIG. 90C illustrates a processing stage in the above process that is supported within the system of FIG. 200 and involves the Claim Scope Concept (CSC) List for the (n=1)th patent claim in the Prior Art Reference Claim Scope Concept Profile that has been generated for the (m=2)th analyzed prior art reference being considered as a Primary Prior Art Reference (PPAR).

FIG. 90D illustrates a processing stage in the above process that is supported within the system of FIG. 200 and involves the Claim Scope Concept (CSC) List for the (n=N)th patent claim in the Prior Art Reference Claim Scope Concept Profile that has been generated for the (m=2)th analyzed prior art reference being considered as a Primary Prior Art Reference (PPAR).

FIG. 90E illustrates a processing stage in the above process that is supported within the system of FIG. 200 and involves the Claim Scope Concept (CSC) List for the (n=1)th patent claim in the Prior Art Reference Claim Scope Concept Profile for the (m=M)th analyzed prior art reference being considered as a Primary Prior Art Reference (PPAR).

FIG. 90F illustrates a processing stage in the above process that is supported within the system of FIG. 200 and involves the Claim Scope Concept (CSC) List for the (n=N)th patent claim in the Prior Art Reference Claim Scope Concept Profile that has been generated for the (m=M)th analyzed prior art reference being considered as a Primary Prior Art Reference (PPAR).

After performing N×M of these processing stages in an automated manner, the system will rationally generate up to N×M possible claim patentability analyses (but most likely significantly less each processing run) and corresponding claim patentability charts indicating computed combinations of prior art references which should contain prior art disclosure that is very likely to be relevant to the issue of patentability of the claim to which each generated chart corresponds. The user can then analyze these charts and quickly determine which ones are very relevant, somewhat relevant or irrelevant as the case may be. If the claims were properly scope concept analyzed and prior art references properly analyzed using the Claim Scope Concept (CSC) Based Prior Art Reference Analysis GUI, then it is expected that the results of the rational automated patentability analysis should be of high quality, and of great value to the analysis of the claims before the user/analyzer.

FIG. 91 shows a sample claim patentability analysis report generated by the system 200 of the present invention. As shown, this sample report contains the following information:

### SAMPLE CLAIM PATENTABILITY ANALYSIS REPORT

### START OF REPORT

### PATENT AND CLAIMS ANALYZED:

US Patent No. XYZ

### Claim Nos. 1-4

### PRIOR ART REFERENCES ANALYZED:

### New Un-Cited Prior Art References (Retrieved During Invalidity Search): Total 25

### List of References:

### Cited and Non-Applied Prior Art References (During Patent Prosecution): Total 45

### List of References:

### Cited and Applied Prior Art References (During Patent Prosecution): Total 4

### List of References:

### All Prior Art References Under Analysis: Total 74

### List of References:

### RATIONAL CLAIM PATENTABILITY ANALYSIS GENERATED AGAINST CLAIM 1

### Under 35 USC Section 102:

### Based on New Un-Cited Prior Art References: Total 2

### Using Cited and Non-Applied Prior Art References: Total 0

### Using Cited and Applied Prior Art References: Total 0

### Using All Prior Art References: Total 2

### Under 35 USC Section 103:

### Maximum Number of Prior Art References That Can Be Combined: Total 3 Based on

### New Un-Cited Prior Art References:

With 1^{st} Degree of claim Scope Concept Overlap: Total 30
With 2nd Degree of claim Scope Concept Overlap: Total 20
With 3rd Degree of claim Scope Concept Overlap: Total 10

### Under 35 USC Section 103:

### Maximum Number of Prior Art References That Can Be Combined: Total 3 Based on

### Cited and Non-Applied Prior Art References:

With 1^{st} Degree of claim Scope Concept Overlap: Total 12
With 2nd Degree of claim Scope Concept Overlap: Total 8
With 3rd Degree of claim Scope Concept Overlap: Total 4

### Under 35 USC Section 103:

### Maximum Number of Prior Art References That Can Be Combined: Total 3 Based on

### New and Cited and Applied Prior Art References:

With 1^{st} Degree of claim Scope Concept Overlap: Total 35
With 2nd Degree of claim Scope Concept Overlap: Total 25
With 3rd Degree of claim Scope Concept Overlap: Total 15
*

### END OF REPORT

The above-described Internet-based platform for patent claim presentation, examination and analysis methods should be of great benefit to Applicant/Owners, their patent attorneys and agents, as well as patent examiners, during all phases of patent claim prosecution. It should help Applicant/Owners prior to filing patent claims with a national patent office, by (i) providing a more efficient and transparent way of analyzing, searching and charting a set of draft patent claims, against prior art references cited/disclosed in a patent application, and (ii) enabling a more efficient and effective way of drafting, presenting and securing allowance of patent claims, against a robust set of disclosed prior art references that have been scope concept charted against the allowed patent claims in the allowed patent application. This improved method of and system for examining the patent claims in a national patent office, and documenting the same during the patent prosecution history, should provide greater transparency and more accurate patent claim scope resolution in the interests of inventors, patent owners and the general public alike.

### Alternative Embodiment of the Claim Scope Concept (CSC) Based Markup Language (CSCML) Model and Claim and Prior Art Reference Document Processing Method and Apparatus of the Present Invention

FIG. 93 shows another illustrative embodiment of the novel claim Scope Concept Based Markup Language (CSCML) model of a patent claim expressed in natural language, and setting forth the meets and boundaries (i.e. the scopes and limits) of patent protection to be afforded to the invention covered by the patent claim. As illustrated in this CSCML Model, each patent claim is composed of a plurality of claim limitation language strings (CLLS), wherein during the markup process, the following process is performed: (i) each claim limitation language string (CLLS) is assigned a claim limitation identifier or index (CLID); (ii) a Scope Concept Phrase (SCP) composed of a set of words (W1, . . . WN) describing the Scope Concept encompassed by the claim Limitation Language String (CLLS) is assigned to the CLLS; and (iii) a claim Scope Concept Structure Identifier (CSCSID) is assigned to the CLLS, to identify the entire CSC data structure, in accordance with the principles of the present invention.

As shown in the CSCML model of FIG. 93, the set of claim limitation language strings (CLLS) are strung together like beads on a string so as to form a complete closed ring structure, to suggest the encompassing of n-dimensional linguistic space by the words and phrases used to create the patent claim, where n is the number of words (i.e. lexical units) used to create the patent claim, and indicates the total number of degrees of freedom that the patent claim have, and the limits of which need to be ascertained (ultimately from the patent prosecution history) to properly construe (i.e. interpret) the scope and boundaries of patent protection afforded by the patent claim. In accordance with principles of US Patent Law, each indexed claim limitation language string (CLLS), as well as every linguistic unit (e.g. word and phrase) expressed therein, contributes to the scope and boundaries of patent protection to be afforded by the claim, if and when allowed in view of a set of considered prior art references. The CSCML model of the present invention respects this principle, and provides a mechanism for marking-up the claim limitation language strings (CLLS) of any patent claim and carrying (i) Inventive Feature Phrases (IFP) reflected in the language of the claim limitations, and (ii) other items of meta-data used to support various document generation and processing operations developed and deployed around the CSCML model of the present invention.

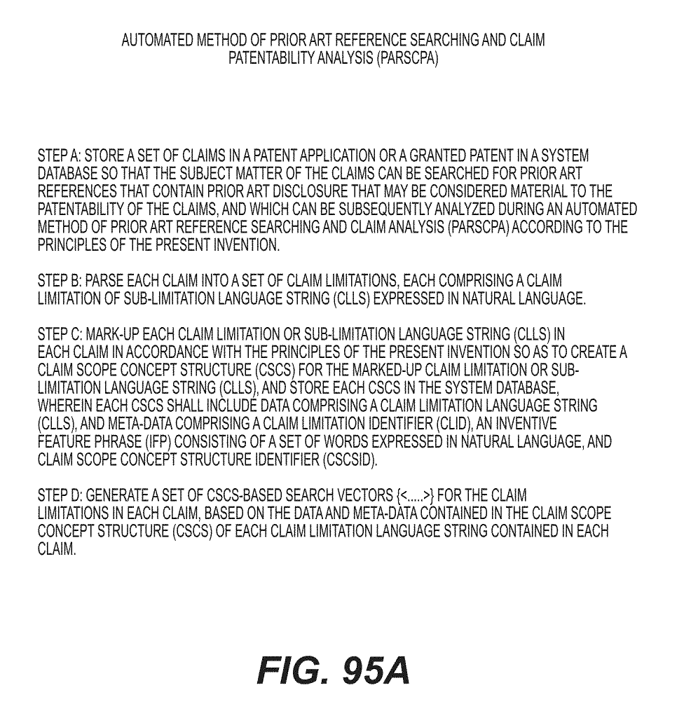

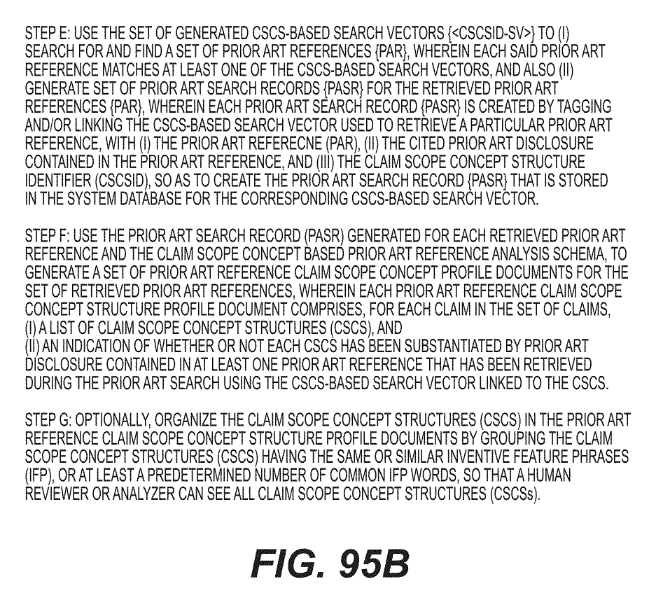

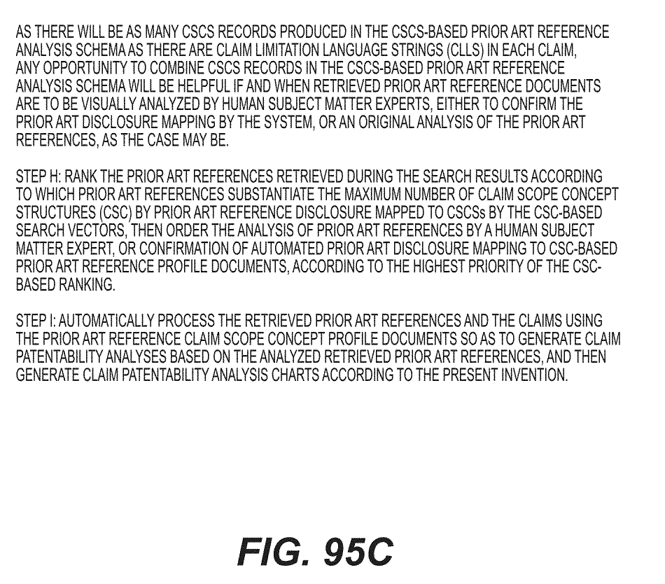

FIG. 94 shows a system architecture that can be implemented in the system of FIG. 5, 72, or 76 or other suitable system or network, capable of supporting the automated (i.e. computer-assisted) method of prior art searching, claim patentability analysis (PARSCPA) and cumulative prior art reference analysis, described in FIGS. 95A through 95C, employing the CCSCML model of FIG. 93 described above.

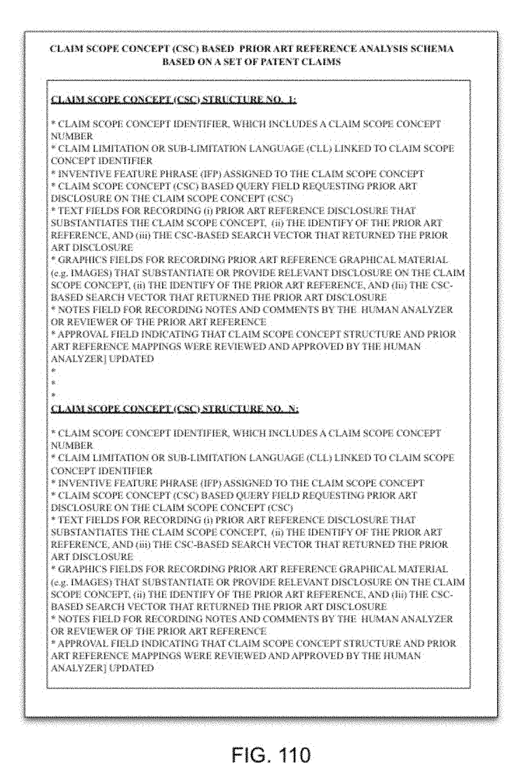

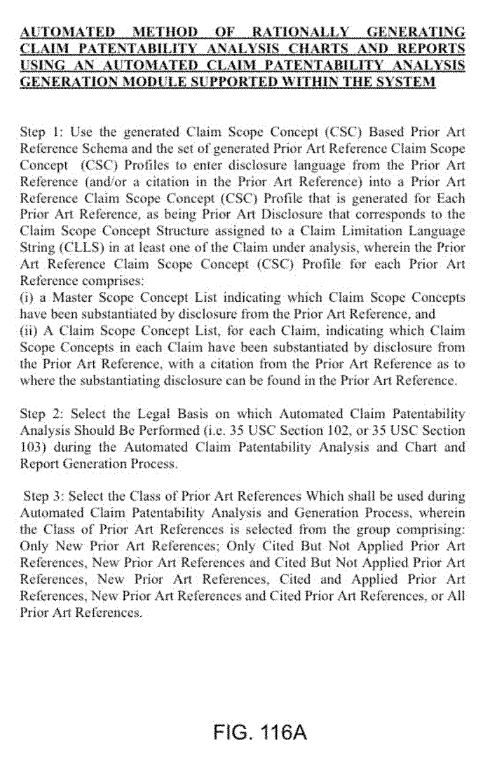

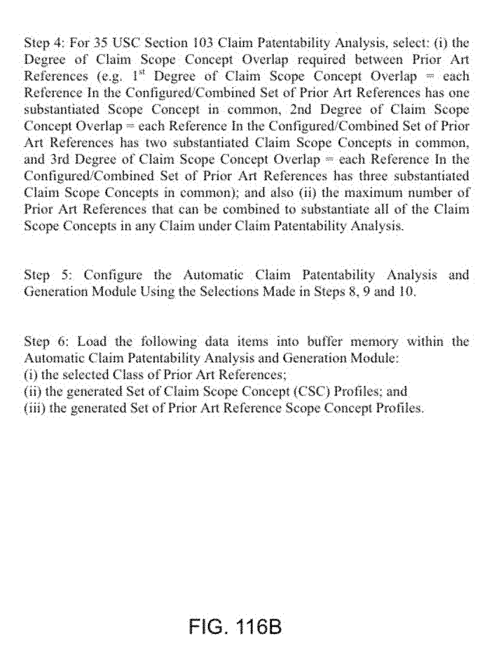

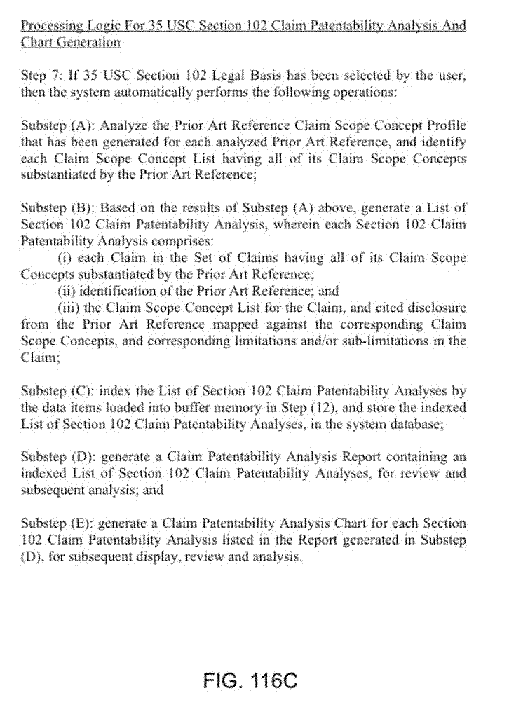

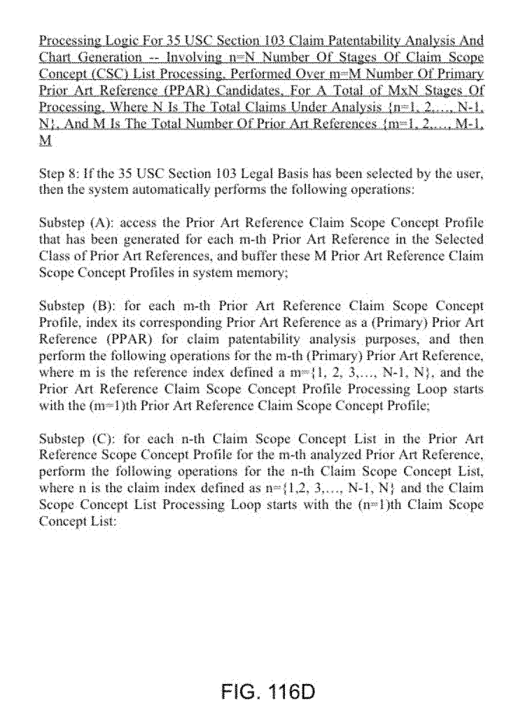

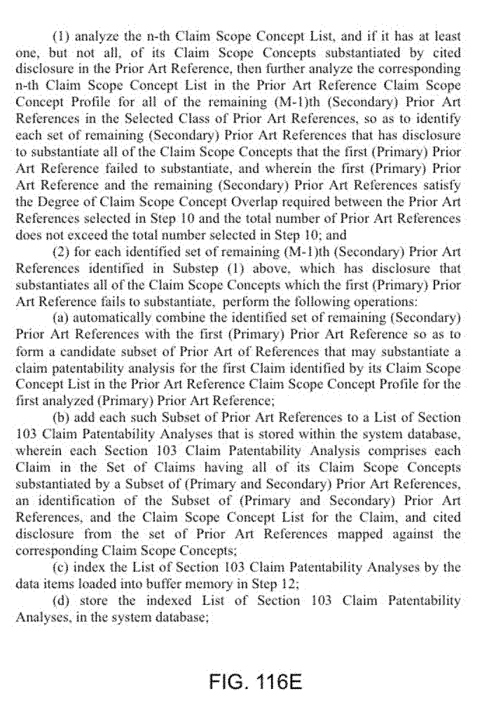

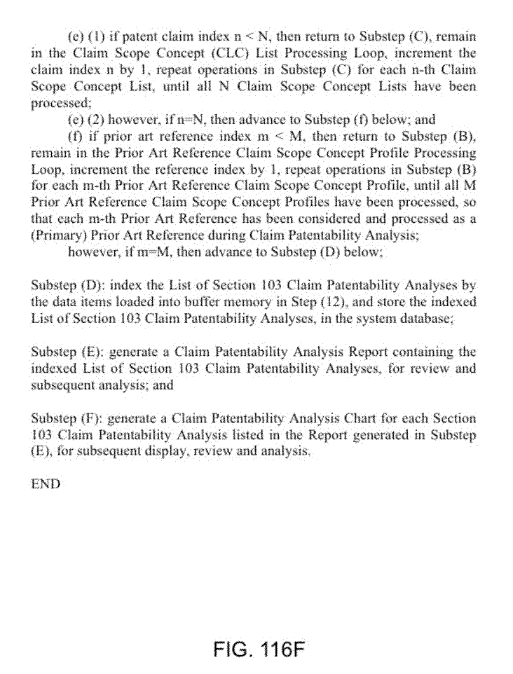

Patent claims under analysis are the input to this architecture system, and may come from at least two different sources, namely: from granted patents with patent claims; and/or from pending patent applications with pending patent claims. As shown in FIG. 94, a parsing module (e.g. algorithm) is used to automatically parse the patent claims into claim limitation language strings (CLLS), typically using punctuation marks as guides to parsing boundaries. The parsed claim limitation language strings are assigned claim Scope Concepts (CSC) as described hereinabove. This process is continued until a Set Of claim Scope Concepts is formed for the Set Of Patent claims under analysis. Then two paths of processing continue. Along the first path, the set of claim scope concepts for the patents claims under analysis are used to generate a claim Scope Concept (CSC) Based Prior Art Reference Analysis Schema (and GUI), and then this Schema (and GUI) are provided to an automated prior art reference analyzer. Along the second path, a claim Scope Concept (CSC) Based Search Vector Profile is generated for each patent claim under analysis, and then a Master Set of claim Scope Concept (CSC) Based Search Vector Profiles are generated for the set of pending patent claims under analysis. A set of CSC-based Search Vectors are generated from the Master Set of claim Scope Concept (CSC) Based Search Vector Profiles, and then supplied to the Search Engines which include patent and technical databases covering patents and technology around the world, in different countries and languages, with language translators where and as necessary, in a matter known in the language translation art. The Prior Art Search Engines deliver discovered prior art references containing prior art disclosure (e.g. searchable text and/or searchable graphics and/or images) specified by CSC-Based Search Vectors. Any given discovered prior art reference may contain prior art disclosure that is relevant to one or more or all of the claim limitation language strings (CLLS) of one or more claims under analysis. Each discovered Prior Art Reference is then tagged with the CSC-based Search Vector that discovered the Prior Art Reference during the prior art search. The Retrieved prior art references tagged with the CSC-based search vectors are then provided to the automated prior art reference analyzer, operating accordance to the CSC-based Prior Art Reference Analysis Schema that was generated for the set of patent claims under analysis. The automated prior art reference analyzer processes (i) each CSC-based prior art reference (i.e. searchable document) tagged with the CSC-based search vectors that discovered the prior art reference during search, and (ii) the CSC-based Prior Art Reference Analysis Schema, described in FIG. 110, so as to generate a prior art reference CSC-based profile document shown in FIG. 121, for each prior art reference retrieved during the search. As shown in FIG. 94, a claim patentability analysis is automatically generated as described in FIGS. 116A through 116F, and claim patentability analysis charts are then generated from the prior analysis, for review and editing by human users.

As shown in FIG. 95A through 95D, the automated process/method of the present invention, for prior art searching and claim patentability analysis (PARSCPA) using the system shown in FIG. 95A, comprises the performance of a number steps which will be described below.

### Automated Process for Prior Art Reference Searching and Claim Patentability Analysis (PARSCPA)

As indicated in STEP A of FIG. 95A, the process involves storing a set of claims in a Patent Application or a granted patent in a system database so that the subject matter of the claims can be searched for prior art references that contain prior art disclosure that may be considered material to the patentability of the claims, and which can be subsequently analyzed during process of the present invention.

As indicated in STEP B of FIG. 95A, the process involves parsing each claim into a set of claim Limitations, where each parsed claim comprises a claim Limitation or Sub-Limitation Language String (CLLS) expressed in natural language.

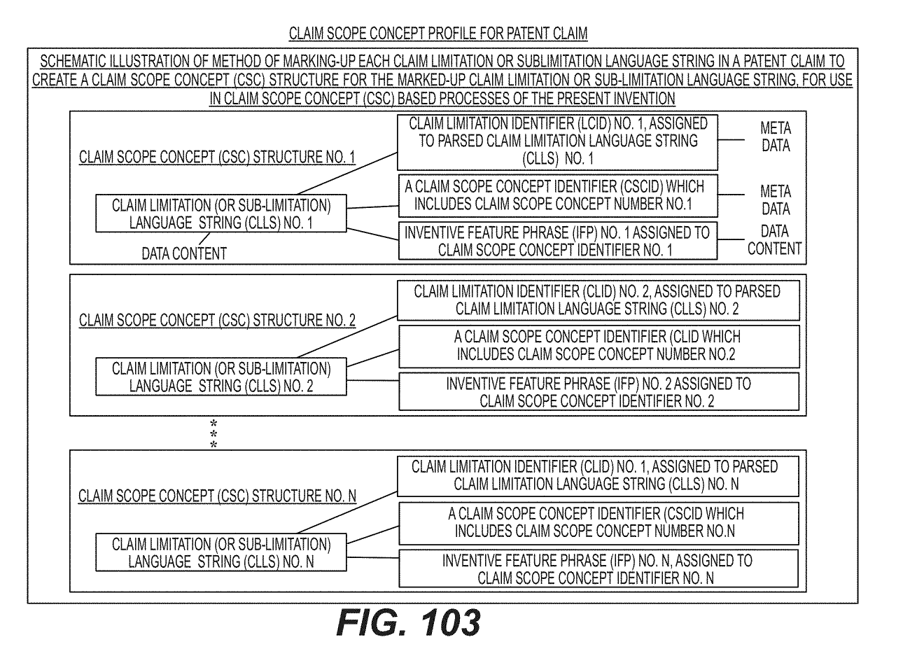

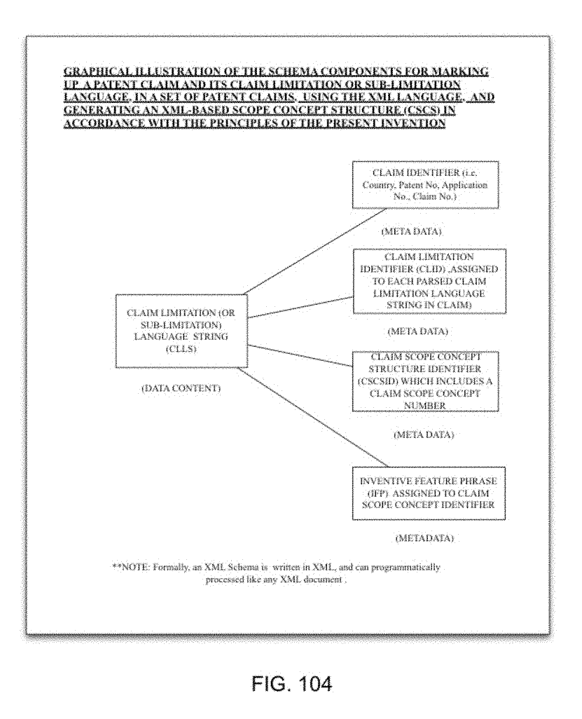

As indicated in STEP C of FIG. 95A, the process involves marking-up each claim Limitation or Sub-Limitation Language String (CLLS) in each claim in accordance with the principles of the present invention so as to create a claim Scope Concept Structure (CSCS) for the marked-up claim Limitation Or Sub-Limitation Language String (CLLS), and store each CSCS in the system database, wherein each CSCS shall include data comprising a claim Limitation Language String (CLLS), and meta-data comprising a claim Limitation Identifier (CLID), an Inventive Feature Phrase (IFP) consisting of a set of words expressed in natural language, and claim Scope Concept Structure Identifier (CSCSID). This step of the process is illustrated in FIG. 96, wherein each claim limitation or sub-limitation language string (CLLS) in a patent claim is marked up according to the CSCSML Model of FIG. 93, to create a claim scope concept structure (CSCS) for the marked-up claim limitation or sub-limitation language string (CLLS). FIG. 103 illustrates the method of marking-up each claim limitation or sub-limitation language string (CLLS) in a patent claim to create a claim Scope Concept Structure (CSCS) for the marked-up claim limitation or sub-limitation language string (CLLS), for use in claim scope concept (CSC) based processes of the present invention. FIG. 104 illustrates the schema components used to mark up a patent claim and its claim limitation or sub-limitation language (CLLS), in a set of patent claims using, for example, the xml language, and generating an XML-based claim Scope Concept Structure (CSCS) in accordance with the principles of the present invention.

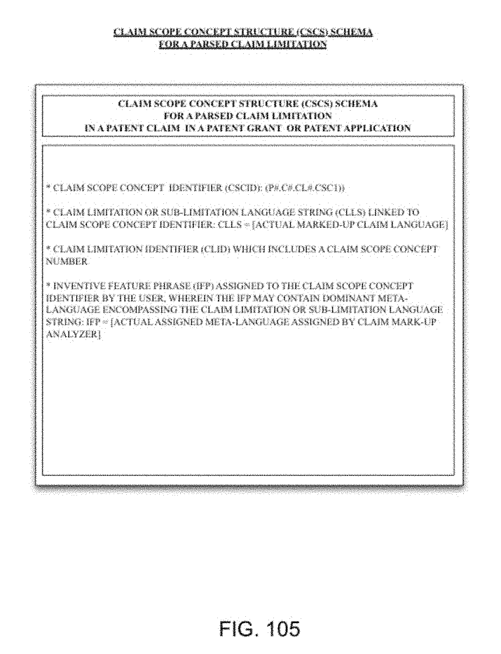

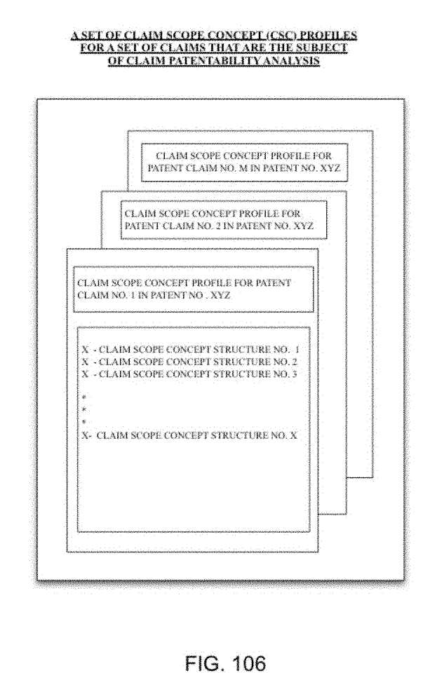

FIG. 105 illustrates the claim Scope Concept Structure (CSCS) schema for a parsed claim limitation in a patent claim in a patent grant or patent application, wherein, consistent with the CSCML process of FIG. 93, the CSCS schema comprises (i) actual marked-up data associated with a claim Limitation Or Sub-Limitation Language String (CLLS), (ii) meta-data associated with a claim Limitation Identifier (CLID) assigned and linked to the parsed claim Limitation Language String (CLLS), (iii) meta data associated with a claim Scope Concept Structure (CSCS) identifier linked to the claim Limitation Identifier, including a claim Scope Concept (CSC) Number, and (iv) an Inventive Feature Phrase (IFP={W−1, . . . W−M}) linked to the claim Limitation Identifier, and assigned by the user, wherein the IFP may contain dominant meta-language encompassing the claim Limitation Or Sub-Limitation Language String (CLLS). FIG. 106 illustrates a set of claim Scope Concept (CSC) Profiles, for a set of claims that are the subject of a claim patentability analysis.

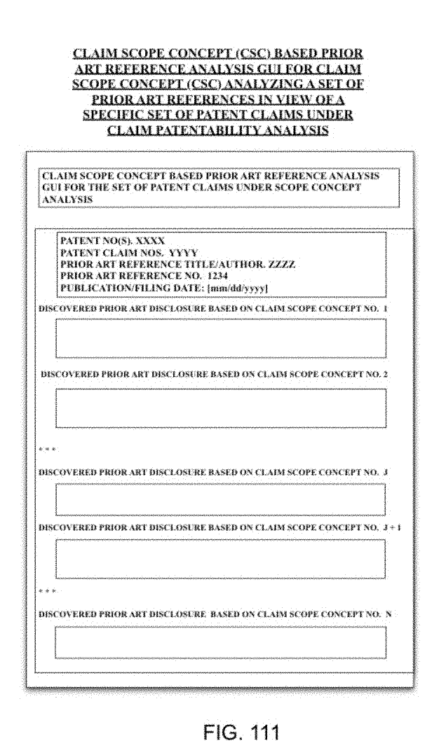

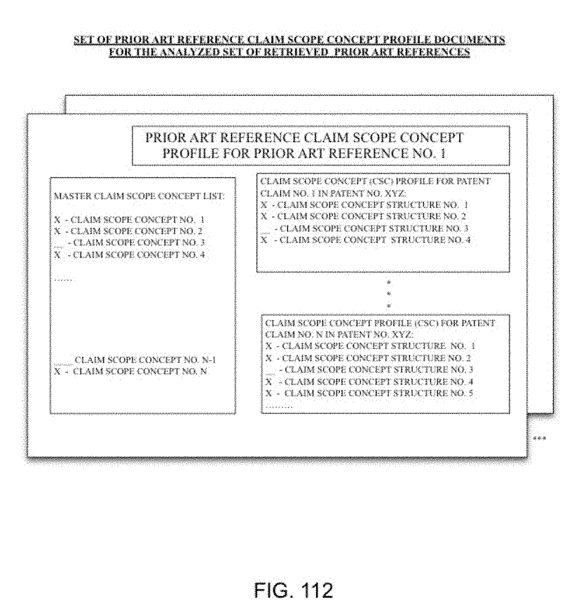

As shown in FIG. 110, a claim Scope Concept (CSC) Based Prior Art Reference Analysis Schema is generated, based on a Set of Patent claims under analysis, and organized by claim Scope Concept (CSC) Structure. FIG. 111 illustrates a claim Scope Concept (CSC) Based Prior Art Reference Analysis GUI that might be generated from a schema, such as for example as shown in FIG. 110, for use in claim scope concept (CSC) analyzing a set of retrieved prior art references in view of a specific set of patent claims under claim patentability analysis. FIG. 112 illustrates a set of Prior Art Reference claim Scope Concept (CSC) Profile documents that are generated by the system, after a set of retrieved prior art references has been analyzed, as will be described in greater detail below.

As indicated in STEP D of FIG. 95A, the process involves generating a set of CSCS-based search vectors {< . . . >} for the claim Limitations in each claim, based on the data and meta-data contained in the claim Scope Concept Structure (CSCS) of each claim Limitation Language String contained in each claim. This step of the process is illustrated in FIG. 97, wherein a CSC-based search vector (CSC-SV) is generated from the data and meta-data contained in the claim scope concept structure (CSCS) of each claim limitation language string of a claim being marked-up using CSCSML.

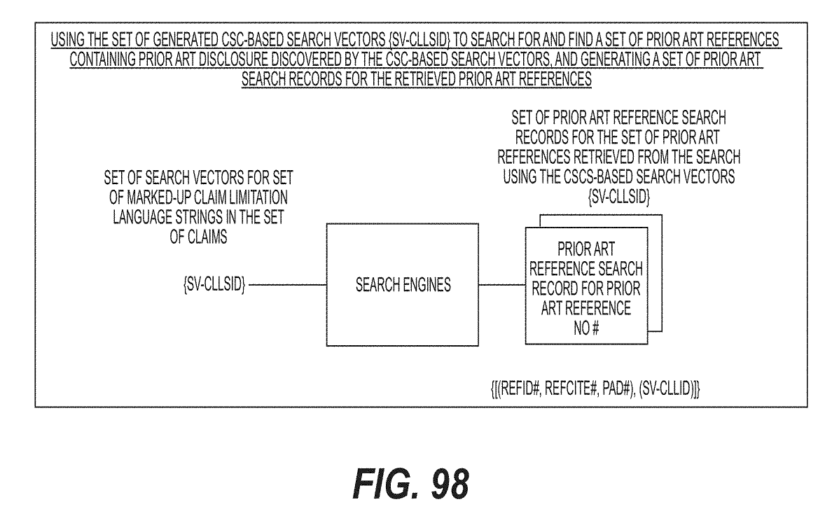

As indicated in STEP E of FIG. 95B, the process involves using the set of generated CSCS-based Search Vectors {<CSCSID-SV>} to (i) search for and find a set of Prior Art References {PAR}. During this step of the search process, each Prior Art References that matches at least one of the CSCS-based Search Vectors is retrieved and stored for analysis. Also, a Prior Art Search Record (PASR) is generated for each retrieved Prior Art Reference, wherein each Prior Art Search Record (PASR) is created by tagging and/or linking the CSCS-based Search Vector used to retrieve a particular Prior Art Reference, with (i) the Prior Art Reference (PAR), (ii) the cited Prior Art Disclosure contained in the Prior Art Reference, and (iii) the claim Scope Concept Structure Identifier (CSCSID) so as to create the Prior Art Search Record (PASR) that is stored in the system database for the corresponding CSCS-based Search Vector. This step of the process illustrated in FIG. 98, wherein a set of generated CSC-based Search Vectors are used to search for and find a set of Prior Art References {PAR} containing prior art disclosure (e.g. searchable text and searchable graphics and/or images) retrieved/discovered by the CSC-Based Search Vectors, and thereafter, a set of Prior Art Search Records {PASR} are generated for the retrieved Prior Art References (PAR).

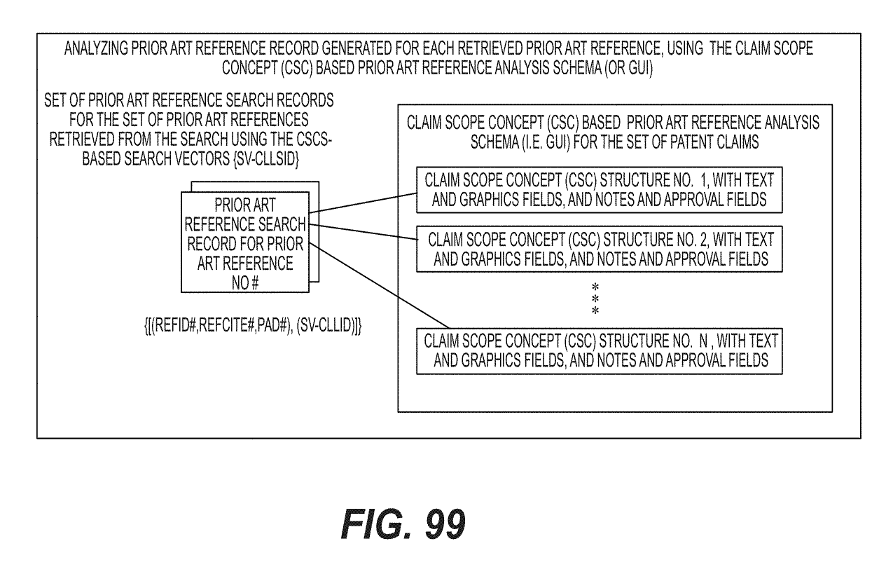

As indicated in STEP F of FIG. 95B, the process involves using the Prior Art Search Record (PASR) generated for each retrieved Prior Art Reference and the claim Scope Concept Based Prior Art Reference Analysis Schema, to generate a set of Prior Art Reference claim Scope Concept (CSC) Profile documents for the set of retrieved Prior Art References. During this step of the process, each generated Prior Art Reference claim Scope Concept Structure Profile document comprises, for each claim in the set of claims, (i) a list of claim Scope Concept Structures (CSCS), and (ii) an indication of whether or not each CSCS has been substantiated by Prior Art Disclosure contained in at least one Prior Art Reference that has been retrieved during the prior art search using the CSCS-based Search Vector linked to the CSCS. This step of the process is illustrated in FIG. 99, wherein the claim Scope Concept (CSC) based Prior Art Reference Analysis Schema (or GUI) is used to analyze the prior art reference record generated for each retrieved prior art reference discovered by the CSC-based search vectors.

As there will be as many CSCS records produced in the CSCS-Based Prior Art Reference Analysis Schema as there are claim Limitation Language Strings (CLLS) in each claim, any opportunity to combine CSCS records in the CSCS-Based Prior Art Reference Analysis Schema will be helpful if and when retrieved Prior Art Reference documents are to be visually analyzed by human subject matter experts, either to confirm the prior art disclosure mapping by the system, or an original analysis of the prior art references, as the case may be. The more highly organized the claim Scope Concepts are, on any given prior art reference analysis GUI (or corresponding schema), the easier it will be for the human analyzer to scope concept analyze any prior art reference and record its relevant prior art disclosure (e.g. searchable text and/or graphics and/or images) in the XML-based GUI, for storage in the system database.

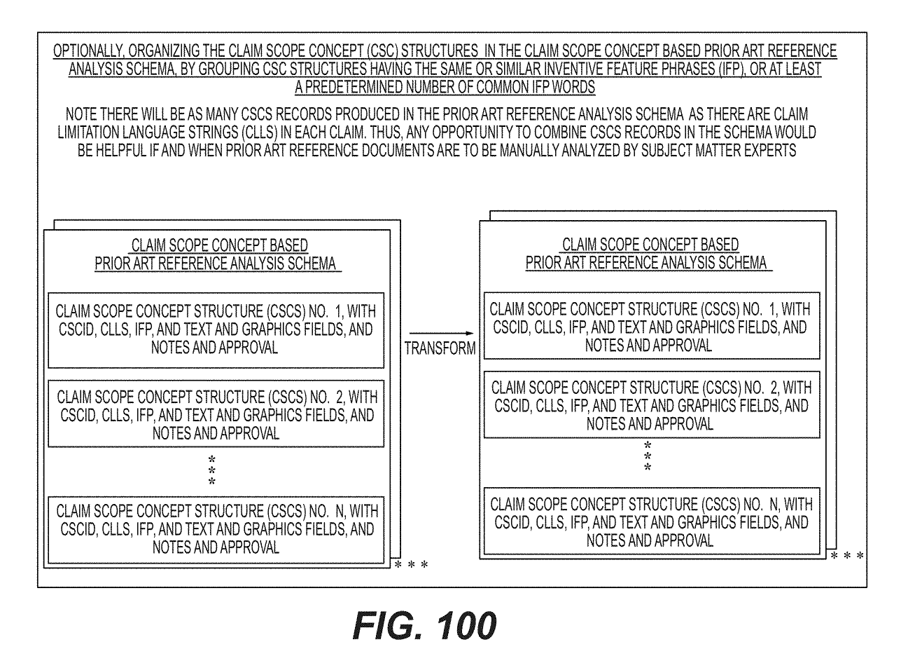

For such reasons discussed above, STEP G in the process of FIG. 95B involves, optionally, organizing the claim Scope Concept Structures (CSCS) in the Prior Art Reference claim Scope Concept Structure Profile documents, say by grouping the claim Scope Concept Structures (CSCS) having the same or similar Inventive Feature Phrases (IFP), or at least a predetermined number of common IFP words, so that a human reviewer or analyzer can see all claim Scope Concept Structures (CSCSs) that are related to each other (e.g. perhaps assigned to a single group). This step in the process is illustrated in FIG. 100, wherein optionally, claim scope concept structures (CSCS) are organized in the claim scope concept (CSC-based) based prior art reference analysis schema, by grouping CSC structures having the same or similar inventive feature phrases (IFP), or at least a predetermined number of common IFP words. By combining CSCS records in the schema will be helpful if and when prior art reference documents are to be manually analyzed by subject matter experts and there as many CSCS records produced in the prior art reference analysis schema as there are claim limitation language strings (CLLS) parsed out and analyzed in each patent claim.

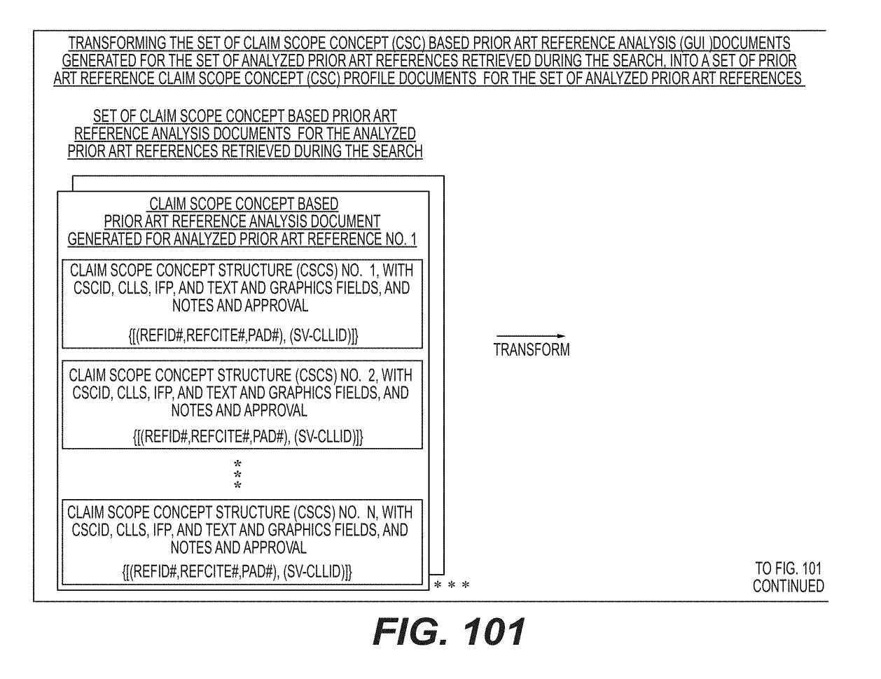

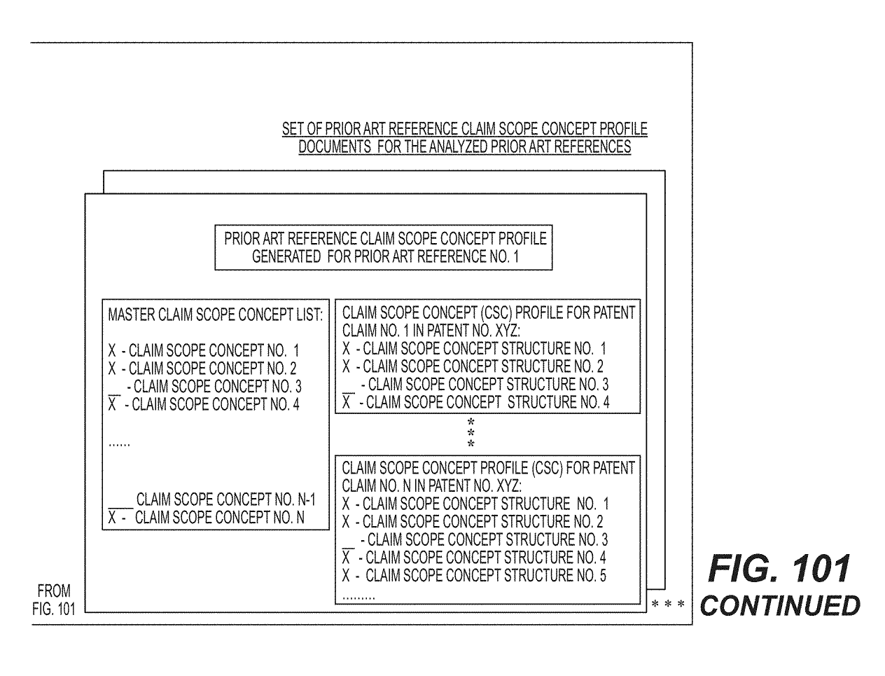

FIG. 101 illustrates the transformation of a set of claim Scope Concept (CSC) Based Prior Art Reference Analysis (GUI) documents generated for the set of analyzed prior art references retrieved during the search, into a set of Prior Art Reference claim Scope Concept (CSC) Profile documents for the set of analyzed prior art references retrieved during the search. Notably, each Prior Art Reference claim Scope Concept (CSC) Profile document contains information about what CSCSs in what claim are substantiated by prior art disclosure in the Prior Art Reference document, and will be used with great benefit in STEP I of the process, as described in detail below.

As indicated in STEP H in FIG. 95, the process involves ranking the Prior Art References retrieved during the search results according to which Prior Art References substantiate (e.g. provide relevant prior art disclosure on) the maximum number of claim Scope Concept Structures (CSC) by Prior Art Reference Disclosure mapped to CSCSs by the CSC-Based Search Vectors, then order the analysis of Prior Art References by a human subject matter expert, or confirmation of automated prior art disclosure mapping to CSC-based Prior Art Reference Profile documents, according to the highest priority of the CSC-based Ranking, wherein STEP H can be implemented using either of the following Methods set forth below.

In a first illustrative method for ranking retrieved prior art references, the first step (a) involves, for each retrieved Prior Art Reference, analyzing its updated Prior Art Reference claim Scope Concept Profile so as to determine, for the entire set of claims, the number of claim Scope Concepts (CSC) which are substantiated by Prior Art Disclosure during the automated prior art search, retrieval and mapping operations, carried out using CSC-Based Search Vectors. The second step (b) involves ranking the retrieved Prior Art References according to the number of claim Scope Concepts that have been substantiated by Prior Art Reference Disclosure during the automated prior art search, retrieval and mapping operations. The third step (c) involves reviewing and analyzing, in a prioritized order, those retrieved Prior Art References having the maximum number of claim Scope Concepts, for all claims, substantiated by Prior Art Reference Disclosure.

In a second illustrative method for ranking retrieved prior art references, the first step (a) involves, for each retrieved Prior Art Reference, analyzing its updated Prior Art Reference claim Scope Concept Profile so as to determine, for a set of specified claims, the number of claim Scope Concepts (CSC) which are substantiated by Prior Art Disclosure during the automated prior art search, retrieval and mapping operations, carried out using CSC-Based Search Vectors. The second step (b) involves ranking the retrieved Prior Art References according to the number of claim Scope Concepts that have been substantiated by Prior Art Reference Disclosure during the automated prior art search, retrieval and mapping operations. The third step (c) involves reviewing and analyzing in a prioritized order, those retrieved Prior Art References having the maximum number of claim Scope Concepts, for the set of specified claims, substantiated by Prior Art Reference Disclosure.

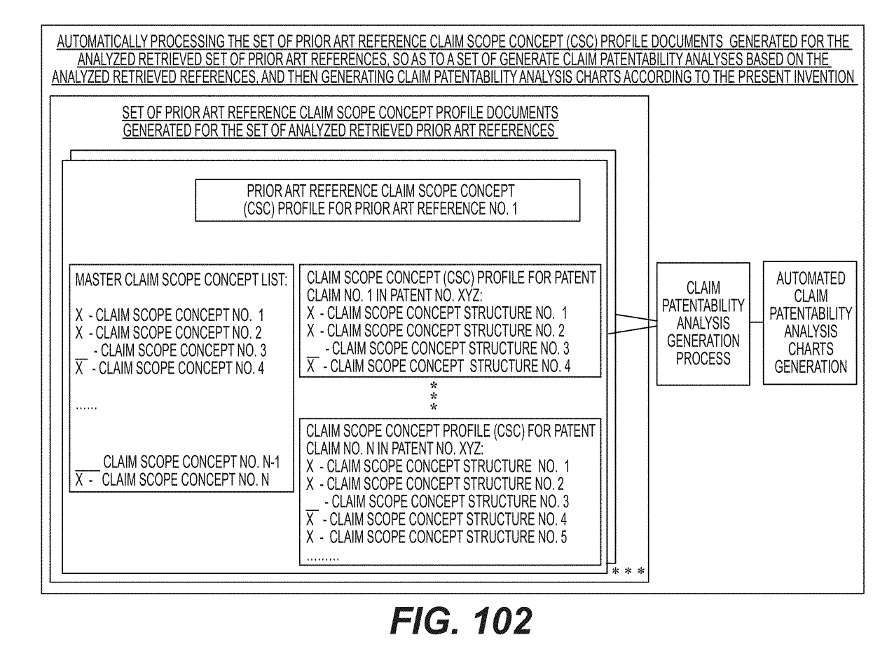

As indicated in STEP I in FIG. 95C, the process involves automatically processing the retrieved Prior Art References and the claims using the previously generated Prior Art Reference claim Scope Concept Profile documents so as to generate claim Patentability Analyses based on the analyzed retrieved Prior Art References. Thereafter, the system will generate claim Patentability Analysis Charts according to the present invention. This step in the process is illustrated in FIG. 102, wherein the set of Prior Art Reference claim Scope Concept (CSC) Profile documents generated for the analyzed retrieved set of Prior Art References are automatically processed, as described in FIGS. 116A through 116F, so as to generate a set of claim patentability analyses based on the analyzed retrieved references. Thereafter, the system will generate claim patentability analysis charts based on the analyses, according to the present invention.

Automated Method of Generating Claim Patentability Analysis Charts and Reports Using an Automated Claim Patentability Analysis Generation Module Supported within the System of the Present Invention

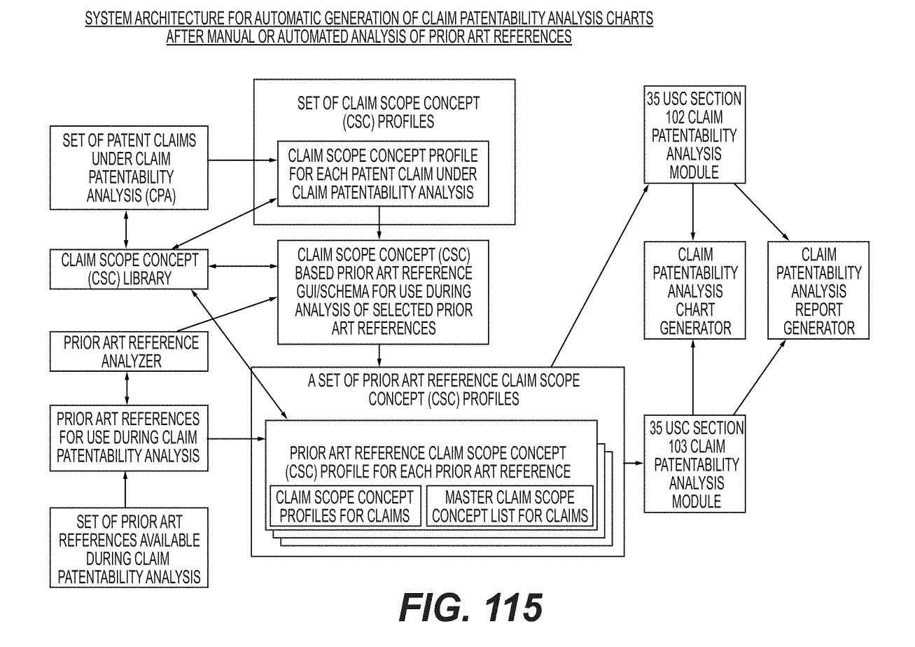

Process Step I in FIG. 95C can be carried out using the automated process of FIGS. 116A through 116F, supported on a system architecture as illustrated in FIG. 115, wherein the automated method of rationally generating claim patentability analyses and charts, in accordance with an alternative embodiment of the present invention, is described below.

As illustrated in Step 1 of FIG. 116A, the system uses the generated claim Scope Concept (CSC) Based Prior Art Reference Schema, illustrated in FIG. 110, and the set of generated Prior Art Reference claim Scope Concept (CSC) Profiles, illustrated in FIG. 112, to enter disclosure language from the Prior Art Reference (and/or a citation in the Prior Art Reference) into the Prior Art Reference claim Scope Concept (CSC) Profile document that is generated for each Prior Art Reference, as being prior art disclosure that corresponds to the claim Scope Concept Structure assigned to a claim Limitation Language String (CLLS) in at least one of the claim under analysis. Notably, during this step, the Prior Art Reference claim Scope Concept (CSC) Profile for each Prior Art Reference comprises: (i) a Master Scope Concept List indicating which claim Scope Concepts have been substantiated by disclosure from the Prior Art Reference, and (ii) A claim Scope Concept List, for each claim, indicating which claim Scope Concepts in each claim have been substantiated by disclosure from the Prior Art Reference, with a citation from the Prior Art Reference as to where the substantiating disclosure can be found in the Prior Art Reference.

As illustrated in Step 2 of FIG. 116A, the user selects the Legal Basis on which Automated claim Patentability Analysis Should Be Performed (i.e. 35 USC Section 102, or 35 USC Section 103) during the Automated claim Patentability Analysis and Chart and Report Generation Process.

As illustrated in Step 3 of FIG. 116A, the user selects the Class of Prior Art References Which shall be used during Automated claim Patentability Analysis and Generation Process, wherein the Class of Prior Art References is selected from the group comprising: Only New Prior Art References; Only Cited But Not Applied Prior Art References, New Prior Art References and Cited But Not Applied Prior Art References, New Prior Art References, Cited and Applied Prior Art References, New Prior Art References and Cited Prior Art References, or All Prior Art References.

As illustrated in Step 4 of FIG. 116B, for 35 USC Section 103 claim Patentability Analysis, the user selects: (i) the Degree of claim Scope Concept Overlap required between Prior Art References (e.g. 1^{st} Degree of claim Scope Concept Overlap=each Reference In the Configured/Combined Set of Prior Art References has one substantiated Scope Concept in common, 2nd Degree of claim Scope Concept Overlap=each Reference In the Configured/Combined Set of Prior Art References has two substantiated claim Scope Concepts in common, and 3rd Degree of claim Scope Concept Overlap=each Reference In the Configured/Combined Set of Prior Art References has three substantiated claim Scope Concepts in common); and also (ii) the maximum number of Prior Art References that can be combined to substantiate all of the claim Scope Concepts in any claim under claim Patentability Analysis.

As illustrated in Step 5 of FIG. 116B, the system configures the Automatic claim Patentability Analysis and Generation Module (i.e. system architecture) of FIG. 115 using the Selections Made in Steps 8, 9 and 10.

As illustrated in Step 6 of FIG. 116B, the system loads the following data items into buffer memory within the Automatic claim Patentability Analysis and Generation Module: (i) the selected Class of Prior Art References; (ii) the generated Set of claim Scope Concept (CSC) Profiles; and (iii) the generated Set of Prior Art Reference Scope Concept Profiles.

### Processing Logic for 35 USC Section 102 Claim Patentability Analysis and Chart Generation

As illustrated in Step 7 of FIG. 116C, if the 35 USC Section 102 Legal Basis has been selected by the user, then the system automatically performs the following operations:

Substep (A): Analyze the Prior Art Reference claim Scope Concept Profile that has been generated for each analyzed Prior Art Reference, and identify each claim Scope Concept List having all of its claim Scope Concepts substantiated by the Prior Art Reference;

Substep (B): Based on the results of Substep (A) above, generate a List of Section 102 claim Patentability Analysis, wherein each Section 102 claim Patentability Analysis comprises:

(i) each claim in the Set of claims having all of its claim Scope Concepts substantiated by the Prior Art Reference;

(ii) identification of the Prior Art Reference; and

(iii) the claim Scope Concept List for the claim, and cited disclosure from the Prior Art Reference mapped against the corresponding claim Scope Concepts, and corresponding limitations and/or sub-limitations in the claim;

Substep (C): index the List of Section 102 claim Patentability Analyses by the data items loaded into buffer memory in Step (12), and store the indexed List of Section 102 claim Patentability Analyses, in the system database;

Substep (D): generate a claim Patentability Analysis Report containing an indexed List of Section 102 claim Patentability Analyses, for review and subsequent analysis; and

Substep (E): generate a claim scope concept (CSC) based claim patentability analysis chart structure for each Section 102 claim Patentability Analysis listed in the Report generated in Substep (D), for subsequent display, review and analysis.

### Processing Logic for 35 USC Section 103 Claim Patentability Analysis and Chart Generation

The Process involves n=N number of stages of claim Scope Concept (CSC) list processing, performed over m=M number of Primary Prior Art Reference (PPAR) candidates, for a total of M×N stages of processing, where N is the total claims under analysis {n=1, 2, . . . , N−1, N}, and M is the total number of prior art references {m=1, 2, . . . , M−1, M}.

As illustrated in Step 8 of FIG. 116D, if the 35 USC Section 103 Legal Basis has been selected by the user, then the system automatically performs the following operations:

Substep (A): access the Prior Art Reference claim Scope Concept Profile that has been generated for each m-th Prior Art Reference in the Selected Class of Prior Art References, and buffer these M Prior Art Reference claim Scope Concept Profiles in system memory;
Substep (B): for each m-th Prior Art Reference claim Scope Concept Profile, index its corresponding Prior Art Reference as a (Primary) Prior Art Reference (PPAR) for claim patentability analysis purposes, and then perform the following operations for the m-th (Primary) Prior Art Reference, where m is the reference index defined a m={1, 2, 3, . . . , N−1, N}, and the Prior Art Reference claim Scope Concept Profile Processing Loop starts with the (m=1)th Prior Art Reference claim Scope Concept Profile;
Substep (C): for each n-th claim Scope Concept List in the Prior Art Reference Scope Concept Profile for the m-th analyzed Prior Art Reference, perform the following operations for the n-th claim Scope Concept List, where n is the claim index defined as n={1, 2, 3, . . . , N−1, N} and the claim Scope Concept List Processing Loop starts with the (n=1)th claim Scope Concept List:

(1) analyze the n-th claim Scope Concept List, and if it has at least one, but not all, of its claim Scope Concepts substantiated by cited disclosure in the Prior Art Reference, then further analyze the corresponding n-th claim Scope Concept List in the Prior Art Reference claim Scope Concept Profile for all of the remaining (M−1)th (Secondary) Prior Art References in the Selected Class of Prior Art References, so as to identify each set of remaining (Secondary) Prior Art References that has disclosure to substantiate all of the claim Scope Concepts that the first (Primary) Prior Art Reference failed to substantiate, and wherein the first (Primary) Prior Art Reference and the remaining (Secondary) Prior Art References satisfy the Degree of claim Scope Concept Overlap required between the Prior Art References selected in Step 10 and the total number of Prior Art References does not exceed the total number selected in Step 10; and

(2) for each identified set of remaining (M−1)th (Secondary) Prior Art References identified in Substep (1) above, which has disclosure that substantiates all of the claim Scope Concepts which the first (Primary) Prior Art Reference fails to substantiate, perform the following operations:

(a) automatically combine the identified set of remaining (Secondary) Prior Art References with the first (Primary) Prior Art Reference so as to form a candidate subset of Prior Art of References that may substantiate a claim patentability analysis for the first claim identified by its claim Scope Concept List in the Prior Art Reference claim Scope Concept Profile for the first analyzed (Primary) Prior Art Reference;

(b) add each such Subset of Prior Art References to a List of Section 103 claim Patentability Analyses that is stored within the system database, wherein each Section 103 claim Patentability Analysis comprises each claim in the Set of claims having all of its claim Scope Concepts substantiated by a Subset of (Primary and Secondary) Prior Art References, an identification of the Subset of (Primary and Secondary) Prior Art References, and the claim Scope Concept List for the claim, and cited disclosure from the set of Prior Art References mapped against the corresponding claim Scope Concepts;

(c) index the List of Section 103 claim Patentability Analyses by the data items loaded into buffer memory in Step 12;

(d) store the indexed List of Section 103 claim Patentability Analyses, in the system database;

(e) (1) if patent claim index n<N, then return to Substep (C), remain in the claim Scope Concept (CLC) List Processing Loop, increment the claim index n by 1, repeat operations in Substep (C) for each n-th claim Scope Concept List, until all N claim Scope Concept Lists have been processed;

(e) (2) however, if n=N, then advance to Substep (f) below; and

(f) if prior art reference index m<M, then return to Substep (B), remain in the Prior Art Reference claim Scope Concept Profile Processing Loop, increment the reference index by 1, repeat operations in Substep (B) for each m-th Prior Art Reference claim Scope Concept Profile, until all M Prior Art Reference claim Scope Concept Profiles have been processed, so that each m-th Prior Art Reference has been considered and processed as a (Primary) Prior Art Reference during claim Patentability Analysis;

however, if m=M, then advance to Substep (D) below;

Substep (D): index the List of Section 103 claim Patentability Analyses by the data items loaded into buffer memory in Step (12), and store the indexed List of Section 103 claim Patentability Analyses, in the system database;
Substep (E): generate a claim Patentability Analysis Report containing the indexed List of Section 103 claim Patentability Analyses, for review and subsequent analysis; and
Substep (F): generate a claim Scope Concept (CSC) based claim Patentability Analysis Chart Structure for each Section 103 claim Patentability Analysis listed in the Report generated in Substep (E), for subsequent display, review and analysis.

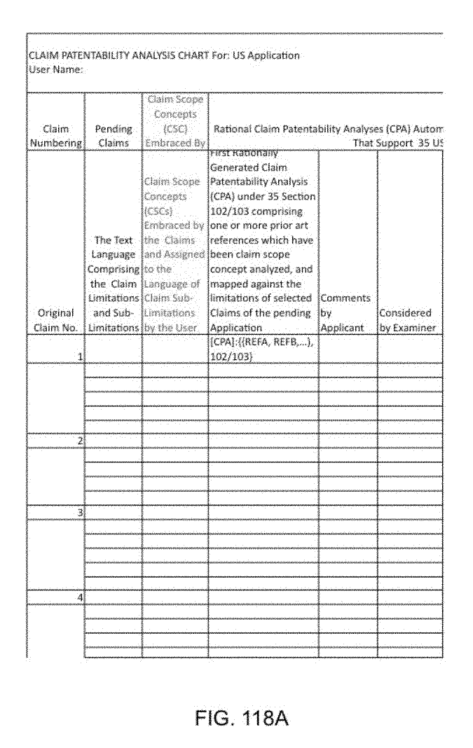

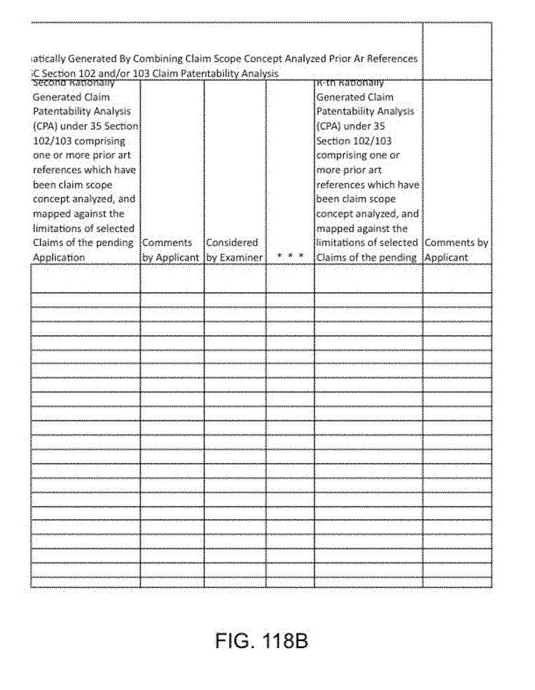

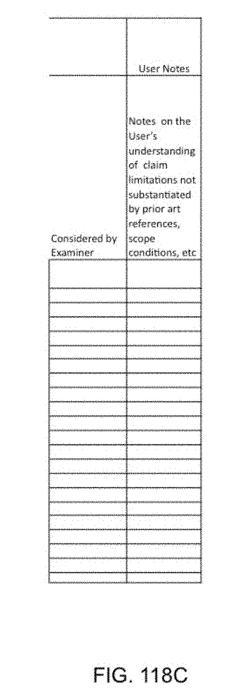

As shown in FIGS. 118A through 118C, the Scope Concept (CSC) based claim Patentability Analysis Chart Structure of the illustrative embodiment comprises the following the data display fields, namely:

(i) Original claim Numbering for the pending claims;

(ii) The Text Language Comprising the claim Limitations and Sub-Limitations of the pending claims;

(iii) claim Scope Concepts (CSCs) Embraced by the claims and Assigned to the Language of claim Sub-Limitations by the User;

(iv) Rational claim Patentability Analyses (CPA) Automatically Generated By Combining claim Scope Concept Analyzed Prior Art References That Support 35 USC Section 102 and/or 103 claim Patentability Analysis, including First Rationally Generated claim Patentability Analysis (CPA) under 35 Section 102/103 comprising one or more prior art references which have been claim scope concept analyzed, and mapped against the limitations of selected claims of the pending Application, Second Rationally Generated claim Patentability Analysis (CPA) under 35 Section 102/103, through R-th Rationally Generated claim Patentability Analysis (CPA) under 35 Section 102/103 comprising one or more prior art references which have been claim scope concept analyzed, and mapped against the limitations of selected claims of the pending Application;

(v) Comments by Applicant;

(vi) Considered by Examiner; and

(vii) Notes on the User's understanding of claim limitations not substantiated by prior art references, scope conditions, etc.

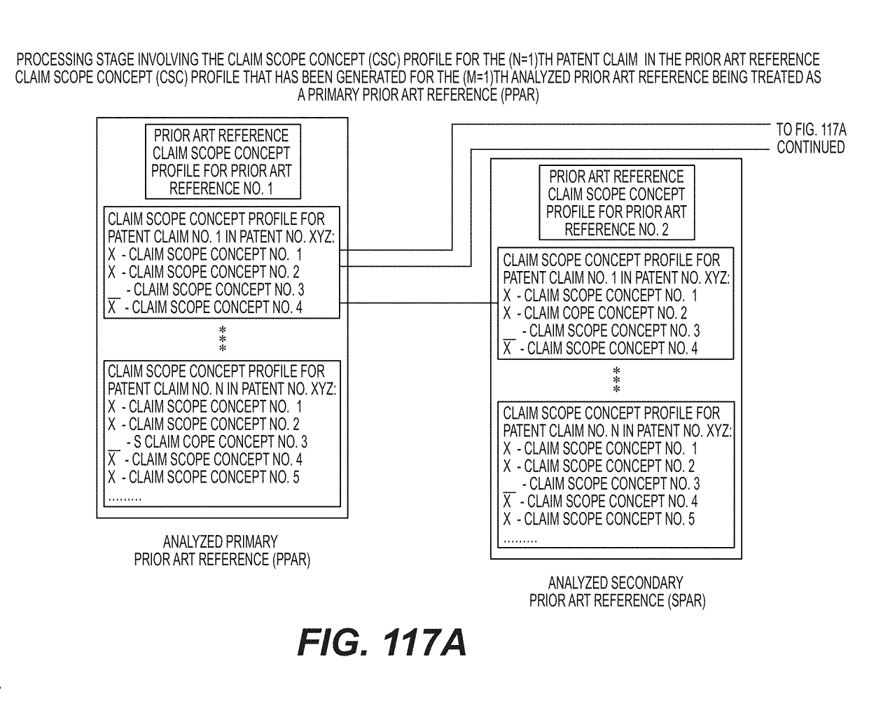

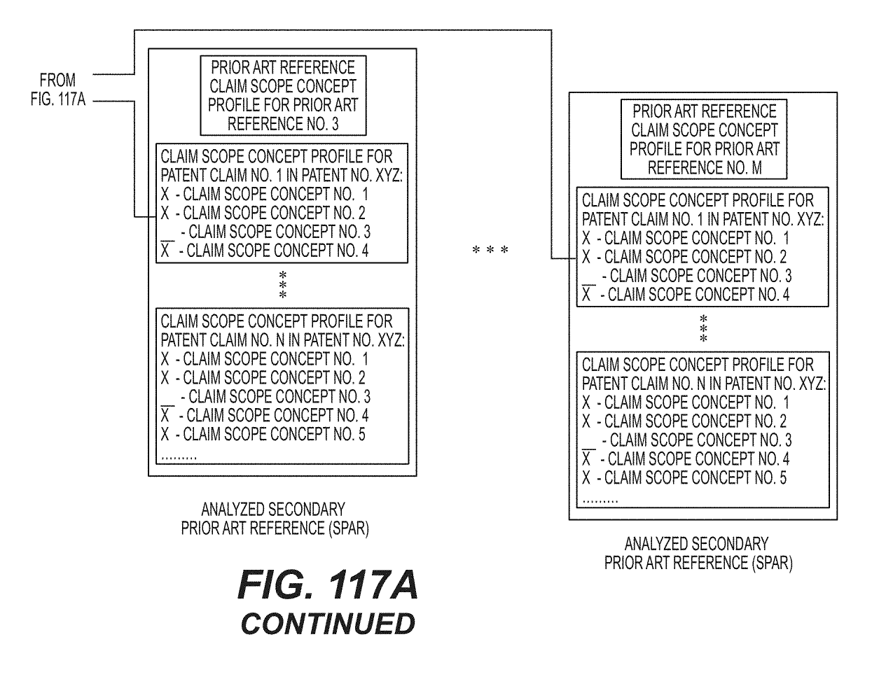

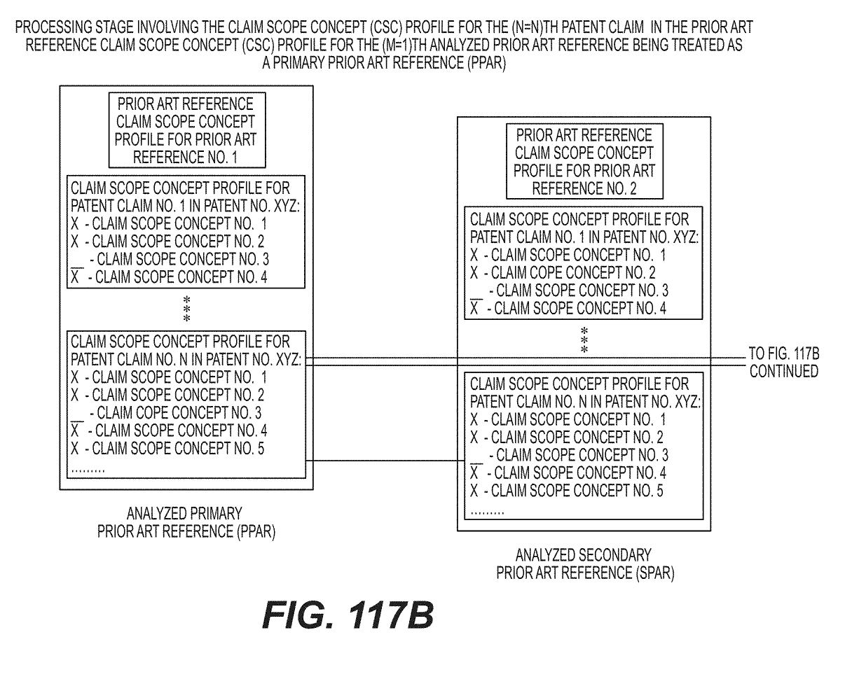

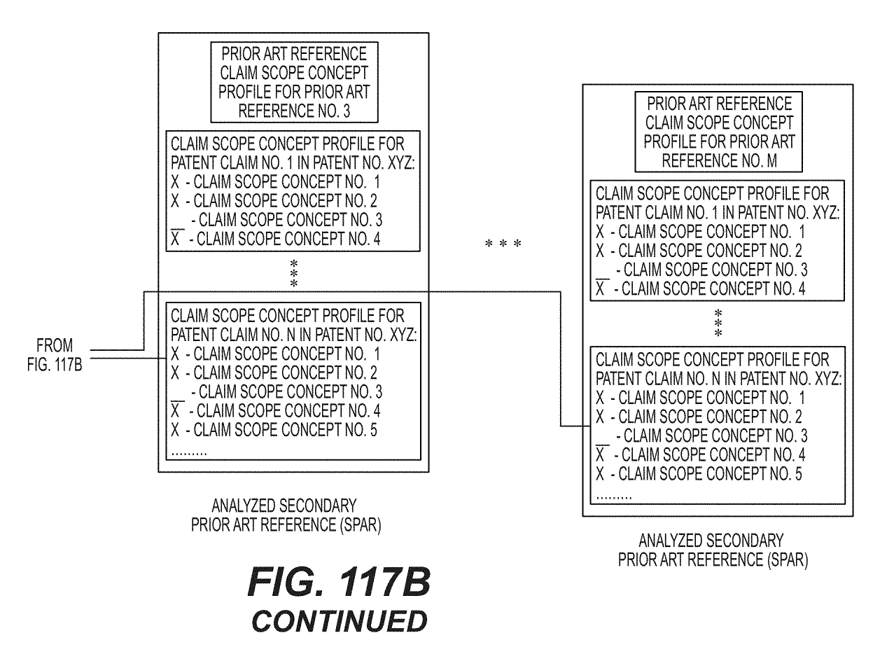

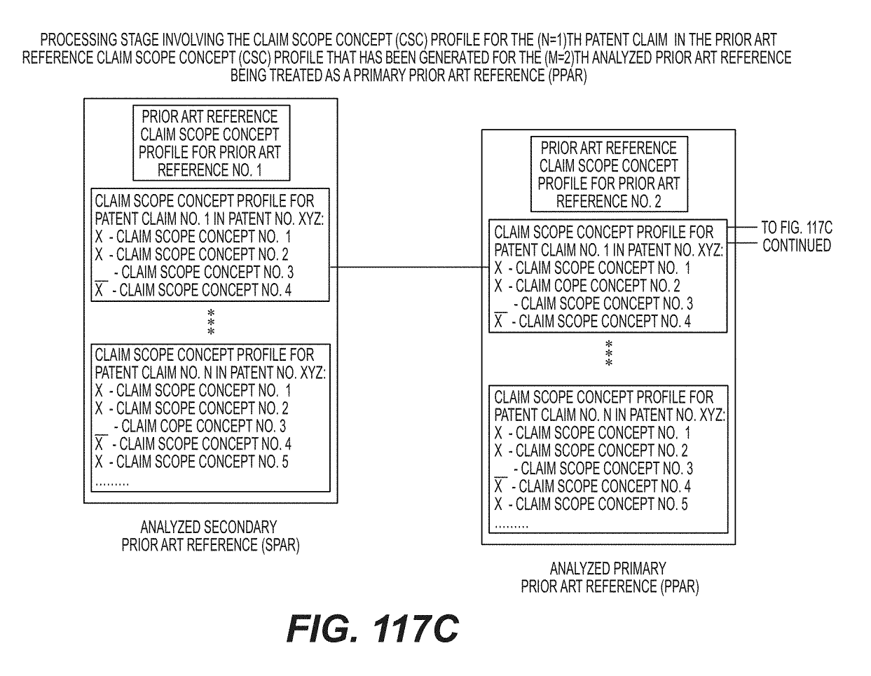

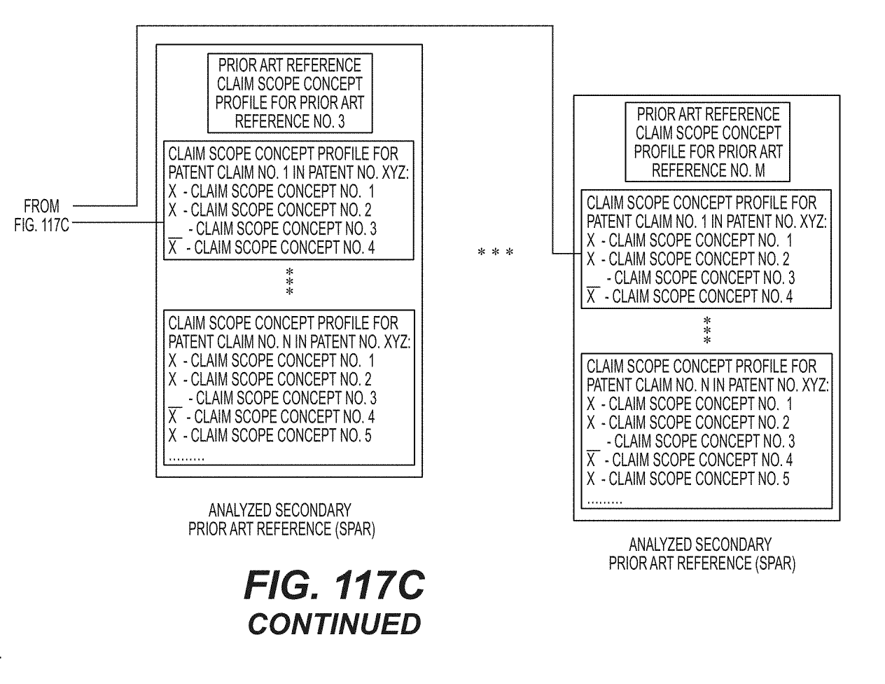

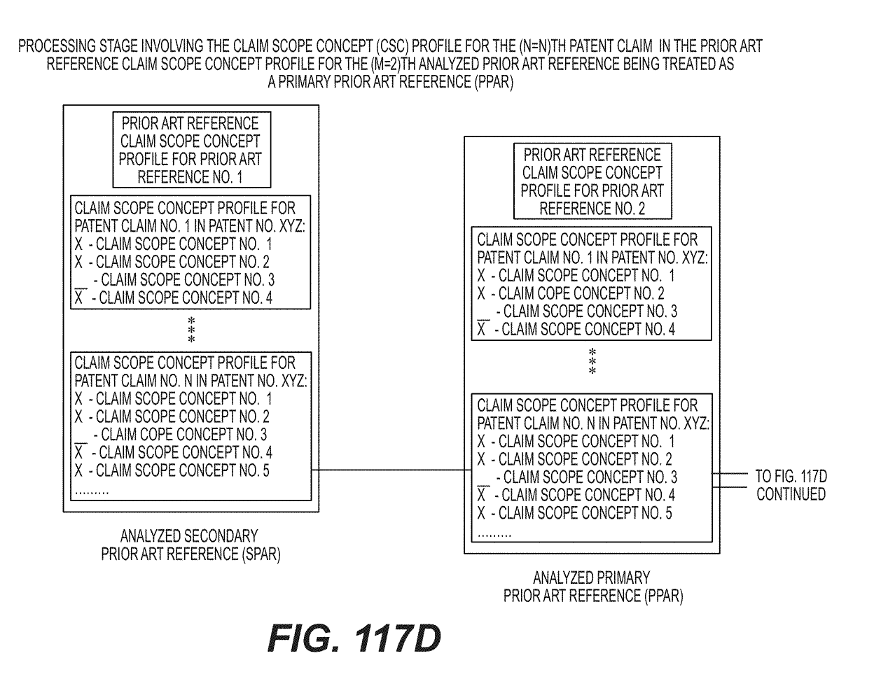

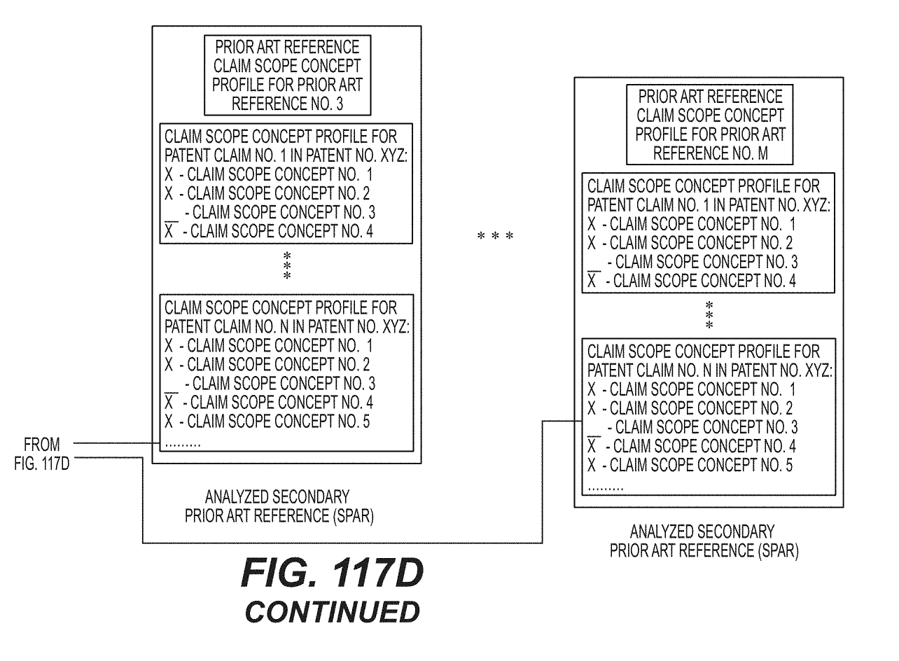

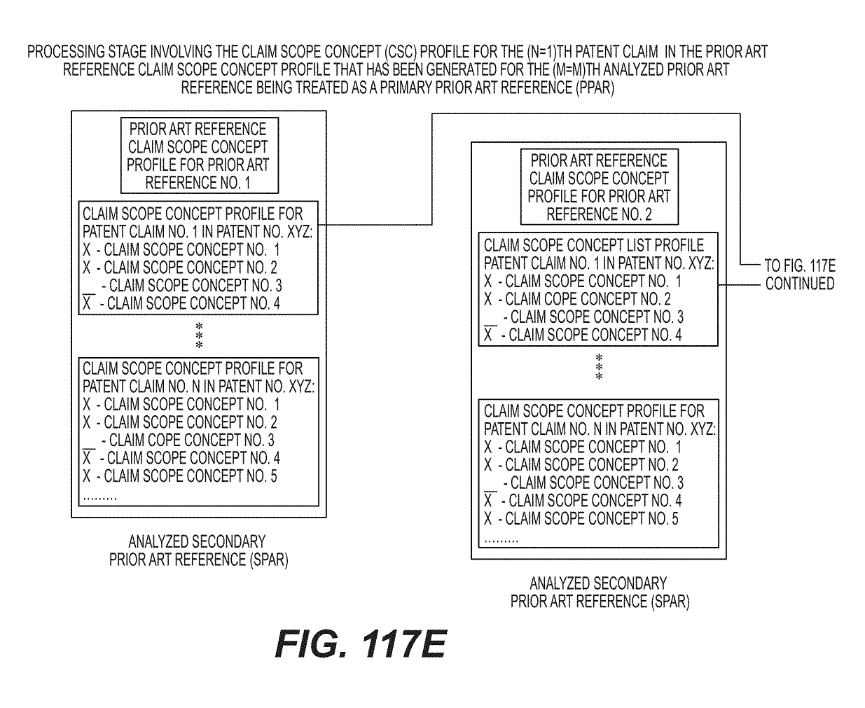

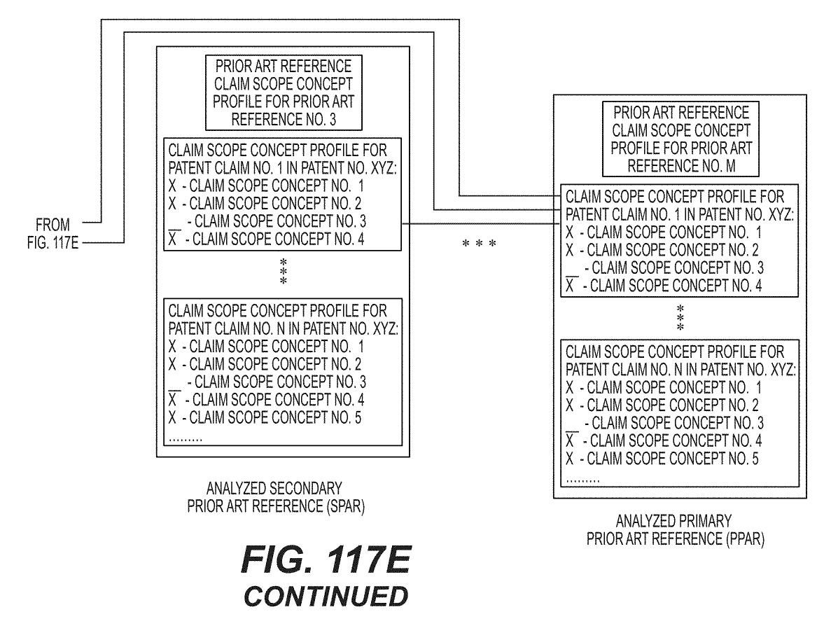

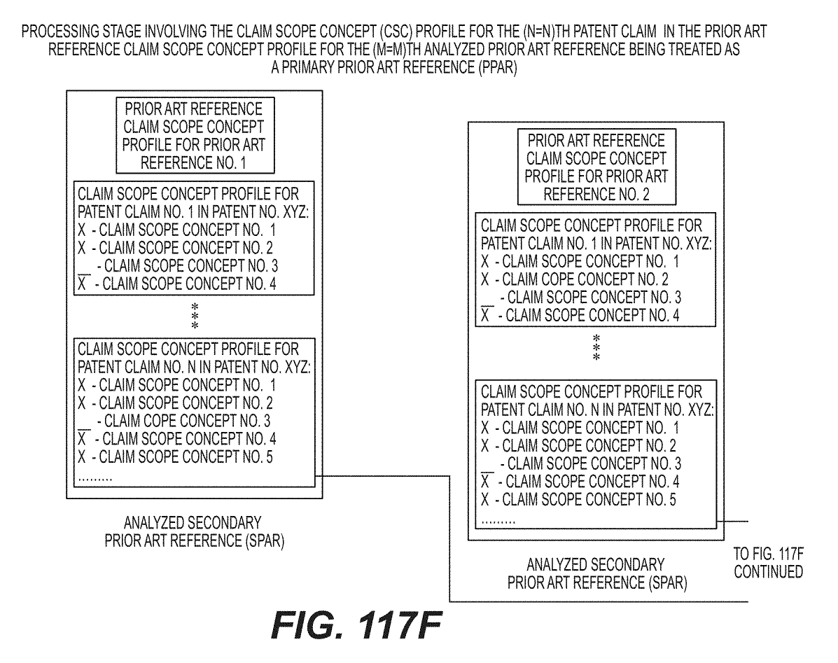

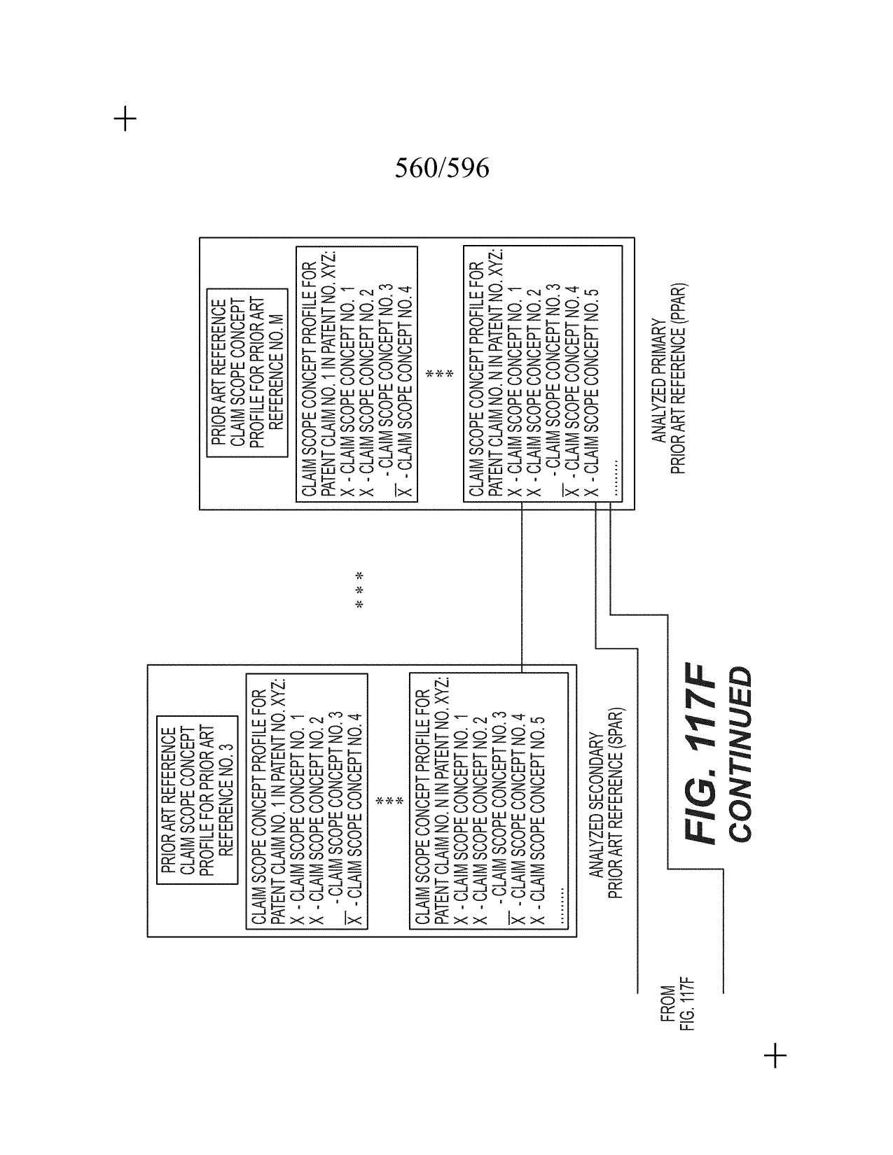

FIG. 117A illustrates a processing stage in the above process that is supported within the system of FIGS. 94 and 115, and which involves the claim Scope Concept (CSC) list for the (n=1)th patent claim in the Prior Art Reference claim Scope Concept Profile that has been generated for the (m=1)th analyzed prior art reference being considered as a primary prior art reference (PPAR).

FIG. 117B illustrates a processing stage in the above process that is supported within the system of FIGS. 94 and 115, and which involves the claim Scope Concept (CSC) list for the (n=N)th patent claim in the Prior Art Reference claim Scope Concept Profile for the (m=1)th analyzed prior art reference being considered as a primary prior art reference (PPAR).

FIG. 117C illustrates a processing stage in the above process that is supported within the system of FIGS. 94 and 115, and which involves the claim Scope Concept (CSC) list for the (n=1)th patent claim in the Prior Art Reference claim Scope Concept Profile that has been generated for the (m=2)th analyzed prior art reference being considered as a primary prior art reference (PPAR).

FIG. 117D illustrates a processing stage in the above process that is supported within the system of FIGS. 94 and 115, and which involves the claim Scope Concept list for the (n=N)th patent claim in the Prior Art Reference claim Scope Concept Profile that has been generated for the (m=2)th analyzed prior art reference being considered as a primary prior art reference (PPAR).

FIG. 117E illustrates a processing stage in the above process that is supported within the system of FIGS. 94 and 115, and which involves the claim Scope Concept list for the (n=1)th patent claim in the Prior Art Reference claim Scope Concept Profile for the (m=M)th analyzed prior art reference being considered as a primary prior art reference (PPAR).

FIG. 117F illustrates a processing stage in the above process that is supported within the system of FIGS. 94 and 115, and which involves the claim Scope Concept list for the (n=N)th patent claim in the Prior Art Reference claim Scope Concept Profile that has been generated for the (m=M)th analyzed prior art reference being considered as a primary prior art reference (PPAR).

After performing N×M of these processing stages in an automated manner, the system will rationally generate up to N×M possible claim patent analyses (but most likely significantly less each processing run) and corresponding claim patentability charts indicating computed combinations of prior art references which should contain prior art disclosure that is very likely to be relevant to the issue of patentability of the claim to which each generated chart corresponds. The user can then analyze these charts and quickly determine which ones are very relevant, somewhat relevant or irrelevant as the case may be. If the claims were properly scope concept analyzed and CSC-based search vectors properly formulated in accordance with the principles of the present invention, then it is expected that the results of the rational automated patentability analysis should be of high quality, and of great value to the analysis of the claims before the user/analyzer.

Notably, the above-described automated claim patentability analysis process can be readily modified and adapted to support automated claim invalidity contention analysis, as described in FIGS. 50B through 50S, described in detail hereinabove.

### Computer-Implemented Method of Performing Cumulative Prior Art Reference Analysis, and Generating Reports Based on Such Analysis

The system architecture of FIG. 94 also supports a novel computer-implemented method of performing cumulative prior art reference analysis, and generating reports based on such cumulative prior art reference analysis, for use in information disclosure statement (IDS) submissions, claim patentability analysis, claim invalidity analysis, and other forms of claim-based analysis. An exemplary Excel-based cumulative prior art reference chart structure, that can be generated by system of FIG. 94, is shown in FIGS. 118A through 118C. Such reporting can be performed during or independent from claim patentability analysis process of the present invention.

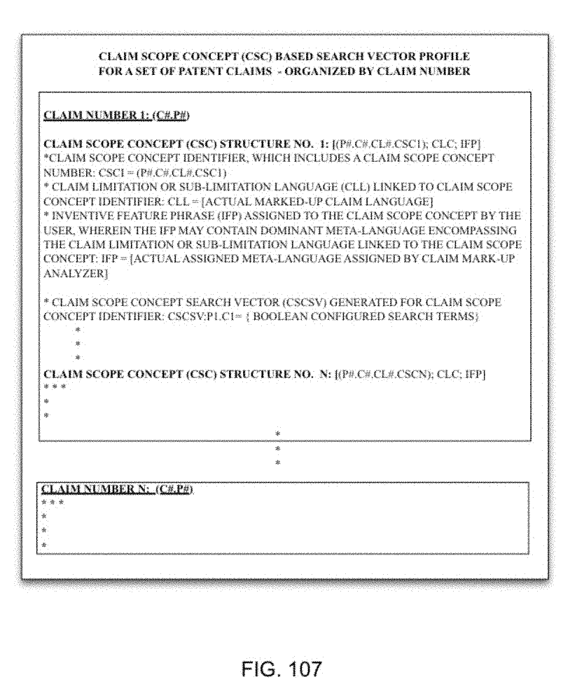

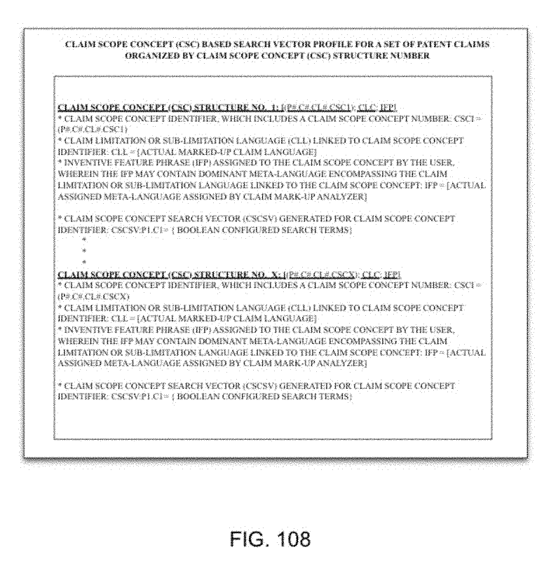

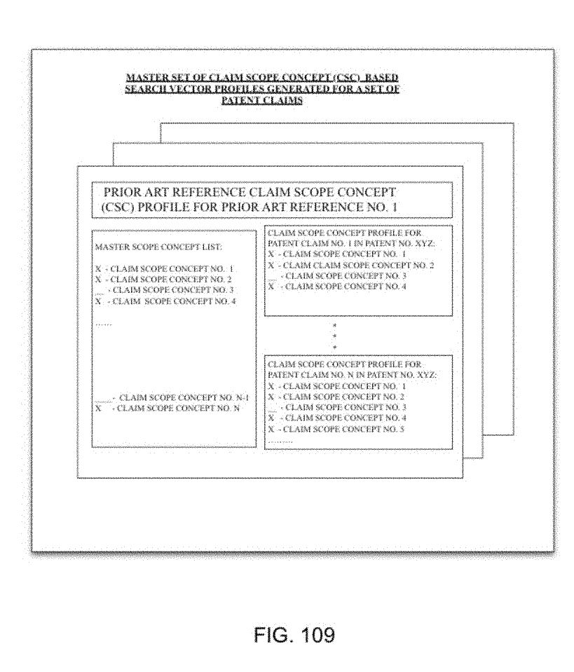

In the illustrative embodiment, automated cumulative prior art reference analysis employs the document structures illustrated in FIGS. 107, 108, 109, 113 and 114. FIG. 107 illustrates the structure of a claim Scope Concept (CSC) Based Search Vector (CSC-SV) Profile document, organized by Patent claim Number, for a set of patent claims under search analysis, and identifying the set of Prior Art References retrieved using the CSC-based Search Vectors generated from claim Scope Concept Structure identified in the CSC-SV profile. FIG. 108 illustrates the structure of a claim Scope Concept (CSC) Based Search Vector (CSC-SV) Profile document, organized by claim Scope Concept Structure (CSCS) Number, for a set of patent claims under search analysis, and identifying the set of Prior Art References retrieved using the CSC-based Search Vectors generated from claim Scope Concept Structure identified in the CSC-SV profile. Each of these documents contains essentially the same information, but organized according to a different scheme. These documents are generated using the information contained in the Master (i.e. complete) Set of claim Scope Concept (CSC) Based Search Vector Profiles illustrated in FIG. 109. The CSC-Based Search Vector Profile documents are generated automatically after the completion of a prior art search carried out using the set of CSC-based Search Vectors generated from the marked-up claim Limitation Language Strings (CLLS) of the claims under analysis.

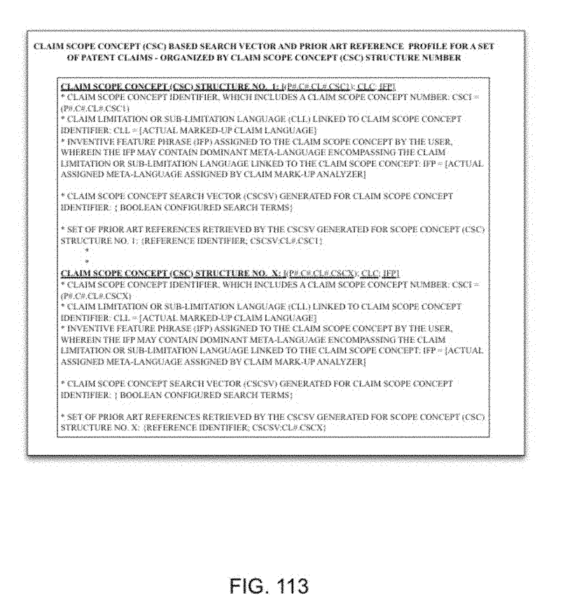

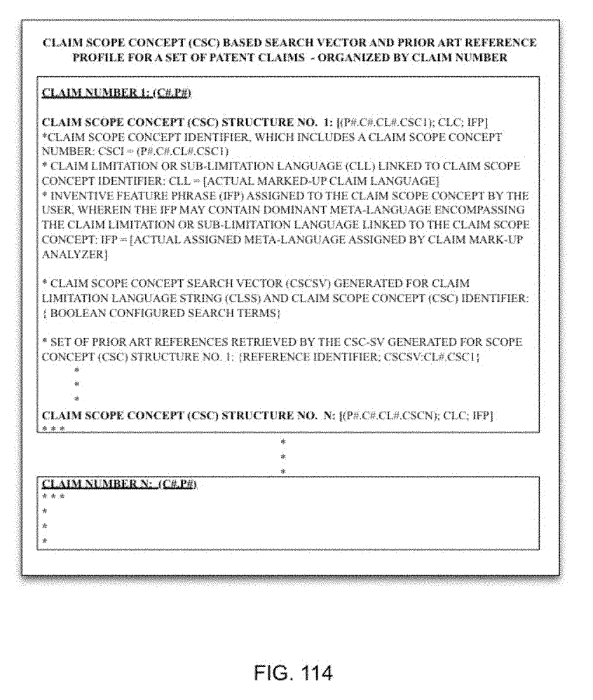

FIG. 113 illustrates the structure of the claim Scope Concept (CSC) Based Search Vector and Prior Art Reference Profile document generated for a set of patent claims, and organized by claim Scope Concept (CSC) Structure Number. FIG. 114 illustrates the structure of the claim Scope Concept (CSC) Based Search Vector and Prior Art Reference Profile document generated for a set of patent claims, and organized by claim Number. Each of these documents contains essentially the same information, but organized according to a different scheme.

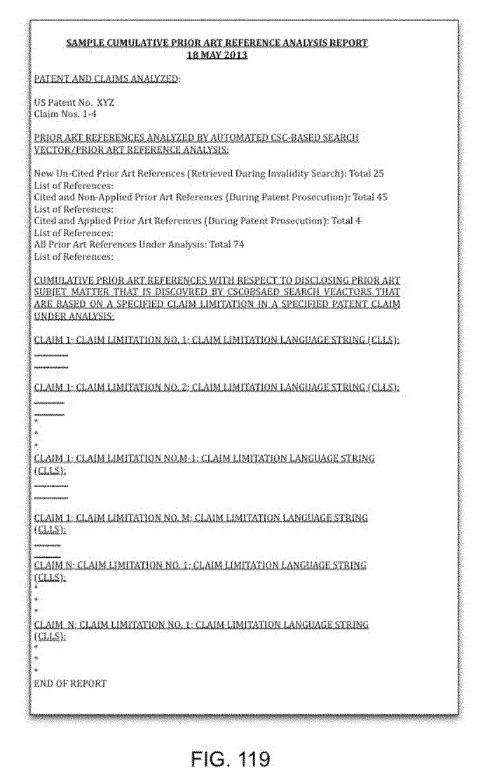

As shown in FIG. 94, the system processes the claim Scope Concept (CSC) Based Search Vector and Prior Art Reference Profile documents, illustrated in FIGS. 113 and 114, to automatically generate a cumulative prior art reference analysis report as shown in FIG. 119, indicating the total number of cumulative prior art references retrieved for each claim Scope Concept Structure (CSCS) generated during the claim markup process, wherein each prior art reference contains prior art disclosure that substantiates the claim Scope Concept Structure (CSCS) assigned to a claim Limitation Language String (CLLS) in a claim under analysis, and from which the CSC-based Search Vector discovering the Prior Art Reference originally was derived.

The process for generating a cumulative prior art reference analysis report can be carried out as follows:

Step 1: Generate a Set of claim Scope Concept (CSC) Based Search Vector Profiles, for each CSC-Based Search Vector generated from the Set of claims, wherein each CSC-Based Search Vector Profile discloses which retrieved Prior Art References contain prior art disclosure that substantiates the subject matter of the claim Limitation Language String, on which the CSC-based Search Vector is based and to which the CSC-based Search Vector is directed;

STEP 2: Analyze the Set of claim Scope Concept (CSC) Based Search Vector Profiles, and determine which retrieved Prior Art References contain prior art disclosure (e.g. searchable text and/or searchable graphics and/or images) that substantiates the claim Scope Concept Structure(s) (CSCS) on which the CSC-based Search Vector is based and to which the CSC-based Search Vector is directed, and generate a CSC-Based Cumulative Prior Art References Profile for each claim Scope Concept Structure (CSCS); and

STEP 3: Use the information contained in the generated set of CSC-based Cumulative Prior Art References Profile documents to compose a Cumulative Prior Art Reference Report.

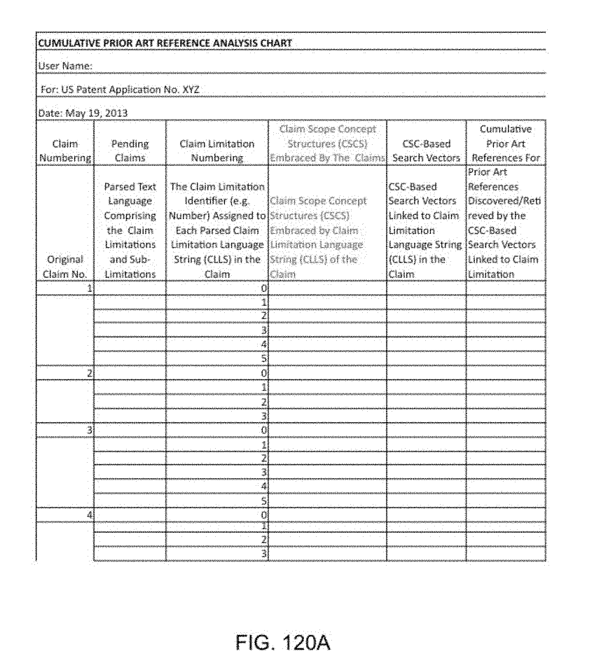

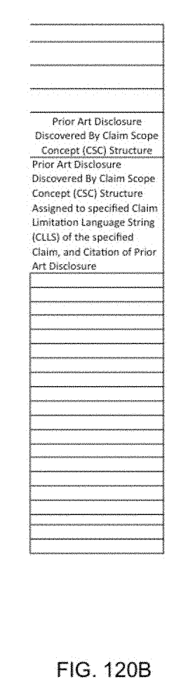

After or before the cumulative prior art reference analysis report is generated, the system can also automatically generate an XML-based spreadsheet based Cumulative Prior Art Reference Chart, as shown in FIGS. 120A and 120B, listing all retrieved prior art references, and corresponding prior art disclosure (e.g. searchable text and/or searchable graphics and/or images) that substantiate an indicated claim Limitation Language String (CLLS) to which a claim Scope Concept Structure (CSCS) was generated during markup, and from which a CSC-Based Search Vector was generated and used to discover the indicated set of cumulative prior art references, listed in the chart. This process can be carried out by compiling the information processed during the report generation process described above, and displaying this information in the XML-based spreadsheet-type based cumulative prior art reference chart structure, as shown in FIGS. 120A and 120B.

As shown in FIGS. 120A and 120B, the XML-based spreadsheet-type based cumulative prior art reference chart structure comprises the following display data fields, namely:

(i) Original claim Numbering in the pending, allowed or granted claims;

(ii) Parsed Text Language Comprising the claim Limitations and Sub-Limitations of the pending, allowed or granted claims;

(iii) claim Limitation Identifier (e.g. Number) Assigned to Each Parsed claim Limitation Language String (CLLS) in the claims;

(iv) claim Scope Concept Structures (CSCS) Embraced by claim Limitation Language String (CLLS) of the claims;

(v)CSC-Based Search Vectors Linked to claim Limitation Language String (CLLS) in the claims;

(vi) (Candidate) Cumulative Prior Art References For Review and Analysis including Prior Art References Discovered/Retrieved by the CSC-Based Search Vectors Linked to claim Limitation Language String (CLLS) in the claims; and

(vii) Prior Art Disclosure Discovered By claim Scope Concept (CSC) Structure Assigned to specified claim Limitation Language String (CLLS) of the specified claims, and Citation of Prior Art Disclosure.

Notably, the cumulative prior art reference analysis reporting and charting process described above can be readily modified and adapted to support non-cumulative prior art reference reporting and charting processes, for use in conjunction with automated claim invalidity contention analysis, described hereinabove.

### Variations in Claim Scope Concept (CSC) Mark-Up of Patent Claims in Different Patent Analysis Applications Arising During the Lifetime of a Patent, Including its Pre-Filing and Post-Grant Phases

Several different techniques have been disclosed herein for marking up patent claims using claim scope concepts (CSCs) and related structures. Also, many different kinds of patent analysis have been disclosed, including patent claim searching analysis, patent prosecution history analysis, claim patentability analysis, patent claim scope interpretation analysis mode, patent claim invalidity contention analysis, patent claim infringement analysis, freedom-to-operate (FTO) analysis, and patent litigation/storyboard analysis. Depending on the method of analysis in question, there typically will a need for a different degree or depth of scope concept mark-up of patent claims, but in all instances, it is expected that the goal will be generally the same, namely: one is attempting to find a set of words (e.g. Scope Concept Phrase, Inventive Feature Phrase, or something else) that encompasses the subject matter of the claim limitation or sub-limitation language string (CLLS) to which the scope concept is being applied, for the purpose of dominating the subject matter of the claim limitation and/or sub-limitation, and thereby gaining greater control over the subject matter of the claim limitation or sub-limitation language string, during the various modes of analysis arising during the life-time of any utility patent, including its pre-filing and post-grant phases. Notwithstanding such claim scope concept (CSC) efforts, it is the actual claim limitation and/or sub-limitation language strings (CLLS) that compose patent claims, as illustrated in FIGS. 25A and 93, that must be considered when constructing/interpreting a patent claim.

The computer-assisted methods described in FIGS. 92 through 120B above can be integrated into the Internet-based system 5 or 300 described above, as an additional mode of analysis or the like, or can be embodied within a stand-alone computer system or distributed network that can accessed and used by others using conventional client computing machines, web browsers and/or client applications, as described hereinabove. Also the services supported in systems 5, 100 and 300 can be integrated in a single multi-mode system, for use by Applicant/Inventors/Owners, their Patent Attorneys and Agents, and Patent Examiners and Customers of the Patent Office, all under the umbrella of the Electronic Business Center (EBC) of the Patent Office, or other national or regional patent system. Alternatively, the services supported in separate systems 5 and 300 can be interfaced by network interfaces, and network authentication (e.g. LDAP services) that allow Applicant/Inventors and their Patent Attorneys and Agents, using system 5 to access and use system 300, in a seamless manner which will become apparent to anyone having the benefit of reviewing the present invention disclosure and novel teachings disclosed herein.

Providing the Internet-Based Patent Analysis and Charting System of the Present Invention with an Open-Public Claim Patentability Analysis (OPCPA) Module and an Open-Public Claim Invalidity Contention Analysis (OPCICA) Module, that are Accessible and Utilizable on the WWW by Members of the Public

In view of the above invention disclosure, another object of the present invention is to provide a further improved Internet-based patent analysis and charting systems 5 and 300 each supporting (i) an open-public claim patentability analysis (OPCPA) module, and (ii) an open-public claim invalidity contention analysis (OPCICA) module, which are accessible and utilizable on the WWW by members of the public. In all respects, these extended-function Internet-based patent analysis and charting systems 5 and 300 shall include all of the features and functions of the previous described system embodiments 5 and 300, and in addition, such systems shall also include: (i) an open-public claim patentability analysis (OPCPA) module as described in connection with the claim Patentability Analysis Mode (i.e. Mode 0) illustrated in FIGS. 93 through 120B, as well as in FIGS. 76 through 92B; and also (ii) an open-public claim invalidity contention analysis (OPCICA) module, as described in connection with the Patent claim Invalidity Contention Analysis Mode (i.e. Mode 5) shown in FIGS. 46 through 51H. Each of these modules will be assigned a unique graphical icon that is displayed in and accessible from the GUI panel of each system 5 and 300, and preferably accessible from a multitude of points on the WWW including, but not limited to, the USPTO's EBC and EFS sites, Google Patents Site, Yahoo, Wall Street Journal, New York Times, and elsewhere on the WWW. Multiple points of access will help provide the interested public notice of such ongoing public patent/application review processes, conducted in the best interests of inventors, patent owners, the investment community and the general public. A concise review of these modules, and the modes and functions they perform, will be described below in connection with the two illustrative embodiments of the present invention described above.

### Specification Internet-Based Patent Analysis and Charting System 5 Supporting an Open-Public Claim Patentability Analysis (OPCPA) Module, and an Open-Public Claim Invalidity Contention Analysis (OPCICA) Module

FIG. 121 shows an exemplary wireframe-type graphical user interface (GUI) served up from the Web and other servers of the Internet-based multi-mode patent analysis and charting system shown in FIG. 5, to one or more of its Internet-based client machines. This GUI includes graphical icons allowing members of the public to access and use (i) the Open Public claim Patentability Analysis (OPCPA) Mode of the present invention based on the claim Patentability Analysis Mode illustrated in FIGS. 93 through 120B, and also (ii) the Open Public claim Invalidity Contention Analysis (OPCICA) Mode of the present invention based on the claim Invalidity Contention Analysis Mode illustrated in FIGS. 46 through 51H.

### Using the Open Public Claim Patentability Analysis (OPCPA) Mode of the Present Invention

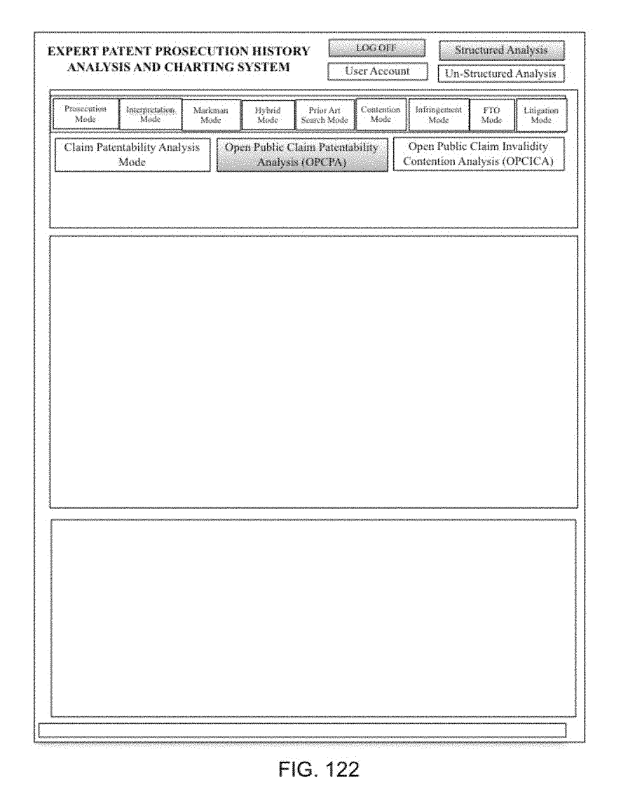

The function of the OPCPA module is to allow members of the public, working alone or together, to review the file history of and patent claims in any published patent application prior to grant, and generate automated rational claim patentability analysis charts for disclosure in the published patent application and review and consideration by the patent examiner during the patent examination process. FIG. 122 shows the exemplary wireframe-type GUI of FIG. 121, having a graphical icon for accessing the Open Public claim Patentability Analysis (OPCPA) Mode is selected by a member of the public. Using a Web-enabled client, the Web-based open-public claim patentability analysis (OPCPA) module can be selected by clicking on the graphical icon, and its GUIs and methods used by members of the public to perform the following functions: (i) identify any specific published patent application for public claim review and analysis prior to patent grant; (ii) create a public patent claim review (PPCR) account on the system accessible through the web-based OPCPA module; (iii) load the file history of the specified patent application in system database 15 and linked to the PPCR account; (iv) scope-concept analyze the patent claims in the published patent application prior to grant; (v) generate claim scope concept (CSC) based prior art search vectors based on the scope concept analyzed patent claims; (vi) use the CSC-based prior art search vectors to search for new and non-cited prior art references relating to the subject matter of the patent claims in the published patent application; (vii) add to the PPCR account, new and non-cited prior art references for review and analysis using CSC-based prior art reference GUIs/schemas; (viii) select scope concept analyzed prior art references, including scope-concept analyzed prior art references cited by the Examiner or Applicant/Inventor, for use in automated rational claim patentability analysis by the system; and (ix) automated generation of claim patentability charts and reports based on the selected scope concept analyzed prior art references. These charts and supporting prior art references can then be disclosed the pending patent application, in a conventional manner, for review and consideration by the patent examiner, during patent examination.

### Using the Open Public Claim Invalidity Contention Analysis (OPCICA) Mode of the Present Invention

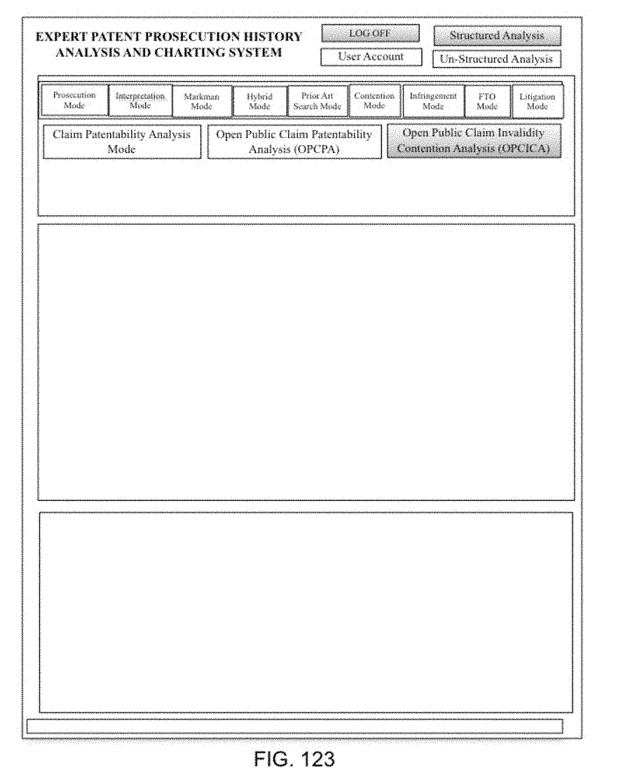

The function of the OPCICA module is to allows members of the public, working alone or together, to review the file history of and allowed patent claims in any granted patent after grant, and generate automated rational claim invalidity contention analysis charts for disclosure in the granted patent, and review and consideration by the patent examiner during a post grant review, a reexamination proceeding or the like. FIG. 123 shows exemplary wireframe-type GUI of FIG. 121, having a graphical icon for accessing the Open Public claim Invalidity Contention Analysis (OPCICA) Mode. Using any Web-enabled client, the Web-based open-public claim patentability analysis (OPCPA) module can be selected by clicking on the graphical icon, and its GUIs and methods used by members of the public to perform the following functions: (i) identify any specific published patent application for public claim review and analysis prior to patent grant; (ii) create a public patent claim review (PPCR) account on the system accessible through the web-based OPCPA module; (iii) load the file history and prior art references of the specified patent in system database 15, and link the same to the PPCR account; (iv) scope-concept analyze the patent claims in the published patent application prior to grant; (v) generate claim scope concept (CSC) based prior art search vectors based on the scope concept analyzed patent claims; (vi) use the CSC-based prior art search vectors to search for new and non-cited prior art references relating to the subject matter of the patent claims in the published patent application; (vii) add to the PPCR account, new and non-cited prior art references for review and analysis using CSC-based prior art reference GUIs/schemas; (viii) select scope concept analyzed prior art references, including scope-concept analyzed prior art references cited by the Examiner or Applicant/Inventor, for use in automated rational claim patentability analysis by the system; and (ix) automated generation of claim patentability charts and reports based on the selected scope concept analyzed prior art references. These charts and supporting prior art references can then be disclosed the pending patent application, in a conventional manner, for review and consideration by the patent examiner, during post grant review, patent examination or like proceedings.

Specification of the Internet-Based Patent Application Searching, Filing, Prior Art Disclosure, and Claim Examination System of the Present Invention Supporting an Open-Public Claim Patentability Analysis (OPCPA) Mode and an Open-Public Claim Invalidity Contention Analysis (OPCICA) Mode of System Operation

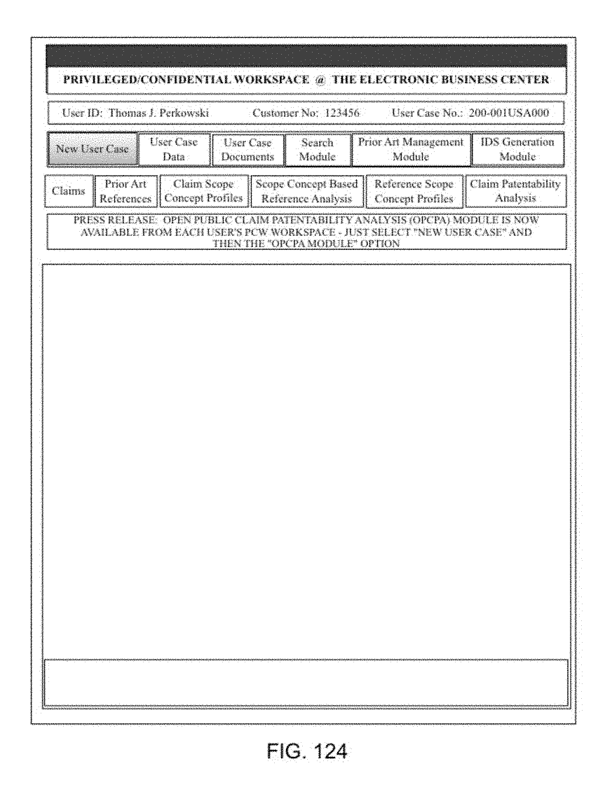

FIG. 124 shows an exemplary wireframe-type graphical user interface (GUI) served up from the Web and other servers of the Internet-based system 300 of FIG. 76, to one or more of its Internet-based client machines. This GUI includes graphical icons allowing members of the public to access and use, from a privileged and confidential workspace (PCW) supported in an Electronic Business Center (EBC) of a patent office, either (i) the Open Public claim Patentability Analysis (OPCPA) Mode of the present invention based on the claim Patentability Analysis Mode illustrated in FIGS. 93 through 120B, and/or (ii) the Open Public claim Invalidity Contention Analysis (OPCICA) Mode of the present invention based on the claim Invalidity Contention Analysis Mode illustrated in FIGS. 46 through 51H.

### Using the Open Public Claim Patentability Analysis (OPCPA) Mode of the Present Invention

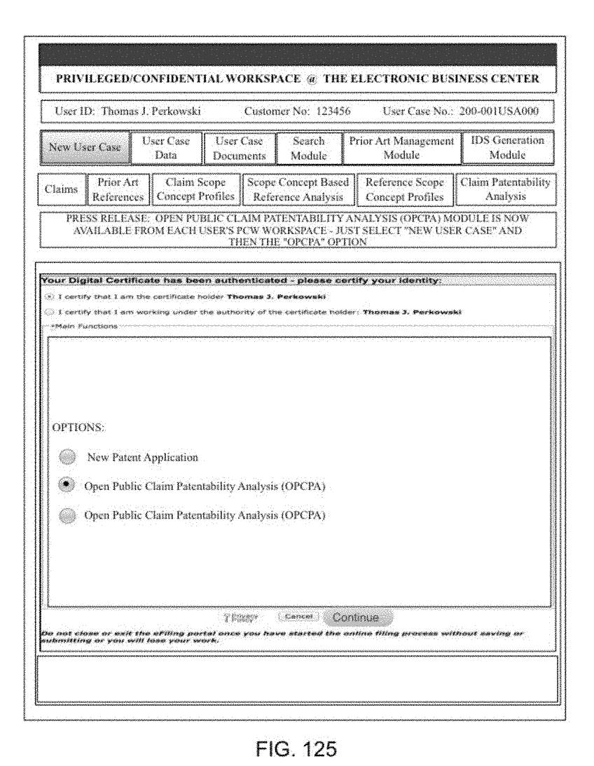

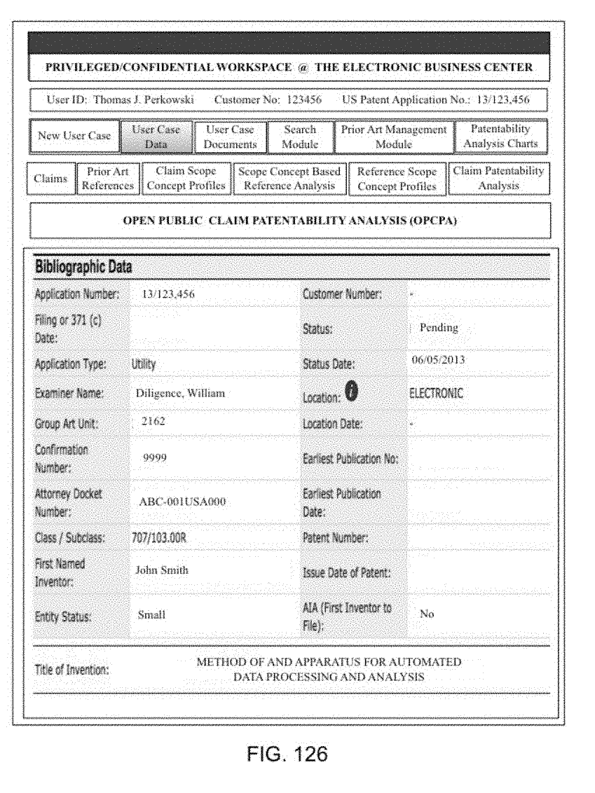

The Open Public claim Patentability Analysis (OPCPA) Mode of the present invention is designed to allow members of the public to analyze the patentability of claims in a published patent application, automatically generate claim patentability analysis charts, and disclose the same in the pending patent application for review and consideration by the patent examiner. FIG. 125 shows the graphical icon on the exemplary wireframe-type graphical user interface (GUI) being selected to access the Open Public claim Patentability Analysis (OPCPA) Mode (and Module) of the present invention, based on the claim Patentability Analysis Mode illustrated in FIGS. 93 through 120B. FIG. 126 shows the bibliographic data for an exemplary published patent application that has been selected by the user for analysis under the Open Public claim Patentability Analysis (OPCPA) Mode of the present invention. Before this step, the file history and claims in the published patent application are automatically loaded into the OPCPA Module for analysis and automated generation of claim patentability analysis charts and disclose the same in the pending patent application for review and consideration by the patent examiner during patent examination.

Using a Web-enabled client, the Web-based open-public claim patentability analysis (OPCPA) module is selected by clicking on the graphical icon in FIG. 125 and its GUIs and methods used by members of the public to perform the following functions: (i) identify any specific published patent application for public claim review and analysis prior to patent grant; (ii) create a public patent claim review (PPCR) account on the system accessible through the web-based OPCPA module; (iii) load the file history of the specified patent application in system database 15 and linked to the PPCR account; (iv) scope-concept analyze the patent claims in the published patent application prior to grant; (v) generate claim scope concept (CSC) based prior art search vectors based on the scope concept analyzed patent claims; (vi) use the CSC-based prior art search vectors to search for new and non-cited prior art references relating to the subject matter of the patent claims in the published patent application; (vii) add to the PPCR account, new and non-cited prior art references for review and analysis using CSC-based prior art reference GUIs/schemas; (viii) select scope concept analyzed prior art references, including scope-concept analyzed prior art references cited by the Examiner or Applicant/Inventor, for use in automated rational claim patentability analysis by the system; and (ix) automated generation of claim patentability charts and reports based on the selected scope concept analyzed prior art references. These charts and supporting prior art references can then be disclosed the pending patent application, in a conventional manner, for review and consideration by the patent examiner, during patent examination.

### Using the Open Public Claim Invalidity Contention Analysis (OPCICA) Mode of the Present Invention

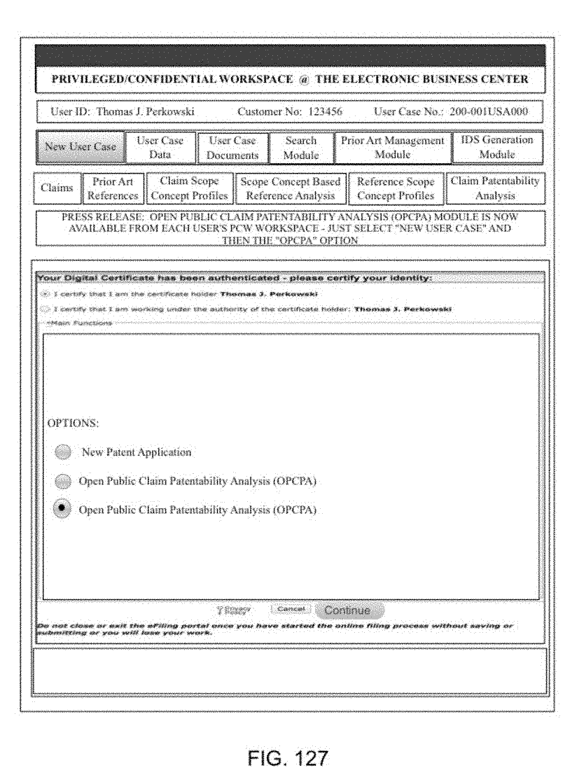

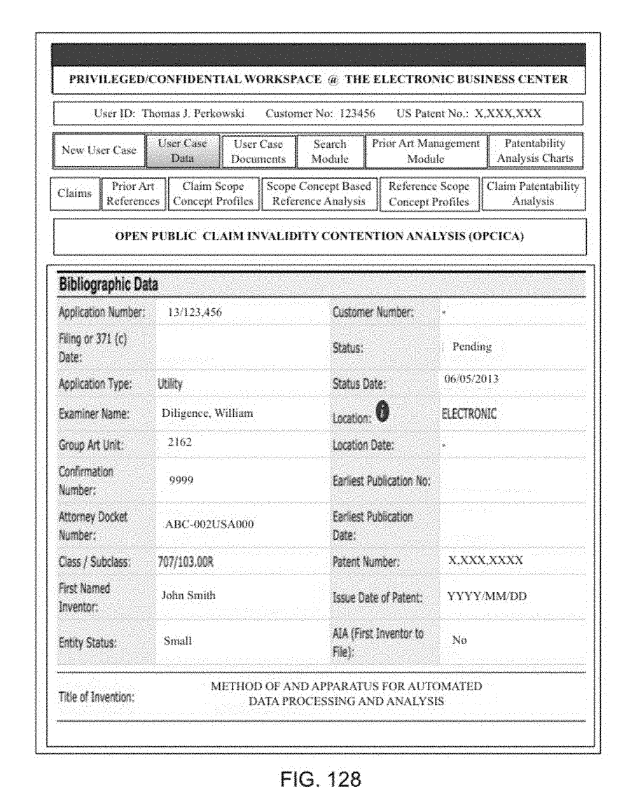

The Open Public claim Invalidity Contention Analysis (OPCICA) Mode of the present invention is designed to allow members of the public to analyze the patentability of claims in a granted patent, automatically generate claim invalidity contention analysis charts, and disclose the same in the granted patent for review and consideration by the patent examiner during a post grant review, a reexamination proceeding or the like. FIG. 127 shows the graphical icon on an exemplary wireframe-type graphical user interface (GUI) being selected to access the Open Public claim Invalidity Contention Analysis (OPCICA) Mode of the present invention, based on the claim Invalidity Contention Analysis Mode of the present invention illustrated in FIGS. 46 through 51H. FIG. 128 show the bibliographic data for an exemplary granted patent that has been selected by the user for analysis under the Open Public claim Invalidity Contention Analysis (OPCICA) Mode of the present invention. Notably, prior to this step, the file history and claims in the granted patent are automatically loaded into the OPCICA Module for analysis and automated generation of claim invalidity contention analysis charts, and disclosure of the same in the granted patent for review and consideration by the patent examiner during post grant review, patent reexamination proceeding or the like.

Using any Web-enabled client, the Web-based open-public claim invalidity contention analysis (OPCICA) module is selected by clicking on the graphical icon in FIG. 127 and its GUIs and methods are used by members of the public to perform the following functions: (i) identify any specific published patent application for public claim review and analysis prior to patent grant; (ii) create a public patent claim review (PPCR) account on the system accessible through the web-based OPCPA module; (iii) load the file history and prior art references of the specified patent in system database 15, and link the same to the PPCR account; (iv) scope-concept analyze the patent claims in the published patent application prior to grant; (v) generate claim scope concept (CSC) based prior art search vectors based on the scope concept analyzed patent claims; (vi) use the CSC-based prior art search vectors to search for new and non-cited prior art references relating to the subject matter of the patent claims in the published patent application; (vii) add to the PPCR account, new and non-cited prior art references for review and analysis using CSC-based prior art reference GUIs/schemas; (viii) select scope concept analyzed prior art references, including scope-concept analyzed prior art references cited by the Examiner or Applicant/Inventor, for use in automated rational claim invalidity contention analysis by the system; and (ix) automated generation of claim invalidity contention charts and reports based on the selected scope concept analyzed prior art references. These charts and supporting prior art references can then be disclosed the pending patent application, in a conventional manner, for review and consideration by the patent examiner, during post grant patent review, patent examination or like proceeding.

In the illustrative embodiments described above, members of the public using a PPCR account in connection with any patent application review or patent grant review can organize in any manner they believe useful or helpful to perform the claim and prior art reference analysis processes required by the OPCPA and OPCICA modes and modules of the present invention. For example, in one use case, a single individual can perform all tasks; in another use case, different people in a group can be assigned to perform different tasks on the system, based according to skill and expertise, to that the highest efficiency and results are attained.

It is envisioned that these open-public patent/application analysis and charting modes are made accessible to the public at large, in any of the systems disclosed above, as well as alternative embodiments thereof, so that members of the public can freely consider and analyze one or more patent applications and/or granted patents using the above described modes of the present invention. For example, members of the public who have registered status, or those who have chosen to remained anonymous, could collectively utilize aspects of the different modes of the present invention to analyze a patent specification and claims, analyze the prosecution history, assign scope concepts to the claims, interpret the claims, analyze prior art references, and create claim invalidity contentions involving the patent. The system of the present invention can also incorporate Web-based collaboration services designed to allow members of the public to push documents and information to particular project folders, make requests and contribute in other ways, so that members of the public, or other users of the system, can contribute information and analysis to any given open-public patent/application analysis and charting project, supported by the system.

It is also understood that an individual or group of individuals will be able to post patent/application target(s) for analysis by interested members of the public, and that these post/requests can also invite others to collaborate on the project, which will work to shape the user work group assigned to a given project. An administrator, or lead investigator, can be assigned to any particular project, and serve to manage the project in the same way that an administrator could control the use of the various modes of the system when other patents and/or applications are under analysis for registered users. The administrator or lead investigator can identify and/or assign tasks to public user groups, or individuals, for completion. Other groups could be assigned review credentials to consider information submitted concerning the patent/application target(s).

In each respect, the collective analysis inertia of multiple individuals having different backgrounds, experiences and intelligence would yield an enormous amount of intellectual energy to be applied to the analysis of the patent/application target(s). All of this may be accomplished by utilizing the various modes of the present invention, whenever a publicized patent/application target is identified by members of the public, and members of the public are permitted access to the system to undertake such analysis in accordance with the principles of the present invention.

Providing the Internet-Based Patent Analysis and Charting System and the Internet-Based Patent Application Searching, Filing, Prior Art Disclosure, and Claim Examination System of the Present Invention with Automated Document Generation Module Allowing Automated Generation of XML-Based Patent-Related Documents from Output XML-Based Chart Structures, and Automated Synchronization of Data Content Among XML-Based Documents and the System Database During the Document Generation Process

Another object of the present invention is to provide the multi-mode patent analysis and charting system 5 and Internet-based patent application searching, filing, prior art disclosure, and claim examination system 300 with an automated XML-based document generation module, that interacts with and shares data between one or more of the patent analysis and charting modules (i.e. modes) supported by the system, so that any user (e.g. Inventor/Applicant patent attorney, patent agent, patent examiner, judge, public advocate, engineer, scientist, individual et al) can simply and quickly generate a particular patent-related document supported within the extensive patent-related document library of the system (e.g. Request for Re-examination, Office Action With Argument for Non-Patentability, Response to Office Action with Argument for Patentability, Argument For Patent claim Invalidity Contention, etc.) based on, or using information from, the output chart structures generated during patent analysis and charting operations supported on the multi-mode patent analysis and charting system. In addition to the automated generation of patent-related documents, the automated XML-based document generation module also supports the automated synchronization of data content among XML-based target and source documents and the system database during the document generation process. This is very useful when the user needs to edit the XML-based patent document, and add facts relating to (i) particular limitations or sub-imitations in a particular patent claims, (ii) a particular prior art reference, and/or (iii) other facts, analysis or observations that support the arguments being made. By design, the system of the present invention has the capacity to synchronize such added data content (made in the XML-based patent-related document during the editing and intermediate/final drafting process) with the XML-source document (i.e. the XML-based chart structure) and also with the system database 15, in which all data content is stored in the enterprise-level system.

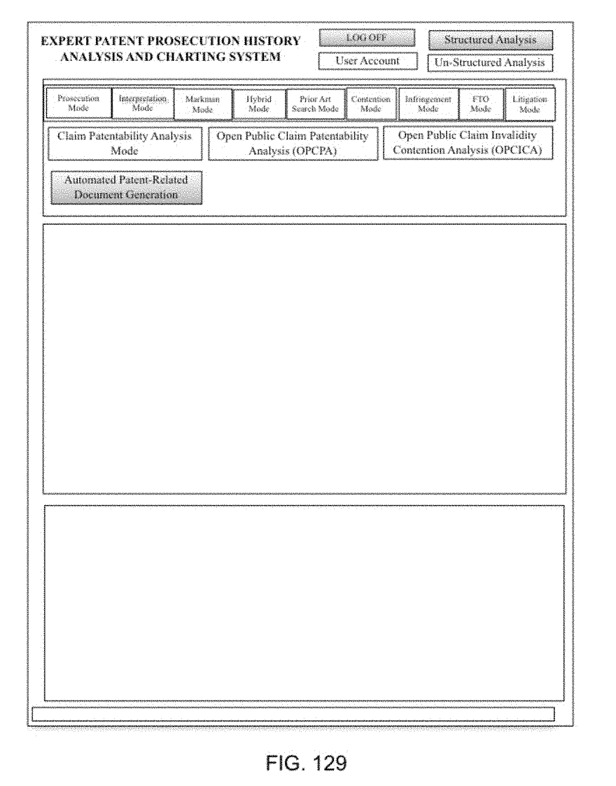

As shown in FIG. 129, the user selects the automated XML-based document generation module by clicking on a graphical icon (e.g. having the form of a document, perhaps), and providing access to the GUI screens and methods supported by the XML-document generation mode implemented within the multi-mode system by the XML-based document generation module. The function of the automated XML-based document generation module is to allow a diverse class of system users to automatically generate “file-ready” or “near-file-ready” documents using templates or otherwise (e.g. legal filings, post-grant filings, government agency office actions, legal memorandums, legal opinions and/or judicial orders etc.) containing natural-language arguments in support of particular positions, decisions or opinions on a wide range of issues, including patent-related issues, concerning, but not limited to: (i) the invalidity of granted patent claims of improper scope in view of the state of the art in view of particular prior art reference information analyzed that may also be contained in generated claim invalidity contention charts; (ii) the patentability of pending patent claims in view of particular combination of prior art references analyzed in generated claim patentability charts; (iii) the non-patentability of pending patent claims in view of particular prior art references analyzed in generated claim patentability charts; (iv) the allowability/patentability of pending patent claims in view of particular prior art references analyzed in generated claim patentability charts or claim invalidity contention charts; (v) the infringement of granted patent claims in view patent claims and products/services analyzed in generated claim infringement analysis charts; (vi) the non-infringement of granted patent claims in view patent claims and products/services analyzed in generated claim infringement analysis charts; (vii) the freedom to operate (FTO) particular product and/or service designs around particular patent claims analyzed in FTO-based charts; or other issues for which a document format supports the delivery of information stored in a database environment, etc.

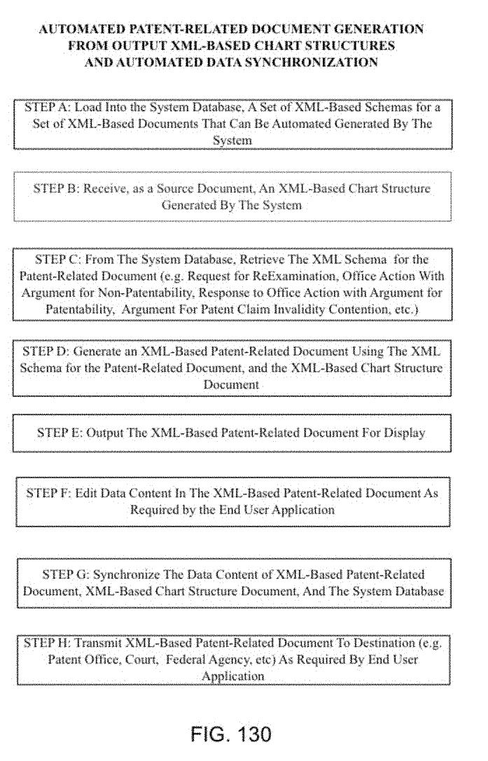

Referring to the flow chart shown in FIG. 130, and schematic diagram in FIG. 131, the document generation process supported by the automated XML-based document generation module within system 5 (or 300) will now be described in detail as follows.

As indicated at Block A in FIG. 130, the first step of the document generation process involves (a) loading into the system database, a library of XML-based schemas for a set of XML-based patent-related documents (e.g. Request for Re-examination, Office Action With Argument for Non-Patentability, Response to Office Action with Argument for Patentability, Argument For Patent claim Invalidity Contention, etc) that can be automatically generated by the system. Also shown is the loading of a library of XML-based schemas for a set of XML-based chart structures that can be automatically generated by the system.

As indicated at Block B in FIG. 130, the second step of the document generation process involves receiving, as an XML-based source document, an XML-based chart structure generated by the system using the appropriate XML chart structure schema. The actual XML chart schema used will depend on the particular mode of patent analysis and charting the user is using when the request for automated document generation is made. The user has great flexibility in choosing which mode of patent analysis to use, and when to request automated XML document generation and synchronization services on the platform.

As indicated at Block C in FIG. 130, the third step of the document generation process involves retrieving from the system database, the XML schema for the patent-related (i.e. target) document (e.g. Request for Re-examination, Office Action With Argument for Non-Patentability, Response to Office Action with Argument for Patentability, Argument For Patent claim Invalidity Contention, etc.). In general, the XML schema for each patent-related document type will be designed based on an analysis of a variety of example documents in the document type class.

For example, consider the case where the patent-related document is a patent invalidity contention brief to be generated by a patent attorney who has examined the claims in a granted patent involved in a patent litigation with his/her client. Typically, the claim invalidity contention brief document has a great deal of boiler plate type text regarding the legal ground of claim rejection under 35 USC Sections 102 and 103, and this text can be assigned to data fields in the XML schema which are static or not-variable, in any given time frame where the patent laws are not in a state of flux. However, in the 35 USC Section 103 and 103 patent claim rejection paragraphs, there are data fields in the XML schema for (i) identification of the claim or claims being rejected, (ii) identification of the prior art reference or prior art references being relied on to support the claim rejection, and (iii) the reasons why the patent claim(s) are obvious in view of the prior art reference or combination of prior art references. These reasons must be set forth clearly in the claim invalidity contention brief (e.g. just one type of patent-related document supported by the system of the present invention).

As indicated at Block D in FIG. 130, the fourth step of the document generation process involves generating an XML-based patent-related document (i.e. target document) using (i) the XML schema selected for the XML-based patent document, and (ii) the XML-based chart structure. Looking to the output XML-based chart structure generated during the claim invalidity contention analysis mode (i.e. Mode 5), the XML-based chart structure will contain data fields indicating what substantiating prior art support of given prior art reference has been linked to any particular claim limitation or claim sub-limitation language string in the rejected claim, by way of claim scope concepts, during previous data processing operations, and it is assumed that such prior art disclosure support should provide the primary reasons why any given claim limitation has been met by any given prior art reference. However, as will be discussed below, there will often be secondary reasons why particular disclosure in a particular prior art reference provides good or excellent prior art disclosure against one or more specific or all claims limitations or claim sub-limitations in any given patent claim, and the patent attorney will want to record these reasons (i) in the claim invalidity contention brief, (ii) in appropriate data fields in the XML-based contention invalidity chart structure, and (iii) in the system database, where all data is ultimately stored in the system. As will be described below, the system of the present invention has XML data synchronization capabilities that enables this data synchronization to occur automatically, to the benefit of all parties involved.

As indicated at Block E in FIG. 130, the fifth step of the document generation process involves outputting the XML-based patent related document (i.e. XML-based target document) for display. Preferably, this will involve downloading the XML-based spreadsheet onto a laptop computer or workstation for review, or reviewing the chart structure document directly on a client computer system while it is logged into the system over a network connection.

As indicated at Block F in FIG. 130, the sixth step of the document generation process involves editing the data content in the XML-based patent-related document as required by the end user drafting and editing the document. In general, the editing process will depend on the end user, the complexity of the arguments in the XML-based patent-related document generated, the number of claims involved and prior art references being cited, the complexity of the patent file history, whether or not the claims have been or are involved in patent litigation, and if so, then the number of products and/or services involved in the patent litigation, and the like. In any event, the XML-based output chart structure generated by the system should reflect the complexity or simplicity of the facts and circumstances surrounding the patent claims involved in the patent-related document which will be independent of the specific type of patent-related document being generated.

In connection with the use case example given above, involving the generation of a claim invalidity contention brief, the system allows the patent attorney or his/her paralegal to provide and record (in the XML document) one or more “secondary reasons” why a prior art reference provides significant prior art disclosure against one or more claim limitations in the patent claim. These secondary reasons will be added to the XML-based claim contention invalidity brief in a marked-up “secondary reasons” data field, which will allow the system of the present invention to data synchronize these secondary reasons (i.e. data content) with the XML-based source chart structure (which will also be provided with a “secondary reasons” data field) as well as its XML schema, and the system database where all data is ultimately stored on the system, and backed up in multiple locations around the world in a manner well known in the art.

As indicated at Block G in FIG. 130, the seventh step of the document generation process involves synchronizing the data content of XML-based patent-related document, the XML-based chart structure document, and the system database. This takes place using XML-based data synchronization techniques well known in the art.

Notably, for XML-based data synchronization to occur in a proper manner, it is essential all source and target XML documents, and of course, their respective XML schemas, must have all of the proper data fields that will be pre-contemplated as being essential to capturing all of the various kinds of data and information on the system platform required during patent analysis, charting operations, and also automated patent-related document generation, in accordance with the principles of the present invention.

Such requirements fall within the art of XML schema and document set design, and can be practiced using conventional XML development tools including, for example, but not limited to: an XML editor, XML Data Mapper, a Web Services Definition Language (WSDL) Editor, Extensible Stylesheet Language (XLST) and XML Query Language (XQuery) Debugger as contained in LIQUID XML Studio 2013 by Liquid Technologies Limited http://www.liquid-technologies.com. Of course, there are many other XML development platforms that can be used for the XML document development purposes at hand.

As indicated at Block H in FIG. 130, the eighth step of the document generation process involves transmitting the XML-Based patent-related document to its destination (e.g. Patent Office, Federal or International Court, Federal Agency, etc) as required by end user application). This can take place by email or other electronic communication protocols known in the art.

As illustrated in FIG. 131 and described above, the automated document generation facility within the multi-mode system 5 (or system 300) supports the following operations: (i) the mapping of data content within the system database of the multi-mode patent analysis and charting system of the present invention, to an output XML-based chart structure (i.e. XML-based source document); (ii) the mapping of data content from the output XML-based chart structure to a XML-based patent-related document (i.e. XML-based target document); (iii) the display of the XML-based patent-related document; (iv) the editing of data content within the XML-based patent-related document; and (v) the synchronization of data content among the XML-based patent-related document, the XML-based chart structure (i.e. document), and the system database within the multi-mode patent analysis and charting system 5 (or system 300).

These XML-based automated document generation techniques of the present invention will provide system users with an unprecedented level of automation capability in (i) charting and visualization of patent claim and prior art analysis, (ii) generating patent-related documents based on generated chart structures, and (ii) editing and synchronization of data content within these generated patent-related documents. Such document automation will be useful whenever it is necessary, required or desired for the user to efficiently generate, prepare and file legal documents in the patent office, federal or international, court or elsewhere while (i) pursuing patent protection based on claims of proper scope in view of the state of the prior art, (ii) pursuing freedom from the tyranny of patent claims of improper scope, and/or (iii) navigating through the risky and rewarding waters of technological innovation.

Generally, a system of the present invention can take several forms as noted above. First, the system can be deployed to a single computer as a standalone application. More preferably, the system is deployed on a server or series of servers. In a standalone application, the system components would need to include some or all of the system modules as disclosed herein, depending upon a particular implementation.

This disclosure further describes embodiments of the invention as systems, non-transitory computer-readable media (e.g., embodied in a hard or floppy disk or other computer storage medium), and methods of using analysis platforms to analyze information within controlled environments that include on-line and off-line components. Throughout this disclosure, controlled environments include environments that are accessible to users and that allow users to analyze and control information within a segregated environment. The analysis platforms allow users to analyze information directly, indirectly and interactively. In one example, the method includes accessing the analysis platforms using an administration application that allows users to generate and modify analysis segments for a defined amount of time within the controlled environments. The administration application controls a portion of the controlled environments for access by other users. The administration application further links analysis segments to patent claims. The administration application enables users to configure the controlled environments for a defined amount of time within the controlled environments. As a result, the analysis platform supports a plurality of distinct controlled environments that may be linked for further integrated analysis.

The administration application allows users to perform functions, such as create other user profiles; select patents; select an analysis time period; generate messages; select a communications preference; select display and modification parameters; and establish analysis segments; among other functions.

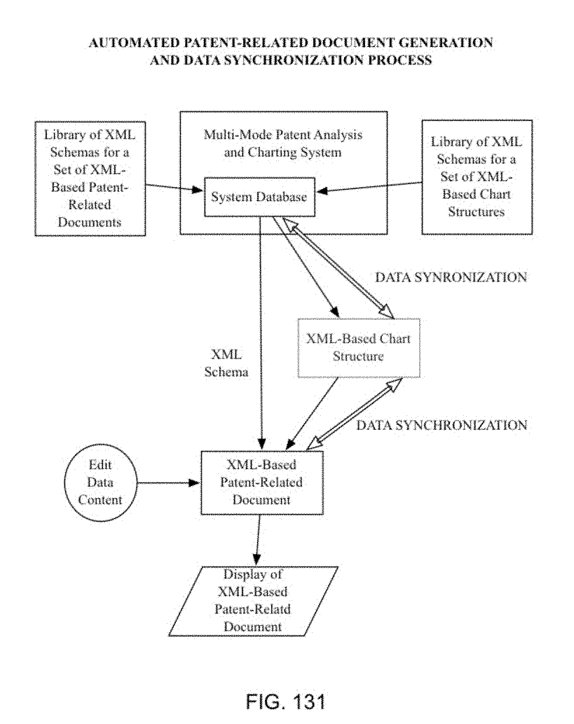

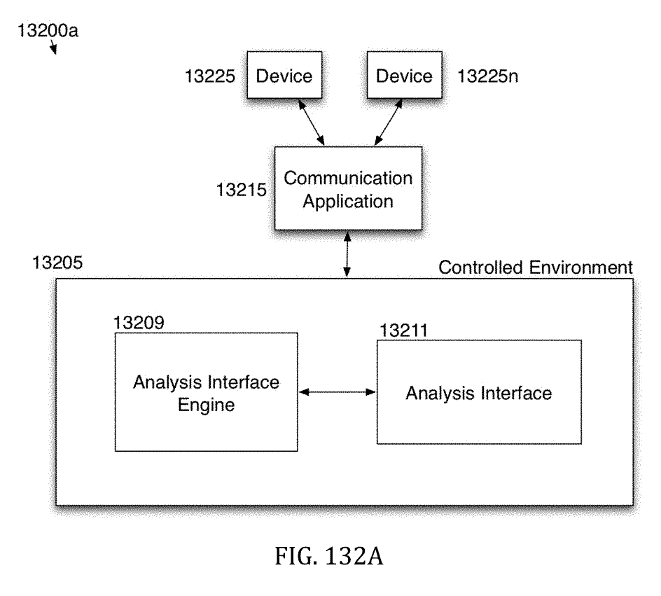

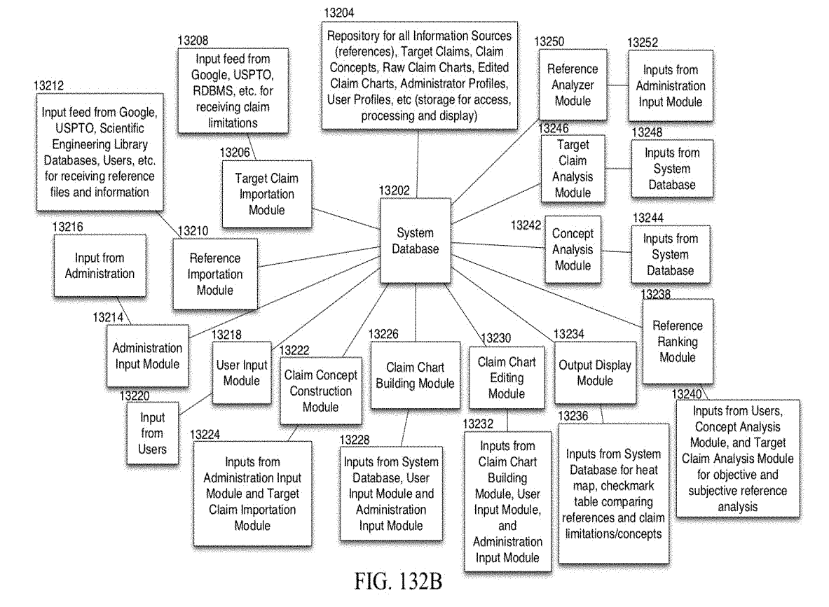

A generalized embodiment of an overall system configuration is illustrated as a system 13200a in FIG. 132A. The embodiment of an exemplary analysis platform 13200a in accordance with the invention includes a controlled environment 13205, a communication application 13215, and one or more user devices 13225 to 13225n (where n is any number of devices). According to one example, the controlled environment 13205 provides users of the analysis platform 13200a with a secure gateway for navigating various on-line resources. The controlled environment 13205 may include a plurality of components for communicatively coupling with other data repositories or with the one or more user devices 13225 to 13225n. For example, the controlled environment 13205 may include an analysis interface engine 13209 and analysis interface 13211, among other components.

The user devices may include or access a communication application 13215 for accessing resources through the controlled environment 13205. The communication application 13215 may provide a consistent graphical user interface (“GUI”) for navigating various resources, including the analysis interface engine 13209, and analysis interface 13211, among other resources. The analysis interface 13211 receives and provides information from communication application 13215 to analyze and manipulate information contained within controlled environment 13205.

The communication application 13215 allows users to directly access the controlled environment 13205 via a private or public dedicated URL, or dedicated connection method including a virtual private network (“VPN”). Once within the controlled environment 13205, the analysis interface engine 13209 may allow users to search information and generate reports for the information, including claim charts and contentions, with the controlled environment 13205.

As described in further detail below, if the user is registered with an access server that is associated with the controlled environment 13205, the user may be authenticated by matching authentication information with access information that preexists on the access server. Alternatively, if the user is not authenticated by the access server, then the user may be invited to submit requested authentication information or take other action.

If the user is authenticated, then the user may be directed to the analysis interface engine 13209, which enables the user to access case specific information. The analysis interface engine 13209 presents users with information and templates that may be customized, while providing users with a functionality and uniformity within the controlled environment 13205. In other words, the functionality of the analysis interface engine 13209 remains familiar to users within the controlled environment 13205.

The invention might be implemented in a variety of ways. In one embodiment, the system code is written using Adobe System's ColdFusion Markup Language (CFML) version 8, HyperText Markup Language (HTML), JavaScript and Microsoft's Structured Query Language (SQL). The application may be developed on a Windows XP platform but can also run on Windows 7, among others. The system uses both the Windows Internet Information Services (IIS) and ColdFusion Server services to process the code and data into web pages. In one implementation, all data records are stored in a Microsoft SQL Server 2005 database using a relational database schema.

The code may be organized using the Fusebox methodology. Fusebox is a framework for building web applications comprised of circuits that correspond to directory and file structures on the web server that function as event handlers to serve up code templates as necessary. One skilled in the art would appreciate that many variations are possible without departing from the scope of the invention as described herein.

An embodiment of the overall system configuration is illustrated as a system 13200b in FIG. 132B and described more generally herein. Each module communicates directly or indirectly with the System Database 13202 to receive and send information for a module's functionality, and further may receive information from other modules directly, or indirectly through the System Database 13202.

The System Database 13202 is a relational database serving as or coupled to a repository 13204 for all Information Sources, generally referenced herein by the terms prior art, prior art references, prior art documents, system descriptions, product descriptions, or other documents and descriptions that are to be analyzed by the system 13200b with respect to the Target claims. The System Database 13202 further includes various information via the repository 13204, including Target claims, claim Concepts, Raw claim Charts, Edited claim Charts, Administrator Profiles, User Profiles, etc., representing stored data associated with the aforementioned, such as for accessing, processing and displaying of a variety of information by the system 13200. Additional analysis may be stored by the System Database 13202 including Target claim Analysis, Concept Analysis and Reference Ranking analysis as described further below.

The Target claim Importation Module 13206 receives and processes information related to one or more claims of one or more target patents. The claim information may be retrieved as input 13208 from feeds from Google Patents, the USPTO, RDBMS (Relational Database Management System) or other sources having claim limitations for target patents. The Target claims may be segmented according to the familiar claim limitation breakdown by semicolon or otherwise, and further configured via user input to make corrections or changes as suitable to reflect the claims as issued, reissued or otherwise recognized as amended by the USPTO.

The Reference Importation Module 13210 receives and processes information related to one or more Information Sources, such as prior art references or product/service descriptions. The Information Sources may be retrieved as input 13212 from feeds from Google Patents, the USPTO, Scientific Engineering Library Databases, Users, etc. for receiving reference files and reference information. PDF or other electronic references may also be received by the Reference Importation Module.

The Administration Input Module 13214 receives inputs 13216 from a case administrator for manipulation of case information, including template fields, claim associations, claim concepts, Target Patents for the Target claim Importation Module, etc.

The User Input Module 13218 receives inputs 13220 from users of the system 13200b for manipulation of case information including disclosures of the Information Sources matching claim concepts, motivation to combine information, and other information related to the Information Sources. The User Input Module 13218 also receives inputs related to information to be displayed or output from the System Database 13202 including various forms of claim charts, claim reports or other views/reports of information contained within the System Database 13202.

The claim Concept Construction Module 13222 receives inputs 13224 from Administration Input Module 13214 and Target claim Importation Module 13206. In exemplary embodiments, the claim Concept Construction Module 13222 is configured to parse Target claim information into features representative of portions of a claim limitation. The features are also referred to herein as concepts, claim concepts, segments, or claim segments. Because claims oftentimes repeat specific claim language or use different claim language to represent an aspect of a claimed invention, there is repetition of claim limitations or minor variances with respect to claim limitations across multiple claims of a patent, or claims in different patents from the same family. Concepts are used to represent the same or similar features recited in Target claims that are repeated within a single claim or among other claims.

The claim Concept Construction Module 13222 presents to a User, typically a User with Administrator privileges, all claims from a Target Patent. From the claims of a Target Patent, the User may extract concepts such that the concepts are representative of all claim limitations for each claim of a Target Patent. In one exemplary embodiment, the claim Concept Construction Module 13222 presents a list of claims and permits the user to drag and drop concepts into a Concept Extraction area for grouping similar recited claim language for tagging or association with one concept. In this way, various recitations of claim language are associated with the same concept. In addition, the System Database 13202 associates each concept with the corresponding claim limitation indicated by the user. In another embodiment, the concepts for Target claims may be listed manually by a user in the form of a chart, whereby the claim language appears in a left hand column and the one or more concepts for each claim limitation appear in the corresponding row for the claim limitation. The user will mentally extract one or more concepts that represent each claim limitation for each Target claim and write, type or otherwise record the information in a claim chart. Once all concepts are identified and recorded manually in a chart for the Target claims, the User will associate, tag or otherwise link each concept using an interface of the claim Concept Construction Module 13222, thereby instructing the System Database 13202 as to the relationship between each concept and one or more claim limitations (as described further below with respect to other figures). In yet another embodiment, the claim Concept Construction Module 13222 may be configured to receive an identification of concepts for each limitation of each Target claim by presenting the user with a first claim limitation. The user will then input a first concept for that claim limitation. The concept will be added to a list displayed to the user. The user will then input a second concept for the claim limitation, with the second concept added to the list of concepts for the claim limitation, and so on, until the claim limitation has the appropriate concepts associated to it. For the next claim limitation, the user may input a concept for the claim limitation or choose an appropriate concept from the list of concepts previously associated with a different claim limitation. In this way, concepts are reused or may be added to the case. This workflow is continued until all Target claims have appropriate concept associations.

In a further configuration for each of the above embodiments for the claim Concept Construction Module 13222, the module may additionally allow the user to pre-select claims and/or claim limitations that are similar from a list of all claims. In this manner, after concept associations are indicated by a user for a claim limitation, the claim Concept Construction Module 13222 will associate the same list of concepts for the pre-selected claims or claim limitations that are identified by the user as being the same or similar to the just analyzed claim limitation, further advancing the workflow and avoiding repetition of having to make similar associations, and also avoiding mistakes in not making the same associations for a limitation that were intended by the user, but overlooked. By populating the same or similar claim limitations in this way, the user still has the ability to alter or change pre-populated concepts at any time.

The claim Chart Building Module 13226 receives inputs 13228 from the System Database 13202, User Input Module 13218 and Administration Input Module 13214. In an exemplary embodiment, the claim Chart Building Module 13226 is configured to generate claim charts in various forms by allowing the user to specify one or more Target claims and one or more Information Sources (references) that are to be contained within a claim chart. Single or multiple claim charts can be specified by a User and delivered to a user's access device, or otherwise stored in the System Database 13202, in various formats including Microsoft Word, PDF, Microsoft Excel, XML or other electronic document formats. The Windows COM standard is used to put information for the System Database 13202 into various Microsoft Word-based claim charts and other Microsoft Word based reports.

The claim Chart Editing Module 13230 receives inputs 13232 from claim Chart Building Module 13226, User Input Module 13218 and Administration Input Module 13214. In an exemplary embodiment, the claim Chart Editing Module 13230 is configured to edit or otherwise revise claim charts in various forms by allowing the user to specify changes to claim charts generated by the claim Chart Building Module 13230. Single or multiple claim charts can be specified for changes or edits, indicated by a User, and then delivered to a user's access device, or otherwise stored in the System Database 13202, in various formats including Microsoft Word, PDF, Microsoft Excel, XML or other electronic document formats.

The Output Display Module 13234 receives inputs 13236 from the System Database 13202. In an exemplary embodiment, the Output Display Module 13234 is configured to output or otherwise display all information stored in the System Database 13202 in various configurations that show individual data elements and/or relationships between the data elements including concepts, claim limitations, claims, Target claims, Target Patents, User access privileges, data accessed or input by a User, Information Source data elements including associated meta data such as dates, subjective rankings, User comments, claim charts, other reports, etc.

The Reference Ranking Module 13238 receives inputs 13240 from Users, Concept Analysis Module 13242, and Target claim Analysis Module 13206 for objective and/or subjective reference analysis. In various methodologies and algorithms described further herein, the Reference Ranking Module 13238 associates various criteria for determining how a reference compares to other references in an objective fashion (number of concepts disclosed, particular concepts disclosed as compared with how many other references disclose the same concept, how many claims/claim limitations require a particular concept, etc.) and also in a subjective fashion (how users rank the reference overall, how the user ranks particular relevance or importance of a reference's disclosure of a concept, etc.). The Reference Ranking Module 13238, in combination with other modules, is used to generate and further identify specific results tailored to identifying the most important references to claims, claim limitations or concepts as requested by a User or other portions of the system 13200, including other modules.

The Concept Analysis Module 13242 receives inputs 13244 from the System Database 13202 for objective and subjective analysis of concepts. In various methodologies and algorithms described further herein, the Concept Analysis Module 13242 associates various criteria for determining how a concept compares to other concepts in an objective fashion (number of times a concept is disclosed by the references as a whole, frequency of a concept disclosed by each reference, number of times a concept is associated with a claim and/or claim limitation and/or Target Patent, etc.) and also in a subjective fashion (how users rank the concept's disclosure by a reference overall, how the user ranks the particular relevance or importance of a reference's disclosure of a concept, etc.). The Concept Analysis Module 13242, in combination with other modules such as the Reference Ranking Module 13238 and the Target claim Analysis Module 13246, is used to generate and further identify specific results tailored to identifying the most important concepts for claims, claim limitations or references as requested by a User or other portions of the system 13200, including other modules.

The Target claim Analysis Module 13246 receives inputs 13248 from the System Database 13202 for objective and subjective analysis of concepts. In various methodologies and algorithms described further herein, the Target claim Analysis Module 13246 associates various criteria for determining how a Target claim compares to other Target claims in an objective fashion (number of different concepts required by a Target claim, frequency of a concept as associated to claim limitations of a Target claim, frequency of similar claim limitations identified by a user as compared to other Target claims, frequency that words of a concept are recited in a Target claim, etc.) and also in a subjective fashion (how users rank the importance of a Target claim as compared to other Target claims, how the user ranks the particular relevance or importance of a claim limitation of the Target claim to the importance of claim limitations of the Target claim or the claim limitations of other Target claims, the frequency in which a single reference or multiple reference combination discloses an entire claim limitation of the Target claim based on the user's ranking of a concept's strength of disclosure for each concept associated with the claim limitation, the frequency in which a single reference or multiple reference combination discloses the entire Target claim based on the user's ranking of a concept's strength of disclosure for each concept associated with the Target claim, etc.). The Target claim Analysis Module 13246, in combination with other modules such as the Reference Ranking Module 13238 and the Concept Analysis Module 13242, is used to generate and further identify specific results tailored to identifying the most important concepts for claims, claim limitations or references as requested by a User or other portions of the system 13200, including other modules.

The Reference Analyzer Module 13250 receives inputs 13252 from the System Database 13202 for objective and subjective analysis of concepts. In various methodologies and algorithms described further herein, the Reference Analyzer Module 13250 associates various criteria for determining how a reference or information source compares to other references or information sources in an objective fashion (number of different concepts disclosed by a reference, frequency of a concept disclosed by the reference, frequency that a word of a concept or a phrase of the concept matches words of the reference, etc.) and also in a subjective fashion (how users rank the importance of a reference as compared to other references, how the user ranks the particular relevance or importance of a references disclosure as a primary reference candidate compared with other references, how user's specify the importance of a reference's priority date with respect to one or more Target claims based on the priority date of each Target claim, the frequency in which a single reference or multiple reference combination discloses an entire claim limitation of the Target claim based on the user's ranking of a concept's strength of disclosure for each concept associated with the claim limitation, the frequency in which a single reference or multiple reference combination discloses the entire Target claim based on the user's ranking of a concept's strength of disclosure for each concept associated with the Target claim, etc.). The Reference Analyzer Module 13250, in combination with other modules such as the Reference Ranking Module 13238, the Target claim Analysis Module 13246 and the Concept Analysis Module 13242, is used to generate and further identify specific results tailored to identifying the most important concepts for claims, claim limitations or references as requested by a User or other portions of the system 13200, including other modules.

When deployed as a cloud-based system on a server or system of servers, individual users can preferably access the system 13200b using any one of several available commercial browsers such as Firefox, Internet Explorer, Chrome, and Safari. Depending on the suite of features deployed by a particular installation of the system, using commercially available browsers might require the users to install and occasionally update browser plug-ins. Alternatively, the users can download and install a standalone thin-client. Users accessing the system 13200b through one of the preferred commercial browsers are presented an intuitive graphical user interface having features familiar to most users—menus, radio-buttons, tabs, folders, links, etc.

In relation to the generalized embodiment of an overall system configuration of system 13200a in FIG. 132A, the modules, information and functionality of FIG. 132B and their respective descriptions may be further understood with the high level blocks of FIG. 132A. For example, the controlled environment 13205 may include system database 13202 (including information of repository 13204), target claim importation module 13206, reference importation module 13210, administration input module 13214, user input module 13218, claim construction module 13222, claim chart building module 13226, claim chart editing module 13230, output display module 13234, reference ranking module 13238, concept analysis module 13242, target claim analysis module 13246, reference analyzer module 13250. The analysis interface engine 13209 of controlled environment 13205 may include claim construction module 13222, claim chart building module 13226, claim chart editing module 13230, output display module 13234, reference ranking module 13238, concept analysis module 13242, target claim analysis module 13246, reference analyzer module 13250. The analysis interface 13211 of controlled environment 13205 correlates data of the system 13200b, inputs from the user, and various displays of data in cooperation with analysis interface engine 13209. For example, analysis interface 13211 may generally represent input feed 13208, input feed 13212, input from administration 13216, input from users 13220, and the various inputs 13224, 13228, 13232, 13236, 13240, 13244, 13248 and 13252.

Initially, the users of a system in accordance with the invention, which in this embodiment and throughout the disclosure herein may be a system as exemplified by systems 13200a and/or 13200b, as reflected in FIGS. 132A and 132B, respectively, or may vary significantly therefrom as described herein, may establish a project, so as to segregate a current instance of analysis and evaluation from past or future instances. Any user with appropriate access rights, for example a “Case Administrator,” can establish a project. In the context of one embodiment, a patent analysis project, the project can be referred to as a “case,” which may or may not uniquely correspond to, for example, a pending litigation. The establishment of a case may create a link on a navigation screen and may also automatically populate the case with certain menus, links, etc., to assist the users' further preparation of the case for analysis. Other levels of access rights may be provided with other levels of permission and accordingly other abilities to manipulate the system to access certain features and the data that resides therein.

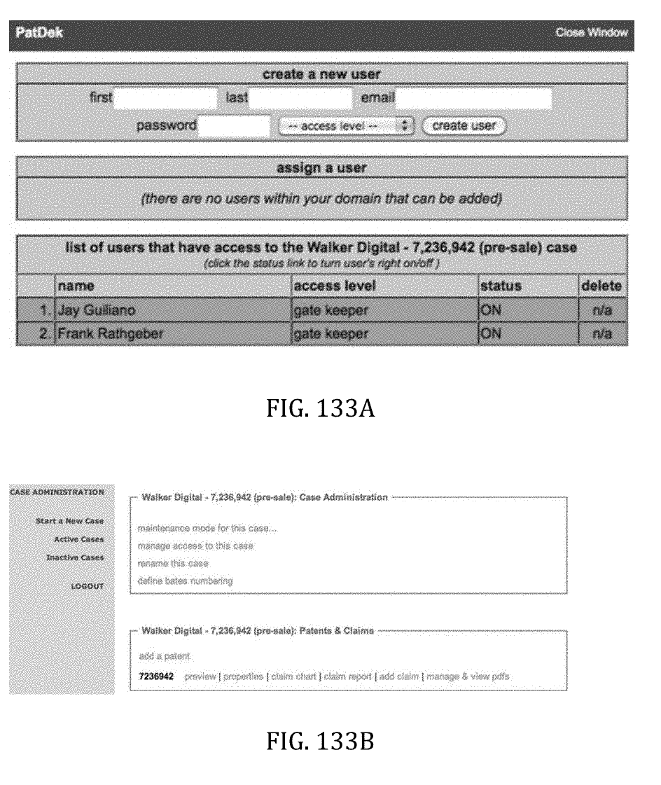

Referring now to FIG. 133A, the system allows users having sufficient access rights to also create new users associated with or within a particular case or project. Users are preferably recorded and recognized using their first names, last names, email address and passwords. Preferably, the user logs into the system by way of his or her user name and password. Preferably, a user with sufficiently high access can manage and establish other users with equal or lower levels of access. To ensure security users might also be subject to IP address checks, security questions if an unrecognized device or IP address is being used to access the system or even asked to submit randomly generated verification codes, unique to each user, that are obtained by way of a smart phone application or text messaging system.

Many different levels of access can be created, each having its own associated rights to use the system and its features, as explained herein in more detail. Once a user is created, the user name is populated. From there, certain users can be added or removed from the case. In this particular example, the only users associated with the “Walker Digital” case are Jay Guiliano and Frank Rathgeber. Both individuals have “gate keeper” access rights. The labels on each level of access, such as “gate keeper” are arbitrary and customizable as are the access rights and features permitted to be used or even viewed.

Preferably, “gate keeper” level of access allows the establishment and management of lower level user rights, but does not permit access to searching, analysis or data entry, for example. This screen also preferably displays the number of users, their access levels, their status and further provides for the ability to delete users. Maintenance of users and access rights is preferably flexible so that the users of the system can provide each level of user with a customized bundle of access rights.

Other specific system user levels can be created as needed. For example, in a large crowd-sourcing project, it might be desirable to have one individual monitor and manage the performance of a plurality of third party system users. Potentially, such a manager might be able to access menus and system features relating to monitoring performance and activity of the third party system users, but not be able themselves to enter or manipulate data relating to the projects. As yet another example, certain users might be granted the ability only to upload new potential sources of information. Other user access levels might be permitted to upload new information sources and evaluate those information sources, or alternatively upload new information sources but only evaluate the sources others have uploaded, as a quality control mechanism. Higher levels of access could potentially add or delete information sources, run certain types of reports, etc. Higher levels still might be able to access deeper levels of the relational database to expand, contract, edit, link or delink the concepts discussed herein.

FIG. 133B depicts a case administration screen of an embodiment of the present invention. From this screen, the users of the system can start a new case, review active cases or review inactive cases by clicking the appropriate link. Within an active case, for example the “Walker Digital” case depicted in FIGS. 133A and 133B, the user has several options. First, the users can enter a maintenance mode for the case. The maintenance mode locks down the information contained in the database so that fundamental aspects of the database can be edited or the case can be placed on inactive status. The user may also set up new users or edit or modify current user access rights. The case title itself may be edited. Additionally, the case administration screen allows the user to set up bates numbering conventions that will be used by information source documents by the various parties to a patent litigation, if the project is associated with a patent litigation.

In the area depicted below in FIG. 133B, the user may also add, edit, manipulate or modify the database with respect to individual target documents, in this case a patent document. By clicking on the appropriate link, users with sufficient access can add new patents. Alternatively, for an existing target document, in this case the '942 patent, users with sufficient access rights can preview the patent, edit the properties associated with this patent in the database, create or edit or modify claim charts, run reports, such as a claim report, add or edit claims of interest and manage and view associated documents, such as .pdfs associated with the target document.

If another project has already analyzed a particular patent, and the users associated with this project have access to the associated database information, the system can optionally import or copy information from that previous project. In a similar fashion, the system can create backups of projects and all of the associated data on a predefined schedule or on a variable schedule depending on the frequency of use—for example, while users are entering data backups that occur more frequently than when users are only logging on sporadically.

Preferably, projects are protected from one another and from outside unauthorized access by way of the username/password/security system described above, but also through the encryption of a projects specific data. Indeed, because of the often confidential legal nature of the analysis involved in the a patent analysis embodiment, the administrators of the system might not be able to either view data or decrypt data without particular access codes and authorizations from case administrators.

If a user lacks sufficient access rights, the system may not even grant them the ability to view this screen or alternatively may not present or allow certain links to progress. Depending on user access levels, certain actions may or may not be permitted by certain users—for example, a user might be able to create or view claim charts, but not be able to add new patents or vice versa.

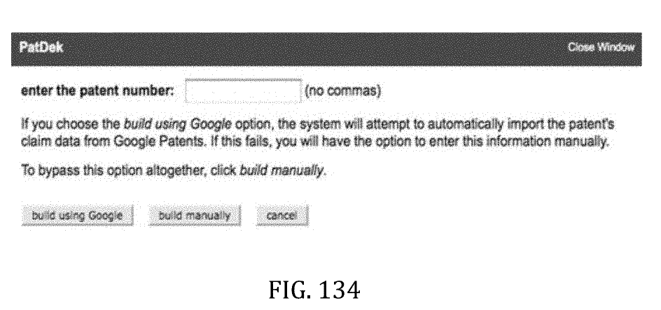

Referring now to FIG. 134, if a user with sufficient access in the case administration screen has the ability to add a new target patent, the system will redirect or present the screen depicted in FIG. 134 as a pop-up or as a new window in the browser or interface. This screen allows users to automatically import information from a new patent from an open-source tools, such as Google patents or the USPTO website (not shown) or some other source (whether open or not). If an automatic import is unavailable or undesirable, the information can be built up within the database manually.

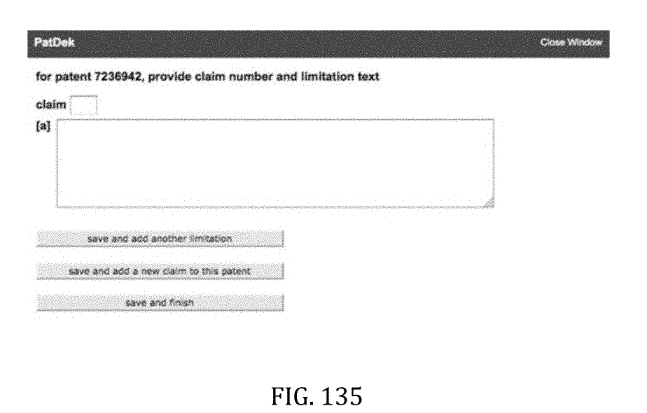

If manual building of target information—in this case the claims of a patent—is selected, the system presents the screen of FIG. 135 to a user of sufficient access. Here, the user is presented with simple text boxes to delineate the various limitations of a specific claim. As a default, but changeable convention, the system recognizes separate claim limitations as, claim 1 [a], 1 [b], 1 [c], 2, 3 [a], 3 [b], etc., according to the specific structure of the claims. After each respective claim limitation is manually entered into the system, the user may alternatively save and add another limitation, save and add a new claim to the patent or save and finish or exit.

Once claim limitation information is entered, users with sufficient access to the system may create prima facie links and hierarchies in the target information. In the example of a patent analysis project, this is done by setting up the dependency structure between various claims in a target patent. If the automatic importation of claim limitations is selected, this process also occurs manually with the ability of the user to review and edit this dependency structure, should an error be introduced. For example, if claim 3 depends from claim 2, which depends from claim 1, the system will establish that hierarchy. The system is capable of recognizing multiple dependencies or alternative dependencies as well—for example, claims written as “claim 4 depends from either claim 2 or claim 3 wherein . . . ” using any number of techniques to distinguish between the claims, denoted claim 4(3) and claim 4(2).

Either prior to or subsequent to the establishment of the target information, e.g. patent claims, in the system, important bibliographic information regarding the target information or patent can be established in the system. In the example of a patent analysis project, this information can take the form of the names of the inventor or inventors, the patent number, application information, an issue date and the filing date or dates of priority applications.

Additionally, if necessary or desirable, priority dates can be established within the system for individual claims or claim limitations at the outset of a project or later when such information becomes known with greater confidence. The target information may also be labeled with a nickname to make it easier for users to navigate through more complex projects. In the example shown in FIGS. 133A and 133B, the target patent is given the nickname of “pre-sale.” This may be of particular use when, in the case of target patents the last three numbers of the patent number are the same.

It should also be noted that both target information and information sources—the target patent and prior references in a patent analysis embodiment—can be tracked using bates numbers or other serial numbers and copies of these documents can be uploaded and linked to the project appropriately.

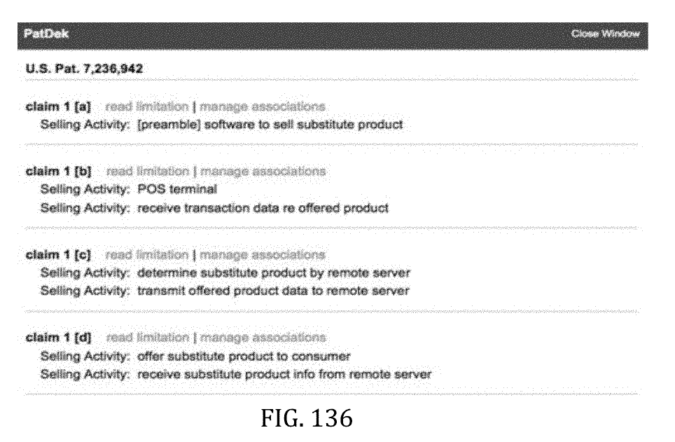

Next, with reference to FIG. 136, the target information can be analyzed to create and leverage informational overlap. In the example of one embodiment—a patent analysis project—the patent claims can be broken into what are referred to herein as “concepts” or “concept phrases.” Concept phrases generally represent shorthand, abbreviated or mnemonic descriptions of the target information's overlapping constituent components. In one embodiment, this represents the overlap between patent claims, claim limitations or even fragments of claim limitations.

These overlapping concept phrases are linked or associated with portions of the target information, in the case of a patent analysis embodiment, to portions of claim language. The structure, associations, grouping and labeling of the concepts is controlled by users with sufficient access and can be edited and evolved as the project evolves.

Concepts may be set, depending on the preferences of the user to a very granular or specific lever or at a higher level. This often depends on the identification of potentially important items of information beforehand. In any event, as stated elsewhere, the concepts may be adjusted and readjusted as necessary.

Using the example of patent analysis, if for example a small number of claims and claim limitations are to be evaluated, tying concept phrases to more granular information can be advantageous. On the other hand, if a large number of claims and claim limitations are to be evaluated, tying concept phrases to less granular information can be advantageous. Typically, the system users will use a mixed approach as appropriate. As a result of breaking claims into concept phrases, each portion or limitation of a claim will be associated with one or more concept phrases and each claim to be evaluated or analyzed may be expressed as various combinations and permutations of the concept phrases. Importantly, these concept phrases can be established across multiple patents, whether such patents are related in a patent filing sense or whether such patents simply share certain features.

Here, the claim limitation is perhaps too complex to be simply linked with a single concept. Instead, multiple concepts will be associated with this claim limitation. The available concept phrases are presented in the box on the left and using the arrow keys, the user can associate these concepts with this specific claim limitation. The order of the concepts within the claim limitation association can similarly be ranked to later ensure readability of the outputted reports. Once the user is satisfied that the associations are correct, the user clicks the save associations button and proceeds to the next limitation. Alternatively, if the user determines that a new concept is necessary, the user can hit cancel and navigate back to the concept creation screens.

Referring back to FIG. 136, depicted is an exemplary breakdown of a single claim of the target patent into various concept phrases. A user with sufficient access may read a limitation in its entirety by clicking on the corresponding link. This is often useful during the process of creating the concept phrasing or during the editing of concept phrases. By clicking on the “manage associations” link, a user with sufficient access might be able to adjust what concepts are associated with a particular limitation. In this exemplary breakdown of the '942 patent, claim limitation 1 [a] is associated with the concept of “Selling Activity: [preamble] software to sell substitute product.” claim limitation 1[b] is associated with two concepts—a “POS terminal” and “receiving transaction data regarding the offered product.”

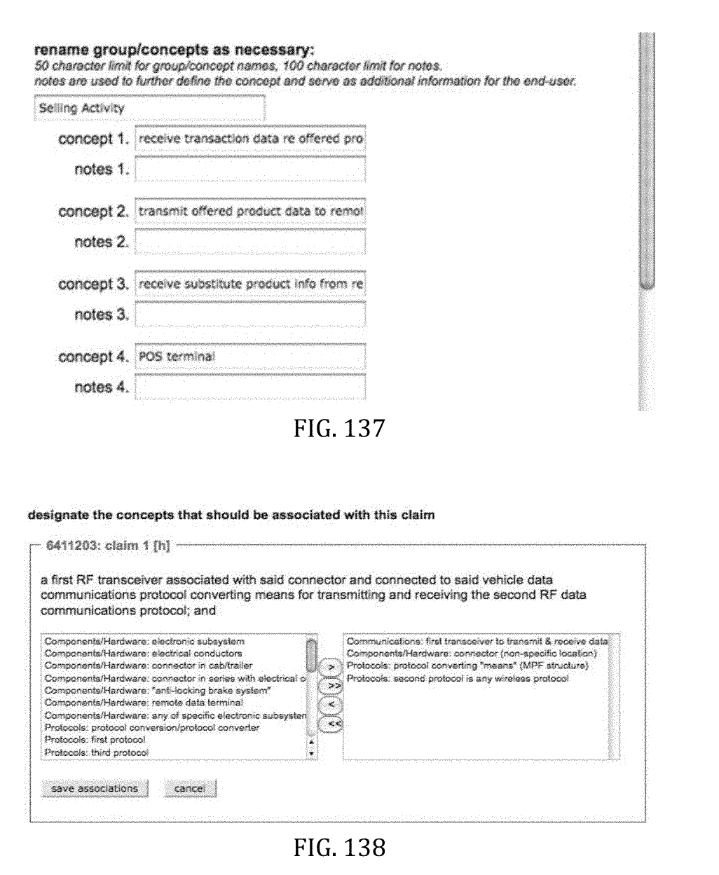

With reference to FIG. 137, once the concept phrases are established, the user can associate concept phrases with each other based on similar characteristics. While this organizational step is not strictly necessary, it is preferable in order to present a cleaner graphical user interface for the system users and to speed the later review of information sources—in this case prior art references and documents. More preferably, these associated concept phrases are organized and presented as separate tabs in the web-based interface, similar to most web browsers and accordingly intuitive to most users.

Establishing concept phrases, linking the concepts with claims and associating the concepts with each other can be an iterative process until the system users are satisfied with the coverage of the claims and the varying levels of granularity desired. The concept phrases and associations can then be “locked down” by the system or by certain users granted certain access privileges, such as a case administrator or manager. Likewise, if adjustments or edits prove necessary, the case administrator can then unlock the concept phrases and their respective associations.

With reference to FIG. 138, a user with sufficient system access has clicked on the manage associations link of a screen, similar to FIG. 136 corresponding to limitation 1 [h] of the target claim. When the system presents such a screen to a user with sufficient access the user is able to examine a list of all of the concepts that have so far been established for the project. By clicking the appropriate concept and the left and right arrows, the user is able to associate one or more concepts with the limitation presented above, in this case 1[h]. In a similar fashion, the user may remove a concept from its association with that same limitation. This is often useful when concepts have been edited or manipulated to be more granular or less granular, given the circumstances or when an assumption of the project that resulted in the establishment of the original set of concepts.

For example, in the particular example depicted in FIG. 138, users of the system may decide the “RF” should be divided into sub-concepts, such as wi-fi and cellular to account for a situation where a court might later adopt a claim construction that included or excluded one or the other from the meaning of “RF.” Once the user is satisfied with the concept associations for a given limitation, the user may click the “save associations” button. Alternatively, the user may click on the “cancel” button to return to the previously saved state. In one embodiment of the present invention, a patent analysis project, the system also preferably reminds the user that certain limitations are written in means-plus-function format. The user is then reminded or prompted to later input into the system an identification of any structure that performs the designated structure. Optionally, when a means-plus-function limitation is established, the system of the present invention may create a specific data entry field for the corresponding structure.

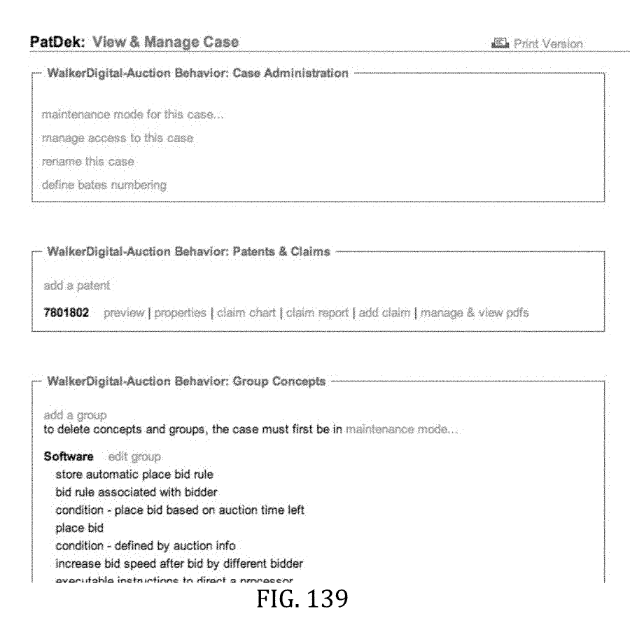

FIG. 139 illustrates another aspect of the system according to the present invention. Here a user is presented with an updated case administration screen, similar to the case administration screen described above. Importantly, here the concepts associated with this patent have been established (at least in part) and the hierarchy or grouping of concepts has also been established (at least in part). Specifically, the user is presented with a grouped list of concept phrases under the heading “Software.” Users with sufficient access can enter into “maintenance mode” in order to create, delete, edits and rearrange concepts and groups of concepts.

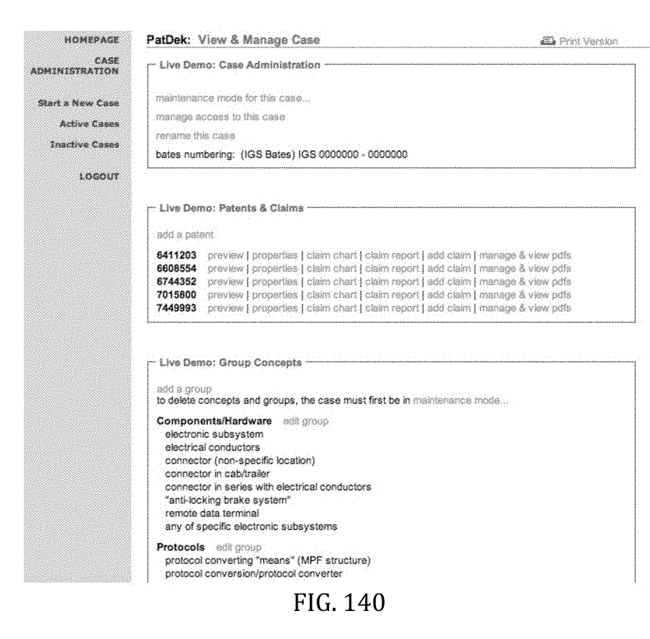

FIG. 140 illustrates a further aspect of the system according to the present invention. Now the user has been presented with an even further developed case administration screen. Several patents have been added to the project and a more developed list of concepts, grouped under various headings has been established. The two concept groups depicted in FIG. 140 are the “Components Hardware” group and the “Protocols” group. Note that a user with sufficient access is granted the ability to add a new group, or edit existing groups by clicking on the appropriate corresponding link.

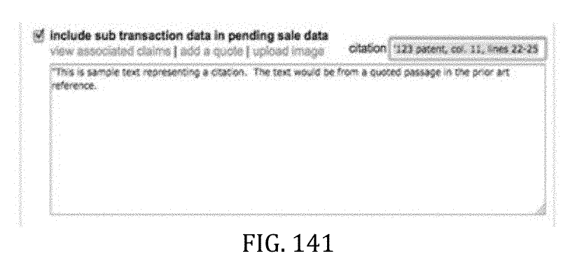

It is preferable in many instances to ensure a consistent presentation and collection of data within the system. This can be particularly important in crowd-sourcing projects where many different users might have very different preferences for analyzing and inputting information from information sources, or in the case of the a patent analysis embodiment inputting information from prior art references. This system attempts to regiment data input by allowing the users to establish the structure of input fields for evaluation. In FIG. 141, the users have established the use of quotation marks for text entry and a specific input style for the citation of prior art patents. Images may also be input into the system as bitmaps, jpegs, pdf's, xps, etc.

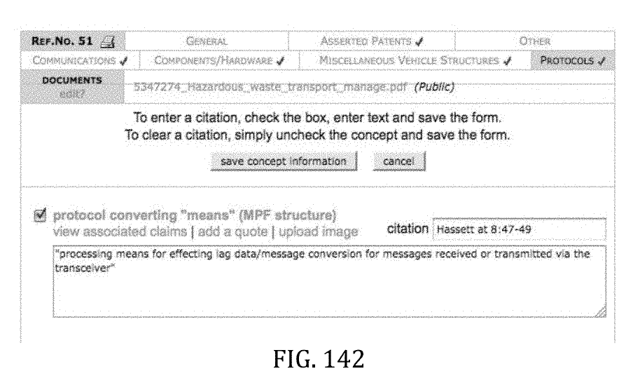

With reference to FIG. 142, a user of the system is presented with a screen such as depicted in FIG. 142 during the process of reviewing and analyzing information sources for the presence of disclosure pertaining to the established concepts. In the case of a patent analysis project this could be, in the case of an invalidity analysis the disclosure of various prior art references. If an alternative type of project were being undertaken, for example an infringement analysis, the information sources to be compared to the concepts would be documents describing an accused product or system. In the case of a claim construction or section 112 support analysis, the information sources could be the specification of the target patent, the file history of the target patent, declarations by experts or inventors and even other prior art references themselves referred to in the prosecution history.

Prior to being presented with this screen, the users (preferably the user that uploads the information source to the system) enter into the system the appropriate bibliographic information associated with that information source. Such information includes, but is not limited to, the author, the full title, a short title, the publication date, evidentiary sponsors, the publication date, the confidential status of the document, bates stamp ranges, the source of the document, etc. In the case of an invalidity or unpatentability reference, the system can track the relevant section of 35 USC § 102; in the case of an infringement document, the system tracks the relevant section of 35 U.S.C. § 271 and the “model” or “version” of the accused product or service. Additionally, the users of the system can upload one or more copies of the document to the system along with further descriptions or notations (e.g. “best copy available,” bates stamped, redacted, etc.).

Moving across the top of FIG. 142, the first box that is highlighted is the reference serial number. The system preferably assigns each information source with its own serial number. The printer icon next to the text allows the user to print a paper (or electronic) copy of the reference for review. The other boxes running along the top of FIG. 142 correspond to groupings of concepts that have been previously established, with the exception of the “General” tab, which is where the reviewer can enter in the appropriate bibliographic information pertaining to the information source. The check marks depicted next to each tab title indicate that the user has saved some information pertaining to those tabs and their respective concepts to the system. The tab entitled “Protocols” is highlighted currently and this indicates that the user is entering information pertaining to the concepts grouped under “Protocols.” Below the tabs is a “Documents edit” link, which allows the user to manage the document associated with the serial number 51. To the right, the system presents links associated with all of the documents associated with this reference, its title and its status—in this case, public.

Importantly, multiple documents may be associated with the reference serial number 51 for various reasons. Often, in the case of a litigation a document may be produced multiple times with multiple bates numbers. It may be desirous for the system to track each copy of the document. Other times, particular with respect to older informational sources, various copies may be better or worse—even in part—in terms of legibility. Finally, it may be the case that the users of the system may decide that multiple documents should be treated as a single reference for purposes of the project. This might be because the documents represent, for example, multiple office actions and responses in a patent prosecution file or multiple documents describing a single public use or on-sale bar.

Below is the “save concept information” and “cancel” buttons, which have the same function as described above. It may be preferable in the system to present multiple instances of this functionality, for example at the top and bottom of the screen—particularly where a large number of concepts are grouped together under a single heading.

Below these items in FIG. 142, the user is presented with the concepts themselves and several boxes and buttons for data input. To the left is a radio button or check box that indicates that the information source discloses that concept. Preferably, the system will automatically activate that box or button if the user enters any information in the data boxes. Alternatively, it may be preferable for the system to not activate that button until all information is appropriately entered as a failsafe.

The larger data entry box permits the user to copy or manually enter disclosure from the information source. The smaller data entry box permits the user to enter a specific citation for that disclosure. The system preferably ensures that whatever citation convention has been established for this project is followed before letting the user save the information. If the user finds the concept difficult to follow or wishes to review actual examples of claim language, the system presents that information if the “view associated claims” link is clicked. This information also preferable indicates the claim numbers associated with that limitation.

If multiple disclosures in an information source disclose a concept, the user has the ability to create additional data entry boxes so that each disclosure has its own data entry box associated with it.

A reviewer thereafter reviews each individual reference and enters into the system those portions of the document that correspond to each of the aforementioned concept phrases that appear within. The entry of this information can be manually typed into the system, cut and pasted or dragged and dropped using any one of several methods well known to those of skill in the art. One preferable mechanism for entering information can employed using the Tabulaw software, for example. Accordingly, the entered information may be text, hypertext, or images. Further, the system tracks relevant citation information, e.g. in the case of a patent document the relevant column and line number or figure number, in the case of an article the page number, or in the case of a website the URL information.

In addition, the system allows the reviewer to categorize each individual entry of information. If an invalidity or infringement analysis is being performed, the system allows the reviewer to choose between multiple levels of importance—express, inherent, sufficient, similar, etc. Alternatively, the system can simply rank a disclosure on a numerical scale. Any type of custom tag can be generated pursuant to the needs of the users. If no disclosure for a concept exists within a particular document, depending on the parameters set by the users of the system, then that concept can simply be left blank. Additionally, the system provides for the entry of free-form arguments in the same or a separate field if the disclosure of the document requires some explanation as to how it meets the concept phrase.

Additionally, the system provides for the entry of language that could be useful to provide a “motivation to combine,” for use in a later obviousness combination. Additionally, the system can provide a field for reviewers to provide a more subjective evaluation of the document. For example, the system might provide for a numerical ranking of the document's subjective value for a jury presentation, where a higher ranking would be given to documents that were clearer and more digestible by a layperson.

It should also be noted that the system will permit text to be formatted in any way that the users desire. For example, the system can bold, underline and italicize just as any word processor and also may permit color text, highlighting and the manipulation of fonts. This can be particularly useful when a disclosure involves a large quantity of text. Additionally, the users of the system are not limited to simply entering text into the system, as stated above, the system also associates images with the concept, in any image format supported by the browser—such as jpeg, bitmap, pdf, xps, etc. It is even possible to associate audio and video clips with a concept or other types of data files. What type of data may be entered into the fields and associated with concepts may also be different for different users with different levels of access. In this example, the system only permits the users to upload images by clicking on the appropriate link.

The system may also preferably provide an electronic version of the information source to the user when the user is entering a disclosure (excerpts) of the information source into the system. The user may drag and drop disclosures of the information source into a concept field. Alternatively, the system may present the user with fields not associated with any concepts and permit the user to designate specific concepts that are to be associated with the data entered into the field(s). In this manner, multiple concepts may be associated with the same information source excerpt and corresponding citation, without having to place the excerpt and corresponding citation in each concept/citation fields appropriate to the information source excerpt. As a further alternative, once a concept/citation field contains an excerpt for an information source, the system may be configured to permit the user to identify other concepts for which the same information source excerpt applies. These latter two alternatives provide the advantage of not duplicating the information source excerpts output in charts or reports. For example, if two concepts are each linked to the same information source excerpt, and a report or chart requires a output for both concepts, the system would preferably only output the information source excerpt once from either concept because the output would be the same for each concept. The system need not present redundant information already supplied by one of two concepts having the same information source excerpt.

As users review information sources, they may also mark the sources as in progress, incomplete or complete to signify to other users of the system that they should either review the reference or not review the reference accordingly. Once marked complete, users with higher levels of access may review the inputted information and make changes as appropriate. Once satisfied, a particular reference may be locked down by the users of the system and closed to further editing. Later, a reference may be unlocked again for further editing.

It is also preferable for the system to track and display to certain levels of users which user has uploaded a particular information source, reviewed a particular information source, edited the data entries or marked an information source as complete. This type of information can be used to gauge productivity of users, manage the review process and as will be further discussed herein allocate bonuses, incentives and awards (or demerits, etc.) to the various individuals involved in a project. Such tracking information may also track mouse clicks, keyboard use, etc., and other standard tracking measures for such purposes as well.

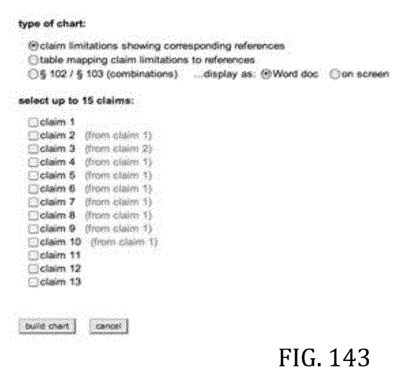

With reference to FIG. 143, a user with sufficient access to the system can generate reports, charts or data visualizations or run experiments at any time during the project. FIG. 143 depicts the presentation of a chart generation wizard in accordance with an embodiment of the present invention. The user may select the type of chart that is desired to be generated. In this instance, the radio button is selecting “claim limitations showing corresponding references” which is a shorthand form of chart that simply shows the references that, based on the review of the users, discloses limitations.

Any other conceivable type of chart is possible, but the system illustrated by FIG. 143 depicts two other common and useful charts that the system of the present invention may generate for data mining purposes. First, a table mapping claim limitations to references in a standard two-column invalidity chart that is well known to patent practitioners and litigators. Second, the system is also displaying an option to build a § 102/§ 103 combinations chart. This type of chart lists all references that disclose the limitations of the selected claims (below) either alone or in combination with other references. In the case of combinations, the system will create a chart that shows each viable combination, rather than simply all possible 2-way, 3-way, 4-way, etc., combinations. While other charts, reports and data mining and experimentation is possible, FIG. 143 reflects a user of the system that does not have the correct type of system access to view those options.

In the lower section of FIG. 143, the user may select the claims that will be analyzed as part of the chart-building process. claim dependences, or multiple/conditional dependencies would also preferably be displayed here. Once the user is satisfied, the user clicks the “build chart” button and a radio button corresponding to the desired output format. In FIG. 143, those output formats are word documents or simply displayed on screen in the user's browsers. Any other type of document or image format may alternatively be selected, such as pdf, WordPerfect, tiff, xps, etc. depending on the setup of the system.

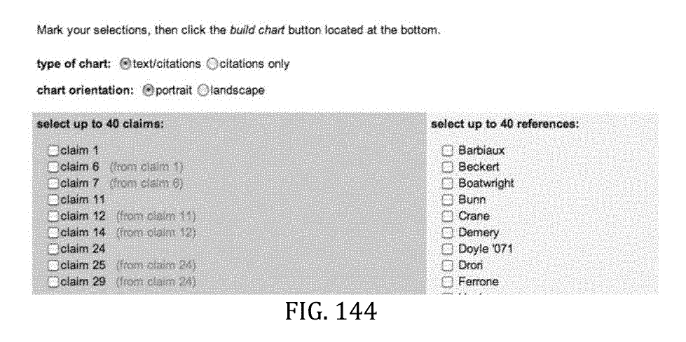

FIG. 144 depicts another example of chart-building according to an embodiment of the invention. In this type of chart-building, the user can select whether to see the “text/citations” or only “citations.” In this embodiment the user can also determine certain formats for the chart-build, such as whether portrait or landscape is desired. It is also preferable that the system enables the users of the chart to build charts for the purpose of submitting or serving in the course of a litigation or a USPTO proceeding. In that instance, the system may allow users to specify a particular format designed to be as compliant as practical with a given court or agency's rule set—for example, if the users select the Central District of California as an output format, the system will build the chart using the lined and numbered pages required in that jurisdiction.

This allows a user to not only build charts, but to run certain experiments on the data set. For example, a particular reference might be excluded due to late production or discovery, and the users can determine the impact that this would have on a case. Alternatively, users can eliminate references known to be weaker or cumulative.

FIG. 144 allows the user to preferable select up to 40 claims and up to 40 references (or other predetermined limits) for the chart build. These limits can be set to ensure that the browser and the system memory is not exceeded and alternatively to ensure that the output is manageable. In a patent project with a large number of claims and a large number of references, the reports and charts that can be generated by the system can easily reach several thousand pages in content.

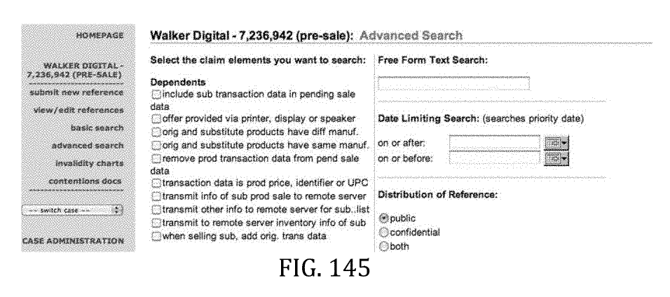

FIG. 145 depicts an exemplary “advanced searching” screen that a system of the invention might present to users with sufficient access. Here, the users can run analysis, build charts, engage in data mining or visualization by controlling various assumptions and examining the resulting data. For example, the user might do a free form text search to determine if some specific language appears in any reference. This search might be a “natural language” search or consist of Boolean searching of the types familiar to those of ordinary skill in the art. Alternatively, or conjunctively, the user may experiment by setting date limits. This is particularly useful in, for example, an invalidity project, where the possibility of a pre-filing priority date exists. The experiment might specify that only references or information sources having particular characteristics should be analyzed by the system—for instance, a specific concept or a specific status (e.g. public, confidential or either).

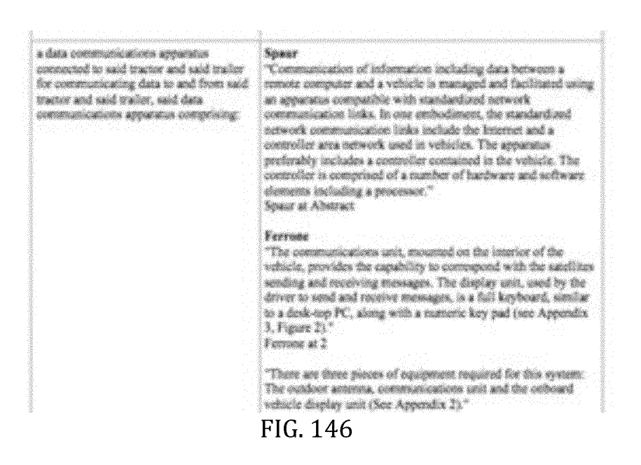

FIG. 146 depicts a portion of the output of an exemplary chart build of the system of the preferred embodiment of the present invention. In the left hand column of the chart the claim language appears. In the right hand column disclosure from the information sources or, in this instance, prior art references are presented. Each reference is headed by its name—e.g., “Spaar” or “Ferrone” and what follows are (in this instance) quotations and citations from the respective references. Note that in the instance of the Ferrone disclosure, the system breaks the limitation into two separate quotations and citations, as the input by the users was in that form. This could correspond to two disclosures of the same concept in the information source. Alternatively, this could correspond to disclosure of two different concepts in the same information source.

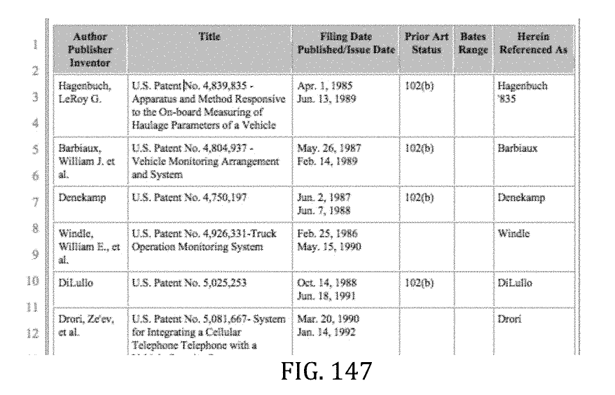

FIG. 147 depicts a type of chart built by the system of the preferred embodiment of the present invention. In this instance, the system has at the direction of the user generated a list of the information sources relied upon in the chart building process—in this instance, separate items of prior art. The bibliographic information stored as part of the review process is organized as part of the chart, which itself can be ordered alphabetically or chronologically, etc. This chart is also built using the Central District of California format, as can be seen by the line numbers on the left hand side of the page. Information of this type is commonly required in expert reports or invalidity contentions generated during the course of litigation in many jurisdictions, such as the Eastern District of Texas.

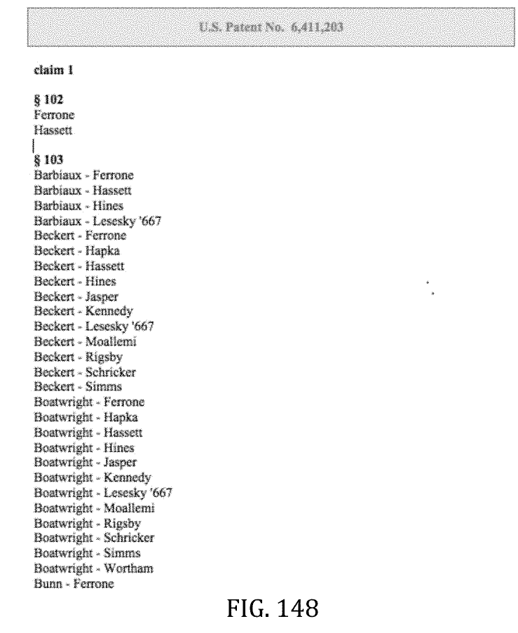

FIG. 148 depicts another type of chart generated in accordance with an embodiment of the present invention. In this instance, the system—at the direction of the user—has generated a chart that simply identifies in chart form the anticipatory (disclosing all claim concepts/limitations) references and viable combinations relied upon by the users for a particular selected claim, in this case claim 1. With respect to combinations under the heading § 103, only 2-way combinations are depicted; however, the system can be directed to generate all of the viable 3-way, 4-way or 5-way, etc., combinations (and of course, other types of corresponding charts).

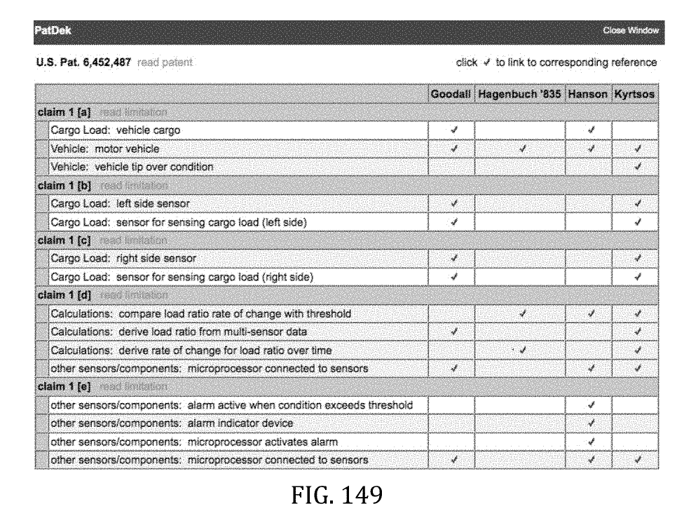

FIG. 149 depicts one exemplary type of data mining or data visualization that can be performed by the system of the present invention. In this instance, the system has generated a “strike chart.” For simplicity sake, this particular strike chart is limited to a single claim of a single patent and only four information sources (e.g. prior art references). As one of ordinary skill in the art will appreciate, many more claims and many more prior art references can be utilized in this (and other) forms of visualization.

With reference to FIG. 149, the user is alerted to the target patent by way of the title heading and is given the option of pulling up the patent with the “read patent” link. The user may also open up specific information sources by clicking on the check boxes, which will take the user not only to the data entered into the system, but the raw document preferably.

Each claim limitation 1 [a] through 1 [e] is separately broken out with its associated concepts. If desired, the user can read a specific limitation by clicking on the corresponding link. In the rightward columns, a check-box appears corresponding to specific information sources that disclose that concept. For example, the “Goodall” information source discloses the concept “Cargo Load: vehicle cargo” and “Vehicle: motor vehicle”, but not “Vehicle: vehicle tip over condition.” That concept is only found in the Kyrstos information source. Using this type of chart, the user with access sufficient to generate the chart may quickly determine what references are actually disclosing, which references are weak, where weak points in the data set exist and accordingly what references will be crucial and what references will be merely cumulative. For example, the user of the system can quickly see that the Hagenbuch '835 reference is not disclosing any limitation not disclosed in more robust information source. Based on this information, a user might decide to eliminate Hagenbuch from further consideration in the project, all other factors being equal.

As stated above, once review of documents is under way the system can be used to perform logical analyses on the pool of reviewed documents, generate reports, and generate draft legal documents such as infringement or invalidity contentions, claim charts and even draft reexamination requests based on a set of available templates. For example, the users of the system can generate draft invalidity contentions into a template generally corresponding to the requirements of the Eastern District of Texas. Perhaps a more typical type of report would be the familiar claim chart, which correlates the limitations of a claim or claims to the disclosures of a document or documents.

Alternatively, queries can be performed on the database of the system across many different variables. For example, queries can be run based on the type of document. In the context of unpatentability, for example, the system can be queried over only patents and printed publications. Alternatively, in the context of invalidity, documents describing public uses (for example) or confidential documents can be queried. As another example, queries to support many “what-if” scenarios can be run. For example, queries can be run using multiple “priority dates” of the targeted patent documents. Other queries can be run using only certain types of invalidity or unpatentability references—for example, those that satisfy the requirements of 35 U.S.C. § 102(b). In an infringement context, queries can be limited to document sources (for example target companies' own websites or specifications), can be limited to a particular type of infringement (direct, induced, contributory), or can be limited to certain versions or models of accused products, among other possibilities.

Other types of reports can also be generated. Reports can be generated in the form of simple document counts—i.e., the numbers of documents that disclose particular concepts or limitations. Such reports can be employed by the system users to guide further searching and analysis. As new documents are reviewed and updated, any report or chart can be re-generated to assist in tracking progress.

Based on the documents' disclosure and the review and analysis by the reviewers, the system can run various processes to assist in determining the “best” documents or combinations of documents for various purposes—infringement or invalidity/unpatentability. In the context of invalidity or unpatentability, the system can determine all of the anticipatory references for a claim or set of claims. Even anticipatory references can be ranked using various optimization algorithms that are known in the art.

As just one example, the system can prioritize documents that “expressly” disclose limitations over those documents that “inherently” disclose limitations. Likewise the system can prioritize documents that qualify as 102(b) references over documents that only qualify as 102(e) references. The system can be instructed additionally to weigh or prioritize documents that disclose certain key limitations or concepts expressly, etc.

As a further example of a ranking algorithm to be employed, the system can be configured to rank or weigh concepts individually for documents and relied-upon disclosures that are associated with concepts. For instance, as above with the “Goodall” information source, consider again that Goodall discloses the concept “Cargo Load: vehicle cargo” and “Vehicle: motor vehicle”, but not “Vehicle: vehicle tip over condition.” As in the example, the concept of “Vehicle: vehicle tip over condition” is only found in the Kyrstos information source. Although Goodall discloses the “vehicle cargo” concept, further information can be associated with this concept using a linked attribute referred to as Strength of Disclosure or Core Rating for the disclosure. Using variables to express how exact the disclosure of Goodall is for the “vehicle cargo” concept, further useful information can be captured for later analysis.

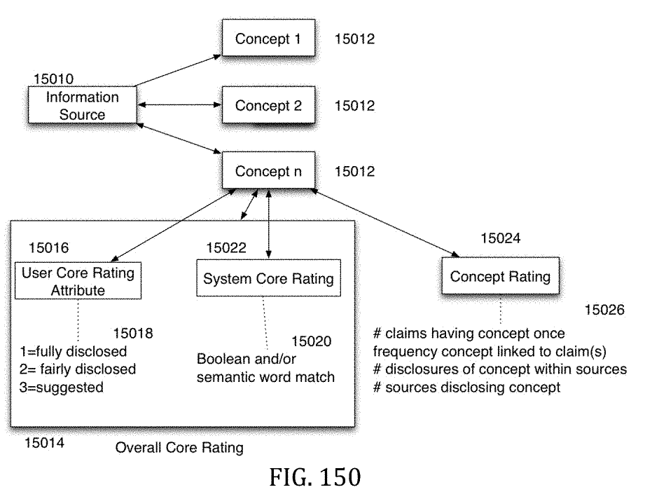

In accordance with FIG. 150, consider the non-limiting example whereby the Core Rating 15016 has three ranks, understanding that additional ranks are possible, may be desirable, may vary from case to case, and may be specified by a user through the case management portal. With Core Rating ranks 15018 of (a) fully disclosed; (b) fairly disclosed; and (c) suggested by reference, the system can utilize the Core Ratings 15016 to rank references identified as 102 and 103 references against a claim, or identify the most useful information pertinent to a user query. The concept of inherency of disclosure might likewise be incorporated into the system.

With respect to the illustration of different ratings and their relationships with concepts in FIG. 150, in the case of invalidity by anticipation, consider that a claim requires ten concepts. If a single information source 15010 were found to teach each of the ten concepts of a claim, the information source 15010 would be understood to anticipate that claim. By applying the additional data provided by Core Ratings 15016, 15022 for each of the ten concepts, the information sources 15010 may be ranked. For example, an information source 15010 having six concepts 15016 each with a rank 15018 of “fully disclosed”, and the remaining four concepts necessary for the claim having the lesser rank 15018 of “suggested by reference”, a particular information source 15010 may be considered a more suitable anticipation information source than an information source whereby four concepts had the secondary rank 15018 of “fairly disclosed” and six concepts had the tertiary rank 15018 of “suggested by reference.” Using the subjective Core Rating 15016 for each concept, and a matching algorithm to determine whether an information source discloses the specified concepts of a claim, provides incremental insight into how information sources rank relative to one another.

In an alternative embodiment, the System Core Rating 15022 for each concept may be automatically applied by the system according to a Boolean or semantic match between the words of the concept and the disclosure from the information source set forth by the user for the concept. It is to be understood that the concept is represented by words, and that additional words, including as notes or other words of guidance, may also be linked to each concept as an additional aid during the review stage. The additional guidance language associated with each concept may also be considered together or separately with the words of the concept itself for purposes of evaluating a Boolean or semantic match. By way of example only, FIG. 6A reflects a relationship between fields for a concept and its respective notes. In a further alternative embodiment, there could be a User Core Rating 15016 (subjective) and a System Core Rating 15022 (objective based on Boolean and/or semantic word match), to generate an Overall Core Rating 15014 for each concept 15012 disclosed by an information source 15010. Many different variations of how to apply, adjust and establish Core Ratings for concepts are contemplated.

Another approach to applying rating data for ranking information sources includes a consideration of how many information sources disclose a particular concept. For example, again with respect to the illustration of ratings and concepts in FIG. 150, consider a set of 20 information sources 15010, each disclosing several of a possible fifteen concepts 15012. A concept 15012 disclosed by the fewest number of information sources, or alternatively, with the fewest number of total disclosures (understanding that a concept may be disclosed more than once by any information source), may be understood to be more important based on the lower frequency of its disclosure compared with other concepts. Further, although a concept may only be disclosed by information sources a small number of times, the concept may only be associated with two claims of a twenty claim set. With this understanding, the concept may not be considered as important compared to a concept that is required by all twenty claims of a twenty-claim set. Appropriate Concept Ratings 15024 can be attributed to concepts based on some or all of the following factors 15026, among others: the number of claims specifying a concept at least once, the total number of times a concept is specified by a claim or the entire claim set, the total number of disclosures of the concept by information sources, and the total number of information sources disclosing the concept at least once.

By characterizing a concept by a Concept Rating 15024 and characterizing a concept's disclosure by an information source 15010 as an aggregate Core Rating 15014, various algorithm-based rankings can be performed using these ratings, with adjustments possible to emphasize the importance of the various rating factors, to provide for relative rankings of the information sources in the context of anticipation and obviousness contentions. Applying the Concept and/or Core Rating values to anticipation and obviousness results output by the system can allow the system to filter or identify the most appropriate information source, or combination of information sources, appropriate to meet the concepts specified for a particular claim.

For example, information sources with a relatively high Core Rating (more instances with fully disclosed concepts and/or system core rating, yielding a higher overall core rating), may be considered more appropriate for both anticipation and obviousness challenges. An information source may also be perceived as more appropriate for an invalidity challenge because its concept rating demonstrates that it discloses a particular concept that is rarely disclosed in other information sources, contains a large number of instances of disclosures of that rarely disclosed concept, and further that the particular concept has a high frequency of appearing in particular target claims. Moreover, the system may reveal, via the Reference Ranking Module, that this particular rarely disclosed concept has a high overall core rating, because it either was marked as being “fully disclosed” (User Core Rating attribute) or has a high correlation with a matched disclosure for the information source (System Core Rating), or both (Overall Core Rating). It should be appreciated that a user may find different rating attributes to be more important depending upon the subject matter, the expertise of a user evaluating an information source for disclosure, and/or the complexity of the claims and related concepts.

In another respect, a concept rating need not be an aggregate value, but rather may be represented by multiple separate values associated with the frequency values discussed above. Discrete, Concept Rating sub-values provide a mechanism for further differentiation in the various operating modules. For invalidity contentions, a crowd-sourced prior art search may be initiated following a prior art review and categorization using this system whereby a search is principally directed to locate one or more concepts having a low number of disclosures of that concept(s) within sources and/or a low number of sources disclosing the concept. Differentiation among the concepts for searching purposes can be further delineated by considering how many claims recite the concept and further how frequently the concept is linked to claim limitations in one or more claims. An additional filter parameter for determining concepts to search, via the crowd-sourced approach or otherwise, may be based on the Overall Core Rating, User Core Rating and/or System Core Rating for a concept.

Separate from the alternative embodiments using Concept Ratings and/or Core Ratings, the system can also generate comprehensive reports regarding obviousness. Rather than generating all mathematically possible combinations of the reviewed documents—which for even a modestly sized database of 10 documents would grow prohibitively large—the system may return only plausible combinations that provide claim coverage within certain selected parameters. For example, the users might query the system to generate all 2-way combinations based on 102(b) art for claims 1, 3-5, 10, 13 and 20. Broader or narrower parameters can be selected as desired.

Another type of useful data mining and visualization aid that the system can generate is the heat map. A heat map is well known generally speaking to those of skill in the field of data visualization and is often used, for example, in securities trading to help users identify potential opportunities in a market. Here, the system of the present invention uses this type of visualization—using colors from deep purple to white hot—to represent the frequency or lack thereof of disclosure covering claims, claim limitations and concepts. For example, in a situation where more references disclose a particular concept, the heat map might display that fact to the user by a color associated with a higher heat value. If a concept or claim or claim limitation has fewer (or no) disclosures from the information sources (e.g. prior art references) then the user is presented a lower heat value color. This heat map can also be run in accordance with the various experimental searches and reports discussed above. This allows users with sufficient access to very rapidly determine where potential weaknesses exist, so that searching can be specifically directed thereto or project strategy can be otherwise adjusted.

It is also possible for the system to generate more sophisticated reports that can take the form of more complex and complete documents. For example, if the system has been capturing the arguments and explanations associated with disclosure of concepts in various information sources along with motivation to combine information, then the system can generate draft reexaminations of patents and selected claims using selected items of prior art. While such a document should be reviewed and later edited, a great deal of time can be saved in the mechanics of drafting by utilizing the informational advantages of the system.

As stated herein, the system can track users as they enter data or use the system. This can be done to ensure productivity. The system can track users by way of mouse-clicks or keyboard entry, etc., to monitor activity level. The system also tracks what users uploaded data, images and made edits to concepts or the data in a specific field. This user information can be stored over time and optionally across projects. Users with sufficient access can access specialized menus, and features that allow them to track, observe and review other users of the system. This tracking feature optionally can tie into the crowdsourcing aspects of the system of the present invention.

Crowdsourcing is made possible by the cloud deployment of the system and its ability to support multiple users simultaneously. Typically, users of the system might all be employed by the same law firm. In other situations, users might span across several law firms tied together by way of a joint defense group. In these situations all of the users of the system would have access to attorney-client privileged and work product doctrine materials; however, they would be legally and ethically bound to keep such information confidential. However, it is possible for the system to create levels of users that would not have access such protected information. For example, a “bounty hunter” user level might only have the ability to upload prior art for others to review. The system can provide, at the discretion of the case administrators, the ability of third parties to register to use the system for that purpose. Such users could sign confidentiality agreements in exchange for access.

As the system tracks “bounty hunter” users they may develop over time a track record of success in finding quality information sources. Such users may later be promoted to a higher level of user that would have the ability not only to upload items of prior art, but also to enter data into the system.

Higher levels of third party access can grant third party users higher levels of rewards. For example, a bounty hunter might be granted a small reward for uploading an item of prior art that was later reviewed by other users of the system. This would be an indication that the users of the system found this art relevant to the project. If however, the bounty hunter user were to upload an item of prior art that was ultimately included in a reexamination or in invalidity contentions, the reward could be higher. Several bounty hunters might share a reward, as in the instance where an information source was uploaded independently by several users or discovered independently by higher-level users.

The system can also track demerits for such users who waste the time of other reviewers by, for example, inappropriately entering bibliographic information into the system or entering information sources that could not be prior art. After a certain level of demerit, a third party user of the system could be demoted from a higher level of access back down to a bounty hunter level of access or even denied access to the system altogether.

A higher-level third party user to the system might be paid on an hourly basis to review informational sources, provided that a certain level of efficiency is maintained. The system's ability to track mouse movement and clicks as well as keyboard entries, etc. can ensure that the third party user is not scamming the system. Even higher levels of third party access might allow such users to communicate with the case administrators or managers to receive direction or even to manage the lower level of users. Leveraging these features might enable the managers of a project to effectively employ thousands of patent searchers and data entry personnel at a fraction of their current costs.

The system also makes use of a secure billing system. The system can register users from the case administrator level to the third party bounty hunters. The billing system can take credit cards and use those credit cards to receive payment for the user of the system, but also preferably to allow the managers of a particular project to pay the third party users that work on the project.

Although the invention has been described and illustrated herein primarily in the context of patent claim analysis, one skilled in the art will appreciate that the concepts disclosed are further applicable to a variety of applications, some of which are specifically mentioned. Likewise, the figures including screenshots illustrate exemplary options for a user interface, and which while described and illustrated as screens or pages may be variously combined, modified, or otherwise adapted for any environment, including display on desktop, portable, mobile and other devices, processed for audio presentation, etc.

The invention is often described with respect to functional modules. However, the disclosed functionality might be embodied in hardware, software, and/or a combination thereof, and could be offered as a web or cloud-based service, implemented on networked or dedicated servers, on a mainframe, etc. In addition, disclosed modules might be varied in countless ways, for example combining functionality from multiple described modules into a single module, parsing out functionality from a single module into multiple, or incorporating into a module functionality not herein described in the context of a module. Thus, many variations are possible without departing from the scope of the invention.

### Modifications of the Present Inventions

While Applicants have disclosed and taught numerous new tools and methods for bettering understanding of scope of patent protection that should be afforded to an invention defined by patent claims in view of the state of knowledge in the art, such tools can be also used by inventors, attorneys, agents and anyone interested in analyzing and understanding inventions, for many other purposes, including, but not limited to, guarding against overly broad patents using computer-assisted claim patentability analysis, prior art search analysis and searching, claim invalidity contention analysis, claim infringement analysis, freedom to operate (FTO) analysis, patent litigation/storyboard analysis, and other uses.

While the systems and methods of the present invention have been designed to help inventors, attorneys, agents and anyone interested in patents, more efficiently and effectively analyze patent claims, patent prosecution histories and prior art references, in an unprecedented manner, it is essential to understand that a primary underlying purpose of the systems and methods of the present invention is to help anyone analyze and understand inventions (i.e. useful ideas) represented by claims expressed in natural human language, and investigate opportunities for securing patent protection, discovering ways to operate in the marketplace with increased levels of intellectual property freedom, develop new products and/or services that do not require third-party patent licenses to be practiced in the marketplace, discovering and removing barriers to market entry created by granted patent claims that are believed to be invalid in view of discovered un-cited/non-considered prior art references, and the like.

Various applications have been described involving the use of scope concepts to map and chart (i) the limitations and/or sub-limitations of patent claims, and (ii) the patent file history documents and prior art references associated with a granted patent or published patent application. These applications have been described in the context of the various modes of system operation of the multi-mode patent analysis and charting system of the present invention.

While Internet-based (i.e. Cloud-based) systems have been described in the illustrative embodiments of the present invention, it is understood that the various aspect of the present invention disclosed herein can be practiced in systems, networks and devices that are not Internet (i.e. Cloud) based, and offer no such internetworking capabilities, yet offer great advantages to its users.

In the illustrative embodiment described above, XML-based spreadsheet technology has been proposed to implement the chart structures because spreadsheet can present and display textual (and graphical) information about patent claim scope and boundaries, against a prior art disclosure landscape, to help users to better visualize such multi-dimensional objects, in multi-dimensional linguistic space. However, it is understood that other document formats, such as Microsoft® PowerPoint document technology, may be used to display various fields of information contained in spreadsheet-formatted chart structures. Along such lines of thinking, the spreadsheet document schema underlying each of the XML-based spreadsheet-type claim scope schema (CSS) chart structures illustrated in FIGS. 18A-18C, 27A-27F, 33A-33E, 33A-33F, 45A-45G, 51A-51G, 57A-57H, 64A-64I, 70A-70I, 92A-92B, 118A-118C, and 120A-120B can be transformed into any kind of presentational document schema designed to generate presentational documents (e.g. interfaces) that meet the needs of those presenting and displaying information about patent claim scope and boundaries, and arguments supporting particular legal positions before the Patent Office, Federal Court, or other judicial or legislative authority. In particular, in some cases, users will need to present arguments on claim patentability or patent claim invalidity contentions, and the use of a time-space sequential document format, such as Microsoft® PowerPoint, will support the presentation of such arguments with high impact, alone or supported by spreadsheet-based chart structures.

It is understood, however, that there are other applications for the principles, methods and structures of the present invention in fields related to, or otherwise impacted by, the perceived or interpreted/constructed scope and boundaries of patent claims covering the subject matter of diverse industries and marketplaces, in which financial capital is invested with an expected return. Uncertainly and lack of transparency surrounding the process of determining the scope and boundaries of patent claims works to create uncertainty and uneasiness within investors who have either have invested, or are thinking about investing, in companies holding patent portfolios claiming exclusive rights to particular product and/or service features and/or functionalities covered by particular granted patent claims. Such uncertainty and lack of transparency in determining the scope and boundaries of patent protection afforded by granted patent claims also impacts any rational valuation of equity in such companies, and making it very difficult if not impossible to rationally assess the economic value that patent-type intellectual property contributes to a company's market valuation.

By reducing uncertainty in the determination of the scope and boundaries of patent claims, the principles, methods and structures of the present invention seek to help the marketplace better and more wisely allocate financial capital to R&D and market innovations, in contrast to encouraging financial capital to accumulate in large companies with patent portfolios whose true value may not be accurately understood, and even over-estimated by the marketplace, including smaller but highly innovative competitors, and investors who wish to invest their capital in the interests of technological progress and growth opportunities.

By helping engineers, scientists, inventors and the legal community at large to reveal the true scope and boundaries that should be afforded to any set of granted patent claims, and generate powerful fact-revealing chart structures documenting the analysis and facts surrounding any given patent grant and post grant analysis, the present invention seeks to help the patent offices, the court systems, and the financial, insurance and trade institutions around the world to see more clearly what was once very cloudy and mysterious with respect to patent grants, and also, to help protect the patent owners, third-party competitors and the public, in knowing the true scope, limits and boundaries of exclusive property rights associated granted patent claims.

In view of the above, the Applicants/Inventors envision the integration of the Internet-based multi-mode patent analysis and charting system of the present invention, or any variation thereof, with different kinds of information management and processing systems, supporting the management of information relating to objects that are impacted by patent claim scope interpretation/construction determinations.

Also, in alternative embodiments of the present invention described hereinabove, the multi-mode patent analysis and charting system can be realized with only a single mode of system operation, or with any number or combination of system modes of patent analysis and charting. Such alternative system configuration will depend on particular end-user applications and target markets for products and services using the principles and technologies of the present invention.

Furthermore, a number of combinations of features involving the modes described herein are contemplated. One aspect is that claims can include chemical formulas, biological/genetic formulas, mathematical formulas, computer programming language, and/or other representations indicative of human intelligence.

Another aspect is a method of analyzing patent claims in a granted patent and generating patent claim prosecution history charts, said method comprising the steps of: (a) in the patent file history of the granted patent, stored in the database of a patent-specific object-oriented system, identify all patent claims that have been allowed during prosecution history; (b) using the allowed patent claims, construct patent claim charts displaying the language of the allowed claim limitations, and any Examiner's claim rejections (based on cited and applied prior art references) which the Examiner may have made and which Applicant(s) overcame by way of argument and/or amendment; (c) analyze statements made by applicant(s) and the examiner during the course of the prosecution history of the patent grant; (d) identify any statements made by applicant(s) and/or examiner, during the prosecution history, which relate to the subject matter of the allowed claims and corresponding claim limitations; (e) within the database, link the identified statements to the allowed claims and corresponding claim limitations; (e) identify claim concepts embraced or embodied within the allowed patent claims; (f) logically organize the claim concepts into concept groups; (g) link concepts to statements made during the prosecution history; (h) use the claim concepts to automatically generate prior art reference analysis GUIs for use display and use during prior art reference analysis; (i) use the scope concept based prior art reference analysis GUIs to analyze the prior art references cited and applied by the examiner during the prosecution history; and (j) use the results of the prior art reference analysis to generate patent claim prosecution history charts.

Another aspect is a method of analyzing patent file history comprising the steps of: generate claim charts from examiner's 102/103 rejections, where the rejections were overcome by argument and/or amendment; link statements in file history to claims and claim limitations; create claim scope concepts; link claim concepts to statements analyze prior art references cited in file history using the claim concepts as filters; generate claim and reference file history charts.

Another aspect is a method of indexing the language of limitations and/or sub-limitations in patent claims with scope concepts, comprising the steps of: (a) initialize a natural language processing system supporting claim limitation index, a buffer memory, a limitation analysis buffer, a scope concept library, and a scope concept/sub-limitation language link library; (b) load a set of patent claims in said buffer memory, wherein said set of patent claims comprise a plurality of claim limitations expressed in natural language, and each said claim limitation including at least one sub-limitation also expressed in said natural language; (c) parse the claims into a set of claim limitations, according to a set of predefined parsing rules; (d) increment the claim limitation index so that the first claim limitation is loaded into said limitation analysis buffer; (e) analyze the words in said limitation analysis buffer so as to identify one or more scope concepts represented by the language of sub-limitations in the claim limitation loaded into said limitation analysis buffer; (f) define each claim concept represented by the language of the sub-limitations, and store each said claim concept in said scope concept library for future use; (g) assign one or more scope concepts to the language of the sub-limitations in the claim limitation loaded in said limitation analysis buffer. The method may further comprise: (h) for each scope concept assigned to the language of the sub-limitation in the claim limitation loaded in said limitation analysis buffer, link said language of said sub-limitation with the selected scope concept, and store said link in said scope concept/sub-limitation language link library; (i) use the scope concept and sub-limitation language links in said scope concept/sub-limitation language link library to search for and find other claim sub-limitations in said patent claims embodying one or more scope concepts in said scope concept library, and index the language of these claim sub-limitations with said scope concepts; (j) index each claim limitation with a sub-limitation that has been indexed with a scope concept in said scope concept library so that a human being can visually discern that said claim sub-limitation has been indexed by a scope concept in said scope concept library; (k) increment the claim limitation index (CLI) by 1, and return to STEP D and carry out STEPS E through J until all of said claim limitations have been indexed by one or more scope concepts.

Another aspect is a method of indexing the language of sub-limitations in patent claims with scope concepts, comprising the steps of: (a) initialize a natural language processing system supporting claim limitation index, a buffer memory, a limitation analysis buffer, a scope concept library, and a scope concept/sub-limitation language link library; (b) load a set of patent claims in said buffer memory, wherein said set of patent claims comprise a plurality of claim limitations expressed in natural language, and each said claim limitation including at least one sub-limitation also expressed in said natural language; (c) parse the claims into a set of claim limitations, according to a set of predefined parsing rules; (d) increment the claim limitation index so that the first claim limitation is loaded into said limitation analysis buffer; (e) analyze the words in said limitation analysis buffer so as to identify one or more scope concepts represented by the language of sub-limitations in the claim limitation loaded into said limitation analysis buffer; (f) define each claim concept represented by the language of the sub-limitations, and store each said claim concept in said scope concept library for future use; (g) assign one or more scope concepts to the language of the sub-limitations in the claim limitation loaded in said limitation analysis buffer; (h) for each scope concept assigned to the language of the sub-limitation in the claim limitation loaded in said limitation analysis buffer, link said language of said sub-limitation with the selected scope concept, and store said link in said scope concept/sub-limitation language link library; (i) use the scope concept and sub-limitation language links in said scope concept/sub-limitation language link library to search for and find other claim sub-limitations in said patent claims embodying one or more scope concepts in said scope concept library, and index the language of these claim sub-limitations with said scope concepts; (j) index each claim limitation with a sub-limitation that has been indexed with a scope concept in said scope concept library so that a human being can visually discern that said claim sub-limitation has been indexed by a scope concept in said scope concept library; and (k) increment the claim limitation index (CLI) by 1, and return to step (d) and carry out steps (d) through (i) until all of said claim limitations have been indexed by one or more scope concepts.

Another aspect is a method of scope concept indexing, comprising the steps of:

(a) load claims in memory; (b) parse claims into limitations according to a set of predefined parsing rules; (c) increment claim limitation index from 0→1 so that the first claim limitation is loaded into limitation analysis buffer; (d) analyze the words in the claim limitation to identify one or more claim concepts embraced by the claim limitation; (e) define the one or more claim concepts and store in a scope concept library; (f) assign a concept to each claim limitation in a claim;
(f) identify sub-limitation in the claim limitation that is closely associated with the selected scope concept; (g) store the link between the scope concept and a sub-limitation;
(h) use all of the sub-limitations linked to the concept, to find other claim limitations, and index these claim limitations with a scope concept, and index (visually somehow) the corresponding claim limitation as being claim scope indexed; and (i) increment the claim limitation index (CLI) by 1.

Another aspect is a method of processing a published patent application or a granted patent in a group of patents/applications under FTO investigation, comprising the steps of: (a) displaying the language of certain claims in a published patent application or a granted patent; (b) selecting a certain string of language in the claims of the published patent application or the granted patent, as a basis for the potential assignment of a scope concept to the selected string of language; (c) searching for and finding all Applicant/Owner originated documents which contain either (i) the identical string of language selected from the patent claims, or (ii) a string of language that is substantially similar to the string of language selected from the patent claims; and (d) linking (i.e. pre-indexing) the strings of language in each such Applicant/Owner originated document with strings of language that are either the same or similar to strings of language recited in the limitations of the patent claims, so that such language links will enable quick retrieval and easy display of specific that claim language was involved in an amendment of an allowed claim in a published patent application or a granted patent in the group of patents/applications, during future patent claim review operations.

Another aspect is a computer-implemented method of conducting a structured analysis of the file wrapper history of a patent grant, and supporting the generation of allowed patent claim and considered prior art charts that facilitate the application of the patent claim construction rule requiring interpretation of granted patent claims so as to preserve claim validity.

Another aspect is a computer-implemented system for conducting a structured analysis of the file wrapper history of a patent grant, and supporting the generation of allowed patent claim and considered prior art charts that facilitate the application of the patent claim construction rule requiring interpretation of granted patent claims so as to preserve claim validity.

Another aspect is a computer-implemented patent file history analysis platform for analyzing the patent file wrapper history of a granted patent using abstracted claim concepts, and displaying patent file history charts containing allowed patent claims, applied prior art references, and prosecution history events, being transparently mapped and indexed using said abstracted claim concepts.

Another aspect is a computer-implemented method of visualizing and better understanding the boundaries of patent protection afforded by granted patent claims using human analysis and judgment during the display patent file history charts containing patent claims, applied prior art references, and prosecution history events being transparently mapped and indexed using abstracted claim concepts.

Another aspect is a computer-implemented system for visualizing and better understanding the boundaries of patent protection afforded by granted patent claims using human analysis and judgment during the display patent file history charts containing patent claims, applied prior art references, and prosecution history events being transparently mapped and indexed using abstracted claim concepts.

Another aspect is a computer-implemented patent file history interpretation platform capable of generating and displaying patent file history charts having multiple prior art reference columns mapped against allowed patent claims, transparently using abstracted claim concepts.

Another aspect is a computer-implemented method of building a computer-database during the structured analysis of the file history of a granted patent, and using computer-database to generate and display patent file history charts containing allowed patent claims, considered prior art references, and prosecution history events being transparently mapped and indexed using abstracted claim concepts.

Another aspect is a computer-implemented method of discovering cumulative prior art references mapped to patent file history charts containing allowed patent claims, applied prior art references, and prosecution history events being transparently mapped and indexed using abstracted claim concepts.

Another aspect is a computer-implemented system for and method of generating patent claim summary charts for supporting Markman hearings, wherein said patent claim summary charts contain allowed patent claims, applied prior art references, and prosecution history events transparently mapped and indexed using parsed claim limitations.

Another aspect is a computer-implemented method of generating patent claim/prior art charts for supporting each substantial new question of patentability (SNQP) in a request for reexamination of certain allowed claims in a granted patent while reducing the burden on the USPTO, wherein each said patent claim/prior art chart contains said certain allowed patent claims for which reexamination is requested, prior art references applied during prosecution, prosecution history events, and prior art references cited in said request, each being transparently mapped and indexed using abstracted claim concepts.

Another aspect is a computer-implemented method of generating patent claim invalidity charts for supporting patent claim invalidity contentions.

Another aspect is a system for generating patent claim validity charts for supporting patent claim validity contentions.

Another aspect is a computer-implemented method of abstracting claim concepts from allowed patent claims in a granted patent.

Another aspect is a computer-implemented method analyzing and charting patent prosecution histories of granted patents to assist during the patent claim understanding/interpretation process to better understand the boundaries offered by the allowed patent claims in the granted patent, while overcoming the shortcomings and drawbacks of prior art methods and technologies.

Another aspect is a computer-implemented method of patent claim analysis and charting comprising the steps of: (i) scope concept mapping claims and statements made in patent prosecution history, including prior art references; (ii) supporting multiple configurable modes of system operation, wherein each configurable mode of system operation employs different mapping techniques for different kinds of patent claim related analysis, language and information processing, and information charting; (iii) generating the various prosecution-history based chart structures for the different modes of system operation supported by system; (iv) guiding the user(s) using graphical user interfaces (GUIs) designed to help identify and collect information about the patent prosecution history, in a structured manner, with the aid of programmed expertise; (iv) presenting collected and processed prosecution history information in novel chart structures that allow patent professionals, including attorneys paralegals and other members of a legal analysis team, as well as inventors, engineers and scientists, to better visualize the boundaries or scope of patent claim protection that should be allowed by a granted patent claim; (iv) allowing collected information from one mode be used and leveraged in other modes, during and over the compete life cycle of a granted patent; and (v) providing a system that replaces some attorney/lawyer functions with technology that assists in organizing patent claims and prior art information, while providing improved tools for better understanding this data, by providing a significant edge over standard patent claim chart analysis, and a deeper understanding of the patent issues in patent cases.

Another aspect is a patent prosecution history processing tool that assists in and enhances the understanding of the scope and boundaries of patent protection, and which can be applied to infringement and invalidity analysis, to assist in the understanding of the proper scope of patent claims.

Another aspect is a patent prosecution history processing tool that can be reconfigured if and when the claims are too broad, based on the prior art analysis, so that a patent invalidity contention can be made.

Another aspect is a patent prosecution history processing tool that be reconfigured and used to assist in determining whether or not the claim scope truly reaches an accused product or service.

Another aspect is a patent prosecution history processing tool for processing, tracking and handling information collected during the prosecution history of a patent, the prior art considered during prosecution, any stated reasons for allowance, and also prior art not considered during prosecution.

Another aspect is a patent prosecution history processing tool that helps enhance the understanding of the boundaries of patent protection.

Another aspect is a patent prosecution history processing tool that helps achieve greater transparency, lower legal costs, and greater technological expertise during the entire patent life-cycle process by way using a new and improved class of information management, analysis/mapping and display/charting tools and instruments for use by inventors, scientists, engineers, patent attorneys, paralegals and others involved in the patent process.

Another aspect is an Internet-based document processing system for supporting an improved method of patent file history analysis assisting in the understanding the boundaries of patent protection allowed granted patent claims, by supporting improved information analysis, indexing, management and display/charting processes that help better organize prior art information surrounding a particular invention disclosure specified in a patent grant.

Another aspect is a computer-implemented method of intelligently analyzing the file/prosecution history of a granted patent and automatically generating patent claim prosecution history charts to help better understand and visualize the boundaries of patent protection afforded by the patent claims in the granted patent.

Another aspect is a system for intelligently analyzing the file/prosecution history of a granted patent and automatically generating patent claim prosecution history charts to help better understand and visualize the boundaries of patent protection afforded by the patent claims in the granted patent.

Another aspect is a computer-implemented method comprising: using claim scope concepts to automatically generate patent file history charts containing patent claims, prior art references and prosecution history events mapped and linked/indexed using claim scope concepts.

Another aspect is a computer-based system configured in a patent claim scope interpretation analysis mode of operation for analyzing and charting the patent prosecution history of a granted patent, so as to help better understand the boundaries of patent protection afforded by the patent claims of the granted patent.

Another aspect is a computer-based system configured in a Markman patent claim term analysis mode of operation, generating patent prosecution history based Markman claim charts to help better understand terms in patent claims of a granted patent.

Another aspect is a computer-based system configured in hybrid-type claim scope interpretation/Markman analysis mode of operation, for analyzing and charting the patent prosecution history of a granted patent, so as to help better understand the boundaries of patent protection afforded by the patent claims of the granted patent.

Another aspect is a computer-based system configured in a prior art analysis mode of operation, for analyzing and charting patent prosecution history of a granted patent, and generating search vectors for use in searching for and discovering new prior art references related to the subject matter of the patent claims in a patent grant.

Another aspect is a computer-based system configured in a prior art analysis mode of operation, for analyzing and charting patent prosecution history of a granted patent, and generating patent prosecution history based claim contention charts for use in contending the invalidity of allowed patent claims in a granted patent.

Another aspect is a computer-based system configured in a patent claim infringement analysis mode of operation, for analyzing and charting patent prosecution history of a granted patent, and generating patent prosecution history based claim infringement charts to assist in patent claim infringement analysis of alleged products and/or services.

Another aspect is a computer-based system configured in a freedom-to-operate (FTO) analysis mode of operation, for analyzing and charting a group of granted patents and/or published patent applications, against product and/or service descriptions, in patent prosecution history based freedom to operate (FTO) charts, used during FTO analysis of the patent claims in the group of patents/applications.

Another aspect is a computer-based system configured in a patent litigation-storyboard analysis mode of operation, for analyzing and charting patent prosecution history of a granted patent, as well as plaintiff-produced and/or defendant-produced evidence discovered during litigation, and generating patent prosecution history based patent litigation-storyboard charts to assist in evidentiary and litigation planning issues related to the allegedly-infringing products and/or services involved in the patent litigation.

Another aspect is a computer-implemented method of and system for conducting a structured analysis of the file wrapper/prosecution history of a granted patent, and supporting the generation of allowed claim charts that facilitate the application of the patent claim construction rule requiring interpretation of granted patent claims so as to preserve claim validity.

Another aspect is a computer-implemented patent file history analysis platform for analyzing the patent file wrapper history of a granted patent using abstracted claim/scope concepts, and displaying patent file history charts containing allowed patent claims, cited and applied prior art references, cited and non-applied prior art references, and prosecution history statements, transparently mapped and indexed using direct linking and/or scope concept mapping processes.

Another aspect is a computer-implemented method of discovering cumulative prior art references mapped to patent file history based charts containing allowed patent claims, cited and applied and cited and non-applied prior art references, and prosecution history statements made by the applicant(s) and the patent office, transparently mapped and indexed using direct linking and/or scope concept mapping processes.

Another aspect is a computer-implemented method of generating claim charts for supporting Markman hearings, wherein the claim charts contain the allowed patent claims, cited and applied and cited and non-applied prior art references, and prosecution history statements by applicant(s) and the patent office, transparently mapped and indexed using parsed claim limitations.

Another aspect is a computer-implemented system for generating claim charts for supporting Markman hearings, wherein the claim charts contain the allowed patent claims, cited and applied and cited and non-applied prior art references, and prosecution history statements by applicant(s) and the patent office, transparently mapped and indexed using parsed claim limitations.

Another aspect is a computer-implemented system for generating patent prosecution history based patent claim charts for supporting each substantial new question of patentability (SNQP) in a request for reexamination of certain allowed claims in a granted patent, while reducing the burden on the USPTO, wherein each patent prosecution history based patent claim chart contains certain allowed patent claims for which reexamination is requested, prior art references cited and applied and cited and not-applied during prosecution, prosecution history statements by applicant(s) and the patent office (i.e. examiner), and prior art references cited in the request, each being transparently mapped and indexed using direct linking and/or scope concept mapping processes.

Another aspect is a computer-implemented system for generating patent prosecution history based patent claim charts for supporting each substantial new question of patentability (SNQP) in a request for reexamination of certain allowed claims in a granted patent, while reducing the burden on the USPTO, wherein each patent prosecution history based patent claim chart contains certain allowed patent claims for which reexamination is requested, prior art references cited and applied and cited and not-applied during prosecution, prosecution history statements by applicant(s) and the patent office (i.e. examiner), and prior art references cited in the request, each being transparently mapped and indexed using direct linking and/or scope concept mapping processes.

Another aspect is a computer-implemented system for generating patent prosecution history based patent claim invalidity charts for supporting patent claim invalidity contentions.

Another aspect is a computer-implemented method of generating patent prosecution history based patent claim invalidity charts for supporting patent claim invalidity contentions.

Another aspect is a computer-implemented system for generating patent prosecution history based chart structures that assist human users during the cognitive process of understanding the scope (i.e. boundaries) of patent claims (i.e. during the patent claim construction process) before the scope or breadth of patent claims is limited for purposes of preserving validity (i.e. claim validity).

Another aspect is a computer-implemented system for generating an unique object-oriented patent claim analysis and charting platform, automatically programmed for each granted patent, to help others better understand the scope and boundaries of patent protection allowed by any granted patent.

Another aspect is a computer-implemented system platform supporting a method comprising: (a) automatically generating, for each patent granted in a national patent protection system, an object-oriented patent analysis and charting system comprising patent file history data, methods and GUIs; (b) loading the object-oriented patent analysis and charting system onto Internet-based servers so that the patent analysis and charting system can be remotely accessed by a group of authorized web-enabled clients; (c) efficiently analyzing the patent file/prosecution history of a granted patent including the allowed patent claims, cited prior art references, and patent prosecution history statements) in highly structured manner; (d) linking claim rejections and prior art reference disclosure to corresponding limitations in the allowed patent claims; (e) linking prosecution history statements made by applicant(s) and the examiner to corresponding claim limitation and/or sub-limitation language; (f) formulate and assign scope concepts to the limitations of the allowed patent claims; (g) linking (i.e. mapping) cited prior art references to corresponding language in the allowed patent claims using scope concept based mapping techniques; and (h) automatically generate patent prosecution history based patent claim charts designed to better help understand the scope and boundaries of patent protection that should be allowed or afforded by the patent claims in each granted patent, granted against a scope concept mapped prior art landscape.

Another aspect is a method of analyzing the patent file wrapper (i.e. prosecution) history of a granted patent, using improved methods, data structures and charting technology, to help others better understand the boundaries of patent protection afforded by the allowed claims of the granted patent, and to do so with a greatly increased level of efficiency and at a significantly lower cost savings.

Another aspect is a computer-implemented method of contending the invalidity of allowed patent claims in a granted patent using scope concept mapping of prior art references and the language of claim sub-limitations in the allowed patent claims.

Another aspect is a computer-implemented method of scope concept based mapping of the language of claimed subject matter in granted patent claims, against the technical disclosure of one or more corresponding prior art references, that may or may not have been cited during the prosecution history of the granted patent, so as to significantly improve the discrimination between a claimed invention against surrounding prior art references, and assist in the understanding of the scope and boundaries of granted patent claims.

Another aspect is a computer-implemented method of scope concept based mapping of granted patent claims and corresponding prior art references, so as to assist in the valuation and devaluation of an invention covered by a granted patent claim.

Another aspect is a computer-implemented method of scope concept based mapping of granted patent claims and corresponding prior art references, so as to assist in determining the best combination of prior art references to support a patent claim rejection, for example, during expedited patent examination proceedings.

Another aspect is a computer-implemented method of scope concept based mapping of granted patent claims and corresponding prior art references, so as to assist in determining the best combination of prior art references to support a patent claim contention, for example, during post-grant and inter-parte re-examination proceedings.

Another aspect is a method of linking the sub-limitation language of patent claim and a scope concept embraced by the sub-limitation language of the patent claim during scope formation and assignment processes within a patent analysis and charting system.

Another aspect is a computer-implemented method of linking claim scope concepts with linguistic statements made in patent file history documents, including the patent specification, office action documents, amendments and prior art references, so that such statements can be mapped against corresponding patent claim limitations displayed in patent prosecution history based chart structures which can be used to support patent claim scope interpretation.

Another aspect is an Internet-based multi-mode patent claim analysis and charting system that can be user-reconfigured to support any one of more of a plurality of modes of system operation, including, but not limited to: a Patent claim Prosecution Analysis Mode, during which, patent prosecution history based claim scope concept (CSS) chart structures are automatically generated and displayed; Patent claim Scope Interpretation/Construction Analysis Mode, during which, Patent claim Scope Interpretation Charts are automatically generated and displayed; a Markman Patent claim Analysis Mode, during which Patent Prosecution History Based Markman claim Charts are automatically generated and displayed; a Hybrid-Type Patent claim Scope/Markman Analysis Mode, during which Hybrid Patent Prosecution History claim Charts are automatically generated and displayed a Prior/Present Art Search Analysis Mode, during which Prior Art Search Vector Specifications are generated as system output; a Patent claim Invalidity Contention Analysis Mode, during which Patent Prosecution History Based claim Contention Charts are automatically generated and displayed; a Patent claim Infringement Analysis Mode, during which Patent Prosecution History Based claim Infringement Charts are automatically generated and displayed; Freedom to Operate (FTO) Analysis Mode, during which Patent Prosecution History Based Freedom-To-Operate (FTO) Charts are automatically generated and displayed; and a Patent Litigation-Storyboard Analysis Mode, during which Patent Prosecution History Based Patent Litigation-Storyboard Charts are automatically generated and displayed.

Another aspect is a method of scope concept formulation, assignment, and linkage carried out within a patent analysis and charting system, comprising the steps of: (a) within a patent analysis and charting system, allowing a user to search two or more words in any phrase in any patent claim, as well as in any document in the patent file wrapper (PFW) of a patent grant, or pending patent application; (b) within the system, allowing the user to think or conceive of a scope concept that embraces the searched words or phrases; (c) within the system, displaying graphical user interfaces (GUIs) that allow the user to define or formulate the conceived scope concept in natural language, and enter the formulated scope concept into a scope concept library supported within the system; (d) using the system to find and link searched words throughout all file history documents/papers, that correspond to the formulated scope concept; and (e) storing these language/scope concept links in a database maintained within the system.

Another aspect is a method of forming scope concepts during freedom to operate (FTO) analysis involving one or more products and/or services, and linking scope concepts to language in the claims of published patent applications and/or granted patents in a group of patents/applications, said method comprising the steps of: (a) in a database system, storing a group of patents/applications comprising (i) one or more published patent applications, each having patent claims with original claim numbering, and/or (ii) one or more granted patents, each having claims with final claim numbering; (b) using the original claim numbering, selectively displaying one or more of patent claims from one or more published patent applications in the group of patents/applications, and using the final claim numbering, selectively displaying one or more selected patent claims from one or more granted patents in the group of patents/applications; (c) in the database system, storing product and/or service descriptions comprising language specifying a set of product features and functionalities defined for the products involved in the FTO analysis, and/or the language specifying a set of service features and functionalities defined for the services under FTO analysis; (d) selectively displaying the language specifying the set of product features and functionalities defined for the products involved in the FTO analysis, and/or the language specifying the set of service features and functionalities defined for the services under FTO analysis; (e) reviewing the displayed language of the claims in the group of published patent applications and/or granted patents and the displayed language of the product and/or service features and functionalities, and therewhile determining correspondences that appear to exist between (i) the displayed language of the product and/or service features and functionalities and (ii) the displayed language of the claims in the group of published patent applications and/or granted patents; (f) using the determined correspondences to define a set of scope concepts that embrace or cover certain subject matter of the patent claims in one or more of the published patent applications and/or granted patents in the group of patents/applications; (g) creating links between the scope concepts, and corresponding language in certain of the claims in the group of patents/applications, and storing these scope concept/claim language links in the system database; and (h) repeating steps (a) through (g) above so that at least one scope concept embraces or covers certain subject matter of each selected (e.g. independent) patent claim in each published patent application and granted patent in the group of patents/applications.

Another aspect is a method of finding a group of patents and/or published applications with claims to be reviewed during freedom to operate (FTO) analysis, said comprising the steps of: (a) producing a technical specification for the system design (e.g. products and/or services) which shall be the subject of freedom to operate or FTO study; (b) based on said technical specification, drafting one or more sets of reference features and functionalities that cover core and subordinate architectural features and functionalities of the product and/or service design; (c) abstracting a set of scope concepts from said set of features and functionalities that represent the technical specifications on product and/or service design, and defining said scope concepts in natural language; (d) based on one or more combinations of said scope concepts, and said set of features and functionalities, generating a set of search vectors for discovering relevant prior art patents and/or published patent applications, containing patent claims covering subject matter specified by said scope concepts and said features and functionalities; (e) using said search vectors to search for, find and access a group of patents and/or published patent applications, referred to as patent references, during prior art search efforts; and (f) filtering-out non-relevant patent references, from the entire retrieved set of patent references, and then organizing the relevant patent references into a group of granted patents and published patent applications, according to one or more levels of relevance.

Another aspect is a computer-implemented system for generating a claim chart structure during the patent claim invalidity analysis of a patent granted with allowed patent claims, said computer-implemented system comprising: a computer system for storing data relating to (i) a patent under patent claim invalidity analysis, (ii) prior art references and other documents produced or otherwise cited during the patent prosecution history of said patent under claim invalidity analysis, and (ii) the processing of said data and generating a claim chart structure for display and use by others during patent claim invalidity analysis and countermeasures thereto by said patent owner; one or more client machines for use by users involved in said claim invalidity analysis, including the patent owner and third parties challenging the validity of the allowed claims in said patent; a communication server operably connected to said computer database system, for serving said claim chart structure to said one or more client machines for display and viewing; wherein said claim chart structure comprises: a first set of data fields containing the language of patent claims allowed in a patent under claim invalidity analysis; a second set of data fields containing specific language from prior art references being used to support patent claim invalidity contentions by a third-party, and being scope concept mapped against limitations and/or sub-limitations of said allowed patent claims; and a third set of data fields containing specific language of prior art references cited during the patent prosecution of said allowed patent claims, and being scope concept mapped against said limitations and/or sub-limitations of said allowed patent claims; wherein the comparison of the data contained in said first and second data fields is used to help said third party to support arguments for the invalidity of one or more of said allowed patent claims, based on the prior art references mapped to said second set of data fields, against limitations and/or sub-limitations of said allowed patent claims; wherein the comparison of the data contained in said second and third data fields is used to help said patent owner support countermeasures against patent claim invalidity contentions being made by said third party against the allowed patent claims of said patent owner; and wherein said claim chart structure assists in resolving the proper scope and boundaries of patent protection that should be afforded by the allowed patent claims in view of the prior art references cited during said patent prosecution history, and by said third party during said patent claim invalidity contentions, without the necessity of invalidating said patent claims.

Another aspect is a computer-implemented method of automatically generating rational patent claim invalidity contentions, based on different classes of prior art references, for use in various applications.

Another aspect is a system for automatically generating patent claim invalidity contentions for use in various applications, including patent insurance policy and risk mitigation systems employed to underwrite and manage patent infringement defense and liability insurance policies in diverse marketplaces.

Another aspect is a patent insurance policy and risk mitigation system, employing patent prosecution history based prior art search methods, and automated patent claim invalidity contention generation methods, that enable an unprecedented level of risk mitigation to patent insurance policy underwriters and policy holders by virtue of new and improved capacities to create and advance patent invalidity contentions against the improper assertion of patent claims in marketplace.

Another aspect is a method of procuring a patent insurance policy with a patent invalidity contention analysis (PICA) provision, over a patent insurance and risk mitigation network supported by an internet-based patent claim invalidity contention analysis (PICA) generation, charting and reporting system to assist in the mitigation of risks and costs associated with providing patent insurance coverage.

Another aspect is a patent insurance and risk mitigation network for procuring and administering patent insurance policies between insured parties and patent insurance underwriters, containing patent invalidity contention analysis (PICA) provisions, supported by an internet-based patent claim invalidity contention analysis (PICA) generation, charting and reporting system to assist in the mitigation of risks and costs associated with providing patent insurance coverage.

Another aspect is a prior art searching system, employing advanced search methods having the capacity to (i) generate search vectors, based on scope concepts assigned to patent claims, to search for and discover prior art information relating to the patent claims, including, but not limited to patents, patent application publications, companies, products, services and people related to the subject matter of a set of patent claims under investigation, and (ii) generate prior art search reports based on such search efforts.

Another aspect is a patent opportunity prospecting system, employing advanced search methods having the capacity to (i) generate patent prosecution history based search vectors for use in searching for news and present art information on companies, products, services and people related to the subject matter of a set of patent claims under investigation, and (ii) generate present art search reports based on such search efforts.

Another aspect is a computer-implemented method of examining the patent claims in a national patent office, and documenting the same during the patent prosecution history using claim patentability charts, so as to provide greater transparency and more accurate patent claim scope resolution in the interests of inventors, patent owners and the general public alike.

Another aspect is a system for presenting, analyzing and examining patent claims in a national patent office, and documenting the same during the patent prosecution history, so as to provide greater transparency and more accurate patent claim scope resolution in the interests of inventors, patent owners and the general public alike.

Another aspect is a patent claim examination and prior art management system supporting automated claim patentability analysis and charting processes, for use by examiners when examining the claims in a pending utility patent application.

Another aspect is a process for examining patent claims in a patent office, employing computer-assisted scope concept analysis of both pending patent claims and prior art references, and automated methods for generating rational patent claim patentability analyses, charts and reports, to better serve the public interest.

Another aspect is a patent claim examination process involving the deployment of a patent claim examination and prior art management system employing scope concept analysis of patent claims and prior art references and automated claim patentability analysis and documentation processes.

Another aspect is a computer-implemented method of automatically generating claim patentability analysis charts based on a set of claims each of which have been analyzed and assigned one or more scope concept encompassing the inventive features of the claims, and a set of prior art of references which also have been analyzed with the scope concepts assigned to the claim.

Another aspect is a n automated system for generating claim patentability analysis charts based on a set of claims each of which have been analyzed and assigned one or more scope concept encompassing the inventive features of the claims, and a set of prior art of references which also have been analyzed with the scope concepts assigned to the claim.

Another aspect is a claim Scope Concept Markup Language (CSCML) and a machine-implemented document processing algorithm called claim Scope Concept Processing (CSCP) which when working together enables unprecedented levels of automated or computer-assisted patent claim analysis and charting—designed to assist patent attorneys in making more informed decisions and judgments about the scope and boundaries of patent claims before filing, during prosecution, and after grant.

Another aspect is a claim Scope Concept Markup Language that can be practiced by a trained human user using a CSCML editor program running on any client or server computer system, and which is designed to (i) help users quickly identify and capture claim limitations in patent claims, and inventive features encompassed by the language of the claim limitations and/or sub-limitations of the patent claims, (ii) convert ordinary text-based patent claim language into CSCML-based patent claim language, or any ordinary text-based patent claim into a CSCML-based patent claim.

Another aspect is a machine-implemented claim Scope Concept Processing (CSCP) method designed to process the CSCML-based patent claims and generates various scope concept based data structures that are used throughout the various legal processes currently found in patent law environments.

Another aspect is a computer-implemented system supporting a claim Scope Concept Markup Language (CSCML) and a machine-implemented document processing algorithm called claim Scope Concept Processing (CSCP) Applications, for use in legal process applications including, but not limited to, claim Patentability Analysis, Patent claim Invalidity Contention Analysis, Scope-Concept Based Search Vector Generation, Patent claim Infringement Analysis, and Patent claim Scope Interpretation/Construction Analysis.

Another aspect is a computer-implemented method of marking up a set of patent claims, using a claim Scope Concept Markup Language (CSCML), said computer-implemented method comprising the steps of: (a) providing a set of patent claims to be analyzed, wherein each patent claim consists of a plurality of claim limitations, each having a claim limitation language string (CLLS); (b) assigning at least one claim scope concept structure (CSCS) to each claim limitation language string in each patent claims, wherein each said CSCS comprises a claim limitation identifier, a claim scope concept structure (CSCS) identifier, and an inventive feature phrase (IFP); (c) generating claim scope concept (CSC) based search vectors; (d) searching for prior art references using the CSC-based search vectors, retrieving prior art references and tagging with the CSC-based search vectors; (e) generating prior art reference scope concept profiles; (f) using prior art reference scope concept profiles to automatically generate claim patentability analysis, and claim patentability analysis charts associated with the claim patentability analysis.

Another aspect is a n automated method of prior art reference searching and claim patentability analysis comprising the steps of: (a) providing a set of claims in a patent application or granted patent for storage in a database so that the subject matter of the claims can be searched for prior art references that may be material to the patentability of the claims, and which can be subsequently analyzed during an Automated Method Of Prior Art Reference Searching And claim Analysis (PARSCPA) according to the principles of the present invention; (b) parsing each claim into a set of claim Limitations, each comprising a claim Limitation or Sub-Limitation Language String (CLLS); (c) marking-up each claim Limitation Or Sub-Limitation Language String (CLLS) in each claim to create a claim Scope Concept Structure (CSCS) for the marked-up claim limitation or sub-limitation language string, and store the CSCSs in the system database, wherein each CSCS includes data and meta-data comprising a claim Limitation Language String (CLLS), a claim Limitation Identifier (CLID), an Inventive Feature Phrase (IFP) comprising a set of words, and claim Scope Concept Structure Identifier (CSCSID); (d) generating a set of CSCS-based search vectors based on the data and meta-data contained in the claim Scope Concept Structure (CSCS) of each claim Limitation Language String contained in each claim; (e) using the set of CSCS-based Search Vectors to search for and find a set of Prior Art References, each matching at least one of the CSCS-based Search Vectors, and a generate set of Prior Art Search Records for the retrieved Prior Art References, wherein each prior art search record is created by linking to or tagging the CSCS-based Search Vector used to retrieve a particular prior art reference, with the Prior Art Reference, cited Prior Art Disclosure and the claim Scope Concept Structure Identifier (CSCSID), to create the Prior Art Search Record that is stored in the system database for the corresponding CSCS-based Search Vector; (f) using the Prior Art Search Record (PASR) generated for each retrieved prior art reference, and the claim Scope Concept Based Prior Art Reference Analysis Schema, to generate a set of Prior Art Reference claim Scope Concept Profile Documents for the set of retrieved Prior Art References, wherein each Prior Art Reference claim Scope Concept Structure Profile document comprises, for each claim in the set of claims, a list of claim Scope Concept Structures (CSCS), and indication of whether or not each CSCS has been substantiated by prior art disclosure from at least one prior art reference retrieved from the search, and indexed with the CSCS-based search vector that was used to retrieve the prior art reference containing the prior art disclosure; (g) optionally, organizing the claim Scope Concept Structures (CSCS) in the Prior Art Reference claim Scope Concept Structure Profile documents by grouping the claim Scope Concept Structures (CSCS) having the same or similar Inventive Feature Phrases (IFP), or at least a predetermined number of common IFP words, so that a human reviewer or analyzer can see all claim Scope Concept Structures (CSCSs); (h) automatically processing the set of Prior Art Reference claim Scope Concept Profile documents to analyze the retrieved set of Prior Art References, and generate claim Patentability Analyses based on the analyzed retrieved Prior Art References, and then generate claim Patentability Analysis Charts according to the present invention; (i) ranking the Prior Art References retrieved during the search results according to which Prior Art References have the Maximum Number Of claim Scope Concepts (CSC) Substantiated By Prior Art Reference Disclosure (Mapped By The CSC-Based Search Vectors), Then Order Prior Art Reference Analysis by a human subject matter expert according to The Highest Priority Of CSC-Ranking.

Another aspect is that the step of ranking prior art references may comprise: (a) analyzing the search results for each retrieved prior art reference; (b) for each prior art reference, analyzing its updated prior art reference claim scope concept profile, to determine, for the entire set of claims, the number of claim scope concepts which are substantiated by prior art disclosure during the automated prior art search, retrieval and mapping operations, carried out using CSC-based search tags; (c) ranking the retrieved prior art references according to the number of claim scope concepts that have been substantiated by prior art reference disclosure during automated prior art search, retrieval and mapping operations; and (d) reviewing and analyzing in a prioritized order, those retrieved prior art references having the maximum number of claim scope concepts, for all claims, substantiated by prior art reference disclosure.

Another aspect is that alternatively, the step of ranking prior art references may comprise: (a) analyzing the search results for each retrieved prior art reference; (b) for each prior art reference, analyzing its updated prior art reference claim scope concept profile, to determine, for specific claims, the number of claim scope concepts that are not substantiated by prior art disclosure during the automated prior art search, retrieval and mapping operations; (c) ranking the retrieved prior art references according to the number of claim scope concepts, for specific claims, that have been substantiated by prior art reference disclosure during automated prior art search, retrieval and mapping operations; and (d) reviewing and analyzing in a prioritized order, those retrieved prior art references having the maximum number of claim scope concepts, for the specific claims, that have substantiated by prior art reference disclosure.

Another aspect is a computer-implemented process for marking up any patent claim expressed in natural language, and directed to a useful invention, setting forth the scopes and boundaries of patent protection to be afforded to the invention covered by the patent claim, said computer-implemented process comprising: (a) storing a patent claim in the memory of a computer system having a graphical display and data input device, and a programmed processor executing a program that performs the following operations: (b) parsed the patent claim into a plurality of claim limitation language strings (CLLS); (c) assigning to each claim limitation language string (CLLS), a claim limitation identifier or index (CLID); (d) assigning to each CLLS, a claim Scope Concept Phrase (CSCP) composed of a set of words (W1, . . . WN) describing the Scope Concept encompassed by the claim Limitation Language String (CLLS), wherein the words selected for the claim Scope Concept Phrase (CSCP) may or may not have an antecedent basis in the CLLS and may be abstracted from the CLLS to encompass subject matter beyond the literal interpretation of the CLSS; and (e) assigning a claim Scope Concept Structure Identifier (CSCSID) to each said CLLS, to identify an entire CSC data structure.

Another aspect is a network-based patent analytical workspace designed for use by everyone interested in patents, comprising: information search systems; and computer-implemented language processing capabilities, designed to (i) help anyone gain simpler access into the complex process of understanding the scope and limits of such patent protection, afforded by any set of patent claims, pending, allowed or granted, (ii) assist Applicant/Inventors to properly reconstruct the true state of knowledge in the art at the time of patent application filing by electronic disclosure of relevant and material prior art references to the Patent Office with insightful forms of analytical support to assist in patent claim examination in a spirit of candor and good faith and the securing of strong but proper patent protection, and also (iii) allow anyone to challenge the scope and boundaries of granted patent claims, whenever necessary and proper, supported by rational prior art analysis and documentary support.

Another aspect is an Internet-based patent analysis and charting system comprises one or more of an open-public claim patentability analysis (OPCPA) module, and an open-public claim invalidity contention analysis (OPCICA) module, that are accessible and utilizable on the www by members of the public.

Another aspect is that the function of the OPCPA module may be to allow members of the public, working alone or together, to review the file history of and patent claims in any published patent application prior to grant, and generate automated rational claim patentability analysis charts for disclosure in the published patent application and review and consideration by the patent examiner during the patent examination process; and wherein the function of the OPCICA module is to allows members of the public, working alone or together, to review the file history of and allowed patent claims in any granted patent after grant, and generate automated rational claim invalidity contention analysis charts for disclosure in the granted patent, and review and consideration by the patent examiner during a post grant review, a reexamination proceeding or the like.

Another aspect is that using a Web-enabled client, the Web-based open-public claim patentability analysis (OPCPA) module may be selected and its GUIs and methods used to perform the following functions: (i) identify any specific published patent application for public claim review and analysis prior to patent grant; (ii) create a public patent claim review (PPCR) account on the system accessible through the web-based OPCPA module; (iii) load the file history of the specified patent application in a system database and linked to the PPCR account; (iv) scope-concept analyze the patent claims in the published patent application prior to grant; (v) generate claim scope concept (CSC) based prior art search vectors based on the scope concept analyzed patent claims; (vi) use the CSC-based prior art search vectors to search for new and non-cited prior art references relating to the subject matter of the patent claims in the published patent application; (vii) add to the PPCR account, new and non-cited prior art references for review and analysis using CSC-based prior art reference GUIs/schemas; (viii) select scope concept analyzed prior art references, including scope-concept analyzed prior art references cited by the Examiner or Applicant/Inventor, for use in automated rational claim patentability analysis by the system; and (ix) automated generation of claim patentability charts and reports based on the selected scope concept analyzed prior art references.

Another aspect is that alternatively, using a Web-enabled client, the Web-based open-public claim invalidity contention analysis (OPCICA) module may be selected and its GUIs and methods used by members of the public to perform the following functions: (i) identify any specific published patent application for public claim review and analysis prior to patent grant; (ii) create a public patent claim review (PPCR) account on the system accessible through the web-based OPCPA module; (iii) load the file history and prior art references of the specified patent in a system database, and link the same to the PPCR account; (iv) scope-concept analyze the patent claims in the published patent application prior to grant; (v) generate claim scope concept (CSC) based prior art search vectors based on the scope concept analyzed patent claims; (vi) use the CSC-based prior art search vectors to search for new and non-cited prior art references relating to the subject matter of the patent claims in the published patent application; (vii) add to the PPCR account, new and non-cited prior art references for review and analysis using CSC-based prior art reference GUIs/schemas; (viii) select scope concept analyzed prior art references, including scope-concept analyzed prior art references cited by the Examiner or Applicant/Inventor, for use in automated rational claim invalidity contention analysis by the system; and (ix) automated generation of claim invalidity contention charts and reports based on the selected scope concept analyzed prior art references.

Another aspect is that members of the public using said PPCR account in connection with any patent application review or patent grant review can organize in any manner they believe useful or helpful to perform the claim and prior art reference analysis processes required by the OPCPA and OPCICA modes and modules.

Another aspect is a patent analysis and charting system comprising an automated XML-based document generation module, that interacts with and shares data between one or more of the patent analysis and charting modules supported by the system, so that a user can simply and quickly generate a particular patent-related document supported within the patent-related document library of the system based on the output chart structures generated during patent analysis and charting operations supported on the patent analysis and charting system.

Another aspect is that the patent-related document may be selected from the group consisting of Request for Re-examination, Office Action With Argument for Non-Patentability, Response to Office Action with Argument for Patentability, and Argument For Patent claim Invalidity Contention.

Another aspect is that, when the user needs to edit the XML-based patent-related document, the user may add facts relating to (i) particular limitations or sub-imitations in a particular patent claims, (ii) a particular prior art reference, and/or (iii) other facts, analysis or observations that support the arguments being made, and the system has the capacity to synchronize such added data content made in the XML-based patent-related document during the editing process, with the XML-based chart structure, the system database from where all data content is stored in the system.

Another aspect is that user may select the automated XML-based document generation module by clicking on a graphical icon and providing access to GUI screens and methods supported by the XML-document generation module, wherein the automated XML-based document generation module allow a diverse class of users to automatically generate documents containing natural-language arguments in support of particular positions, decisions or opinions on a wide range of patent-related issues.

Another aspect is that documents may be selected from the group consisting of legal filings, government agency office actions, legal memorandums, legal opinions and/or judicial orders; and wherein said wide range of patent-related issues, include, but are not limited to: (i) the invalidity of granted patent claims of improper scope in view of the state of the art in view of particular prior art references analyzed in generated claim invalidity contention charts; (ii) the patentability of pending patent claims in view of particular combination of prior art references analyzed in generated claim patentability charts; (iii) the non-patentability of pending patent claims in view of particular prior art references analyzed in generated claim patentability charts; (iv) the allowability/patentability of pending patent claims in view of particular prior art references analyzed in generated claim patentability charts or claim invalidity contention charts; (v) the infringement of granted patent claims in view patent claims and products/services analyzed in generated claim infringement analysis charts; (vi) the non-infringement of granted patent claims in view patent claims and products/services analyzed in generated claim infringement analysis charts; and (vii) the freedom to operate (FTO) particular product and/or service designs around particular patent claims analyzed in FTO-based charts.

Another aspect is a method of generating patent-related documents in a patent analysis and charting system having a system database, said method comprising the steps of: (a) loading into the system database, a library of XML-based schemas for a set of XML-based patent-related documents; (b) receiving, as a source document, an XML-based chart structure generated by the system using the appropriate XML chart structure schema; (c) retrieving from the system database, the XML schema for the patent-related document; (d) generating an XML-based patent-related document using (i) the XML schema selected for the XML-based patent document, and (ii) the XML-based chart structure; (e) outputting the XML-based patent related document for display; (f) editing the data content in the XML-based patent-related document as required by the end user drafting and editing the document; and (g) synchronizing the data content of XML-based patent-related document, the XML-based chart structure document, and the system database. The method may further comprise: (h) transmitting the XML-Based patent-related document to its destination (e.g. Patent Office, Federal or International Court, Federal Agency, etc.) as required by end user application).

Another aspect is a system for analyzing and charting patent applications and/or granted patents, including an automated document generation facility that supports a document generation processing comprising the steps of: (i) mapping data content within a system database of the system, to an output XML-based chart structure; (ii) mapping data content from the output XML-based chart structure to a XML-based patent-related document; (iii) displaying the XML-based patent-related document; (iv) editing data content within the XML-based patent-related document; and (v) synchronizing data content among the XML-based patent-related document, the XML-based chart document, and the system database within said system.

Another aspect is that users may be provided with the capacity of: (i) charting and visualization of patent claim and prior art analysis; (ii) generating a patent-related document based on the generated chart structure; and (iii) editing and synchronizing of data content within these generated patent-related document.

Another aspect is a method for ranking the quality of a first information source of a plurality of information sources with respect to a patent claim in a collaboration and analysis system, the first information source having a first information disclosure, comprising: storing the plurality of information sources in a database; representing the claim as one or more core concepts; for a first core concept, assigning a first core rating based upon a precision of the first information disclosure of the first information source with respect to the first core concept; assigning additional core ratings based upon a precision of the first information disclosure of the first information source with respect to any additional core concepts; and determining a ranking for the first information source with respect to the claim based upon the first core rating and the additional core ratings. In the method, the first core rating and additional core ratings may comprise a numerical value. The numerical value may be assigned based upon a determination that the first information disclosure of the first information source with respect to the first core concept satisfies one of: 1) fully discloses the first core concept, 2) fairly discloses the first core concept, and 3) suggests the first core concept. The determination that the first information disclosure of the first information source with respect to the first core concept may satisfy one of: 1) fully discloses the first core concept, 2) fairly discloses the first core concept, and 3) suggests the first core concept is made based upon an average of one or more disclosure ratings assigned to the first information disclosure of the first information source with respect to the first core concept by one or more users of the system. The average may be weighted based upon a level of access assigned to the one or more users of the system. The first core rating and additional core ratings may be objectively based upon an analysis of a an extent of semantic correlation between words associated with the first core concept and words of the first information disclosure of the first information source.

Another aspect is a system for analyzing a first disclosure of a first information source with respect to a first core concept of a first patent claim, comprising: a database for storing a plurality of information sources and a plurality of core concepts of the first patent claim; a plurality of electrical components comprising a controlled environment for providing a communication medium between a user and the database; an analysis interface, forming a part of the communication engine, for correlating data of the system, inputs from a user, and the display of data in cooperation with an analysis interface engine; and a communication application for coordinating communication between a user device of the user and the controlled environment, for accessing resources through the controlled environment.

It is understood, that numerous other modifications will readily occur to those with ordinary skill in the art having had the benefit of reading the present disclosure.

These and all other such modifications and variations are deemed to be within the scope and spirit of the present invention as defined by the accompanying claims to Invention.

1. A method of analyzing patent claims in a granted patent and generating patent claim prosecution history charts, said method comprising the steps of:
(a) in the patent file history of the granted patent, stored in the database of a patent-specific object-oriented system, identify all patent claims that have been allowed during prosecution history;
(b) using the allowed patent claims, construct patent claim displaying the language of the allowed claim limitations, and any Examiner's claim ections (based on cited and applied prior art references) which the Examiner may have made and which Applicant(s) overcame by way of argument and/or amendment;
(c) analyze statements made by applicant(s) and the examiner during the course of the prosecution history of the patent grant;
(d) identify any statements made by applicant(s) and/or examiner, during the prosecution history, which relate to the subject matter of the allowed claims and corresponding claim limitations;
(e) within the database, link the identified statements to the allowed claims and corresponding claim limitations;
(f) identify claim concepts embraced or embodied within the allowed patent claims ;
(g) logically organize the claim concepts into concept groups;
(h) link concepts to statements made during the prosecution history;
(i) use the claim concepts to set up prior art reference analysis data schemas within the database, for use in generating and displaying prior art reference analysis GUIs during prior art reference analysis;
(j) use the prior art reference analysis GUIs to analyze the prior art references cited and applied by the examiner during the prosecution history; and
(k) use the results of the prior art reference analysis to generate patent claim prosecution history charts.

2. A method of indexing the language of sub-limitations in patent claims with scope concepts, comprising the steps of:
(a) initialize a natural language processing system supporting claim limitation index, a buffer memory, a limitation analysis buffer, a scope concept library, and a scope-concept/sub-limitation language link library;
(b) load a set of patent claims in said buffer memory, wherein said set of patent claims comprise a plurality of claim limitations expressed in natural language, and each said claim limitation including at least one sub-limitation also expressed in said natural language;
(c) parse the claims into a set of claim limitations, according to a set of predefined parsing rules;
(d) increment the claim limitation index so that the first claim limitation is loaded into said limitation analysis buffer;
(e) analyze the words in said limitation analysis buffer so as to identify one or more scope concepts represented by the language of sub-limitations in the claim limitation loaded into said limitation analysis buffer;
(f) define each claim concept represented by the language of the sub-limitations, and store each said claim concept in said scope concept library for future use;
(g) assign one or more scope concepts to the language of the sub-limitations in the claim limitation loaded in said limitation analysis buffer.

3. The method of claim 2 above, which further comprises:
(h) for each scope concept assigned to the language of the sub-limitation in the claim limitation loaded in said limitation analysis buffer, link said language of said sub-limitation with the selected scope concept, and store said link in said scope-concept/sub-limitation language link library;
(i) use the scope concept and sub-limitation language links in said scope-concept/sub-limitation language link library to search for and find other claim sub-limitations in said patent claims embodying one or more scope concepts in said scope concept library, and index the language of these claim sub-limitations with said scope concepts;
(j) index each claim limitation with a sub-limitation that has been indexed with a scope concept in said scope concept library so that a human being can visually discern that said claim sub-limitation has been indexed by a scope concept in said scope concept library;
(k) increment the claim limitation index (CLI) by 1, and return to STEP D and carry out STEPS E through J until all of said claim limitations have been indexed by one or more scope concepts.

4. A method of indexing the language of sub-limitations in patent claims with scope concepts, comprising the steps of:
(a) initialize a natural language processing system supporting claim limitation index, a buffer memory, a limitation analysis buffer, a scope concept library, and a scope-concept/sub-limitation language link library;
(b) load a set of patent claims in said buffer memory, wherein said set of patent claims comprise a plurality of claim limitations expressed in natural language, and each said claim limitation including at least one sub-limitation also expressed in said natural language;
(c) parse the claims into a set of claim limitations, according to a set of predefined parsing rules;
(d) increment the claim limitation index so that the first claim limitation is loaded into said limitation analysis buffer;
(e) analyze the words in said limitation analysis buffer so as to identify one or more scope concepts represented by the language of sub-limitations in the claim limitation loaded into said limitation analysis buffer;
(f) define each claim concept represented by the language of the sub-limitations, and store each said claim concept in said scope concept library for future use;
(g) assign one or more scope concepts to the language of the sub-limitations in the claim limitation loaded in said limitation analysis buffer;
(h) for each scope concept assigned to the language of the sub-limitation in the claim limitation loaded in said limitation analysis buffer, link said language of said sub-limitation with the selected scope concept, and store said link in said scope-concept/sub-limitation language link library;
(i) use the scope concept and sub-limitation language links in said scope-concept/sub-limitation language link library to search for and find other claim sub-limitations in said patent claims embodying one or more scope concepts in said scope concept library, and index the language of these claim sub-limitations with said scope concepts;
(j) index each claim limitation with a sub-limitation that has been indexed with a scope concept in said scope concept library so that a human being can visually discern that said claim sub-limitation has been indexed by a scope concept in said scope concept library; and
(k) increment the claim limitation index (CLI) by 1, and return to step (d) and carry out steps (d) through (i) until all of said claim limitations have been indexed by one or more scope concepts.
